(19) United States
(12) Patent Application Publication
(10) Pub. No.: US 2003/0215551 A1
(43) Pub. Date: Nov. 20, 2003

(54) Products, methods and apparatus for fresh meat processing and packaging

(76) Inventor: Anthony J.M. Garwood, Mercer Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/413,073

(22) Filed: Apr. 10, 2003

Related U.S. Application Data
(63) Continuation of application No. 09/724,287, filed on Nov. 28, 2000.
Application No. 09/724,287 is a continuation-in-part of application No. 09/550,399, filed on Apr. 14, 2000, now abandoned.
Application No. 09/550,399 is a continuation-in-part of application No. 09/392,074, filed on Sep. 8, 1999, now abandoned.
Application No. 09/392,074 is a continuation of application No. 09/039,150, filed on Mar. 13, 1998, now abandoned.
(60) Provisional application No. 60/040,556, filed on Mar. 13, 1997.

(51) Int. Cl. C12C 3/04

(52) U.S. Cl. 426/392

(57) ABSTRACT

Improved processing and packaging for perishable goods such as red meats providing a processing system wherein ambient air is excluded and suitable gases such as carbon dioxide are provided at a suitable pressure and in such a manner as to increase the quantity of the gases dissolved in the perishable goods. Then providing a base and placing the perishable goods over the base. A flexible web of plastic wrapping material (second web) is then applied over the base and the goods and air or gas evacuated therefrom and replaced with a suitable gas. The base includes a cup-shaped tray with a recess (first web), of plastics or other suitable material, with side walls extending upwardly to connect to a narrow horizontally disposed flange. The first web, goods and second web are located inside a depression in a third web of gas barrier material and there together placed into an enclosed evacuation chamber. A suitable gas is provided in the chamber in such a manner as to displace substantially all other gas and particularly atmospheric oxygen that may be present with the enclosed goods and web materials. The third web is then sealed so as to enclose the goods with first and second webs, that the pressure of the gas may be increased to a level above atmospheric pressure. Most preferably the quantity of gas dissolved into the goods will be increased. Most preferably the gas introduced into the chamber and the space will enhance preservation of the packaging goods when contacting the goods. The first web, second web and third web are sealed together thereby producing a hermetically sealed package with the goods and a gas filled space contained therein to provide a sealed package. The sealed package can be stored for any convenient period of time after which the third web is can be removed so as to allow ambient air to contact the goods. The invention further includes the method and apparatus for producing the processed goods and packaging.

### CROSS-REFERENCE TO RELATED APPLICATIONS

This application is a continuation of application Ser. No. 09/724,287, filed Nov. 28, 2002, which in turn is a continuation-in-part of application Ser. No. 09/550,399, filed Apr. 14, 2000, which in turn is a continuation-in-part of application Ser. No. 09/392,074, filed Sep. 8, 1999, which in turn is a continuation of application Ser. No. 09/039,150, filed Mar. 13, 1998, now abandoned, which in turn claims the benefit of U.S. Provisional Application No. 60/040,556, filed Mar. 13, 1997. In addition, this Application claims the benefit of U.S. Provisional Application Serial Nos. 60/129,595, filed Apr. 15, 1999; 60/141,569, filed Jun. 29, 1999; 60/144,400, filed Jul. 16, 1999; 60/148,227 filed Jul. 27, 1999; 60/149,938, filed Aug. 19, 1999; 60/152,677, filed Sep. 7, 1999; 60/154,068, filed Sep. 14, 1999; 60/160,445, filed Oct. 19, 1999; and 60/175,372, filed Jan. 10, 2000.

### FIELD OF THE INVENTION

The present invention relates to products, methods, apparatus, and the products made therefrom used for processing and packaging perishable foods and particularly to processed perishable foods that are packaged in plastic food trays that are overlaid with one or more layers of sealable plastic materials. The present invention also relates to apparatus for processing and pre-treating perishable foods and associated packaging with gases.

### BACKGROUND OF THE INVENTION

For the entire history of fresh red meat processing for human consumption, where slaughtered, eviscerated, and chilled carcasses are produced in the normal process, improvements in terms of reducing labor and or reducing costs of the process, have been sought. Few major improvements have been achieved in the recent past and it is a purpose of this present invention to expose opportunities and to provide methods, apparatus and products of improving the efficiency and competitiveness of the red meat industry. Such opportunities are epitomized by, for example, the condition that all carcasses contain a great deal of bone and other materials that are not used for human consumption and yet the entire carcass must be chilled prior to further processing, in order to chill those parts that are used for human consumption. Furthermore, the shape of all animals used for human consumption are of irregular and inconvenient profile. Conversely, packaging trays that have been cost effectively and efficiently manufactured, are invariably rectangular and/or square in profile. By adopting procedures disclosed herein it will be seen that costs of chilling are reduced since, for example, the skeleton can be removed before chilling thereby saving costs of such chilling process. Fresh red meat tissue is typically quite soft and easy to cut immediately after the animal has been slaughtered and prior to the natural, “hardening” effects of rigor mortis has occurred. It can therefore be easier and quicker to cut primal portions from animal carcasses, during the normal animal “disassembly” process prior to rigor mortis and chilling. Those fresh red meat primal items, that are intended for human consumption, can then be shaped by placing into molds of a specifically designed and desired profile prior to rigor mortis and then chilled during the natural rigor mortis process. This device will provide a method to change and adjust the shape of fresh red meat primal items so that, for example, fresh red meat primal items can be readily and automatically processed during the slicing and cutting process as required prior to packaging. Furthermore, profiles of primal meat portions can be arranged so as to be more convenient when slices of fresh red meat primal items are loaded into improved packaging, such that more can be loaded into improved packaging while still maintaining a space efficient, appealing and attractive appearance for the consumer at the point of retail display and/or foodservice outlet.

Typical modified atmosphere packages for fresh foods, such as red meats and other perishable foods, having a limited shelf life, typically include a thermoformed tray or other package composed of EPS/tie/PE (barrier foam trays) plastics material or other suitable substantially gas impermeable material, i.e. tray, overlaid with a single transparent web of plastics material that can be heat sealed to the tray. A typical substantially gas impermeable heat sealable composite web includes a biaxially oriented polyester (PET) layer/tie layer/gas barrier layer (such as PVDC) an adhesive layer/heat sealing layer (such as polyethylene), which in turn is finally adhered by a heat sealer to the tray. The polyethylene layer is a heat sealable layer that is tied to a gas barrier layer such as polyvinylidene chloride which is in turn adhered to polyester. Because of the diverse types of materials that are employed in the foregoing package, it is difficult to reprocess and recycle the post-consumer package. Moreover, the cost associated with post-consumer recycling of multiple layer plastics material renders the process impractical and substantially not economically feasible.

Commonly used modified atmosphere packages for fresh foods such as red meats and other perishable foods having a limited shelf life typically comprise a tray thermoformed from a sheet of EPS (expanded polystyrene) laminated to a web of substantially gas impermeable web material or other suitable substantially gas impermeable material. A lid, such as a single or composite transparent web of plastics material that can be bonded to the flanges of the tray. Both tray and lid materials are typically substantially gas impermeable heat sealable composite structures and cannot be readily recycled. Lid material typically comprises a laminated structure including several layers such as bi-axially oriented polyester bonded to a gas barrier layer (such as PVDC) which is sandwiched between an adhesive or heat sealing layer (such as polyethylene). Because of the diverse types of materials that are employed in the foregoing package, it is difficult to reprocess and recycle the “post-consumer” package. Moreover, the cost associated with post-consumer recycling of multiple layer plastics material, such as the aforementioned, renders the process impractical and substantially not economically feasible.

A further limitation of packaging perishable goods such as fresh red meats in hermetically sealed gas barrier packages results from the need to enclose a relatively large volume of gas, and particularly carbon dioxide, within the package. Clearly, consumers have no interest in purchasing these gases that accompany the red meat. Minimizing the size and bulky appearance of such packaging is desirable, therefore it is a goal to reduce the overall size and volume of the packaging to a minimum size. Additionally, a major proportion of red meat production occurs at locations that are located at a substantial distance from the point of retail sale of red meats to consumers. Most US beef is produced in the central plains around Kansas, Nebraska and Iowa and the major markets are situated on the coastal regions such as New York or California. Costs of shipping these fresh red meat items from the point of production and packaging can be reduced if the packages are reduced in volume. However, reduction in the volume of gases provided within a package can have a deleterious effect on shelf life of the perishable goods and red meat contained therein.

Typical methods used for production of ground meats and patties, that are substantially composed of fat, muscle tissue, protein and water, have remained unchanged for many decades and are inefficient when compared with other food production methods that are commonly applied in other industries. These inefficiencies that result in large part from poor controls and questionable safety standards, often cause significant and unnecessary wastage of meat in addition to occasional loss of human life.

A limitation of producing perishable goods such as fresh beef patties at the point of source animal slaughter results from shelf life limitations inherent with current packaging systems. A major proportion of beef patties production occurs at locations that are situated at a substantial distance from the point of sale of these products. Beef patties are often produced at locations remote from the point of slaughter due to short shelf life. The present invention provides an improved, automated fresh pattie processing system that can be readily integrated at the point of animal slaughter.

The packaging industry has therefore felt the need for simplified individual packaging structures that will provide finished package performance including label requirements for a variety of applications. Additionally, if the packaging can be handled economically both in the pre-consumer handling and in post-consumer recycling, significant economic advantages are available.

With conventional packaging of meats and other perishable type goods, the shelf life is limited due to bacterial growth within the package. The growth can be inhibited when the package contains carbon dioxide gas, however, carbon dioxide will dissolve in liquids such as water contained within the goods in the package. After time, carbon dioxide can become substantially dissolved in the water and shelf life may be limited by this. After time, discoloration due to formation of, for example, metmyoglobin on the outer surface of the red meat also reduces consumer appeal of the packaged goods. It is also known to provide other gases within the package to enhance the keeping of the packaged goods. In the case of red meat blends of CO₂ and N₂, in varying proportions and up to 100% of each single gas have been used. When carbon dioxide dissolves into liquids and water, this can cause the package to collapse inwardly. Collapsing causes the appearance of the package to be unacceptable to consumers and can also cause the package to rupture.

In order to extend shelf and storage life of the packaged goods several inventions have been disclosed and examples of known packaging for this purpose are given in the following US patents:

| | | |
|---|---|---|
| 5,779,832 | Kocher | Method and Apparatus for making a peelable film |
| 5,629,060 | Garwood | Packaging with Peelable Lid |
| 5,560,182 | Garwood | Packaging Method |
| 5,534,282 | Garwood | Packing Perishable Goods |
| 5,514,392 | Garwood | Packaging for Perishable Goods |
| 5,323,590 | Garwood | Method of producing food packaging with gas |
| | | between tensioned film and lid |
| 5,226,531 | Garwood | Food Packaging with gas between tensioned film |
| | | and Lid |
| 5,155,974 | Garwood | Food Packaging with gas between tensioned film |
| | | and Lid |
| 5,115,624 | Garwood | Thermoplastic skin packing means |
| 5,129,512 | Garwood | Packaging |

The subject matter of the above patents is hereby incorporated by reference.

Prior art as described in U.S. Pat. No. 5,779,832 to Kocher, discloses a method of making a multilayer peelable film. Kocher discloses a method of co-extruding two webs of material simultaneously in the form of a multilayer film that can be delaminated into a third web and a second web and then after treating the second web to improve gas permeability therethrough, re-laminating the third and second webs together. These two re-laminated webs can be sealed to a first web of gas barrier material and thereby produce a package. The first web may have a depression formed therein into which goods such as red meat can be placed before heat sealing the third and second webs to the first web. Typically, goods will not completely fill the depression and space will remain in the depression in addition to the goods. A blend of gases or a single gas such as CO₂ can be provided in the space with the goods and thereby can contact the goods. After storage and prior to retail display at an intended point of sale to consumers, the third web can be peeled from the package allowing atmospheric oxygen to permeate the second web of gas permeable material and to contact the goods. The atmospheric oxygen can then allow generation of a bright red colored substance such as oxymyoglobin thereby providing an appearance attractive to the consumers.

It has been found that when applying the second and third webs extruded in the manner as disclosed in Kocher to packaging as that disclosed in the inventor's own U.S. Pat. No. 5,534,282, a dull appearance of the second web can result with reduced clarity when compared with other webs of material that are produced in a single web such as plasticized PVC (pPVC). Furthermore, after removal of the third web, from the re-laminated co-extrusion, by peeling, as described in U.S. Pat. No. 5,534,282, distortions and ripples can appear in the second web. This occurs, partly, as a result of inadequate lateral tension provided in the second web when limited by the inherent limitations of co-extruding the second and third webs simultaneously. This can, therefore, severely detract from the visual appearance of the package in the eyes of consumers.

A further limitation of packaging perishable goods such as fresh red meats in hermetically sealed gas barrier packages results from the need to enclose a relatively large volume of gases, and particularly carbon dioxide, within the package. Clearly, consumers have no interest in purchasing gases with red meat and minimizing the size and bulky appearance of the package is desirable. Additionally, a major proportion of red meat production occurs at locations that are situated at a substantial distance from the point of sale for red meats. Costs of shipping the goods from point of production and packaging can be reduced if the packages are reduced in size. However, reduction in the volume of gasses contained within a package can have a deleterious effect on the shelf life of perishable goods and red meats contained therein.

Conventional modified atmosphere “case ready” retail packaged fresh red meats and other perishable type goods experience limited shelf life because of bacterial growth, such as aerobic and anaerobic bacteria, on the packaged goods; rancidity “off flavors” caused, in part, by oxidizing fats; and discoloration to visible meat surfaces. The growth can be inhibited when goods are treated by exposure to certain agents prior to packaging and then providing certain gasses and/or other agents with the goods within the finished and sealed package. Such a gas, blend of gasses agent or agents may include one or a combination of the following: oxygen, carbon dioxide, ozone, hydrogen, nitrogen, argon, krypton, neon, helium, xenon, hydrogen peroxide, potassium permanganate, chlorine dioxide, fluorine, bromine, iodine and/or any other suitable substances. However, some gasses such as carbon dioxide gas, for example, can quickly dissolve in substances such as oils and water contained in the goods. After time, carbon dioxide can become substantially dissolved in water which may limit shelf life. Furthermore, when oxygen is present and more particularly when a quantity of approximately 5,000 to 30,000 parts per million of oxygen is present in a gas within a package, discoloration due to formation of metmyoglobin on the visible surface of red meat, reduces consumer appeal of the packaged goods. When carbon dioxide dissolves (into another substance) the combined volume of the residual substances is substantially reduced which can cause the package to collapse inwardly. Collapsing causes the appearance of the package to be unacceptable to consumers and can also cause the package to rupture and render it unfit for use. In compensating for such a deleterious event, several existing packaging systems require large volumes of gas to be packaged with the goods. However, when large volumes of gas are provided, the resultant “bulky” condition does not provide for cost efficient shipping and distribution from the location of packaging to the point of retail sale of the packaged goods.

Conventional packages for red meat are produced in one or more sizes. When packaging red meats or other perishable goods, the package must conform to the goods. Therefore, if a red meat portion is too large for one size of a package, the next larger size must be used. Oftentimes, this will lead to an overly large sized package introducing inefficiency into the process because of the wasted space. In order to maximize efficient use of the internal space available in a typical road, rail or sea, refrigerated shipping container or trailer, it is important to increase the density and unit weight per unit volume of the packaged perishable goods. The maximized efficient use of the space in the shipping containers can be achieved by adjusting the shape of the inconveniently shaped animal fresh red meat primal portions such that slices of the fresh red meat primal portions will fit and substantially fill the available space within trays of the improved packaging.

High oxygen case ready packages are inefficient, in large part, due to the inherent need to include a quantity/volume of gas that is equal to, or greater than the volume of the package meat contents. For example, a high oxygen package comprising a barrier foam tray and clear barrier film lid, hermetically sealed to flanges of the barrier foam tray and with a 2 lb quantity of meat sealed therein will require approximately 1 liter of gas to be enclosed and sealed within the package to ensure that an approximate 10 day shelf life extension can be provided. Said gas (referred to as modified atmosphere) will typically comprise 80% Oxygen and 20% Carbon Dioxide but other combinations that may include relatively small quantities (say <10%) of residual atmospheric nitrogen are also typical. The relatively high level of CO2 (when compared to ambient atmosphere) is provided to inhibit bacterial growth, and with good storage temperature control a shelf life for sound, fresh meat can be extended to over 10 days from packaging. The bacterial controlling effect is a consequence, in part, of a characteristic of bacteria entering a “lag phase” when the environment in which it is placed, significantly changes . . . eventually the bacteria will equilibrate and adapt to the atmosphere that is present and commence normal reproduction and extended infection. The shelf life extension will vary according to several factors including, for example, the following: storage temperature i.e.: the less variation from a minimum temperature of approximately 29.5 degrees F. is optimum, (while ensuring that freezing of the meat, which occurs at about 26-27 degrees F., does not occur); the condition and age of the meat at packaging, the conditions at the point of packaging such as hygiene, temperature etc., muscle type and age of animal from which the meat was harvested. Nevertheless, a shelf life extension of 10 days is readily reproducible when conditions are maintained as required. After a relatively short period of time, the CO2 provided within the package will dissolve into the water and oils contained in the meat and the oxygen is present to ensure that a consumer appealing/acceptable “bloom: or “redness” is maintained. The “bloom” is caused by the natural color of oxymyoglobin and oxyhemoglobin that is present in freshly cut meat but when oxygen is present, after approximately 9 to 10 days discoloration such as browning due to increased levels of surface metmyoglobin, will occur, rendering the product unsalable or requiring a reduction in price to sell to a consumer. Furthermore, the excessive volume of the finished packages, results in excessive packaging material and shipping costs and display case space at retail outlets and also excessive costs incurred for disposal of additional cardboard etc. at the supermarket outlets. Therefore by reducing volume of the retail package, costs for packaging, shipping and display are substantially reduced, which is a purpose of the inventions.

Effective packaging materials for existing, extended shelf life, retail packaged, case ready perishable goods are often relatively expensive and the associated packaging processes are typically labor intensive. The use of EPS and FP can provide desirable low cost packaging materials but the inherent cell structure of these materials can retain residual oxygen (from air) within the cell structure, even during and after exposure to very low levels of air pressure (vacuum). When EPS and FP materials are used in low residual oxygen modified atmosphere packaging, such as described in U.S. patent application Ser. No. 09/039,150, residual oxygen can diffuse and exchange from the cell structure, and become present as a free gas within the master container thereby elevating the level of oxygen present therein to a potentially undesirable level. As described in the subject matter of US patent applications in the name of the present inventor, apparatus for minimizing the level of residual oxygen retained in the cell structure and master containers are disclosed. However, such a process of gas exchange is problematic and difficult to reliably maintain. Therefore, packaging fabricated from solid plastics sheet, may be more efficiently employed in this application.

Conventional “master container” or “master package” modified atmosphere packaging (MAP) systems include loading perishable goods into trays and then a plurality of loaded trays are subsequently placed into a larger “master container” which may be manufactured from a suitable gas barrier material. The “master container” is typically evacuated of air and then filled with a gas blend that may include a mixture of any desirable gasses which may include, for example, 40% carbon dioxide and 60% nitrogen for a low oxygen MAP system. The master container is then sealed with loaded trays to provide an airtight, sealed master container, containing loaded trays and a gas blend with a residual quantity of atmospheric oxygen. Most desirably, for low oxygen MAP systems, the residual quantity of atmospheric oxygen will not exceed an amount of 100 to 300 PPM (parts per million) with the balance of the gas blend including nitrogen and carbon dioxide and/or other inert or oxygen free gasses. Low cost packaging materials include foamed polystyrene (EPS trays), however, the choice of material for tray manufacture must exclude materials (unless treated in a manner that will substantially remove atmospheric oxygen from the cell structure), such as expanded (foamed) polystyrene (EPS), that have a capacity to “retain” air, even after exposure to a high vacuum as may occur in packaging processes. Therefore, in order to maintain the residual quantity of atmospheric oxygen at not more than 100 PPM, untreated expanded (foamed) polystyrene (EPS) or FP trays cannot be easily and efficiently used. By way of explanation, EPS trays are typically thermoformed from extruded EPS sheet. A typical method of producing EPS sheet is to “foam” the melted (liquid) polystyrene by injection of a foaming agent, such as nitrogen, carbon dioxide or pentane, into liquid polystyrene thereby causing it to foam (become frothy, with bubbles and/or tiny gas filled cells within the foam) and then extrude the foam through a slot in a flat or annular die. The extruded EPS can then cool and solidify into a sheet that can be slit and wound onto a roll prior to further processing. Immediately after extrusion of the EPS sheet, cells retained within the foam are filled with nitrogen or other gas (foaming agent) used in the foaming process. However, such a foaming agent gas, if not retained by other means in the cell structure, can quickly exchange with the ambient air during storage and the cells can become filled with air. When placed within a vacuum chamber and exposed to a high level of vacuum, as is normal in a “master container” packaging process for low oxygen MAP systems, cells can retain a quantity of air, even during and subsequent to evacuation (unless the exposure to vacuum is significantly extended to the extent required). The retained quantity of air in the cells, can subsequently exchange with gas within the sealed “master container” which can, thereby, elevate the residual oxygen content of the “free” gas contained within the “master container” above a desirable level.

A fundamental need that resulted in the development of thermoformed EPS trays initially arose in the modern supermarket. Fresh meats and poultry were formerly processed and retail packaged at the supermarket immediately prior to retail display and sale. EPS foam trays were developed to meet these supermarket requirements, and have provided a functional and low cost retail package, when “over wrapped” with a low cost web of plastic material such as plasticized PVC. However, with case ready MAP systems, such EPS trays are now required to be shipped in trucks and other means of transport from the point of packaging, which may be located many hundreds of miles from the point of sale. Abuse and damage can occur to the packaging during this shipping. In an effort to protect against damage, rigid and heavy weight cartons with sheets, cushions and/or columns, made from suitable materials such as chipboard are manufactured and assembled with EPS trays and goods contained therein. Such protective packaging is expensive, bulky and results in excessive shipping costs. Furthermore, excessive packaging, as required for the sole purpose of protection during shipping, must be discarded at the supermarket thereby creating excessive waste disposal problems with the attendant costs to the environment.

### SUMMARY OF THE INVENTION

Methods and apparatus of the present invention are directed at saturating fresh meat with CO₂ prior to packaging. In this situation, adequate CO₂ can be dissolved in the tissue of the meat and to such a level that the meat can become a source of CO₂ after packaging. This can be achieved by lowering the temperature of the meat to a minimum (typically about 29.5 degrees F.) and exposing it to relatively high pressure (ambient to 200 psi or more) CO₂ gas. CO₂ gas dissolves more readily at lower temperatures and therefore a part of the method is to expose the meat to high pressure CO₂ at the lowest temperature above freezing and then retail package the meat in a tray, then over wrapped with a highly gas permeable web of material such as pPVC. If an extended shelf life of say not more than 10 days is adequate, then a barrier pouch master container may not be needed, the CO₂ gas “entrained” in the meat tissue prior to packaging will gradually be released immediately after removal from a higher pressure to ambient and as the temperature elevates during delivery to the point of sale and this can be sufficient to inhibit bacterial growth and atmospheric oxygen in unlimited quantities is available to maintain the requisite “bloom”. In this way, shipping, packaging and display costs can be reduced substantially, while providing an extended shelf life which may be sufficient for some industry packers and supermarkets.

Thus, the present invention discloses a method of processing and packaging goods, the method having a step for placing goods in an enclosed vessel containing a gas to enhance the keeping of the goods, a step allowing the gas to contact and dissolve in liquids and oils present in the goods, a step restricting the formation of oxymyoglobin by substantially displacing ambient air, that may otherwise contact the surface of the goods, with the gas, a step providing a retail package including two overlapping webs with a space therebetween with at least one of the webs being gas permeable, a step transferring the meats from the vessel to a position between the two overlapping webs and into the space without allowing significant formation of oxymyoglobin on surface of the meats.

In a preferred embodiment, the method is suitable to use on goods including fresh red meats wherein the gas is a substantially oxygen free gas.

A further embodiment is a method of packaging goods, the method having a step providing four or more overlapping web sections, the two outer, first and second, web sections being gas barrier webs, the inner web sections having folded, third web material with at least one cup-shaped depression therein that restricts nesting of the webs together, and a fourth gas permeable web material with space between the third and fourth web sections, a step providing goods between the folded third web material and the fourth web material, a step for sealing the folded third web material and the fourth web material so as to substantially retain the goods in the cup-shaped depression but allowing gas to pass into and out of the space, a step for sealing the overlapping webs after sealing the third and fourth web material but prior to sealing the first and second webs together at a seal path near the perimeter of the packaging which will provide a hermetically sealed package, a step for gas flushing the chamber means with a gas to enhance the keeping of the goods, a step for sealing the first and second webs together by a sealing means which defines a seal path near what will be an outer perimeter of the packaging and which encloses the third and fourth web material within a hermetically and substantially gas impermeable package with the goods and the gas sealed therein and allowing the gas to contact the goods.

A further embodiment includes one or more packaging tray(s), each fabricated from a single web of thermoformed plastics material web. Said packaging tray having upwardly disposed side walls, defining depression(s) with space therein into which goods are placed, a second web of gas permeable material overlapping said first web which may have been stretched over said packaging tray with goods therein and hermetically sealed to fully enclose said packaging tray and goods therein, a third web of gas impermeable material overlapping and hermetically sealed so as to fully enclose one or more of said first and second webs with space therein, a suitable gas in said space, said gas or blend of gases selected for enhancing preservation of the packaging goods by contacting the surface of said goods, a chamber means to enclose said first, second and third webs, prior to sealing said third web, which can be isolated from external atmosphere by valve means, providing a suitable pressure to said gas in said chamber, hermetically sealing said third web.

A further embodiment is a goods packaging tray having a base with upwardly extending side walls that terminate at a flange that extends around a perimeter of the tray to provide a cup-shaped recess. The tray having at least one extension connected to the flange at a hinge. The extension having a cup-shaped flap that can be folded about the hinge and be sealed to at least one of the upwardly extending side walls to provide an enclosed space. The tray having apertures at a base of the side wall of the tray so as to provide communication between the enclosed space and the tray that will allow liquids to pass from the tray cup-shaped recess to the enclosed space.

A further embodiment is an apparatus for producing packaging trays having means for thermoforming plastics sheet to form and trim a packaging tray with a base and upwardly extending side walls that terminate at a flange that extends around a perimeter of the tray to provide a cup-shaped recess with at least one extension connected to the flange at a hinge having a cup-shaped flap that can be folded about the hinge and be sealed to at least one of the upwardly extending side walls to provide an enclosed space. The apparatus further includes a sealer to seal the flap to the tray wall around a perimeter of the flap and a device to optionally provide apertures in the side wall of the tray recess so as to provide a communication between the enclosed space and the tray recess.

A further embodiment includes a method and apparatus for grinding boneless beef directly into an enclosed chamber that has been filled with a suitable gas such as CO₂ and which substantially excludes oxygen from contacting with the ground beef. Adjusting temperature of the ground beef to a suitable temperature.

Processing and mixing ground beef (meat), in a vessel or series of vessels substantially excluding oxygen, so as to blend and adjust the relative quantities of fat and muscle in the finished product to a desired ratio. Maintaining the ground beef at a suitable temperature.

Extruding ground beef in a stream of grinds by pumping through an enclosed conduit with an exit end and a selected cross sectional area and profile that is substantially similar to typical beef patty, at a velocity that is adjustable while maintaining pumping at a substantially constant rate. Pressurizing a stream of ground beef in a conduit at a selected pressure and compressing any voids such that CO₂ gas contained therein dissolves into the stream of ground beef. Maintaining ground beef at a suitable temperature.

Intermittently adjusting the velocity of stream of grinds so as to intermittently slow or stop its flow as it emerges from the exit end of the enclosing conduit and allow slicing with knife means to provide single beef patties in stacks of a chosen quantity. Intermittent slowing or stopping of flow may exceed 500 cycles per minute.

Interfacing with a packaging system and packaging fresh meat patties without exposure to air while maintained at a suitable temperature.

The present invention provides an efficient method and apparatus for processing fresh red meat products at the point of animal slaughter for subsequent case ready packaging and delivery to the consumer via a typical supermarket or retail sale outlet. The consumer may be located thousands of miles away from the point of slaughter which often results in distribution and delivery that can require a period of time exceeding 20 days.

The present invention provides a most efficient method and apparatus for packaging fresh red meat products at the point of animal slaughter for subsequent delivery to the consumer via a typical supermarket or retail sale outlet. Consumers, located thousands of miles away from the point of slaughter and packaging often results in distribution and delivery that can require a period of time exceeding 15 days.

The present invention maximizes efficient use of the internal space available in a typical road, rail or sea, refrigerated shipping container or trailer, it is important to increase the density and unit weight per unit volume of said packaged perishable goods. Effective packaging materials for existing case ready packaging systems are often expensive and the associated packaging processes are typically labor intensive. The present invention provides low cost packaging trays by utilizing various packaging materials such as polypropylene or PET.

The present invention provides improved packaging for perishable goods, an improved appearance of the packaging and a means to increase the level of carbon dioxide dissolved into the liquid and water contained on or with the perishable goods, thereby reducing the total volume of the packages, increasing density for more efficient shipping and subsequent display at the point of sale. The goods includes fresh red meat and a further purpose of this invention is to provide a means of enhancing the keeping qualities of the goods.

The present invention provides several alternative methods of stretching the second web such that after removal of the third web, the second web will be in a substantially “ripple free”, clear, smooth, and at least partially tensioned condition. Additionally, a further description of a method to pre-stretch the second web, before sealing the first web, second web and third webs, within a single chamber sealing means is disclosed. A further description of methods to package goods in a single chamber sealing and packaging machine when the first and second webs are applied separately without having been re-laminated after treatment of the second permeable web.

Therefore in accordance with a first broad aspect of the present invention there may be provided improved packaging for perishable goods including: a tray or first web over which the goods are placed, the goods including oils, fats, protein, liquids and water. The tray having upwardly disposed side walls, defining a depression with space therein, the side walls having been urged inwardly to a controlled and predetermined extent and are tensioned, thereby retaining an outwardly urging force; a second web of gas permeable material overlapping the first web which may have been pre-stretched; a third web of gas impermeable material overlapping the first and second webs; a gas in the space, the gas or blend of gasses (preferably carbon dioxide and nitrogen) selected for enhancing preservation of the packaging goods by contacting the surface of the goods; a chamber means to enclose the first, second and third webs, prior to sealing, which can be isolated from external atmosphere by valves, providing pressure to the gas in the chamber, the pressure being at a level above ambient atmospheric pressure, thereby providing accelerating dissolving of the gasses and carbon dioxide into the liquids and water; and sealing the first, second and third webs together while retaining the side walls of the first web tray in tension with the second and third webs.

In this way, the shelf life of the packaged goods can be extended and when the third web is removed, the tension between the side walls and the second web can cause the second web to be stretched and be substantially flattened with fewer ripples in its surface. Thus the packaging will be pleasing to an intending purchaser.

The invention provides a labor efficient, low cost processing and packaging system for perishable goods that can minimize the presence of undesirable levels of both anaerobic and aerobic bacteria, fungi, virus and residual oxygen, for an extended period of storage time by enhancing the keeping qualities of the perishable goods. The processing and packaging system is disclosed herein, with further disclosures providing details of several package configurations produced from various packaging materials including polypropylene, amorphous polyester, expanded polystyrene (EPS) and foamed polyester (FP).

Additionally, the present invention provides efficient methods and apparatus for delivering fresh red meat products from the point of animal slaughter and retail packaging to the consumer via a typical supermarket or retail sale outlet. The consumer may be located thousands of miles away from the point of slaughter which often results in distribution and delivery that can require a period of time exceeding 14 to 25 days.

The present invention provides methods and apparatus for reducing the processing costs, provide a method to reduce the labor content of the process and separate the carcass into at least two groups of components that can be either used for human consumption or not for human consumption prior to chilling the carcass.

The present invention provides improved and accurate “portion control.” For example, a New York Strip primal that includes a strip of muscle with a fat covering on one side, can be substantially shaped into a uniform strip prior to slicing. Additionally, such primal items as tenderloin that have a tapered profile can be combined and pressed together to form a single tenderloin of uniform cross-section and then sliced to produce uniform slices of equal size and weight. In yet a further embodiment, the present invention provides for the cutting of meat containing deoxymyoglobin in an atmosphere that excludes oxygen and substantially inhibiting and preventing contact of the freshly cut surface with oxygen in the ambient atmosphere.

The present invention provides a labor efficient, low cost processing and packaging system for perishable goods that can minimize the presence of undesirable levels of bacteria, rancidity, discoloration and enhance the keeping qualities of the perishable goods.

Trays and packaging apparatus are disclosed in the present invention that can incorporate either a low oxygen modified atmosphere or alternatively a high oxygen modified atmosphere. A high oxygen modified atmosphere may include a blend of gasses including 20% carbon dioxide, 70% oxygen and 10% nitrogen. Part of this blend of gas may include some residual ambient atmospheric gases.

The tray construction and packaging disclosed in this invention describe ways to substantially eliminate excessive packaging by incorporating multifunctional features in a single tray. The multifunctional features include devices to allow stacking of a plurality of trays in a vertical stack, incorporation of an in-built protective cushion around the perimeter of the tray and a purge absorbing feature.

Additionally, the present invention provides a most efficient means of delivering fresh red meat products from the point of animal slaughter and retail packaging to the consumer via a typical supermarket or retail sale outlet. The consumer may be located many hundreds of miles away from the point of slaughter which often results in distribution and delivery time that can exceed 14 to 25 days.

The present invention increases the volume of carbon dioxide gas within a package without increasing the size and volume of the package. This can be achieved by carbonation and increasing the quantity of dissolved carbon dioxide in the free liquids, oils and water contained in the package with red meat prior to hermetically sealing the package.

In order to maximize exploitation of the benefits of improved packaging as described herein for use with packaging of perishable goods such as cuts of fresh red meat, as detailed herein, a method and apparatus of changing and/or adjusting the shape and profile of the red meat primal, before slicing the primal, such that slices of the primal will have a permanently adjusted shape facilitating more efficient use of the improved packaging, is highly desirable. The description contained herein provides a method and apparatus of achieving an adjustment and or shape of large fresh red meat primal portions and combinations of smaller pieces pressed together.

The present invention provides a product, method and apparatus for processing fresh meats such as ground beef, lamb and pork and most particularly for production of ground beef, safe bulk storage, sale in bulk form, further processing, and packaging according to customer specifications that are provided immediately prior to packaging and where the product and packaging specifications are provided by customer via electronic transfer of information, directly, or substantially directly to the ground beef storage and packaging equipment. Said ground beef, in whichever form, including beef patties, being intended or human consumption and made in accordance with the present invention. The present invention provides an automatic and enclosed fresh meats grinding and/or cutting, blending, processing, storage and packaging process including the electronic business method of specifying and purchasing the finished meat products according to the purchasers specifications which may be specified immediately prior to production of the specified products.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view of one package made in accordance with the present invention;

FIG. 2 is a perspective view of a corner section of the package of FIG. 1 with the heat sealable layers up turned;

FIG. 3 is a cross-sectional view of the package of FIG. 1 taken along section line 3-3;

FIG. 4 is a schematic view of an assembly line for manufacturing a package such as shown in FIG. 1;

FIG. 5 is a schematic view of a master bag method of packaging individual packages for storage and transport in accordance with the present invention;

FIG. 6 is an alternate embodiment of a tray having a vent hole in accordance with the present invention;

FIGS. 7, 8, and 9 show another embodiment of a stackable tray built in accordance with the present invention;

FIGS. 10-15 show another embodiment of a stackable tray constructed in accordance with the present invention;

FIG. 16 shows another embodiment of a master package and method for storing and transporting individual packages containing edible materials in accordance with the present invention;

FIGS. 17 and 18 show an alternate valve arrangement to that shown in FIGS. 14 and 15;

FIGS. 19-21 show another alternate valve arrangement;

FIGS. 22-26 show the incorporation of a material for indicating the presence of E. coli bacteria into a tray, constructed in accordance with the present invention;

FIGS. 27-30 show a production line and method in accordance with the present invention for producing a material for indicating the presence of E. coli bacteria.

FIG. 31 shows a perspective view of a tray with flaps constructed according to the present invention;

FIG. 32 shows a perspective view of the tray of FIG. 31;

FIG. 33 shows a cross-sectional view of the tray of FIG. 32 taken along line 33;

FIG. 34 shows a finished package constructed according to the present invention;

FIG. 35 shows a master container constructed according to the present invention;

FIG. 36 shows the master container of FIG. 35 with finished packages enclosed therein and sealed with a lid and enclosed in a cardboard box;

FIG. 37 shows a cross-sectional view of a tray constructed according to the present invention;

FIG. 38 shows a perspective view of a finished package constructed according to the present invention;

FIG. 39 shows a cross-sectional view of a tray portion including a flap in the up position;

FIG. 40 shows a bottom plan view of the flap of FIG. 39;

FIG. 41 shows a cross-sectional view of the flap of FIG. 39 in the down position;

FIG. 42 shows a schematic view of a tray sealing apparatus constructed according to the present invention;

FIG. 43 shows a web material constructed according to the present invention;

FIG. 44 shows a web material constructed according to the present invention;

FIG. 45 shows a cross-sectional view of a finished package constructed according to the present invention;

FIG. 46 shows a cross-sectional view of a web material constructed according to the present invention;

FIG. 47 shows a perspective view of a finished package constructed according to the present invention;

FIG. 48 shows a tray portion including a flap in a down position, constructed according to the present invention;

FIG. 49 shows a cross-sectional view of a web material constructed according to the present invention;

FIG. 50 shows a perspective view of a tray with flaps constructed according to the present invention;

FIG. 51 shows a bottom perspective view of the tray of FIG. 50;

FIG. 52 shows a bottom plan view of the tray of FIG. 50;

FIG. 53 shows a side plan view of the tray of FIG. 50;

FIG. 54 shows a cross-sectional view of a tray constructed according to the present invention;

FIG. 55 shows a perspective view of a tray constructed according to the present invention;

FIG. 56 shows a cross-sectional view of a tray portion of FIG. 55 taken along line 56;

FIG. 57 shows a cross-sectional view of a tray portion of FIG. 55 taken along line 57;

FIG. 58 shows a cross-sectional view of a tray portion of FIG. 55 taken along line 58;

FIG. 59 shows a cross-sectional view of a web material constructed according to the present invention;

FIG. 60 shows a perspective view of a tray constructed according to the present invention;

FIG. 61 shows a cross-sectional view of a tray portion of FIG. 60 taken along line 61;

FIG. 62 shows a perspective view of stacked trays constructed according to the present invention;

FIG. 63 shows a cross-sectional view of the stacked trays of FIG. 62;

FIG. 64 shows a perspective view of a finished package constructed according to the present invention;

FIG. 65 shows a perspective view of a tray with flaps constructed according to the present invention;

FIG. 66 shows a schematic view of a tray portion including a flap constructed according to the present invention;

FIG. 67 shows a cross-sectional view of a tray portion of FIG. 65 taken along line 67;

FIG. 68 shows a cross-sectional view of a tray portion of FIG. 65 taken along line 68;

FIG. 69 shows a detailed view of FIG. 68;

FIG. 70 shows a cross-sectional view of a tray portion including a flap constructed according to the present invention;

FIG. 71 shows a cross-sectional view of a web material constructed according to the present invention;

FIG. 72 shows a cross-sectional view of a detailed tray portion of FIG. 70;

FIG. 73 shows a cross-sectional view of a finished package with a peelable label constructed to the present invention;

FIG. 74 shows a perspective view of the package with label of FIG. 73;

FIG. 75 shows a cross-sectional view of a finished package with over wrap web material constructed according to the present invention;

FIG. 76 shows a perspective view of the finished package of FIG. 75;

FIG. 77 shows a cross-sectional view of the finished package of FIG. 76 with the over wrap in its loose state;

FIG. 78 shows a cross-sectional view of the finished package of FIG. 76 with the over wrap in a stretched state;

FIG. 79 shows a cross-sectional view of a master container containing finished packages, the master container being enclosed within a cardboard box, constructed according to the present invention;

FIG. 80 shows a portion of the master container of FIG. 79;

FIG. 81 shows a portion of the master container of FIG. 79;

FIG. 82 shows a perspective view of a tray with flaps constructed according to the present invention;

FIG. 83 shows a cross-sectional view of the tray of FIG. 82 taken along line 83;

FIG. 84 shows a pair of tray pre-forms with ribs that are arranged to provide enclosed pressure vessels after sealing;

FIG. 85 shows a side elevation of a packaging tray that has been manufactured from a pair of pre-forms shown in FIG. 84;

FIG. 86 shows a cross-sectional view of a tray portion of FIG. 85 taken along line 86;

FIG. 87 shows a cross-sectional view of the tray portion of FIG. 86 taken along line 87;

FIG. 88 shows a three dimensional view of a complete packaging tray comprising a base 303 with four upwardly extending side walls terminating at a continuous flange 901 that follows a path at a perimeter of the packaging tray and surround a cavity 110;

FIG. 89 shows a cross sectional view through the packaging tray shown in FIG. 88;

FIG. 90 shows a plan view of a thermoformed pre-form that can be fabricated by folding and bonding to form a packaging tray as shown in FIG. 88;

FIG. 91 shows a cross-sectional view of a tray portion of FIG. 89;

FIG. 92A shows a plan view of a thermoformed pre-form that can be fabricated by folding and bonding flaps 10, 11, 13, 16, 14, and 15 to form a packaging tray with cavity 12 as shown in FIGS. 95 and 96;

FIG. 92B shows a cross sectional view of a tray flap of FIG. 92A.

FIG. 93 shows two thermoformed and fabricated packaging trays 20 and 21, that are nested and stacked together to provide a stack of trays;

FIG. 94 shows a cross section through an apparatus that is arranged to seal flaps (such as 10, 11, 13, 16, 14, and 15 shown in FIG. 92) to the walls of a packaging tray (such as shown in FIG. 92) to produce trays such as 40 and 41 shown in FIG. 95;

FIG. 95 shows a side elevation of two packaging trays that are stacked after flaps, such as 10, 11, 13, 16, 14, and 15 shown in FIG. 92 have been sealed to walls of the tray;

FIG. 96 shows an end view of two packaging trays that are stacked after flaps, such as 10, 11, 13, 16, 14, and 15 shown in FIG. 92 have been sealed to the corresponding walls of the tray;

FIG. 97 shows a three dimensional view of a packaging tray 60 with ribs 62, 63, 65 and 66 formed into the profile of flaps and walls of the packaging tray;

FIG. 98 shows a cross-sectional view of tray 60 in FIG. 6 taken along line 2;

FIG. 99 shows a perspective view of a tray according to the present invention;

FIG. 100 shows a cross-sectional view of a tray portion of FIG. 99 taken along line 100;

FIG. 101 shows a cross-sectional view through a segment of a preferred packaging tray embodiment;

FIG. 102 shows a cross-sectional view of a tray portion of FIG. 101 taken along line 102;

FIG. 103 shows details of the components used to manufacture a composite tray;

FIG. 104 shows a plan view of a web material to construct a tray according to the present invention;

FIG. 105 shows a cross section through an apparatus with housing 12, and a tapering screw 15 mounted therein; a piston 16, with corresponding cylinder 25, is mounted to housing 12 and a restricting conduit 18 is attached to the exit end of housing 12, grinds 20 can be transferred into said housing 12 and screw 15 may be used for pumping said grinds into a profiled conduit thereby providing an extruded stream of grinds for subsequent slicing and thereby production of patties;

FIG. 106 shows a cross section through an apparatus intended for use in slicing extruded streams of ground meats to produce patties, a temperature controlled conduit 45 is mounted adjacent to a revolving blade 47, such that stacks of sliced patties 51 and 52 can be produced and transported to a packaging station via conveyor belting 50 that is driven intermittently by drive roller 49 in direction shown by arrow 52;

FIG. 107 shows a cross-sectional view of an apparatus portion of FIG. 105 taken along line 107;

FIG. 108 shows a side elevation of an apparatus assembled to produce fine ground boneless beef 77, from coarse ground boneless beef 61, after fine grinding into vessel 70 from grinder 65, ground beef 77 is pumped, in the direction shown by arrow 74, via servo driven positive displacement pump 71, through conduit 73 which can be connected directly to conduit 9, shown in FIG. 1. Conduit connections 66 and 78 are provided to allow injection of gas such as CO₂ there through and conduit connection 79 is provided to allow gases to be withdrawn from vessel 70;

FIG. 109 shows a side elevation, cross sectional view of an apparatus that is arranged to automatically measure and slice portions of meat primals that have been molded to a predetermined profile corresponding with a temperature controlled conduit 81 of similar profile, pre-conditioned and tempered primal cuts of boneless meat 87 are located in an entry end of conduit 81 followed by a plug such as 82, electromagnetic driving fixtures 83 are arranged to intermittently drive and by magnetic bonding to each plug, carry plugs such as 81, in a forward direction and a distance equal to the selected thickness of a single slice of beef, blade 92 is controlled to intermittently slice during a single revolution shaft 91, conveyor 94 is mounted in an enclosure 98, and adjacent to the exit end of conduit 81, so as to conveniently carry slices to a further processing or packing station;

FIG. 110 shows a cross-sectional view of an apparatus portion of FIG. 109 taken along line 110;

FIG. 111 shows a cross-sectional view of an apparatus portion of FIG. 109 taken along line 111;

FIG. 112 shows a cross-sectional view of a finished package constructed according to the present invention;

FIG. 113 shows a perspective view of a finished package constructed according to the present invention;

FIG. 114 shows a perspective view of a tray with flaps constructed according to the present invention;

FIG. 115 shows a cross-sectional view of a tray portion including flaps of FIG. 114;

FIG. 116 shows a cross-sectional view of a tray constructed according to the present invention;

FIG. 117 shows a perspective view of a tray with a flap constructed according to the present invention;

FIG. 118 shows a cross-sectional view of packages stacked atop one another, constructed according to the present invention;

FIG. 119 shows a top plan view of a tray constructed according to the present invention;

FIG. 120 shows a cross-sectional view of a tray portion of FIG. 119;

FIG. 121 shows a cross-sectional view of a tray portion of FIG. 119;

FIG. 122 shows a cross-sectional view of a plurality of stacked trays with flaps, constructed according to the present invention;

FIG. 123 shows a cross-sectional view of a tray with a flap constructed according to the present invention;

FIG. 124 shows a cross-sectional view of a finished package constructed according to the present invention;

FIG. 125 shows a cross-sectional view of a master container containing finished packages constructed according to the present invention;

FIG. 126 shows a perspective view of a tray portion constructed according to the present invention;

FIG. 127 shows a cross-sectional view of a tray portion of FIG. 126;

FIG. 128 shows a cross-sectional view of stacked trays in a master container constructed according to the present invention;

FIG. 129 shows a cross-sectional view of a finished package with a flap constructed according to the present invention;

FIG. 130 shows a cross-sectional view of a tray with flap constructed according to the present invention;

FIG. 131 shows a top plan view of a tray portion with flap constructed according to the present invention;

FIG. 132 shows a side plan view of a tray portion of FIG. 131;

FIG. 133 shows a side plan view of stacked trays according to the present invention;

FIG. 134 shows a top plan view of a tray portion with flaps constructed according to the present invention;

FIG. 135 shows a perspective view of a tray portion with the flaps folded down according to the present invention;

FIG. 136 shows a cross-sectional view of a tray portion of FIG. 135 taken along line 136;

FIG. 137 shows a cross-sectional view of a tray with flaps constructed according to the present invention;

FIG. 138 shows a cross-sectional view of a tray with flaps containing iron particles constructed according to the present invention;

FIG. 139 shows a cross-sectional view of a tray portion of FIG. 138;

FIG. 140 shows a schematic view of an apparatus for applying iron particles according to the present invention;

FIG. 141 shows a cross-sectional view of an apparatus portion of FIG. 140;

FIG. 142 shows a cross-sectional detailed view of an apparatus portion of FIG. 141;

FIG. 143 shows a schematic view of an apparatus for applying iron particles according to the present invention;

FIG. 144 shows a top plan view of a web material containing iron particles according to the present invention;

FIG. 145 shows a cross-sectional view of the web of FIG. 144 taken along line 145;

FIG. 146 shows a schematic view of an apparatus for packaging and forming holes in web materials according to the present invention;

FIG. 147 shows a side plan view of a tray formed by the apparatus of FIG. 146;

FIG. 148 shows a schematic view of a master container sealing apparatus according to the present invention;

FIG. 149 shows a perspective view of an apparatus portion of FIG. 148;

FIG. 150 shows a cross-sectional view of an apparatus portion of FIG. 149 taken along line 150;

FIG. 151 shows a schematic view of a packaging, labeling, and weighing apparatus according to the present invention;

FIG. 152 shows a top plan view of the apparatus of FIG. 151;

FIG. 153 shows a top plan view of a register formed according to the present invention;

FIG. 154 shows a cross-sectional view of a vacuum chamber constructed according to the present invention;

FIG. 155 shows a cross-sectional view of an apparatus portion according to the present invention;

FIG. 156 shows a cross-sectional view of a vacuum chamber constructed according to the present invention;

FIG. 157 shows a cross-sectional view of a tray with flaps according to the present invention;

FIG. 158 shows a cross-sectional view of a tray portion with flap of FIG. 157;

FIG. 159 shows a cross-sectional view of a sealing plate constructed according to the present invention;

FIG. 160 shows a top plan view of a sealing plate according to the present invention;

FIG. 161 shows a top plan view of a sealing plate according to the present invention;

FIG. 162 shows a cross-sectional view of the sealing plate of FIG. 161 taken along line 162;

FIG. 163 shows a cross-sectional view of a finished package constructed according to the present invention;

FIG. 164 shows a cross-sectional view of a tray located in a sealing plate according to the present invention;

FIG. 165 shows a top plan view of a sealing plate according to the present invention;

FIG. 166 shows a schematic view of tray walls being bonded when located in the sealing plate according to the present invention;

FIG. 167 shows a cross-sectional view of a vacuum chamber constructed according to the present invention;

FIG. 168 shows a schematic view of an apparatus for loading and sealing trays according to the present invention;

FIG. 169 shows a schematic view of an apparatus for forming a laminated web according to the present invention;

FIG. 170 shows a schematic view for an apparatus for packaging trays using a laminated web according to the present invention;

FIG. 171 shows a cross-sectional view of a web material according to the present invention;

FIG. 172 shows a schematic view of a packaging and sealing apparatus constructed according to the present invention;

FIG. 173 shows a cross-sectional view of a tray with a laminated web;

FIG. 174 shows a cross-sectional view of a tray with a single web;

FIG. 175 shows a schematic view of an apparatus for forming master containers according to the present invention;

FIG. 176 shows a cross-sectional view of the apparatus of FIG. 175 taken along line 176;

FIG. 177 shows a cross-sectional view of an apparatus portion of FIG. 175 taken along line 177;

FIG. 178 shows a cross-sectional view of an apparatus portion of FIG. 176;

FIG. 179 shows a finished package enclosed within a master container;

FIG. 180 shows an apparatus for grinding and processing meat constructed according to the present invention;

FIG. 181 shows an apparatus for grinding and processing meat constructed according to the present invention;

FIG. 182 shows a cross-sectional view of an apparatus portion of FIG. 181;

FIG. 183 shows a cross-sectional view of an apparatus portion of FIG. 181;

FIG. 184 shows a front plan view of a manifold constructed according to the present invention;

FIG. 185 shows a side plan view of the manifold of FIG. 184;

FIG. 186 shows a cross-sectional view of an apparatus for grinding and processing meat according to the present invention;

FIG. 187 shows a cross-sectional view of an apparatus for processing meat constructed according to the present invention;

FIG. 188 shows a side plan view of an apparatus portion of FIG. 187;

FIG. 189 shows a cross-sectional view of an apparatus portion of FIG. 188 taken along line 189;

FIG. 190 shows a cross-sectional view of an apparatus portion of FIG. 187 taken along line 190;

FIG. 191 shows a top plan view of a tube structure according to the present invention;

FIG. 192 shows a cross-sectional view of an apparatus portion having three meat processing tubes, constructed according to the present invention;

FIG. 193 shows a cross-sectional view of an apparatus for grinding and processing meat;

FIG. 194 shows a cross-sectional view of an apparatus portion of FIG. 187;

FIG. 195 shows a cross-sectional view of a measuring device constructed according to the present invention;

FIG. 196 shows a top plan view of a packaging and slicing apparatus having a tunnel, constructed according to the present invention;

FIG. 197 shows a cross-sectional view of the apparatus of FIG. 196 taken along line 197;

FIG. 198 shows a schematic view of a meat processing apparatus constructed according to the present invention;

FIG. 199 shows a schematic view of a meat processing and packaging apparatus constructed according to the present invention;

FIG. 200 shows a schematic view of a meat processing and packaging apparatus constructed according to the present invention;

FIG. 201 shows a schematic view of a meat processing and packaging apparatus constructed according to the present invention;

FIG. 202 shows a cross-sectional view of a web material constructed according to the present invention;

FIG. 203 shows a perspective view of an over wrapping web material constructed according to the present invention;

FIG. 204 shows a perspective view of an over wrapped package constructed according to the present invention;

FIG. 205 shows a schematic view of an apparatus portion constructed according to the present invention;

FIG. 206 shows a top plan view of an apparatus portion constructed according to the present invention;

FIG. 207 shows a cross-sectional view of a meat blending apparatus constructed according to the present invention;

FIG. 208 shows a cross-sectional view of the meat blending apparatus of FIG. 207 taken along line 208;

FIG. 209 shows a schematic view of a meat processing and conditioning apparatus constructed according to the present invention;

FIG. 210 shows a cross-sectional view of a meat forming and shaping apparatus constructed according to the present invention;

FIG. 211 shows a side plan view of an apparatus portion of FIG. 210;

FIG. 212 shows a perspective view of a meat forming and shaping apparatus constructed according to the present invention;

FIG. 213 shows a schematic view of a master container sealing apparatus constructed according to the present invention;

FIG. 214 shows a cross-sectional view of the apparatus of FIG. 212;

FIG. 215 shows a cross-sectional view of a meat forming and shaping apparatus constructed according to the present invention;

FIG. 216 shows a side plan view of an apparatus portion of FIG. 215;

FIG. 217 shows a cross-sectional view of a forming and shaping apparatus for several primals, constructed according to the present invention;

FIG. 218 shows a cross-sectional view of an apparatus portion of FIG. 216;

FIG. 219 shows a cross-sectional view of an apparatus portion of FIG. 218;

FIG. 220 shows a cross-sectional view of an apparatus portion for forming and shaping meat primals constructed according to the present invention;

FIG. 221 shows a cross-sectional view of an apparatus portion for shaping and forming meat primals constructed according to the present invention;

FIG. 222 shows a schematic view of an equipment layout constructed according to the present invention;

FIG. 223 shows a cross-sectional view of a master container vacuum chamber constructed according to the present invention;

FIG. 224 shows a schematic view of an equipment layout constructed according to the present invention;

FIG. 225 shows a cross-sectional view of a tube apparatus of FIG. 224 taken along line 225;

FIG. 226 shows a perspective view of a spool for storing web material constructed according to the present invention;

FIG. 227 shows a schematic view of a thermoforming oven of FIG. 224 taken along line 227;

FIG. 228 shows a schematic view of equipment layout constructed according to the present invention;

FIG. 229 shows a cross-sectional view of a web material constructed according to the present invention;

FIG. 230 shows a cross-sectional view of a web material constructed according to the present invention;

FIG. 231 shows a detailed view of web material constructed according to the present invention;

FIG. 232 shows a detailed view of web material constructed according to the present invention;

FIG. 233 shows a detailed view of web material constructed according to the present invention;

FIG. 234 shows a detailed view of web material constructed according to the present invention;

FIG. 235 shows a detailed view of web material constructed according to the present invention;

FIG. 236 shows a detailed view of web material constructed according to the present invention;

FIG. 237 shows a detailed view of web material constructed according to the present invention;

FIG. 238 shows a perspective view of a tray treatment apparatus constructed according to the present invention;

FIG. 239 shows a perspective view of a tray treatment apparatus constructed according to the present invention;

FIG. 240 shows a cross-sectional view of a tray forming apparatus constructed according to the present invention;

FIG. 241 shows a cross-sectional view of a tray forming apparatus constructed according to the present invention;

FIG. 242 shows a cross-sectional view of web material constructed according to the present invention;

FIG. 243 shows a cross-sectional view of web material constructed according to the present invention;

FIG. 244 shows a cross-sectional view of a web material constructed according to the present invention;

FIG. 245 shows a cross-sectional view of a web material constructed according to the present invention;

FIG. 246 shows a cross-sectional view of a web material constructed according to the present invention;

FIG. 247 shows a cross-sectional view of formed web material constructed according to the present invention;

FIG. 248 shows a cross-sectional view of formed web material constructed according to the present invention;

FIG. 249 shows a cross-sectional view of a web material constructed according to the present invention;

FIG. 250 shows a cross-sectional view of a web material constructed according to the present invention;

FIG. 251 shows a perspective view of a tray portion with ribs constructed according to the present invention;

FIG. 252 shows a cross-sectional view of formed web material constructed according to the present invention;

FIG. 253 shows a cross-sectional view of formed web material constructed according to the present invention;

FIG. 254 shows a cross-sectional view of a web forming apparatus constructed according to the present invention;

FIG. 255 shows a cross-sectional view of a web forming apparatus constructed according to the present invention;

FIG. 256 shows a cross-sectional view of a web material constructed according to the present invention;

FIG. 257 shows a cross-sectional view of a web aperture forming apparatus constructed according to the present invention;

FIG. 258 shows a cross-sectional view of a web forming apparatus constructed according to the present invention;

FIG. 259 shows a top plan view of an apparatus portion of FIG. 258;

FIG. 260 shows a cross-sectional view of a formed web material constructed according to the present invention;

FIG. 261 shows a cross-sectional view of a pressure chamber for removing oxygen from the cell structure of EPS foam constructed according to the present invention;

FIG. 262 shows a cross-sectional view of an apparatus for removing oxygen within the cell structure of EPS foam constructed according to the present invention;

FIG. 263 shows a perspective view of an apparatus portion of FIG. 261;

FIG. 264 shows a front plan view of the apparatus of FIG. 262;

FIG. 265 shows a schematic view of an apparatus with vacuum tubes constructed according to the present invention;

FIG. 266 shows a schematic view of equipment layout constructed according to the present invention;

FIG. 267 shows a schematic view of equipment layout constructed according to the present invention;

FIG. 268 shows a tray with flaps having crests and indentations constructed according to the present invention;

FIG. 269 shows a perspective view of the tray of FIG. 268 with the flaps opened upward;

FIG. 270 shows a side plan view of stacked trays of FIG. 268 showing a space between the crest and a flap indentation;

FIG. 271 shows a perspective view of a tray with flaps constructed according to the present invention;

FIG. 272 shows a perspective view of the tray of FIG. 271 with the flaps folded downward;

FIG. 273 shows a cross-sectional view of a tray portion with substances located within a flap space constructed according to the present invention;

FIG. 274 shows a cross-sectional view of a tray with flaps having flap spaces;

FIG. 275 shows a schematic representation of an apparatus for processing fresh meat such as ground beef;

FIG. 276 shows a schematic representation of a cross section through a conveyor and packaging tray with goods;

FIG. 277 shows a perspective view of a tray with flaps constructed according the present invention;

FIG. 278 shows a cross section of the tray of FIG. 277 through a wall after the corresponding flap has been folded inwardly;

FIG. 279 shows a perspective view of a mold comprising an extruded tube of any suitable cross sectional profile having parallel sides with end plugs that are arranged to fit within the extruded tube so as to slide readily in a gas tight manner;

FIG. 280 shows the profile of this particular extruded molding tube with meat portion loaded therein;

FIG. 281 shows a detail of a section of the assembled and loaded extruded tube with an end plug in position;

FIG. 282 shows a view of a pre-form web that can be either thermoformed or injection molded from any suitable plastics material such as polypropylene;

FIG. 283 shows a cross sectional view of the pre-form of FIG. 282;

FIG. 284 shows a cross sectional view of a finished package using the pre-form of FIG. 282;

FIG. 285 shows a perspective view of a pre-form web with corrugated corners constructed according to the present invention;

FIG. 286 shows a perspective view of a portion of a finished tray constructed from the pre-form web of FIG. 285;

FIG. 287 shows a schematic illustration of a representative portion of the Internet for transacting commerce according to the present invention;

FIG. 288 shows a block diagram of the several components of a seller server shown in FIG. 287 that is used to store a database and control program for servicing buyers;

FIG. 289 shows a block diagram of the several components of a buyer computer shown in FIG. 285 that are used to store and implement certain portions of the database and control program;

FIG. 290 shows a block diagram of a method of transacting commerce over a communications system according to the present invention;

FIG. 291 shows a schematic illustration of an embodiment of a plant layout according to the present invention;

FIG. 292 shows a schematic illustration of an embodiment of a tray packaging layout according to the present invention;

FIG. 293 shows a schematic illustration of an embodiment of tray treatment and finishing equipment according to the present invention;

FIG. 294 shows a perspective view of a tray portion with flaps having the flap ends contoured to fold overlapping the tray corners;

FIG. 295 shows a perspective view of the tray portion of FIG. 294 with the flap ends bonded to the tray corners;

FIG. 296 shows a schematic illustration of an embodiment of a plant layout according to the present invention;

FIG. 297 shows a schematic illustration of a section of the plant for packaging trays with meat products;

FIG. 298 shows a sectional view of the tray de-nesting apparatus portion of FIG. 297 before the flap ends have been bonded to the tray walls;

FIG. 299 shows a schematic illustration of an embodiment of an apparatus for forming webs according to the present invention; and

FIG. 300 shows a schematic illustration of the web material of FIG. 299.

### DETAILED DESCRIPTION OF THE PREFERRED EMBODIMENT

As used herein, the following terms take the following meanings, unless otherwise indicated.

The term “case ready” refers to retail packaged fresh meats (that were typically formerly prepared at the supermarket) that has been packaged ready for retail sale from the meat case at a place of production remote from the supermarket.

The term “high oxygen modified atmosphere” refers to a blend of gases that includes some or all of the naturally occurring atmospheric gases but in proportions that are different to air and including a high level of oxygen which may be greater than 40%. Such an example would be a gas comprising 80% oxygen and 20% carbon dioxide, however in virtually all applications a residual quantity of nitrogen remains in the sealed “high oxygen modified atmosphere” package.

The term “low oxygen” or “no oxygen” modified atmosphere” refers to a blend of gases that includes some or all of the naturally occurring atmospheric gases (except oxygen) but in proportions that are different to air and including a low (or zero level of oxygen) which may be less than 300-500 parts per million.

The term “MAP” refers to modified atmosphere packaging.

The term “CAP” refers to controlled atmosphere packaging.

The term “Epsilon GMS-40” or “GMS-40” refers to an apparatus that can be used to measure the fat and/or lean content of pumpable ground meats. The GMS-40 is manufactured and supplied by Epsilon Industries, of Austin, Tex. Additional information is available on web site: www.epsilon-gms.com.

The term “AVS-ET system” refers to a system that can be used to identify the composition of boneless meats. The system can identify quantities of fat, muscle/lean tissue, contaminants, bone, metal inclusions and other matter that is transferred, in a continuous stream, through a conduit and into and then away from the AVS-ET system. The system operates preferably when the continuous stream is exclusive of any voids such as pockets of air. The system is manufactured and supplied by Holmes Newman Associates, 4221 Fallsbrae Road, of Fallbrook, Calif. 92028.

The term “statiflo blending devices” refers to a continuous, static and enclosed material blending device that can introduce gases such as CO₂ to the blended material. STATIFLO is a registered trademark of Statiflo International, The Crown Center, Bond Street, Macclesfield, Cheshire SK116QS, UK. Information is available on web site: sales@statiflo.co.uk.

The term “blending devices” refers to a continuous, static and enclosed material blending device that can be used to continuously blend such perishable goods as ground meats that comprise substantially two components of fat and lean meat and may also be used to introduce gases such as CO₂ to the blended materials.

The term “shelf life” refers to the period of time between the date of retail packaging of perishable goods (that are slowly deteriorating) of acceptable quality and a subsequent point in time or date, prior to the perishable goods having deteriorated to an unacceptable condition.

The term “PP” refers to polypropylene.

The term “EPS” refers to expanded polystyrene.

The term “pPVC” refers to plasticized polyvinylchloride.

The term “PET,” polyester or “APET” refers to amorphous polyethylene terephthalate.

The term “heat activated adhesives (or coating)” refers to adhesives that become active and capable of bonding substances together when heated to a suitable temperature that otherwise, at ambient temperature, will not bond.

The term “OTR” refers to oxygen transmission rate.

The term “perishable goods” or “goods” refers to any perishable foods such as sliced beef or other fresh meats, ground meats, poultry pieces etc.

The term “liquids and oils” refers to water, liquids, blood, purge, liquid animal fats and oils and the like.

The term “master container” generally refers to a substantially gas barrier container that can be filled with finished packages, evacuated of substantially all atmospheric air and filled with any suitable gas. However, said “master container” may also be gas permeable if so desired.

The terms “suitable substance”, “suitable gas” or “suitable gases” refer to any gas or blend of gasses, provided at any pressure (suitable pressure) such as 45% oxygen and 55% carbon dioxide at ambient pressure or any other blend of gases. A suitable gas may include a blend of carbon dioxide and nitrogen and oxygen with residual atmospheric gases in any relative proportions. Examples are provided, but are not restricted to any of the following:

1. A blend of gases including argon, carbon dioxide, nitrogen and a quantity of oxygen that does not exceed 5% and is not less than 5 PPM (parts per million).

2. Air that has been filtered to remove substantially all oxygen therefrom.

3. Carbon dioxide and nitrogen in any relative proportions.

4. Carbon dioxide and oxygen where oxygen does not exceed 5% and is not less than 5 PPM.

5. Carbon dioxide and a quantity of oxygen that does not exceed 5% and is not less than 5 PPM (parts per million).

6. Nitrogen and a quantity of oxygen that does not exceed 5% and is not less than 5 PPM (parts per million).

7. A blend of inert gasses and a quantity of oxygen that does not exceed 5% and is not less than 5 PPM (parts per million).

8. A blend of pentane and nitrogen in any relative proportions and a quantity of oxygen that does not exceed 5% and is not less than 5 PPM (parts per million).

9. A blend of propane and nitrogen in any relative proportions and a quantity of oxygen that does not exceed 5% and is not less than 5 PPM (parts per million).

10. A blend of butane and nitrogen in any relative proportions and a quantity of oxygen that does not exceed 5% and is not less than 5 PPM (parts per million).

11. A blend of a CFC and nitrogen in any relative proportions and a quantity of oxygen that does not exceed 5% and is not less than 5 PPM (parts per million).

12. A blend of an HCFC and nitrogen in any relative proportions and a quantity of oxygen that does not exceed 5% and is not less than 5 PPM (parts per million).

13. A blend of methane and nitrogen in any relative proportions and a quantity of oxygen that does not exceed 5% and is not less than 5 PPM (parts per million).

14. A blend of hydrogen sulfide and nitrogen in any relative proportions and a quantity of oxygen that does not exceed 5% and is not less than 5 PPM (parts per million).

15. A blend of carbon monoxide and nitrogen in any relative proportions and a quantity of oxygen that does not exceed 5% and is not less than 5 PPM (parts per million).

16. A blend of sulfur dioxide and nitrogen in any relative proportions and a quantity of oxygen that does not exceed 5% and is not less than 5 PPM (parts per million).

17. A gas including 100% carbon dioxide

18. A substance or agent including one or more of the following: isoascorbic acid, ascorbic acid, citric acid, erythorbic acid, lactic acid, succinic acid or mixtures of salts thereof. Glycerol monolaurate, potassium sorbate, sodium sorbate, sodium iodoacetate, potassium acetate, iodoacetomide, potassium iodoacetate, sodium acetate or mixtures or acidic solutions thereof.

The term “suitable gas pressure” or “water pressure” refers to any pressure that is suitable for the application and may be controlled within any of the following pressure ranges, or any other suitable pressure:

Suitable gas pressure:

gas at a pressure of 1 PSI to 14 PSI.

gas at a pressure of up to 3 PSI.

gas at a pressure of 13 PSI to 50 PSI.

gas at a pressure of 50 PSI to 80 PSI.

gas at a pressure of 80 PSI to 120 PSI.

gas at a pressure of 120 PSI to 200 PSI.

gas at a pressure of 200 PSI to 500 PSI.

gas at a pressure above 500 PSI.

Suitable water pressure:

water at a pressure of 1 PSI to 14 PSI.

water at a pressure of up to 13 PSI.

water at a pressure of 13 PSI to 50 PSI.

water at a pressure of 50 PSI to 80 PSI.

water at a pressure of 80 PSI to 120 PSI.

water at a pressure of 120 PSI to 200 PSI.

water at a pressure of 200 PSI to 500 PSI.

water at a pressure above 500 PSI.

The term “suitable gas temperature” or “suitable water temperature” refers to any temperature that is suitable for the application and may be controlled within any suitable temperature ranges for any suitable period of time, or at any other suitable temperature. Suitable temperature also includes a temperature range which may be a pasteurizing temperature range such as maintaining a product such as a beef primal within a temperature range of not less than 138.5 degrees F. to 140 degrees F. and for a suitable period of time.

Bond or Bonding refers to sealing or welding of two or more surfaces together by any suitable means such as with any suitable adhesive, RF welding, ultrasonic welding heat sealing, or any other suitable means.

Hermetic seal refers to a seal or bonding of two or more surfaces of any suitable material together by any suitable means to provide an enclosed space and wherein said enclosed space is rendered fully enclosed in such a manner that will substantially inhibit the passage or communication of any substance such as gas, air or liquids from within said enclosed space to and with the exterior of said enclosed space.

Pre-Form refers to a thermoformed or suitably fabricated packaging component that has been arranged with one or more hinged flaps that can be folded or bonded to produce a useful packaging tray or container for goods. Pre-forms may also comprise more than one component that are subsequently assembled together to provide one or more components but where the number of items remaining after assembly are less than the number of components from which the remaining items are produced.

“Valve” refers to any suitable valve to suit the particular needs of the disclosed application. Valves may be arranged to control the flow of gas, liquid, or solids such as powders and can be selected from manufacturers skilled in the arts of valve manufacturing of any particular valve from any suitable materials.

“CPU” refers to a central processing unit or any suitable computer processor suitable for the application such as are contained in most personal computers (PC).

“HHRCD” refers to a hand held remote controlling device such as a PALM PILOT®.

“Fat” content is a component of meat and may mean the measured fat content of a quantity of boneless meat harvested from any species of slaughtered animal such as beef.

“Meat” can mean any meat harvested from any species of slaughtered animal wherein the meat comprises several components but generally including water, fat, oils, and protein in relative quantities that are not precisely known at the time of harvesting and must be measured to determine the precise ratio of each component.

Trays with Peelable Lids

In accordance with the present invention, trays having peelable lids are disclosed herein. Perishable goods packaged in trays with peelable lids have extended shelf life. A peelable lid provides a method of delaying the exposure of fresh meat contained within a package to ambient air at a predetermined period, preferably at the point of sale.

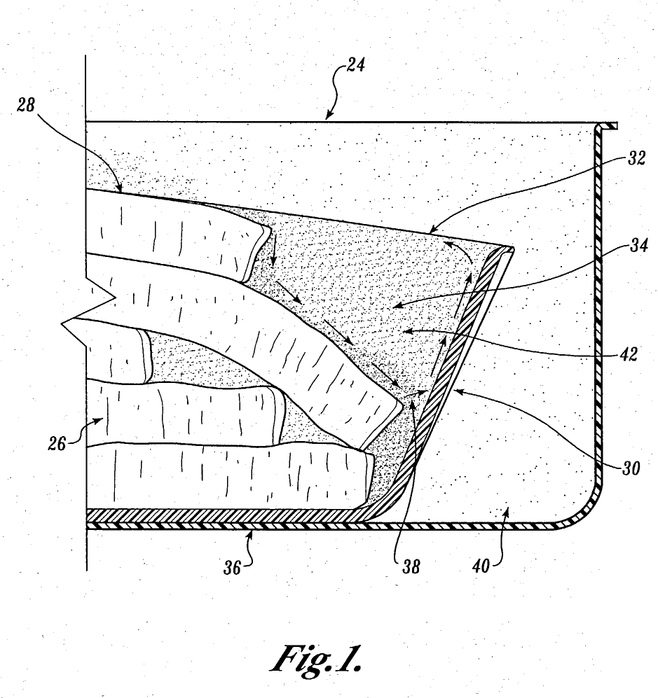

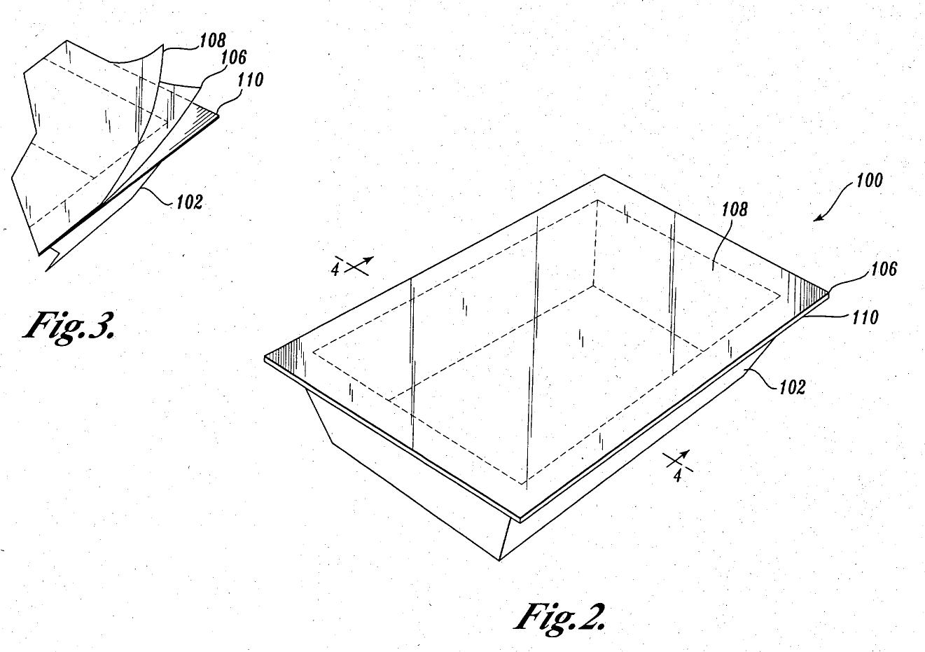

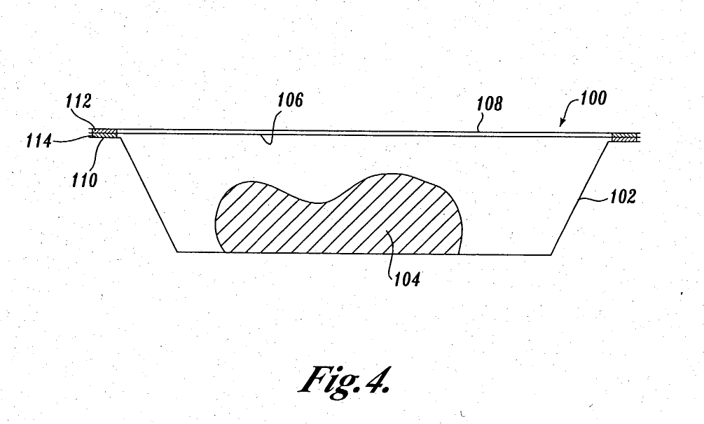

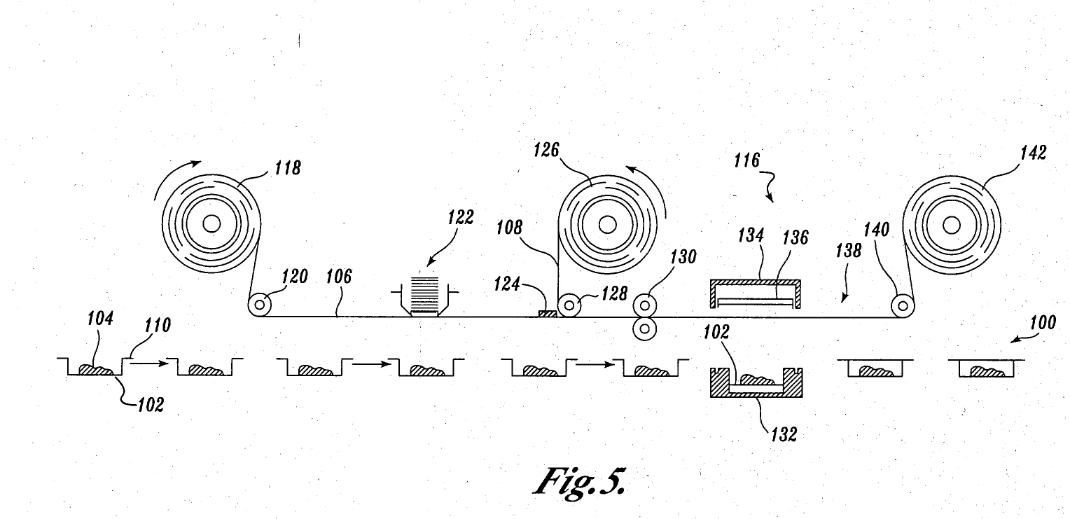

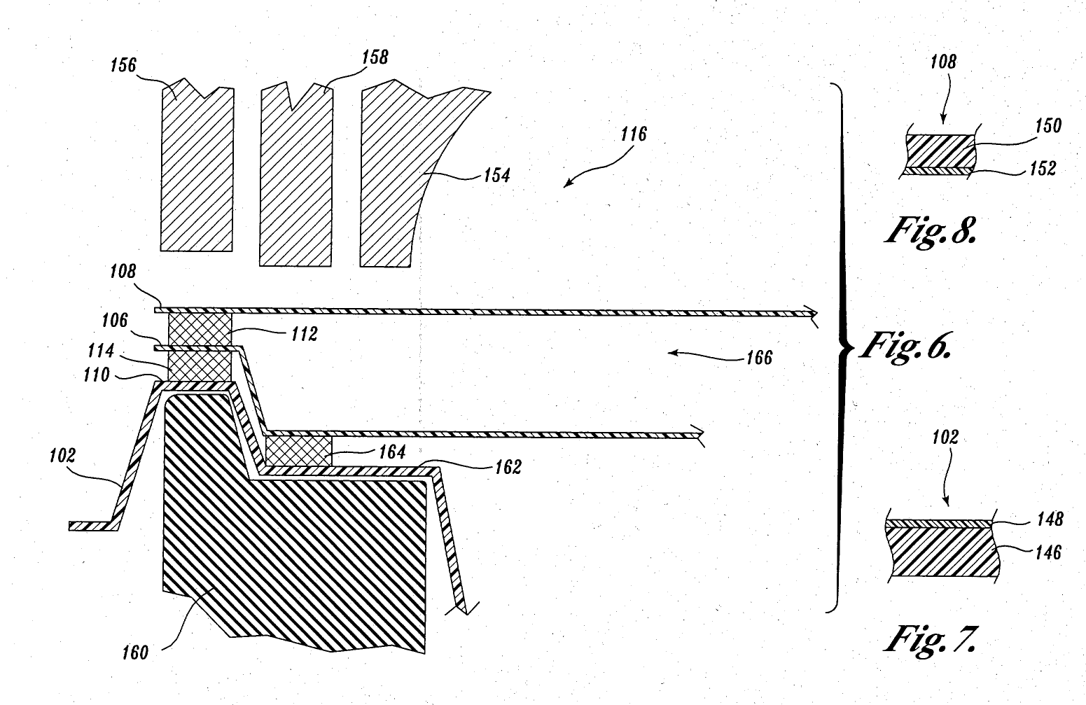

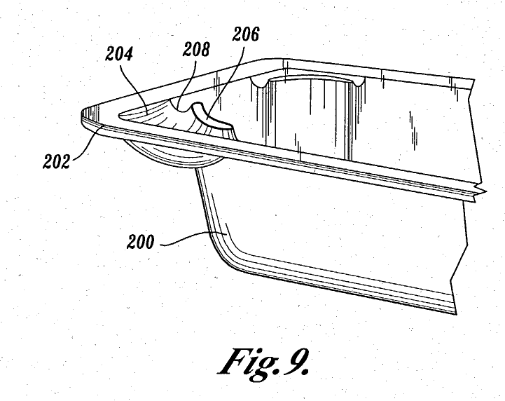

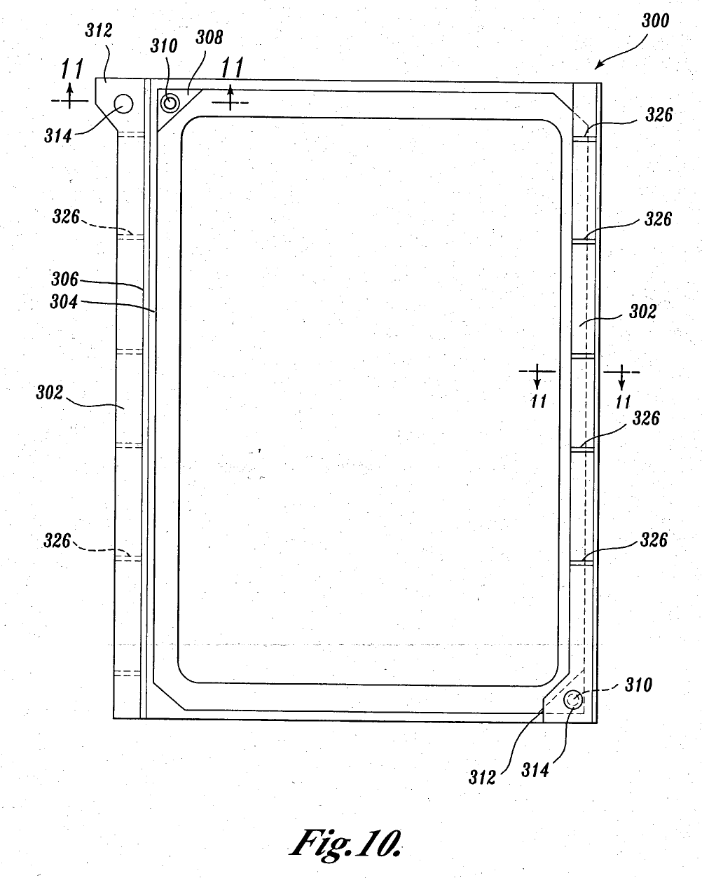

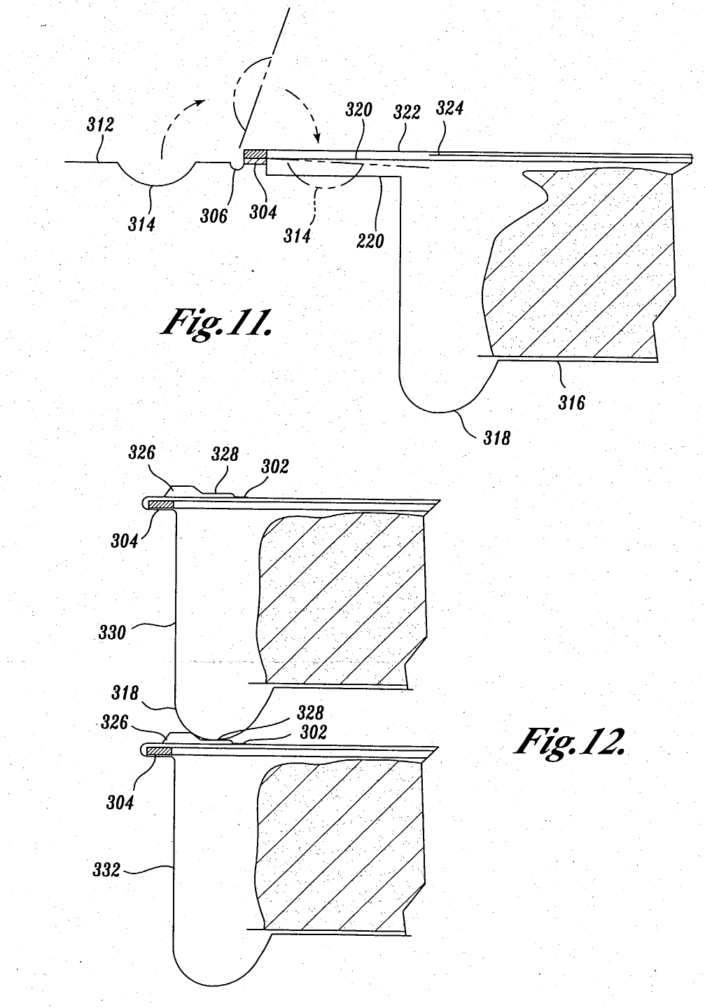

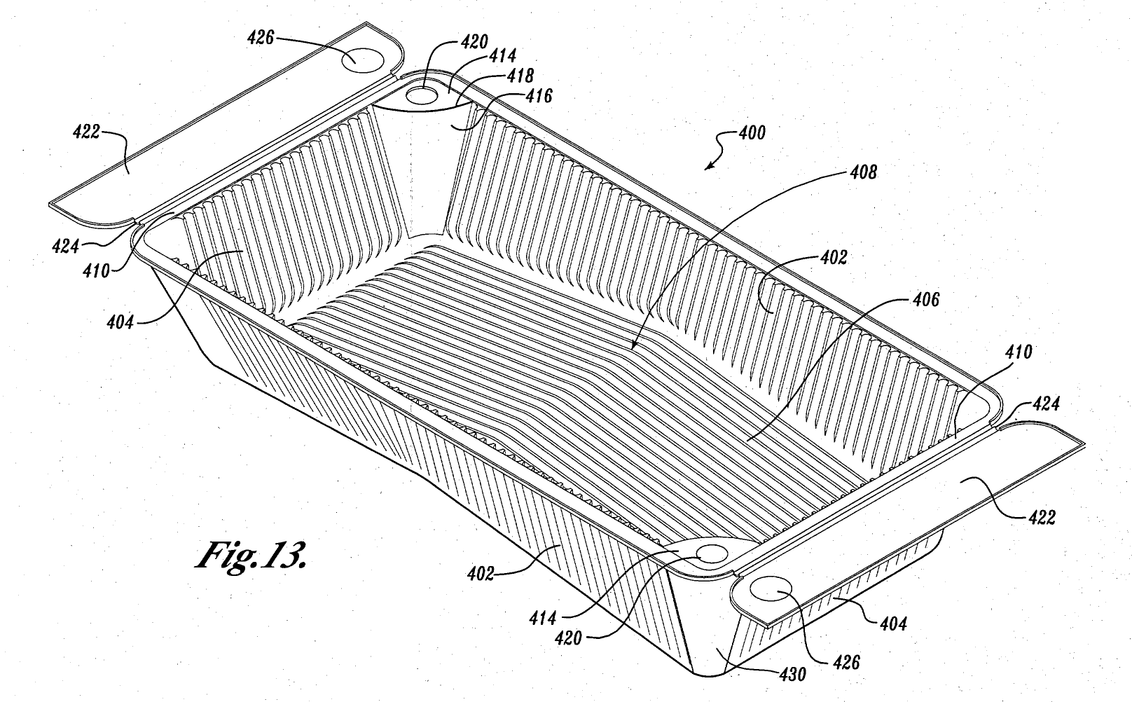

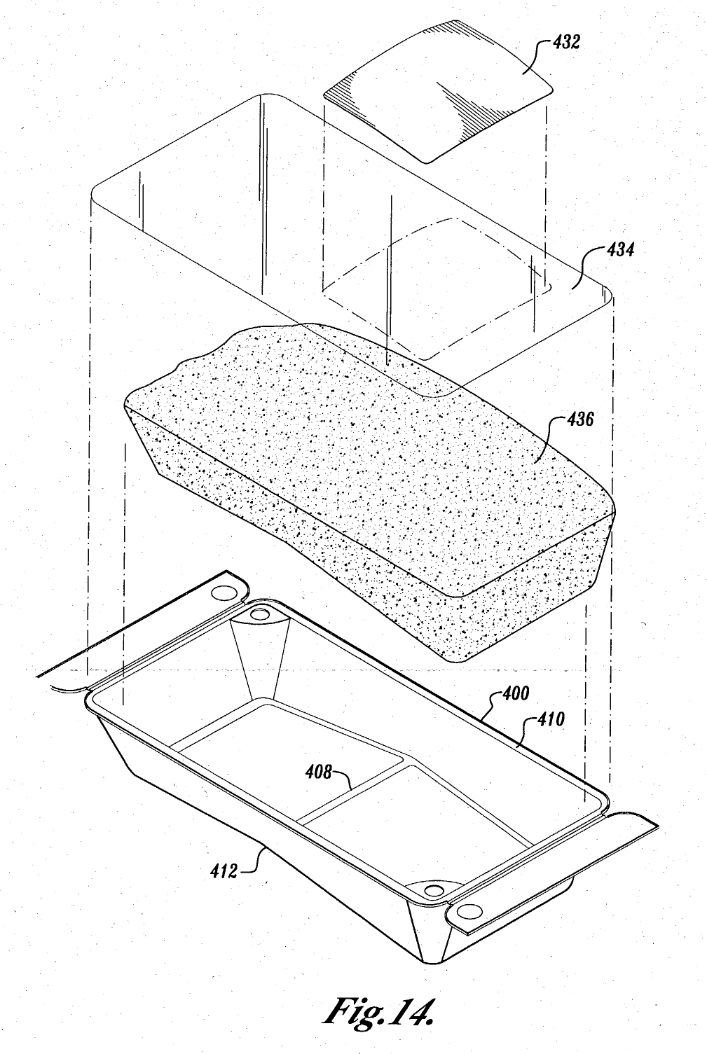

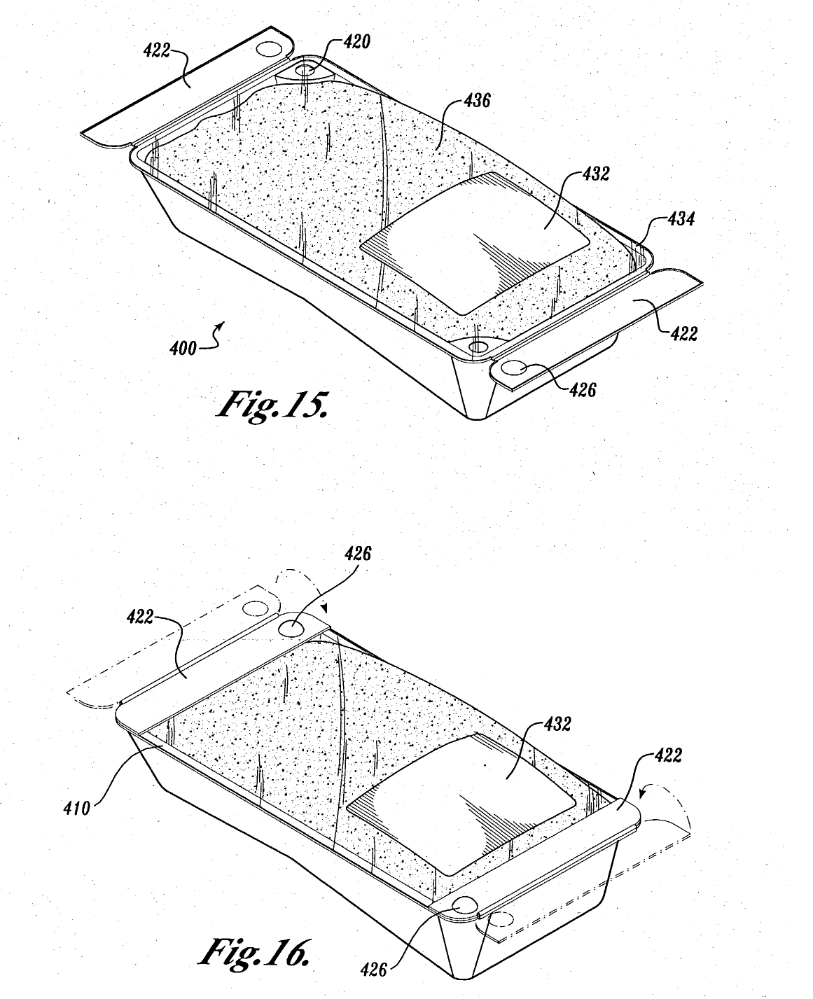

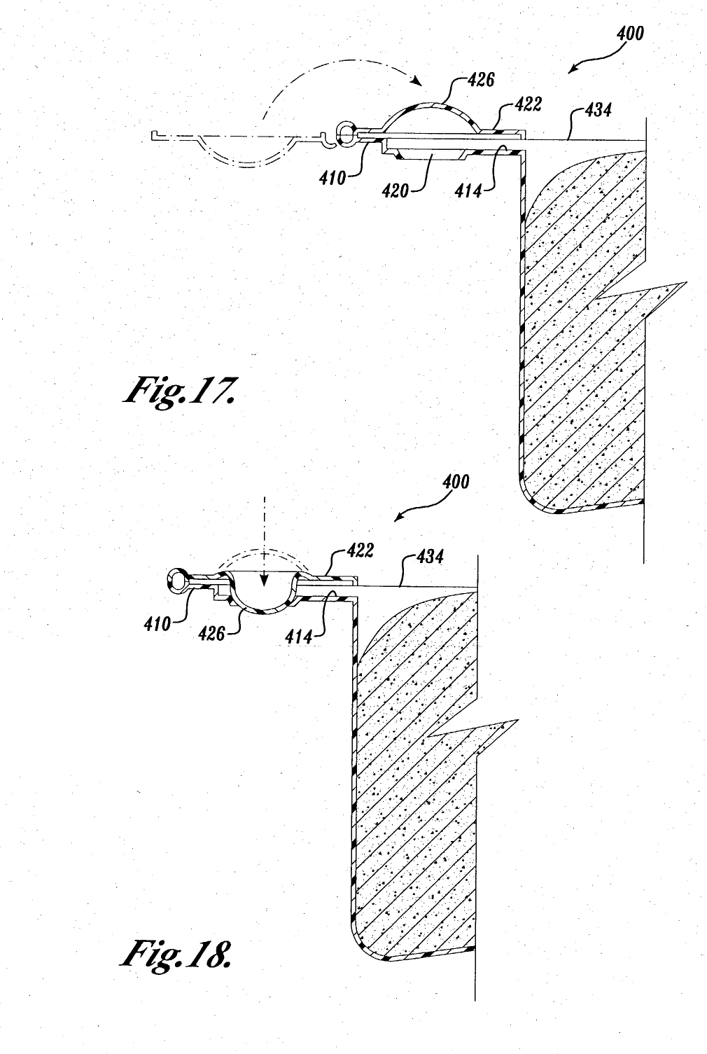

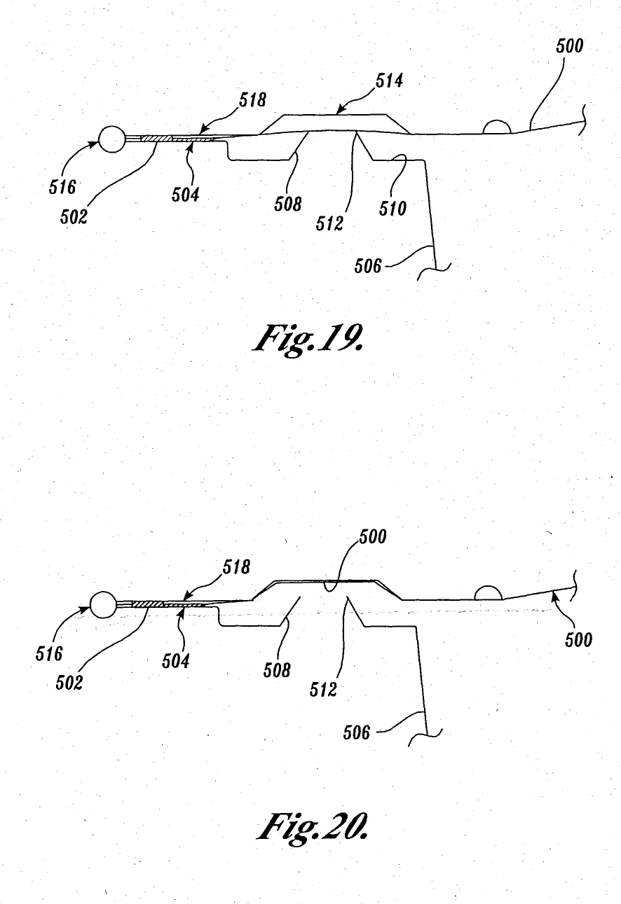

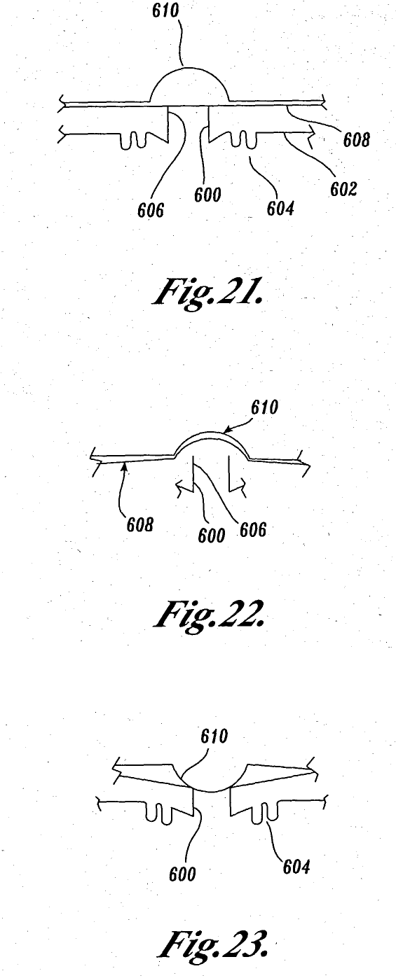

Referring first to FIGS. 1, 2, and 3, a preferred package 100 made in accordance with the present invention includes a tray 102 into which meat 104 (FIG. 3) or other perishable food product is placed. A first layer 106 and second layer 108 of heat sealable material are then placed over the tray 102 and heat sealed to the upper horizontal flange 110 that extends outwardly from the upper periphery of the tray 102. By draftsman's license used in accordance with the present invention, the layers 106 and 108 are shown separated. In actuality, they are in intimate contact throughout their entire length and width. The layers 106 and 108 are also shown to be heat sealed to each other by cross hatching shown in the drawings at locations 112 between the two layers and between the bottom layer 106 and the tray flange 110. In actuality again, there is no substantial thickness at the heat sealed locations, but in fact, the materials are in intimate contact with each other and/or the flange 110 of the tray 102. Thereby substantially expelling/removing air or gas from therebetween.

Depending upon the particular design and use of the tray, the first layer 106 can be composed of a substantially gas impermeable barrier layer or a substantially gas permeable layer. Similarly, the outer layer 108 can either be substantially gas impermeable or permeable. Substantially gas permeable materials include plasticized polyvinyl chloride (pPVC) and polyethylene (PE). Preferably, these are more typically used in thicknesses from 0.0004 inches to 0.001 inches. Preferably, suitable barrier layers (substantially gas impermeable) are composed of amorphous polyethylene terephthalate (APET) unplasticized polyvinyl chloride (uPVC) and a composite material such as a biaxially oriented polyester/tie/polyvinylidene chloride/tie/polyethylene. Other suitable materials known to those of ordinary skill can also be employed in accordance with the present invention. The trays are preferably made of polyester (APET, amorphous polyethylene terephthalate often referred to as polyester), polyvinyl chloride or other suitable food grade polymers. As used herein, a web is a sheet of material that may have one or a plurality of layers or zones of differing compositions. Also, when the terms “substantially gas permeable” or “substantially gas impermeable” are used, they are intended to reflect the fact that no practical heat sealable material is totally gas permeable or impermeable. Materials disclosed herein as substantially gas impermeable will serve as a barrier layer to the transfer of significant amounts of gas over time. Likewise substantially gas permeable materials will not function as a barrier but will allow ready diffusion of gas therethrough.

Method for Producing Peelable Lids

A method is disclosed for producing the peelable lids disclosed above which include a label.

Referring now to FIG. 4, a side elevation of a package sealing arrangement for assembling a package of the type disclosed in FIG. 1 is shown. Trays 102 are loaded with perishable edible material 104 and placed in conventional carrier plates on a conveyor (not shown) and conveyed toward a heat sealing station 114. A roll 116 of heat sealable material is supplied above the conveyor. The sheet of material that will become the inner web 106 from the roll 116 travels downwardly and wraps around a roller 118 and then traverses horizontally in a left-to-right direction along with the trays 102 being conveyed by a conveyor (not shown). A label dispenser 118 positions a label 120 on the upper surface of the inner web 106 of heat sealable material. The outer web 108 of sheet material is then drawn from roll 122 downwardly around another roller 124 and traverses horizontally from left-to-right, where the label 120 is captured between the inner and outer webs 106 and 108. The two webs and the label are then run through a pair of nip rolls 126 to cause the two webs and the label to come into intimate contact and also substantially removing air from between the webs. The webs of heat sealable material 106 and 108 are then positioned at the heat sealing station 114. Corresponding tray 102 is positioned in the lower portion 114 of the heat sealing chamber. The lower portion of the heat sealing chamber 162 is then raised upwardly toward the upper portion 160 of the heat sealing chamber wherein the webs 106 and 108 are sealed to each other and to the upper surface of the flange/lip portion of the tray 102 around the periphery at the flange. At the same time, a knife incorporated into the mechanism trims the excess material neatly around the outer edge of the tray flange 110. The scrap material 128 is then passed around a roller 130 and onto a scrap retrieval roll 132. The tray 102 is then moved onto another conveyor where the finished packages 134 are moved from left to right to a transportation and/or storage station.

Apparatus for Forming Peelable Lids

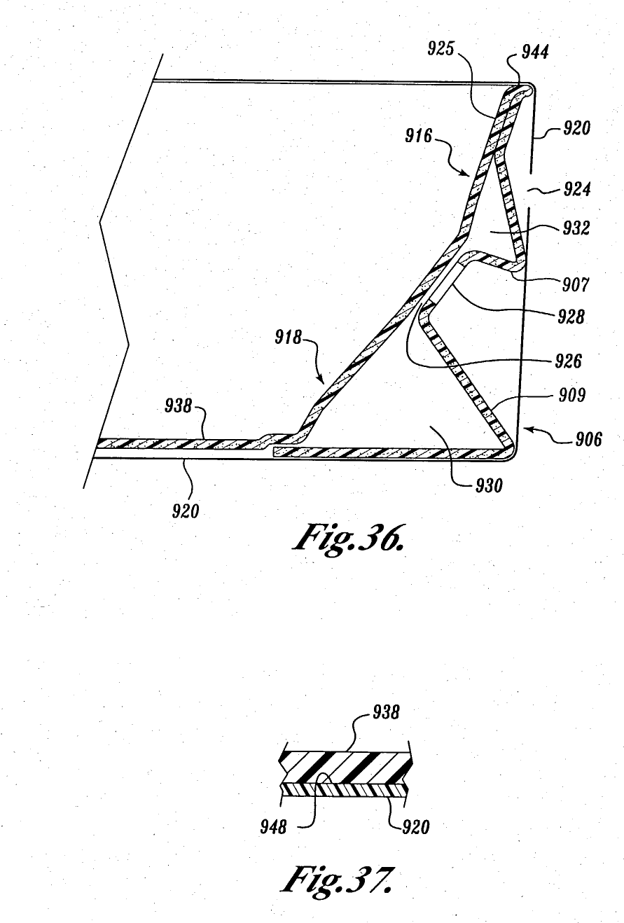

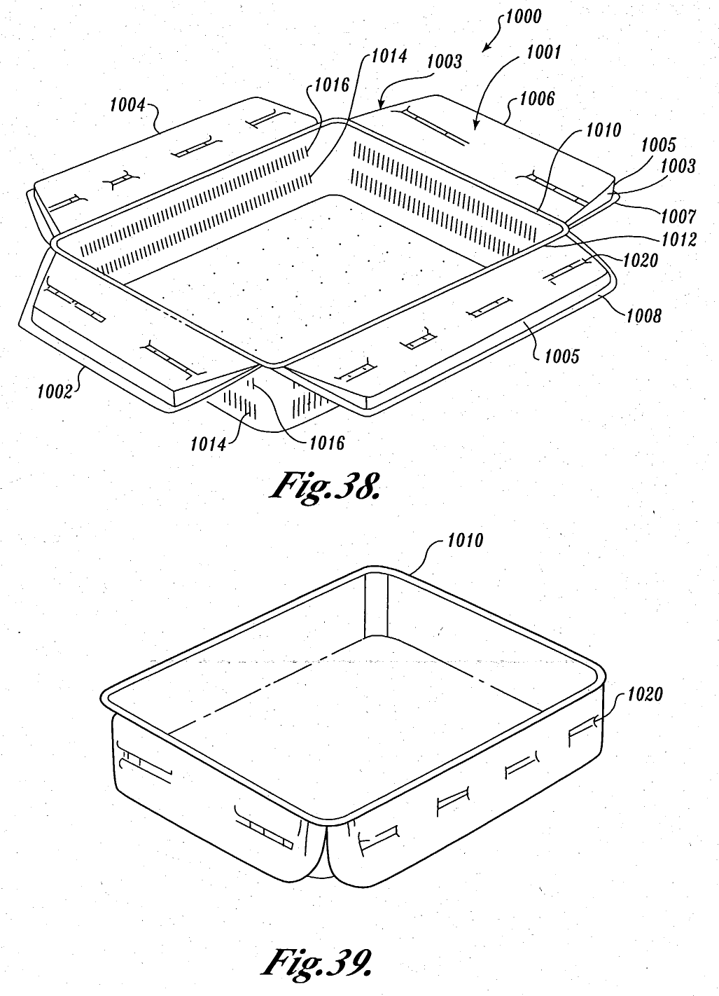

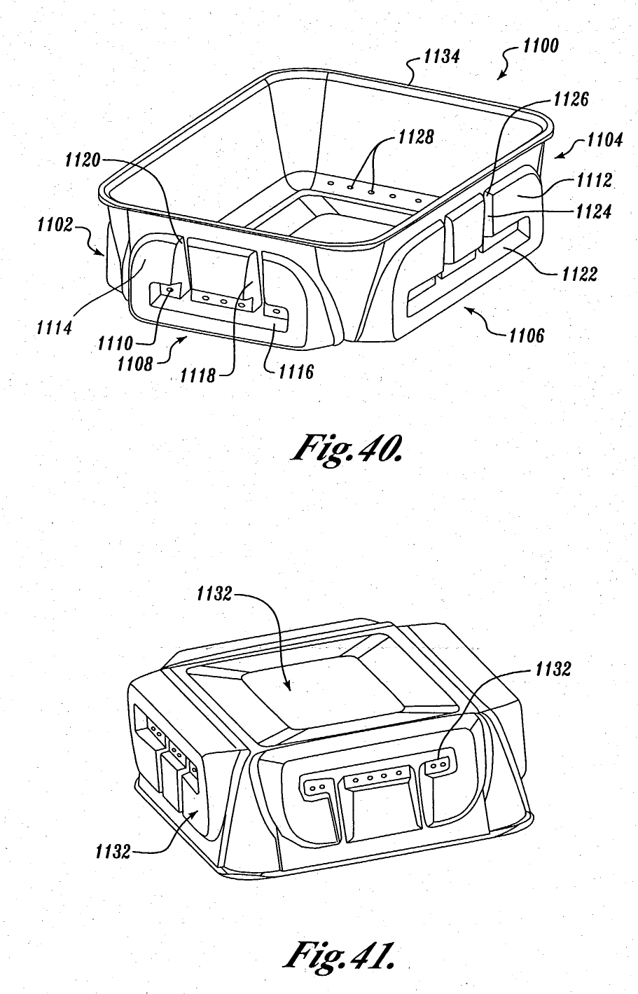

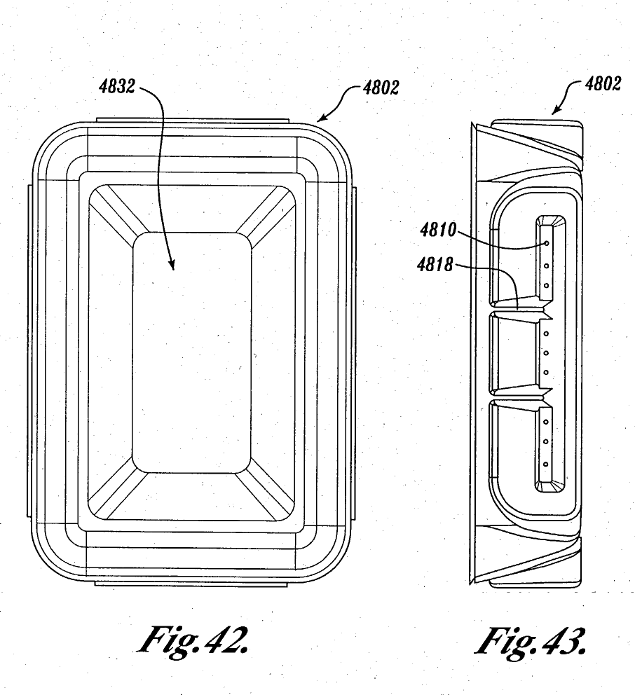

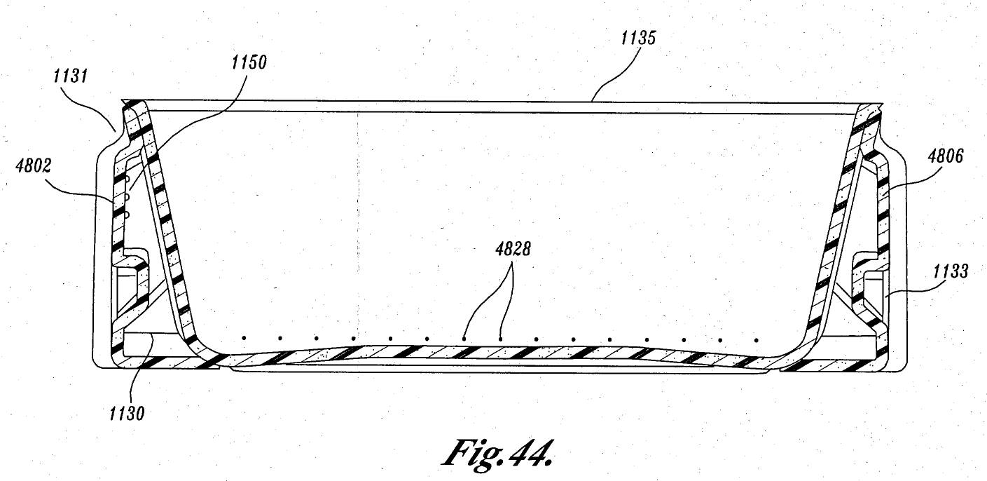

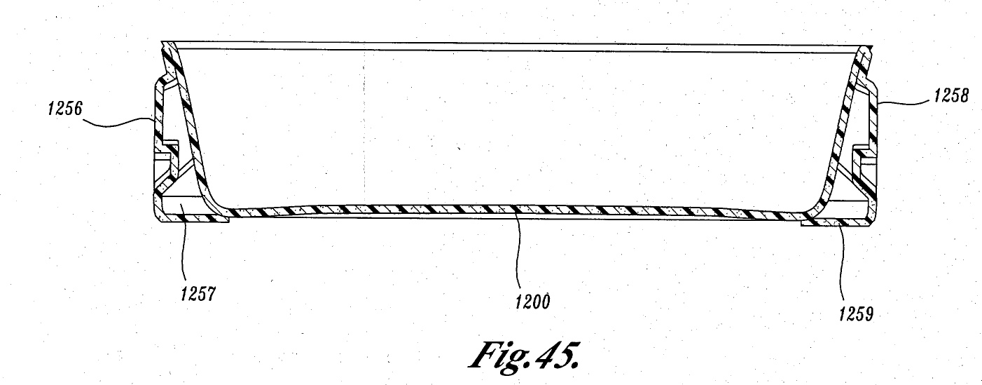

Referring to FIGS. 42-44, a schematic side elevation view through a section of a package is shown. A schematic view is provided so as to clearly disclose an example of a preferred peelable seal mechanism that will facilitate peeling of the third web from the package while the second web remains substantially intact and sealed to the first web. The example is provided to show preferred plastics materials that will seal as required when used according to the present invention. Other selected materials may also be used in similar manner without departing from the general ambit of this invention. First 1002, second 1004, and third 1006 webs are shown where, in this instance, first web 1002 preferably includes a thermoformed tray produced from a multilayer co-extruded material including first, outer layer 1088 of Eastman 9921 about 0.008″ thick and a second inner layer 1086, about 0.004″ thick, including a blend of about 50% PETG 6763 and about 50% Eastman 5116 (or Eastman PM14458 or equivalent shown in FIG. 42). Second web 1004 preferably includes a web of pPVC with a thickness of about 0.0008″. Referring to FIG. 41, third web 1006 preferably includes a two layer co-extruded web with a first outer layer 1082 of Eastman PET 9921 about 0.003″ in thickness and a second inner layer 1084 about 0.003″ thick including a blend of about 16% Eastman PETG 6763 and about 84% Eastman PET 9921. Referring now to FIG. 40, preferably, a water cooled clamp 1104 is shown in position above the flanges of first, second and third webs and two separate heat seal bars 1106 and 1008 are arranged adjacent thereto and all are separated by space and are each independently activated and controlled and moved. Preferably, heat seal bar 1106 can have a set temperature of about 385 degrees F. and heat seal bar 1108 can have a set temperature of about 370 degrees F. Third web second inner layer 1084 will heat seal to second web when the temperature at the interface of second and third webs reaches about 385 degrees F. and above. Preferably, second web will heat seal to second inner layer 1086 of first web 1002 when the temperature of the interface between the first and second webs is about 370 degrees F. and above.

Preferably, the water cooled clamp 1104 is mounted to an independently activated pneumatic driver, providing downward pressure such that the water cooled clamp can clamp against first, second and third webs so as to hold them firmly against the rubber seal 1110 located beneath the first web flange portions 1072 and 1074. Preferably, heat seal bars 1106 and 1108 are independently attached to pneumatic drivers for applying pressure thereto so as to facilitate a method to seal third, second and first webs together under independently selected pressure. Preferably, heat seal bar 1106 heat seals the third, second and first webs together at 1112 and 1114 and heat seal bar 1108 heat seals the second web 1004 to the first web 1002 at 1116 but does not heat seal the interface between the third 1006 and second 1004 webs. When the package is assembled and sealed in the foregoing manner, the third web 1006 can be peeled from the package without rupturing the second web 1004. Preferably, second web 1004 may be perforated so that after seals 1112, 1114 and 1116 have been provided, the second 1004 and third 1006 webs can be separated to provide a space 1118 therebetween.

Seals at 1112, 1114, and 1116 have been shown as heat seals, however, effective sealing can be achieved with use of ultra sonic devices or alternatively latex rubber adhesives when applied at the interfaces of the webs at 1112, 1114, and 1116, or with any other suitable method of sealing. Such sealing can provide improved economics while still providing an effective peeling mechanism as required and described above.

Stackable Trays, Trays with Valves

Conventional thermoformed trays are shaped in a mold which have sides that generally are inclined to facilitate separation between the mold and the tray. Thus, making them cumbersome to stack when filled, because the smaller area at the bottom cannot be suitably supported by the larger opening at the top. Trays constructed according to the present invention include members, in the form of flaps that provide a suitable resting area for the lower portion of the tray when stacked atop one another.

Embodiment 1

Referring now to FIGS. 7-9, a preferred embodiment of a stackable tray 200 constructed in accordance with the present invention is illustrated. Referring first to FIGS. 7 and 8, a tray 202 has a recessed bottom 204 so as to form peripheral legs 206 on which the tray rests. The longitudinal edges of the tray each include a flange 208. The outer flange 208 is coupled to an inner flange 210 of the tray by a hinge member 212. The inner flange is integral with and extends outwardly from the upper edge of the tray 202. A recessed platform 214 is formed across the corner of the tray at diagonal corners of the tray. The bottom of the platform 214 is lowered slightly relative to the level of inner flange 210. The platform 214 in the edge of the tray carries a small depression 216, the bottom of which is perforated. During evacuation and flushing, gases can rapidly enter through the perforation in the depression 216, travel through the recess formed by platform 214 into the interior of the tray and vice versa. Adjacent to the recessed platform 214, the flange 208 includes an outwardly extended flap 218. In the unfolded position shown in FIG. 7, the flap carries a concave dimple 220 (viewed from the top). The dimple is located relative to the hinge 212 such that when the flange 208 is folded over on top of the flange 210, the dimple 220 resides directly above and central to the depression 216. When desired, the dimple can be depressed from the upper side so as to reverse its concavity. When the concavity is reversed, it extends downwardly into depression 216 to close off the perforation in the cavity and thus seal the container.

Referring now to FIG. 8, a first and second web 222 and 224, respectively, of heat sealable material overlay the upper portion of the tray 202 and are heat sealed to the upper surface of the flange 210. First web 222 may be incorporated by deleting web 222. A label 226 or other indicia bearing material can be sandwiched between the heat sealable layers 222 and 224. The method for incorporating a label between a first and second web has been described above.

The label 226 sandwiched between heat sealable webs 222 and 224 is optional and can cover the entire surface of the tray 202. Alternatively, the label can cover only a portion of the product contained in the tray. The label can carry graphics that, for example, show the contents in a fully prepared and cooked condition to suggest to the consumer how the product will look when cooked, yet allowing the consumer to see at least a portion of the fresh product in the tray. For example, if the tray contained fresh beef patties, the label could cover half of the exposed upper surface. The label may be arranged with a straight cut or opening running the full length of the package. Alternatively, the label could be positioned on one side of a diagonal through the package, while the portion of the package on the opposite side of the diagonal would be open for viewing the fresh, packaged product.

Referring again to FIG. 7, the remainder of the longitudinal extent of the flanges 208 include lateral reinforcing ribs 228 that extend upwardly from the flanges 208 when folded over the top of flange 210. The reinforcing ribs 228 have a recess 230 that receives the legs 206 of an identical container stacked on top of a first container as shown in FIG. 9. The recesses inhibit lateral movement of one tray relative to another. Thus, these containers are stackable for use for example in the master bag evacuation technique which will be described below in conjunction with FIG. 5.

Embodiment 2

Referring now to FIGS. 10-13, another embodiment of a stackable tray 300 constructed in accordance with the present invention is illustrated. The tray in plan form is generally rectangularly shaped. The tray includes first and second sidewalls 302 and first and second end walls 304. Walls 302 and 304 are generally upright and slope inwardly from their upper portion toward the tray bottom 306 to facilitate separation from a mold. The bottom 306 has a raised central portion 308 that slopes downwardly toward the bottom of each end wall 304. The upper end of the sidewalls 302 and end walls 304 terminate in an outwardly extending horizontal flange 310 that extends completely around the tray 300. The raised center portion 308 creates a cavity 312 in the bottom of the tray. When the trays are filled and stacked, the contents extend above the flange 310. The cavity 312 will accommodate the raised contents without compression in a stacked arrangement.

Referring to FIGS. 10-13, a horizontal platform 314 is formed in diagonally opposed corners of the tray. The platform 314 is positioned at an elevation slightly below that of flange 310. A wall segment 316 extends downwardly from the inner edge 318 of the platform 314 and has edges that join the sidewalls 302 and end walls 304. The platform 314 and the wall 316 form a recess on the outside of the tray. An aperture 320 is formed in the center portion of platform 314 and allows gas communication between the inside of the tray and the outside of the tray via the recess when a web is sealed over the tray to flange 310.

Referring now to FIGS. 14 and 15, the tray 300 also has movable flanges 322 that are hinged via a hinge 324 to the outer edges of the portions 310a of horizontal flanges 310 that extend outwardly from the end walls 304. The flange 322 when open carries a hemispherical shaped dimple 326. The center of the dimple 326 is on a line perpendicular to the hinge 324 which line also runs through the center of aperture 320. The centers of the aperture 320 and the dimple 326 are equidistantly spaced from the hinges. Thus, as shown in FIG. 14, when the movable flange 322 is folded over the flange 310, the dimple 326 resides over the aperture 320. Referring to FIG. 14, when a web 328 of material is heat-sealed over the top of the tray 300, the interior of the tray 300 remains open to the atmosphere through the space between platform 314 and web 328 through aperture 320. As will be better understood below, it is many times desirable to close the aperture 320. This is done by pressing downwardly on the exterior of the dimple 326 forcing it to reverse itself as shown in FIG. 15 and extend downwardly and fill the aperture 320, thus closing it and sealing the inside of the tray 300 from the external atmosphere.

Embodiment 3

Referring now to FIGS. 17 and 18, another embodiment of a stackable tray with tray valve constructed according to the present invention is shown. In this embodiment, a web 400 of substantially gas permeable material is heat sealed at 402 to the top of the peripheral flange 404 of a tray 406. A frustoconical tube 408 extends upwardly from ledge 410 and terminates in an opening 412 that is slightly above the level of the outer flange 404. After heat sealing web 400 to the flange 404, the web 400 overlying the opening 412 contacts the upper edge of the frustoconical member thus forming an effective valve to close the interior of the containers 406 from the atmosphere. During evacuation of the master pack, the portion of the web 400 over the frustoconical member 408 will elastically extend away from the aperture until the gas inside the package is completely withdrawn, allowing full evacuation of the individual container. This occurs because the air/gas pressure inside the package is greater than the air gas pressure outside the package 406 during evacuation. When gas flushing occurs, which immediately follows evacuation, the web at the opening 412 will again be elastically extended and lifted off the rim of the frustoconical member 408. This again occurs because a partial vacuum remains in the recess of the dome 414 overlying the frustoconical member. Moreover, during gas flushing, at least the initial pressure in the container is less than that on the outside thus allowing gas pressure on the outside to distend the web 400 away from the opening 412. After equilibration, the tension of the web 400 over the rim of the frustoconical member 408 remains so as to effectively close it and prevent ingress of undesirable material into and/or egress of juice or matter from the container 406.

Embodiment 4

Referring now to FIGS. 20-22, another alternative arrangement for a valve structure similar in operation to that shown in FIGS. 17 and 18 includes a tube 700 that extends upwardly from the upper surface of ledge 702. The tube is connected to the ledge 702 by a concentric bellows structure 704 that allows the tube 700 to move upwardly and downwardly relative to the ledge. In practice, the upper lip of the tube (which forms an opening into the tray from the outside) is in contact with the web. The dimple 710 resides over the upper edge of the tube 700. During evacuation and gas flushing, the web 708 will distend away from the lip 706 of the tube in the same manner as described in conjunction with FIGS. 17 and 18 as shown in FIG. 21. However, the tube may be more permanently closed by depression and reversal of the dimple 710. Full reversal of the dimple 710 would push the tubes 700 downwardly against the resistance of the bellows structure 704 thus, forming a very tight closure between the upper lip 706 of the tube and the bottom surface of the reversed dimple 710.

Embodiment 5

Referring now to FIG. 6, another embodiment of a tray with valve constructed in accordance with the present invention is shown. In this embodiment, the tray 146 has an upper peripheral flange 148 that extends outwardly from the entire upper periphery of the tray 146. The tray sides extend downwardly to the horizontally disposed bottom. A downwardly extending recess 150 is cut in the tray corners. The edges of the recess 152 communicate with the interior of the tray. At the inner portion of the recess, the recess and the wall of the tray terminate in an opening 154 having its upper edge at the same level as the upper surface of the flange 148. The opening 154 functions in a similar manner as the apertures in the tray 202 shown in FIG. 7. However, in this embodiment, if the tray is tipped, undesirable juices can flow into the recess 150 and back out through the edges of the recess 152. In this manner the undesirable juices/liquids will not easily exit the package through the opening 154.

Trays constructed in accordance with the present invention provide a closable ventilation mechanism. In addition, trays constructed according to the present invention provide for ledges which allow the trays to be stacked in a convenient fashion in master bag or master containers as shown in FIG. 5. Further, valves according to the present invention may be one way only valves.

Master Containers, Master Bags

Packaged trays constructed according to the present invention can be stacked in master containers, evacuated and flushed with desirable gases, and the master container can be sealed to enhance the shelf life of the packaged goods.

A description of the master container method of packaging perishable good according to the present invention will now be described with reference to FIGS. 5, 10-13, and 16.

One of the aforementioned trays make suitable packages for use with the master container method provided the tray includes foldable flaps and channels providing communication from the interior of the package to the exterior surrounding environment, for example the tray of FIG. 10. Referring now to FIG. 11, the package can be used to store and transport red meat 330, for example, ground beef. In accordance with the present invention, the ground beef 330 may be ground in a conventional grinder. The grinder may be modified so that preconditioned carbon dioxide at a predetermined temperature is injected into the grinder head for two purposes. The first is to cool the grinder head; the second is to allow the carbon dioxide to mix with the ground beef 330 and become dissolved in the liquid therein. The dissolved carbon dioxide will aid in preservation of the ground beef during the storage period. A web 328 of substantially gas permeable material is then placed over the tray 300 and heat sealed to the flange 310 in a conventional manner as shown in FIG. 12. The web is taught over the top of the red meat to prevent its movement about the tray during handling. A label 332 may be applied to the upper surface of the web 328 if desired. Alternatively, a dual web can be employed as shown in FIG. 1 and a label sandwiched therebetween. Thereafter, the flaps or movable flanges 322 are folded over the top of the flange portions 310a so that the dimples 326 reside over the apertures 320. However, any of the aforementioned trays with valves can be used. The flaps 322 are then further heat sealed along their outer edges to the flanges 310 at a second heat sealing station to form a completed package as shown in FIG. 13.

Referring now to FIG. 16, a preferred embodiment of a master container constructed according to the present invention is shown. The master container 334 can be thermoformed from substantially gas barrier materials such as unplasticized PVC or alternatively a coextruded material including amorphous polyethylene terephthalate and polyethylene glycol. The material can be formed with the polyethylene glycol layer on the inside of the tray allowing exposure to the web of PVC material for heat sealing. The master container 334 includes flange 336 located around the periphery of the upper portion of the container 334. The master container containing finished packages 300 with perishable goods therein are evacuated and flushed with a gas of suitable composition. The master container can be sealed by a web of material to the flange 336.

As shown in FIG. 16, a plurality of trays 300 may then be positioned in a master tray 334. For example, in a 3 high by 4 wide array. In accordance with the method of the present invention, the master tray 334 can then be evacuated and flushed with substantially oxygen free gases. At the same time, the individual packages 300 are evacuated through the apertures 320 and flushed with inert gases that enter the individual packages through apertures 320 as well. A package formed in accordance with the present invention allows the use of relatively large aperture 320, which in turn enables very rapid evacuation and gas flushing of the individual packages. With the disclosed system it is estimated that only a few seconds will be needed to completely evacuate and gas flush the master tray 334 and individual trays 300. After the containers are evacuated and flushed, a master web 338 is heat sealed to the top of the master tray 334. To form a completed master tray 334, if desired, an oxygen absorber may be inserted in the master tray 334 so that it is assured that the residual oxygen content in the package will stay below about 0.05%. This low level of oxygen is required to prevent irreversible oxidation of the deoxymyoglobin in the red meat and forming of metmyoglobin.

Once the package reaches its destination, it can be stored for several days in a sealed condition. When it is time to display the meat, the master web 338 is removed from the master tray 334 and the individual packages can be weighed and labeled. At that time, oxygen reenters the individual packages 300 through the aperture 320 as well as through the substantially gas permeable web 328. The oxygen converts the deoxymyoglobin in the red meat to oxymyoglobin, giving the meat a very fresh red appearance. Before placing the package in the display case, the dimple 326, one embodiment of which is shown in FIGS. 14-15, is depressed so as to close the aperture 320 which prevents the entry of undesirable elements such as insects into the package, and also substantially seals the package so that juices from the red meat cannot escape from the container if it is tipped on end.

Referring now to FIG. 5, a preferred alternate master bag container constructed according to the present invention is illustrated. Trays constructed according to the present invention can be stacked conveniently atop one another because the trays have been provided with flaps which fold inwardly to provide a ledge for a tray resting atop another tray can rest. Once trays are placed inside a master container as shown in FIG. 5, the gas inside the master bag and trays can be evacuated through opening 140, because trays constructed according to the present invention include valves which allow the interior of sealed trays 136 to also be evacuated, and then flushed with a gas of desirable composition. The gas is preferably inert and substantially oxygen-free so as to reduce oxidation of the edible products in the packages 136 during storage. The number of cycles which are necessary to lower the level of the undesirable gas will vary. Once the master bag reaches an intermediate processing station prior to delivery to the location of point of display, it can be opened and flushed with high oxygen atmosphere containing 80% O₂+CO₂. The packages can be weighed and labeled. Then the dimples may be depressed to close the perforations in depressions at this station or alternatively left open. In some alternates of the present invention, the trays are provided with one-way valves which eliminates the need for dimples. Other alternates of trays may have no valves, because these packages will have been packaged in a low oxygen atmosphere. After this step, the trays can then be replaced into a master bag at which time the interior can be partially or completely evacuated and flushed with a high oxygen content gas such as 80% O₂+CO₂. The master bag can then be heat sealed again. In this way, extra days of shelf life can be obtained because the CO₂ will tend to inhibit bacterial growth.

This method of packaging can be advantageously used for other types of higher value products such as tomatoes, grapes, peaches and the like.

Referring again to FIG. 5, an alternative to evacuating the bag 138, includes an oxygen absorber such as an iron compound that can be placed in a container 142 in the master bag 138. Thus, instead of or additionally to evacuating and flushing with an inert or substantially oxygen free gas, the oxygen-absorbing compound quickly absorbs all remaining oxygen in the bag leaving only nitrogen and other inert gases that will not adversely affect the condition or value of the food or red meat products in the containers.

In practice it is possible that all features described above will be incorporated into individual retail package structures. With the valve arrangement, free passage of air and/or gas through the aperture is essentially restricted. In addition, small microperforations in the overlying web may be employed to allow more rapid gas/air exchange than would otherwise occur through a normal substantially gas permeable material such as plasticized polyvinyl chloride. Such microperforations would facilitate more rapid reoxygenation of the deoxymyoglobin and generation of a desirable bright red meat color.

Soaker Pads

Soaker pads provide absorptive materials to absorb liquids extruded by the packaged goods. Soaker pads constructed according to the present invention include bacteria sensing materials.

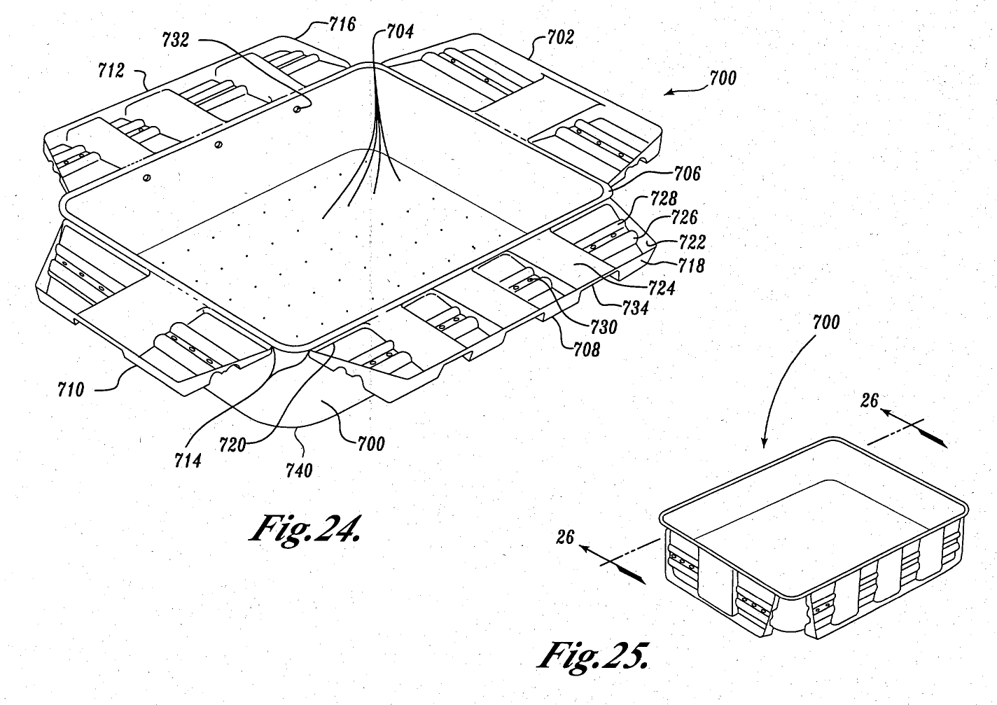

Referring now to FIG. 22, a tray constructed according to the present invention is shown. Tray 800 is configured similarly to that of the tray shown in FIG. 10, and carries a soaker pad 802 that lies on the bottom of the tray. A plan side view of soaker pad 802 is shown in FIG. 24 and a cross-sectional view C-C is shown in FIG. 23. The ground beef 804 or other edible material is positioned on the soaker pad and first and second webs 806 and 808 of heat sealable material are placed over the tray and sealed to the horizontal flanges 810 that extend outwardly from the upper edges of the tray. The label 812 is included of a special polymeric material that has the capability of indicating the presence of E. coli bacteria. This material may be laminated into a three-layer web including polypropylene/E. coli sensor material/polypropylene or polyethylene/sensor material/polyethylene. The polymeric material employed is of the type disclosed in the paper entitled “A Litmus Test for Molecular Recognition Using Artificial Membrane,” Charych, D. et al. Chemistry and Biology, Vol. 3, No. 2, February 1996, 3:113-120, expressly incorporated herein by reference. The lower web 806 may be microperforated in the region of the label 812 so that juices from the ground beef 804 can penetrate the web and contact the label 812. The label 812 will change color in the presence of E. coli bacteria. The upper surface of the label can also be treated so that it may be printed with instructions relating to the E. coli test and/or information relating to the ground beef 804 or other edible product. A detail of the webs 806 and 808 carrying the litmus test label 812 is shown in FIG. 25.

Alternatively, as shown in FIGS. 24 and 25 (a cross-section of FIG. 24 along section line c-c) shows that the container for the soaker pad 808 can be made of the laminated three-layer web described above containing as the middle layer the litmus test sensor material. In this embodiment, the absorbent material 814 in the soaker pad 802 is encased in an upper web 816 of the tri-layer test material and a lower web 818 of the same test material. It is heat sealed around the entire periphery 820 and placed in the bottom of the tray 800 (FIG. 22). Both webs 816 and 818 are microperforated so that juices from the red meat 804 can penetrate to the absorbent layer 814. The presence of E. coli will be shown by a change in color of the test material in the web 816 and 818.

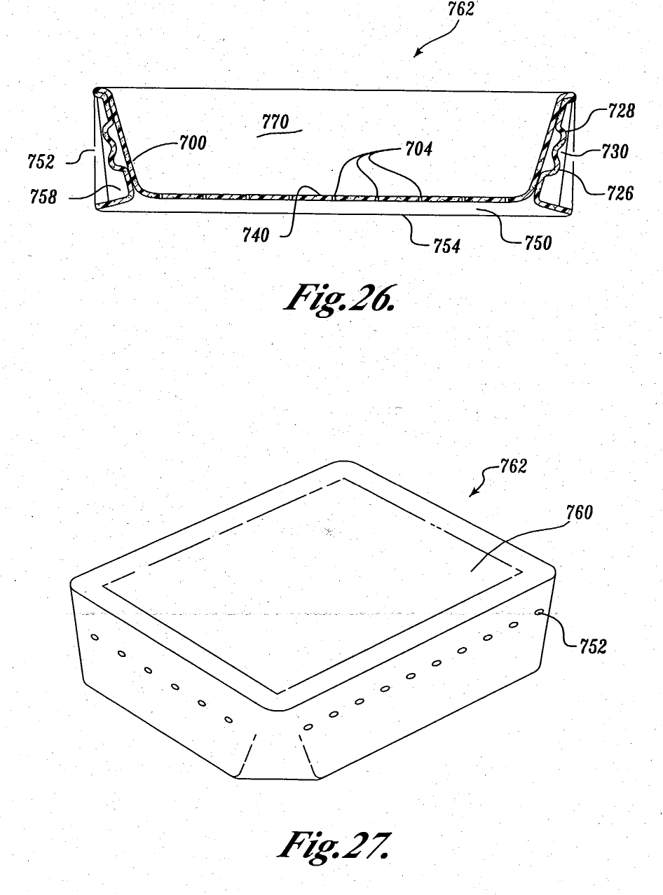

FIG. 26 illustrates a tray 800 similar to that shown in FIG. 22. However, this tray carries a plurality of ground beef patties 822 that are interleaved with layers 824 of the test material. In this manner, the presence of E. coli bacteria can be ascertained at a variety of locations in the package.

Apparatus and Methods for the Manufacture of Soaker Pads

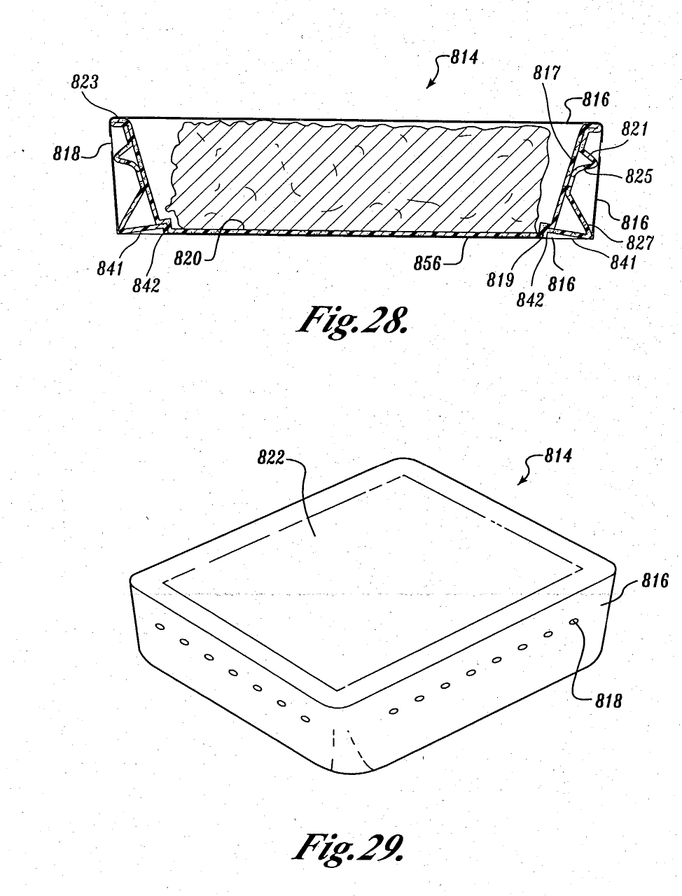

Referring to FIGS. 27-30, a side elevation (FIG. 28) and a plan view (FIG. 29) of an apparatus for manufacture of soaker pads with the engineered polymerized molecular film of the type that detects E. coli and indicates its presence by a change of color [EPMF] attached to an inner surface of a side of the soaker pad is illustrated. A roll of coextruded transparent, perforated, plastics material 900, including a rolled length of web 902, is mounted on an unwind stand 904 and the end of the web is “threaded” around a series of drive and idler rollers, 906, 908, 910, 912, and 914 such that when drive rollers 908 and 914 are driven, the web 902 is pulled over the drive roller 908 so that the inside surface of the web 902 contacts the surface 922 of the water 918 flowing through the trough 920. The trough 920 is connected to a conventional Langmuir-Blodgett water trough in such a manner as to cause water 918 to flow, from the tangmuir-Blodgett water trough, horizontally, underneath and parallel to web 902 and at a similar rate of flow to the speed of the forward movement of the web 902 as controlled by the rate of revolutions of drive roller 908. The Langmuir-Blodgett water trough is provided to generate sufficient quantities of EPMF as required by the process. The EPMF floats on the surface 922 of the water 918 and is carried with the flow of water at a similar speed. When the web 902 contacts surface 922, the EPMF is transferred from the water surface to the web 902 and travels adjacent to a drying section 924 that evaporates any surplus water.

The web 902 is transferred from a vertical disposition across drying section 924 to horizontal by way of movement over the idler roller 910. Soaker (absorbent) pads 942 are positioned onto the surface of the web 902 and a further perforated web 930 is unwound from roll 932 mounted on unwind stand 934. The two webs, with absorbent pads therebetween, are transferred, between two drive rollers, 914 and into a heat sealing station 936. The heat sealing station seals the two webs 902 and 930 together by applying pressure through two sets of temperature controlled heat sealing bars 936a, 936b shown in FIG. 30. The pressure applied is sufficient to distort the EPMF layer 960 and allow direct contact of the web 902 and 930 surface layer material (SURLYN is a registered trademark of Dupont), which is an ionomer resin and the SURLYN readily bonds together. Webs 902 and 903 are composites which include an outer and inner layer, 962, 964, 966 and 968, respectively. The longitudinal slitting station 938 slits and separates the sealed soaker pads into continuous strips and the lateral cutting station 940 cuts across the webs thereby separating the complete soaker pads.

Trays with Flaps Trays with Channels

Trays with flaps and trays with channels which are constructed according to the present invention provide sturdier stackable trays which are able to be evacuated of air and flushed with inert gasses and additionally provide channels and spaces to retain any liquids exuded from the purchased goods.

Embodiment 1

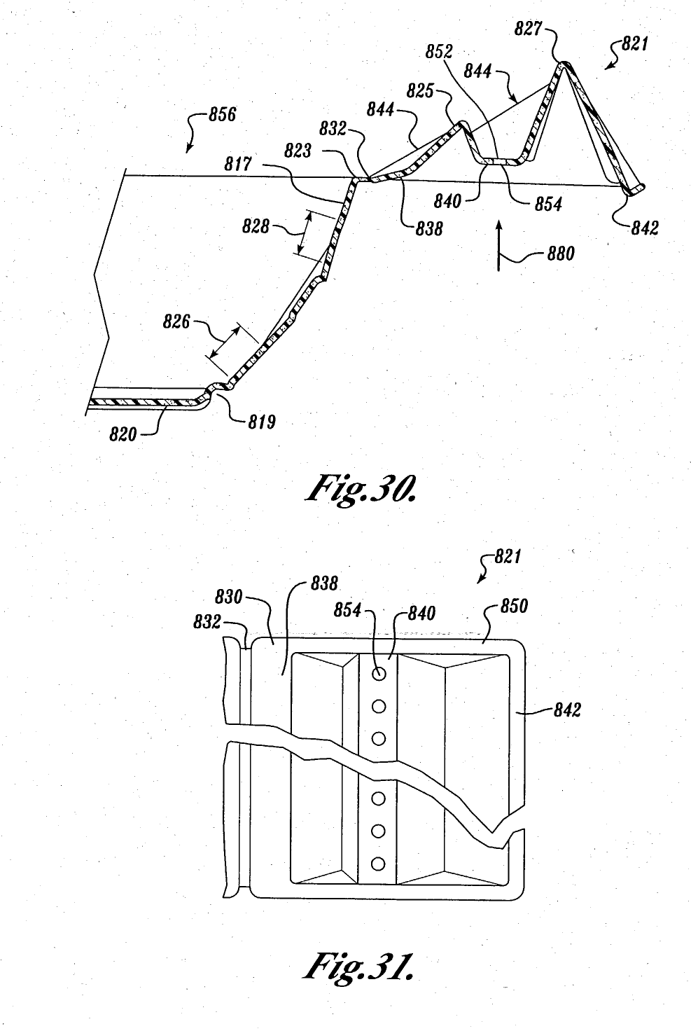

Referring now to FIG. 31, a preferred packaging tray 3000 with flaps, is shown in a three dimensional drawing. The tray and flaps 3002 can be thermoformed from suitable materials such as polystyrene, polyester and polypropylene in a solid or foamed sheet. The tray 3000 is most preferably thermoformed from an expanded polystyrene sheet of suitable thickness. Tray 3000 includes a base with perforations 3004. Four upwardly extending sides terminate at a common flange 3006. Flaps 3002, 3050, 3052 and 3054 are attached to flange 3006 at the external edge of flange by way of hinges at a hinge lines as shown. Flap 3002 is provided with a profile that mirror images flap 3052, and flap 3050 is provided with a profile that mirror images flap 3054. Flaps are attached to the outer edge of flange rim at hinges as shown, such that flaps 3002, 3050, 3052 and 3054 will fold downwardly and intimately contact outer surfaces of the tray walls. The cross-sectional profile of flaps 3002, 3050, 3052, 3054 are similar, flap 3002 and flap 3052 being of substantially similar dimensions, and flap 3050 and flap 3054 being of substantially similar dimensions. Flaps are formed with a rim 3008 that follows a continuous path around the perimeter of the flaps. Flaps include a profile which includes a flap base 3010, a flap flange wall 3012 and external flap vertical walls 3022. Buttresses 3016 are formed into flap profile and connect flap flange wall 3012 to flap base 3010. Horizontally disposed ridges 3018 and 3020 provide horizontal channels that connect buttresses 3016 with continuous communication to openings at each end of flaps in flap vertical walls 3022. Apertures 3014 are provided between the ridges. Apertures 3014 thereby provide communication through flaps at locations between the buttresses. Apertures 3026 are provided in upwardly extending walls of tray at points adjacent to buttresses such that when flaps are folded into a vertically disposed position relative to tray, apertures 3026 provide direct communication through tray walls to buttress recesses 3024.

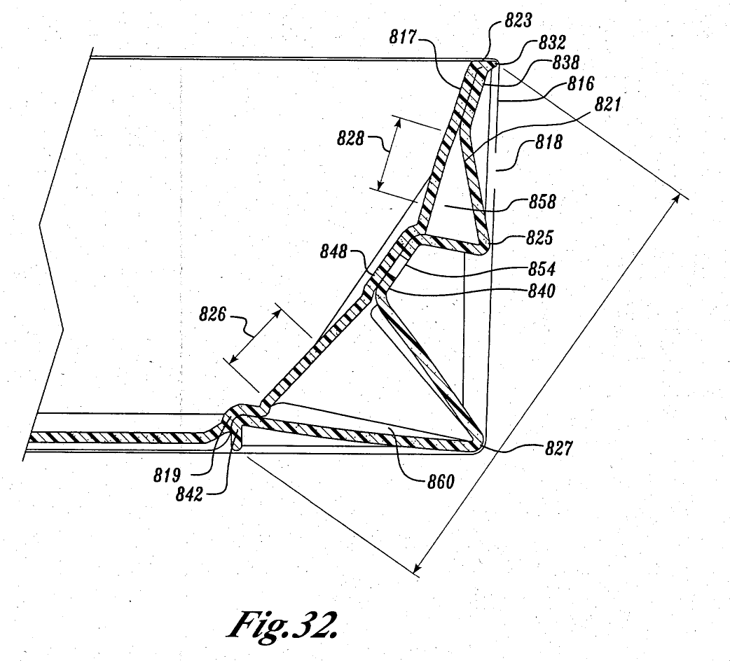

Referring now to FIG. 32, a three dimensional sketch of the tray 3000 with flaps folded downwardly, is shown. Flaps are folded to a downwardly position, such that flap flange wall 3012 is in contact with the underside of flange 3006. In this position, flaps are located in close proximity and in contact with upwardly extending tray sides. Flap base 3010 is substantially horizontally disposed relative to tray and provides an extension to base of tray such that when tray with flaps folded as shown in FIG. 32 is placed directly above a similar tray, flap base is adjacent to and resting on flange 3006. It should be noted that while packaging shown in FIG. 31 includes a tray with four flaps, any number of flaps from one to four may be provided according to preference and any specific requirements of a particular application.

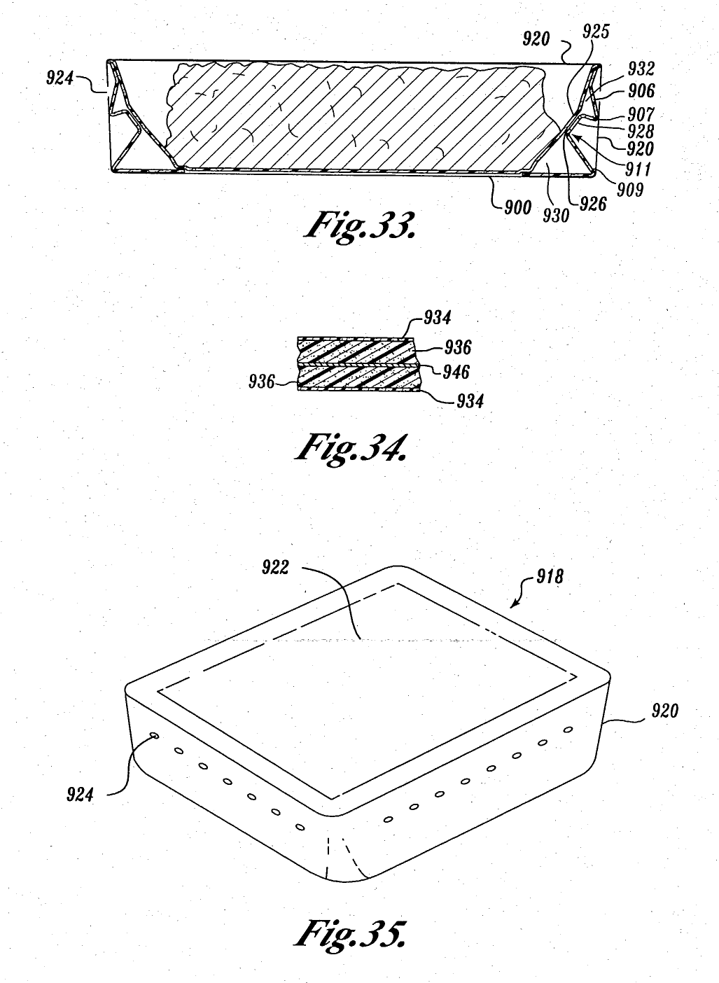

Referring now to FIG. 33, tray base 3028 is shown with perforations therein. Perforations 3004 may extend directly through tray base or partially therethrough from either side. Perforations can provide absorption of liquids that may accumulate adjacent thereto, by the open cell structure of the tray base material, such as when the tray has been thermoformed from expanded polystyrene sheet which is, at least in part, of open cell structure. A space 3030 is shown which can be provided if desired. Space 3030 can be provided after tray with flaps is inserted into a pre-formed shrink bag that is then exposed to elevated temperature that can cause the shrink bag to shrink around the tray with flaps. Alternatively, tray with flaps profile can be arranged such that space 3030 is substantially minimized when the tray base is in direct and intimate contact with the shrink bag. Shrink bags may be printed as required with information of interest to any person interested in purchasing the finished package. Such shrink bags are manufactured for example by Robbie Manufacturing Inc., and are well known by the name PromoBagtm. Shrink bags can be printed and fabricated from a clear, biaxially-oriented, heat shrinkable, anti-fog, polyolefin film material manufactured by E. I. Dupont De Nemours and known as Clysar AFG anti-fog shrink film. Clysar is a registered trade mark of Dupont, details of which can be obtained from Dupont or on the internet at www.clysar.com.

Referring now to FIG. 34, a finished package is shown. The finished package may contain perishable goods such as fresh red meats or fresh ground meats. Apertures 3032 can be provided at optimized locations and/or as shown, in the outer cover shrink material 3034 of the finished package 3036. Apertures 3032, which may be provided in the bag or web of shrink material before or after package assembly, thereby providing direct communication from external atmosphere through space 3038, apertures 3032, buttress recess 3024 and apertures 3036, and into the tray cavity 3040. A plurality of finished packages can be located inside a barrier master container as shown in FIG. 35 or any other master container/bag previously described above. Such barrier master container may be thermoformed from a substantially gas barrier plastics material, such as a co-extruded multi-layer sheet of nylon//PVDC//polyethylene. After inserting finished packages into the barrier master container, the master container can be located inside a vacuum chamber and substantially all atmospheric gases can thereby be evacuated from within the barrier master container, and within the finished packages. A gas or blend of suitable gases such as carbon dioxide, nitrogen, oxygen and any other suitable gases, can be provided into the barrier master container and the finished packages prior to hermetically sealing a substantially gas barrier lid to flanges of the barrier master container. A plurality of barrier master containers can then be positioned into a suitably sized shipping case as shown in FIG. 35, prior to shipping to another location.

Referring to FIGS. 116-117, in yet another preferred embodiment, the master container 3226, with one or more finished packages, 3224, contained therein and including a “loaded master container”, may be located inside a pressure vessel that is also arranged to operate as a vacuum chamber with gas flushing. After location of the “loaded master container” inside a pressure vessel, the pressure vessel is closed and sealed from atmospheric air and substantially all air is evacuated to a desired and predetermined level. Following evacuation, the pressure vessel can be filled with a desired gas such as carbon dioxide to a predetermined, controlled and maintained pressure, above atmospheric pressure, such as 12 psi or up to 250 psi or higher, and held at a predetermined pressure for a period of time that will allow sufficient carbon dioxide gas to dissolve in the perishable goods contained in the finished packages in the master container. Carbon dioxide gas can be held at the pressure, for a period of time, as required to prolong the subsequent storage life of the perishable goods. Following the period of time, the gas pressure may be lowered to a pressure equal to that of the prevailing atmospheric pressure and a gas barrier lid then hermetically sealed to the flanges of the master container prior to opening the pressure vessel and removing the master container. The aforementioned process may include the steps of:

i) Locating a master container, 3226 with finished packages such as those shown as 3224 contained therein, into a suitable pressure vessel.

ii) Closing and sealing the pressure vessel so as to isolate it from atmospheric air.

iii) Evacuating substantially all air from within the pressure vessel.

iv) Providing a gas such as carbon dioxide in the pressure vessel at a pressure above atmospheric pressure.

v) Holding the pressurized carbon dioxide provided in the pressure vessel for a period of time sufficient to enhance the keeping qualities of the perishable goods contained in the finished packages 3224, for an extended period.

vi) Lowering the gas pressure within the pressure vessel, to a level equal to the prevailing atmospheric pressure.

vii) Hermetically heat sealing a gas barrier lid to the flanges of the master container so as to substantially exclude oxygen gas from inside the master container.

viii) Removing the master container from the pressure vessel automatically.

ix) Locating another master container in the pressure vessel by automatically and repeating steps i). to viii). in an automatic fashion.

x) Placing and sealing the master container into a finished shipping case as shown in FIG. 36 which may be constructed of cardboard material with a crush test rating of 44 lbs. per inch.

xi) Shipping the finished container to another location.

xii) Removing the finished packages from the finished shipping case and allowing atmospheric air to penetrate through the apertures in the finished package.

xiii) Repeating any or all of the above steps as required to maximize the keeping qualities of the perishable goods.

Referring again to FIGS. 31 and 32, it can be seen that by manufacturing packaging in this manner, any liquids that may accumulate within the tray cavity 3040, such as blood, will be substantially restricted from escaping through apertures 3032 shown in FIG. 34. This restriction is provided due to the arrangement of flaps and apertures therein, and the location of the apertures. Furthermore, perforations 3004 provide for retention of the liquids within the package.

Embodiment 2

An alternate embodiment of a tray with flaps constructed according to the present invention is shown in FIGS. 37-124. The tray of FIG. 37 includes four flaps as the tray of FIG. 31, with modifications as described herein. FIG. 37 shows the cross-sectional detail of a tray. The tray walls are perforated in sections shown as incision section 3526 and incision section 3528, shown in FIG. 39. Perforations may be in the form of small holes or incisions that extend fully through the tray walls, but may be only provided within the limits of regions shown as incision sections 3526 and 3528.

Referring now to FIG. 37, a cross-sectional view of finished package 3514 is shown. Finished package 3514 includes a packaging tray 3556 with perishable goods located in tray cavity with an outer cover 3516. The outer cover 3516 includes an envelope of material that completely covers and encloses the packaging tray and the perishable goods and is heat sealed to provide a sealed package. The outer cover 3516 may be manufactured from a shrink material such as Clysar, manufactured by DuPont, and can be printed such that all surfaces are rendered opaque leaving a transparent window 3522 on the upper surface only, as shown in FIG. 38 of the finished package. Clysar outer cover shrink material is then heat shrunk such that the outer cover shrinks, holding the flaps against the tray walls. Apertures 3518 are provided on the four vertical faces of the finished package when the base 3520 of tray is horizontally disposed.

Referring now to FIG. 39, a detailed section of a packaging tray 3556 with base 3520, tray wall 3524 and flange rim 3512 attached to flap 3508 at a hinge 3532, is shown. The relative position of flap 3508 and the section of tray is in the “open position”. Flap 3508 is attached at hinge 3532 to flange rim 3512, however flap 3508 is not folded downwardly.

Referring now to the flap portion 3508 of FIG. 39, a cross-section is shown including a first and second raised peaks 3534 and 3536, respectively, and a flat area shown as face 3538 and face 3540; also shown are a ridge 3542; and gussets 3544, with connecting sections therebetween. Packaging tray includes a base 3520, flange rim 3512 with tray wall connecting base of tray to the flange rim. Tray wall includes recess 3546, a first incision section 3526, recess 3548 and a second incision section 3528. FIG. 40 shows a view of flap from the direction of arrow 3608. Flap 3508 includes a perimeter 3530 including hinge 3532, face 3538 and end flanges 3550 that are connected together to provide the continuous flat perimeter. Referring now to FIG. 126, depressions 3552 may be provided in the flap section between peak 3534 and ridge 3542 but do not perforate the section to provide direct communication therethrough. Apertures 3554 are also provided in face 3540.

Referring now to FIG. 41, an enlarged view of a tray portion of FIG. 124 is shown. Flap and the tray wall are in intimate adjacent contact and ridge 3542 and recess 3546 are engaged. Faces 3538 and 3540 as shown in FIG. 126, are in direct and intimate contact with the tray wall. Face 3540 is located in recess 3548, thereby closing apertures 3554 when in this position. Spaces 3560 and 3558 are directly adjacent to first and second incision sections 3526 and 3528. Shrink film 3516 holds flap firmly and tightly against the tray wall providing sealed contents within the finished package. The package may be colorized to prevent translucency. An adhesive such as a cold seal latex is provided between the continuous perimeter 3530 of the flap as shown in FIG. 40. The tray wall is inwardly flexible such that when a vacuum is provided within the tray cavity, the recess 3548 and face 3540 will separate to provide direct communication from within the tray cavity via perforations or incisions at first and second incision sections 3526 and 3528 through apertures 3554, and through apertures 3518 in outer cover shrink film 3516.

A plurality of finished packages 3514 of this embodiment can, as well, be stacked and placed inside a gas barrier master container inside a vacuum chamber. Substantially all the air may be evacuated from within the gas barrier container and from inside the finished packages. Air is evacuated from within the packaging tray cavity through perforations and/or incisions in the tray wall at first and second incisions 3526 and 3528 into space 3560 and 3558, created when the flap is place adjacent the tray wall, the air flows through apertures 3554 and apertures 3518. A suitable gas or gas blend such as nitrogen and carbon dioxide can then be provided into the vacuum chamber. The desired gas can be provided in a reverse flow direction into the finished packages by way of direct communication through apertures 3518, apertures 3554 into spaces 3560 and 3558, through perforations at incision sections 3526 and 3528 and thereby fill all free space within the finished packages and the gas barrier master container. A gas barrier lid can then be hermetically heat sealed to the opening of the gas barrier master container and the finished packages in the hermetically sealed master container can then be stored at a controlled temperature for a desired period of time prior to opening the master container and removal of the finished packages for retail sale.

In this way air and gasses can be removed from the finished and sealed packages by evacuation and then replaced by gas flushing with a desired gas, while liquids such as blood cannot readily escape.

Embodiment 3

Referring now to FIG. 271, another preferred packaging tray with flaps constructed according to the present invention is shown in a three dimensional sketch. The packaging tray of this embodiment as with the packaging trays of previous embodiments is similar in operation, but with an alternate configuration of the channels through which evacuation and flushing is accomplished. The tray with flaps can be thermoformed from suitable plastics materials such as polystyrene, polyester and polypropylene in a solid or foamed sheet. The present packaging tray is preferably thermoformed from expanded polystyrene (EPS) sheet. The EPS sheet may include an “open cell” structure with a surfactant added prior to extrusion of the sheet such that the finished tray will have a capacity to absorb water and other liquids such as “purge” or blood. The EPS sheet may be extruded with a “skin” on what will become the in-side of the finished tray. The “skin” can be arranged so as not to absorb the liquids. The non absorbent “skin” may be provided on both surfaces of the extruded sheet.

The EPS sheet may be a multi-layer extruded sheet including three layers. The three layers may include two outer layers of closed cell EPS foam with an inner layer of open celled EPS foam. The outer layers may be close celled and resistant to liquids such as blood and/or purge. The inner layer of open celled EPS foam can be extruded with a suitable surfactant contained therein that will enhance the liquid absorbing qualities of the open celled EPS foam.

The tray with flaps, shown in FIGS. 271-272, is most preferably thermoformed from expanded polystyrene sheet of suitable thickness, of preferably from about 0.01″ to about 0.15″, and most preferably about 0.090″ and including at least two layers including a “skin” that will not absorb the liquids and an adjacent layer of open cell structure that will absorb the liquids. FIG. 271 shows detail of the packaging tray with flaps extended and including a tray with tray cavity and four flaps shown as flap 7002, flap 7004, flap 7006, and flap 7008. Flap 7002 is provided with a profile that mirror images flap 7006, and flap 7004 is provided with a profile that mirror images flap 7008. Flaps 7002, 7004, 7006 and 7008 are attached to the outer edge of flange rim 7010 at hinges 7012 as shown, such that flaps 7002, 7004, 7006 and 7008 will fold downwardly and intimately contact outer surfaces of the tray walls. FIG. 272 shows the packaging tray with flaps folded downwardly. The cross-sectional profile of flaps 7002, 7004, 7006 and 7008 are similar. Flap 7002 and flap 7006 being of substantially similar dimensions, and flap 7004 and flap 7008 being of substantially similar dimensions, but can be longer or shorter than flaps 7002 and 7006. Referring yet again to FIG. 271, the packaging tray includes a base with four upwardly extending tray walls terminating at a continuous flange rim 7010. The tray walls can be perforated with openings directly therethrough with the perforations arranged in sections shown as a first incision section 7014 and a second incision section 7016. The perforations may be in the form of small holes or incisions that extend fully through the tray walls, but are preferably provided within the limits of regions shown as first and second incision sections 7014 and 7016, respectively. Apertures provided in sections 7014 and 7016 preferably extend into spaces between flaps and tray walls. Apertures 7020 provide a passage for evacuating and flushing the tray in a master container, as previously described.

Embodiment 4

In another embodiment shown in FIGS. 45-49, a gap 4126 is provided between the flap at openings 4128 and the tray wall. The flap 4106 is in a folded down position and a gap 4126 is arranged between openings 4128 and the tray side wall. Spaces 4130 and 4132 are directly adjacent to incision sections 4118 and 4116. The shrink film holds the flap firmly and tightly against the tray wall. An adhesive such as a cold seal latex, or any other suitable adhesive may be provided between the flaps and the tray walls so as to cause sealing and bonding where contact between the flaps and the tray walls occurs. FIG. 46 provides details of a cross-section through a section of the tray wall and the flap that are in direct contact. A “skin” 4134 is shown on the outer surfaces of the section directly adjacent to EPS foam that is bonded together by adhesive layer 4146 causing a secure bonding and sealing of the tray wall and the flap together. The sealing and bonding can be arranged so as to provide a completely sealed and “liquid tight” condition such that any liquids contained in the spaces 4130 and 4132 will be retained within the spaces. As shown in FIG. 49, an adhesive layer 4142 can be provided between base 4138 and outer cover 4240 so as to bond the outer cover 4240 to the base 4138.

Referring now to diagram FIG. 47, an elevation of finished package 4118, is shown. The finished package 4118 includes a packaging tray as shown in FIG. 45 with perishable goods located in tray cavity with an outer cover 4120. The outer cover 4120 includes an envelope of material that completely covers and encloses the packaging tray and the perishable goods and is heat sealed to provide a sealed package. The outer cover 4120 may be manufactured from a shrink material such as Clysar, manufactured by DuPont, or alternatively a stretch wrapping material such as Mapac -M, a plasticized polyvinyl chloride web material manufactured by AEP Industries, Inc. The outer cover 4120 can be printed such that all surfaces are rendered opaque leaving a transparent window 4122 on the upper surface as shown in FIG. 47. Clysar outer cover shrink material is then heat shrunk such that the outer cover shrinks, holding flaps against the tray walls. Alternatively, if the Mapac -M, pPVC material is used, heat shrinking may not be required and the Mapac -M material is stretched over the tray with flaps such that flaps contact the tray walls. Apertures 4124 are preferably provided on the four vertical faces of the finished package. The apertures are conveniently located in such a location so as to minimize the probability of any liquids, such as blood or “purge”, escaping therethrough.

The EPS material, which may contain a suitable surfactant, used in production of the packaging tray may be manufactured so as to have a capacity to absorb liquids such as blood. Incisions and/or perforations provided in sections of the packaging tray can enhance the capacity of the EPS material to absorb the liquids such as blood.

Referring now to FIG. 48, an enlarged view of a cross section of the tray of FIG. 45 is shown. The flap and the tray wall are in intimate contact and a gap 4126 is arranged between openings 4128 and the tray side wall. Spaces 4130 and 4132 are directly adjacent to incision sections 4118 and 4116. A suitable adhesive can be applied between the flap and the tray at all direct points of contact therebetween causing a secure bonding and sealing of the tray wall and the flap together. The sealing and bonding can be arranged so as to provide a substantially sealed and “liquid tight” condition such that any liquids contained in spaces 4130 and 4132 will be retained. The shrink film, outer cover 4120 holds the flap firmly and tightly against the tray wall. Referring now to FIG. 49, a cross-section of the tray base portion and outer cover 4120 are shown to be in adjacent disposition. An adhesive layer 4142 can be provided so as to completely bond the outer cover 4120 to the base of tray 4138.

Furthermore, when the outside-surface of foam is arranged to have a capacity to absorb liquids, such liquids can be retained and substantially prevented from escaping from within the finished package. Additionally, a suitable adhesive can be provided between the tray flange rim 4144 and the outer cover 4120 where the continuous flange rim 4144 is in contact with the outer cover 4120 so as to cause bonding in a substantially liquid tight fashion therebetween. The openings at sections 4116 and 4118 in the tray wall, openings 4128 in the flaps and apertures 4124 in the outer cover 4120 provide a passage and direct communication from the tray cavity to the outside of the finished package such that when the finished package is exposed to a vacuum, air and gasses can be removed from within the package and replaced with a desired gas or mixture of gasses through the passage.

Embodiment 5

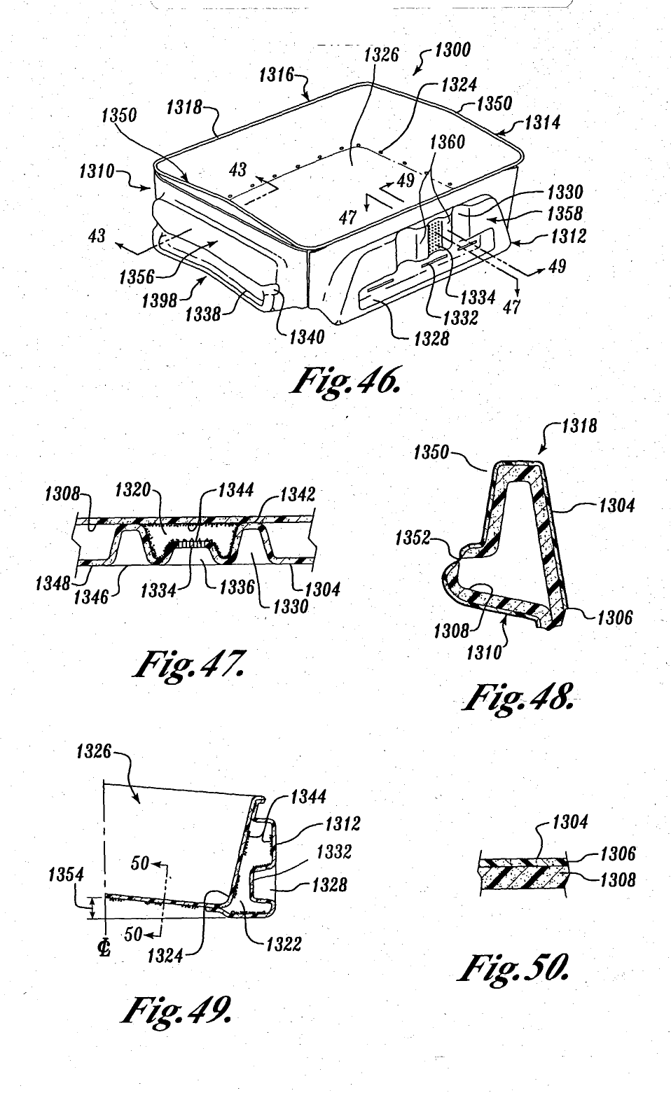

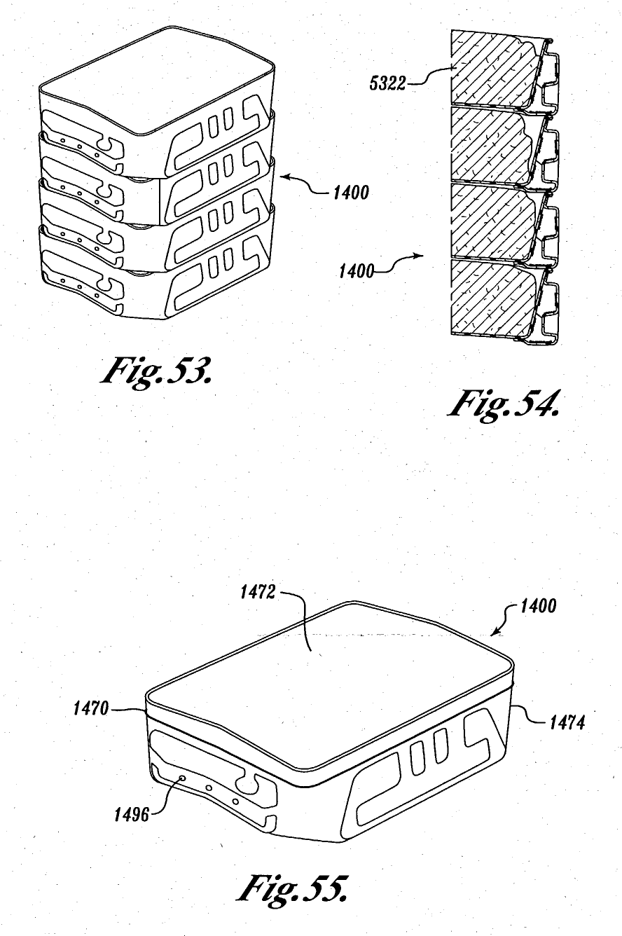

FIGS. 50-53 show yet another embodiment of a tray with flaps constructed according to the present invention. The tray 4808 of this embodiment is similar in operation to the trays described above. Referring to FIG. 50, a tray is shown whereby flaps 4802 and 4806 can be arranged so as to have no openings therein, and flaps 4800 and 4804 can be arranged to have openings 4810 therein. Tray 4808 as shown in FIGS. 50-56 can be over wrapped with a web of pPVC to produce a finished package. The web of pPVC can be printed on the inner surface with a heat activated coating that can provide a method of bonding the web of pPVC to faces 4812 on flaps 4802 and 4806 and face 4814 on flaps 4800 and 4804. The heat activated coating can be applied to the web of pPVC by typical offset printing process and applied in those areas of pPVC that will come into contact with the faces 4806 and 4814 after over wrapping the tray 4808 with the web of pPVC in such a manner that when heat is applied to the pPVC in contact with the faces 4812 and 4814 the web of pPVC will become bonded to the faces 4812 and 4814. The web of pPVC will thereby cover recess 4816 and recess 4818 in flaps 4800 and 4804 but will not fully enclose and isolate the recesses leaving openings at openings 4820. The web of pPVC can also thereby cover recess 4822 and recess 4824 in flaps 4806 and 4802 but will not fully enclose and isolate the recesses leaving openings at openings 4826. In this way a path of direct communication from internal space of the tray to external atmosphere is provided through apertures 4828 into space 4830 shown in FIG. 274 through apertures 4810 in flaps 4806 and 4802 only into recessed 4822 and recesses 4824 and through openings 4826 into space between the pPVC outer cover and tray through space 4830 and therefrom through openings 4820 into recesses 4816 and 4818 and finally through apertures that are provided in the outer cover pPVC adjacent to the recesses 4818 in flaps 4800 and 4804 to external atmosphere.

The tray 4808 may be thermoformed from any suitable material such as expanded polystyrene EPS materials as shown in FIGS. 242-246 and FIGS. 71-72. The EPS materials may include several layers of co-extruded material that are arranged so as to allow any liquids that may enter space 4830 of FIG. 274 through apertures 4828 to be absorbed into the open cell structure of EPS materials through surface perforations 4850 that can be provided into the surface of the EPS materials that are adjacent to space 4830 only. Liquids can thereby be concealed within the layers 4502 or 4508 as shown in FIG. 173.

The pPVC outer cover can be bonded to the underside of the tray 4808 by any suitable method, such as heat sealing or adhesive bonding, so as to follow contours of recess 4832 shown in FIG. 173. The pPVC outer cover can also be bonded, by any suitable method, such as heat sealing or adhesive bonding, to flange rim 4834 along the full length and perimeter thereof so as to inhibit liquids from passing between the flange rim 4834 and the pPVC over wrapping web of material after the bonding.

In this way liquids that may accumulate in internal space of tray are restricted from escaping from within the finished package, while providing a path to allow extraction and injection of suitable gasses into and out of the internal space of tray.

In another preferred embodiment the flaps may be extended as shown in FIG. 54, flap 5056 to provide additional cushioning around the perimeter. The additional cushioning can provide protection of the package and the package contents during shipping from the point of production of the finished packages and a point of sale to consumers such as a supermarket. FIG. 273 shows a tray flap with a space wherein substances 4850 may be added, such as wax-coated iron particles. FIG. 274 shows a cross section of a tray with flaps, wherein the flaps form a plurality of spaces between the tray wall and the flap (outer wall).

Embodiment 6

Referring now to FIG. 55, yet another preferred packaging tray 5200 with flaps, is shown. The flaps are shown folded into a desired position and bonded to the tray base and/or walls. The packaging tray with flaps can be thermoformed from suitable plastic materials such as polystyrene, polyester and polypropylene in a solid or foamed sheet. The present packaging tray is preferably thermoformed from expanded polystyrene (EPS) sheet. The EPS sheet may include a single or multi-layer construction as shown in FIG. 59. Any suitable sheet of EPS material may be used but most preferably the sheet includes 3 layers 5204, 5206, and 5208. The layer 5204 preferably includes a layer of solid plastic material such as polystyrene sheet with any suitable thickness, preferably about 0.001″ and is laminated to layer 5206. Layers 5206 and 5208 preferably include “closed” or “open cell” structures either with or without a surfactant added prior to extrusion of the sheet such that the finished tray may have a capacity to absorb water and other liquids such as “purge” or blood. The EPS sheet may be extruded with a “skin” covering on a surface that will become the in-side of the finished tray. The “skin” can be arranged so as not to absorb the liquids. The non-absorbent “skin” may be provided on both surfaces of the extruded sheet. The layer 5204 may contain a white or other suitable pigment, such as white titanium dioxide in such a quantity so as to prevent visibility of any discoloration that may be caused by blood or purge absorbed by layers 5206 or 5208. In this way the layer 5204, which will be visible, will not show substantial discoloration as a result of blood or purge that has been absorbed by any of the other layers.

Tray 5200 with flaps is most preferably thermoformed from sheet material of suitable thickness, preferably about 0.01″ to about 0.15″ but preferably about 0.090″ and includes a tray with tray cavity and four flaps. Two flaps are shown as flap 5210 and flap 5212. Flap 5210 is an end flap and flap 5212 is a side flap. The construction of tray 5200 with folded and bonded flaps, allows for production of suitably rigid finished trays even though the thickness of the sheet material from which the tray is formed, is substantially thinner than would otherwise be required in conventionally formed packaging trays that do not have “flaps”.

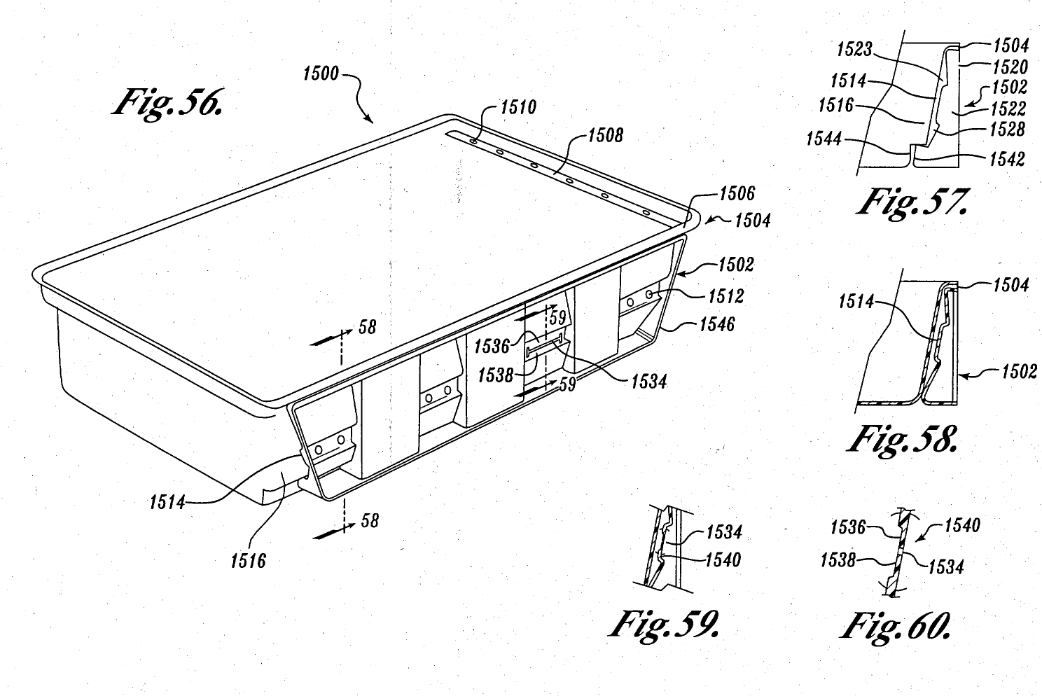

Flap 5210 can be provided with a profile that is a mirror image of 5214 (not shown), and flap 5212 can be provided with a profile that is a mirror image of flap 5216. Flaps 5210, 5212, 5214 and 5216 are attached to the outer edge of flange 5218 at hinges as shown by the hinge lines, such that flaps 5210, 5212, 5214 and 5216 can be folded downwardly and intimately contact outer surfaces of the tray walls at locations as required. One or more flaps may be provided and folded to provide an enclosed space 5222 and/or cavity 5220 shown in FIG. 58. The cross-sectional profile of flaps 5210 and 5214 are similar. The cross-sectional profile of flaps 5212, and 5216 can be similar.

Referring again to FIG. 55, the packaging tray includes a base with four upwardly extending tray walls terminating at a continuous flange 5218. Tray walls can be perforated with openings 5224 directly therethrough with the perforations arranged so as to communicate between the tray cavity and space 5222. The apertures 5224 can be located so as to allow any purge that may be present in the tray cavity 5226 to pass therethrough and into space 5222. The perforations 5224, may include small holes, slots or incisions that extend fully through the tray walls. The flaps can be bonded to the tray walls so as to retain any liquids that enter therebetween and into space 5222. Any suitable liquid absorbing medium may be attached to one or more of the flaps so that when the flaps are folded and bonded the liquid absorbing material will be enclosed within space 5222. The liquid absorbing material could therefore absorb any liquids that may enter the space 5222 during use of the tray.

Referring again to FIG. 55, recesses 5228 and 5230 are shown in flap 5212. Slots 5232 are shown in flap 5212 and are located in recess 5228. Perforations 5234 are provided in flap 5212 and are located in recess 5228. Recesses 5238 and 5240 are shown in flap 5210. A suitable adhesive is provided at the interface between flaps and tray walls so as to provide a bonding of flaps to tray walls. Bonding of flaps and tray walls is provided in such a manner so as to ensure complete bonding of flaps to the tray wall along strips that follow a path close to what will become a perimeter of the flaps. FIG. 58 shows a cross-section through flap 5212 and tray wall showing enclosed space 5222. Space 5222 is enclosed between the flap and the tray wall in a substantially liquid tight manner. Iron powder deposits 5244 can be applied to locations on the tray walls and flaps adjacent to space 5222 and also to the underside surface of the tray base. The iron powder deposits 5244 may include iron powder particles that have been fully coated with a special coating material, such as wax. The coating can be arranged to prevent direct contact of the iron particles with ambient air or any gas that may be present, until such direct contact with the air or gas is required. The coating may have physical and/or chemical properties that can be activated by exposure to microwaves, radio waves or a magnetic field. For example, when using wax as a coating, microwaves will cause the iron particles to heat up, thereby melting the wax and exposing the iron particles. The coating may also contain an adhesive that is heat activated and otherwise does not bond with other matter until activated and/or heated by exposure to any suitable microwaves, radio waves, magnetic field or any suitable electrically or sonically induced waves or field. The coated iron particles 5244 can be deposited on the surfaces by apparatus shown in FIG. 140 herein. The coated particles can be coated with a substantially gas barrier substance that is altered when exposed to suitable microwaves or an electrically induced magnetic field. Exposure to the waves, field or microwave can cause the coating gas barrier substance to physically or chemically alter and become gas permeable, in such a manner that will cause the iron particles to immediately or subsequently react with any gases such as oxygen that may be present. The quantity of iron particles 5244 provided and attached to the tray and flap selected surfaces can be measured and controlled in an amount having an equal or greater capacity that may be required to absorb substantially all oxygen gas that may be present and/or become present by permeating into the finished package.

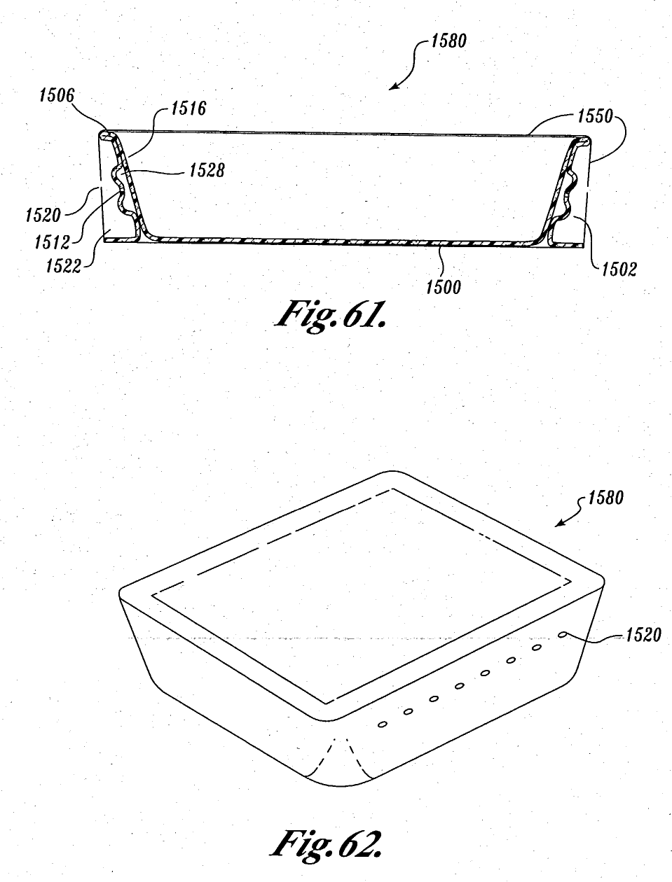

Referring now to FIGS. 55-209, a plurality of finished packages that may be conveniently stacked as shown in FIG. 62 may be placed in a gas barrier master container which can then be evacuated of substantially all air. Ambient air that may be present within the finished package tray cavities and spaces such as 5222 shown in FIG. 58 will be evacuated through apertures 5306 and replaced with a suitable gas. The air can be replaced or displaced with any suitable gas prior to hermetically sealing the master container to provide a single container with finished packages enclosed and sealed therein. At a convenient time after sealing the sealed master containers may be exposed to a suitable level of microwaves or magnetic field or other suitable source of energy that will selectively alter the gas barrier coating on the iron particles so as to render it permeable and further activate iron particles to oxidize with any residual oxygen that may remain within the master container. The substance “IPD” 5244 may include any suitable substance that can be applied in any convenient manner to the trays 5200 so as to remain inactivated until exposed to the microwave and/or magnetic field in such a manner as to render the IPD activated. When the IPD is selectively activated by any suitable source of energy that is applied before or after the trays are loaded with goods, the IPD can react with and thereby absorb any residual oxygen gas remaining within the finished packages, in such a manner so as to inhibit the formation of metmyoglobin that may otherwise be formed as a result of available oxygen that has been released during reduction of any oxymyoglobin that may be present in the finished package after sealing the master container.

The IPD can be applied in any suitable manner to selected surfaces of the tray and/or flaps so as to not directly contact but to be in close proximity to goods that is subsequently loaded into the cavities of trays. Ground or sliced red meats may have been exposed to ambient oxygen, after grinding or slicing and prior to packaging, for such a period of time that deoxymyoglobin present in freshly cut red meats has reacted with ambient atmospheric oxygen to form oxymyoglobin. Fresh meat with oxymyoglobin may be then packaged in a substantially oxygen free gas package such as a barrier master container that has been evacuated and filled with any suitable gas that may contain less than 500 PPM oxygen. After packaging, the oxymyoglobin will reduce to deoxymyoglobin thereby releasing oxygen gas into the spaces in the master container. The released oxygen can then react with the deoxymyoglobin to form metmyoglobin. The metmyoglobin is brown in color and is undesirable and consumers are unlikely to purchase meat that is brown in color. The IPD substance can be provided within the finished packages in such a manner so as to substantially absorb, and thereby render inactive, the oxygen that has been released by reduction of the oxymyoglobin to deoxymyoglobin, after hermetically sealing the finished packages. In this way the formation of undesirable metmyoglobin can be inhibited and/or minimized. In order to enhance the absorption of oxygen gas by the substance IPD, any suitable method to cause circulation and movement of any gas inside the finished package can be incorporated. Such methods may include shaking or suitable movement of the finished and sealed master containers in such a manner so as to cause gas to circulate through apertures 5306 from the spaces in the tray cavities and more particularly near and over the exposed surfaces of the goods.

In another alternate embodiment, the present invention provides capsules of suitable size but most preferably having a diameter or widest/longest/deepest dimension of less than 0.25″, wherein capsules have a generally rounded, spherical or oval profile with a continuous capsule wall of any suitable thickness but most preferably approximately 00.060″ thickness, with a cavity enclosed within the continuous capsule wall and wherein each enclosed capsule cavity contains a suitable quantity of any selected agent, substance or material, such as, for example, a bactericide, a water absorbing gel, a CO₂ generating agent. The capsule wall may be manufactured from a material such as wax or a flexible waxy plastics material that is affected by micro waves, RF (radio frequency) or a magnetic field that is generated from a controlled source and with such an intensity that it can cause the capsule walls to rupture or soften or dissolve and to such an extent that the contents of the capsule cavities will be expelled or allowed to escape from within the enclosed capsule cavity. A suitable quantity of capsules or combination of capsules containing separate quantities of several agents, with any selected agent(s) contained therein may be enclosed, for example, within the cavity(ies) of any suitable packaging tray prior to use in a packaging application. At any time during or after assembly of such a tray with capsules contained therein, it may be exposed to the appropriate source and intensity of micro waves, RF (radio frequency) and/or a magnetic field and in such a way so as to cause the release of any agents contained within the cavity of the capsules. In this way, for example, a bactericide may be held until required for use within the package walls or base and after assembly of the package such as a tray containing fresh red meat, at which time the bactericide can be released and thereby made available to substantially kill bacteria, fungi, virus or any undesirable life form that may be dangerous to human or animal life.

Referring now to FIG. 64, a finished package 5300 is shown with a seal 5324, that extends continuously around a horizontally disposed perimeter of the finished package. Seal 5324 is provided so as to bond an over wrap 5326, which is positioned above the seal 5324, to an over wrap 5328 which is located below the seal 5324. The seal 5324 can be provided by any suitable method such as by heating and is arranged to be a complete and continuous and gas tight seal along the full length of the seal 5324. The over wraps 5326 and 5328 may be either both clear and transparent or alternatively printed but most preferably the 5328 will be printed as desired. 5326 and 5328 may be produced from a substantially gas barrier material such that when sealed along seal 5324 a hermetically sealed finished package is produced. Alternatively gas permeable plastic materials may be used to produce the over wraps. The profile of over wrap 5326 and 5328 may be provided by a thermoforming method prior to assembly of the finished package whereby a loaded tray 5300 is located into a thermoformed over wrap 5328 prior to sealing a thermoformed over wrap 5326 thereto at seal 5324. Alternatively, both over wraps 5326 and 5328 may be produced from a web of “stretched” material such as pPVC. The web of pPVC may be held taught above a depression where the depression is similar in profile to the lower section of tray 5300 but slightly larger so as to allow a neat location of tray 5300 therein. A vacuum can be applied in the depression so as to stretch the pPVC web therein and thereby provide a lower over wrap 5328. Tray 5300 can be located into the stretched pPVC depression and heat sealed at 5324 to an over wrap 5326 that can be formed in a similar manner by stretching into an inverted depression, of suitable size, that is located directly above and aligned therewith so as to allow such sealing at seal 5324. Apertures 5306 may be provided in the over wrap 5328 or alternatively, over wrap 5328 may be maintained without apertures so as to provide a complete finished and substantially gas barrier package.

In another preferred embodiment, iron powder that has been completely coated with a substance, such as a special type of wax, can be included in one or more layers of a tray thermoformed from a one, two, three or more layer sheet of co-extruded EPS foam. The special type of wax coating can be arranged so as to prevent contact of undesirable substances such as water, with the powdered iron that is completely covered by the special type of wax coating, until a suitable time. The special type of wax coating can be arranged so as to melt or otherwise change when exposed to an electromagnetic field, microwaves or other suitable medium. The melting or change to the special type of wax coating can allow the powdered iron to become exposed and thereby react with oxygen gas that may be present, after exposure to the electromagnetic field, microwave or suitable medium. In this way trays, formed from the EPS foam with coated iron powder contained therein, can be used to package perishable goods and when the tray with perishable goods has been over wrapped with a gas permeable web of plastics materials, can be located in a master container with a suitable gas, and all hermetically sealed so that the master container contains the over wrapped tray with perishable goods and a suitable gas. Immediately after hermetically sealing the master container, the master container can be exposed to an electromagnetic field, microwave or other suitable medium, so as to change the coating and thereby expose the iron powder and allow reaction of the iron powder with any oxygen gas that may be generated within the master container as a result of reduction of oxymyoglobin.

Immediately prior to or after loading goods such as ground or sliced meats into the tray cavities, the trays 5320 can be exposed to a suitable level of microwaves or a magnetic field sufficient to cause coating SCM to be altered and thereby allowing the IPD to react with any oxygen that is present and in contact with the IPD. In this way and due to the close proximity of the IPD to the oxymyoglobin, the oxygen that is released by reduction of the oxymyoglobin, can be quickly absorbed by the iron powder IPD as soon as it contacts therewith.

Pre-conditioning of the goods, prior to loading into the trays can reduce the quantity of oxymyoglobin formed immediately after slicing or grinding of the goods but before packaging and sealing in the master container. The pre-conditioning can include the process of exposing the goods to carbon dioxide or any suitable gas at any suitable pressure or high pressure immediately after and/or during slicing and/or grinding. The goods can be exposed to the gas at high pressure in such a manner that the gas becomes highly soluble in liquids and oils present in the goods, and dissolves in the liquids and oils. The goods can be exposed to high pressure gas for an adequate period of time to allow saturation of the liquids with soluble gas. Saturation of liquids and oils will therefore occur at the high pressure. Therefore, when goods are removed from exposure to high pressure gas and returned to exposure to normal ambient atmosphere for subsequent packaging into finished package and/or master container, gas (or gases) that have dissolved in the liquids and oils will be then exposed to a lower gas pressure. Gas that has dissolved under the high pressure into liquids will be “released” and return to a gaseous condition. The release of gas will occur at the surface of goods and during this event, any oxygen that is present in atmospheric air will be inhibited from contacting the surface of the goods. This procedure can therefore provide a method to slice and package goods while reducing and minimizing the formation of oxymyoglobin immediately prior to packaging and consequently minimizing the otherwise corresponding formation of metmyoglobin after packaging in the manner described herein. The pre-conditioning process can also include the method of lowering the temperature of the goods to any suitable “pre-conditioning” temperature that may be 28 degrees F. prior to slicing and/or subsequent immersion in high pressure gas with exposure thereto. After removal of the goods from immersion in and exposure to high pressure gas at a lower temperature the goods will be exposed to ambient atmospheric conditions which will be at a higher temperature and lower gas pressure. After packaging the goods in the finished package and/or master container, the packaged, goods can be stored and maintained within a suitable temperature range that may be higher than the “pre-conditioning” temperature. The pre-conditioning temperature may be maintained within a range of approximately 29 to 32 degrees F. The suitable post conditioning temperature range may be maintained between 33 to 36 degrees F. The difference between the pre-conditioning temperature and the post conditioning temperature may be less than 15 degrees F. Goods may be pre-conditioned by passing through a first tube at a suitable pressure where the first tube has a diameter of ‘X’ and is centrally located within a second tube that has a diameter of ‘X’+1 inch or more and thereby providing a space between the outer surface of the first tube and the inner surface of the second tube. A temperature controlled liquid such as brine or glycol can be provided in the space between the first and second tubes and thereby provide a cooling or heating devices that will allow temperature controlling of goods that are present in the first tube. A specified and controlled quantity of any suitable gas at any suitable temperature and pressure can also be provided in the first tube with goods so as to provide a controlled devices of dissolving suitable gasses into the goods. The goods with the gas can be held in the first tube for a suitable period of time so as to allow the gas to dissolve into the liquids and oils in the goods at a suitable temperature. The first tube can be filled with compacted goods in such a manner so as to restrict any gas, that is provided therein, from escaping or leaking there from. The first tube may be provided with mixer therein to allow mixing of goods contained therein. The first tube may be fitted with scraper and substantially remove any solids, such as frozen liquids, ice and/or solids that may accumulate on the internal surfaces thereof.

Referring now to FIG. 56, a cross-sectional view through tray wall and flap 5212 is shown. For illustration purposes, a section of web material 5246 is shown bonded to plane 5248. Recesses 5236, and 5230 are therefore shown as enclosed channels. Cavity 5220 is fully enclosed and sealed from external communication save through perforations 5234 by bonding at interface 5242. Gases can therefore communicate through the perforations 5234 and into the cavity 5220 and recess 5236. The gases can therefore come into direct contact with deposits 5244. The deposits 5244 are preferably applied to tray and flap surfaces that will not come into contact with any goods that are subsequently located in the tray cavity.

Referring again to FIGS. 57-58, a cross-sectional view through crest 5250 is detailed in FIG. 57 with hinge 5252 between the flap 5210 and flange 5218. In FIG. 58, tray 5200 is shown in a horizontal disposition with the opening in tray cavity facing upwardly. The tray base is profiled so as to be higher at the center of the tray base than at the lowest point of the tray cavity (at a radius connecting the tray base to the upwardly extending tray wall) and a clearance, designated by arrow 5254 is shown. The clearance 5254 is the distance (clearance) measured from the lowest point of the tray 5200, at the side flaps and the highest point of the under surface of the tray base. The clearance 5254 is arranged so as to suitably accommodate and “mate” with the crest 5250 when another tray (not shown) is located above and placed onto a lower tray 5200. In another alternate, the clearance 5254 may be enclosed by over wrap material to provide a cavity into which purge may enter through suitably located apertures in the tray. Suitable liquid absorbing material with a suitable capacity may be provided between the over wrap and underside of the tray base. The crest 5260 and clearance 5254 prevent the base of a stacked tray from contact with an overwrap on the bottom tray. In this manner, the goods are prevented from touching the base of an adjacent tray.

Embodiment 7

Referring now to FIGS. 60-61, another preferred embodiment of a tray 5300 with flaps is shown. Tray 5300 has similar features to tray 5200; therefore, those features ill be alluded to by the same reference numerals. Tray 5300 with depression therein is shown after over wrapping with overwrap web 5302. Web 5302 may include a plastic web of material such as pPVC. The depression may be substantially filled with goods such as ground beef prior to over wrapping with the over wrap 5302. Over wrap 5302 may be stretched in such a manner as to contact the goods in the depression. The web of material 5302 may be printed with information that gives detail of the contents of the over wrapped tray. Further more the inner surface of the over wrap 5302 may have been processed and a heat activated coating applied thereto, by any suitable method, and in those areas that will come into contact with planes 5258 and 5256 as shown in FIG. 55. A suitable heat source can be provided to activate the heat activated coating so as to cause bonding of the web 5302 to flaps 5212 and 5210 at planes 5256 and 5258 and at locations shown as shaded sections 5304. Alternatively, the areas shown as 5258 and 5256 may be coated, by any suitable method, such as by “ink-jet”, with any suitable bonding material such as a heat activated coating. Apertures 5306 may be provided as shown. Apertures 5306 can be provided after bonding of the web to plane 5256 such that communication directly into recess 5238 is provided. A cross-sectional view is shown in FIG. 61 through where web 5302 has been bonded to plane 5256 thereby providing space 5308 and recess 5310. Apertures 5312 in flap, apertures 5314 in wall of tray and apertures 5306 in web 5302 are provided. In this way a communication is provided between the tray cavity to the outside of the over wrapped tray following a path that will readily allow gases to communicate therethrough but will restrict escape of liquids such as purge. The communication follows a path through aperture 5314 into space 5316, through aperture 5312 into recess 5310, through recess 5310 to space 5308, through space 5308 to recess 5318, through recess 5318 to recess 5238 and through aperture 5306.

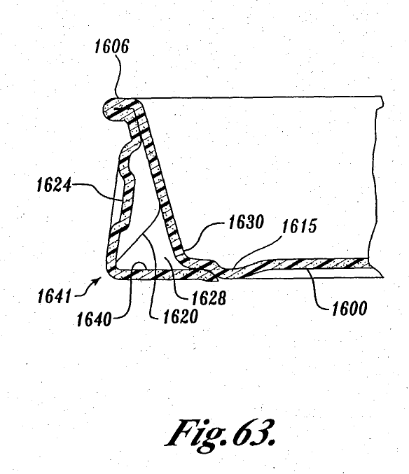

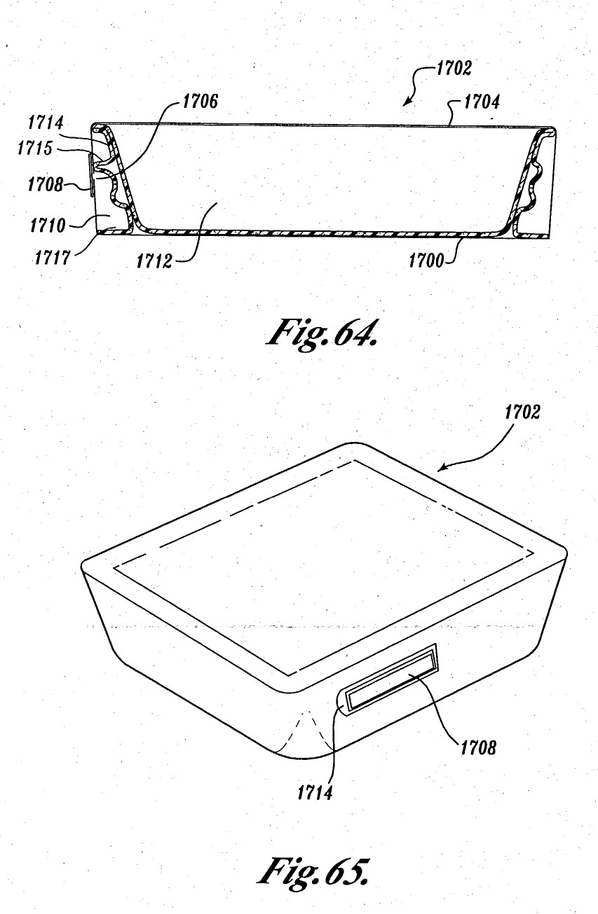

Referring now to FIG. 62, a stack of 4 finished packages of the tray shown in FIG. 60 is shown. A cross-sectional view is shown in FIG. 63, through the stack of packages. It can be seen that with this arrangement an upper tray is in contact and rests on the flange of a lower tray. As can also be seen, clearance provided in the underside of the base of tray mates with the upper profile of a lower tray whereby the contents of a lower tray are located in close proximity to the upper tray but are not in contact with the underside of the upper tray.

Embodiment 8

Referring now to FIG. 65, a preferred packaging tray 3200 with flaps, is shown. FIG. 65 shows a flap 3202 attached to a tray 3200 by a hinge 3204 to flange 3206. Tray can also be provided with similar flaps attached by hinges to all four sides of the tray at hinge lines between flaps and flanges. However, FIG. 65 shows a tray that has two flaps, on opposing sides, where one only flap can be seen.

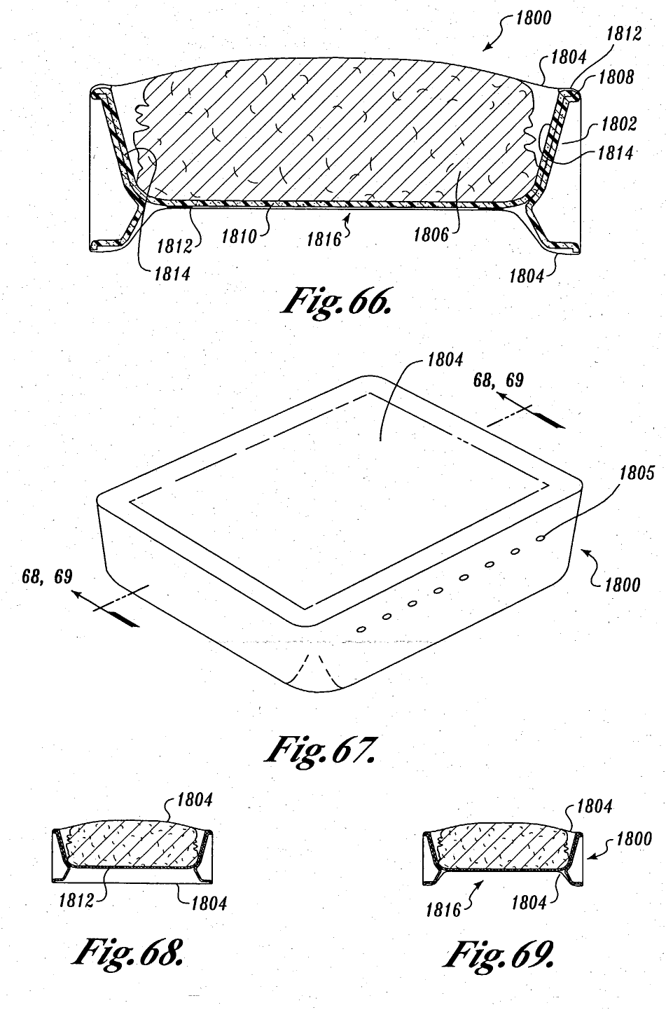

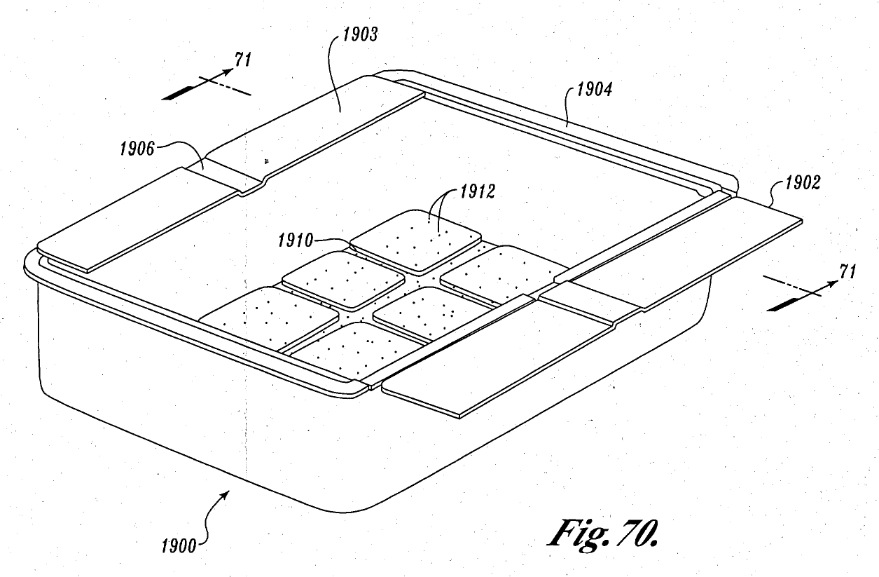

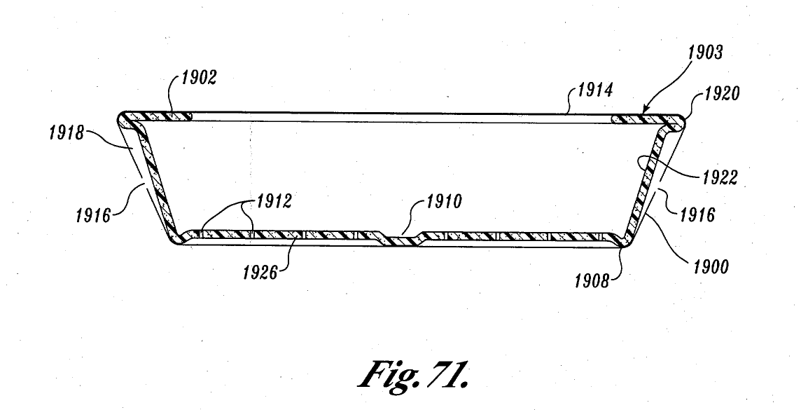

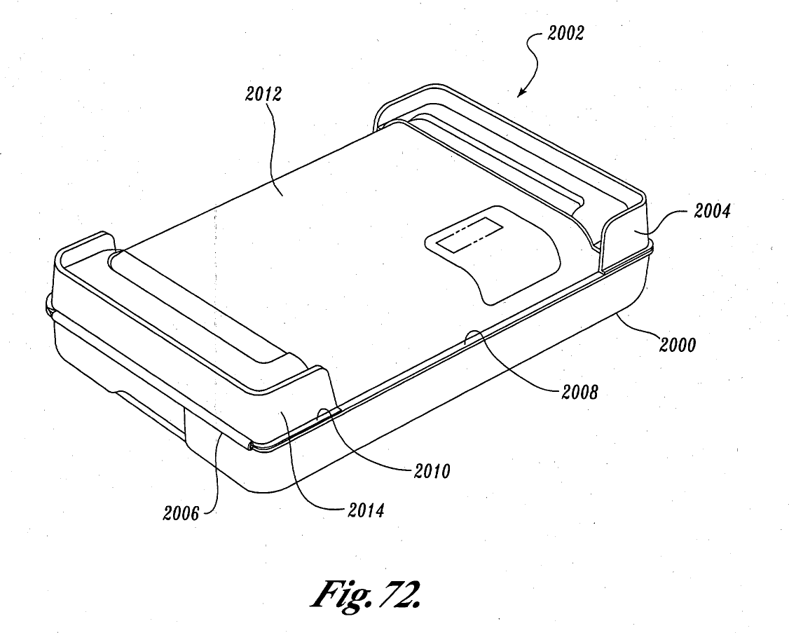

Packaging tray 3200 includes a substantially flat base that may have depressions, ridges, apertures and/or penetrations provided therein, with upwardly extending walls terminating at a continuous flange 3206. A ledge 3208 is provided in two of the four walls in a horizontally disposed position and level, across the face of the side wall and between the flange and the base of tray. The other two walls have flaps 3202 attached thereto, at a hinge connecting the flaps to the flange. Apertures 3210 provided are provided in ledge 3208. Tray 3200 with flaps 3202 may be thermoformed from a suitable material such as solid or foamed polystyrene (EPS), polyester, polypropylene or other suitable material. Apertures 3212 are provided in flaps at optimized locations that will restrict passage of solid or liquid matter therethrough. An alternative aperture construction is also shown as slot 3234 cut through a compressed section 3240 of tray in cross-section FIG. 68 and in an enlarged view, FIG. 69, showing details of the slot 3234 provided in a section of the flap along ridge 3214. Slots may also be located at other locations. The region surrounding the slot is compressed to provide a section of thinner cross-sectional thickness. Slot 3234 includes an incision in the compressed section of the ridge and may be provided with an “H” profile. The slot with “H” profile provides two adjacent flaps, 3236 and 3238, respectively, that can open when a differential in gas pressure is provided on opposite sides of the flap, however, when the gas pressure differential has equalized the two adjacent flaps shown as “H” flaps, can close to the former condition before opening.

Flaps 3202 are folded downwardly, against the upwardly extending adjacent tray walls 3216 as shown in end view of flap in FIG. 66, prior to over wrapping. Flaps 3202 can be provided with a fastening lug 3242 that is profiled so as to “mate” with a corresponding fastening recess 3244 provided in tray 3200. The fastening lug 3242 and fastening recess 3244 holds flap 3202 in a downwardly located position in convenient readiness to be inserted into a bag prior to sealing and shrinking. Flaps 3202 may otherwise prevent automated loading of the tray with perishable goods therein, into the bag.

Perishable goods such as fresh ground beef can be placed in the tray cavity prior to tray and perishable goods being over wrapped and shrink wrapped with a material such as Clysar AFG Anti Fog Polyolefin Shrink Film. Shrink film may be in the form of a preformed fabricated printed pouch (or bag) or alternatively, unrolled from a continuous web of rolled material that is formed into a tube on a machine such as a flow overwrapper, and cut into convenient sized sections that can be heat sealed (or cold sealed), so as to completely cover the assembled packaging tray and contents, prior to heat shrinking. The assembled tray with flaps, perishable goods and sealed overwrap are then passed through a heat shrink tunnel that causes the overwrap material to shrink and provide a taut and relatively tight cover over the packaging tray and goods. Flap 3202 is provided with a continuous rim 3246. The continuous rim 3246 is provided in such a manner so as to contact the inner surface of the outer cover 3218. Rim is in continuous contact around the perimeter of the flap and substantially restricts passage of matter between the rim and the outer cover 3218 as shown in FIG. 112.

Referring now to FIG. 112, a cross-section through the tray with flaps is shown after outer cover 3218 has been heat shrunk into a finished position. Apertures 3220 are provided in the outer cover. A space 3222 is provided between the flap and the outer cover such that apertures 3220 provide direct communication between the space 3222 and external atmosphere. A finished package 3224 is shown in FIG. 113. A plurality of finished packages can be assembled in a group that may include a total of twelve finished packages in three adjacent stacks of four finished packages. The group of twelve packages can be transferred by automatically into a thermoformed, substantially gas barrier, outer master container as shown in FIGS. 35-36. The barrier master container 3226 containing the finished packages may be located within a vacuum chamber and substantially all air evacuated from the vacuum chamber and from within the finished packages and the barrier master container. In this way, substantially all atmospheric air can be removed from within the finished packages via a route that follows a path through apertures 3210 (FIG. 65) into space 3228 (FIG. 66), through apertures 3212 (FIG. 65) into space 3222 (FIG. 112) and through apertures 3220 (FIG. 112). The vacuum chamber may then be filled with a desired gas such as any single, oxygen free or oxygen enriched blend of gases including nitrogen, carbon dioxide and/or any other suitable gases. The gases will therefore substantially fill all voids and spaces within the barrier master container and the finished packages contained therein, by following the reverse route of the path along which atmospheric gases had previously been evacuated. In this way, finished package 3224 provides a suitable package with space therein that can be filled with desired gases as required, while restricting the escape of liquid or solid matter, from within the finished package, to external atmosphere.

Referring again to FIG. 112 and FIG. 113, it can be understood that when a plurality of finished packages are assembled in a stack, the base of tray 3230 with adjacent flaps will be in intimate contact with the upper surface of the finished packages. The flaps will be in adjacent contact with the flange regions of the lower package, thereby supporting the weight of packages stacked above. Therefore, the perishable goods contained in any package located beneath a package stacked above, will be protected from damage.

Embodiment 9

Referring now to FIG. 88 an isometric projection of a finished package 2500 constructed according to the present invention is shown and a cross-section through an empty package 2500 is shown in FIG. 116. Tray 2502 is thermoformed from a suitable material such as expanded polystyrene. Flaps 2504 are connected to the tray by way of hinges 2506. Flaps can rotate about the hinges such that upper surface of flanges 2508 can contact directly and in alignment with flanges 2510 of the flaps.

Referring now to FIG. 115, a perishable goods 2600 such as ground meat is located in tray 2502 and a web 2512 is positioned directly above and over the tray and perishable goods. Web 2512 includes a transparent sheet of a suitable material such as plasticized PVC that has been coated with a heat activated adhesive covering the areas of the web that will come into contact with flange 2508 thereby providing a method of sealing web 2512 to the flanges 2508. After the web has been heat sealed to the flanges 2508, it is severed along the perimeter of flanges 2508. The web is hermetically sealed around the full flange extending around the perimeter of the tray. Flaps 2514 and 2504 can then be rotated about hinges 2506 and flanges 2510 of flaps are sealed to flanges 2508 of the tray as shown in FIG. 114.

Referring again to FIG. 115, flanges 2516 and 2518 are conveniently formed into a portion of the end walls of the tray. Web 2512 can be sealed to the flanges 2516 and 2518 as shown. Aperture 2520 can be provided in the location shown such that direct communication between the gas contained between the tray and the web 2512 and external atmosphere is enabled. The location of aperture 2520 inhibits the egress of any liquids that may accumulate within the package from escaping therethrough. Additionally or alternatively, aperture 2522 is also shown. A plurality of finished packages can be stacked together such that face 2524 engages with face 2526. Such engagement of faces provides a secure method of stacking finished packages.

Embodiment 10

Referring now to FIG. 117, another preferred embodiment of a finished package constructed in accordance with the present invention is shown. The package 2544 includes a tray 2526 and a tray cover 2528. Tray and cover can be formed from suitable materials such as expanded polystyrene (EPS). Cover 2528 has a window 2530 cut therein as shown and web 2532 is stretched taut and heat sealed to flanges 2534. Tray 2526 and tray cover 2528 are hermetically sealed together at flanges 2536 and 2538. Walls of tray and the cover can be printed directly thereon with information describing the contents of the package with all legally required information, pricing, weight of contents and cost per unit weight. Recesses 2540 (four) in ridge 2542 are conveniently provided to allow for evacuation of air from between stacked packages. Recesses 2540 can also provide for location of bands of printed paper that may provide further information and details of package contents.

Referring now to FIG. 118, a cross-section through the end section of two stacked and finished packages 2544 of FIG. 117 is shown. The perishable goods contents of the packages have been omitted for clarity. Faces 2546 and 2548 engage between the stacked finished packages. Engagement of the faces causes the outward urging of ridge 2550 of the lower package. The weight of the upper package is thereby transferred through the walls of the lower tray cover while inhibiting the inward displacement of flange 2552. Such an arrangement minimizes the likelihood of undesirable pressure being applied to the perishable goods contents of the lower tray by depressing the flange 2552 downwardly.

FIGS. 119-121 show an enlarged section of flange 2552, including side elevation, FIG. 120, and a plan view FIG. 119, of the underside of FIG. 120, and a further end view, FIG. 121, is shown with grooves and slots that allow direct communication between the inside of the finished package and atmospheric gases on the outside. Web 2554 is heat sealed along a continuous seal path 2556 and intermittent seals 2562 are shown with slots 2558 therebetween. Slot 2560 is therefore in direct communication with slots 2558 and 2564 and grooves 2566. Apertures 2568 are located adjacent to slot 2560 and directly between continuous seal 2556 and intermittent seals 2562. Web 2554 can include a sheet of plasticized PVC and is tensioned prior to sealing as shown thereby providing a transparent cover across the window. In this way direct communication from within the package to atmosphere is provided through apertures 2568, slot 2560, slots 2558, slot 2564, and grooves 2566, while minimizing the possibility of any accumulated liquids escaping that may be present within the package.

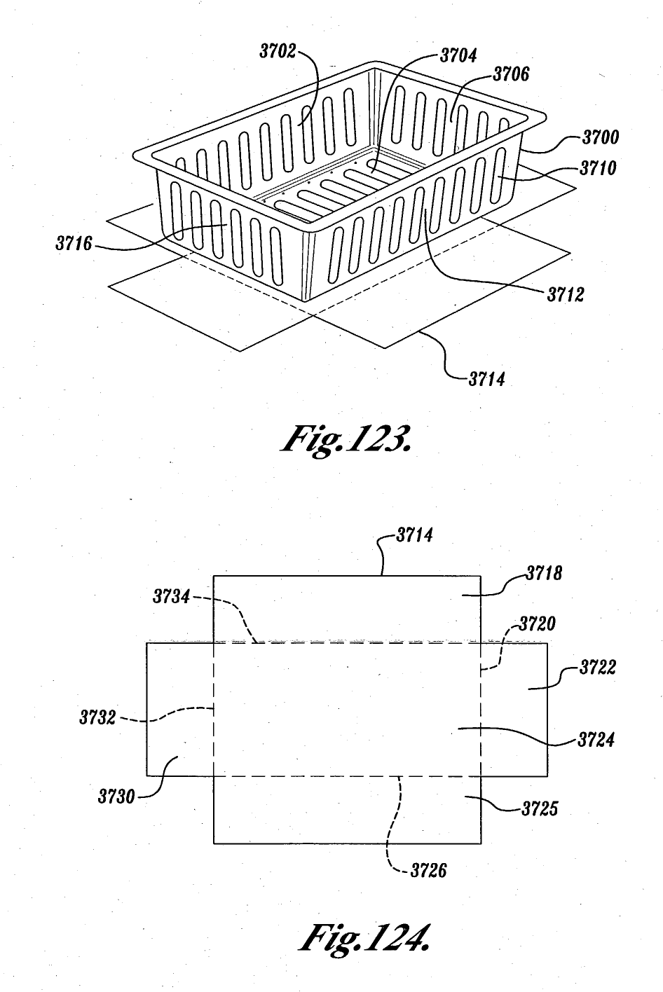

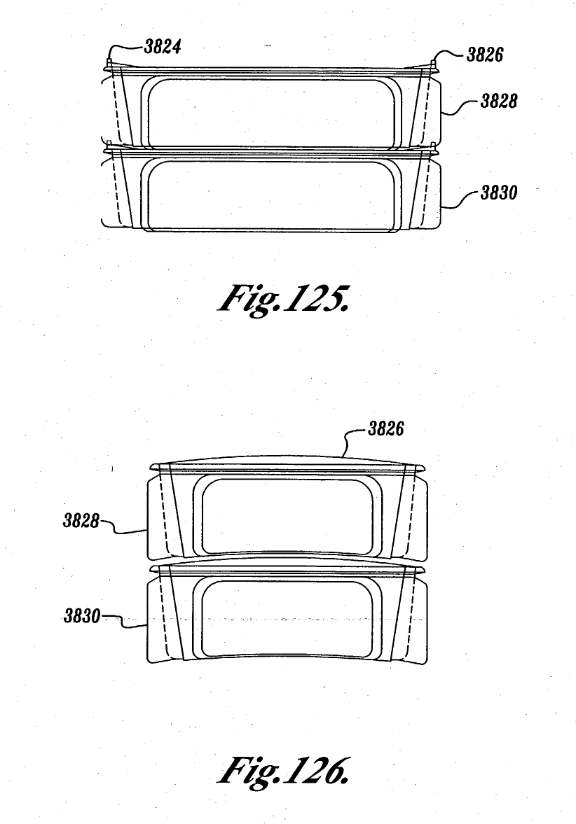

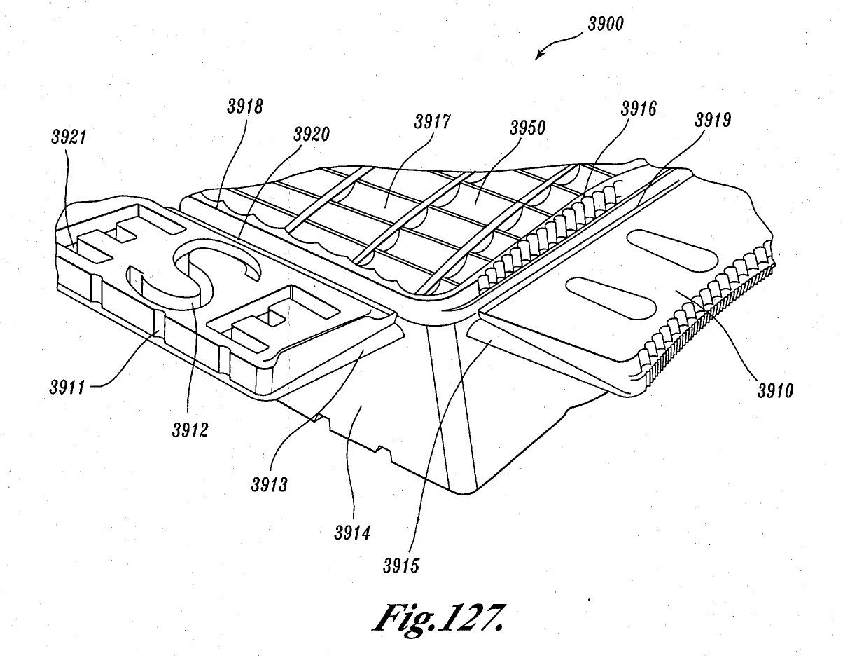

Referring now to FIG. 122, three empty packages 9608 with web sealed thereto, are shown stacked together. A section through a finished package 9610 is shown in FIG. 124, and a section through an individual package is shown in FIG. 123.

Referring now to FIG. 125 three finished packages 2570 are stacked together within a flexible gas barrier container 2572. A gas barrier lid 2574 is hermetically heat sealed to gas barrier container 2572 after substantially all air has been evacuated and replaced with a suitable gas that may be substantially oxygen free.

Embodiment 11

Referring now to FIG. 126, another alternative embodiment of a tray with flaps constructed according to the present invention is shown. Tray 2578 includes a first 2576 and second flap (not shown). Flap 2576 is attached to tray 2578 by hinge 2580. Ridges 2582 are formed in flap and corresponding ridges 2584 are formed in tray such that when flanges of flap and tray are in contact, portions of ridges are also in contact. Web 2586 is heat sealed to flanges 2588 and 2590. Apertures 2592 and 2594 are provided in the web such that when flanges of the flap and tray are parallel to each other and in closest proximity, apertures are in alignment providing direct communication therethrough. Concentric depressions 2596 are shown in FIG. 126 and in the detail of cross-section FIG. 127. Tray 2578 may be formed from a three layer construction of expanded polystyrene where the inner layer includes an “open” cell structure that will absorb liquids such as water and blood. Depressions are provided on the inner surface of the tray, to allow contact of liquids, that may be present in the tray, with the inner cells of the tray and allowing absorption of liquids by the open cell structure.

Embodiment 12

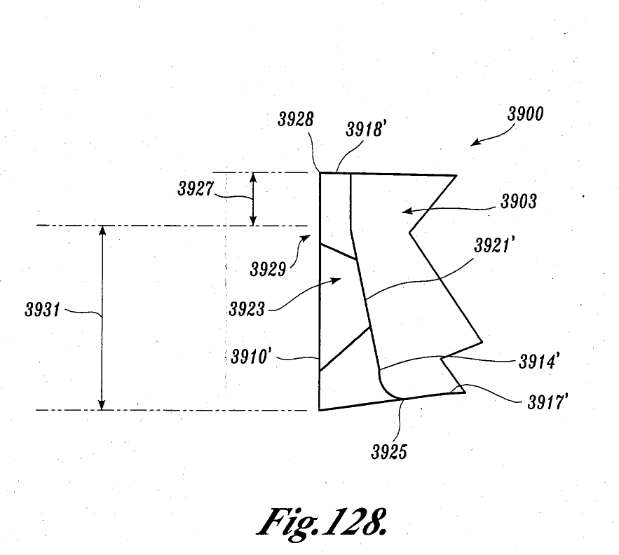

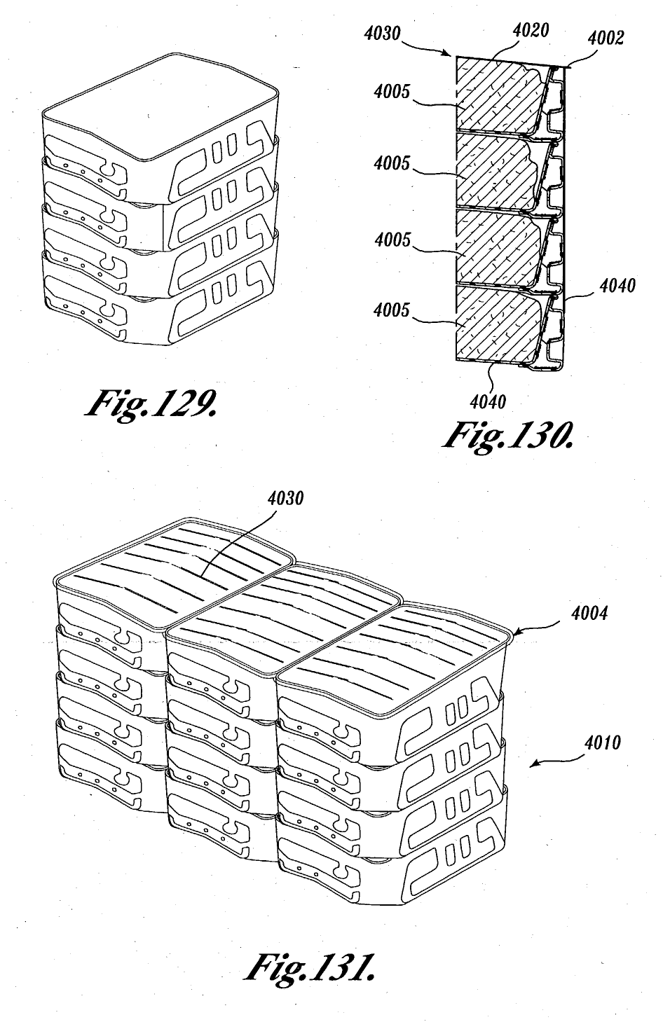

Referring now to FIGS. 128-130, another preferred embodiment of a tray with flaps constructed according to the present invention is shown. FIG. 130 shows a cross-section through a tray 2400, FIG. 129 shows a cross-section through a tray 2402 that contains ground meat with a web 2404 stretched over the ground meat and sealed to flanges 2406, 2408 and edge portion 2410. FIG. 128 shows a cross-section through a portion of a master container 2412 with finished packages 2414 stacked therein. A flap 2415 is shown that has been severed from tray 2402 and web 2404 is also sealed to flap 2416. A space 2418 is provided between web 2404 and inner surface of the flap 2416 providing direct communication between recess 2420 and aperture 2422. Flap 2416 and tray 2402 are therefore attached together by web,2404 and a gap 2424 is provided between flap 2416 and the tray 2402. An aperture 2422 is provided in web 2404 at flap 2416 portion and an aperture 2426 is also provided in web 2404 at tray portion. Recesses 2420 are provided in the flap 2416 such that when web 2404 is sealed thereto recess 2420 provides direct communication therethrough from atmosphere to the space between the flap 2416 and web 2404. Recesses 2420 are conveniently located in wall of flap 2416 between flange 2406 and horizontal edge portion 2410 shown in FIG. 129. Severing of flap 2416 is optional and alternatively a hinge may be provided by compressing flange 2428 with a profile so as to facilitate easy hinging of flap 2416 and tray 2402 relative to each other.

Flap 2416 is arranged such that it can be “hinged” about the gap 2424 such that flanges 2406 and 2408 contact directly with web 2404 material therebetween. Flanges can then be sealed together through web 2404 such that web 2404 material seals together in a desired manner. The apertures 2422 and 2426 are positioned such that they become aligned after sealing of the flanges. Web 2404 material is then most likely to become lightly bonded together around the perimeter of apertures 2422 and 2426. An adhesive may also be applied to the contacting surfaces of web 2404 around the perimeters so as to cause substantial bonding and providing a substantially liquid ‘tight’ seal there around so as to inhibit escape of any liquids therebetween. This arrangement provides a direct communication from space 2418 to any atmosphere external of the package, via apertures 2422 and 2426, space 2430 and recesses 2420. The location of apertures 2422 and 2426, space 2430 and recesses 2420 are arranged such that any liquids (or solid matter) that may accumulate within the package are inhibited from escaping from space 2418. With this arrangement, gasses can communicate directly between space 2418 and while liquids and other solid matter is substantially restricted and held within space 2430 or 2418.

Tray can be formed from foamed polyester or from expanded polystyrene foam (EPS). Web 2404 may include a suitable grade of plasticized PVC (pPVC) which may be printed with various colors and graphics and a heat activated, or pressure sensitive adhesive may also be applied during the printing process or separately as desired and required to provide sealed finished packages.

Completed packages 2434 can be stacked into master container 2412 until it is filled. A lid including a gas barrier web can be then sealed to the flanges of 2412 as described in U.S. patent application Ser. No. 09/039,150. Packages 2434 are stacked such that the ridges 2436 on the base of a first package “nest” adjacent to ridges 2438 of a second package. A space can therefore be maintained between the bottom of the second package and the web and contents of the first package.

In a further embodiment, 2412 can be located within a chamber such as is shown in diagram 5100 prior to sealing the gas barrier web to the flanges of ‘MC’.

Embodiment 13

Referring now to FIG. 70, another embodiment of a tray with flaps constructed according to the present invention is shown. FIG. 70 shows a cross-sectional through tray detailing a preferred profile. Rib 4420 is formed in flap 4422 adjacent to recess 4424. Rib 4420 is formed so as to contact wall of tray as shown when flap is folded into position. Recess 4426 is formed in the flap 4422 with an aperture or slot therein but does not contact the outer surface of the wall of tray and is provided with space 4428 therebetween. A suitable adhesive such as a solvent is applied to the surfaces of the flap 4422 and the wall of tray such that when flap 4422 contacts the wall of tray, both parts bond together. The bond between the flap 4422 and the wall of tray can be arranged to follow a continuous path close to the perimeter of the flap 4422 and thereby provide a substantially liquid “tight” seal around space 4428. Each flap (4) can be applied with adhesive in a similar manner to that described for flap 4422 then, in like fashion, bonded to walls of tray to produce a finished tray. Apertures 4430 can be provided in the lower section of the wall of tray such that liquids that may accumulate within the tray can pass through apertures 4430 and enter space 4428. Slots, slits or holes can be provided in recess 4424 such that direct communication through recess 4424 into space 4428 and through apertures 4430 can be provided. The surface of the flap and the wall of tray in direct contact with space 4428 can be treated so as to absorb liquids such as water, purge and blood.

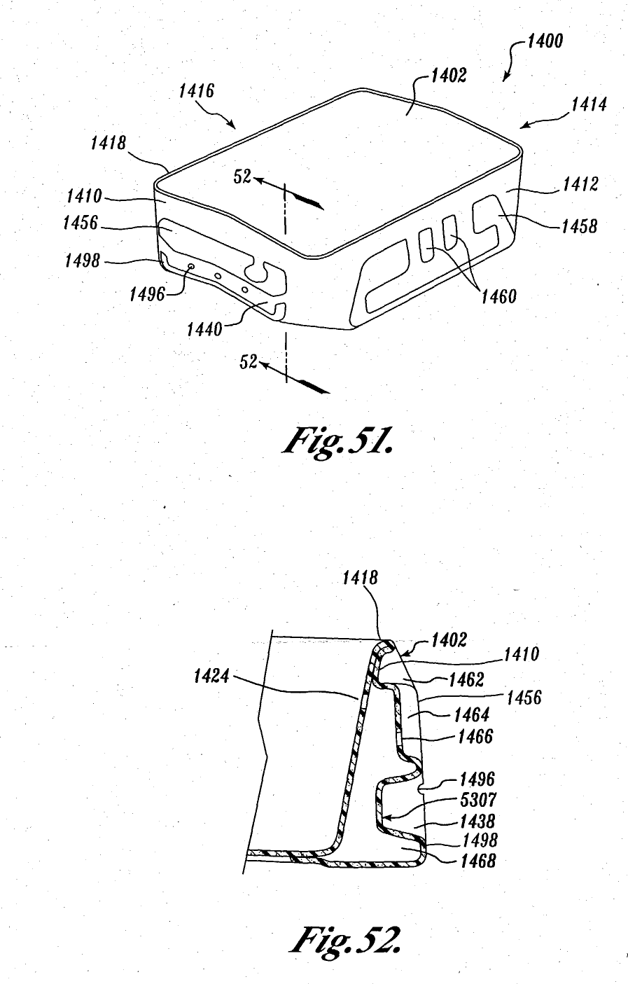

Referring now to FIGS. 71-72, an enlarged cross-section through a portion of EPS sheet is shown and an enlarged cross-section through EPS sheet, after thermoforming and assembly of tray and flaps in finished and bonded position, are detailed. In FIG. 71, a cross-section through a portion of sheet EPS foam with skin 4432 and skin 4434 is shown. EPS sheet, as shown in FIG. 71 can be extruded in normal production such that skin 4432 and skin 4434 is substantially nonporous and will resist absorption of liquids, while the inner layer of EPS foam 4436 can be produced so as to absorb liquids. In a preferred embodiment, the EPS sheet with skin 4432 and skin 4434 can be extruded and wound onto rolls in readiness for use in thermoforming and production of trays with flaps as shown in FIG. 52. In another preferred embodiment, the EPS sheet material may include three layers of expanded polystyrene sheet where an inner layer of open celled foam, that has been arranged to absorb desired liquids, is “sandwiched” between two outer layers of closed cell expanded polystyrene sheet that will resist absorbing of the liquids. After thermoforming the trays with flaps, from the three layer material or alternatively from material with outer skin 4432 and 4434 a solvent or other suitable agent, can be applied by spraying, or any other suitable method, to selected areas of flap(s) and wall(s) of tray such that only those selected surface areas, that will become enclosed between the flaps and the trays, after folding and sealing into the required position, will have the solvent applied thereto. The solvent, or other suitable agent, can be applied in sufficient quantities to the selected surface areas, so as to dissolve the skin 4432 or 4434 at surfaces 4438 and 4440, shown in FIG. 72 thereby exposing the inner, liquid and water absorbing EPS foam, for subsequent contact with any liquids that may enter space 4428. In this way a finished tray, with flaps folded and sealed into the desired configuration, can be produced so that only the surfaces adjacent to and in contact with the space 4428 will be substantially liquid and water absorbing. It can be seen that any liquids that may be present on the inside of the tray can pass through apertures 4430 and into space 4428. Liquids can then be absorbed by the exposed EPS foam in contact with the space 4428 however, due to the liquid absorbing resistance of skin 4432 and 4434, the liquids may not be visible to any person looking at the tray with flaps from outside the space 4428.

Embodiment 14

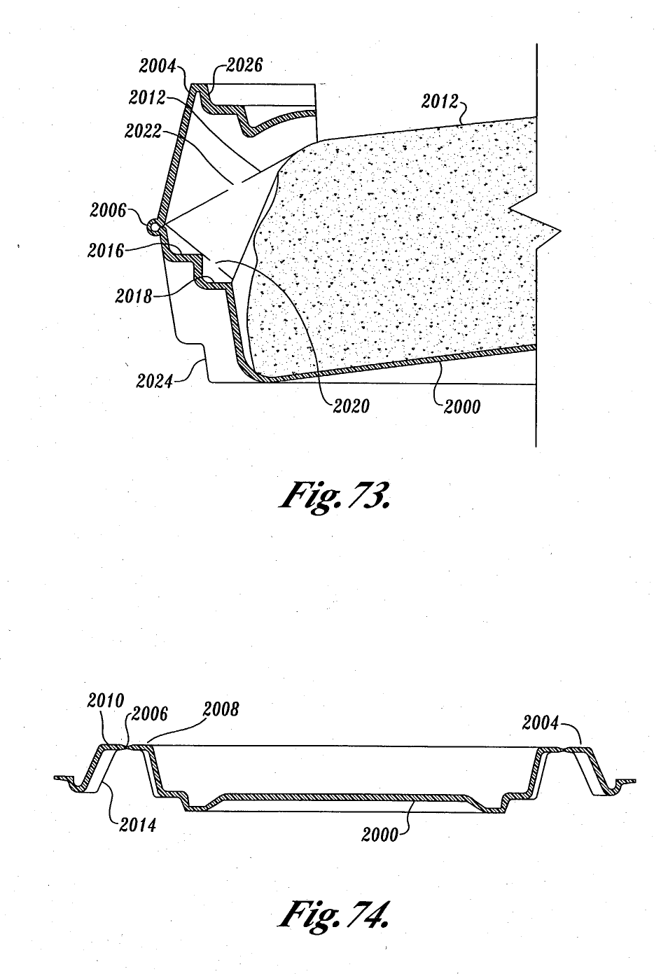

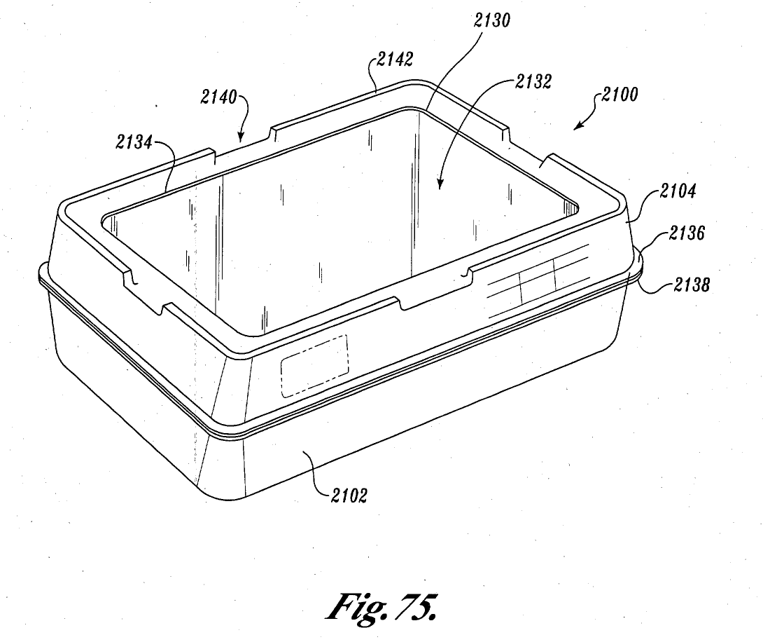

Referring now to FIGS. 73 and 74, another embodiment of a tray with flaps constructed according to the present invention is shown. A cross-section through a finished package in shown in FIG. 730 and a three dimensional view of a finished package 3400, is shown in FIG. 74. The finished package 3400 includes a tray 3402 with perishable goods contained therein and an outer cover of a substantially gas barrier shrink material 3404. Apertures 3406 are provided in the gas barrier outer cover and a peelable, gas barrier label 3408 is hermetically sealed over the apertures 3406. The finished package 3400 has spaces 3410 and 3412 and other space contained within the outer cover 3404. A substantially oxygen free gas including any suitable gas, selected to extend the keeping qualities of the perishable goods, such as a blend of carbon dioxide and nitrogen, can be provided in the spaces inside the package 3400 after evacuating other gasses contained therein, such that all the spaces are filled with oxygen free gas. The finished package can be stored for a period of time and then the gas barrier label 3408 on the tab 3414 can be removed by peeling, thereby allowing atmospheric gas to enter through the apertures 3406 and 3416 and into the spaces around the perishable goods and contact the perishable goods.

Embodiment 15

Referring now to FIG. 76, another embodiment of a finished package constructed according to the present invention is shown. A cross-sectional view with details of a preferred configuration including a tray with flaps that are folded into the finished position and extend below the base of tray is shown in FIG. 75. As described in earlier embodiments of this present specification, a tray with flaps may include a rectangular flat base with radiused corners and upwardly extended walls that terminate at a flat horizontally disposed, common flange. A space or cavity is therefore defined between the walls. Flaps are connected directly to the peripheral edge of the common flange at a hinge along a hinge line. A single flap may be attached to a single wall or alternatively up to four flaps may be attached, one to each wall. The packaging tray with flaps can be thermoformed from suitable plastics materials such as expanded polystyrene (EPS) sheet. Flaps of various configurations have been described herein with apertures conveniently provided to allow gas or air exchange therethrough while inhibiting and restricting the escape of other matter such as liquids including blood therethrough. Such apertures and configurations allowing gas exchange therethrough can be provided in this present embodiment if desired, however, the purpose of the description of this present embodiment is to disclose an improved packaging that will also protect the perishable goods contents of the finished package when stacked together in a master container as shown in FIG. 16.

Referring now to FIG. 75, a loaded tray 3700 with flaps 3702 is completely covered with an outer cover 3704 and it can be seen that the outer cover 3704 is domed upwardly and is stretched over the upper surface of the perishable goods 3706 such that the uppermost part of the perishable goods 3706 is extended above the common flange 3708 under the outer cover 3704. In this manner the perishable goods 3700 are held firmly to the base 3710 of tray 3700 by applying tension on the outer cover material. An adhesive 3712 may be provided between the outer cover 3704 and the common flange 3708 so as to seal, hermetically or otherwise, the outer cover 3704 to the common flange 3708 along a path that will become an outer edge of the finished package. Additionally and as shown, adhesive 3712 may be provided between the flaps 3702 and the tray walls 3714 so as to seal the flaps 3702 in position to the walls as may be desired, hermetically or otherwise. Adhesive 3712 may also be provided between the underside of the base 3710 and between the base and the inner surface of the outer cover 3704. Outer cover 3704 may include a suitably printed, heat shrinkable, stretchable, sealable, transparent, oxygen and gas permeable web of material with a “memory” that may be applied after loading the perishable goods into the tray cavity. The outer cover 3704 may be applied directly from a continuous web or roll of the material or alternatively may be fabricated into suitably sized bags, such as those supplied by Robbie Manufacturing, Inc., prior to sealing over the loaded tray with flaps. The outer cover 3704 may be suitably perforated with apertures to allow gas and/or air exchange therethrough and can be heat shrunk after sealing over the loaded tray with flaps by passing through a suitably adjusted heat tunnel. Alternatively, the outer cover 3704 may be applied from a continuous web and stretched during application thereof and then sealed to provide a sealed outer cover 3704 that is stretched taught around and over the loaded tray with flaps as shown in FIG. 75.

FIG. 77 shows a cross-section of a tray after the application of the outer cover 3704, that may be manufactured from any transparent suitable material, but before stretching by depressing the outer cover 3704 into the recess 3716 as shown in FIG. 78. FIG. 78 shows the same cross-section as in FIG. 134 after outer cover has been depressed so as to contact the adhesive between the base of tray and the inner surface of the outer cover 3704. By a mechanical device, the outer cover 3704, that is located adjacent to the underside of the base 3710 of tray, can be depressed and stretched so as to contact the adhesive 3712 located between the inner surface of the outer cover 3704 and the under surface of the base 3710 of tray so as to provide bonding therebetween. A recess 3716 can therefore be provided as shown. In this way, the outer cover 3704 can be stretched over the entire surface of the tray 3700 with perishable goods contained therein. Therefore, when another finished package of similar configuration is located and stacked above and onto a similar lower package, the underside of the finished package will not contact the upper surface of the dome of the lower package. In this way the lower packages are protected from damage when stacked and transported or when displayed in stacks at a point of sale to consumers.

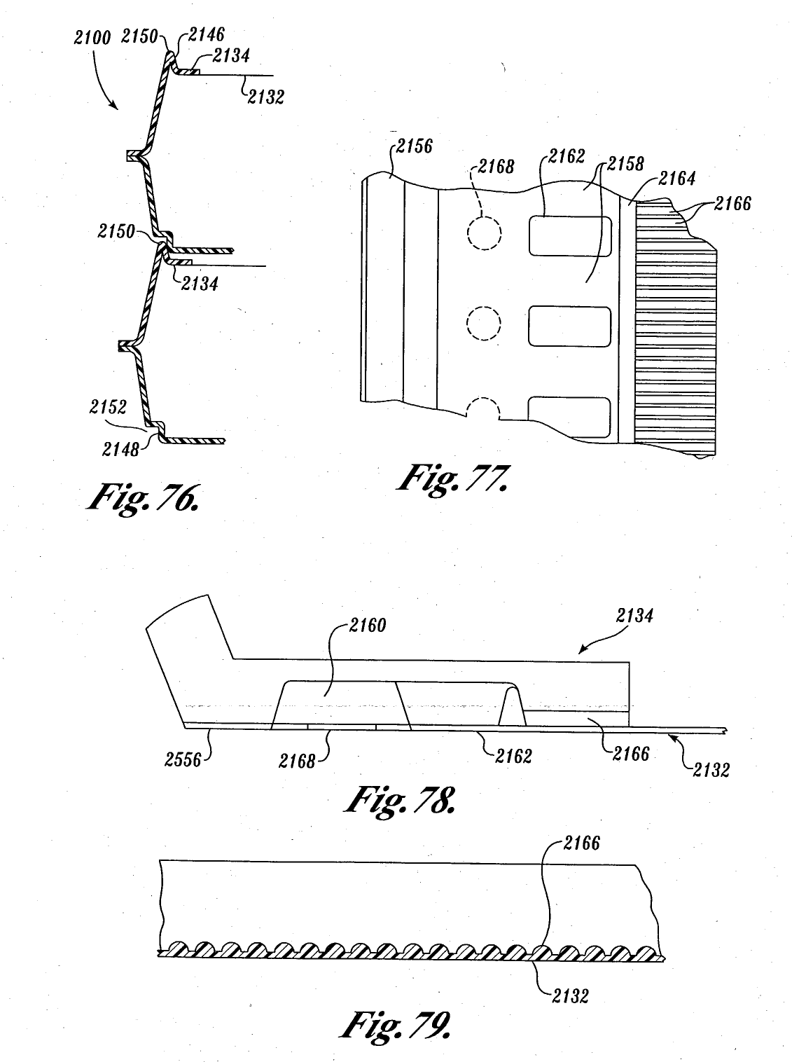

Referring now to FIG. 79, a cross-sectional view through an assembled and finished master container 3722 is shown inside a closed and sealed corrugated cardboard carton 3724. Two finished packages 3726 and 3728 are shown inside the master container 3722. As can be seen, the extended flaps of the upper finished package provide a recess to accommodate the upper surface dome of the lower finished package thereby providing protection to the perishable goods contained therein. The master container 3722 may be thermoformed from a web of flexible, substantially gas barrier, plastics material such as Curlon Grade 9315-II as manufactured by Curwood of Oshkosh, Wis. and can be provided so as to tightly hold the finished packages. A substantially gas barrier lid 3732 that is provided from a web of plastics material such as Curlam Grade 2500-K as manufactured by Curwood of Oshkosh, Wis., is shown heat sealed to the flange of the master container 3722. The seal 3734 between the lid and the master container will, most desirably, be a peelable seal that can be peeled with relative ease by any person wishing to open the sealed master container. A desired gas 3736 is contained within the hermetically sealed master container and an oxygen scavenger 3730 is located therein. Further, the lid of a master container may contain a relief valve to allow escape of any excess gas that may be released from solution in the meat and to accommodate for an expansion of the master container.

The sealed, gas barrier, master container 3722 is located in a corrugated cardboard carton 3724. The corrugated cardboard carton 3724 may be manufactured by the Weyerhaeuser Corporation, of Tacoma, Wash. from 69/40/69, 5100 flute corrugated cardboard and such a construction will withstand substantial loading.

An enlarged view of the seal arrangement is shown in FIG. 80 and an alternative configuration showing flange of container in position after folding inwardly is shown in FIG. 81. In this embodiment the corrugated cardboard carton is just large enough to contain the master container but the flange of the master container is folded inwardly to allow the sides of the master container to be in close contact with the inner surface of the carton, thereby reducing the size of the carton to a minimum.

The size of the master container and the corresponding size of the carton can be suitably arranged to contain one or more finished packages.

Embodiment 16

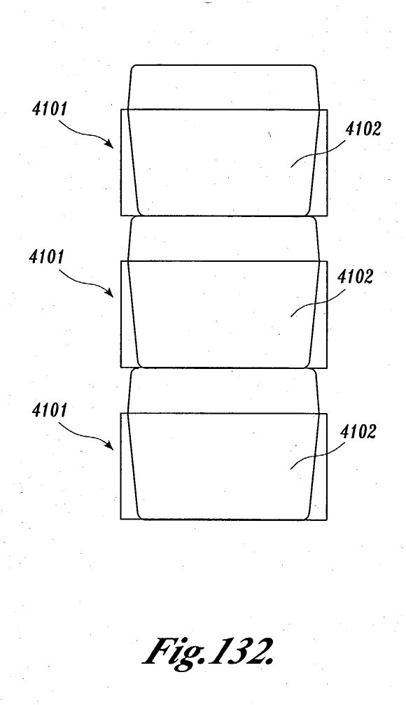

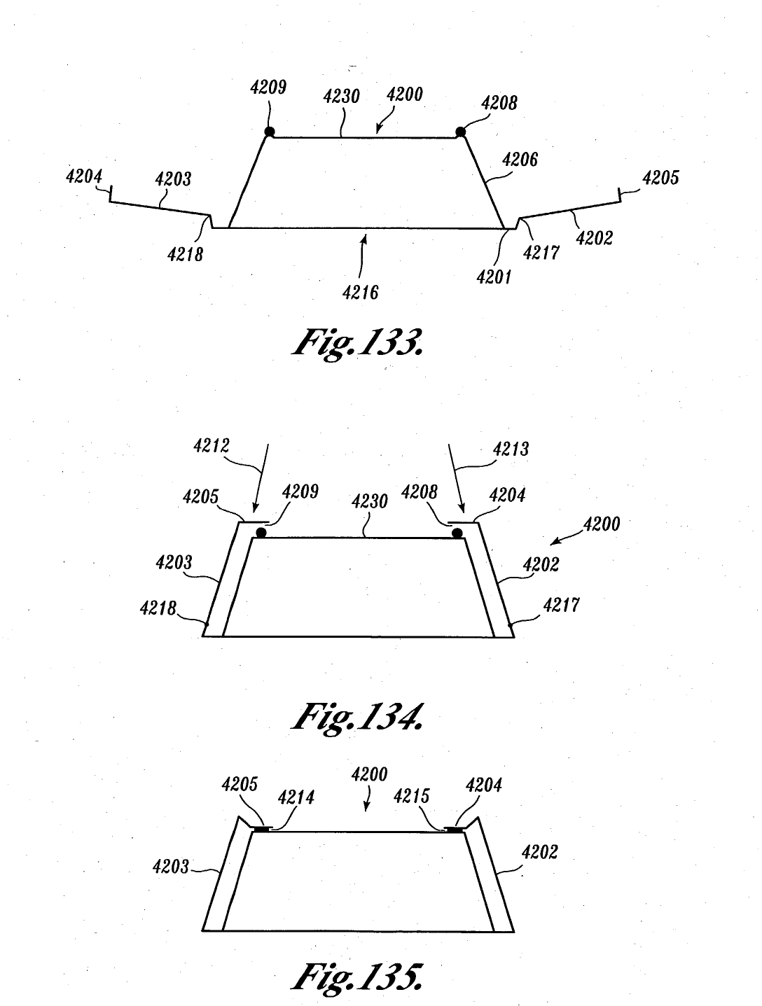

FIG. 131 shows another embodiment of a tray constructed according to the present invention. The tray 1900 includes flap 1900. Flap 1900 is attached to tray 1902 along an outer edge 1904 of tray flange 1906 and a further flap (not shown) can be attached to the outer edge along the opposite side of the tray which is parallel with the first flap and is similar in operation thereto. After sealing of second and third webs to flanges 1906 and 1908, flap 1900 can be folded downwardly so that radius 1910 in FIG. 132 engages with recess 1912. Flap 1900 includes a hinge that can be folded along a hinge line through an arc shown more clearly in FIG. 132. Radius 1910 and recess 1912 “mate” and can be arranged so that they “snap” into a matingly engaged position, thereby holding the flap 1900 firmly. Referring now to a cross-sectional view of the stacked trays in FIG. 65, flap base 1918 is shaped so as to correspond with profile of flanges 1906 and 1908 and a ridge 1926 is located along the external edge of flap base 1900 such that when a finished package is stacked above another similar package they will “nest” together and the upper tray is prevented from contacting the contents of the lower tray. The base of the tray can be formed with a profile providing an upwardly extending depression that extends above the highest point of the contents in the lower tray. In this fashion, the finished packages can be stacked within cartons for distribution and shipped long distances without causing damage to contents of the trays in the lower position. First web tray 1920 has recessed base to clear goods in the tray below. Lip 1928 can be heat sealed after folding of the flap by heat seal bars 1930 to ensure that flap 1900 is retained in folded position as shown in the stacked finished packages FIG. 133. Ridges 1932 can be formed into flaps to improve rigidity and stability of the finished pack.

Embodiment 17

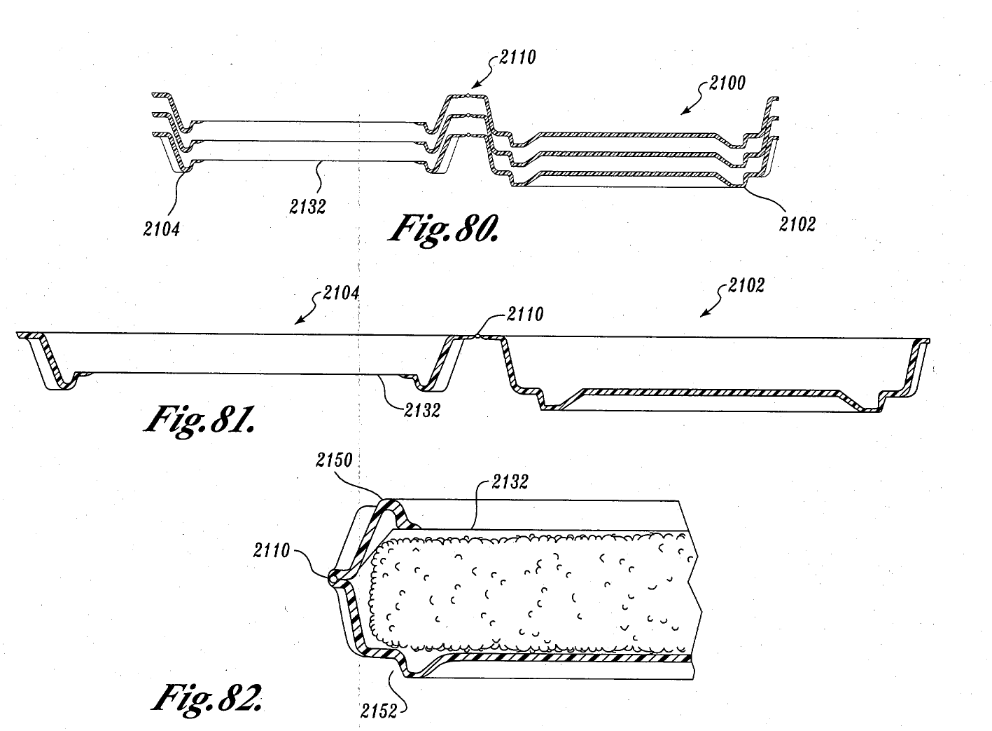

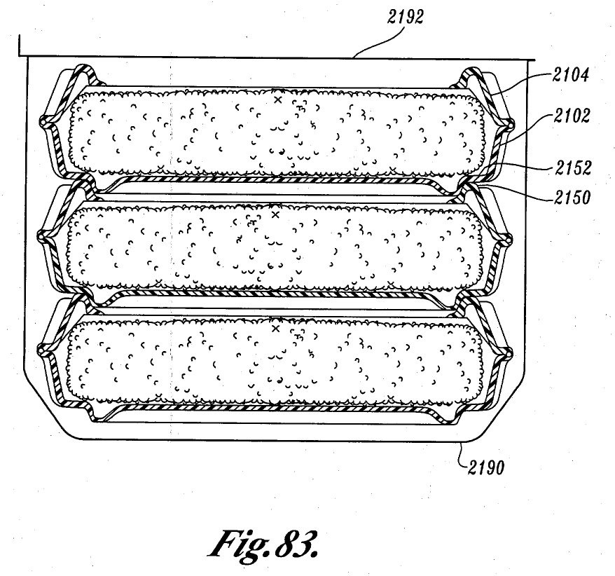

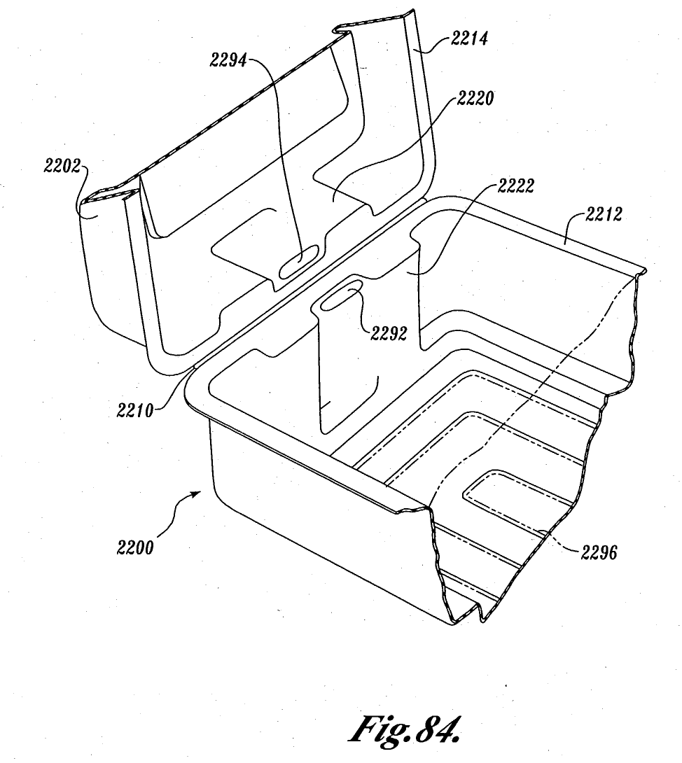

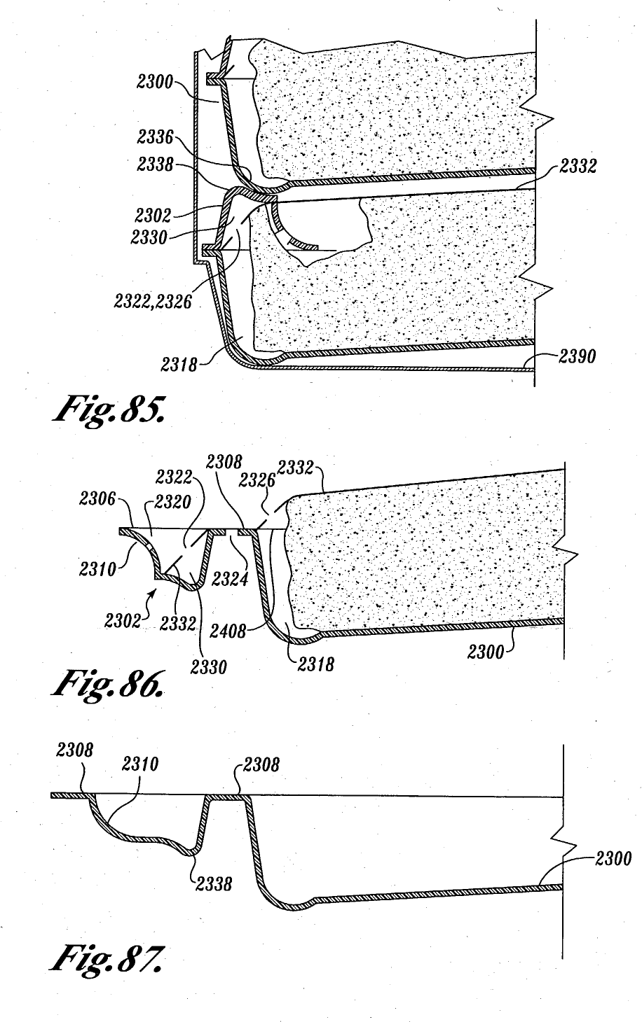

Referring to FIG. 82, another embodiment of a tray, 3100, with flaps is shown. A cross-section is shown in FIG. 83, where both flaps are folded inwardly and the package has been inserted into a Clysar AFG shrink bag 3114. The tray can be “stretch-wrapped” with PPVC as an alternate to a PP bag as shown in FIG. 83.

Tray 3100 includes a base with four upwardly extending walls, terminating at flanges 3104. Two flaps 3102, 3103 are provided such that they can fold inwardly. Recesses 3106 are provided in the flaps to allow communication of gasses therethrough. Tray 3100 further includes a base rim 3108 that extends around the perimeter of the base. Depressions 3110 and perforations 3112 can be provided at the tray base 3126. Apertures 3116 are provided in shrink bag 3114. Tray 3100 may be thermoformed from any suitable material. Apertures 3116 provide direct communication from external atmosphere through space 3118 and recesses 3118 to tray cavity. Perishable goods can be located into tray cavity and flaps 3102 folded inwardly. Assembled tray and perishable goods can then be located within a polypropylene shrink bag, such as Clysar AFG shrink bag 3114 which is then heat sealed and heat shrunk around the tray and goods to form a finished package. A plurality of finished packages may be assembled and stacked together to provide a group of assembled finished trays which is then hermetically sealed within a substantially gas barrier master container as described in U.S. patent application Ser. No. 09/039,150 with a gas barrier lid. When the finished packages are stacked, the base rim 3108 of one pack will rest directly above flaps 3102. In this way, finished packages can be stacked together without causing undesirable damage to the contents of the package. Perforations 3112 absorb liquids as described herein.

Alternatively, in a preferred embodiment, the Clysar AFG shrink bag 3114, may be replaced with a stretch wrap material such as plasticized PVC.

Referring now to FIG. 135 wherein a view of a section of tray 3100, after folding and bonding of the flaps to the tray wall, is shown. A plan view of the scrap view section, prior to folding and bonding of the flaps, is shown in FIG. 134. A preferred method for production of trays with flaps includes a thermoforming process and a “cut in place” procedure. The term “cut in place” is a common term used by those skilled in the art of tooling manufacture and use of thermoforming equipment. This term describes a thermoforming production method including the use of a thermoforming tool with a cutting devices incorporated into the tool so as to permit cutting of the subject thermoformed component from a web of plastics material immediately after forming and before ejection and removal of the component(s) from the thermoforming tool. The scrap view section shown in FIGS. 134-135 details a single corner section of a four cornered tray such as the tray of FIG. 55, however, all four corners of the tray with flaps are similar. Referring again to FIGS. 134-135, flaps 5268 and 5270 are shown attached to a tray 5272 at a hinge 5274. The tray with flaps is shown in FIG. 134 prior to folding flaps and bonding. The tray with flaps is shown in FIG. 135 after folding of flaps and bonding. The flaps can be printed by ink jet devices, prior to folding and bonding in the manner disclosed above with reference to FIG. 55. Adhesives can also be applied by ink jet printers to the flaps and tray. Hinge lines 5276 and cut lines 5278 are all parallel and in the same plane. The cut lines 5278 and hinge line 5276 terminate at points 5280 and 5282. If desired a further hinge line 5284 provides devices to fold sections 5286, which can be folded and bonded to the base of tray. Panels 5288 and 5290 can be printed with any information or graphics as may be desired and are arranged to be elevated and angled so as to be more easily visible by an intending purchaser of the tray with goods therein.

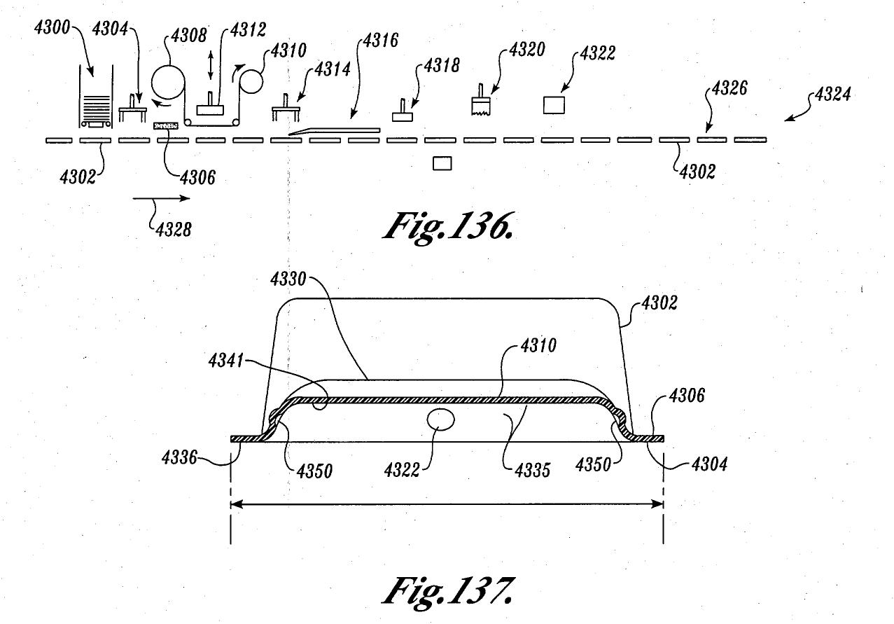

Referring now to FIG. 136, a cross-sectional view through a corner of the tray with flaps, after the flaps have been folded and bonded, is shown. The “cut in place” forming method allows a method to provide walls 5292 and 5294 that can contact each other, as shown, and be bonded together after folding the flaps into the finished position. In this way, a substantially more rigid tray structure can be provided that would otherwise require a heavier wall section for trays that have not been provided with flaps as herein disclosed. With ink jet application of adhesives, as described herein, an efficient devices of economically applying the minimum quantity of adhesives is provided. In this way, adhesives can be applied in a pattern that allows for maximum surface area bonding of trays and flaps while minimizing the quantity of adhesive material required.

In yet another preferred embodiment, packaging including a combination of features disclosed in any of the trays above may be combined to construct a finished package. For example, a package including a tray with any of the flaps disclosed herein may be constructed to provide desired features and inserted into either a Clysar AFG shrink bag or alternatively a stretch wrapped in a pPVC stretch film over wrap or shrink wrapped with printed Clysar AFG anti fog shrink film.

In yet another preferred embodiment, packaging including a combination of features disclosed above may be combined to construct a finished package. However, perforations may be provided in depressions to allow any free liquids to pass therethrough to a space between the base of tray and the outer shrink bag. Indentations may be provided in the under (or outer) surface of the tray that can allow open cells, that may be present in the EPS structure of the tray, to absorb the liquids.

Any of the foregoing trays with flaps will be used in a method to automatically or manually performing the following steps:

Providing a tray with flaps, that has been thermoformed from expanded polystyrene (EPS). The tray having dimensions that will provide for the efficient use of the internal dimensions and capacity of typical, refrigerated road and rail transport vehicles.

Trays will retain a substantially oxygen free gas within cell structure of the tray and/or exposing the tray and/or the tray material prior to and/or during thermoforming and production of the tray, to a gas that excludes oxygen and allowing the gas to exchange with any gasses contained within the cells of the EPS thereby substantially displacing any atmospheric oxygen from the cells or otherwise ensuring that gasses contained in the cell structure substantially excludes oxygen.

Providing perishable goods onto the base of the tray. The perishable goods having been treated and processed to enhance the keeping qualities thereof.

Over wrapping the tray with goods therein with a web of gas permeable material such as pPVC, to produce a finished package and then seal the over wrapping web of gas permeable material to portions of the tray by a heat sealer or other suitable adhesives and then perforate the over wrapping web of gas permeable material at desired locations.

Placing the finished package or a plurality of similar finished packages into a gas barrier master container.

Displacing substantially all atmospheric gas, and particularly atmospheric oxygen, from within the master container, with a suitable gas or blend of suitable gasses.

Sealing a lid over the opening in the master container to form a hermetically sealed package containing the trays with perishable goods and suitable gas.

Placing the master container inside a carton such as can be manufactured from corrugated cardboard and enclosing the master container.

Locating a plurality of closed cartons onto a standard (GMA specified) pallet (Dimensions of 40″×48″) so as to maximize the efficient use of the upper surface area provided by the pallet thereby producing a loaded pallet.

Storing the loaded pallet for a period of time in refrigerated space.

Delivering the finished pallets to a point of sale such as a supermarket.

Performing all aspects of the process in temperature controlled conditions

Embodiment 18

Referring first to FIG. 88, a tray 1000 is shown in a three dimensional disposition. The tray is arranged with a base 303 and four upwardly extending walls terminating at a flange 901 with a cavity 110 surrounded by the walls. Each of the walls may be rigidly fabricated by bonding together, two or more layers (shown as 100, 101 and 102 in FIG. 89). Each layer is attached directly together or in series to the flange 901, of the tray, via hinges that allow folding of each layer together and against each other, prior to bonding the layers together, to provide rigid wall(s). In this way the tray walls can be rigidly constructed with higher compression resistance and at a lower cost than would otherwise be incurred for a single layer wall of a similar compression resistant rigidity.

Referring to FIG. 90, a plan view of a thermoformed pre-form is shown which can be manufactured from any suitable material, of any suitable thickness but is most preferably thermoformed from extruded polypropylene sheet with a thickness of approximately 0.018″. The polypropylene sheet is then thermoformed to produce a pre-form, which is constructed so that it can then be folded and bonded into a stackable tray profile. The pre-form consists of a cavity 110, with a series of semi-rigid flaps, all connected by at least a single hinge to the flange 901. Cavity 110 has a base 303 with four upwardly extending walls terminating at a continuous flange 901. Flange 901 may be arranged with four straight sections connected via rounded corners but the other packaging tray configurations may be fabricated. At the outer perimeter of flange 901, adjacent flange flaps, 100, 301, 300 and 400 are attached via hinges shown as 88, 90, 89 and 87 respectively. Located at each corner of flange 901, and between each adjacent pair of adjacent flange flaps, additional flaps are provided. Between adjacent flange flaps 100 and 301 a pair of generally triangular adjacent flaps 101 and 99 are located but severed completely from direct attachment together by cut 200. Flap 101 is attached to adjacent flange flap 100 via hinge 91 and flap 99 is attached to adjacent flange flap 301 via hinge 98. Similarly, flap 104 is attached to adjacent flange flap 301 via hinge 96 and flap 206 is attached to adjacent flange flap 400 via hinge 94. Additionally, flap 205 is attached to adjacent flange flap 400 via hinge 93 and flap 105 is attached to adjacent flange flap 300 via hinge 202. Finally, flap 106 is attached to adjacent flange flap 100 via hinge 97 and flap 204 is attached to adjacent flange flap 100 via hinge 73. The pair of flaps 204 and 106 are severed along cut 203, the pair of flaps 101 and 99 are severed along cut 200, the pair of flaps 104 and 206 are severed along a cut 201 and the pair of flaps 205 and 105 are severed along cut 202. Said flaps 101 and 204 can be folded toward each other until they contact what becomes the inner surface of adjacent flange flap 100, and adjacent flange flap 100 can then be folded toward adjacent tray cavity wall 102 until the surfaces of flaps 101 and 204 contact a surface of adjacent cavity wall 102. This can be repeated simultaneously, separately or in correspondingly opposite, adjacent flange flaps such that all flaps are folded and held together for bonding at any and all contact points between the corresponding flaps and generally as detailed in FIG. 89.

Referring now to FIG. 89, a side wall of packaging tray shown in FIG. 88 is detailed, after folding of flaps shown therein which can be bonded, by any suitable bonding means, at contact points 405, 406, 407, 408 and 409. Bonding can be arranged to follow a path near what becomes a perimeter of adjacent flange flap 100 so as to hermetically seal space 900 therein.

Referring now to FIG. 91, a cross section through flange 901, cavity wall 102 and adjacent flange flap 100, details a preferred embodiment wherein hinge 88 is located parallel to hinge 902 with an additional flap section 905 between hinges 88 and 902. Adjacent flange flap 100 is bonded to wall 102 at 904.

Referring again to FIG. 90 in a preferred embodiment, an additional flap 701 is shown attached to adjacent flange flap 301 via hinge 85 and additional flap 700 is shown attached to adjacent flange flap 300 via hinge 86. Flaps may also be similarly attached via hinges to adjacent flange flaps 100 and 400 if so desired. In this arrangement pairs of flaps 104 and 206, 99 and 101, 204 and 106, 205 and 105 can be deleted, allowing flaps 701 and 700 to be folded respectively against what become internal surfaces of adjacent flange flaps 301 and 300 prior to bonding there together to provide a structure generally similar to that shown in FIG. 89.

Referring now to FIG. 92, a plan view of a preferred pre-form is shown, wherein a centrally located cavity 12 is connected via hinges 17, 19, 23 and 18, to flaps 11, 13, 14 and 16 respectively. Additional flaps 10 and 15 are attached via hinges to flaps 11 and 14. Ribs can be provided to all parts of the tray cavity, walls and flaps and can be arranged in any suitable profile so as to maximize rigidity of the finished tray but are shown only in flaps 10 and 15.

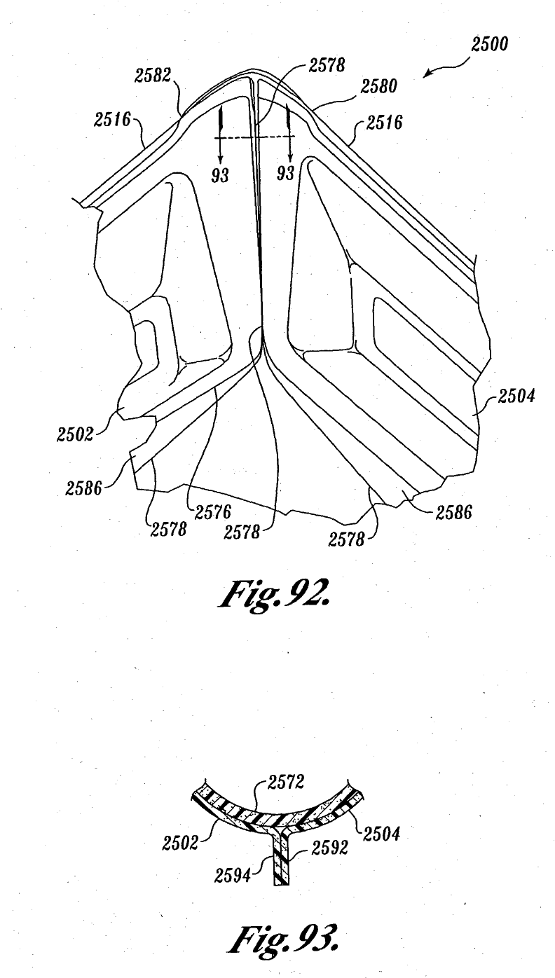

Referring now to FIG. 93, two pre-forms are shown stacked and nested together. In this way pre-forms can be manufactured and then conveniently stacked in a nesting configuration, minimizing the volume of space required during storage and shipping thereof. Pre-forms can then be fabricated at the point of use for packaging goods.

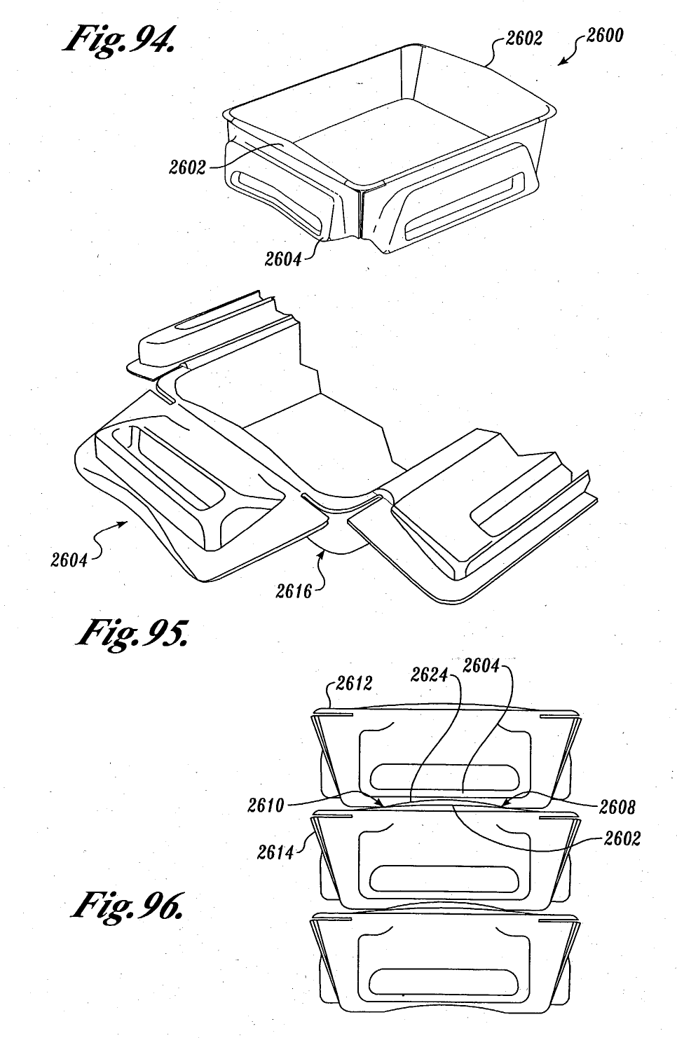

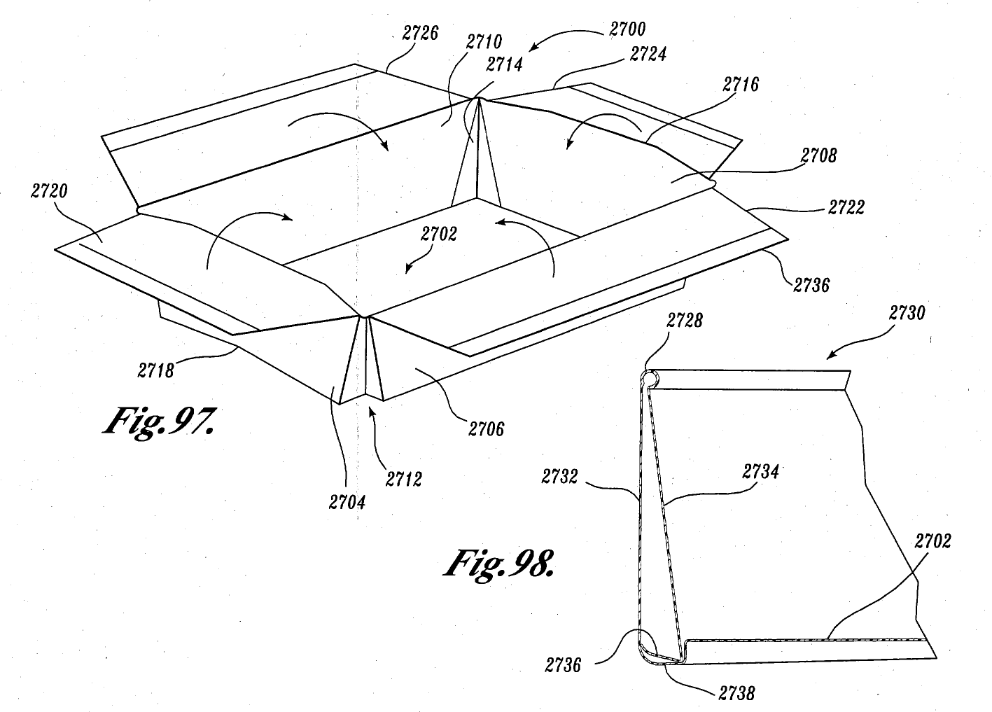

Referring now to FIG. 94, a cross section through a tray assembly fixture arranged to fold and bond pre-forms in an enclosed chamber is shown. Only one view of the assembly fixture is shown which is rigidly constructed from suitable materials wherein a base frame 38 is connected to a platen 37. Base frame 38 and platen 37 can be securely connected there together by any suitable means but most preferably by way of a quick release arrangement so as to allow the rapid separation of the two components. In a preferred embodiment, several similar assembly fixtures can be attached to a horizontally disposed continuous conveyor and arranged to operate automatically as a complete machine and this will be generally described in a later part of this disclosure. Platen 37 is securely attached to a profiled fixture 39, which is shaped to correspond with the internal, cavity surface profile of a pre-form such as shown in FIG. 92. A pre-form 35 is shown in position and mated with fixture 39. Part 36 is hinged at 151 and part 33 is hinged at 150. Parts 36 and 33 are arranged to dimensionally correspond to the flaps of pre-form 35, and can be attached to a suitable driving arrangement such as pneumatic cylinders that will drive each part to close in a sequence as required. Part 36 is shown in an open disposition whereas part 33 is shown in a closed position and firmly holding, a flap of pre-form 35 against a wall thereof. A source of vacuum may be attached to fixture 39 or single chamber (32 and 31) so as to assist in securely holding the pre-form in place during folding and bonding of flaps. After flaps have been bonded into position the vacuum may be released to allow easy removal of the folded and bonded tray. Additional hinged parts (not shown), similar to 36 and 33, may be attached to other sides to fixture 39 as may be required to correspond with additional flaps that may be attached via hinges to pre-form 35. A typical pre-form is shown in FIGS. 92 and 93. All hinged parts 36, 33 and any others can be arranged to fold flaps against the side walls of pre-form 35 and to hold there against securely during bonding of flaps to correspondingly adjacent side walls. A single chamber is shown in two parts, 31 and 32, that can be opened and closed as required to allow pre-forms such as 35 to be located on fixture 39 and sequentially unloaded by any suitable means in an automated and continuous process. The single chamber (31 and 32) is attached to a shaft 30, which in turn is attached to a drive such as a pneumatic cylinder, which can provide alternating opening and closing of the chamber. Ports can be provided in the single chamber with valves arranged to allow any suitable gas at any suitable pressure therein and connection to a suitable source of vacuum. The single chamber can be arranged to close over fixture 39 after locating a pre-form (35) thereon and a seal such as ‘O’ ring 34, can be installed along the contacting face between the single chamber (31 and 32) and platen 37. In this way, an enclosed and substantially gas tight enclosed space 46 can be provided. Prior to closing the single chamber against platen 37, hinged parts 36 and 33 can be activated by driving air driven cylinders. After closing the single chamber, space 46 can be substantially filled with any suitable gas at any suitable pressure via valves and ports (not shown) and to ensure that cavities between flaps and cavity walls are filled with the selected gas and thereby substantially excluding atmospheric oxygen. Hinged parts 36 and 33 can be arranged to carry any suitable sealing mechanism, such as RF welding and arranged to bond flaps to side walls of pre-form 35 directly. In this way cavities such as space 900 described above and in association with FIG. 89 can be filled with any suitable gas at any suitable pressure. In summary, a preferred sequence of apparatus operation, as shown in FIG. 94 can be as follows:

A. Provide a pre-form 35, locate on fixture 39, and apply a vacuum source to hold the pre-form securely to fixture 39.

B. Apply any suitable adhesive to selected surfaces of flaps of pre-form and fold hinged parts such as 36 and 33 so as to fold and close flaps against the side walls of the pre-form. [Hinged parts 36 and 33 may be arranged with a means to partially close and thereby allow substantially complete evacuation of air or gas therefrom prior to bonding].

C. Close single chamber over pre-form and seal chamber against platen 37.

D. Evacuate space 46 and provide any suitable gas at any suitable pressure therein.

E. Seal flaps to side walls of pre-form.

F. Open chamber and allow removal of pre-form with flaps bonded to side walls.

Referring again to FIG. 94, assembly fixture detailed therein can be arranged in groups wherein each assembly fixture is attached, via quick release connection, to a pair of parallel horizontally disposed, continuous chains, with a driving motor such as a servo electric motor, horizontally disposed to provide a conveyor. In this way a complete machine can be arranged with the upper section thereof, enclosed and a suitable gas provided in enclosure, such that when pre-forms are located on fixtures (39), if so desired, the gas in contact with pre-forms is oxygen free.

Referring now to FIG. 95, a side view and end view of two finished packaging trays 40 and 41 stacked together are shown. Ribs 43 and 42 locate interlock with the base of the upper tray.

Referring now to FIG. 97 and FIG. 98, another preferred packaging tray (190) embodiment is shown with a cross sectional view 2-2 therethrough. Tray 190 may be manufactured from any suitable material but in this instance a material such as polyethylene is preferable. A cavity 61 is surrounded by upwardly extended side walls 64, 67, 68 and 60 all terminating at flange 60. Flaps 67 and 64 are visible and ribs 65 and 67 are shown in flap 67 and ribs 62 and 63 are shown in flap 64. Flaps, 67 and 64 (including those not visible), have been hermetically bonded to side walls of tray. Referring now to section 2-2 in FIG. 98, a cross section through ribs 65 and 66 is shown. Hinges 70 and 71 are arranged to allow folding of flap 67 against wall 80. Hermetic seals are shown at 72, 75 and 78. Hermetic seals shown as 72 and 75 follow a path completely around the perimeter of rib 65 and hermetic seals shown as 75 and 78 follow a path completely around the perimeter of rib 66. In this way a spaces 73 and 76 can be completely enclosed and hermetically sealed separately from each other. However, prior to bonding ribs so as to enclose and hermetically seal spaces 73 and 76, any suitable gas such as carbon dioxide at any suitable pressure but most preferably at a relative high pressure, such as 80 psi, can be provided therein. In this way a rigid tray can be manufactured with reduced material content and therefore at relatively lower cost.

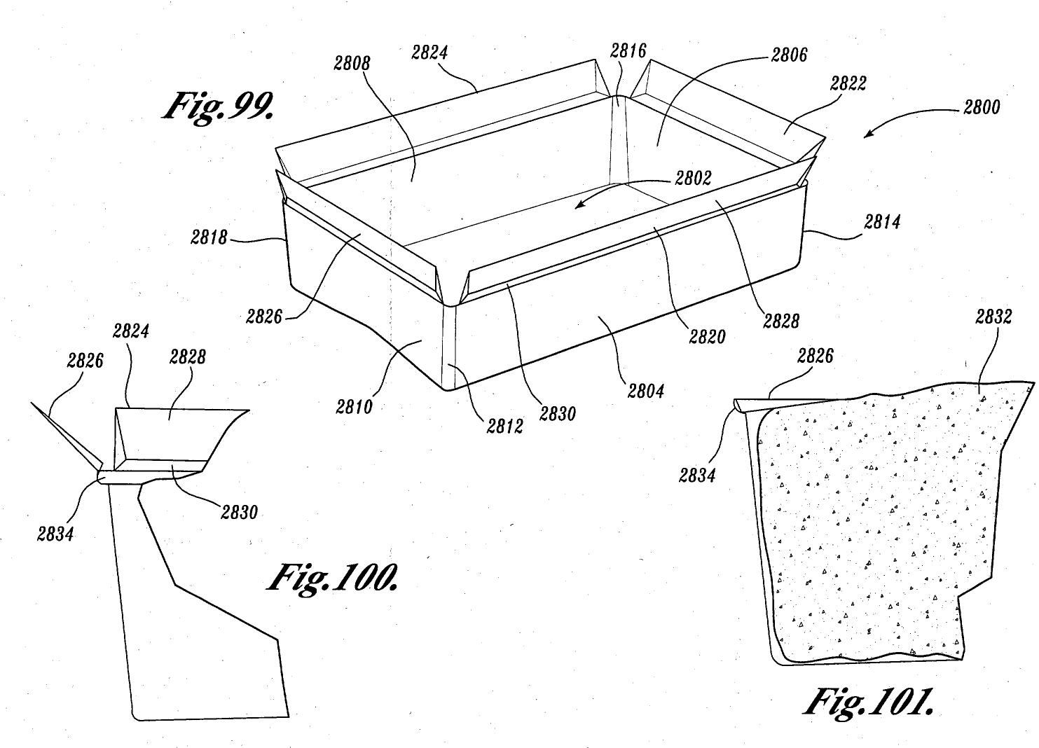

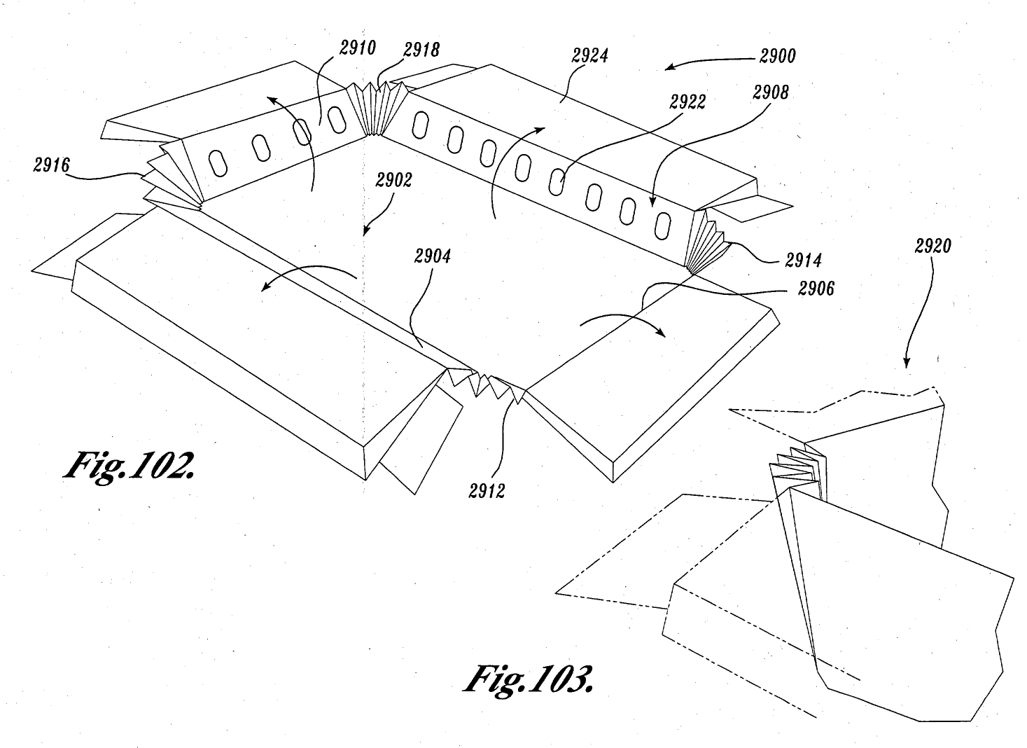

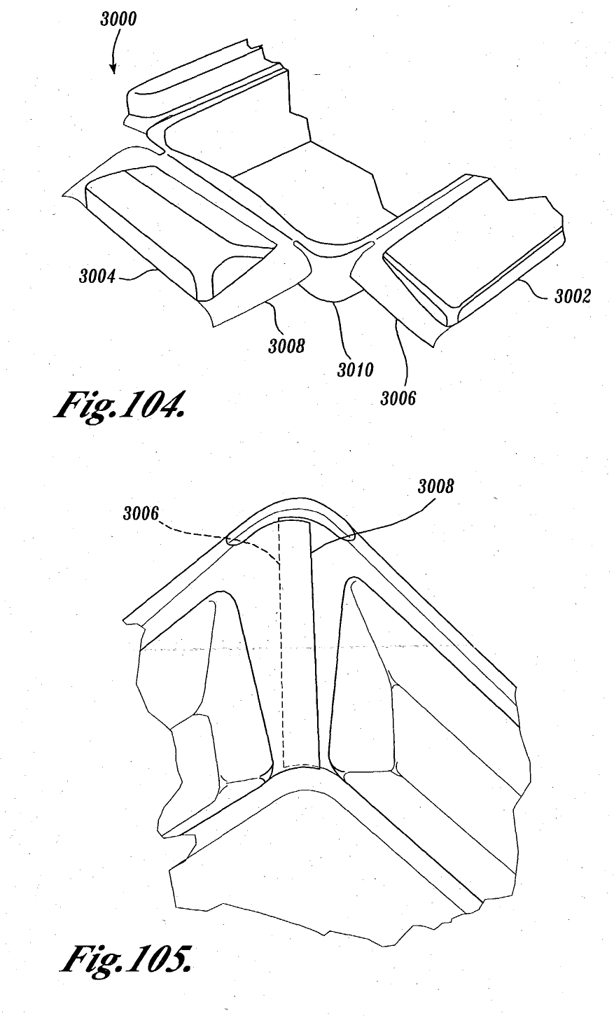

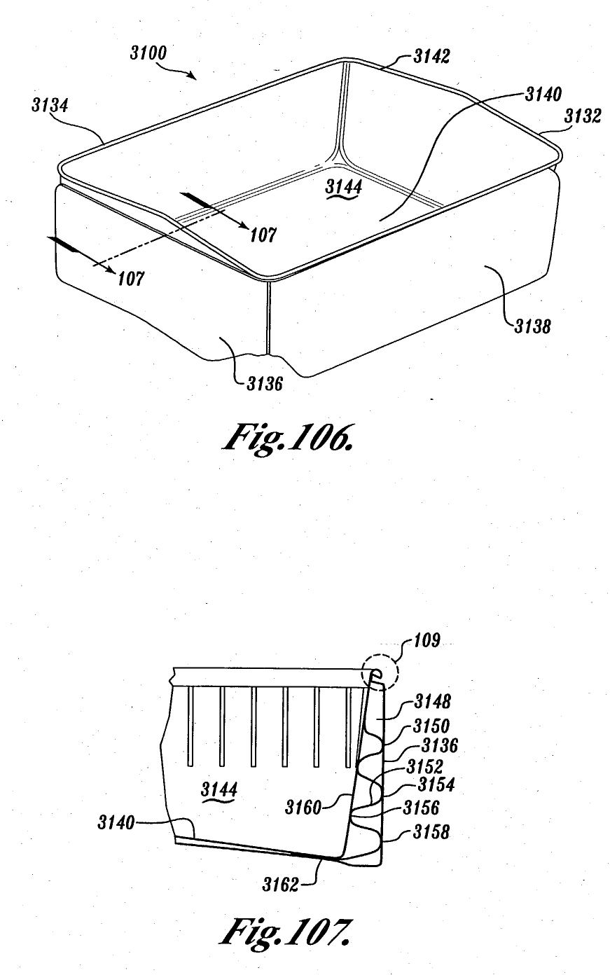

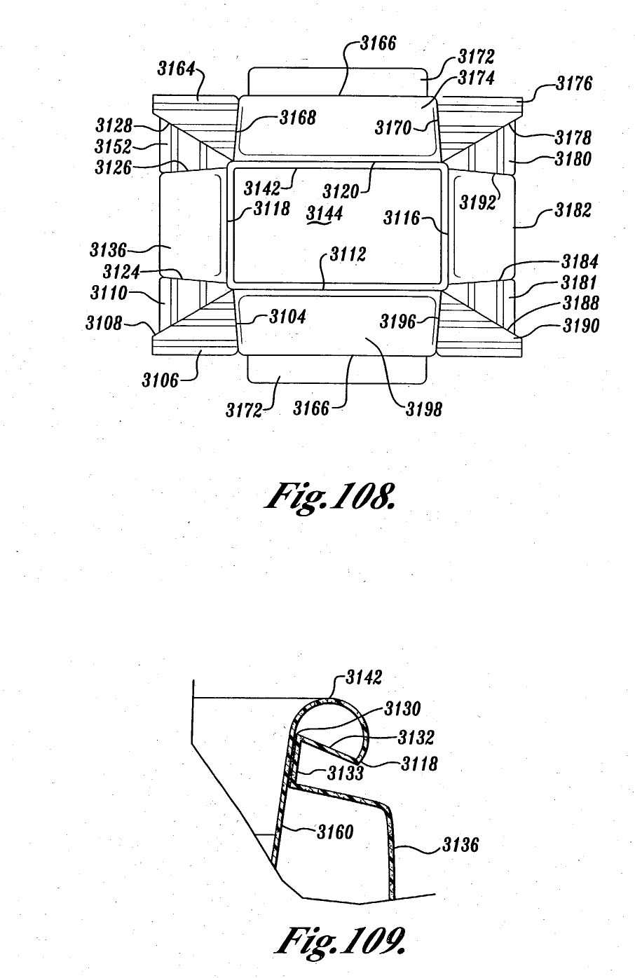

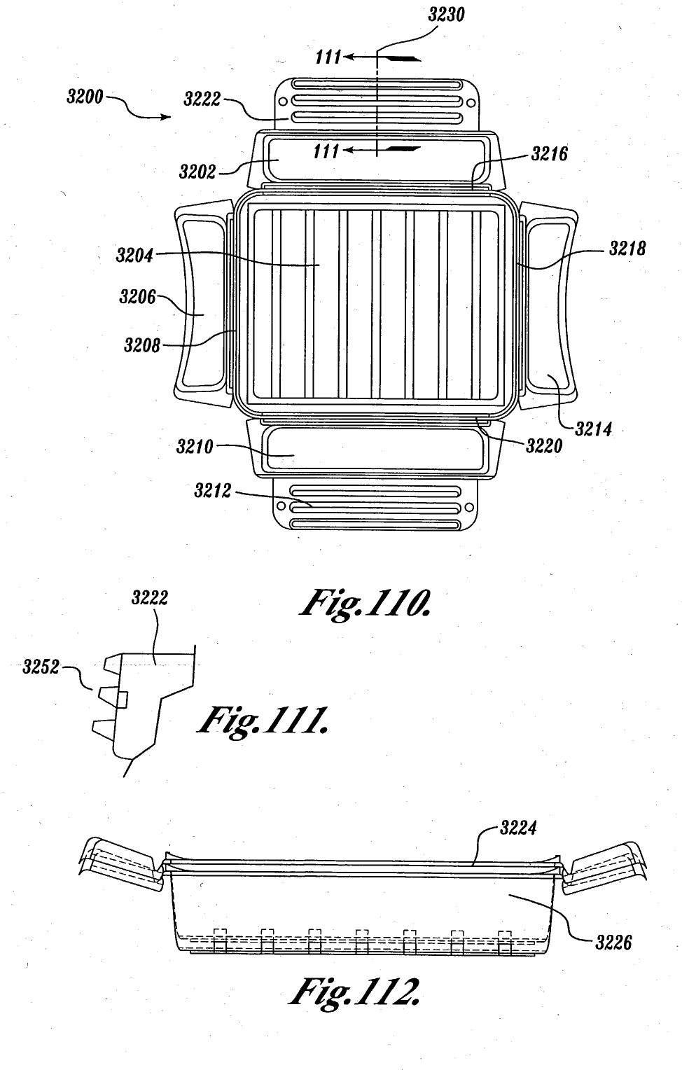

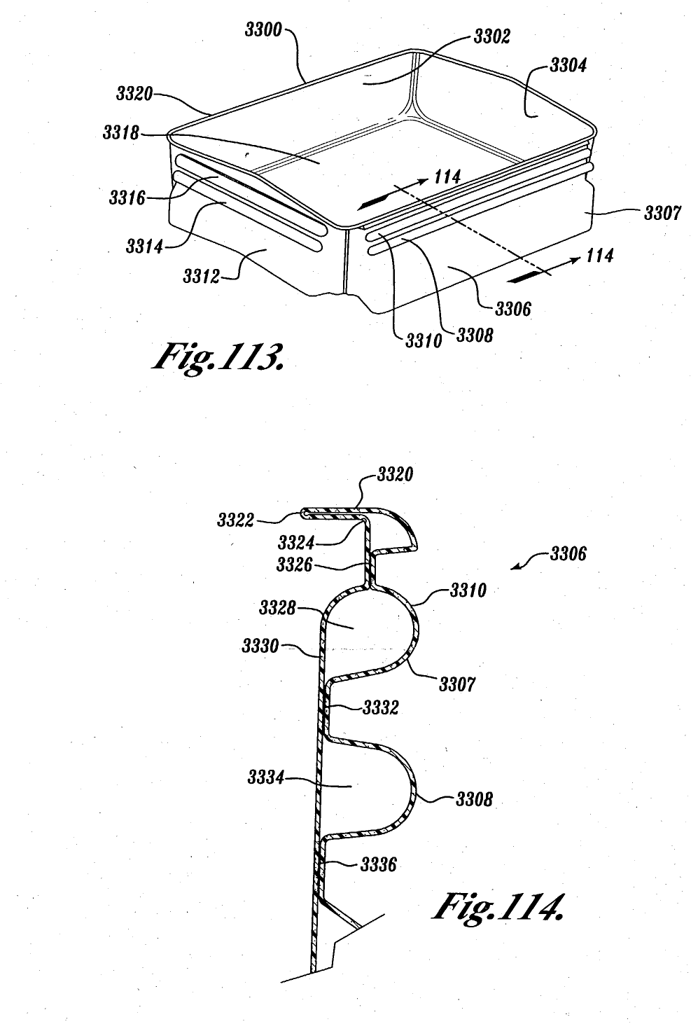

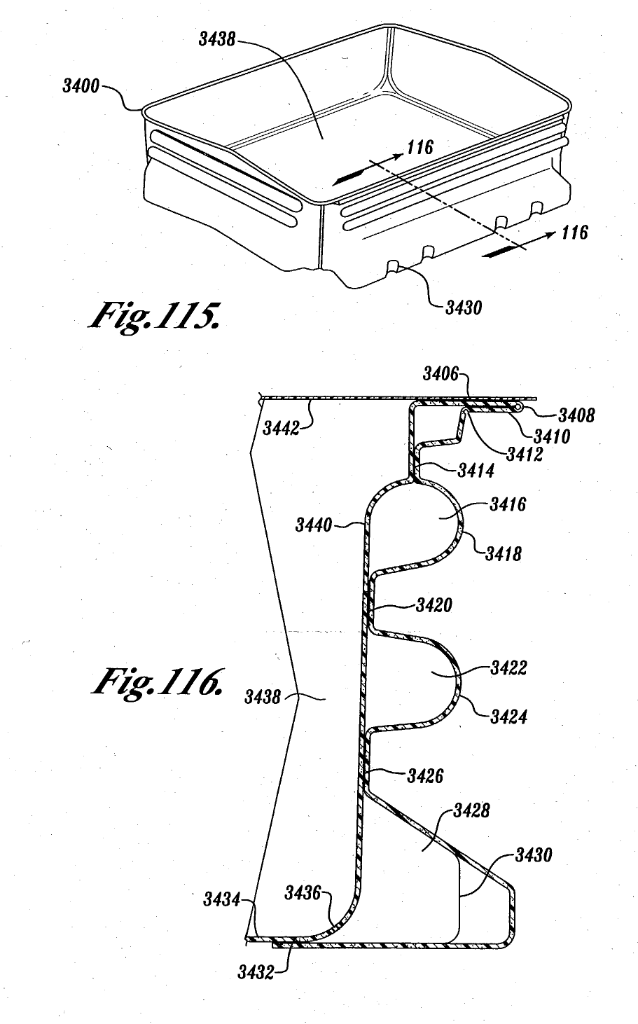

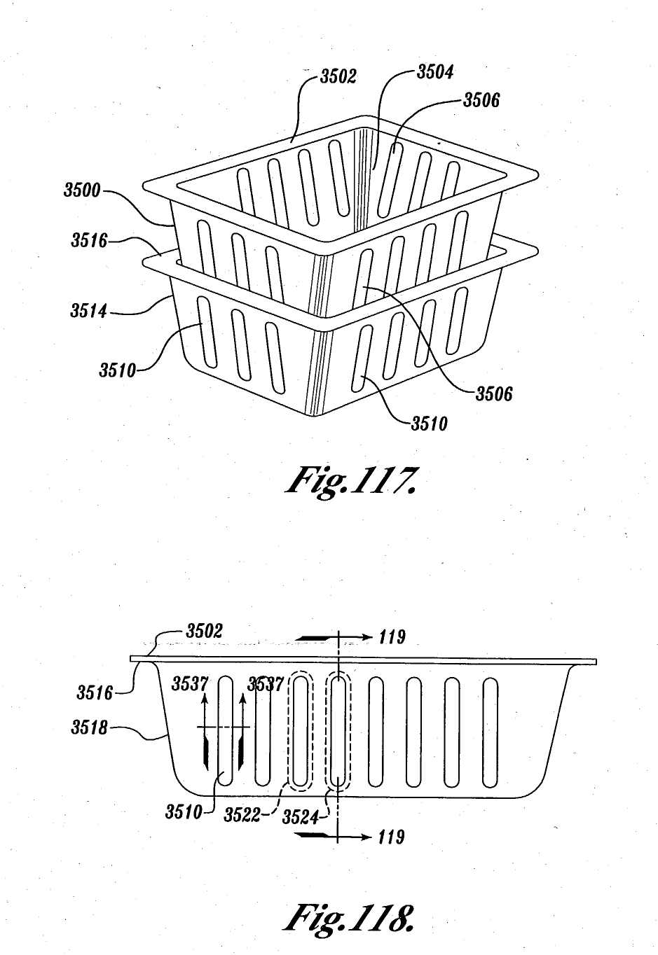

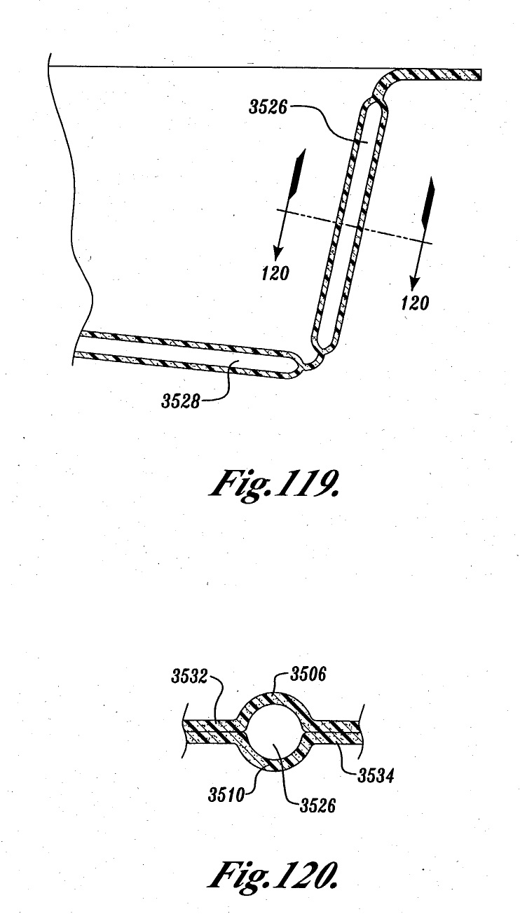

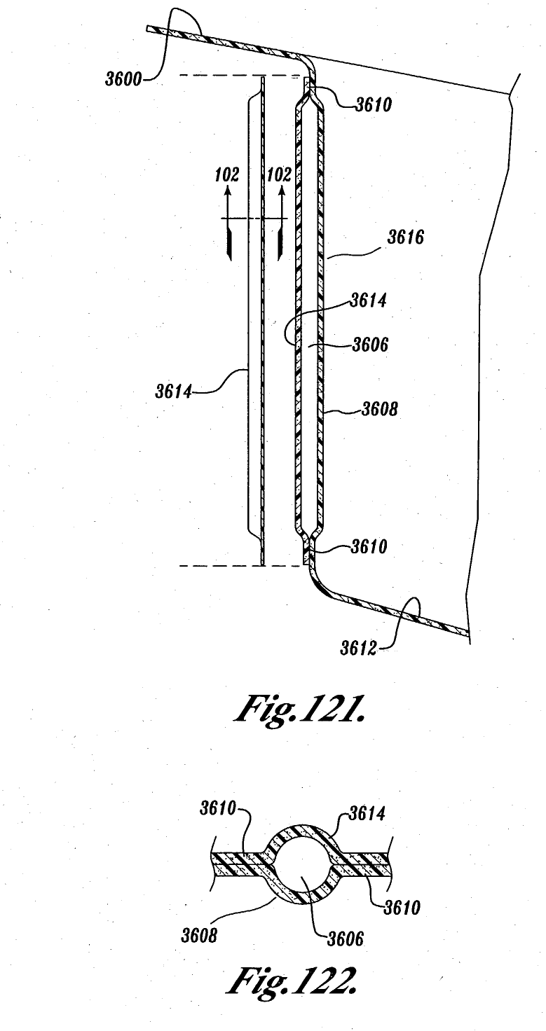

Referring now to FIG. 99, a tray 180 with lateral ribs arranged in a similar manner to those (62, 63, 65 and 66) disclosed in FIG. 7 is shown. Section 3-3 shows spaces 86 and 87, enclosed and hermetically sealed within ribs 94 and 98, along seals 84, 88 and 89 which can be filled with high pressure gas such as CO₂. Hinges 82 and 83 are located so as to provide an outwardly extending flange, after folding flap against wall 85, and to which a web of material shown as lid 81 can be hermetically sealed so as to fully enclose cavity 181. Apertures such as 99 can be provided to allow liquids to enter cavity 90 and seal at 91 prevents escape of such liquids from space 90. Ribs such as 93 can be provided.

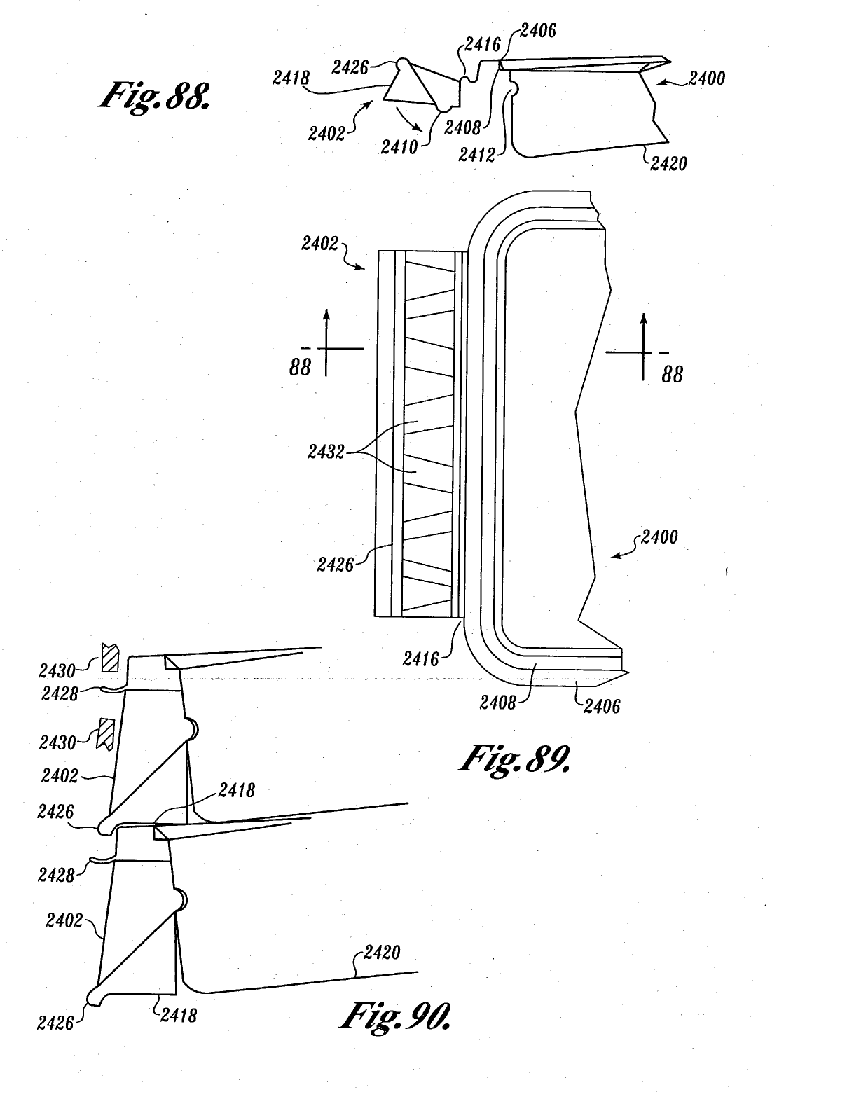

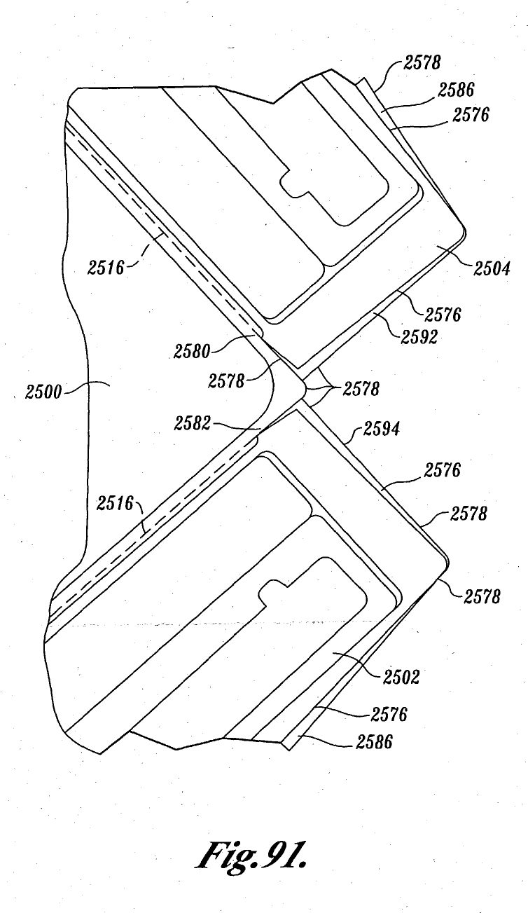

Referring now to FIG. 84, two thermoformed trays 200 and 20i are shown in a partially nesting disposition. The profile of tray 200 is arranged with upwardly extending walls terminating at flange 196 with ribs 199 and 184, formed into the walls. Ribs formed in tray 200 such as 199 and 184 extend inward toward the center of cavity 210 and ribs such as 198 and 183 in tray 201 extend outwardly away from a centrally disposed cavity.

Referring now to FIG. 85, the two trays 200 and 201 in FIG. 84 are shown sealed together to form a single tray 1001. Flanges 196 and 197 are hermetically sealed together around the full length of what has become a path close to the tray perimeter. FIGS. 86-87 show details of enclosed spaces such as 188, 187 and 189. Ribs are also hermetically sealed such that ribs formed in the walls of the inner tray are sealed against the corresponding rib in the outer tray to provide fully enclosed spaces such as 187 shown in FIG. 87, that can be filled with high pressure gas. Seal paths 190 and 191 are shown as examples of hermetic sealing and enclosing of spaces such as 187. FIG. 87 shows rib 184 hermetically sealed to rib 187, at 186 and 185 enclosing space 187.

Referring now to FIG. 101 a cross section through a tray similar to tray 200 shown in FIG. 84 is detailed in a preferred embodiment wherein a tray with a base 1100, and upwardly extending walls 1102 terminating at flange 1103 is provided with rib 1102 formed therein. A separately formed rib 1101 is shown adjacent to rib 1102 in a position prior to bonding and also after bonding to tray wall along seal path 1105. A hermetically sealed and enclosed space 1106 can be filled with high pressure such as CO₂. In FIG. 102, a cross section through ribs 1105 and 1102 is shown with space 1106 enclosed therein.

Referring now to FIG. 103, a thermoformed tray, 12102 is shown in a three dimensional view located above a form cut blank, 12100. Ribs are provided in the base 12104 and walls, 12108, 12107, 12106 and 12105 in a vertically disposed arrangement. Any suitable rib configuration may be provided in the walls and base of any suitable size tray, but most preferably rigid ribs such as 12103, as shown in FIG. 103, are provided with the recess accessible from the outer side of each wall, with the ridge extending inwardly. Trays 12102 and blanks 12100 can be manufactured in any required size, from any suitable material but most preferably would be produced from mono-layer extruded polyethylene terephthalate (PET) sheet. PET sheet may be extruded with multiple layers and both or a single outer layer may be provided with enhanced heat or RF (radio frequency(RF) or micro wave) sealable properties. Enhanced RF sealability may be provided by including any suitable additive such as suitable metallic elements or compounds in the outer layers, by blending into the polymer prior to extrusion.

Hinges shown at 1204, 1208, 1209 and 1207 are arranged so that flap portions 1200, 1201, 1202 and 1205 are all attached, thereby, to central rectangular portion 1203. In this way flap portions can be folded upwardly about hinges so as to contact the walls of tray 12103. Flap and base portions of blank 12100 can then be sealed to the walls of tray 12102 so as to provide a hermetic seal around the perimeter of each rib after providing gas such as CO₂ at an elevated pressure in the recess of each rib. In this way a rigid tray can be manufactured with substantially less material content than would otherwise be required for a tray manufactured from a single component.

Embodiment 20

Referring now to FIGS. 268-270, a preferred tray with flaps is shown. Tray 7202 includes a crest 7200 constructed on the perimeter of the tray opening on a wall of the tray 7202. A similar crest is also constructed on opposite sidewall so as to form two convex areas having a first radius. Referring now to FIG. 269, a flap is shown with a flap base 7204 having a concave indentation 7204 of a second radius. When folded, as in a finished package, flap base 7204 is substantially level with the tray base 7216. Preferably, two such flap bases are provided, each in opposing sides from the other. Referring now to FIG. 270, a plurality of finished stacked packages using the trays of FIG. 268 is shown. Preferably, the flap base concave indentation radius is smaller than the radius of tray crest, so that when stacked, flap base of upper tray 7212 makes contact with tray crest of lower tray 7214 at two locations 7208 and 7210. In this manner, trays are prevented from rocking back and forth if only one contact point is provided. Preferably, a space is provided between upper tray 7212 and lower tray 7214 which is also shown in FIG. 270. In this manner, the underside of tray base 7216 is prevented from touching the sealed or overwrapping web on lower tray. The sealed or overwrapped web material substantially holds the fresh meat portions to the tray base. Preferably, the web material is oxygen permeable. Finished packages can thus be stored and packaged in any of the master containers disclosed herein. The disclosed tray profile allows stacking of several layers of trays in a vertical stack, wherein each loaded and over wrapped tray is located directly above and in contact with a lower tray to maximize density of a finished master container. Preferably, the profile of the flaps is an upwardly arched base that corresponds with the profile of the tray upper flange profile. Preferably, ground meat is extruded with a profile that corresponds to the inner profile of the cross section across the length of the tray such that when loaded into the tray, the upper surface of the extruded grinds portion is in firm contact with the tray over wrap so that it holds it in place and slightly below the upper edge of the flanges. The end flanges are arched to match the arched base and end flap profile of the lower tray profile. Continuous bonding of each flap around it's perimeter to ensure that the end edge butts up and contacts the adjacent flaps provides for maximum structural stability and minimum twist after fabrication and bonding. Thus, the double walls (inner cavity and outer flap) improve crush resistance.

Trays with Iron Powder

Powdered iron is often used as an agent for scavenging free, residual oxygen gas in packaged perishable, foods; for example Keplon Co., Ltd. of Kanagawa, Japan have manufactured deoxidizers such as Keplon-TY for this purpose. As exemplary of the application of the method to the present invention, reference will be made with regard to FIG. 49, but it should be readily apparent that the method herein described can be easily applied to any of the trays made from the present invention. Powdered iron may be applied to the inner surface of the outer cover 4140, in such a manner so as to become activated by water that may be provided in the adhesive layer 4136. Furthermore when the outside-surface of foam 4142 (see detail in FIG. 49) is arranged to have a capacity to absorb liquids, such liquids can be retained and substantially prevented from escaping from within the finished package. Additionally, a suitable adhesive can be provided between the tray flange rim 4144 and the outer cover 4140 where the continuous flange rim 4144 is in contact with the outer cover.

Powdered iron can be used as an oxidizing agent and removal of oxygen gas from within a hermetically sealed, gas barrier package. Powdered iron may be applied, in combination with other suitable sealing substances and agents, to the surface and most preferably to an inner surface, of the outer cover 4140 at locations that will become in direct contact with underside of the base of tray. The iron powder can be applied to outer cover 4140 in such a manner so as to allow subsequent activation by water that may be contained in the adhesive layer 4136 when applied to the under surface of the base of tray, at the time of over wrapping the tray with perishable goods therein, and when cover 4140 contacts the base of tray.

Prior to application to the inner surface of the outer cover 4140, the powdered iron particles may be coated with a suitable coating including a suitable protecting substance or blend of protecting substances, that can provide a protecting layer over the complete outer surface of the iron powder particles thereby protecting and isolating the iron powder particles from direct contact with water or other substances that may cause the iron powder to oxidize. The protecting layer can thereby remain in the protecting condition until the coating is altered to allow water to permeate therethrough or otherwise contact the iron particles. The coating may be altered at, for example, a convenient time after complete or partial assembly of the finished packages by exposing to an electromagnetic field of such intensity or in such a manner as to induce generation of heat in the particles of iron. Generation of heat in the iron particles by, for example, exposure to an electromagnetic field, may be induced by a suitable frequency of alternating electric current. Generation of heat in this manner may cause the protecting coating to release water or allow water from adhesive layer to contact and thereby activate the powdered iron to oxidize. Oxidation of iron powder in this way can result in absorption of residual oxygen that may be present inside the master package. Any suitable coating that possesses the required chemical and physical properties may be used to coat the iron powder. In this way the iron powder particles can be maintained in a protected and “dormant” condition until required to absorb oxygen such as after sealing of the package and when enclosed within a master container.

In this way air and gasses can be removed from the finished and sealed packages by evacuation and then replaced by gas flushing with a desired gas, while liquids such as blood cannot readily escape. Furthermore, gasses can readily flow through the communicating passage from inside to outside of the package (but still inside the master container) to enable rapid equilibration of gasses when oxygen gas is released by reduction of oxymyoglobin after sealing of the master container. Any residual oxygen that may remain present in the sealed master container can be absorbed by the oxidizing iron particles after activation with the electromagnetic field, causing release of water or other suitable substances and direct contact with the iron particles.

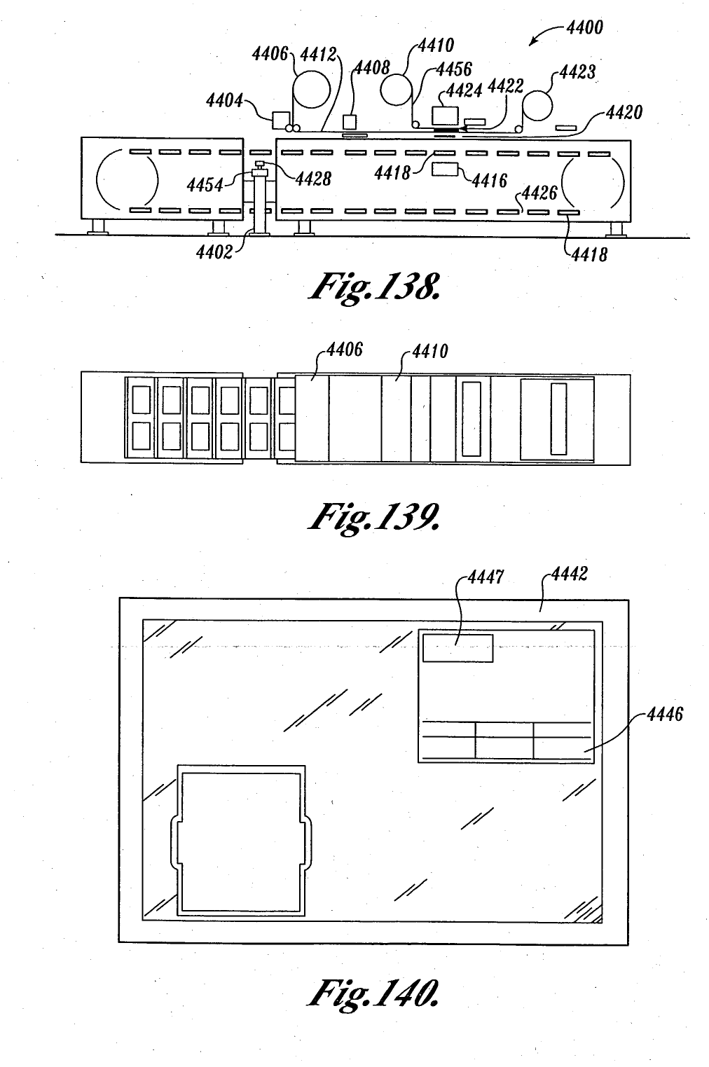

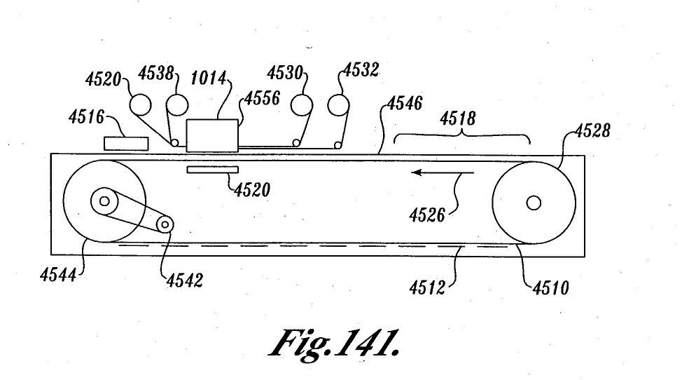

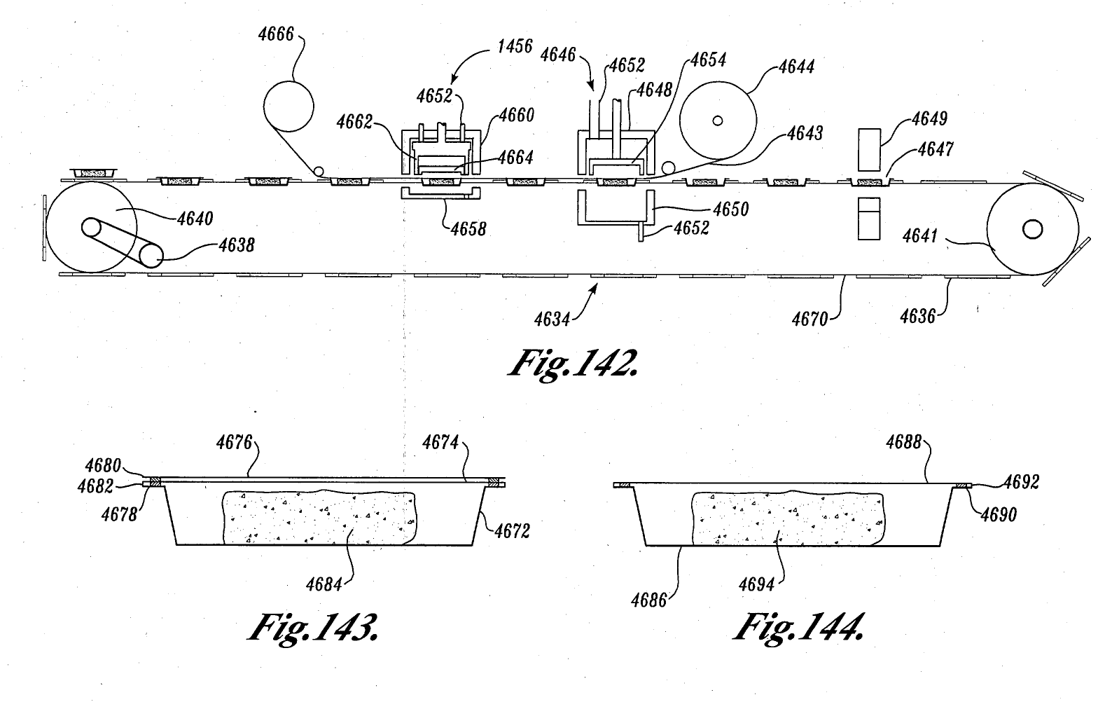

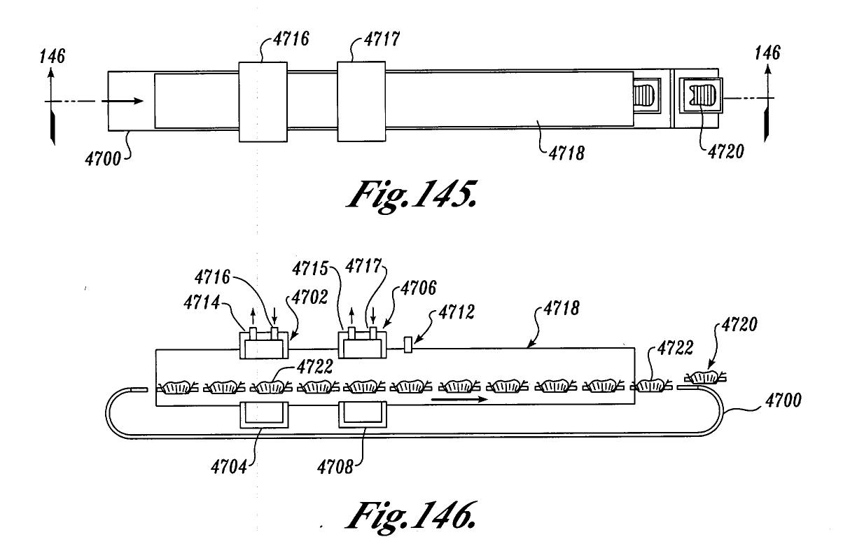

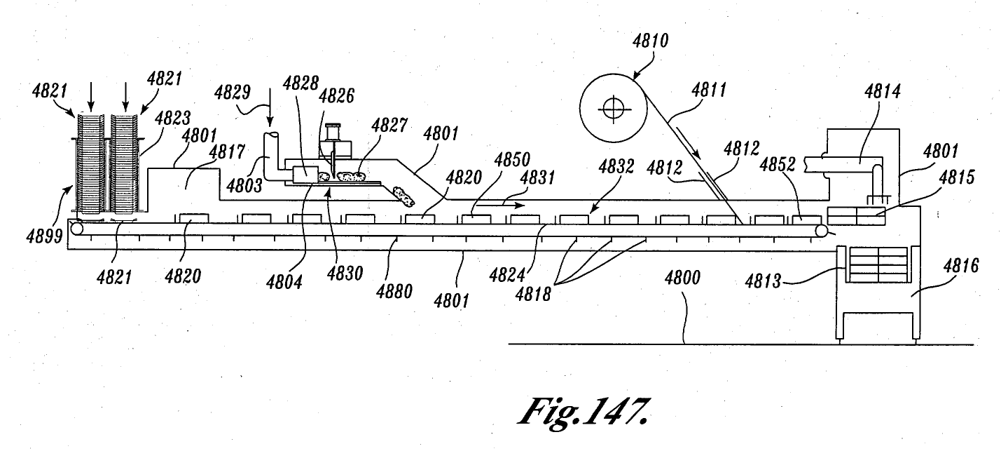

Referring now to FIGS. 137-139 three cross-sectional views of selected sections of EPS trays with flaps are detailed. FIG. 137 shows a section of a tray with a flap attached at a hinge and where the flap is “open” and not folded so as to be in contact with tray 3500. FIG. 138 shows a flap folded into a finished position and contacting tray 3500. The flap may be formed with a recess 5506 that can be a arranged to be a continuous recess that follows a path close to the perimeter of the flap. The tray can be arranged to have a ridge 5508 that follows a path corresponding to the recess 5506 such that when the flap is folded about the hinge so as to intimately contact the tray wall and base, the ridge 5508 will mate with the recess 5506, as shown in enlarged view of FIG. 139. Accordingly, the flaps with heat activated adhesive applied in recesses 5506 can be folded, as shown in FIG. 138, so as to cause intimate contact with the tray base 5512 and/or walls 5514 thereby providing a tray with folded flaps. The tray with folded flaps can be held in such a folded condition so as to hold ridges 5508 firmly against adhesive and in continues contact with 5516 along the full length of the ridge and recess. The tray with folded flaps can be transferred automatically into and through a microwave oven source of heat such that adhesive 5516 is activated by exposure to a suitable level of microwave heat source and thereby bond the flap and tray together at ridge 5508 and recess 5506. The bond can be arranged along a continuous path and enclose the space between the flaps and the tray so as to provide a substantially liquid tight seal. Selective heating of adhesive 5516 can be provided by microwave or magnetic field devices so as to cause bonding without application of excessive heat that could otherwise cause undesirable distortion to the EPS tray. Any suitable heat activated adhesive may be provided by any suitable device. In another preferred embodiment the heat activated adhesive may be provided in the recess 5506 by computer controlled robots such as in the form of a heated and softened continuous extruded bead that may be subsequently heated so as to provide good bonding in the recess, followed by cooling thereof to provide hardening of the heat activated adhesive. Heat activated adhesives may be applied to the tray with flaps or any other suitable packaging materials by any suitable method prior to bonding. Subsequent exposure to microwave or other suitable source of heating, that can be selectively applied in such a manner so as not to cause undesirable damage or distortion to the packaging materials, can produce a package according to the present invention. A suitable device for adhesive application to selected surfaces of packaging may be provided by the known process of ink jet printing.

Any suitable substances for enhancing the keeping qualities of goods can be provided into the spaces between the flaps and the tray walls. Water, liquid and purge absorbing substances can be provided in those spaces which may be arranged so as to be non absorbing prior to exposure to and capable of absorbing liquids only after exposure to microwaves or a magnetic field.

Apparatus for Applying Adhesives and Iron Powder to Trays

Trays constructed according to the present invention may have one or more features which lends itself to be stackable or allows the channeling of gases, while retaining liquids. Trays with flaps are preferably constructed with adhesives to form the finished tray. This description therefore provides a method and apparatus for applying adhesives and other substances to the trays.

Referring now to FIGS. 140-142, an apparatus constructed according to the present invention that can be used to apply substances to the surface of packaging materials, such as EPS trays, for bonding thereto is shown.

In FIG. 140 a cross-sectional view through a diagrammatically represented apparatus is shown where a horizontally disposed motor driven conveyor 5400, can be intermittently indexed by driving for a set distance or movement. Magnets 5402 can be located in the conveyor 5400 in convenient positions. A web of tray 5404 impressions can be arranged to mate with the conveyor 5400 and can thereby be carried by the conveyor. The distance traveled by the conveyor in each movement or index is equal and can be arranged so as to carry a single tray impression a distance equal to the machine direction length of each consecutive tray impression. Such an arrangement can therefore position each tray impression adjacent to a station or processing device for a desired period of time followed by further movement of the tray impression to a subsequent station to allow further processing. FIG. 140 shows a first, second, and third station which are marked 5406, 5408 and 5410, respectively. Station 5406 is arranged to apply an adhesive 5412 by a nozzle spray device 5412 to an exposed surface of the tray impressions. Station 2 is arranged to dispense iron powder 5410 or other suitable substance, from a conveniently located hopper 5418 with valve 5420, directly above an exposed surface of a tray impression that has had adhesive applied thereto. Magnets 5402 which may be arranged as permanent or as electrically induced (electromagnets) magnets, are conveniently located in the conveyor such that when iron powder 5416 is dispensed from hopper 5418, it will be attracted toward the magnets 5402 and be deposited in a pattern on the exposed surface of the tray impressions. The pattern of iron powder deposits can be determined by the profile/shape of the magnets 5402 which can be adjusted as required to provide a suitable pattern. The powder 5416 may be then bonded by adhesive to the tray impression 5424. Third station 5410 can be arranged to apply drying or curing, such as a radiant heater 5422, to the adhesive sprayed and tray impressions 5424 and thereby cause setting and/or drying of the adhesive applied at the first station 5406 with iron powder 5416 thereto. The iron powder applied at second station 5408 can thereby be suitably bonded to the tray impression 5424. Additional stations may be arranged, adjacent to the conveyor 5400 so as to apply additional layers of adhesive and/or additional substances as may be required.

Referring now to FIG. 141, a cross-sectional view through a section of a diagrammatically represented apparatus is detailed and showing a profiled vacuum plate mating with a section of an EPS tray that is located between a manifold 5426 and a vacuum plate 5428. Manifold and the vacuum plate can be attached to moving devices such as pneumatic cylinders that can be operated as desired to move the vacuum plate and the manifold toward and away from each other in an automated cycling and repetitive sequence. The vacuum plate and the manifold can be closed together so as to conveniently clamp an EPS tray (or other material) therebetween for a period of time. The EPS tray can be arranged with perforations 5430 therein. The perforations can be located in a recess shown as 5432 in the enlarged view in FIG. 141. The vacuum plate can be provided with vacuum ports 5434 therein and located so as to provide connection between the under surface of EPS tray and a suitable vacuum source 5436. In this fashion a vacuum source can be applied to the under surface of the EPS tray with communication through the perforations 5430. The manifold can be provided and arranged with suitable openings that connect selected exposed sections, such as sections 5440 and 5442, on the exposed surface of the tray to a source of powdered substances “ADSP”. In this way powdered substances, such as heat activated adhesives, can be provided into the manifold openings and by applying a vacuum source to the underside of the tray, the powdered substances can be deposited onto the exposed surfaces of the tray and/or in recesses such as recess 5432. After the powder 5414 has been deposited into the recesses 5432 the manifold and vacuum plate can be opened pneumatically allowing the EPS tray to be removed therefrom and subsequently passed into and through a suitable heat and/or suitable energy source, such as a microwave oven. The powder 5414 can be arranged to contain substances such as water or suitable metal elements, so that when the tray with powder 5414, 5444 is exposed to a microwave, magnetic field or other suitable source of heating energy, the powder will be heat activated and bond together and to the surface of the tray and in the recess 5432. The powder 5414, 5444 can thereby be securely bonded to the EPS tray at selected locations on the exposed surfaces of the EPS tray. This method of using a magnetic field, microwave or other suitable source of heating energy can selectively heat the powder 5414, 5444 without application of excessive heat to the EPS tray. Powder application apparatus including the vacuum plate and the manifold material clamping devices with all required driving and controlling apparatus can be integrated into a typical thermoforming equipment, such as an Irwin Magnum or a Commodore 730-12 MM continuous thermoformer (as manufactured by Commodore Machine Company of Bloomfield, N.Y. The disclosed powder application with selective microwave heating of the powder 5414, 5444 can be located between a thermoforming station and a trim press of the thermoforming equipment. In this way, a heat activated adhesive can be applied to specific locations of any suitable material such as the flaps and/or tray walls of EPS trays such as a tray with flaps described above.

Apparatus for Applying Adhesives and Iron Powder to Outer Cover

Referring now to FIG. 143 an embodiment of apparatus constructed according to the present invention to apply adhesive materials and powdered iron to a web of material such as stretch or shrink wrapping materials is shown.

The description disclosed herein provides details of a method and apparatus for producing stretch or shrink wrapping material that can be used in the production of those packages disclosed above, having an outer cover web material. The stretch or shrink wrapping material with powdered iron attached thereto absorbs any residual oxygen that may be present within the master container and also the cell structure of EPS materials used in the production of the finished package.

The apparatus shown in FIG. 143 includes a series of rollers, a hopper containing powdered iron, a tray containing solvent based adhesive, an oven and a continuous web of outer cover material 4300 that is arranged to follow a path over rollers, through oven and onto a web winder assembly as shown. The sketch includes a cross-section through the apparatus.

A suitable tension is applied to web outer cover material 4300 which is arranged to follow a path over idler roller 4302 and then to contact imprint roller 4304, over roller 4306, between oven segments 4310 and onto a roll 4310 at a web winder assembly 4312. Web 4300 is wound onto roll 4310 by web winder assembly 4312 at a suitable tension and speed. In this manner, imprint roller 4304 is arranged to apply a suitable adhesive, which may be solvent based, onto web 4300 in a registered print pattern and in rectangular areas 4314 as shown in FIG. 144 where a section of finished web material 4316 is detailed in plan view, with a cross-sectional view shown in FIG. 145, after processing through the apparatus shown in FIG. 143. The method includes transferring the adhesive 4318 from the tray 4320 via contact with roller 4322 which in turn transfers the adhesive to transfer roller 4324 which in turn transfers the adhesive onto the imprint roller 4304. Transfer of the adhesive from the transfer roller 4324 to imprint roller 4304 occurs only at selected areas on the roller 4304 that correspond with the rectangular areas 4314 such that areas 4314 only are imprinted with the adhesive applied thereto and leaving other sections of the outer cover 4300 free of adhesive. The outer cover web material 4300 can be printed with information and graphics as required on the opposite side of the web to the applied solvent based adhesive in rectangular areas 4314 and in registered relationship to the rectangular areas 4314, such that when the web 4300 is cut by slitting along the length of the outer cover web, and wound conveniently onto rolls, the web 4300 can be applied, in an earlier described manner to cover the finished packages and with the rectangular area 4314 adjacent to and in direct contact with the base of trays.

Referring again to FIG. 143, powdered iron is dispensed from the hopper evenly across the web, so as to fall directly downward toward web 4300 above roller 4306. Roller 4306 includes a tube manufactured, most preferably, from a non-metallic material such as fiberglass and is cylindrically ground on both internal and external surfaces to provide a finished tube of specified internal and external diameters. External diameter is arranged so as to have a circumference equal to two (×3 across the web) consecutive imprints (6 imprints in total) of rectangular areas 4314 per single revolution of the roller 4306. Correspondingly, during a single, full revolution of the roller 4306, 2 times 3 imprints (6) are applied to the web 4300. Corresponding to the imprint areas 4314, magnets 4305 are located and fixed to the internal surfaces of roller 4306 in a pattern that corresponds with the rectangular areas 4314 in positions such that when the powdered iron is dispensed from the hopper it is drawn by the magnets so as to be deposited substantially within the specified rectangular areas 4314. When the powdered iron contacts the areas 4314, on the web 4300, the powdered iron bonds to the solvent based adhesive applied by imprint roller 4304. The powdered iron thereby becomes fixed to the web 4300 by adhering to the solvent based adhesive. The web 4300 then passes between the oven segments 4308 that are arranged to have sufficient capacity to cure and dry the solvent based adhesive prior to further processing and/or winding of web 4300 onto the roll 4310 by web winder assembly 4312.

Web 4310 may be further processed by applying solvent based adhesive onto rectangular areas 4314 after the powdered iron has been applied and cured together therewith by passing through the oven segments. This process may be repeated several times and as may be required to produce the most effective finished outer cover web 4304 materials.

In yet another preferred embodiment other web materials such as perforated polyethylene and polyester may be laminated to web 4300 and over the powdered iron. Most preferably the powdered iron will thereby be applied and retained between the outer cover 4300 and the polyethylene and/or polyester webs in such a manner so as to allow oxygen to transmit through the outer webs and contact the powdered iron and after reacting therewith, inhibiting the escape of any odor that may be produced as a result of oxygen reacting with the powdered iron, and/or other substances contained therein. Solvent based adhesive can also allow transmission of oxygen therethrough while inhibiting transmission of odors therethrough.

Alternative oxygen absorbing materials that are suitable for the application may be applied with the iron powder or in place thereof.

The finished web material 4316 can be slit and wound onto conveniently sized rolls for subsequent use as the outer cover of packages similar to the finished packages described above.

Tray Sealing Apparatus

Webs suitable for use as trays and covers have thus far been disclosed. A method for sealing a cover to a tray web now follows.

Referring now to FIG. 146, a tray sealing apparatus is shown to produce packages, including a tray, a web and perishable goods contents shown as ground meat. The perishable goods may be portions of beef, pork, or any other suitable perishable goods. A horizontally disposed, continuous conveyor 2326 including a number of carrier plates 2302 suitably attached to chains is arranged adjacent and below a series of stations. The conveyor 2326 is driven by a driver that intermittently indexes in a forward direction indicated by arrow 2328, at a rate of one carrier plate per index. Trays 2300, as described in any of the previous embodiments, are dispensed into apertures in the carrier plates 2302 at a first station generally denoted by the number 2330. With each progressive forward indexing movement of the conveyor, stations will perform a function. Cutting devices at a second station generally denoted by 2304 severs flaps. Product such as portions of ground beef is loaded into the tray at a product loading station 2306, and a web of material 2308 is heat sealed to flanges at a heat sealer station 2312. Scrap material from web 2308 is wound onto scrap roll 2310. Preferably, tray apertures are provided by heated pin devices at station 2314. Flaps are turned over by rotating about hinge so as to then locate flanges adjacent to tray 2300, at flap turning station 2316. Preferably flanges of flaps are then sealed to flanges of tray at station 2318 and flange trimming is performed as may be required at station 2320. Labeling is done with a tray labeler at station 2322. The finished tray with perishable goods packaged therein is ejected from the conveyor at an ejector station 2324.

Referring now to FIG. 14, a preferred tray constructed according to the present invention is shown in an inverted position. The tray 2402 includes those apertures made by the apparatus of FIG. 83.

Method and Apparatus for Evacuating Master Containers

Trays constructed according to the present invention provided structures which allowed the evacuation of ambient atmosphere and flushing with inert gases. Trays according to the present invention are also stackable atop one another to allow placement within a master container. Therefore, a method for evacuating a master container appropriately follows.

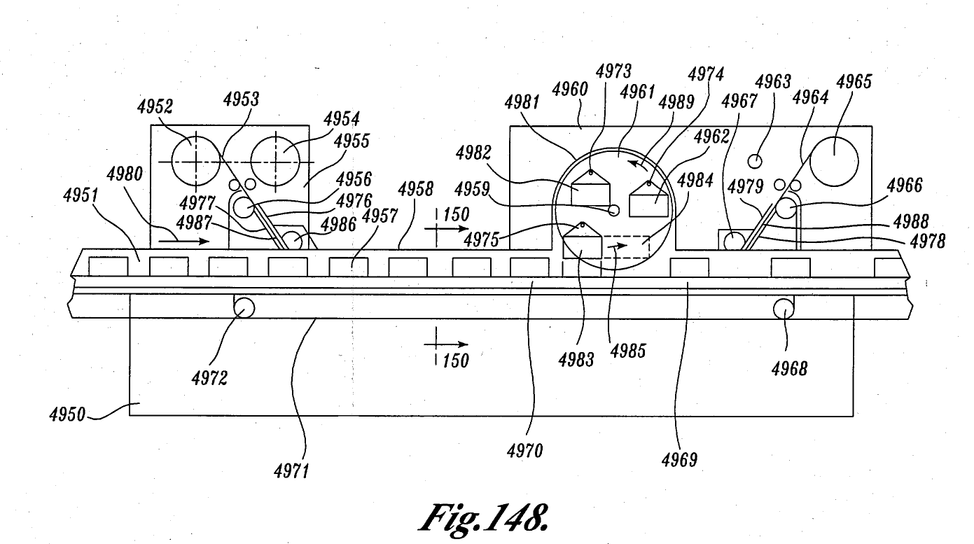

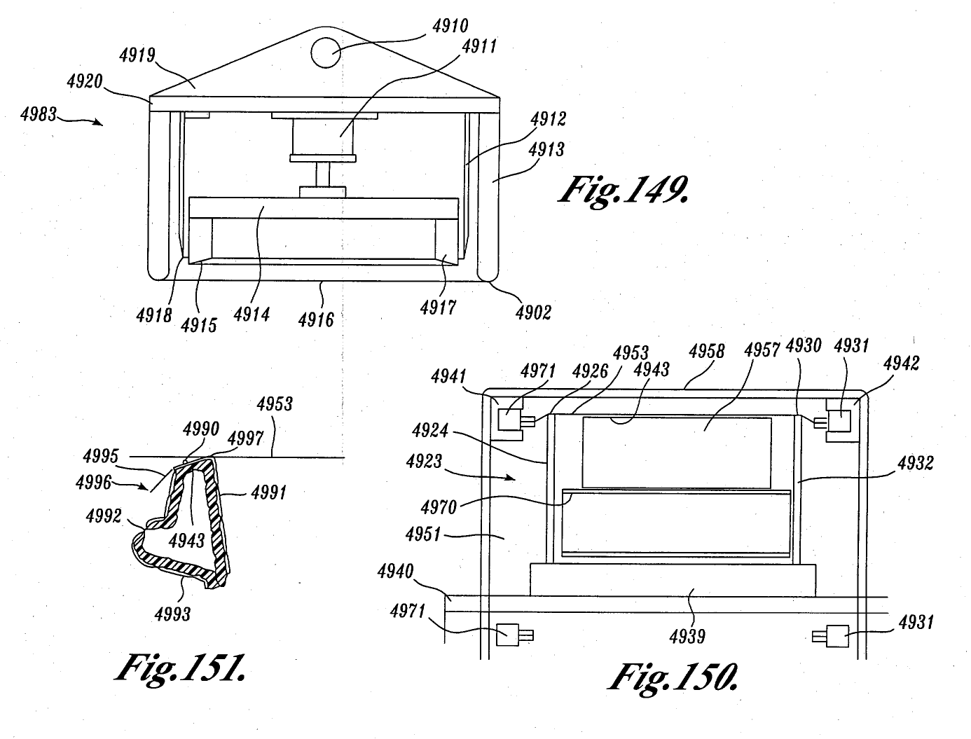

Referring now to FIG. 148, details of a vacuum and modified atmosphere packaging and sealing apparatus is shown. The apparatus 3564 can be used to hermetically seal a web of material over the open end of a plastic bag or pouch. The web of material and pouch may include substantially gas barrier materials and the hermetically sealed pouch and web can be used for any useful purpose, such as vacuum packaging meat primal portions or to contain one or more retail packages, thereby providing a master package which can be subsequently packaged inside a suitably sized shipping carton.

The apparatus 3564 includes a lower vacuum chamber 3566, that is suitably mounted with a driver (not shown) attached to a shaft 3568, an upper vacuum chamber 3570 with a moveable heat bank 3572, attached to a driver (not shown) via shaft 3574 and suitably mounted between the upper and lower vacuum chambers, and a web unwinding assembly 3576 arranged to allow controlled unwinding of web material 3578 from roll 3584. A conduit 3582 is connected to upper vacuum chamber 3570 and a conduit 3584 is connected to lower member 3566. Both conduits 3582 and 3584 can be connected to a suitable source of vacuum and/or supply of suitable gas. The upper vacuum chamber 3570 is fitted with a suitable rubberized sealing member 3586 which is attached to the rim of the vacuum chamber 3570 and a corresponding and matching sealing member 3588 is mounted, in similar fashion, to a rim of member 3566, so that when the upper and lower vacuum chambers are closed and held together, members 3586 and 3588 are in intimate contact with each other, thereby providing an enclosed vacuum chamber that is sealed from ambient atmosphere with space 3590 contained therein. Web unwind assembly 3576 is arranged to unwind material 3578 from roll of material 3580, as required, and locate the web between the upper and lower vacuum chambers. In this way suitable portions of the material 3578 can be automatically unwound by web unwind assembly and clamped between sealing members 3586 and 3588. Referring now to FIG. 150, it can be seen that rim at 3588 is extended beyond rim at 3592 such that when web 3578 is clamped between members 3566 and 3570 a space 3594 between the web 3578 and the rim at 3592 is provided. Sealing members 3588 and 3586 are parallel and follow adjacent paths at parallel perimeters of the respective members 3570 and 3570 along corresponding rims at 3586 and 3588, such that when the vacuum chambers 3570 and 3566 are closed together a completely sealed and defined space 3590 is provided therein. In this way space 3590 can be evacuated and substantially all air contained therein removed, as required, and then space 3590 can be filled with suitable gas such as nitrogen, CO₂ or any other suitable blend of gases, at a suitable pressure, via conduits 3582 and 3584.

Referring now to FIG. 149, a three dimensional sketch is shown of the lower vacuum chamber with a portion of the lower vacuum chamber shown in FIG. 150. The vacuum chamber can be manufactured from any suitable material such as stainless steel. It can be seen that vacuum chamber 3566 includes a rectangular profiled component with vertical walls and a rectangular depression 3596 provided therein; two parallel and continuous rims, an inner rim 3592 and an outer rim 3598 are provided with a recess 3600 between the parallel rims. A suitably sized pouch 3602 can be located into the depression 3596 and the “mouth” 3604 of the pouch can be cuffed over the rim 3592 such that the mouth of the pouch is tensioned around and over the external and upper surface of rim 3592. A vacuum source can be provided to recess 3596, via conduit 3584, such that the pouch can be drawn against the internal walls of the depression 3596, prior to closing the upper and lower vacuum chambers together. In this way the mouth portion of the suitable pouch 3602 can be tensioned across the rim 3592 in such a manner so as to ensure that no creases are present in the pouch mouth section that is located directly adjacent (and above) the rim 3592. Any suitable stretching devices may be provided that will stretch the mouth section of the pouch and ensure that no creases are present, thereby allowing subsequent and effective sealing of the web 3578 to the pouch when required. Following loading of goods into the pouch 3602, heat bank member 3572 can be activated so as to provide heating and sealing of a section of web 3578 to the mouth of the pouch around the full continuous length of rim 3592. An automatic cutting device 3606, can be arranged so as to provide suitable cutting and severing of the web 3578 after sealing to the pouch. In this way web 3578 can be hermetically sealed to the mouth section of the pouch 3602 so as to completely seal and enclose any space and goods that may be located in the pouch prior to sealing of web 3578 thereto.

Any suitable method of manufacturing a suitable pouch with adequate gas barrier properties may be employed to manufacture the pouches. For example the pouch may include a suitably sized, multi-layer plastics tube, extruded from an annular die with specified layers of material that provide all gas barrier and sealing properties and features required. Such a tube may be extruded and cut into suitable lengths and then heat sealed to close one end of each length of tube, in any suitable fashion, to produce pouches and, if required, a valve may be fitted to the wall of the pouches. The valve can be arranged to allow excess gas such as carbon dioxide, that may be generated in the pouches after sealing with goods, such as carbonized retail packaged ground meat, therein.

Referring again to FIG. 149, a grouping of several identical such members 3564 may be arranged by attaching to the upper surface of a suitable conveying device such as a horizontally disposed carousel style, circular table, of suitable size arranged with suitable driver to intermittently rotate the carousel. In this way, pouches could be automatically loaded into each lower vacuum chamber 3566, consecutively and immediately prior to loading goods into the pouch. After loading the goods, the carousel can rotate so as to locate the loaded member 3566 directly under upper vacuum chamber 3570 and web unwind assembly so as to allow sealing of a section of web 3578 thereto. In this way, an automatic and semi-continuous packaging process can be arranged to automatically open the pouches, load into member 3566, fill the pouch with goods, evacuate and gas fill the pouch with goods therein and then heat seal a web of material 3578 over and to the mouth of the pouch. An automatic ejection device can be provided that may include a method of relaxing tension in the pouch mouth and lifting the sealed and finished pouch (with goods therein) from member 3566 and then locating the finished pouch into a carton prior to closing the carton closed and sealing the finished pouch therein.

Referring to FIG. 213, yet another preferred embodiment f an apparatus 7200 for producing a master container with finished packages is shown. Equipment 7200 includes an upper chamber 7206 and a lower chamber 7210. A master container 7216 with finished packages 7208 is contained within lower chamber 7210. The operation of this apparatus is in many respects similar to the previous embodiments. Master container 7216 is loaded with finished packages 7208, and located in the lower vacuum chamber. A web 7214 is passed through the chamber to cover the opening in the master container 7216. The upper 7206 and lower 7210 chambers close, providing a substantially air tight seal. Air is evacuated through any number of ports 7204 and 7212 a suitable gas is flushed into the chambers. The cycle can be repeated any number of times to expel the air and/or oxygen from the master container 7216 and packages 7208. The master container is then sealed with web 7214. The vacuum chambers separate, and a new master container is evacuated, flushed and sealed.

In yet another preferred embodiment, the packages need not have apertures, but rather are sealed or wrapped with a web that expands to fill the voids in the master container to expel the air. This is possible because the web preferably has memory, to contract to its relaxed state. The packages need not be evacuated because packages can be wrapped in a low oxygen atmosphere according to the invention, thus eliminating the need for values.

Method and Apparatus for Packaging, Labeling and Weighing

Trays containing perishable goods are preferably weighed and labeling prior to sealing. Therefore, it is appropriate to describe a method and apparatus of the invention for such a task.

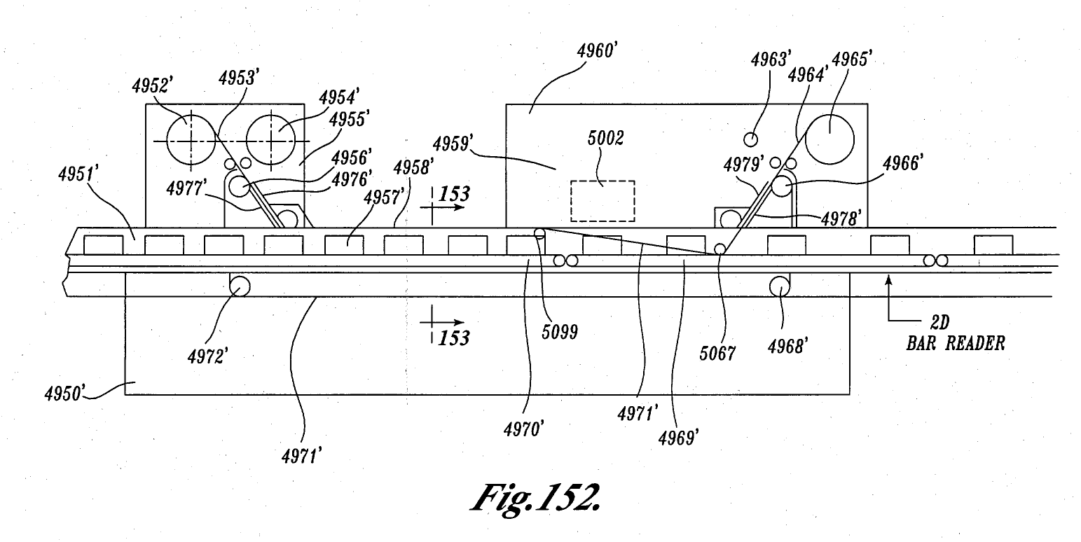

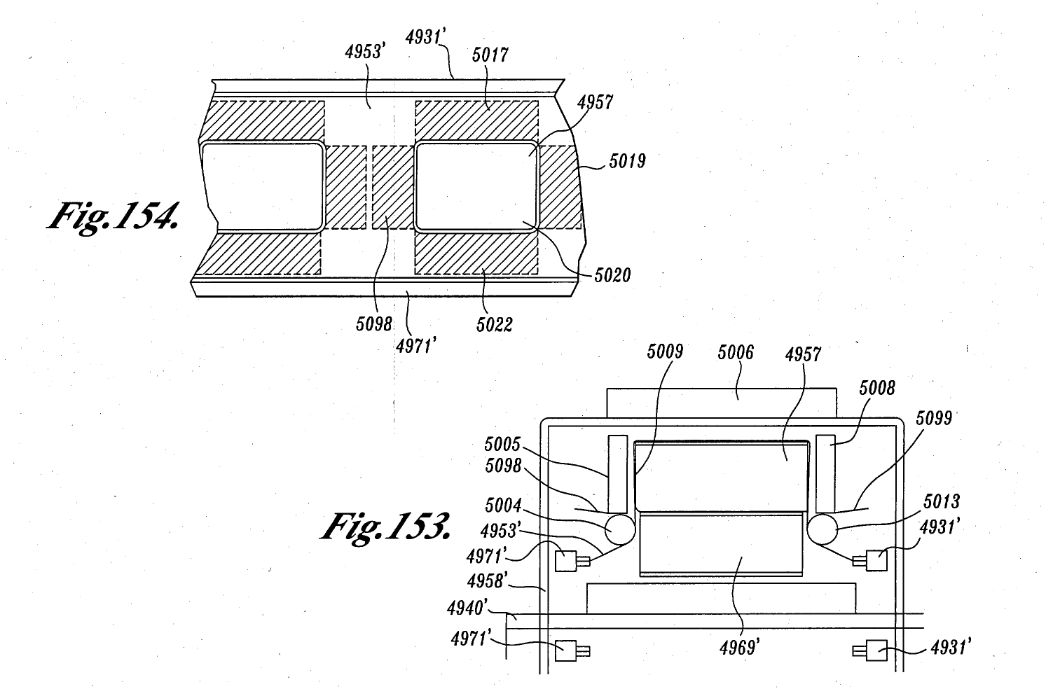

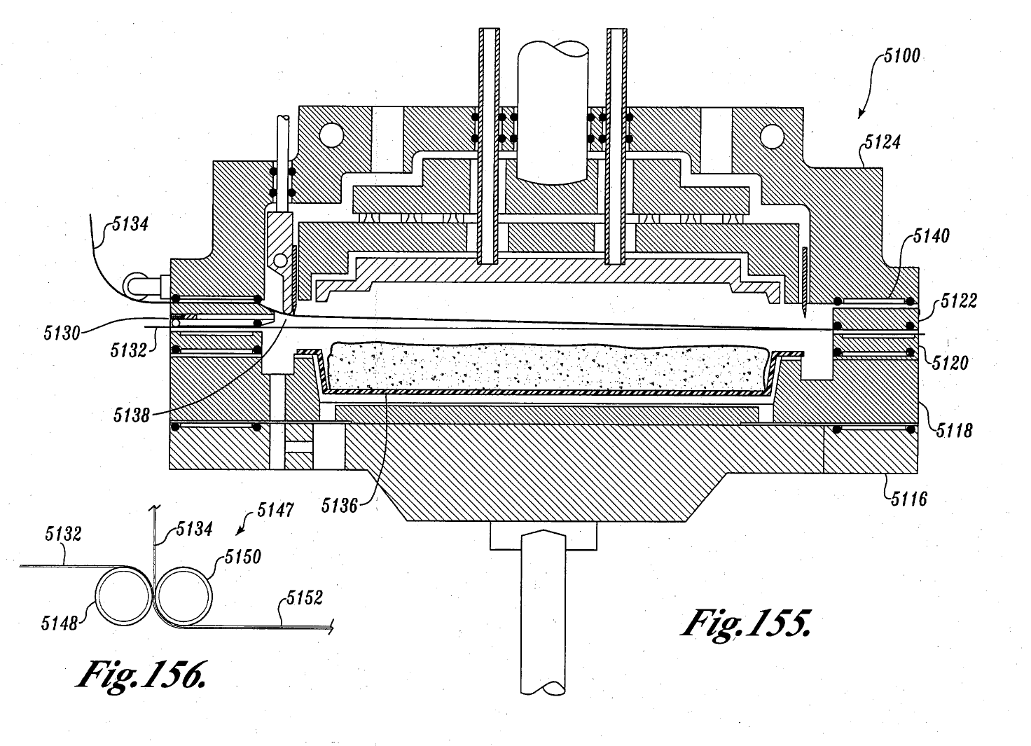

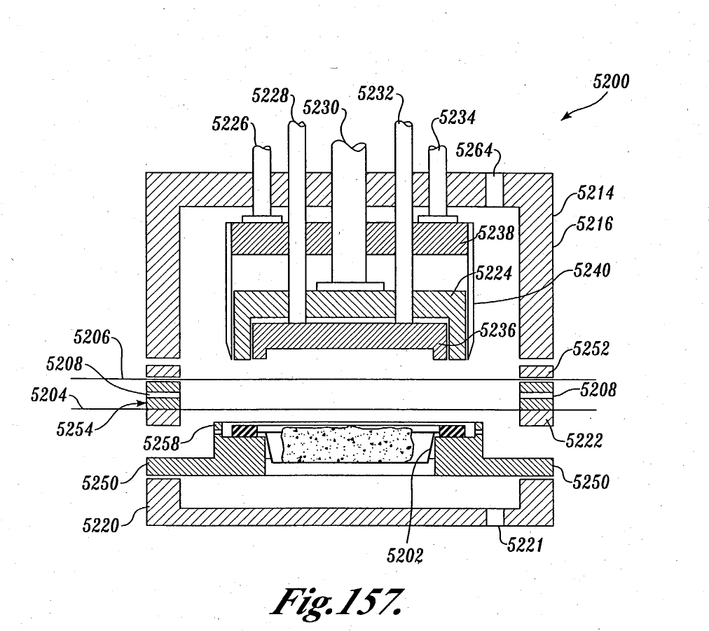

FIG. 151 shows a packaging machine constructed according to the present invention to apply label(s) to the second web and also an alternative printing device to print directly onto the second web. Reference is also made to patent application PCT/AU93/00484, which is herein incorporated by reference. FIG. 151 shows a side elevation of the packaging apparatus and FIG. 152 shows a plan view of the upper side of the packaging machine of FIG. 151. Packaging machine 1800 is arranged in two sections to provide a space so as to allow a sufficiently clear area to install a scale 1802 with load cells 1828. Packaging machine 1800 is mounted and attached to the floor (also shown) independently of scale 1802 such that they are not in contact with each other. Second web unwind roll 1806 is provided with braking devices attached thereto. Drive 1804 is arranged to unwind second web from roll 1806 of second web 1812. Printer 1808 is located between second web roll 1806 and third web roll. Printer 1808 is attached to driver to move in X, Y and Z axis in horizontal and vertical planes. Printer 1808 includes a mechanism to print onto labels and then apply labels to second web or alternatively print directly onto second web. Third web roll 1810 is located above second web 1812 and is fitted with braking devices as well to maintain tautness of the web as it is unrolled. Packaging apparatus 1800 includes a vacuum chamber assembly. The assembly includes a number of components including a lower 1816 and upper 1824 vacuum chamber, a lower 1820 and upper 1822 plate and a sealing plate 1818.

FIG. 154 shows a cross-section through the vacuum assembly constructed according to the present invention. Sealing plates 1818 are arranged in a conveyor which is driven by a motor as required providing intermittent movements of the conveyor 1826. Lower vacuum chamber 1816 is independently moved by pneumatic driver (not shown) so as to apply pressure to underside of sealing plate 1818. Plate 1820 is located between sealing plate 1810 and plate 1822. Plate 1822 has vacuum port 1830 provided therein. Upper vacuum chamber 1824 is located above plate 1822. All components are in vertical alignment and when lower chamber 1816 and upper chamber 1824 are retracted and moved in the vertical plane away from each other, plates 1818, 1820 and 1822 which can be spring loaded also “expand” away from each other so as to allow free movement of first 1836 and second 1832 webs between plate 1820 and plate 1827 or between plate 1818 and plate 1820 as may be selected according to requirements or preferred operation of apparatus. As is shown in FIG. 154, third web 1834 enters the vacuum chamber assembly between plates 1822 and 1824 and exits the vacuum chamber assembly between plates 1820 and 1822. Also it can be seen that second web 1832 enters vacuum chamber assembly between plates 1820 and 1822. A space 1838 is shown between the second 1832 and third 1834 webs with port 1830 opening into space 1838. During the operation of the packaging apparatus, after closing of lower vacuum chamber 1816 and upper vacuum chamber toward each other thereby providing a closed and sealed vacuum chamber, a vacuum source can be applied to port 1830 and thereby evacuate substantially all air from the space 1838 Evacuation of air from space 1838 can cause second 1832 and third 1834 webs to become laminated together after removing substantially all air from the space 1838. Slots shown as 1840 are provided between the faces of plates 1816 and 1818, 1818 and 1820, 1820 and 1822, and 1822 and 1824. These slots provide spaces between each of the components also, “O” rings are fitted along the outer edges of each slot to provide a seal when the components are in contact with each adjacent component. A vacuum source can be applied to each of these spaces, simultaneously, thereby providing a method to hold them together with a force equal to that provided by the ambient atmospheric air pressure prevailing at the time. The holding force that urges the components together is therefore approximately equal to the width of the slots between each component, times the length of the slot, multiplied the difference of the prevailing atmospheric air pressure minus the air pressure within the slots defined by the equation:

F=WL(Pₐ−Pₛ)

wherein,

F is the force,

W is the width of the slot,

L is the length of the slot,

Pₐ is the atmospheric pressure, and

Pₛ is the pressure inside the slot.

The width of each slot can be arranged, by enlarging (or decreasing) so as to provide a level of force that exceeds the desired and opposing force of gas pressure within the closed chamber. A pair of “O” rings are also provided around all shafts that penetrate the chamber and spaces provided between each pair of “O” rings can also be evacuated.

Referring again to FIG. 151, printer 1808 is equipped so as to either apply a label or print desired information onto second web 1812. Load cells 1828 are located along a beam 1854 that extends across and under the full width of sealing plates 1818. Beam 1854 can be elevated and lowered. Scale 1802 and beam 1854 is arranged to elevate load cells 1828 upwardly so as to contact underside of trays in apertures of sealing plates 1818 and lift the trays from apertures in sealing plates 1818 in conveyor. Trays are lifted to an extent that prevents any contact with anything else apart from the load cells 1828. The weight of each separate tray can thereby be determined and this information is transferred to a printer 1808. Printer 1808 prints information onto labels (prior to application of label onto second web) or directly onto the second web 1812. Second 1812 and third web 1856 are then laminated together before heat sealing to flanges of first web trays.

FIG. 153 shows one embodiment of a single register detail of second web. The single register detail includes a frame 1842 of heat activated adhesive that can be printed directly onto web. The frame is arranged with dimensions that correspond to the flange of third web tray such that the frame 1842 covers flanges and located above third web tray. Other details of package contents are also shown and boxes 1846 provide areas onto which information can be printed at the time of packaging. Barcode 1847 contains product information, such as date of packaging and weight, which can later be used to determine price at the point of sale.

FIG. 155 shows a cross-section view through a laminating assembly including a first 1848 and second 1850 driven rubber coated roller arranged in horizontal disposition and with devices (not shown) to be urged toward each other so as to press and laminate the second 1832 and third 1834 webs when the webs are passed between the rollers. Rollers are driven by a variable speed motor (not shown). Laminating assembly can be located between the third web roll 1810 and the vacuum chamber assembly and provide a method to laminate second 1832 and third 1834 webs together before entering the vacuum chamber assembly.

Method and Apparatus for Packaging Trays

Trays with flaps constructed according to the present invention can be sealed by a first and second web. Webs are sealed to the flap in the non-folded state in two or one heat sealing stations. Upon bending of the flaps, the webs are stretched, thus, providing a taut appearance and protection for the perishable goods inside.

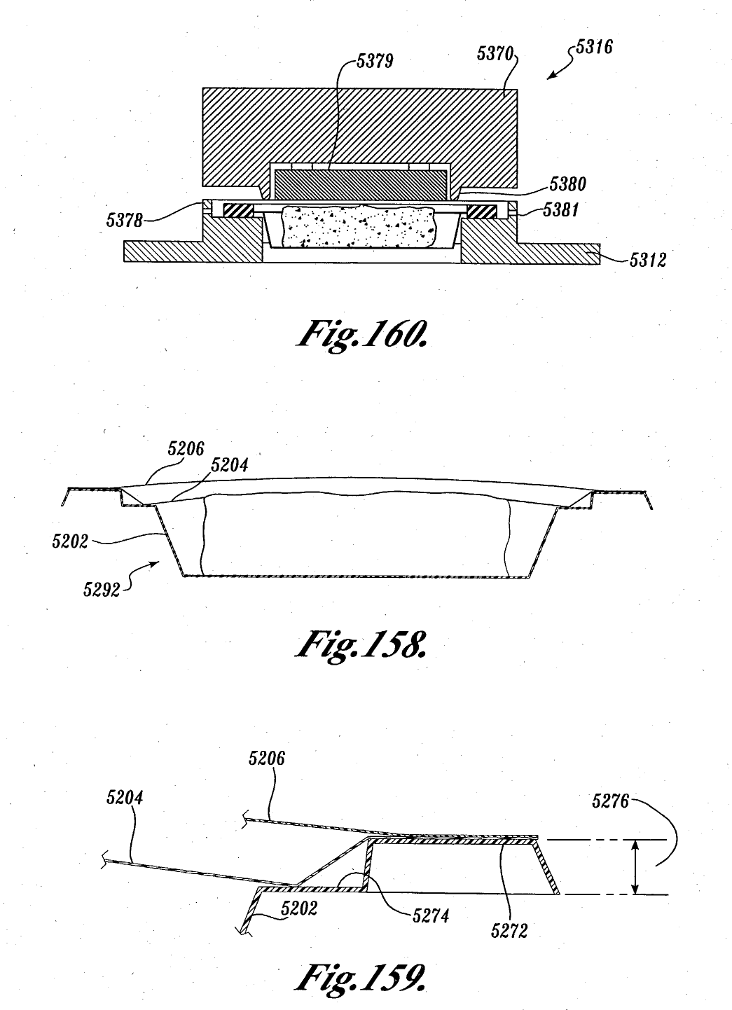

The following description provides apparatus and methods for production of a package of the type shown in FIG. 158, with a pre-stretched second web 1004. The preferred use of this embodiment is for the packaging of shallow products such as boneless pork loin chops, butterfly steaks, thick-cut bone in pork chops and New York Strip, super trim beef and pork cuts that are generally not displayed in the package by shingling but are laid flat and adjacent to each other and spaced apart so that a consumer can inspect carefully.

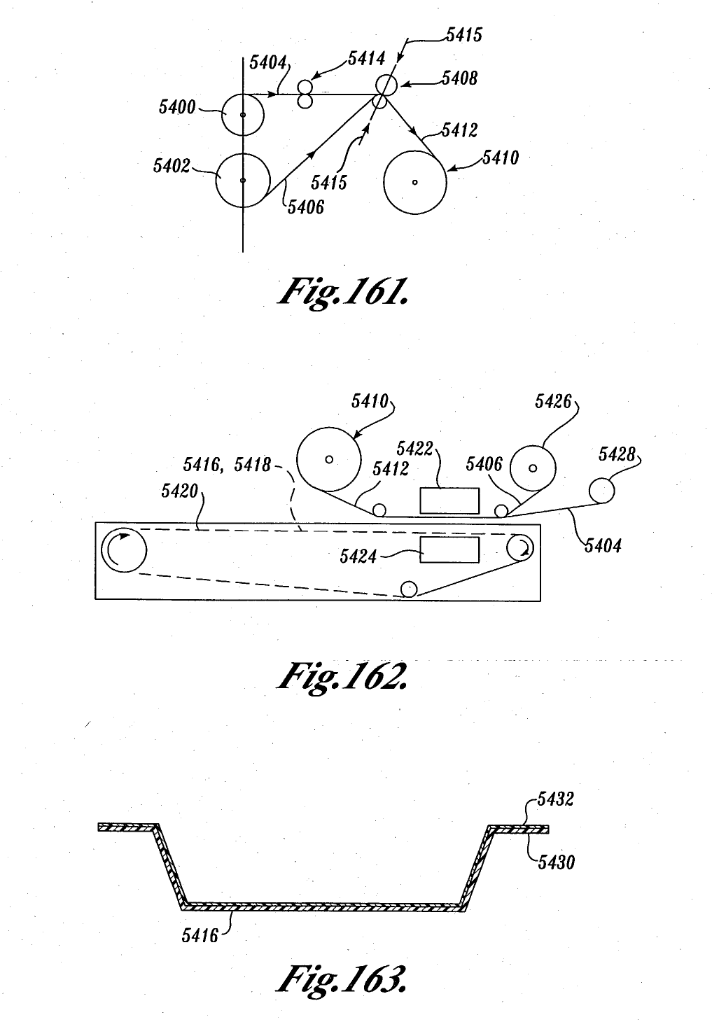

FIG. 168 shows a sketch of a side elevation of a preferred packaging machine constructed according to the present invention that can be used to produce packages of types described herein in this disclosure. The packaging machine includes a frame supporting a driven conveyor with two roller chains located one on each side the packaging machine and engaged with a first 1044 and second 1128 set of sprockets, each pair of the sprockets is located at opposite ends of the frame. Sealing plates, 1012, as shown in FIGS. 159-162 are attached to the roller chains via attachment points. First and second stations, generally denoted by 1014 and 1016, respectively, are located on the upper side of the packaging machine with web unwind arrangements rolls 1130 and 1132 and scrap web wind-up arrangements at 1120 and 1138. Continuous conveyor 1010 carries sealing plates 1012 in the direction indicated by arrow 1126. Details of a preferred sealing plate 1012 can be seen in FIGS. 159-162. Preferably, first and second stations 1014 and station 1016 are mounted onto the upper side of the packaging machine frame adjacent to the upper section of the conveyor 1010. A loading section 1018 is preferably located adjacent to and down stream of station 1014. Conveyor 1010 is supported within the frame and is attached to a powered indexing device for moving the conveyor 1010 and sealing plates 1012, intermittently and in a direction from loading section 1018 toward first station 1014. Preferably, each intermittent movement of conveyor 1010 travels one pitch which is equal to at least the distance required to move a sealing plate 1012 the full distance of the length of the sealing plate. Preferably, with each movement of the conveyor, a sealing plate is located directly between the lower vacuum chamber 1020 and the lower clamp plate 1022 shown in FIG. 167. Preferably, a sealing plate is also located directly beneath heat bank 1024, as shown in FIG. 156. Preferably, this arrangement transfers a package that has been sealed in first station 1014, to a subsequent location at second station 1016. Preferably, the driving devices for the packaging machine, machine components and conveyor are a pneumatic cylinder and electrically powered driving motors of suitable size and capacity. The pneumatic cylinders are attached to shafts 1030 (attached to heat bank 1024), 1032 and 1028 (attached to water-coded clamp 1036) and, 1034 and 1026 (attached to cutting device 1038), and provide independent reciprocating movements to each shaft and attachments generally in the directions shown in the diagrams by arrows drawn adjacent to each attachment. Similarly, pneumatic cylinders (not shown) are attached to upper 1056 and lower 1020 chambers to provide reciprocating movements parallel with shafts 1030, 1028, 1032, 1026, and 1034 to provide movement and apply pressure as required. Preferably, an electrically powered drive motor 1042 is attached to conveyor sprocket 1044 so as to intermittently drive the conveyor 1010 as required such that the upper section 1046 of the conveyor travels in a direction from right to left.

First Heat Sealing and Vacuum Chamber

FIG. 167 shows a cross-sectional view through a first station vacuum chamber assembly 1014 constructed according to the present invention which details the first 1002, second 1004 and third 1006 webs prior to sealing the webs together. This vacuum chamber has a plate, separating to second and third webs, unlike the chamber of FIG. 154. Meat is loaded into tray (first web 1002) and then each loaded tray is placed into apertures in sealing plate 1050. The conveyor indexes forward such that a loaded tray is located at first station 1014. During indexing, third web 1006 and second web 1004 are also indexed forward and a longitudinally disposed tension can be applied to third and second webs and in a direction parallel with the conveyor. Preferably, lateral stretching can also be applied to second web 1004 such that it is stretched taut. Upper clamp member 1052 and lower clamp member 1022 then close against the middle clamping plate 1054 thereby clamping and firmly holding third and second webs 1006 and 1004, respectively. Preferably, lower vacuum chamber 1020 and upper vacuum chamber 1056 are closed against the clamping plate assembly such that a substantially “airtight” seal is provided and the upward movement of lower vacuum chamber 1020 lifts sealing plate 1050 and holds it firmly against the underside of the lower clamp 1022 thereby providing substantially “airtight” seals around the perimeter of the upper and lower vacuum chambers 1056 and 1020. Closing the upper and lower chambers thereby defines a single enclosed chamber that is substantially isolated from atmospheric gasses. During the procedure of closing the upper and lower chambers, the lower vacuum chamber 1020 lifts the sealing plate 1050 upwardly and tray (first web 1002) is carried upward. The upper rim portion of sealing plate 1050 and 1058 contacts the underside of second web 1004 stretching second web upwardly until sealing plate 1050 contacts the underside of lower clamp 1022 at surface thereby stopping the upward movement in a closed and substantially “airtight” condition. Preferably, the second web 1004 is now stretched taut across the opening of the ring 1058 and distanced preferably about 1/64″ to about ½, and most preferably about ⅛″ above flange 1072 (FIG. 158) and preferably about 1/64″ to about ½, and most preferably about ⅛″ below third web 1006.

Preferably, atmospheric air contained within the enclosed chamber is then substantially evacuated through evacuation ports 1008, to a pressure of less than 5 torr. Preferably, immediately after evacuation, the chamber can be filled with carbon dioxide gas, or a blend of carbon dioxide and nitrogen gasses, to a pressure of up to 2 bar (28 psi) or more, by injection through ports 1064 and optionally 1008, and held at pressure for a period of 1 to 5 seconds or more and most preferably until water and goods in the tray have become substantially saturated with dissolved carbon dioxide. The gas pressure within the chamber assembly can then be lowered to a pressure equal to that of the prevailing ambient atmospheric pressure prior to sealing. Evacuation and gassing of the chamber assembly in accordance with the invention, provides a method of filling packages with a chosen gas such that the residual atmospheric oxygen that remains within the package does not exceed an amount about 0.05% by volume of the gas that remains within the package after sealing the first 1002, second 1004, and third 1006 webs together.

Referring now to FIG. 158, a clamping member 1036, that is preferably water cooled, can now be moved and positioned so as to clamp third web 1006 against second web 1004 and in turn against the inner edge portion of flange 1072 on first web tray 1002. Preferably, heat bank 1024 can then clamp and heat seal second and third webs 1004 and 1006 to flange of first web 1002, under pressure. Preferably, heat bank 1024 can now be retracted followed by cutting of second and third webs with cutting member 1040 attached to cutting device 1038. The cutting member is withdrawn from the cutting position followed by release of clamp 1036. Preferably, enclosed vacuum chamber assembly can then be opened allowing conveyor to move forward a single pitch followed by closing the enclosed chamber assembly, followed by evacuation, gassing and heat sealing. Preferably, this cycle can be repeated in an automatic and continuous mode. Vacuum chamber assembly constructed according to the present invention and frame to which it is attached is built in a manner that will allow continued cycling of the packaging process and pressurization without sustaining excessive damage other than normal wear and tear.

An optional method of using the apparatus whereby a gas is not provided in the space between third web 1006, the upper barrier web, and second web 1004 (so as to subsequently facilitate urging of the second 1004 and third 1006 webs together), before sealing the third web 1006, second web 1004 and first web 1002 (shown as tray) together at a path near what will be a perimeter of the package. The tray 1002 is elevated so as to urge second web 1004 toward the underside of third web 1006 thereby providing stretching means to second web 1004 to sealing webs together to form a package. Apparatus for evacuation of substantially all air from the space between the third 1004 and the second 1004 webs, through ports 1008 is optionally provided.

Preferably, packages are then transferred from the vacuum chamber at first station 1014 via the conveyor to the secondary sealing apparatus located at second station 1016.

Second Heat Sealing Chamber

Referring now to FIG. 156, a cross-sectional view of second station 1016, constructed according to the present invention is shown in a partially closed position.

Referring to FIGS. 157-158 a cross-sectional view through a finished and sealed package constructed by second station 1016 is shown. Package 1092 includes a flange with second web 1004 and third web 1006 attached thereto. Shown is first web, tray 1002, formed with two flange portions 1072 and 1074. Preferably, flange portions 1072 and 1074 are adjacent and concentric to each other, with flange 1074 located on the inner side of flange 1072.

Referring now to FIG. 156, an assembled package is positioned in the sealing plate which is located beneath heat bank 1070. It can be seen that lip 1080 has a profile that corresponds and follows the path and plan profile of flange portion 1074. A section of flange 1074 can be clearly seen in the enlarged cross-section in FIG. 157. Preferably, flange portion 1074 is parallel and concentric to flange portion 1072 but follows a path on the inner side of flange portion 1072 and at a plane shown to be at a distance 1076, about ⅛″, below flange portion 1072. Preferably, heat bank 1070 is pneumatically operated and can extend downwardly and be retracted upwardly as required to exert a force such as to provide pressure onto the lip 1080 and when engaged with flange portion 1074, simultaneously depressing third and second webs that are then held, under pressure (sealing pressure), between the surface of flange portion 1074 and lip 1080 for a set period of time (set time). Preferably, the temperature of heat bank 1070, and correspondingly lip 1080, can be controlled and is set at a suitable temperature (set temperature). Preferably, the temperature of heat bank 1070 is less than temperature of heat bank 1024 located in first station 1014. Preferably, pressure is applied at lip 1080 and can be set at sealing pressure. The suitable time of contact and clamping of third and second webs to flange portion 1074 can be varied. Time of contact is defined as the length of time during each cycle from the first instant of first contacting between lip 1080 and flange portion 1074 through the third and second webs, to the first instant of no contacting after retraction of heat bank 1070. Thereby, when the set temperature, sealing pressure and set time of heat bank 1070 are adjusted as required, the selective heat sealing of second web to flange portion 1074 can be achieved while third web does not heat seal to second web. This can preferably be achieved when first, second and third webs include materials as shown in FIGS. 43 and 44.

Referring now to FIGS. 43 and 44 a representation of an enlarged view of a section through a flange portion of an assembled package is shown. FIG. 43 shows heat sealing bars and a section of a rubber seal mounted on sealing plates around the perimeter of the apertures in the sealing plates. Details of materials that can be used in the first, second and third webs are also shown and described in detail below: Preferably, third web 1006 is a co-extruded web including at least two layers with a first layer 1082 of Eastman PET 9921 and a second layer 1084 of material on the underside of the third web including a blend of 2 grades of Eastman polyesters in amounts of about 50%. Eastobond 6763 and about 50% Eastobond 9921 or alternatively the layer on the underside may be about 100% Eastman PM 15086. Preferably, third web can be about 0.006″ thick, about equally divided between first and second layer. Preferably, second web 1004 is a web of pPVC with a thickness of about 0.0008″. Preferably, first web 1002 includes a thermoformed tray produced from a multilayer co-extruded web with an outer layer 1088 of Eastman 9921 and an inner layer 1086 including a blend of about 50% Eastman PETG 6763 and about 50% Eastman 5116 (or Eastman PM14458 or equivalent). Preferably, first web has a thickness of about 0.012″ where the inner layer 1086 is about 0.004″ thick and the outer layer 1088 is about 0.008″ thick. Preferably, under such conditions the heat transferred through third web is insufficient to cause bonding between the third and second webs but sufficient to cause bonding between the second and first webs at flange portion 1074. Preferably, such arrangement provides stretching of second web, after sealing of third and second webs to first web at first station 1014. Preferably, applying gas pressure to the upper surface of the third web, when located at second station 1016, so as to cause the second and third webs to depress downwardly and substantially conform to the contours of flange portion 1074 prior to providing heat seal 1090 provides an alternative step in the method.

Preferably, second web 1004, will have a feature known as a “memory”. The term “memory”, in this context, is known in the packaging industry and is characterized as a material that will substantially return to its original shape after distortion has occurred due to, for example, a consumer “feeling” the goods contained within the package while the package remains intact, with second web sealed to the tray flanges. This can cause finger marks and depressions in the second web as prospective purchasers of the package examine it prior to purchase during retail display of the package. After excessive handling by consumers the package can become unattractive to an intending purchaser and financial losses can result therefrom. Materials such as polyethylene substantially do not have “memory”. However, plasticized PVC (pPVC) web materials, such as are made by Borden do provide this important feature. Second web constructed from pPVC may be perforated by perforating apparatus to improve gas transmission therethrough.

Preferably, perforations can be provided in second web 1004. The perforations can allow gas to permeate into a space between second web and third web. Preferably, when the gas pressure inside the sealed package is at a pressure slightly above ambient air pressure, third web will be stretched outwardly into a dome shaped condition thereby providing a gas buffer between third web and the surface of goods beneath the second web. Second web may be in contact with the surface of package goods, alternatively a space can be provided therebetween. Preferably, the seal between second web and first web may be arranged such that it is not a continuous seal along the full path of flange portion 1074 and may be arranged as an intermittent sealing, completely along one or more sides only or parts thereof.

In yet another embodiment heat bank 1070 may be mounted at first station 1014, concentrically with and on the inside of heat bank 1024 within the same chamber but with separate moving shafts. Such an embodiment would allow sealing at flange portion 1072 and flange portion 1074 without the need to transfer the package from first station 1014 to second station 1016 for sealing of flange portion 1074. Preferably, web cutting devices are located at second station 1016 to separate the sealed and finished package 1092 from webs.

After passing through stations 1014 and 1016 on packaging machine, the finished packages are ejected from the machine.

In yet a further embodiment, the tray evacuation arrangement can be set up to transfer trays containing goods to a vacuum chamber, evacuate any ambient atmosphere from the trays and then transfer the trays into an enclosure excluding air. However, the trays have not been sealed with a lid at the vacuum chamber.

Sealing Plates

Sealing plates constructed according to the present invention are members attached to conveyors to carry trays in the packaging system.

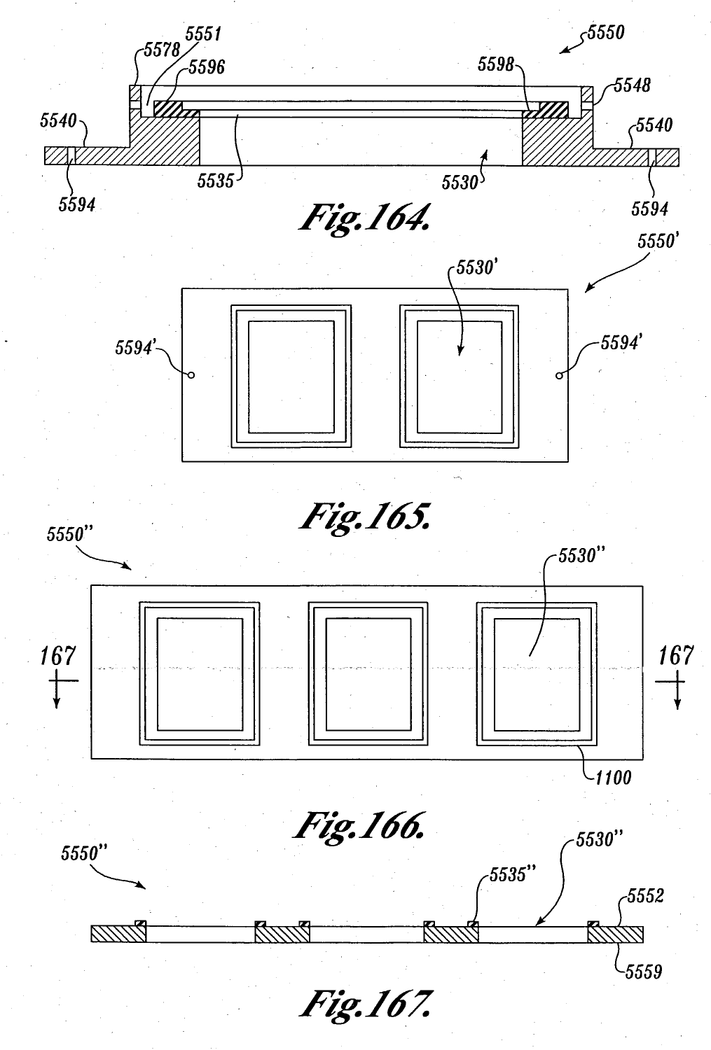

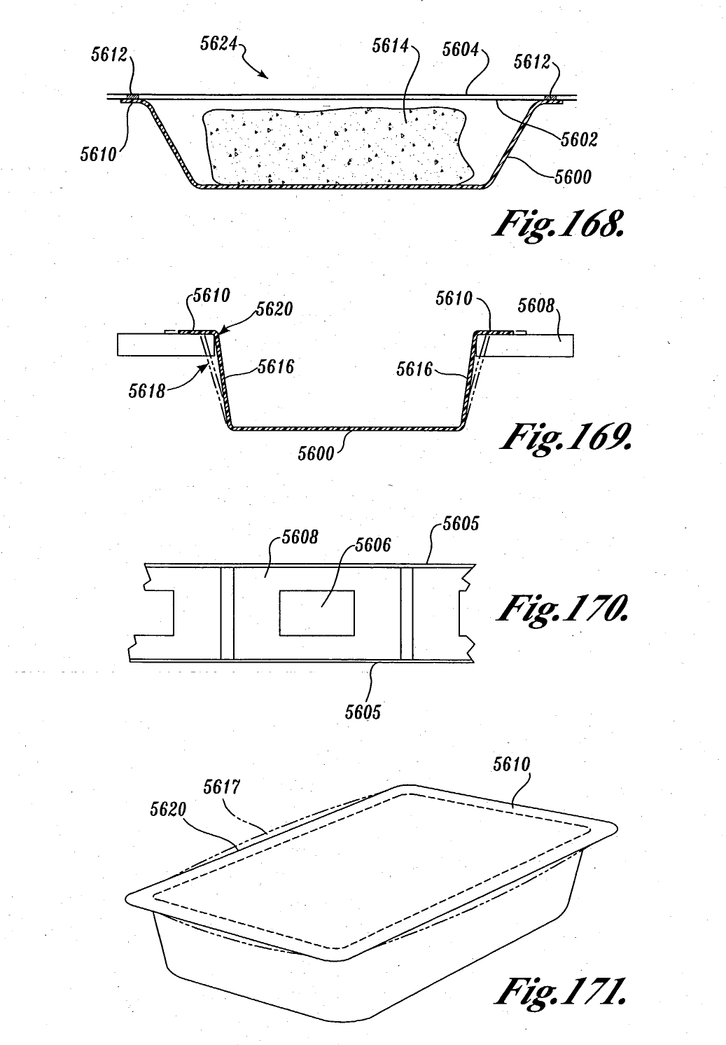

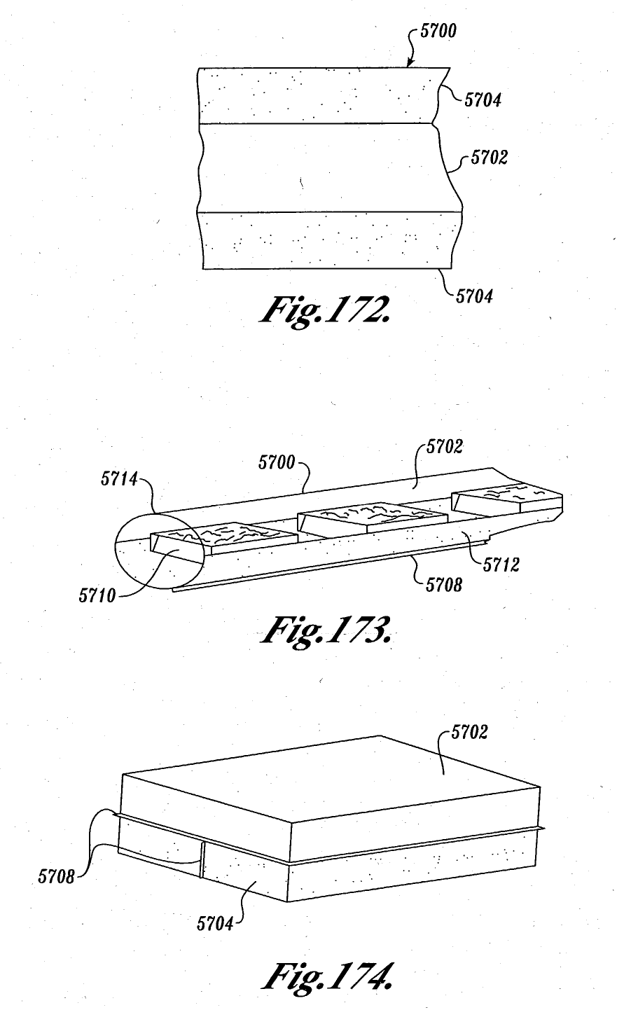

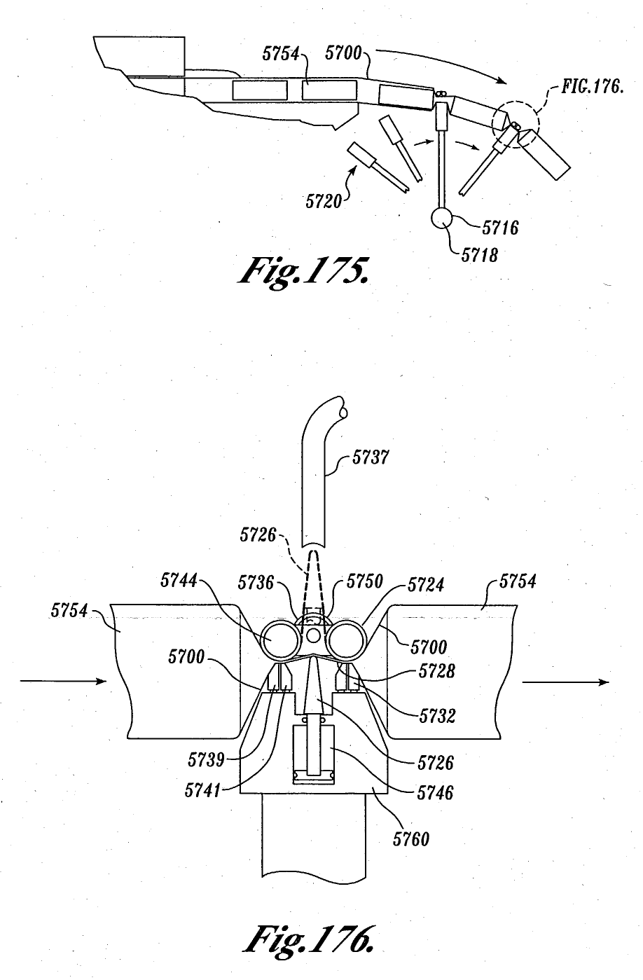

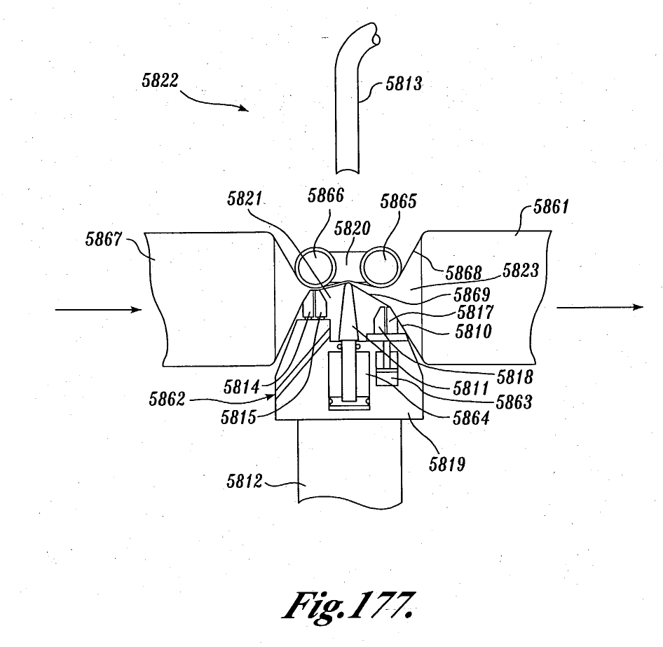

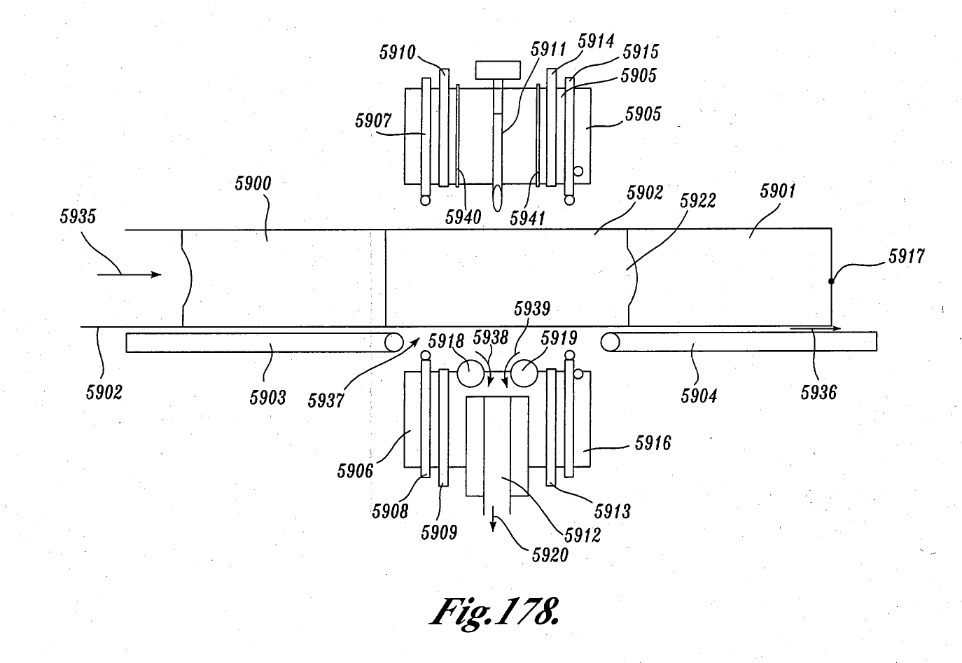

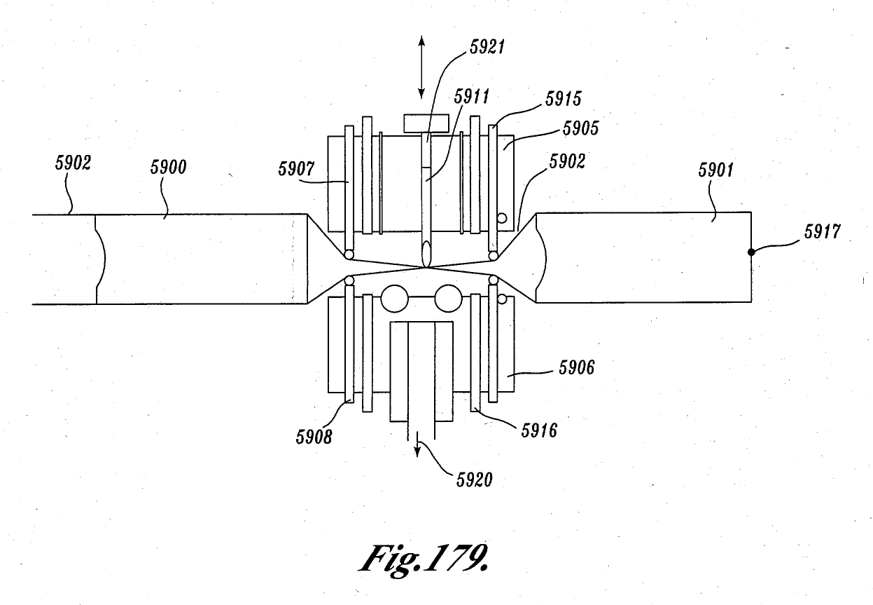

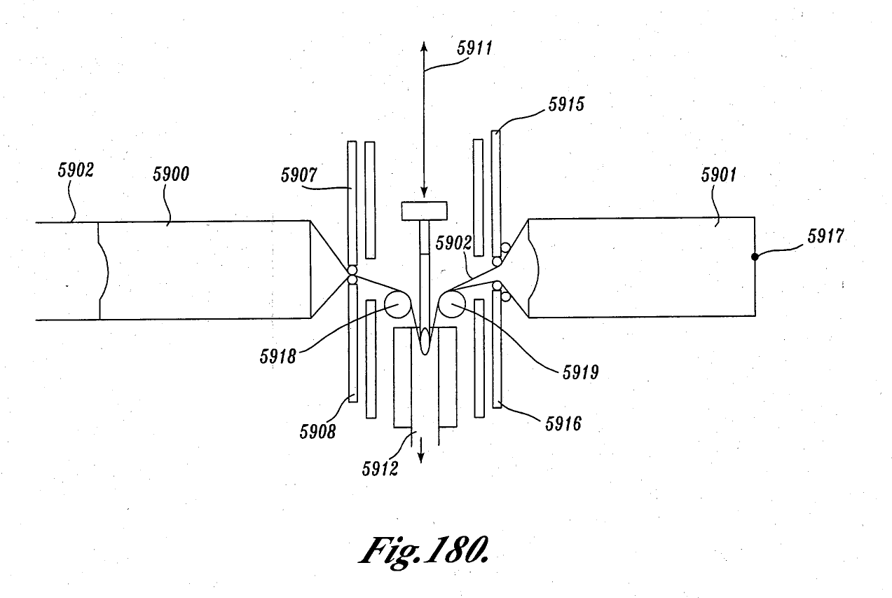

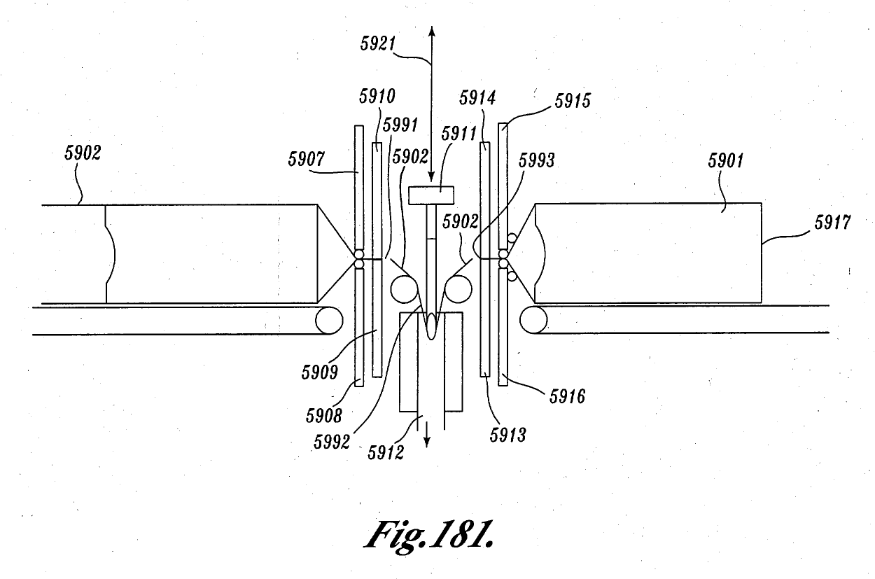

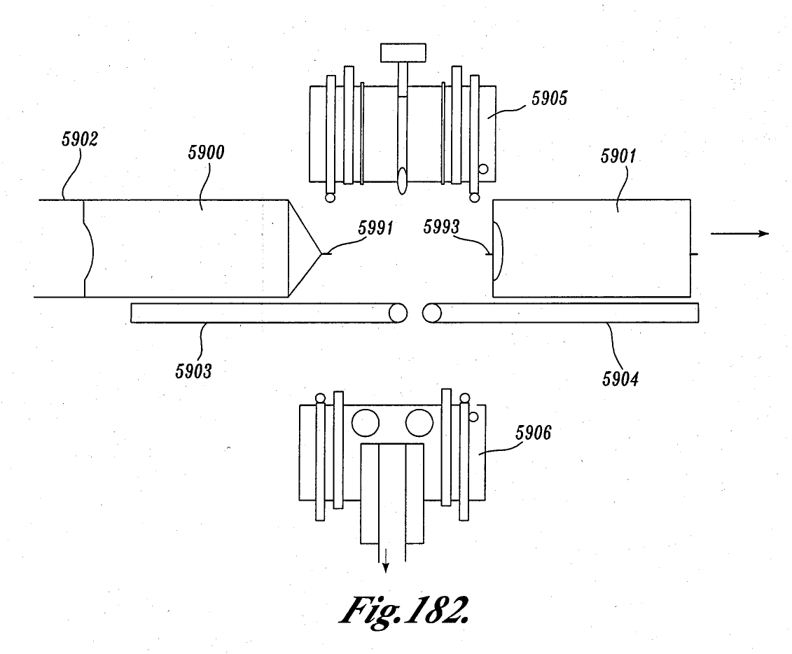

FIGS. 163-166 show the use of sealing plates with trays of the present invention. Package 1224 contains goods 1214 shown in FIG. 163. In FIG. 163, the first web 1200, second web 1202, and the third web 1204 are shown sealed together to form a complete package 1224. FIG. 164 shows a cross-section through the tray (the first web). Dotted lines are shown in FIGS. 164-166. The dotted lines in FIGS. 164-166 show the position of the side walls before insertion of the tray into the aperture 1206 in the sealing plate member 1208. Dotted lines in FIG. 166 show the relative position of the edge of the flange prior to the tray insertion into the aperture. The aperture is sized to suit and is slightly smaller than the tray. The aperture is located in member 1208 which includes a plate means with the aperture therein with the aperture having dimensions slightly smaller than the external dimensions of the side walls of the third web tray such that when the tray is inserted into the aperture, the side walls are distorted and urged inwardly. The solid lines show the side walls after the inward distortion and the dotted lines show the relative position of the tray prior to insertion into the aperture. FIG. 164 shows a plan view of a section of a conveyor such as may be installed in a packaging machine. Sealing plate 1208 may have a plurality of apertures, all of a suitable size and arranged to hold a plurality of the trays in like distorted condition as herein described.

Referring to FIGS. 159-162, a cross-section of a preferred sealing plate 1050 constructed according to the present invention is shown with a plan view shown in FIG. 160. Sealing plate includes attachment points 1094. Preferably, attachment points 1094 attach the sealing plates to a pair of continuous roller chains that engage with sprockets 1044 and 1128 and are located, one at each relative side of conveyor. Preferably, sealing plate 1050 has a depth dimension that is about equal to or deeper than the depth of depressions in first web. Preferably, a rubber seal 1100 is attached to the sealing plate 1050 by an adhesive and is profiled to provide flanges 1096 and 1098 that correspond to flange portion 1072 and flange portion 1074 of first web tray. Preferably, a space between the rubber seal 1100 and rim 1078 is provided to allow clearance for cutting member 1040 during the cutting of the third and second webs after sealing to flange portions 1072 and 1074.

Referring now to FIG. 162, a cross-sectional view of the details of sealing plate 1050 are provided. As an example, a preferred embodiment with three apertures 1150 and rubber seals 1100 located around the perimeter of each aperture is shown. However, sealing plates may have more or less apertures and corresponding, rubber seals. Preferably, rubber seals are made optional. Preferably, sealing plates are machined from aluminum or other metals or any suitable plastic plate, for example, about 0.75″ thick polypropylene with upper 1152 and lower 1154 faces.

Referring again to FIG. 164, wherein the arrangement of first web 1200 (tray) with a flange 1210 extending continuously around the perimeter of tray 1200 to provide a flat ledge to which second web 1202 is sealed. Preferably, tray 1200 has been distorted such that side walls are urged inwardly and held in position by the limiting size of aperture 1206 located in sealing plate 1208 of FIG. 165. Preferably, second web 1202 is a gas permeable material such as pPVC of about 0.0008 inches thickness and first web 1200 is constructed of a substantially gas impermeable material such as a co-extruded multilayer sheet of Eastobond APET 9921 and a blend of about 16% Eastobond PETG 6763 and about 84% Eastobond 9921. A third web 1204 is sealed to second web 1202 adjacent to seal 1212 of the second web to the first web.

Alternatively, the tray 1200 can be formed from a web of polystyrene foam that has been previously laminated to a web of gas barrier material. A second web of material can be sealed to the web of gas impermeable material laminated to the upper side (inside) of foam tray. Trays according to the present invention are substantially impermeable to gases.

Referring to FIG. 163, webs are shown sealed together by a strip-like seal 1212 on flange 1210 that follows a path that continues around the flange near the perimeter of the package thereby providing a substantially hermetically sealed package. Preferably, goods 1214 are contained within the sealed package and a suitable gas blend such as may include about 40% carbon dioxide and about 60% nitrogen is provided within the package. Preferably, sealing of the package is effected while side walls of the tray are urged inwardly. Preferably, side walls thereby retain a tension and desire to return to their original relative position thereby exerting a substantially outwardly disposed urging around the perimeter of the depression in the tray but which is retained and held captive by the combined tensile strength of third and second webs sealed to the flange. Preferably, third web is sealed to the package in such a manner as to allow peeling from the package, without rupturing second web and thereby leaving second web attached to the flange. Preferably, when third web is peeled from the package the tensile strength of the second web is insufficient to restrain outwardly urging of the side walls, thereby releasing urging and providing a means to stretch the second web into a substantially flat condition. The extent of the urging can be controlled such that it will maintain a tension in second web.

FIG. 163 shows a finished package that has been produced by the method herein described and, after heat sealing of first 1200 and second 1202 webs together, has been removed from aperture 1206 in sealing plate 1208.

Method and Apparatus for Producing Laminated Webs

Having discussed the advantage obtained by packaging trays having second and third webs, another embodiment of producing bilayer coverings is herein described. Referring to FIG. 169, an apparatus for producing a pre-stretched second web of flexible gas permeable material laminated to a substantially more rigid gas barrier material is schematically illustrated.

First 1400 and second 1402 roll of web material including a second web 1404 and a third web 1406 are preferably unwound simultaneously and laminated by passing the webs through a pair of “nip” rollers 1408 that apply pressure against each other and to the webs as they pass through nip rollers 1408. Preferably, nip rollers 1408 are driven by any suitably powered driver to rotate at a suitable speed. Preferably, the laminated web 1412 is rewound onto a single roll 1410 together to produce a laminated web 1412. Third web 1406 may include a semi rigid polyester material, of about 0.005″ to about 0.007″ thick. The construction of this material is such that it can be used in a packaging machine to produce packages as described herein whereby laminated webs are sealed to a first web of gas barrier material (tray). First web may have a depression formed therein into which goods such as red meat can be placed before heat sealing the third and second webs to the first web. Goods will typically not completely fill the depression and space will remain in the depression in addition to the goods. A blend of gases or a single gas such as CO₂ can be provided in the space with goods and thereby can contact the goods. The gas substantially eliminates the presence of oxygen and any red color present in the red meat may be transformed to a purple color. This is caused in part by the reduction of oxymyoglobin to deoxymyoglobin. After storage of perhaps a period of 14-28 days from packaging but prior to retail display at an intended point of sale to consumers, the third web can be peeled from the package allowing atmospheric oxygen to permeate the second web of gas permeable material and to contact the goods. Atmospheric oxygen can then generate a bright red colored substance such as oxymyoglobin. Such use involves the sealing of the laminated webs to the first web of gas barrier material such as a two-layer co-extrusion where the outer layer includes Eastman APET 9921 of about 0.0035″ thickness, and the inner layer may is a blend of Eastman polyester materials including about 16% of 6763 and about 84% of 9921. The thickness of blended layer 1412 can be about 0.0015″. Second web 1404 includes a roll of monolayer pPVC with a thickness of about 0.0008″ to about 0.0012″. Preferably, as second web 1404 is unwound it can be passed through a perforator 1414 that perforates the second web by creating small apertures therethrough. Preferably, second web 1404 can be tensioned in a controlled manner by retarding the rate of unwinding of second web 1404 from roll 1400 relative to the unwinding rate of third web 1406 from roll 1402. Tension is thereby applied to second web 1404 of material prior to passing through the nip rollers 1408 at which point substantially all of the air between the two layers of material is forced out by the nip rollers 1408. The consistency and texture of elasticized PVC material including second web 1404 is such that it adheres lightly to third web 1406 unwound from roll 1402 forming a very light seal that excludes all air from between the webs. Second web 1404 is applied to the inner, blended layer of third web 1406, preferably a substantially more rigid material unwound from roll 1402. Preferably, an anti-blocking agent, such as very fine sand, can be added to the third web upper (outer) layer of the co-extrusion so as to preferentially inhibit sticking of second web to what will be upper layer such that second web will remain in close contact with what will be the underside of third web during storage in a roll 1410 condition and during unwinding from roll 1410 in normal operation on a packaging machine.

Second 1404 and third 1406 webs, having been laminated to produce a lamination and subsequently wound onto the finished roll 1410 can be stored and when required for use in packaging can be loaded onto packaging machine as shown in FIG. 170.

Referring now to FIG. 170, a process to laminate two webs of material together is shown. The two webs include the third and second webs. The apparatus is suited to produce any packages herein described. First web 1416, preferably of a substantially gas barrier material is located into an aperture (not shown) in sealing plate 1418 mounted on the conveyor 1420. Preferably, sealing plate 1418 being similar to sealing plate member 1208 shown in FIG. 159. Preferably, first web has a cup-shaped depression formed therein and similar to that shown in FIG. 171. Red meat or other perishable goods is loaded into first web tray 1416 and a plurality of trays are located into the apertures in each sealing plate 1418 mounted to conveyor 1420. The conveyor indexes forward such that a loaded tray is located between upper vacuum chamber 1422 and lower vacuum chamber 1424. During indexing of the conveyor the third web tray is also indexed in a direction parallel with the conveyor and placed into position between upper and lower vacuum chambers. Upper 1422 and lower 1424 vacuum chambers are closed together such that sealing plate is clamped therebetween to provide a substantially sealed and enclosed chamber assembly. Air is evacuated from the chamber assembly to a pressure level of approximately 5 torr and a selected gas is injected into the chamber assembly. The gas being chosen for its properties of enhancing the keeping qualities of goods, in first web tray 1416, such as carbon dioxide or a blend of carbon dioxide and nitrogen is suitable. First, second and third webs are then sealed together to produce a package. Upper 1422 and lower 1424 vacuum chambers are then opened so that conveyor 1420 can carry sealed package to an ejection point. The package may be trimmed by a cutting devices located within the chamber assembly such that a skeletal scrap web can then be wound onto a single wind-up spool, or alternatively, could be separated by de-laminating the third web scrap from second web scrap onto scrap wind-up 1426 and 1428 as shown in FIG. 48. The package may be trimmed within vacuum chamber in one machine cycle or alternatively the package may be trimmed from the web in a secondary operation immediately after the vacuum chamber.

Preferably tray construction may be thermoformed from co-extruded polyester plastic materials as shown in FIG. 171. Co-extruded material may include two layers of a total thickness of about 0.015″. The outer layer 1430 is about 0.0135″ thick and the inner layer 1432 is about 0.0015″ thick. The outer layer 1430 includes Eastman APET 9921 and the inner layer 1432 is about a 50% 50% blend of Eastman 13162 and Eastman 6763.

Method and Apparatus for Packaging Perishable Goods

Having described laminated webs, it is now appropriate to describe a method to package perishable goods using a laminated web. Although the description preferably applies to laminated webs, one or more non-laminated webs can also be used with the method with apparent modification.

FIG. 172 shows a schematic representation of a side elevation of a preferred packaging apparatus including a conveyor with a plurality of sealing plates generally denoted 1436 attached thereto. Preferably, a drive motor 1438 is connected to conveyor sprockets 1440a, and b and arranged so as to provide intermittent driving of the conveyor as required. Trays with goods therein are loaded into apertures in sealing plates at the loading section and the conveyor is driven forward in the conveyor direction shown in intermittent increments of one pitch which is equal to the distance of a single sealing plate. The conveyor is otherwise stationary except during each movement of one pitch. A scale 1442 can be positioned under the upper section of the conveyor and is attached to a driver such that when the conveyor is stationery the scale can be elevated and lift the tray from sealing plate 1436, and weigh the tray and goods. Preferably, scale can be interfaced with a label printing device. Preferably label will include information such as price, weight and time of packaging and then label printing device will apply the label to the upper surface of the second (or third web) in a label position. Label position can be predetermined such that when first, second and third webs are sealed together the self adhesive label is in a desired location which can be easily seen by any prospective purchaser of the finished package after removal of the third web. Alternatively, if the label is located on the third web and if the third web is not removed before retail display then the label can be viewed. A roll of material 1444 is mounted above the conveyor adjacent to a first station 1446 to facilitate unwinding of the material 1443. The material may include a single web of material or alternatively the material may include a roll of two laminated webs such as described above. Packages produced with material according to the present invention would be similar to packages shown in FIG. 173, whereas packages produced with web conventional material would be similar to the conventional package in FIG. 174. First station 1446 includes an upper vacuum chamber 1448 and lower vacuum chamber 1450 and both are mounted to the packaging machine and pneumatic drivers. Pneumatic drivers are arranged to move the upper 1448 and lower 1450 vacuum chamber in a reciprocating upward and downward motion.

Preferably, vacuum chambers operate such that they move simultaneously but in opposing directions such that when they are moved toward each other a sealing plate 1436 is clamped therebetween to provide a completely enclosed chamber that is isolated from ambient atmosphere. Preferably, each vacuum chamber has ports 1452 and is attached to a vacuum pump (not shown) and sources of gases via ports 1452. Preferably, the gas sources can be several in number but typically can include: 100% carbon dioxide and a blend of carbon dioxide and nitrogen in any concentration. Sources of gas can be switched from one to the other such that a selected gas can be injected into the chamber as required and at will. For example after evacuation of the vacuum chambers, a gas, such as 100% carbon dioxide, can be provided in the vacuum chamber at a gas pressure above ambient atmospheric pressure, for example about 25 psi. Gas pressure may then be reduced to any pressure between about 0 and about 25 psi before then providing a gas, such as 100% nitrogen, in the vacuum chambers. A heat bank sealer 1454 is located within the upper vacuum chamber 1448. Sealing device is also attached to a pneumatic cylinder that provides motion in an upward and downward fashion. Sealing device is profiled to provide a flat strip like surface, horizontally disposed, that corresponds to the flange of the tray and can apply pressure downwardly onto the flange. Preferably, second station 1456 includes lower clamp 1458 and upper clamp 1460. Preferably, clamps 1485 and 1460 are attached to pneumatic cylinder and can be operated such that when moved toward each other a single sealing plate 1436 is clamped therebetween. Preferably, a sealing device is located within the upper clamp 1460 with pneumatic cylinders attached thereto and a cutting device 1462 is located on the outer perimeter of heat bank 1464 and on the inside of 1460. Preferably, members 1462, 1460, 1464, and 1458 can be moved independently and in vertical directions. A winding arrangement 1466 is mounted above the conveyor and is powered by an electric driver to wind skeletal scrap. The preferred sequence of operation of the packaging machine is as follows. Sealing plate 1436, attached to the conveyor with a loaded tray contained therein is indexed into position in first station 1446. Lid material 1443 is unwound from 1444 and located above tray 1436. Chambers 1450 and 1448 are clamped together with 1436 clamped therebetween. Air is substantially evacuated from the vacuum chambers which are then filled with carbon dioxide gas or a blend of carbon dioxide and nitrogen. The gases are pressurized to a pressure above atmospheric pressure to about 25 psi and held for a period exceeding about one second. Pressure of the gas in the chambers is reduced to about atmospheric pressure and sealer 1454 is lowered so as to clamp the lid material against the flange portion of the tray. The lid material is then sealed thereto along the complete path of tray flange. Vacuum chambers 1448 and 1450 open and the conveyor indexes forward until sealing plate 1436 is located at second station 1468, between upper clamp 1464 and lower clamp 1458. Clamps 1464 and 1458 close together thereby clamping sealing plate 1436 between the clamps. Sealing device 1464 is lowered to seal the lid material to tray at flange and cutting device 1462 is also lowered and retracted thereby severing the tray and package from web while the tray still located in the sealing plate 1436. Skeletal scrap is wound onto scrap winding spool 1466. Conveyor indexes forward and packages are ejected therefrom.

Cross-sections through the package shown in FIG. 173 and a conventional pack of FIG. 174 are shown alongside for comparison. The conventional package shows the absence of second web. The tray constructed according to the present invention include a second and third web sealed to a tray flange around the upper periphery of the tray. A tray constructed according to the present invention provides a peelable lib to introduce oxygen at a predetermined time, thus extending the shelf life of the perishable good stored therein.

Method and Apparatus for Packaging Finished Packages

Now that trays, webs, and methods have been described, it is appropriate to consider master packs and their methods for making.

Referring now to FIG. 175, details of a packaging apparatus constructed according to the present invention for producing substantially gas barrier master containers and heat sealing a substantially gas barrier lid material to the master containers to produce hermetically sealed containers is shown. The following description discloses a method and apparatus for producing the hermetically sealed containers for providing a vacuum and/or selected gases in the containers at selected and variable pressures, so as to accelerate the dissolving of selected gasses into perishable goods such as red meat that may be contained therein and then exchanging the selected free gases with other suitable gases for the purpose of enhancing the keeping qualities of the perishable goods. Furthermore, the method provides methods of removing residual oxygen gas that may be retained within the cell structure of packaging materials such as EPS, that may be contained in the hermetically sealed master.

FIG. 176 shows a cross-section through an apparatus intended to produce master packs thermoformed from a continuous web of plastics material. The dimensions of the master containers are arranged so that they can be filled with preferably an exact number of finished packages containing perishable goods such as any of the finished packages herein described. The apparatus preferably includes a horizontal thermoforming, reel fed packing machine, similar to Model R530 packing machine manufactured by Multivac Sepp Haggenmuller GmbH & Co. of Germany.

Preferably, the apparatus includes a frame (not shown) that is arranged with two horizontally disposed and parallel continuous gripper chains generally denoted as 4400 in FIGS. 176, 177 and 178 that run almost the full length of the frame and are retained in tracks that are located on each side of the frame. Gripper chains 4400 are arranged to grip the two opposing edges of the lower web 4402 and apply suitable lateral and longitudinal tension thereto. The machine direction is shown by arrow 4444 and the chain is preferably powered by an electrical motor (not shown) that is controlled electronically to carry the lower web 4402 in the machine direction in intermittent movements. The distance traveled by the gripper chains, carrying the lower web, is controlled so as to carry the formed master packs 4402 forward and simultaneously locate a suitable area of the lower web material 4402 between the upper and lower sections of the thermoforming section. Each intermittent movement, during each machine cycle, of the gripper chains is equal in distance traveled and the apparatus can be arranged to automatically operate at a machine speed of a set number of cycles per minute which may be, preferably about 4 cycles per minute.

During a single machine cycle the following functions preferably occur. After the gripper chains cycle forward carrying a section of lower web material 4402 into position between the upper and lower sections of the thermoforming section 4406 the upper and lower sections close together and thermoform master packs including, in the present case, three containers. A hole punch 4466 is arranged to provide apertures 4452 in the lower web located between the containers as shown in FIG. 176 and in an enlarged cross-sectional view in FIG. 178. Finished packages are then loaded into the master packs (containers) in the loading section 4446 and with each machine cycle the lower web travels forward an equal distance. The gripper chain carries the lower web 4402 in the machine direction a distance of a single pitch for each machine cycle until the loaded master packs are located between upper chambers, generally denoted by 4410 and lower chambers, generally denoted by 4412. Preferably, a total of five upper chambers and five corresponding lower chambers are arranged such that the upper chambers 4414, 4416, 4418, 4420 and 4422 can be elevated and lowered as required. Lower chambers 4424, 4426, 4428, 4430 and 4432, are located directly below the upper chambers and arranged with powered drivers (not shown) to elevate and lower the lower chambers as required. A cross-section is shown in FIG. 176 and is typical for upper chambers 4414, 4416, 4418, and 4420 with corresponding lower chambers 4424, 4426, 4428, and 4430. Upper chamber assembly 4410 and the lower chamber assembly 4412 operate simultaneously so as to close toward each other and open away from each other, as required. During a single machine cycle upper chambers and lower chambers close and open once. After upper chambers and lower chambers open, gripper chains 4400 carrying the lower web 4402 move and carry the master packs forward for one single pitch. A roll 4434 of upper web material is located as shown and upper web material 4444 is unwound, as required, during each machine cycle, providing a length of upper web material equal to the distance of the lower web forward movement. A side web sealer 4436 is located one on either side of the machine in a position that allows sealing of the upper web to the lower web, forming a single and continuous heat seal between the upper web and the lower web, along the outer edges of the upper web, along path 4438 and 4440 shown in FIG. 176. A gassing member 4442 is located between the upper web and the lower web such that the upper web and the lower web can be heat sealed together at paths 4438 and 4440, thereby encapsulating the gassing member 4442 with the upper web 4444 and the lower web 4402, in close and touching proximity to the gassing member 4442. The gassing member 4442 is attached and fixed to the machine at the entry end to the upper and lower chambers assembly and otherwise floats along its entire length. Gas ports 4446 and vacuum recesses 4448 are machined in the gassing member, such that the gas ports 4446 provide direct communication from a suitable gas source separately to each lower chamber location 4424, 4426, 4428, and 4430, thereby introducing into the master containers chosen gases separately and during each cycle of the machine. Vacuum recesses 4448 provide communication between the master containers and a vacuum source via apertures 4452 in lower web and vacuum ports 4450.

Preferably, during each machine cycle, upper chamber assembly 4410 and lower chamber assembly 4412 close toward each other with a clamping force, and clamping the upper web and lower web with gassing member therebetween, such that master packs in lower web are enclosed in the cavities in the lower chamber. As can be seen in FIG. 178, the upper chamber 4414 is clamped against the upper web 4444 and the lower chamber 4424 is clamped against the lower web 4402 with the gassing member 4442 between the upper web 4444 and the lower web 4402, which are sealed along path 4440. Seals 4468 are provided as required and as can be seen in this closed position, the upper chamber 4414 and the lower chamber 4424 provide a substantially airtight assembly. Preferably, after closing of the upper and lower chambers together, a vacuum source is connected to vacuum ports 4450, which substantially evacuates all air from within the master packs. Preferably after evacuation of the master packs, a suitable gas which may be selected from those gases listed herein, is provided through gas port 4446 and into the master packs 4404. The suitable gas is provided at a pressure that exceeds ambient atmospheric pressure and may be provided at a pressure preferably between about 0 psi and about 200 psi or more. The gas can be retained at the desired pressure for a set period of time preferably equal to about one or more seconds. Preferably, after the set period, suitable gas pressure is reduced to slightly above ambient atmospheric pressure so as to maintain a positive pressure within the master containers but not at such a high pressure that may cause rupturing of the seal between the upper and lower webs at seal paths 4438 and 4440, after opening of the upper and lower chambers.

The upper and lower chambers assembly is then opened and the master packs move forward one pitch so as to be located directly between upper chamber 4416 and lower chamber 4426. The upper and lower chambers assembly is then closed and the evacuation and gassing sequence as described for upper chamber 4414 and lower chamber 4424 is repeated, however, the gas provided through the gas port into the closed upper and lower chambers may be a different gas. This sequence of evacuation and pressurized gassing is repeated during each machine cycle in upper chambers 4418 and 4420 with corresponding lower chambers 4428 and 4430.

FIG. 177 shows a cross-sectional view through upper chamber 4422 and lower chamber 4432 with heat bank. Upper chamber 4422 and lower chamber 4432 close against each other and heat bank 4458 heat seals the upper web 4444 to the lower web 4402, at a path that follows the perimeter fully around each master container, so as to hermetically heat seal the upper web 4444 to the lower web 4402 with suitable gas contained therein. Upper chamber 4422 and lower chamber 4432 open to allow the hermetically sealed master packs 4456 to be carried forward toward the exit end of the machine. The master packs 4456 are slit longitudinally with a slitter 4462 and cut laterally with a knife 4464 as shown in FIG. 157, prior to the ejection of finished master packs from the machine.

In this way residual oxygen that is retained in the cell structure of the EPS foam trays, contained in the mater packs, can be exchanged with other suitable gasses. Preferably, gasses such as carbon dioxide can be provided under pressure so as to dissolve in any free liquids such as water and oils contained in the perishable goods such as red meat.

Modified and Controlled Atmosphere Packaging

Before disclosure of the preferred methods for conditioning meats prior to packaging, the inventor, without intending to be bound to the particular theory, now wishes to advance the theory for the formation of metmyoglobin in packaged red meats and solutions to the problems of metmyoglobin formation, with reference to FIG. 179.

Fresh meats that have been chilled during an adequate storage period will contain large quantities of purple colored, de-oxymyoglobin which is unattractive to typical consumers. When the chilled meat is sliced in ambient atmosphere the de-oxymyoglobin that consequently comes into contact with atmospheric oxygen, will then, by oxidation, convert into oxymyoglobin (referred to as “bloom”) displaying a bright red color that is attractive to consumers. However, if the sliced meat (or ground meat) is intended to be stored in a low oxygen gas atmosphere, case ready condition, as a way of extending storage life prior to retail display, the oxymyoglobin that has formed after slicing and/or grinding (but before subsequent packaging in the low oxygen atmosphere), may provide for undesirable transfer of oxygen gas into the sealed environment of the master container. Even though the quantity of oxygen transferred by the de-oxymyoglobin, is relatively small it can lead to the formation of undesirable metmyoglobin on the visible surface of the retail packaged red meat. Metmyoglobin is brown in color and is unattractive to consumers. It is therefore desirable to prevent and/or minimize the extent of such deleterious formation of the metmyoglobin. The apparatus disclosed in the following subject matter details preventative methods. In order to provide a more detailed description of the conditions under which the undesirable metmyoglobin may form, the following known laws of physics and natural processes are referenced:

Normal Conditions for Oxymyoglobin Formation

After storage under commercially normal refrigerated conditions in carcass or vacuum packed conditions, freshly sliced beef will predictably turn bright red (by oxidation of purple colored deoxymyoglobin to bright red colored oxymyoglobin) with a virtually 100% probability, when exposed to ambient air.

Optimum Conditions for Metmyoglobin Formation

It is known that optimum conditions for formation of metmyoglobin, at the surface of sliced, fresh beef muscle exposed to a gas occurs when the free oxygen content of the gas is approximately 5000 to 30,000 ppm.

Graham's Law of Gas Diffusion

The rate of gas diffusion is inversely proportional to the density of the subject gas.

Relationship between Density of Gas and Temperature

The density of a gas (and most matter) is inversely proportional to temperature (i.e.: the gas density increases as its temperature is decreased).

Henry's Law

At a given temperature, the solubility of a gas in a liquid is directly proportional to the pressure of the gas above the liquid.

The “Mud Puddle Ring” Effect

According to the present inventors observations and independently performed empirical trials, the “Effect” can typically occur, immediately following packaging, when the following prevailing conditions are generally approximated:

1). The subject sliced beef has been allowed to “bloom” as a result of exposure to ambient atmospheric oxygen immediately prior to packaging.

2). The temperature of the sliced beef is lower than the gas and packaging materials surrounding it, immediately after packaging.

3). The sliced beef is placed in an “enclosed space” defined by the “retail package” including an EPS foam tray (or other) and a high OTR over wrapping web (the “web”). The “enclosed space” is not completely filled with the subject sliced beef and a remaining space (“the space”) is also contained. “The space” is subsequently filled with a “suitable gas” during evacuation of master container.

4). The ratio of beef to gas is low, i.e. the volume of “suitable gas” is relatively low and the volume beef is relatively high, in the “enclosed space”.

5). The “retail package” is placed into a substantially gas barrier “master container” which is evacuated (including the “retail package”) of ambient air and then filled with the “suitable gas”. The composition of the “suitable gas” can be carbon dioxide, nitrogen and residual oxygen at approximately 100 to <500 ppm. Thereby, substantially filling “the space” and “other space”. The “other space” is defined by the internal space of the master container but excluding space occupied by “retail packages”.

6). The temperature of “suitable gas” is lowest at the lowest point in “the space”.

FIG. 179 is intended to be representational and not a depiction of the actual “Effect” which is described as follows. Immediately after packaging, the highly oxygenated condition of myoglobin (oxymyoglobin), which is present at the surface of the beef slices starts to reduce, releasing oxygen gas inside the enclosed space 1242. At those sliced beef surface locations shown as 1228, that are in direct and intimate contact with the web 1232 (such that there is no gas between the beef surface and the web), the released oxygen gas passes through the gas permeable web, directly and diffuses into the other space 1242 inside master container but outside retail package 1230. This newly released oxygen gas is therefore immediately separated and essentially excluded from within the retail package. Any further gas contact with this area in direct and intimate web contact is limited to any gas outside the retail package, where the oxygen concentration remains relatively low. However, oxygen gas that is released from the beef surface that is not in contact with the web enters the space 1242 inside the retail package which immediately causes a significant elevation of oxygen concentration in the small free space under the web. Even though the web is oxygen permeable the rate of oxygen gas diffusion therethrough is such that it can take an extended period of time for the oxygen content in the gas under the web to equilibrate with the oxygen content of gas outside the retail package. Furthermore, the temperature of the oxygen atoms/molecules as they are emitted from the surface of the beef is the same as the beef which is significantly lower than the temperature of the gas in the space and therefore the density of the released oxygen is relatively high. This condition results in two additional effects. The diffusion rate is lower (Grahams Law) and because the density is higher, these newly emitted oxygen atoms tend to sink toward the lowest point in the package and/or remain in contact with the sliced beef surface for a longer period than may otherwise be required. Consequently, the partial pressure of oxygen at the surface of the meat increases and, in accordance with Henry's Law the level soluble oxygen gas in the meat surface liquid elevates. The temperature of gas in space 1242 is higher at the highest point and lowest at the lowest point. It can be concluded that oxygen gas emitted from the beef surface will remain in contact with the surface of the beef for a more extended period at lower locations and therefore higher concentrations will be present at these lower locations. Conversely, lower concentrations will be present at higher locations. Correspondingly, concentrations of metmyoglobin will form in direct proportion to the concentrations of oxygen. The composition of the gas in direct contact with the surface of the beef, a layer of gas that is probably less than about 0.01″ in depth, is the active gas that has effect at the surface of the beef. Under the conditions described above, the oxygen concentration in this layer can become significantly elevated.

The tendency of the relatively heavier oxygen atoms to move toward the lower levels in the space 1242 can cause it to tend to follow the downwardly disposed surface of the sliced beef, carried with other gasses and liquids that are close to the surface. This condition can therefore result in an increased level of oxygen concentration at the surface of the beef which exponentially increases toward the lowest point in the space 1242 and is consequently highest at the lowest point in the space 1242. This results in correspondingly higher (and darker) concentrations of metmyoglobin at the lowest point in the package and, conversely, visible but lower concentrations at the highest point.

A mud pool drying in the sun can appear to be surrounded by parallel rings that are typically gray/brown in color. These rings are lightest at the furthermost point from the center of the puddle and typically darkest at the center of the puddle, with a gradual color density change between the two points. The color density of metmyoglobin that is formed under the conditions described above gradually increases between the highest point in the package where the color is the lightest to the lowest point in the package where the color is darkest. Hence the comparison with a mud pool drying under the sun.

Eventually, any free oxygen gas released by the reduction of oxymyoglobin, will become either reabsorbed in the form of metmyoglobin or will be diffused and equilibrated with the modified atmosphere contained throughout the master package. However, the effective, irreversible, deleterious event of formation of metmyoglobin at the visible surface of the meat will have already occurred and under the prevailing conditions prior to intended retail sale of the meat, will permanently remain visible.

Subjectively, the above occurs in what can appear to be a confusing manner. The best most highly oxygenated and therefore red looking beef (as in that having an attractive red “bloom”) prior to packaging in the low oxygen atmosphere will, with an almost certain predictability, emerge as the worst looking beef after removal from the master container. Conversely, the worst looking (as in that beef colored by purple deoxymyoglobin) prior to packaging in the low oxygen atmosphere will, with an almost certain predictability, emerge as the best looking beef after removal from the master container.

Other issues of multiple species mass transfer with chemical reaction (i.e. a potential cause for the mud puddle ring problem in packaged fresh meat) are described as follows.

1. Equilibrium between a gas and a liquid is governed by Henry's law which states that the partial pressure of a gas at equilibrium is equal to the Henry's Law constant multiplied by the concentration of the gas in the liquid phase at equilibrium. The gas is oxygen (O2) and the liquid is water (H20).

2. Based on the functional relationship expressed in Henry's law, several conditions can influence the state of equilibrium between free O2 in the package and O2 absorbed in water.

A. Partial pressure of free O2 in the in-package atmosphere.

B. Temperature as Henry's constant is temperature dependent.

Conversion of absorbed O2 in water due to chemical reaction. (The work reported by Zhao and Wells indicates that in-package absolute gas pressure can vary in fresh packaged meat, either increasing or decreasing due to a combination of factors including composition, storage time, temperature, pre and postmortem factors, and others. Since total in-package gas pressure can vary, partial pressure conditions of O2 can vary causing a migration of O2 in and out of water solely based on consideration of factor A. With respect to factor B, it is likely that there are thermal gradients that develop across products, from the center to the surface, for even slight temperature variations that are experienced within the package. This would have two results. The temperature gradients across a product would help to cause moisture migration within a product; and the temperature fluctuation would promote a change in O2 equilibrium concentration within water. In effect, O2 could be absorbed into water, the water migrate, and subsequently be deposited somewhere else in the product.

As a result of factors A and B, and the role of chemical conversion, it is likely that some aqueous participation is needed. Given this, the question becomes what relative O2 concentration and reaction time is needed to produce brown metmyoglobin color. If the time is sufficiently long, factors A and B would operate to move O2, seemingly through the product, to a point to produce the mud puddle ring.

Because the in-package gas atmosphere in a closely wrapped product package is minimal, there is very limited opportunity for bulk convective gas movement by mass transfer within the package. The enclosed space near the permeable web, product and tray are particularly prone to development of a boundary layer away from free mixing of gas molecules within a larger, relatively unconfined headspace. Boundary layer phenomena may include the establishment of a proportionate localized gas concentration compared with the free gas concentration. This situation would aggravate the O2 conditions outlined above in point 2A and 2B compared with a package with a larger headspace volume.

Once formed on a slice of fresh red meat, metmyoglobin is essentially a fixed stain, with unappealing appearance and is generally unacceptable to consumers. On the other hand, oxymyoglobin, which imparts an acceptable red bloom color is attractive to consumers and is therefore desirable.

The present invention provides methods and apparatus for grinding meats such as beef by processing boneless beef through a grinding machine (such as may be supplied by Weiler & Company of Whitewater, Wis., USA) and substantially preventing exposure of the ground meat from contacting ambient air until the ground meat is delivered in any suitable retail package to a point of sale, such as a supermarket. In this way formation of excessive quantities of metmyoglobin and/or any cause of excessive discoloration can be minimized. In a preferred embodiment, the meat can be vacuum packaged after treatment with CO₂ in any one of the methods described herein.

Meat Grinding, Blending and Methods for Controlling Fat

Typically meat packing companies slaughter cattle and then process the dressed carcass by chilling and then disassembling the carcass into portions of meat which can then be, in part, delivered to the point of sale to consumers, in vacuum packs. However, approximately 40% of the disassembled meat is processed at the point of animal slaughter by grinding and then blending to provide ground meat with a selected fat and lean content as required by the retailer. The fat and muscle content of the ground meat may be, for example, 20% fat and 80% lean. Current processing methods require that the boneless meat be firstly coarse ground then blended, vacuum packaged, delivered to a supermarket or packaging facility close to the consumer where the coarse ground meat is fine ground and then retail packaged immediately prior to retail display. This process inherently results in excessive exposure of the ground meat to ambient atmosphere during the grinding and blending process at the point of slaughter. Furthermore, this process requires that relatively large quantities of ground beef are blended together in a single batch. Because it is not possible to disassemble a carcass and provide boneless meat therefrom with a precise and selected ratio of fat to muscle tissue, the typical batch blending process often requires several attempts to produce the desired ratio of fat to lean content. The general industry practice is to deposit selected boneless beef with a fat to lean ratio as close to a desired tolerance as possible. The selected boneless beef may have a fat to lean ratio of 15% fat to 85% lean +/−5%. The selected boneless beef is then coarse ground and blended in a batch blender such as can be acquired from Weiler and Company. Typically, a sample of the blended boneless beef is then removed from the blender and then can be tested to determine fat and lean content using, for example, a device known as an Analray testing procedure. After determining the fat and muscle content of the coarse ground meat addition fat or lean meat is added to the batch blender and the full batch is again blended for a period of time and then a second sample is extracted and tested to determine fat and lean content. If the fat and lean content is as required at this point, the batch of coarse ground meat can be vacuum packaged and stored in refrigerated facilities prior to delivery to the point of retail sale. However if the fat and lean content is not as required then additional fat or lean meat can be added to the batch and further mixing is then required. This process is often repeated as many as 5 times or more. Each time the coarse ground meat is blended again it is damaged by the blending process. This damage may include “fat smear” or over heating. Heat is generated during this blending process and “fat smear” occurs when the meat has been exposed to excessive blending. This procedure is expensive in terms of energy, labor and equipment time. Furthermore, damage to the ground meat is undesirable and yet damage typically occurs as a matter of normal process with the currently predominant industry procedures. During the process described above the meat is exposed to ambient air and bacteria such as E. Coli and other dangerous bacteria can be present in the blended ground meats. Excessive blending can cause the bacteria to spread throughout the batch of meat in the blender.

Ground foods such as ground beef have been produced by processing in meat grinding and blending equipment and associated equipment, such as blending and processing equipment manufactured by Weiler/Beehive. The equipment can be viewed at the following web site: www.meatingplace.com/com/beehive

Ground meat such as ground beef is produced by processing selected portions of boneless meat, including fat and muscle tissues, through a grinding machine. The relative quantities of fat and muscle contained in any batch of the portions of boneless meat is typically arranged to correspond with set industry standards. The batch of boneless meat may include about 93% muscle tissue and therefore the balance of about 7% would be fat. The following list of items 1 to 5, shows the fat and muscle tissue content of some typical industry specifications for boneless meat:

TABLE 1

| Item | Muscle Tissue | Fat Tissue |
|---|---|---|
| 1 | 93% | 7% |
| 2 | 90% | 10% |
| 3 | 75% | 25% |
| 4 | 65% | 35% |
| 5 | 50% | 50% |

Although the industry standards are established, it is difficult to produce large quantity of boneless beef to any specification or ratio of fat and muscle. This difficulty can arise as a result of genetic variation in the animals from which the boneless meat is harvested. Consequently, there is often variations that could be as much as +/−2% to 3%, which corresponds to a possible variation of up to 6% and perhaps even more, in the actual fat or muscle content of the boneless meat.

Typically, consumers can purchase fine ground beef with a fat content that is specified and clearly marked on any retail package. The fat content may be specified to 10%, 25%, or 30% and it is illegal to sell such retail products to consumers if the fat content is higher than the amount shown on the retail package. Therefore, producing retail packages of ground beef with a fat content of, for example, 25%, may be achieved by grinding a known quantity of Item 2 (listed above) and blending this with a known, measured and corresponding quantity of Item 4 (listed above). The fat content of the resulting ground beef can be measured but it is common for the fat content variation in the initial quantity of the boneless beef items to vary to such an extent that a compensating procedure must be accommodated during production of the product for retail packaging. This compensating procedure can often result in production of ground beef that has a muscle content that is higher than is specified on the retail package. The consumer, however, only pays for the ground beef according to the fat content shown on the retail package. Thus a loss of profit for the ground beef producer can be incurred.

A quantity of boneless beef, with a specified muscle and fat content, say Item 5, is loaded into a hopper which is connected directly to a primary meat grinder. The portions of meat are progressively carried, by augers and compressed into a tubular conduit with a perforated grinding plate fitted across. The grinding plate is typically manufactured from suitably hardened steal and the perforations may include drilled and reamed holes of a chosen diameter, which may be about 0.5″ diameter, and which extend completely through the grinding plate. The primary grinder typically produces coarse grinds with the diameter of the meat pieces corresponding with the diameter of the drilled and reamed holes in the grinding plate.

After primary grinding a quantity of Item 5 may be blended with a selected quantity of coarse ground Item 4. After the blending of Item 5 with Item 4 the resultant mix is processed through a secondary fine grinding machine prior to portioning and retail packaging. The secondary fine grinding machine may be similar to the primary coarse grinding machine except that the grinding plate can be drilled and reamed with holes of less than about 0.25″ diameter.

Typical fine ground meat for retail packaging and sale to consumers may be produced with fat and muscle content as shown in the following table:

TABLE 2

| Item | Muscle Tissue | Fat Tissue |
|---|---|---|
| 1F | 90% | 10% |
| 2F | 75% | 25% |
| 3F | 65% | 35% |

The existing grinding, blending and processing equipment, such as Weiler/Beehive equipment, has been demonstrated as effective for grinding meats of various types. However, little has been proposed to improve the quality of the ground meats by, for example, arranging equipment in such a manner so as to substantially prevent contact of the ground meats with air and/or atmospheric oxygen during the grinding and blending process. Meats are ground and blended in such a manner so as to produce ground meats including a product with a desired ratio of muscle and fat content. The conventional equipment does not allow for continuously and automatically grinding and blending the ground meats in such a manner so as to continuously produce quantities of ground meats to an exact and predetermined muscle and fat content.

The present invention provides methods, systems and apparatus to automatically and continuously grind, condition and blend the ground meat products with improved accuracy of muscle tissue to fat tissue ratio, so as to minimize losses to the processor. The ground meat can then be packaged in suitable packaging that will enhance the keeping qualities of the products and provide a safer method of delivering the goods to consumers.

Meat Grinding and Conditioning Apparatus

Having described tray construction, web covers, master container and associated methods for making and packaging, it is now appropriate to discuss apparatus and methods for treating the perishable food items that are to be packaged by those methods herein described. A logical starting point is a method and apparatus for grinding and conditioning meat.

Referring to FIG. 180, a cross-sectional view of a preferred grinding head 1300 constructed according to the present invention is shown. Preferably, grinding head 1300 is attached to a source for the carbonation of liquids and water contained in ground meats. Meat 1310 is processed through grinding head 1300 of a meat grinder 1302 and deposit ed into vessel 1304. Vessel 1304 is substantially sealed from the external atmosphere. Preferably, entry point 1306 and exit point 1308 are such that when compacted meat 1310 fills the grinding head 1300 adjacent to the cutter 1312 and similarly compacted ground meat 1316 fills the exit point 1308 of vessel 1304 adjacent to the end of screw-auger 1314, the vessel 1304 can be filled with a gas such as carbon dioxide under pressure. Preferably, pressure is kept above ambient atmospheric pressure therefore assisting the dissolving process of carbon dioxide into water in meat. Preferably, screw-auger 1314 is attached to a driver (not shown) and rotated so that the ground meat is carried forward and as it travels down the length of the screw auger 1314, the space between the tapered flights 1320 of the screw auger 1314 gradually is reduced, thereby compressing the ground meat just prior to ejection at exit point 1308, thus providing a seal of the vessel 1304 from ambient atmosphere.

This embodiment provides a cost effective method of increasing the pressure of carbon dioxide and elevating the quantity of dissolved carbon dioxide in water and ground meat to a desirable level. Gas provided under pressure into the vessel may include, preferably, a suitable blend of carbon dioxide and other gasses such as nitrogen, stabilized chlorine dioxide (stabilized chlorine dioxide brand name Oxine), helium, and other inert gases, but substantially excluding oxygen, and including an amount of carbon dioxide of about 5% to about 100% by volume or weight.

One embodiment of screw-auger 1314 is shown but alternates may be arranged in other configurations such as when connected directly to and parallel with screw auger 1318 and housed in a tube that has an internal diameter slightly larger than the outside diameter of screw auger 1314, that is also in line and parallel with screw auger 1318. Such an arrangement passes ground beef through a pressure box or vessel and exposes the ground beef to carbon dioxide or other suitable gasses at a gas pressure above ambient atmospheric pressure.

Preferably, suitable blends of gasses can be produced and/or blended at the point of use and injected into vessel 1304 and grinding head 1300 at ports 1322. Preferably, a stainless steel or plastic extension tube is fitted to the flanges of the “downstream” egress/exit point of the pressure box (so as to allow all ground meat to pass through the tube) and the blend of gases is injected into the tube so as to substantially expel atmospheric gasses and oxygen from the tube such that the blend of gasses remains in contact with the meat within the tube. The tube may house an auger type screw arrangement to transfer ground meat inside the tube. The auger has apertures and holes drilled that connect to a pressurized supply of gas.

When the gas is injected through the drilled holes and apertures, exposure of the ground meat to the gasses will be maximized. The ground meat can be shaped or profiled and cut into portions of specified size and directly loaded into packaging while enclosed in a space containing the gas.

Temperature of the gas or blend of gases can be preferably controlled, and may include individual gases in varying relative proportions so as to optimize the cooling of the meat simultaneously while providing sufficient carbon dioxide to allow maximized dissolving of carbon dioxide into the water contained in the freshly ground meat content liquids.

Gasses will most preferably be injected into the grinding head at a pressure that will purge or cause to be expelled, substantially all atmospheric gases from the grinding head and both upstream and downstream of the grinding head. Preferably, covers (not shown) will enclose the portions of the grinding process, package filling and packaging equipment to limit and control escape of dangerous levels or quantities of carbon dioxide or other gasses that may cause damage to health of any machine operators and/or personnel. Preferably gas extraction fans can be located adjacent to the equipment to ensure that safety to operators of the equipment is maintained.

Covers will also preferably restrict egress of atmospheric gasses, such as oxygen, from contacting the freshly ground beef and/or meat prior to packaging and hermetic heat sealing of each package. Such apparatus will substantially inhibit the oxidation of deoxymyoglobin contained in those freshly ground meat portions that were previously not exposed to atmospheric oxygen.

Alternatively, a suitably concentrated solution of carbonic acid (carbon dioxide dissolved in distilled water) can be injected into the grinding head 1300 at port 1322, or mixed with the meat portions immediately prior to grinding such that it becomes mixed with the meat in the grinding process. Preferably, subsequent to grinding, the ground meat can be carried through a tube or “tunnel” that is filled with carbon dioxide.

Alternatively, prior to grinding the meat, the portions of meat are passed through a carbon dioxide tunnel to evaporate a quantity of free water equal to the amount of carbonic acid injected into the grinding head. Carbonic acid solution may be sprayed onto the portions of meat while passing through the carbon dioxide tunnel. Preferably, solid carbon dioxide (“snow”) may be dissolved into water to produce carbon dioxide solution (carbonic acid and water). A measured quantity of snow may be injected into the grinding head at a point immediately adjacent but located on the up stream side of the grinding head such that, during the grinding process, the solid carbon dioxide is blended with the meat so as to substantially cover the surface of the meat particles after grinding. Preferably, a controlled and continuous weighing and feeder device may be used to accurately dispense the solid carbon dioxide.

The process of the present invention advantageously inhibits the growth of bacteria on the surface of the meat portions and particles and maximizes shelf life of the meat for a longer period than the shelf life period that would otherwise be possible without an increase of dissolved carbon dioxide in surface water and also minimizes exposure of ground meat to atmospheric oxygen while in processing from grinder to retail pack. This reduces the normal event of the oxidation of deoxymyoglobin, contained in the meat prior to cutting, to oxymyoglobin and then the reduction back to deoxymyoglobin after packaging in the packages that do not contain oxygen. Alternatively, freshly ground or cut meat may be passed through apparatus for removing and collecting some of the free surface liquid in a continuous or batch process such as with a centrifuge. The liquid is then processed by way of pasteurization at a temperature that does not cause any undesired effects on the ultimate oxidation of the deoxymyoglobin to oxymyoglobin to produce a desirable fresh red color at the point of sale. The liquid can also be exposed to carbon dioxide by mixing with solid or gaseous carbon dioxide. After sufficient carbon dioxide has dissolved into the liquid, the liquid can be sprayed onto meat or other types of goods in a continuous production process.

Alternatively, in another embodiment of the present invention, the carbonation of the free surface liquid may be achieved by including a further step in the process/method of producing modified atmosphere retail packages. Fresh meat can be packaged in a substantially gas impermeable plastic package including a thermoformed tray and flexible plastic lid, hermetically sealed to the tray. The process involves locating the tray (with fresh meat) into an enclosed chamber and then substantially removing atmospheric air from within the chamber before then filling the chamber with a blend of desired gases followed by hermetically sealing the lid to the tray. The present invention provides an apparatus and method for, after substantially evacuating the chamber and filling the chamber with the desired gas, compressing the gas (blend of N₂ and CO₂ or 100% CO₂) within the chamber to an optimized pressure of between slightly above ambient atmospheric pressure and up to 6 bar (6 times the atmospheric pressure). The gas pressure within the chamber is then lowered to ambient pressure (1 atmosphere) and the package is then hermetically sealed. This process of carbonation increases the quantity of carbon dioxide that is dissolved into the liquid in the meat and goods. After hermetic sealing of the package, the liquid is substantially saturated with dissolved CO₂. This inhibits further dissolving of CO₂ into the liquid, that may otherwise cause the package to collapse, and can also extend the shelf/storage life of the meat when held under refrigeration (at preferably between about −2 to about 4 degrees C.).

Meat Carbonation Equipment

Referring now to FIG. 181, another preferred pressure vessel assembly constructed according to the present invention is shown. The pressure vessel 1600 preferably saturates any given quantity of ground meat, with absorbed or dissolved gasses and particularly carbon dioxide gas while also controlling the temperature of the ground meat and minimizing or eliminating freezing of the ground meat during the process.

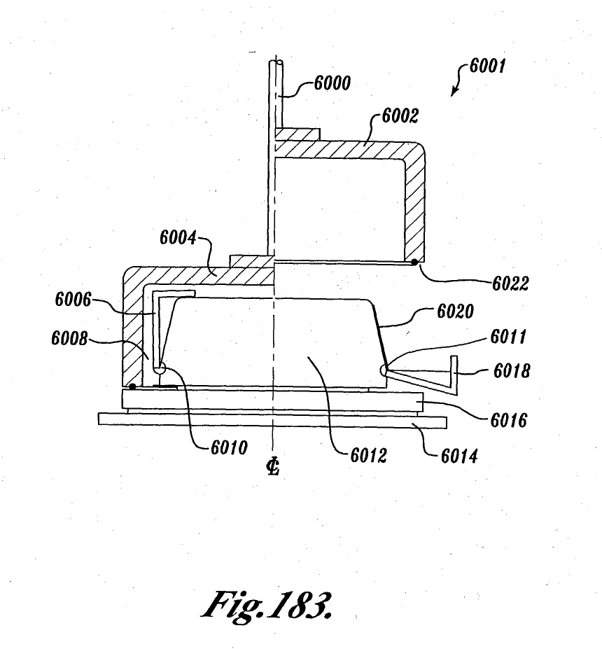

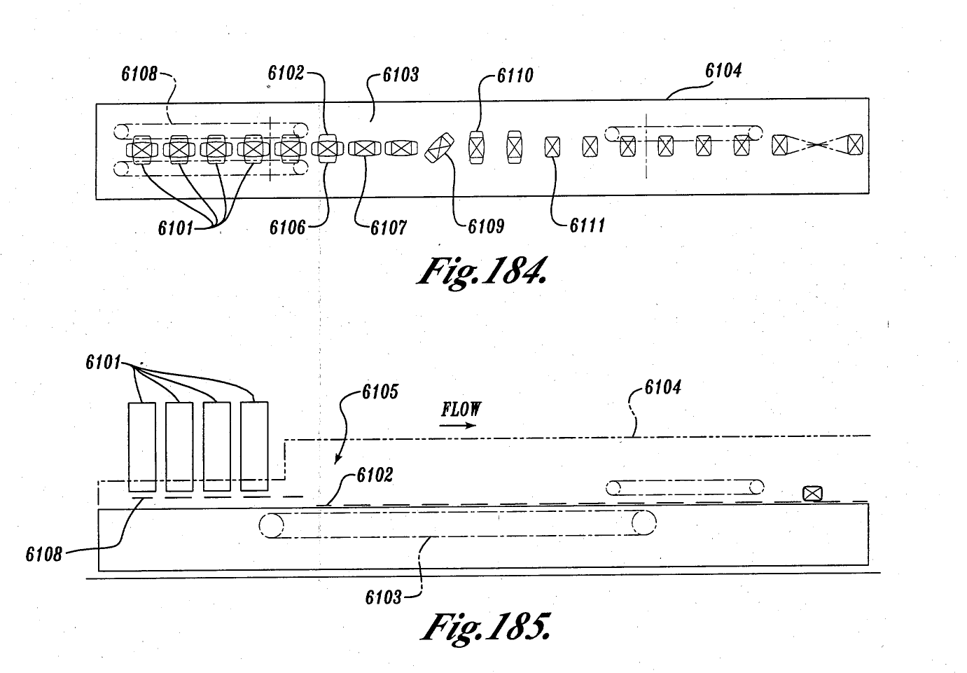

An adapter tube 1602 is shown connecting a meat grinder 1604 to the pressure vessel assembly 1600 and is most preferably provided with an airtight connection. Compacted meat 1606 is shown within the meat grinder 1604. Preferably, the compacted meat 1606 is forced through holes in a plate and cut by a rotating blade in a manner as is typically incorporated in most meat grinders and is well known to manufacturers and users of meat grinding equipment. Preferably, compacted meat provides a seal to substantially prevent escape of pressurized gasses that may be provided to the pressure vessel. Preferably, a port 1608 is provided in a section of the meat grinder 1604 to allow injection of gasses such as carbon dioxide or blends of carbon dioxide nitrogen or any other suitable gas. Preferably, injection of the gasses into port 1608 substantially purges air that is in contact with the meat just prior to grinding and displaces the air with the desired gas. Preferably, the gasses may include a gas blend of carbon dioxide and nitrogen where the percentage of carbon dioxide is about 95% and the balance of about 5% includes nitrogen. Preferably, the interior of pressure vessel 1600 is substantially isolated from atmospheric air and is fitted with a removable dome 1610. Removable dome 1610 can facilitate easy access for general cleaning and sanitizing purposes. Preferably, the main portion of pressure vessel 1600 is enclosed by a jacket 1612 providing a space between the jacket 1612 and walls of pressure vessel 1600. Preferably, temperature is controlled by circulating fluid through jacket through port 1614 and extracted through port 1616. A cross-section of the vessel 1600 taken along line P-P, through the jacket and pressure vessel walls is shown in FIG. 182 for clarity.

Preferably, a port 1622 is provided at the apex of removable dome 1610 providing a port to inject gasses and other substances such as O₃, F₂, H₂O₂, KMnO₄, HClO, ClO₂, O₂, Br₂, I₂, or any combination thereof and flavors into or alternatively extract from within the pressure vessel through port 1622. Alternatively, a gas blend is injected into the pressure vessel through port 1622 and maintained at a pressure of about 25 psi. Most preferably, a gas blend including nitrogen and/or carbon dioxide and/or ozone (O₃) will be provided into pressure vessel via port 1622. Water and oils contained in the ground meat can then absorb carbon dioxide until it becomes substantially saturated and cannot absorb any additional carbon dioxide. Preferably, a controller to maintain and/or adjust and vary pressure of the gasses within the pressure vessel, as desired, is also provided but not shown. Preferably, a side port 1624 is provided in the wall of the pressure vessel through which ground beef may be provided into the pressure vessel 1608 for further processing in the pressure vessel assembly. Preferably, the size of the pressure vessel can be adjusted to suit requirements. The dimensions of length and height may be increased or decreased to accommodate the required processing capacity of the first pressure vessel assembly. The lower end of the pressure vessel 1600 is attached to a horizontally displaced tube section 1624 within which an auger 1628 is mounted. Preferably, auger 1628 includes passageways and holes 1646 provided so as to allow injection of gasses therethrough by connection to a source of gasses through port 1648, thus substantially maximizing exposure of the ground meats to direct contact with the gas blend. Tube section 1634 has a length dimension L which can be increased or decreased according to requirements. Preferably, auger 1628 is attached to a driver (not shown) that can provide a force to rotate auger 1678 in a direction such that ground meat will be transferred through horizontally displaced tube section 1626 and toward a tapered tube section 1632. Preferably, driver has the capacity of rotating auger 1628 at a desirable speed which can be adjusted as may be required to optimize throughput of ground meat by first pressure vessel assembly.

Fine ground meat passes into the pressure vessel 1600 and accumulates until the upper level of accumulated ground meat is adjacent to proximity switch 1650. Switch 1650 sends a signal to the variable speed drive motor which motor starts to slowly rotate auger 1628. Ground meat continues to accumulate and when level reaches a point adjacent to proximity switch 1652 variable drive motor is accelerated to a higher speed. The level of ground meat may continue to elevate and when the level reaches proximity switch 1652 drive motor speed is increased to maximum speed causing the level of ground meat to drop below a level adjacent to 1654 at which point the drive motor slows down to a lower speed. When the level of ground meat drops to a level below 1650 the drive motor is signaled to stop. Therefore, in this fashion, the level of ground meat within the pressure vessel 1600 can be maintained at a point between the lowest proximity switch 1650 and the highest proximity switch 1652.

Preferably, tapered tube section 1632 has ports 1634 and 1636 to allow injection of gasses into section 1632 or allow gasses to be extracted from within the tapered section by passage. Preferably, additional ports may be provided through any part of apparatus walls as may be required to optimize efficiency and operation of pressure vessel assembly. A transfer section 1630 is located at the egress end of tapered tube section 1632. Preferably, section 1630 is provided with a port through which gasses may be injected into or extracted from within section 1630. Preferably, a desired profile can be varied by interchanging an extruded profile section 1640. Preferably, the continuous length of extruded food product can be severed by a cutting device such that pieces of extruded food can be provided with specified and desired lengths. The pieces of extruded food can then be packaged into packages of suitable size. Such an extruded profile section 1640 is attached to the egress end of the transfer section 1630. A cross-section through section 1640 is shown in FIG. 183 where a rectangular profile can be seen. Ground meat can be compressed by auger 1628 and thereby forced through section 1640. Preferably, compression of the ground meat through the profiled section provides a similar rectangular profile to the ground beef as it passes through the egress end of section 1640.

A side view and end view of an alternative extruded profile section 1640 in the form of a manifold is shown in FIGS. 185 and 184. Preferably, manifold 1642 includes a series of three tube profiles through which ground meat can be extruded. Such a process can provide three separate streams of profiled ground meat. The manifold 1642 may include one or several streams of profiled ground meat. A tube of similar internal cross-section to the stream of ground meat may be connected to each stream of ground meat and thereby contain each stream of ground meat separately within a corresponding number of tubes so as to allow transfer of the profiled ground meat to other processing equipment such as automatic ground meat patty production equipment or a second pressure vessel. The tube(s) will thereby provide protection to the ground meat and substantially isolate it from contact with external contaminants or atmosphere.

Preferably, a 3 way valve (not shown) can be inserted between transfer section 1630 and profile section 1640. The 3 way valve can be attached to section 1630 and section 1640 in a substantially airtight fashion so as to provide direct connection to each other or a connection to an alternative tube connected to other equipment or to port 1624. Preferably, this provides diverting the ground meat to other equipment for further processing or, as may be required at the start of a period of production, diversion of the ground meat into a first pressure vessel through port 1624 for additional processing to ensure that the ground meat is substantially saturated with dissolved carbon dioxide or other gasses. After the ground meat has been re-processed, which may require return to pressure vessel 1600 via port 1624 repeatedly, the three way valve can be switched to direct passage of the ground meat through the extruded profile section 1640 or other equipment for further processing or retail packaging. Preferably, valves (not shown), most preferably automated valves to close all ports shown in FIG. 181 and any others that may be provided, in a substantially airtight manner, are provided to each port but not shown.

As can be learned and understood with the foregoing description an adequately effective gas tight seal can be provided by compacted meat 1606 within meat grinder 1604. Furthermore, auger 1628 can be arranged so as to fit closely within transfer sections 1632 and 1630 such that when 1628 is rotating, during normal operation of the apparatus, ground meat will become compacted within 1632 and 1634 and around auger 1628 and thereby provide an adequately effective gas tight seal. Therefore, gas pressure within the pressure vessel 1600 can be increased to above ambient atmospheric air pressure as required and maintained at a selected pressure by a controller to maintain and/or adjust and vary pressure of gasses within the pressure vessel 1600, as desired. The gasses within the pressure vessel 1600 will therefore be substantially contained between the compacted meat at 1606 in the meat grinder and compacted meat 1656, within transfer sections 1632 and 1630 at a desired pressure. Pressure can therefore be maintained at a pressure most suited for rapid absorption by water and oils in the ground meat contained within the apparatus during operation and transfer of the ground meat,through the apparatus.

Preferably, second and additional pressure vessel assembly of similar construction to the first pressure vessel assembly, can be provided and attached to the first pressure vessel assembly via an adapter tube so as to provide direct passage of the ground meat from the egress point at the extruded profile section 1640 by way of a tube connected directly to the adapter tube 1602 into the second pressure vessel assembly thereby providing direct communication to the second pressure vessel. After passage of the ground meat through the first pressure vessel it can therefore be passed directly into a second pressure vessel. Preferably, the second pressure vessel is attached to a vacuum pump via a similar port to that as shown as port 1622 in FIG. 181. Preferably, the port shown as port 1624 is not provided in the second pressure vessel. A suitable gas such as nitrogen is injected into ports provided in the second pressure vessel assembly which are shown as ports 1608, 1634 and 1636 and the nitrogen gas is also injected through ports and passageways in auger, also provided in the second pressure vessel assembly and shown as 1628 in the first pressure vessel assembly. The gas pressure within the second pressure vessel assembly is maintained at approximately a pressure equal to or higher to the prevailing atmospheric pressure. The ground meat is passed through the second pressure vessel assembly and through extruded profile section and into other equipment as required for packaging and or further processing. Passage of the ground beef through the second pressure vessel assembly removes free carbon dioxide that may remain within the voids contained within the ground meat and replaces it with a gas such as nitrogen.

A preferred embodiment is to provide a method of substantially restricting the escape of any gasses, such as carbon dioxide or ozone, from an apparatus, that may be hazardous to the wellbeing of operators of the apparatus. This can be achieved by locating the apparatus, such as shown in FIG. 181, within a confined space such as an enclosed room or other enclosure that is substantially filled with an inert gas such as nitrogen. The enclosure may include several parts and be arranged to cover only certain parts of the apparatus. The apparatus can be arranged such that certain parts are exposed to allow access or loading. Preferably, the gas contained in the room or enclosure will be substantially nitrogen with a residual oxygen content of less than 20,000 parts per million. The enclosures or room can be extended to enclose or house other equipment such as conveyors and packaging apparatus that may be used to process and package the ground meat. Such an arrangement would most preferably isolate the ground beef from contact with gasses containing oxygen in concentrations greater that 20,000 parts per million, or greater than 300 parts per million, and allowing the ground meat, which may be ground beef, to be packaged in a vacuum pack or a modified atmosphere package containing a gas that includes a blend of desired gasses but containing residual oxygen of not more than 500 parts per million. The gas contained within the enclosures or the room may be pressurized and vented to a convenient and safe point into the atmosphere.

Meat Carbonation System

In another preferred embodiment a series of enclosed vessels which may be pressure vessels, can be connected together, in series, via suitable conduit means with a positive displacement pump located between each pressure vessel and connected to the conduit means such that a pump can transfer product such as ground meat, by pumping means, from a first pressure vessel to a second pressure vessel. Goods such as ground meat can be transferred directly from a grinder into a first pressure vessel and a first pump can transfer the ground meat from the first pressure vessel to a second pressure vessel. A second pump can be provided to transfer the ground meat from the second pressure vessel to a third vessel and a third pump can be provided to transfer the ground meat from the third vessel to a fourth vessel. Any desired number of vessels and pumps may be assembled in series so as to provide a method of transferring the ground meat progressively from the first vessel to subsequent vessels as may be required. Gases and/or other goods and materials may be transferred by any suitable means into any of the vessels at any suitable temperature and pressure. Blending and mixing devices may be installed in the vessels, as may be required, and any suitable means of controlling and adjusting temperature of goods transferred into and from the vessels can be provided. In this way each vessel can be separately and independently controlled and arranged with a holding capacity to accommodate any desired quantity of ground meat, with selected gases and other materials provided therein, and held at any chosen temperature and pressure. Each pump can be arranged to separate each vessel such that temperature and pressure can be independently adjusted in each of the vessels.

In a preferred embodiment, for example, fat and muscle tissue contained in a quantity of boneless beef can be separated into a first quantity and a second quantity where the first quantity includes only muscle tissue which is then ground or cut into suitably sized pieces and then transferred directly into a vessel containing a suitable oxygen free gas and held at a temperature of 140 degrees F. for a period of time sufficient to substantially kill any bacteria contained therein. The second quantity including only fat can be transferred into a second vessel and subjected to ultra high pressure (UHP), exceeding 80,000 psi, so as to substantially kill all bacteria contained therein while maintaining the second quantity of fat at a temperature of not more than 104 degrees F. The first quantity of muscle tissue can be chilled to a temperature below 100 degrees F. and processed by extrusion to provide a first continuous stream of muscle tissue with a desired cross-sectional profile that can be arranged to be similar to the profile of the muscle component of a typical New York strip. The second quantity of fat can be chilled to a temperature below 100 degrees F. and extruded to provide a second stream of fat with a profile similar to the fat component of a New York strip. The first stream of profiled muscle tissue and the second stream of profiled fat can be then be combined into a single stream of muscle tissue and fat and the temperature of the single stream be reduced to about 29.5 degrees F. In this way, a substantially bacteria free, continuous stream of extruded muscle and fat having a cross-sectional profile similar to a New York strip can be produced which can then be sliced into suitable portions prior to retail packaging.

In this way, ground meat (and other meats) can be processed so as to substantially prevent the formation of oxymyoglobin immediately after grinding. The ground meat can then be retail packaged in a low oxygen package such as a master package system as described herein and delivered to the point of sale in a de-oxymyoglobin condition. The package can be removed from the de-oxymyoglobin condition immediately prior to retail display so as to allow generation of the consumer appealing red color or “bloom” for the first time after grinding.

Meat Grinding and Conditioning Apparatus

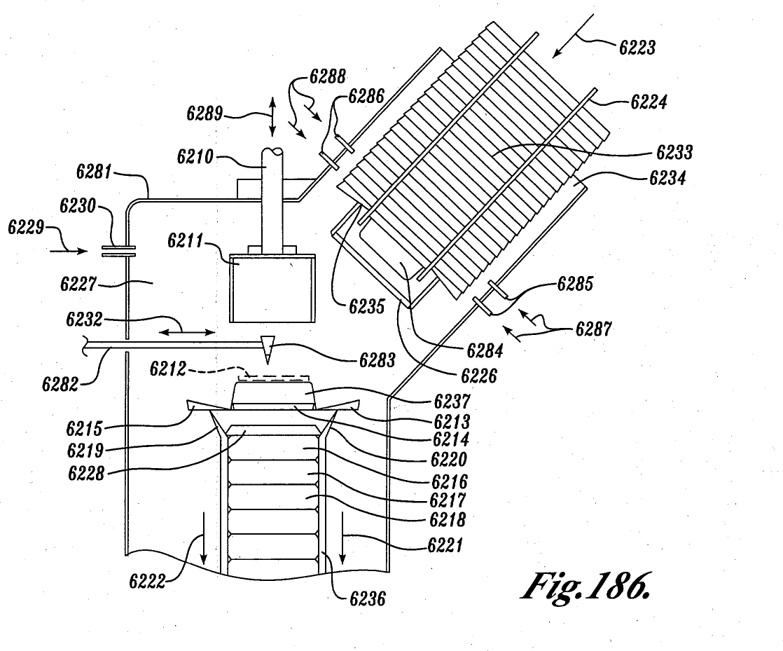

Referring now to FIG. 186, a meat grinding assembly constructed according to the present invention includes a first and second meat grinders that are in direct communication via a pressure vessel 1700. Preferably, first meat grinder 1702 is fitted with an auger 1704 and meat grinder 1702 is attached to pressure vessel 1700 via adapter tube 1706 thereby providing direct communication to transfer ground meat that has been ground by grinder 1702 directly into the pressure vessel 1700. Preferably, adapter tube 1706 is provided with a substantially gas tight seal at the point of connection to pressure vessel 1700 such that pressurized gas that can be provided into 1700 will not escape. Preferably, the adapter tube 1706 is fitted with a valve (not shown), such that when grinder 1702 has completed grinding and no compacted meat remains in the grinder, the valve can be closed thereby closing communication between the pressure vessel 1700 and grinder 1702. Closing the valve can thereby allow continued processing of any coarse ground meat that may remain in pressure vessel 1700 with gas provided therein under pressure and above ambient atmospheric pressure as required and until all coarse ground meat contained in the pressure vessel 1700 has been processed through second fine meat grinder 1738 and into downstream pressure vessel 1730. Furthermore, if so desired an additional valve, similar to the valve at grinder 1702, can be provided in the adapter tube 1718 so as to allow further processing of the fine grinds in the pressure vessel 1730.

Preferably, pressure vessel 1700 is fitted with a removable dome 1708 in which is provided a port 1710. Preferably, the lower portion of pressure vessel 1700 is attached to a housing containing auger 1712 which is directly attached to a variable speed drive (not shown) that can rotate auger 1712 in a direction that causes coarse ground meat to be urged into and through blade 1714 and plate 1716. Preferably, an adapter tube 1718 is fitted so as to provide direct communication to pressure vessel 1730 Preferably, proximity switches 1720, 1722 and 1724 are conveniently located in walls of the pressure vessel 1724. Preferably, proximity switch 1720 is located at a point higher than the location of switch 1724, and switch 1722 is located between switches 1720 and 1724.

Pieces of meat are placed into a hopper (not shown) attached to first meat grinder 1702 and auger 1712 is rotated to cause pieces of meat to be urged through a rotating blade and a perforated plate 1716. Compacted meat 1726 accumulates in a compressed condition just prior to passing through blade 1736 and plate 1716, providing a gas tight seal between the grinder 1702 and the pressure vessel 1700. Coarse ground meat passes into pressure vessel 1700 and accumulates until the upper level of accumulated ground meat is adjacent to proximity switch 1724. Preferably, switch 1724 sends a signal to a variable speed drive motor (not shown) connected to shaft 1728 which starts motor to slowly rotate auger 1712. Coarse ground meat continues to accumulate and when level reaches a point adjacent to proximity switch 1722, the variable drive motor is preferably accelerated to a higher speed. The level of ground meat may continue to elevate and when the level reaches proximity switch 1720, preferably the drive motor speed is increased to maximum speed causing the level of ground meat to drop below a level adjacent to switch 1722 at which point, preferably, the drive motor slows down to a lower speed. When the level of ground meat drops to a level adjacent to switch 1724, preferably, the drive motor is signaled to stop. Therefore, in this fashion, the level of ground meat within the pressure vessel 1700 can be maintained at a point between the lowest proximity switch 1724 and the highest proximity switch 1720. Preferably, meat is compacted at just prior to passing through rotating blade 1714 and perforated plate 1716, thereby providing a gas tight seal between pressure vessel 1700 and pressure vessel 1730.

In this fashion compacted meat remains in a compacted condition at location 1732 and 1726 providing gas tight seals. Preferably, a desired gas or blend of gasses can be injected into pressure vessel 1700 at a desired pressure. Preferably, gas pressure is slightly above ambient atmospheric pressure or up to 150 psi and is maintained at desired pressure by metering and gas pressure regulating equipment (not shown). In this fashion gas can be continuously injected into the pressure vessel 1700 and maintained at a desired pressure at a rate equal to the rate of absorption of gasses by the ground meat. The meat and ground meat may be compacted to provide substantially gas tight seals other than as described herein while providing for a continuous production process of meat treatment during the meat grinding procedure. Production speed can be adjusted to optimize the gas absorption (and contact with surface of the ground meat) at a desired rate while maximizing output of the apparatus and equipment.

In yet another preferred embodiment, pressure vessel 1700 and/or other pressure vessels attached thereto, preferably are provided with valves, that can be opened and closed, and that are provided at all ports, adapter tubes, entry and egress apertures in the pressure vessel(s), so as to enable isolation of the pressure vessel(s) from external ambient atmosphere. Preferably, when isolated, gas pressure within the pressure vessel(s) may be adjusted to a suitable and adjustable pressure below and/or above ambient atmospheric pressure. Preferably, the gas pressure, in the pressure vessel, may be increased and decreased in a pulsating and/or oscillating frequency and pattern that can provide for the efficient removal of undesirable gasses and the replacement with desirable gasses at a desired pressure.

Meat Processing System

A processing system is disclosed including a meat grinder and a processing and blending tube with three augers to transfer the meat through the system. The tube includes a heat exchanger to maintain temperature and ports for the introduction of conditioning gases.

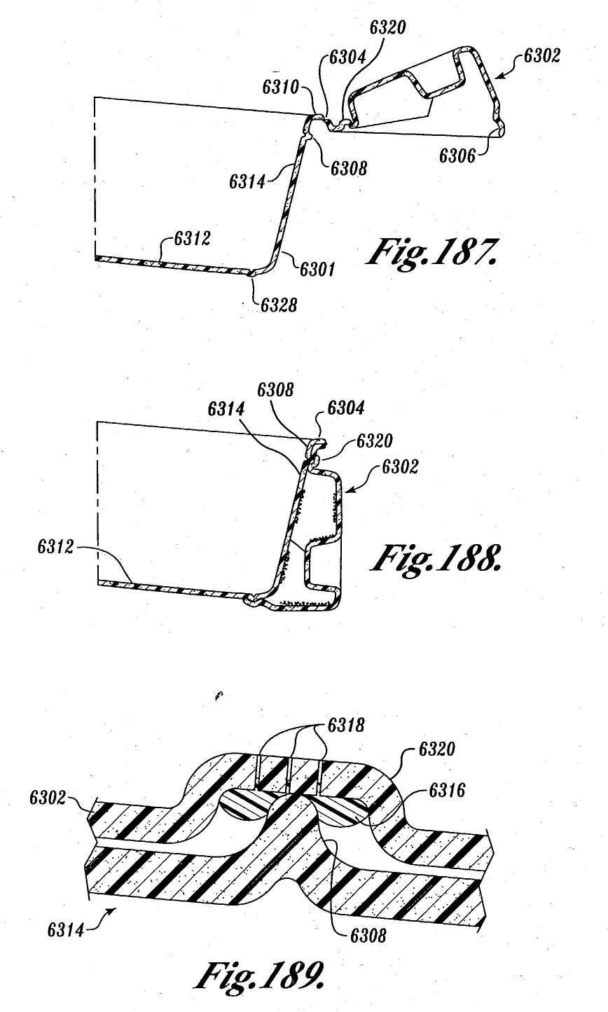

FIGS. 187-189 discloses a preferred apparatus constructed according to the present invention arranged to process perishable foods such as ground beef. Preferably, the apparatus can be assembled in a gas tight manner with components manufactured from any suitable materials such as approved stainless steel or plastics. Preferably, the assembled apparatus may be arranged in a horizontal disposition or with devices to adjust the horizontal disposition to any desirable angle of repose.

Apparatus 5600 includes an enclosed vessel 5624 of circular cross-section profile, with end enclosures 5602 and 5604. Preferably, vessel 5624 can be arranged to contain any suitable gas at any suitable internal gas pressure and at any suitable temperature. Preferably, the temperature of the gas is controlled. Preferably, vessel 5624 can be fitted with drivers 5614, 5616, 5618 and 5620 attached thereto at suitable convenient locations and as required to provide driving forces to a round blending tube, shown as 5622, located inside vessel 5624. Preferably, the drivers can be controlled to drive the tube 5622 at a suitable constant and variable speed. The tube 5622 engages with four drive wheels, all shown as 5626 for clarity, and tube 5622 is supported thereon, but otherwise is free from contact with other components except for suitable contact with seals as may be required at each end of the tube 5622. Preferably, drive wheels 5626, are engaged to the corresponding drivers 5614, 5616, 5618 and 5620. In this way, the tube 5622 is retained by the drive wheels, 5626, in a horizontally disposed position or as may be otherwise required. Preferably, pressure vessel 5624 is fitted with vent 5628 which can be provided with a valve (not shown) to allow any excess liquids or gases to be drained therefrom. A vent with valve and venturi, 5632, can be fitted to vessel 5624. Preferably, any desired number of vents with valves and venturis can be fitted to the vessel 5624. Preferably, venturis can be arranged to provide gas injection into space 5636 in such a manner that will cause the injected gas to flow along space 5636 and then through tube 5622, in a desired direction at a suitable velocity.

The tube 5622 is arranged inside the vessel 5624 and passageway 5636 is thereby provided between the outer surface of the tube 5622 and the inner surface of vessel 5624. Gas can therefore be provided inside the pressure vessel and in the passageway 5624. Preferably, any suitable gas temperature controller may be arranged such as by arranging a heat exchanger 5638 connected to the vessel 5624 as shown. Preferably, a first and second suitably sized tubes, 5640 and 5642 are attached in direct communication with vessel 5624 such that gas can pass between the tubes and the vessel 5624. Preferably, tube 5640 is connected to the heat exchanger 5638 and another connecting tube 5644 is attached to a gas blower 5646 which in turn is connected to the connecting tube 5642. In this way gas can pass through tube 5640, into and through the heat exchanger 5638, through tube 5644, into and through the gas blower 5646, and through connecting tube 5642. Preferably, a barrier 5648 is located in space 5636 which can follow the outer circumference of tube 5622 so as to substantially inhibit gas passing therethrough. In this way, when gas blower 5646 is activated, gas can be drawn in from space 5636 on one side of barrier 5648, through tube 5640 and passed through tube 5642 and back into space 5636 on the opposite side of the barrier 5648. Preferably, this provides recirculation of any suitable gas along the space 5636, through tube 5622, back into space 5636 and again through the heat exchanger 5638. The gas can be re-circulated and repeatedly passed through heat exchanger, 5638, to maintain the gas at a desired temperature. A tube shown as 5650 is provided to allow suitable gas to be injected into the heat exchanger 5638. Preferably, the suitable gas can be provided in a liquid or high pressure condition and allowed to expand in the heat exchanger 5638, and thereby cause a lowering of temperature. Suitable gas can then pass from heat exchanger 5638 and into tube shown as 5652 which is connected to tube 5644. Alternatively, suitable gas can be allowed to escape through tube 5654 and valve 5656. In this way, by controlling the flow of gas, the internal temperature of vessel 5624 and all other items therein can be controlled. During the re-circulation of gas through tube 5622 and heat exchanger 5638, a quantity of water, contained in the grinds, may evaporate and condense in heat exchanger 5638. The quantity of condensed water in the heat exchanger may be processed, sterilized and carbonized, by dissolving carbon dioxide therein and then injected into the grinds through vent tube 5658. Preferably, tubes 5652 may be provided with pressure regulators and valves to allow excess gas to escape therethrough, from vessel 5624 at a suitable rate and in such a manner as to maintain the temperature of the gas within a temperature range of plus or minus about 0.5 degrees F., or at any other suitable temperature range. Preferably, the suitable gas and/or any other suitable substances can be provided in vessel 5624 at any suitable gas pressure to facilitate dissolving of the gas and/or substances into the ground meats contained in the tube 5622. In this way, the suitable gas can be controlled to either chill or heat the ground meats being processed in tube 5622, and by the apparatus.

Referring now to end enclosure 5602 with a plurality of apertures. Cover 5660 is located over an inspection access hole so as to provide a convenient access into the apparatus for any purpose such as for cleaning. Preferably, a vent 5662 is provided to allow excess gas to escape. Preferably, vent 5662 can be attached to suitable valves with gas pressure regulators as may be required to control gas pressure. A tube 5664 is located through a tube in the wall of end enclosure 5602. Preferably, tube 5664 connects to a nozzle 5666, that can be arranged to provide temperature controlled water or other liquids, at any suitable pressure into the inner space contained within tube 5622. Preferably, the water or other liquids can be used to clean the internal surfaces of the apparatus after use of the apparatus. Bearings such as bearing shown as 5668 are also located in the end enclosure 5602.

Referring now to end enclosure 5604, several openings are shown therein with other apparatus attached thereto. Preferably, three variable speed drive motors, 5614, 5616 and 5618 are fixed to the end enclosure 5604 and each motor is attached to corresponding shafts shown as 5670, 5672 and 5674. A subassembly 5601 is mounted to end enclosure 5604 in a desired position and can pass ground beef into the tube 5622 directly from a grinding apparatus without contacting atmospheric air. Preferably, all shafts, tubes, components and assemblies attached to end enclosures are sealed in a suitable and desired gas tight manner, thereby retaining any gas that may be contained within vessel 5624, at any suitable pressure.

Referring again to FIG. 187, three separate augers (two shown), depicted as 5678, 5680 and 5682 are preferably mounted in close proximity to each other and with a member 5682 arranged above auger shown as 5676 separating it from augers 5678 and 5680. Preferably, augers 5676, 5678 and 5680 can be arranged in a horizontally disposed and parallel position. Auger 5676 is attached to drive motor 5614, auger 5678 is attached to drive motor 5616 and auger 5680 is attached to drive motor 5618. The end sections of each auger 5676, 5678 and 5674 are arranged with shafts and each shaft end mates with bearings located in end enclosures 5602 and 5604. Drive motors 5614, 5616 and 5618 are arranged to drive the corresponding augers at variable rotating speeds in any chosen direction, either clockwise or counterclockwise, as may be selected according to any desired direction and at any suitable speed that will enable optimized mixing of the ground meats processed in tube 5622. Alternatively one or any number of augers may be located in tube 5622 to provide the most optimized mixing therein.

Referring again to FIG. 187, sub-assembly 5601 is attached to end enclosure 5604 and can be operated to grind beef and inject the ground beef directly into tube 5622. In this way, ground meat can be continuously provided into tube 5622, at any suitable rate within the capacity of the apparatus. Referring now to FIG. 190, the ground beef that flows into tube 5622 can be arranged to fall directly onto but centrally and between the center lines of augers 5678 and 5680. Preferably, augers 5678 and 5680 can be arranged to rotate in opposite directions. Direction of rotation of auger 5678 can be in a clock-wise direction and auger 5680 can be rotated in a counter clockwise direction. In this way, the ground beef can be carried by augers 5678 and 5680 toward end enclosure 5604 and away from end enclosure 5604. Member 5682 is arranged to allow containment of the ground beef between its upper faces and augers 5678 and 5680 for a brief period such that as augers rotate the ground beef is carried toward the end enclosure 5604. As augers 5678 and 5680 rotate the ground beef will then drop and contact tube 5622. Preferably, tube 5622 can be arranged to rotate at a suitable speed, of between about 100 rpm or less and about 500 rpm or more, such that centrifugal force will hold the ground beef against the internal surface of tube 5622. When tube 5622 has rotated by approximately one half of one revolution and the ground beef is carried to an upper location and above augers 5678 and 5680, a scraper 5625 can be provided to remove the ground beef from contact with tube 5622. The scraper 5625 can be arranged to cause the ground beef to be directed back onto augers 5678 and 5680. Auger 5676 can be driven in a direction that will carry any ground beef, that it contacts, toward the end enclosure 5602. Preferably, the rotating speed of each auger can be adjusted as required. Preferably, auger 5676 can be arranged to have an extended length, that is longer than 5678 and 5680 such that 5676 extension extends beyond 5678 and 5680 and into a tubular, section, shown as 5722, with an internal diameter slightly larger than the external diameter of auger 5676. As shown in FIG. 187, auger 5676 can then be arranged to carry ground beef from within tube 5622 and through tubular section 7522 at a desired rate. In this way the ground beef will be carried toward end 5602 by augers 5678 and 5680 and toward end 5604 by 5676. The rotation of tube 5622 and its interaction with the scraper 5625 will then provide further mixing fat and muscle content of the ground beef. By independently adjusting the rotating speed of augers 5676, 5678 and 5680 and also tube 5622, the period of time that the ground beef is retained within the tube 5622 can be controlled to an optimized period of time and thereby allow an efficient method of blending. Preferably, after a suitable period of retention, the ground beef will be transferred through tube 5642 and will then fall downwardly into tube 5724. Tube 5724 can be located directly above and connected to a suitable vane pump shown as 5726, which may include any suitable vane pump manufactured by Weiler & Company, Inc. Preferably, the ground beef can be pumped at a known and controlled velocity by vane pump 5726 into tube 5728 which is connected directly thereto. Tube 5728 can be connected to another measuring device 5730. In this way, ground beef can be ground and injected into tube 5622, by sub-assembly 5601, and after passing through a first measuring device 5730, blended by augers before pumping through a second measuring device 5730 located between tubes shown as 5728 and 5732. Ground beef can be conditioned and blended at a production rate limited only by the chosen size and capacity of the ground beef conditioning and blending apparatus, which may be varied in size and capacity as required.

The conditioned and blended ground beef can thus be pumped through tube 5732 at a desired and controlled temperature with a quantity of suitable gas such as carbon dioxide, dissolved in the ground beef to any desired level of saturation. Vane pump 5726 can be provided with a variable speed drive motor and arranged to pump ground beef at a controlled velocity into other apparatus for subsequent blending with other ground beef or chosen material and/or further processing.

In a preferred embodiment the conditioned ground beef may be exposed to a suitable beam of electrons by locating an electron beam generator and accelerator such as may be manufactured by Titan-Scan Systems of 3033 Science Park Road, San Diego, Calif. 92121. Preferably, the electron beam generator may be located in such a manner that the suitable beam of electrons produced there with, is directed directly at and through a stream of grinds while the grinds are passing through a tube such as tube 5754 shown in FIG. 191. The cross-sectional profile of the tube may be arranged to provide maximum exposure to the electron beam. In this way the conditioned ground beef can be sterilized at any temperature while maintaining a fresh and uncooked condition. Preferably, electron beam sterilization is used on fresh ground beef which is in a low oxygen environment to prevent over-oxidation. In an alternative embodiment the stream of conditioned ground beef can be exposed to irradiation from a source of gamma rays.

Referring again to FIG. 191, a section of assembled tubes is detailed. The section of tubes includes a first tube 5744, a second tube 5746 and a third tube 5748 which are all joined at a confluence, 5750, to a fourth tube 5754. The tubes and particularly the confluence may be manufactured from any suitable plastics or stainless steel materials and machined so as to ensure that any processed materials passing therethrough, will not be subject to significant turbulence until after passing through the confluence 5750. Preferably, any number of two or more tubes joined, at a confluence, to a single tube 5754, may be arranged to produce processed materials as may be desired. In a preferred configuration, a first processing machine (not shown), is arranged to deliver the processed material via tube 5744, a second processing machine (not shown), is arranged to deliver the processed material via tube 5746 and a third processing machine (not shown) is arranged to deliver the processed material via tube 5748. Preferably, the fat content of each stream of ground beef can be measured, by any suitable measuring device such as that shown as 5730 in FIG. 195, and the fat content will therefore be known. Preferably, the velocity of each stream of material can be adjusted by adjusting the speed of separate vane pumps arranged in such a manner so as to provide for velocity adjustment. By adjusting the velocity of each stream of processed material corresponding to the measured fat content contained therein, delivered quantities of the processed material, can be adjusted such that when any two or more streams are combined together, the resultant fat content of the combined stream will be substantially constant and as required. In this way, the known fat content of the combined stream of processed material can be maintained to within a narrow range of variation. The variation may be within a range of not more than +/−1% of the fat content of any item such as Item 1F.

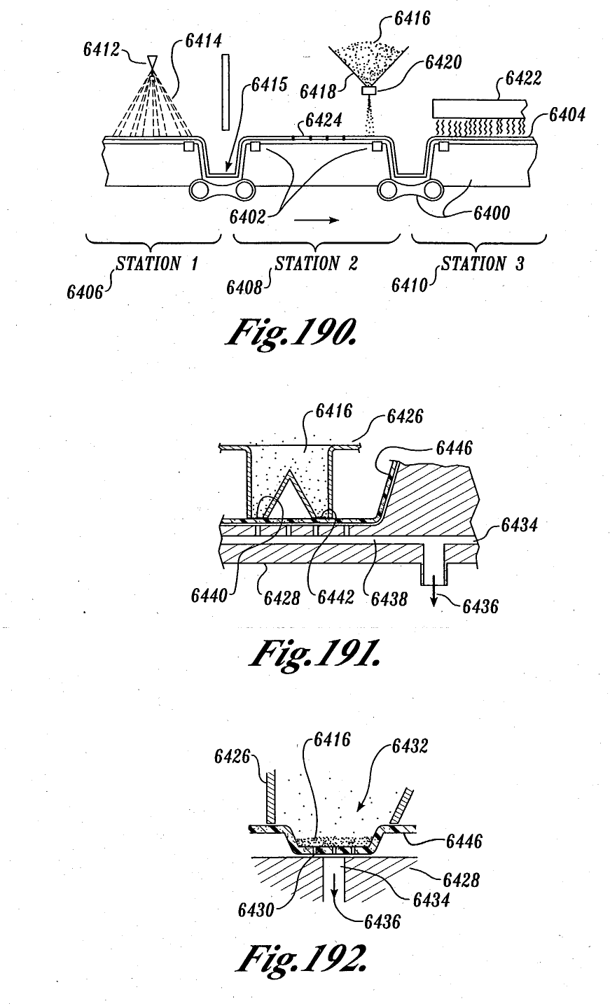

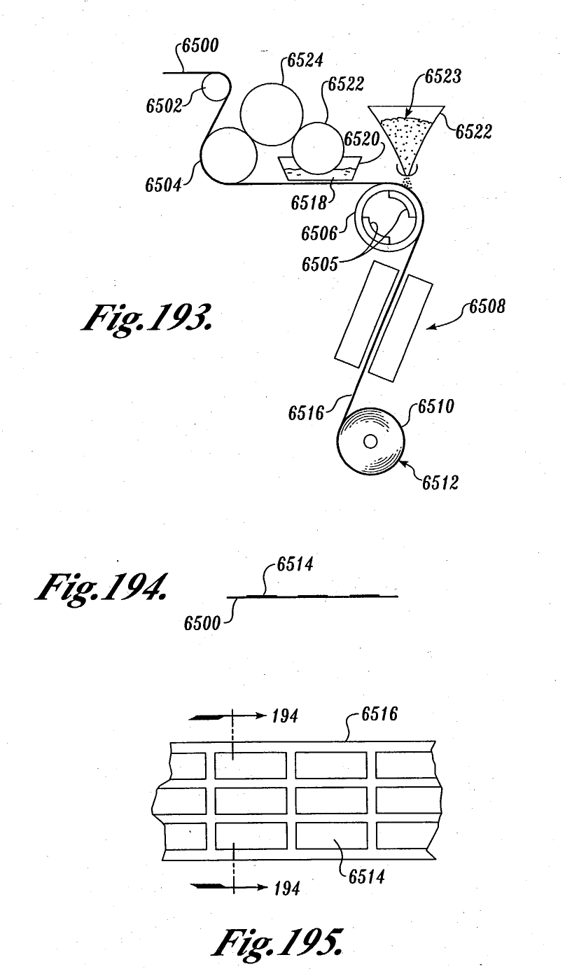

Referring now to FIG. 192, a preferred embodiment including a group of three blending tubes 5756, 5758 and 5760 is shown, each tube being similar in operation to tube 5622 shown in FIG. 187. Preferably, the group of three blending tubes are each assembled with an auger similar to as described above in association with the tube 5622 and auger 5676, 5678 and 5680. Rollers 5762, 5764 and 5766 are arranged to engage and retain the blending tubes as shown. A pressure vessel 5768, is arranged to accommodate the group of three blending tube assemblies such that drive wheels 5770 are engaged there with and as shown and can be activated as required so as to rotate the blending tubes. Ground beef can be provided into each blending tube by similar apparatus to that disclosed above with sub-assemblies 5601 of FIG. 188. In this way, three grades of ground beef can be processed simultaneously in three continuous streams. Each of the continuous streams of conditioned ground beef can be further processed if desired.

In a preferred embodiment, a plurality of processing machines are arranged to process material such as fine ground (or coarse ground) meat, such as beef grinds. Each of the processing machines may be similar to the apparatus shown in FIG. 187. A total of three processing machines can include a first machine, a second machine, and a third machine, and can be arranged so that each processing machine can process a separate quantity of boneless beef. The first machine, may process a quantity of Item 1, the second machine, may process a quantity of Item 2 and the third machine, may process a quantity of Item 3. The first, second and third machines will therefore produce first, second and third streams of ground beef (processed material) that, after processing, will be pumped, by separate vane pumps (for delivery as required), along tubes shown as 5732 in FIG. 187.

Preferably, any number of one or more processing machines may be arranged so to provide any number of streams of processed material. Preferably, the streams of processed material may be combined and joined together in any chosen configuration, to produce one or more subsequent streams of processed material. Preferably, the velocity of each stream of material may be adjusted, so as to deliver a known and corresponding quantity of processed materials with any desired fat content as required. Preferably, the fat content and muscle content, of each stream of processed material can be continuously measured, as described herein, or in any other suitable manner. One or more streams of processed materials may be combined to produce a single stream of processed material. By adjusting the velocity and consequent delivered quantity of each stream of material (before combining together into a resultant single stream) any quantity of any processed material, such as Item 1F can be produced to a substantially constant and precise specification. The combined stream of processed materials may be further processed through a grinder and/or through processing machines such as that shown in FIG. 187. Additionally, the streams of processed materials may be directed through a tube that is exposed to sterilization such as by exposure to gamma irradiation, or any other suitable sterilizer while contained within the tube.

Subsequent to processing, the beef grinds or processed material can be retail or bulk packaged in any suitable manner, such as a substantially oxygen free modified atmosphere master package.

The packaging may be arranged to accommodate a variation in total volume of the package such as an expansion or contraction in volume. The package volume variation may occur as the temperature variation of the packaged processed material. The volume variation may correspond to the temperature variation as a result of any gases dissolved in the processed materials “boiling off” or again dissolving in direct relationship to the temperature variation. Accommodation of the variation in package volume may be achieved by provision of a suitably sized, flexible, substantially gas barrier package.

Referring again to end enclosures 5602 and 5604 shown in FIG. 187, suitably located apertures shown as 5736, are provided therein so as to allow free movement of gas therethrough. The velocity of the gas can then be controlled by blower 5648 and along a path through tube 5622, into the spaces shown as 5738 and back through space 5636. Preferably, the velocity and temperature and pressure of the gas can then arranged at the most effective settings to control the temperature of the ground beef and the rate of gas dissolving therein.

Referring now to FIG. 194 and particularly, end enclosure 5604, a member shown as 5738 is arranged to mate with member 5604 at a close contacting face shown as 5740. Members 5604 and 5738 are in contact at interface 5740, and fixed relative to each other but not locked together. Member 5738 can move relative to 5604 but is retained by interface 5740 and shafts shown as 5670 and 5674 (and 5672, which is not shown). Suitable bearing surfaces are provided between 5738 and 5604 and also between 5738 and 5676, 5678 and 5680. Sub assembly 5601 is arranged so as to be removable for cleaning purposes and plugs may be inserted into the connecting apertures created by removing sub-assembly 5601. When 5601 is removed and replaced with the plugs, member 5738 can be moved away from tube 5622 by sliding along shafts 5676, 5678 and 5680 so as to provide a space between member 5738 and the end rim of tube 5622. Preferably, such an arrangement may be installed at either or both end enclosures of the apparatus in such a manner so as to facilitate effective cleaning of apparatus after use. Other cleaning features may be incorporated into the apparatus. Preferably, pressurized and heated water may be provided inside the apparatus with suitable sanitizing detergents in such a manner so as to facilitate an automatic cleaning when augers 5676, 5678 and 5680 and tube 5622 are all rotated in common or opposing directions and at suitable speeds. Alternatively or additionally high pressure steam may be provided inside the apparatus to facilitate sterilization and thorough cleaning of the internal surfaces of the apparatus. Draining/venting tubes such as 5742 can be provided with valves, at any suitable and convenient location on the apparatus.

Lean Muscle and Fat Measuring Apparatus

A lean tissue and fat analyzer is an optional feature of the meat processing system. Referring now to FIG. 189, a cross sectional view of the conduit of FIG. 188 is shown as a square or rectangular tube 5730. Preferably, tube 5730 and tube 5702 are similar. Tube 5730 can be manufactured from any suitable material which includes plastics as well. Preferably, two electrodes, shown as 5710 and 5712 are located on opposing internal sides of tube 5730 and attached to terminals. Electrode 5710 is attached to terminal 5714 and electrode 5712 is attached to terminal 5716. An electrical current can be arranged to flow through terminals 5714 and 5716 and into electrodes 5710 and 5712. Ground beef (ground meat) is shown as 5715 and in this way, will directly contact the electrodes as it passes through tube 5730. The electrical current can therefore pass through ground beef from electrode 5712 and to electrode 5710. Electrical current will be affected by the resistance of the ground beef and this resistance will vary according to the ratio of fat and muscle content of the ground beef and therefore the electrical resistance can be measured. The variation in electrical resistance can be measured and such measurements can be converted and used to determine the ratio of fat and muscle contained in the ground beef in a continuous process. Tube 5730 with terminals and electrodes together include a measuring device shown as 5718. Preferably, the measuring device may be installed, and used to measure the ground beef fat and muscle content ratio, at any convenient location as may be required.

Meat Grinder Sub-Assembly

A meat grinder sub-assembly is an optional feature of the meat processing system. Several embodiment of a meat grinder have been previously described. However, a meat grinder preferably for use with the processing machine follows.

Referring now to FIG. 193, a meat grinder sub-assembly according to the present invention is shown. The sub-assembly includes a pressure vessel 5684, with an entry port 5686 at an upper location and an exit port 5688 at a lower location. A horizontally disposed and tapered auger 5690 is located in a lower portion of vessel 5684 and arranged with a shaft 5692 that can be attached directly to a suitable variable speed driver. Preferably, the tapered auger is suitably profiled and is fitted with passageways therein to allow any suitable gas to be injected therethrough. A meat grinding apparatus is attached directly to the entry port 5686 and can be disconnected therefrom to provide access for cleaning as required. Boneless meat portions can be processed by grinder 5694 to produce grinds which are then transferred directly into vessel 5684 in a continuous stream. Preferably, the cross-sectional profile of vessel 5684 is circular and a valve member 5696 is arranged to mate with a valve seat 5698, which is located between the entry port 5686 and the auger 5690, to provide a gas tight seal when required. Valve member 5696 can be opened and closed by valve stem 5697 as required and arranged to automatically close as required for any reason. Ground beef that is transferred into vessel 5684 can contact auger 5690. Preferably, any suitable gas at any suitable pressure can be injected into vessel 5684 through ports 5700 and/or 5702. Each port such as 5702 and 5700 is fitted with suitable valve and pressure regulator. As desired, gas can be injected into a port such as port 5702 and allowed to exit through a port such as 5700. Pressure regulators maintain a desired gas at any suitable pressure in the vessel 5684. In this way, the continuous stream of ground beef can be transferred through the vessel 5684 by auger 5690 at a desired rate and pressure. As the ground beef is transferred through vessel 5684 by tapered auger 5690, the ground beef is compressed and extruded through a restriction as shown, so as to exclude gas and produce a substantially continuous flow of ground beef without gas bubbles contained therein. In this way the compressed ground beef can provide an effective gas tight sealing between vessel 5684 and vessel 5624 of FIG. 187. The continuous flow of ground beef is passed through a tube section 5702 at a desired and controlled rate. After passing through tube 5702 the ground beef passes through the exit port 5688 and can be directed into any suitable container such as tube 5622 shown in FIG. 187. If desired, a secondary grinder may be interposed between the vessel 5684 and a valve 5706. Valve 5706 is provided at the exit port 5688 and can be arranged with an automatic actuator to open and close at a remote distance as may be required for any reason. When in a closed position valve 5706 can seal the exit port 5688 in a gas tight manner. As the ground beef passes through tube section 5702, the fat and muscle content of the ground beef can be measured. The measuring device may include the passing of an electric current through the ground meat as it passes through the section 5702. Preferably, the electrical resistance is measured and a muscle and fat concentration can be obtained.

Meat Pre-Conditioning System

Referring now to FIGS. 196-197, a plan view and a side elevation view of an apparatus designed to slice meat while conditioning in an oxygen free environment is shown. The apparatus is shown in diagrammatic form and includes a continuous conveyor 5100, with a driver mounted to a rigid frame (not shown) and horizontally disposed to allow horizontal motion in a machine direction in intermittent or continuous movement. The conveyor is fitted with two corresponding and vertically opposed pairs of pressure chambers includes an upper chamber 5102 with a corresponding lower chamber 5104 and another upper chamber 5106 with a corresponding lower chamber 5108. An enclosed gassing tunnel 5118 is arranged to enclose the upper section of the conveyor 5100 with a gassing port 5112 affixed thereto to provide any suitable gas, such as nitrogen gas or carbon dioxide, into the tunnel 5118.

Referring now to upper chamber 5102 and corresponding lower chamber 5104 the opposing chambers are arranged so as to open and close. Upper chamber 5102 is mounted to a driver (not shown) to provide elevating, lowering and clamping apparatus. Lower chamber 5104 is also mounted to a separate driver (not shown) to provide elevating, lowering and clamping. Chambers 5102 and 5104 can be closed together by moving in opposing directions so as to contact each other along a path around the perimeter of openings. In this way a single chamber is so arranged in a manner that is airtight and sealed from external atmosphere. An evacuation port 5114 and a gas port 5116 are provided so as to allow evacuation and gas flushing of the closed chamber. As shown in FIG. 196 two separate pressure chamber assemblies are arranged such that conveyor 5100 passes through both chamber assemblies. Trays with sliced beef or other meat primal, placed therein, are located into carrier plates in conveyor 5100. The primals are sliced in a suitable manner and can then be opened so as to expose the multiple surfaces of the slices immediately prior to entry into enclosed tunnel 5118. Enclosed tunnel 5118 is arranged so as to substantially exclude atmospheric oxygen gas by flushing other suitable gases therein. The trays with sliced primal 5122 are located in carrier plates and progressively move through enclosed tunnel 5118 until each tray with primal is located directly between an upper chamber 5102 and lower chamber 5104. The upper and lower chambers close together and around the sliced primal 5122 in an airtight and sealed manner. Substantially all air is evacuated from the chambers and a suitable gas, including carbon dioxide, is injected through port 5116. The suitable gas pressure can be increased to any suitable pressure as desired. The primal 5122 can be retained in the pressure chambers for a desirable period of time so as to cause sufficient carbon dioxide gas to dissolve in the oils and water contained in the primal 5122. After the primal 5122 has been exposed to the high pressure carbon dioxide gas for a suitable period of time, the pressure chambers open and allow conveyor 5100 to carry sliced primal 5122 in tray, forward in machine direction and through the enclosed tunnel 5118. A second pressure chamber assembly may also be closed around the sliced primal 5122 in tray. Any suitable gas at any suitable pressure can be provided in the second enclosed chamber. Second chamber includes an evacuation port 5115 and a gassing port 5117. The sliced primal 5122 in tray is intermittently carried through the tunnel 5118 until it emerges at the exit end of the tunnel.

In this way, rapid formation of oxymyoglobin is inhibited when the primal 5122 is exposed to ambient atmosphere.

Plant Layout

Having described meat grinding systems and ancillary equipment, it is appropriate to describe the integration of equipment to form a whole production facility for processing and packaging meats.

Referring now to FIG. 198, a plan view of a preferred production plant layout is shown, including ground meat processing, blending equipment and retail packaging plant. The equipment shown in FIG. 198 is represented by diagrammatic sketches and is integrated such that ground beef processed by the equipment shown can be transferred directly from grinders 6400, 6402 and 6404 into oxygen free vessels shown as 6408, 6410 and 6412, respectively.

The chart set out below provides a list of equipment shown in FIG. 198.

| ID | Item |
|---|---|
| 6400 | Grinder |
| 6402 | Grinder |
| 6404 | Grinder |
| 6406 | Grinder (Fine) |
| 6408 | Vessel + Mix |
| 6410 | Vessel + Mix |
| 6412 | Vessel + Mix |
| 6414 | Vessel/Hopper |
| 6416 | Vessel/Hopper |
| 6418 | Vessel/Hopper |
| 6420 | Positive displ. pump |
| 6422 | Positive displ. pump |
| 6424 | Positive displ. pump |
| 6426 | Positive displ. pump |
| 6428 | Measure fat/lean |
| 6430 | Measure fat/lean |
| 6432 | Measure fat/lean |
| 6434 | Continuous blending |
| 6436 | Control Panel |
| 6438 | Valve (diversion) |
| 6440 | Elevator |
| 6442 | Elevator |
| 6444 | Discharge Ports |
| 6446 | Discharge Ports |
| 6448 | Discharge Port |
| 6450 | Magazine |
| 6452 | Gas Exchange |
| 6454 | Tray Welding |
| 6456 | Grinds Portioning machine |
| 6458 | RT 1800 Packaging Machine |
| 6460 | Horizontal Vacuum |

Boneless beef with a suitable fat/lean composition is loaded into grinders 6400, 6402 and 6404. Ground beef is produced by grinders 6400, 6402 and 6404 and transferred directly into enclosed vessels 6408, 6410 and 6412 that are otherwise filled with a suitable gas at a suitable pressure.

Vessels 6408, 6410 and 6412 can be fitted with blending apparatus so as to blend grinds therein. Positive displacement pumps 6420, 6422 and 6424 pump quantities of grinds, in three respectively separate streams from vessels 6408, 6410 and 6412 directly into continuous blender CB. The quantity of grinds pumped by the positive displacement pumps in the separate streams is controlled and dictated by the measured fat and lean content of each stream of grinds. Fat and lean content of each stream of grinds is measured by measuring devices shown as 6428, 6430 and 6432. Continuous blender 6434 terminates at positive displacement pump 6424 and blended grinds are transferred directly from 6434 into 6424. Pump 6424 can transfer the blended grinds in a single continuous stream into either vessel 6418 or vessel 6416.

Grinds can be stored in vessels 6416 and 6418 as may be required. The grinding, pumping, measuring and blending apparatus can be arranged so as to produce a single stream of grinds by combining three separate streams into a single stream in continuous blender 6434. The single continuous stream of blended grinds can be produced according to a specification such as 85% lean and 15% fat. Alternatively, single stream of blended grinds can be produced according to any other desired specification such as 90% lean and 10% fat. In this way two separate quantities of specified grinds can be stored with one in each of vessels 6416 and 6418. For example, a quantity of 85% lean and 15% fat grinds can be stored in vessel 6416 and a quantity of 90% lean and 10% fat grinds can be stored in vessel 6416. Suitable positive displacement pumps can be arranged to transfer specified quantities of grinds from either or both vessels 6416 and 6418 for separate or combined grinding in a grinder such as is shown as 6406 is FIG. 198. Any suitable number of pumps can be arranged to transfer grinds from either of the vessels 6416 and 6418 for further blending and/or grinding and subsequent retail packaging in packaging machine shown as 6458. If required suitable blending equipment can be provided for blending of any suitable number of additional pairs of streams of grinds, in selected quantities, after pumping from vessels 6416 and 6418 to produce specified quantities of blended grinds that can then be fine ground prior to retail packaging.

In this way, ground meat can be processed and packaged while being contained within a series of vessels and tubes that are filled with ground meat and suitable gas that substantially excludes oxygen and any other undesirable gas and/or material. Therefore, formation of oxymyoglobin on substantially all freshly cut meat surfaces can be inhibited until after packaging and immediately prior to retail display or other desired use.

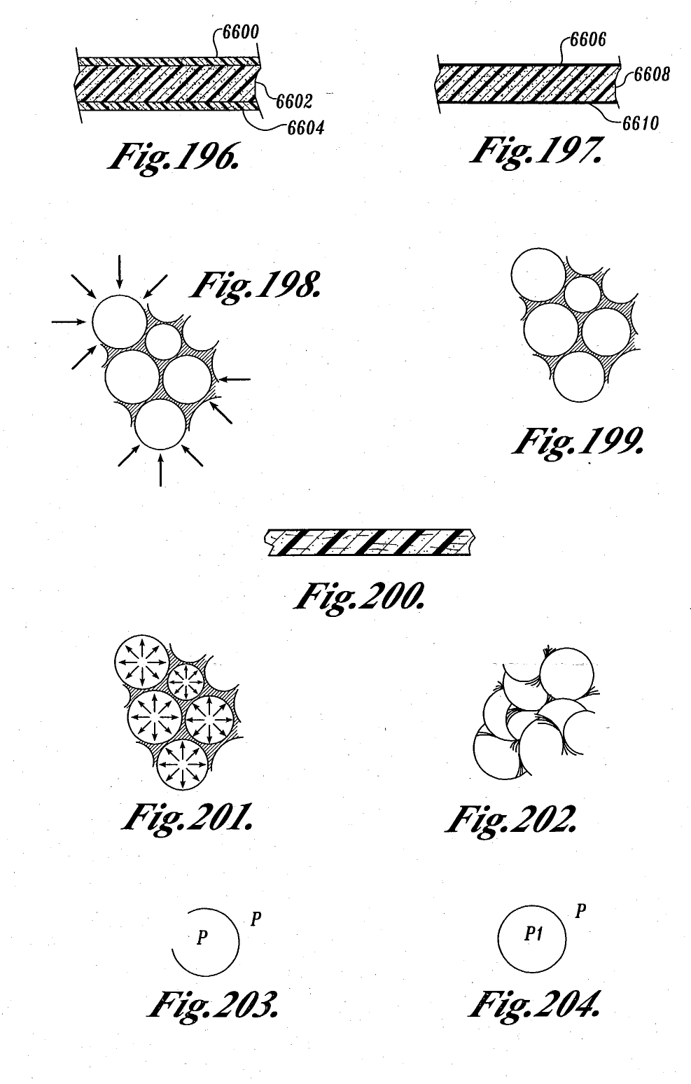

Referring now to FIG. 199, a plan view of another preferred production plant layout is detailed including production and packaging equipment.

A preferred layout includes items of equipment in the table below and identified by a reference numeral.

TABLE 3

| Item # | Production Equipment | | Packaging equipment |
|---|---|---|---|
| 5900 | Grinding machine | 5960 | Chub/vacuum packaging |
| | | | machine |
| 5902 | Grinding machine | 5930, | Ground beef portioning |
| | | 5932, | machines |
| | | 5934 | |
| 5904 | Grinding machine | 5940, | Over wrapping packaging |
| | | 5938, | machines |
| | | 5936 | |
| 5906 | Ground beef processing | 5954, | Foam tray erecting machines |
| | machine | 5956, | |
| | | 5958 | |
| 5908 | Ground beef processing | 5924, | Conveyor belts |
| | machine | 5926, | |
| | | 5928 | |
| 5910 | Ground beef processing | | |
| | machine | | |
| 5922 | Ground beef processing | | |
| | machine | | |
| 5942 | Gas blower with heat | | |
| | exchanger. | | |
| 5912 | Ground beef Injector | | |
| 5914 | Ground beef Injector | | |
| 5916 | Ground beef Injector | | |
| 5944 | Ground beef Injector | | |
| 5946 | Vane pump | | |
| 5948 | Vane pump | | |
| 5950 | Vane pump | | |
| 5952 | Vane pump | | |
| 5918 | Multi-tube combining die | | |
| 5920 | Electron beam sterilizer | | |
| | and/or grinder | | |

Preferably, the equipment shown in FIG. 199, and listed above, is arranged to continuously produce and retail package, case ready ground meats. Quantities of specified boneless beef raw materials are processed by grinding machines 5900, 5902 and 5904 to produce grinds that are transferred directly into ground beef processing machines 5906, 5908 and 5910 via corresponding injector machines 5912, 5914 and 5916. Each grinder processes a quantity of specified boneless beef raw materials each of which may be selected from the following table of raw materials Item 1 through Item 5.

TABLE 4

| Item | Muscle Tissue | Fat Tissue |
|---|---|---|
| 1 | 93% | 7% |
| 2 | 90% | 10% |
| 3 | 75% | 25% |
| 4 | 65% | 35% |
| 5 | 50% | 50% |

Equipment shown as vessels 5906, 5908 and 5910 is arranged to process grinds as above described apparatus shown in FIG. 187. Grinds are injected into vessels from the grinders 5900, 5902 and 5904 by injectors 5912, 5914 and 5916 which are arranged to operate as the above described apparatus shown in FIG. 193. Conditioned grinds are transferred in a single continuous stream from each vessel, by a pump from vessels into transfer tubes which are then combined at confluence 5918 into a single tube. Confluence 5918 includes a manifold generally as the above described apparatus shown in FIG. 191.

Preferably, the fat content of the continuous streams of grinds is continuously measured by measuring devices as the above described apparatus shown in FIG. 194. Preferably, the fat content of the grinds can be continuously measured before injection into the vessels and immediately after transfer from the vessels and into the transfer tubes. Preferably by measuring the fat content and automatically adjusting the flow rate of each stream of grinds, directly and according to the measured fat content, prior to combining the streams of grinds, a combined stream of grinds with consistent fat content can be produced. The combined stream is then transferred via a tube into a single grinder shown as 5920. An electron beam generator of suitable capacity may be integrated such that the combined stream of grinds passes therethrough prior to injection directly into vessel 5922. Vessel 5922 may be arranged to process grinds as the above described apparatus shown in FIG. 187. A single stream of conditioned grinds is then transferred into a single tube that is divided into four separate streams of grinds.

Still referring to FIG. 199, the preferred plant layout includes four packaging systems and a single supply stream of grinds is transferred to each of the packaging systems. Preferably, one stream to “chub/vacuum” packaging machine. Preferably, apparatus constructed according to the present invention includes three packaging machines 5924, 5926, and 5928, and a single stream of grinds to each of three portioning machines, shown as 5930, 5932, and 5934, respectively. Portions of grinds are then retail packaged by automatic loading into trays which are then over wrapped by packaging machines shown as 5936, 5938, and 5940. While, an embodiment has been described and shown to include three processing trains, any suitable number of processing trains may be used in accordance with the present invention, which may include more or less than the three trains herein described.

The equipment as described herein may be arranged to automatically produce any quantities of coarse or fine grinds according to any specifications. The following table shows the specified muscle and fat tissue content of three types of fine beef grinds.

TABLE 5

| Item | Muscle Tissue | Fat Tissue |
|---|---|---|
| 1F | 90% | 10% |
| 2F | 75% | 25% |
| 3F | 65% | 35% |

Equipment as described herein may be arranged to grind, measure, condition, blend, process and package specified portions of grinds according to any suitable size by automatically computer controller. The computer controller may continuously provide production information including such data as the total fat and muscle tissue content of each and all streams of grinds during the processing. In this way, a method to improve efficiency and reduce total losses is provided by producing grinds to meet precise specifications according to, for example, the list of fine beef grinds shown above.

Plant Layout

Referring now to FIGS. 200 and 201, another preferred production plant layout including ground meat processing and blending equipment and a preferred CAP retail packaging plant layout including packaging equipment is shown. The equipment shown in FIGS. 200-201 is integrated such that ground beef processed by equipment shown in FIG. 200 is packaged in packaging that is processed by equipment shown in FIG. 201. The present invention provides for a method of grinding meats directly into an oxygen free vessel or hopper and then blend and process the ground meat as described herein. The present invention also provides a method of saturating the liquids, water and oils in the ground meats with a suitable gas or substance such as carbon dioxide, provided at a suitable pressure, to such a level that when removed from the processing equipment the ground meat will emit a suitable gas such as carbon dioxide.

Items of equipment shown in FIGS. 200-201 that are identified by letters and/or numbers are listed in the following table set out below:

| Item # | Production Equipment | | Packaging equipment |
|---|---|---|---|
| 6006 | Conveyor (with variable speed | 6122 | Magazine |
| | control) | | |
| 6008 | Conveyor (with variable speed | 6124 | Magazine |
| | control) | | |
| 6010 | Conveyor (with variable speed | 6126 | Magazine |
| | control) | | |
| 6018 | Conveyor (with variable speed | 6128 | Tray material evacuation & |
| | control) | | gassing |
| 6020 | Conveyor (with variable speed | 6130 | Tray material evacuation & |
| | control) | | gassing |
| 6022 | Conveyor (with variable speed | 6132 | Tray material evacuation & |
| | control) | | gassing |
| 6034 | Conveyor (with variable speed | 6134 | Tray flap erection & welding |
| | control) | | |
| 6036 | Conveyor (with variable speed | 6136 | Tray flap erection & welding |
| | control) | | |
| 6030 | Ultra violet sterilization equipment | 6138 | Tray flap erection & welding |
| 6032 | Ultra violet sterilization equipment | 6140 | Conveyor |
| 6038 | Grinding machine | 6142 | Conveyor |
| 6040 | Grinding machine | 6144 | Conveyor |
| 6100 | Grinding machine | 6116 | Ground beef portioning machine |
| 6104 | Grinding machine | 6118 | Ground beef portioning machine |
| 6108 | Grinding machine | 6120 | Ground beef portioning machine |
| 6046 | Tube connection | 6146 | Conveyor |
| 6050 | Tube connection | 6148 | Conveyor |
| 6048 | Ground beef hopper | 6150 | Conveyor |
| 6052 | Ground beef hopper | 6000 | Over wrapping packaging |
| | | | machines |
| 6058 | Ground beef hopper | 6002 | Over wrapping packaging |
| | | | machines |
| 6064 | Ground beef hopper | 6004 | Over wrapping packaging |
| | | | machines |
| 6056 | Statiflo blender | | |
| 6062 | Statiflo blender | | |
| 6090 | Statiflo blender | | |
| 6092 | Statiflo blender | | |
| 6094 | Statiflo blender | | |
| 6096 | Gas injection ports. | | |
| 6054 | Positive displacement pump | | |
| 6060 | Positive displacement pump | | |
| 6066 | Positive displacement pump | | |
| 6068 | Positive displacement pump | | |
| 6070 | Positive displacement pump | | |
| 6072 | Positive displacement pump | | |
| 6074 | Positive displacement pump | | |
| 6076 | Positive displacement pump | | |
| 6078 | Epsilon GMS-40 | | |
| 6084 | Epsilon GMS-40 | | |
| 6080 | Epsilon GMS-40 | | |
| 6086 | Epsilon GMS-40 | | |
| 6082 | Epsilon GMS-40 | | |
| 6088 | Epsilon GMS-40 | | |
| | Electron beam sterilizer and/or | | |
| | grinder | | |

The equipment shown in FIGS. 200-201 is listed above and is arranged to automatically and continuously produce selected grades of retail packaged, case ready ground meats. The ground meats may include quantities of muscle and fat tissue such as shown in the following chart, where item 1F includes ground meat with about 90% muscle tissue and about 10% fat tissue, with a muscle to fat tissue variation within about +/−0.2%. The packaging equipment shown in FIG. 201 can be arranged so that the packaging machine 6000 will produce CAP case ready packages containing ground meats according to a specification equivalent to item 1F. Similarly, packaging machine 6002 can produce CAP case ready packages containing ground meats according to a specification equivalent to item 2F and packaging machine 6004 can produce CAP case ready packages containing ground meats according to a specification equivalent to item 3F in TABLE 7.

TABLE 7

| Item | Muscle Tissue | Fat Tissue | Muscle/Fat Tissue Variation |
|---|---|---|---|
| 1F | 90% | 10% | +/−0.2% muscle content |
| 2F | 85% | 15% | +/−0.2% muscle content |
| 3F | 80% | 20% | +/−0.2% muscle content |

Referring again to FIG. 200, variable speed conveyors 6006, 6008 and 6010 are preferably arranged in close and parallel proximity such that each conveyor can carry specified quantities of selected boneless beef. In this way conveyor 6006 can be arranged to carry specified quantities of raw material, which may be boneless beef selected from the chart shown below, in a direction indicated by arrow 6012, conveyor 6008 can be arranged to carry specified quantities of selected boneless beef in a direction indicated by arrow 6014 and conveyor 6010 can be arranged to carry specified quantities of selected boneless beef in a direction indicated by arrow 6016. The specified quantities of selected boneless beef can be varied between the conveyors marked 6006, 6008 and 6010 such that 6006 carries selected boneless beef shown as 2X, in TABLE 8, conveyor 6008 carries selected boneless beef shown as 3X and conveyor 6010 also carries the selected boneless-beef shown as 3X.

Preferably, variable speed conveyors 6018, 6020 and 6022 are arranged in close and parallel proximity such that each conveyor can carry specified quantities of selected boneless beef. In this way conveyor 6018 can be arranged to carry specified quantities of raw material, which may be boneless beef selected from TABLE 8, in a direction indicated by arrow 6024, conveyor 6020 can be arranged to carry specified quantities of selected boneless beef in a direction indicated by arrow 6026 and conveyor 6022 can be arranged to carry specified quantities of selected boneless beef in a direction indicated by arrow 6028. The specified quantities of selected boneless beef can be varied between the conveyors marked 6018, 6020 and 6022 such that conveyor 6018 carries boneless beef shown as 1X in TABLE 8, conveyor 6020 carries boneless beef also shown as 1X and conveyor 6022 carries boneless beef shown as 2X.

TABLE 8

| Item | Muscle Tissue | Fat Tissue | Muscle/Fat Tissue Variation |
|---|---|---|---|
| 1X | 99% | 1% | +1%/−3% muscle content |
| 2X | 93% | 7% | +/−3% muscle content |
| 3X | 75% | 25% | +/−3% muscle content |

TABLE 8

| Item | Muscle Tissue | Fat Tissue | Muscle/Fat Tissue Variation |
|---|---|---|---|
| 1X | 99% | 1% | +1%/−3% muscle content |
| 2X | 93% | 7% | +/−3% muscle content |
| 3X | 75% | 25% | +/−3% muscle content |

Preferably, the variable speed conveyors 6006, 6008 and 6010 can be arranged in close and parallel proximity and located inside an ultra violet light (UV) tunnel shown as 6030 in FIG. 200. Tunnel 6030 can be arranged so as to expose any of the selected boneless beef to sufficient UV light so as to substantially sterilize the surfaces of the boneless beef. A suitable device of turning and/or rotating the boneless beef can be provided in the tunnel, so as to ensure that substantially all external surfaces of the boneless beef are exposed to the UV light to ensure the sterilization of the surfaces. Similarly, the variable speed conveyors 6018, 6020 and 6022 can be arranged in close and parallel proximity and located inside an ultra violet light (UV) tunnel shown as 6032 in FIG. 200. Tunnel 6032 can be arranged so as to expose any of the selected boneless beef to sufficient UV light so as to substantially sterilize the surfaces of the boneless beef. A suitable method of turning and/or rotating the boneless beef can be provided in the tunnel, so as to ensure that substantially all external surfaces of the boneless beef are exposed to UV light to ensure sterilization of surfaces.

Preferably, the variable speed conveyors 6006, 6008, 6010, 6018, 6020, and 6022 can be provided with independent drivers and arranged to pass through a tunnel with a device to independently measure the fat and muscle content of the boneless beef carried on each individual and separate conveyor. Any suitable method of measuring the fat and muscle content of the boneless beef may be integrated with the conveyors 6006, 6008, 6010, 6018, 6020, and 6022 so as to provide a method of separate and continuous measurement of the fat and muscle content of the boneless beef separately carried on each conveyor. Preferably, the variable speed conveyors 6006, 6008, and 6010 can be arranged to converge and deposit the boneless beef, carried by each independent conveyor onto a conveniently located secondary conveyor shown as 6034 in FIG. 200. Similarly, the variable speed conveyors 6018, 6020, and 6022 can be arranged to converge and deposit the boneless beef, carried by each independent conveyor onto a conveniently located secondary conveyor shown as 6036 in FIG. 200. Preferably, the speed of each conveyor can be varied in direct relationship to the variation of measured fat and muscle content of the boneless beef carried by each conveyor.

Preferably, the length of the variable speed conveyors 6006, 6008, 6010, 6018, 6020, and 6022 can be extended so as to allow operators, such as carcass disassembly workers, to deposit the boneless beef raw material thereon immediately after disassembly and separation from an animal carcass source of the boneless beef. Furthermore, the carcass disassembly workers can, for example adjust the fat content of boneless beef that is deposited onto each of the conveyors 6006, 6008, 6010, 6018, 6020, and 6022 according to requirements. More specifically, if it is determined by the fat measuring device that a reduced quantity of fat and an increased relative quantity of muscle (lean) tissue is required on any particular conveyor, this can be accommodated. Conversely, if it is required to deposit an increased relative quantity of muscle tissue onto any particular conveyor, this also, can be accommodated. In this way, the fat and lean content of the boneless beef that is deposited onto each of the individual conveyors can be adjusted to suit requirements which can be determined by the fat content measuring method through which each of the conveyors can be arranged to pass. Preferably, boneless beef can be deposited onto variable speed conveyors 6006, 6008, and 6010 according to requirements and by varying the speed of each conveyor and therefore the quantity of boneless beef carried and deposited onto conveyor 6034, a combined stream of boneless beef including fat and muscle tissue with a desired and constant relative ratio can be produced and carried on the conveyor 6034. Similarly, with variable speed conveyors 6018, 6020, 6022, boneless beef can be deposited onto each conveyor according to requirements and by varying the speed of each conveyor and therefore the quantity of boneless beef carried and deposited onto conveyor 6036, a combined stream of boneless beef, carried on conveyor 6036 and including fat and muscle tissue with a desired and constant relative ratio, can be produced and carried on the conveyor 6036.

Referring again to FIG. 200 and in particular to conveyor 6034, it can be seen that boneless beef carried on 6034 will be carried and deposited into meat grinder 6038. Similarly, it can be seen that boneless beef carried on conveyor 6036 will be carried and deposited into meat grinder 6040. By adjusting the ratio of fat and muscle content of boneless beef carried on each conveyor 6006, 6008, and 6010 and adjusting the speed and therefore the volume of boneless beef carried on each conveyor, a single stream, indicated as stream 6042 in FIG. 201, of boneless beef including fat and muscle tissue of a desired ratio can be provided and carried forward on conveyor 6034. Similarly, by adjusting the ratio of fat and muscle content of boneless beef carried on each conveyor 6018, 6020, 6022 and adjusting the speed and therefore the volume of boneless beef carried on each conveyor 6018, 6020, and 6022, a single stream, indicated as stream 6044 in FIG. 201, of boneless beef including fat and muscle tissue of a desired ratio can be provided and carried forward on conveyor 6036.

Preferably, in this way, boneless beef stream 6042 may include boneless beef with a fat and muscle content of about 95% lean muscle and about 5% fat with a fat content variation of about +/−0.3%. Preferably, boneless beef stream 6044 may include boneless beef with a fat and muscle content of about 80% lean muscle and about 20% fat with a fat content variation of about +/−0.3%.

Boneless beef stream 6042 is carried forward by conveyor 6034 and deposited into grinder 6038. Conveyor 6034 and grinder 6038 may be enclosed inside a substantially sealed outer covering with a suitable gas such as nitrogen contained therein in such a manner so as to substantially exclude ambient air from presence therein. The boneless beef carried in stream 6042 is ground in the grinder 6038 and transferred through tube 6046 and into hopper 6048. It can also be seen that the boneless beef stream 6044 is carried forward by conveyor 6036 and deposited into grinder 6040. The conveyor 6036 and grinder 6040 may also be enclosed inside a substantially sealed outer covering with a suitable gas such as nitrogen contained therein in such a manner so as to substantially exclude ambient air from presence therein. The boneless beef carried in 6044 is ground in grinder 6040 and transferred through tube 6050 and into hopper 6052.

Stream 6042 of ground beef is then transferred by a pump, such as a positive displacement pump 6054, from hopper 6048 into and through static blending tube 6056 and into hopper 6058. Stream 6044 of ground beef is then transferred by a pump, such as a positive displacement pump 6060, from hopper 6052 into and through static blending tube 6062 and into hopper 6064. Preferably, positive displacement pumps 6054 and 6060 can be fitted with variable speed drivers Hoppers 6058 and 6064 can be substantially filled with a suitable gas such as carbon dioxide or any other suitable substance, and both hoppers 6054 and 6060 are arranged to have an adequate capacity to accommodate any quantity variations in normal production of boneless beef that may result from any variable requirement.

Hopper 6058 is connected with three positive displacement pumps shown as 6066, 6068 and 6070. Preferably, any number of pumps may be provided and connected to hopper 6058. Similarly, hopper 6064 is connected with three positive displacement pumps shown as 6072, 6074 and 6076. Preferably, any number of pumps may be provided and connected to hopper 6064. Preferably, each of the positive displacement pumps shown as 6066, 6068 and 6070 can be fitted with suitable, independently controlled, variable speed drivers such that any required quantity of ground boneless beef contained in hopper 6058 can be pumped therefrom at a desired velocity, and through a measuring device, such as the Epsilon GMS-40 shown as 6078, 6080 and 6082. Similarly, each of the positive displacement pumps shown as 6072, 6074 and 6076 can preferably be fitted with suitable independently controlled, variable speed drivers such that any required quantity of ground boneless beef contained in hopper 6064 can be pumped therefrom and through a measuring device, such as the Epsilon GMS-40 shown as 6084, 6086 and 6088.

The Epsilon GMS-40-40 Meat Analyzer is a fat measuring device and is commercially available from Epsilon Industrial, 2215 Grand Avenue Parkway, Austin, Tex. 78728. Specifications for the GMS-40 are available from this supplier and information is also available from their web site at www.epsilon-gms.com. While this component is specified herein, other suitable fat measuring devices can be used as an alternate for fat and/or muscle content measurement.

As can be seen in FIG. 200, Epsilon GMS-40 measuring devices shown as 6078 and 6084 are preferably attached directly to junction box X, Epsilon GMS-40 measuring devices shown as 6080 and 6086 are preferably attached directly to junction box Y and Epsilon GMS-40 measuring devices shown as 6082 and 6088 are attached directly to junction box Z. Suitably sized tubes connect pumps directly to corresponding Epsilon measuring devices as shown. The fat content of ground beef that is pumped by pump 6066 through the connecting tube and directly through Epsilon GMS-40 measuring device 6078, is measured by device 6078. The fat content of ground beef that is pumped by pump 6072 through the connecting tube and directly through Epsilon GMS-40 measuring device 6084, is measured by device 6084. The ratio and percentage quantity of fat in each separate stream of ground beef pumped by pumps 6066 and 6072 can therefore be measured and compared and the pumping rate of pumps 6066 and 6072 can be automatically adjusted according to the respective fat content of each stream of ground beef so as to provide a single stream of ground beef, after combining in junction box X, with a desired fat content. In this way selected quantities of boneless ground beef can be pumped directly from hopper 6058, containing ground beef from stream 6042 and hopper 6064, containing ground beef from stream 6044, by pumps 6066 and 6072 respectively and through Epsilon GMS-40 measuring devices shown as 6078 and 6084 into junction box X. Similarly, selected quantities of boneless ground beef can be pumped directly from hopper 6058, containing ground beef from stream 6042 and hopper 6064, containing ground beef from stream 6044, by pumps 6068 and 6074 respectively and through Epsilon GMS-40 measuring devices shown as 6080 and 6086 into junction box Y. Preferably, selected quantities of boneless ground beef can be pumped directly from hopper 6058, containing ground beef from stream 6042 and hopper 6064, containing ground beef from stream 6044, by pumps 6070 and 6076 respectively and through Epsilon GMS-40 measuring devices shown as 6082 and 6088 into junction box Z.

Preferably, selected quantities of ground meat from stream 6042 and stream 6044 can be combined in junction boxes X, Y and Z. By varying the pumping rate of variable speed positive displacement pumps 6066 and 6068, a selected blend of ground beef, with a pre-determined and known ratio of fat to lean muscle tissue, can be pumped into junction box X. The fat content of the selected blend of ground beef pumped into junction box X may be, for example, about 10% +/− about 0.3%. Alternatively, the fat content of the selected blend pumped into junction box Y may be, for example, about 15% +/−0.3% and the fat content of the selected blend pumped into junction box Z may be, for example, about 17% +/− about 0.3%. By processing ground meats in this way, the fat content of any given production quantity of selected ground beef can be controlled within a narrow margin of variation, such as about +/− about 0.3% and the muscle and fat content selected as desired by adjusting the fat content of raw materials that are deposited onto conveyors 6006, 6008, 6010, 6018, and 6020 accordingly. Furthermore, the energy required to blend the ground beef in the methods described herein is much less than is typically required to produce ground meats using currently common industry practice.

The selected ground beef blend that is pumped into junction box X by way of two streams from pumps 6066 and 6072 is then transferred through blender 6090. The selected ground beef blend that is pumped into junction box Y by way of two streams from pumps 6068 and 6074 is then transferred through blender 6092. The selected ground beef blend that is pumped into junction box Z by way of two streams from pumps 6070 and 6076 is then transferred through blender shown as 6094.

Blender 6056, 6062, 6092, and 6094 are all conveniently arranged with gas injection ports shown as 6096. Preferably, gas injection ports 6096 are arranged to provide suitable gas, such as carbon dioxide, into blenders in such a way as to ensure that all ground meat that is pumped through the blenders is exposed to gas as desired and to an extent that will, for example, ensure that ground meat is saturated with dissolved suitable gas as required. Blenders 6056, 6062, 6090, 6092, and 6094 may include suitably sized continuous static mixing equipment such as may be supplied by Statiflo International, Macclesfield, Cheshire, UK. Preferably, any continuous blender may be integrated and located where indicated in FIG. 200 by blender reference numerals 6056, 6062, 6090, 6092 and 6094 or in any desired configuration that will ensure blending of ground meats as required.

The process described in association with FIGS. 200-201 shows a combination of equipment that is configured to preferably produce a first 6042 and a second 6044 stream of ground meat. Stream 6042 and stream 6044 are provided by measuring the fat content of two pair of three streams of boneless meat where streams 6012, 6014 and 6016 converge into a first stream 6042 and where streams 6024, 6026, and 6028 converge into a second stream 6044.

Preferably, the fat and muscle (lean) meat content of stream 6042 is determined by the following factors: The total quantity of boneless meat deposited onto the conveyors that include the streams 6012, 6014, and 6016 and the fat and muscle content of the boneless meat. The velocity of the streams 6012, 6014, and 6016.

Correspondingly, the fat and muscle (lean) meat content of stream 6044 is determined by the following factors: The total quantity of boneless meat deposited onto the conveyors that include the streams 6024, 6026 and 6028 and the fat and muscle content of the boneless meat. The velocity of the streams 6024, 6026 and 6028.

The fat and lean content of streams 6042 and 6044 can be determined by adjusting the velocity of streams 6012, 6014, 6016, 6024 and 6028 and the fat content of the boneless meat provided into streams 6012, 6014, 6016, 6026 and 6028.

Referring now to FIG. 200, streams 6098, 6102 and 6106 are shown to be connected directly to meat grinders 6100, 6104 and 6108. Grinders 6100, 6104 and 6108 are arranged to fine grind the corresponding stream of ground meat and transfer directly into a corresponding portioning apparatus. Grinder 6100 is arranged to fine grind ground meat in stream 6098 and transfer the stream of fine ground meat directly into portioning apparatus. Grinder 6104 is arranged to fine grind ground meat in stream 6102 and transfer the stream of fine ground meat directly into portioning apparatus 6118. Grinder 6108 is arranged to fine grind ground meat in stream 6106 and transfer the stream of fine ground meat directly into portioning apparatus 6120. Preferably, any suitable variable speed driver may be integrated into equipment shown in FIG. 200 and may be controlled by a central processing computer.

The fat and muscle (lean) content of the stream of ground meat that is shown as stream 6098 and which is delivered to grinder 6100, is determined by the fat and lean content of a quantity of ground meat from both stream 6042 via pump 6070 and an additional quantity of ground meat from stream 6044 via pump 6076. The fat and muscle (lean) content of the stream of ground meat that is shown as stream 6098 is also determined by the velocity (and quantity of ground meat pumped therethrough) of the ground meat stream pumped into junction box Z by pump 6070 and the ground meat stream pumped into junction box Z by pump 6076. By adjusting the speed of pumps 6070 and 6076 the fat content of the ground meat in stream 6098 can be selected. The fat content of the ground beef in the stream pumped by pump 6070 is measured by the Epsilon (or other suitable fat measuring devices) fat measuring devices 6082. The fat content of the ground beef in the stream pumped by pump 6076 is measured by the Epsilon (or other suitable devices) fat measuring device 6086. The velocity of pumps 6070 and 6076 can therefore be controlled and set by the fat measurements provided by 6082 and 6086. In this way, a selected fat content can be produced by an automatic controller such as a computer that is preferably connected to all associated pumps and fat measuring devices.

The fat and muscle (lean) content of the stream of ground meat that is shown as stream 6102 and which is delivered to grinder 6104, is determined by the fat and lean content of a quantity of ground meat from both stream 6042 via pump 6068 and an additional quantity of ground meat from stream 6044 via pump 6074. The fat and muscle (lean) content of the stream of ground meat that is shown as stream 6104 is also determined by the velocity (and quantity of ground meat pumped there along) of the ground meat stream pumped into junction box Y by pump 6068 and the ground meat stream pumped into junction box Y by pump 6074. Preferably, adjusting the speed of pumps 6068 and 6074 the fat content of the ground meat in stream 6102 can be selected. The fat content of the ground beef in the stream pumped by pump 6068 is measured by the Epsilon (or other suitable fat measuring devices) fat measuring device 6080. The fat content of the ground beef in the stream pumped by pump 6074 is measured by the Epsilon (or other suitable devices) fat measuring device 6080. The velocity of pumps 6068 and 6074 can therefore be controlled and set by the fat measurements provide by 6080 and 6074. In this way, a selected fat content can be produced by an automatic controller such as a computer that is connected to preferably all associated pumps and fat measuring devices.

The fat and muscle (lean) content of the stream of ground meat that is shown as stream 6106 and which is delivered to grinder 6108, is determined by the fat and lean content of a quantity of ground meat from both stream 6042 via pump 6066 and an additional quantity of ground meat from stream 6044 via pump 6072. The fat and muscle (lean) content of the stream of ground meat that is shown as stream 6106 is also determined by the velocity (and quantity pumped there along) of the ground meat stream pumped into junction box X by pump 6066 and the ground meat stream pumped into junction box X by pump 6072. Preferably, by adjusting the speed of pumps 6066 and 6072 the fat content of the ground meat in stream 6106 can be selected. The fat content of the ground beef in the stream pumped by pump 6066 is measured by the Epsilon (or other suitable fat measuring devices) fat measuring device 6078. The fat content of the ground beef in the stream pumped by pump 6072 is measured by the Epsilon (or other suitable devices) fat measuring device 6084 The velocity of pumps 6066 and 6072 can therefore be controlled and set by the fat measurements provided by devices 6078 and 6084. Preferably, any quantity of ground meat with any selected fat content can be produced by an automatic controller such as a computer that is connected to preferably all associated pumps and fat measuring devices.

The configuration shown in FIG. 200 preferably provides for automatic production of three streams of ground meat 6110, 6112 and 6114, each with a selected fat and lean content. A configuration of the required equipment, with any chosen capacity and size to suit any rates of production, can be arranged to produce any suitable number of one or more streams of ground meat, each with a selected fat and lean content, as may be desired.

Overwrapping and Web Stretching Apparatus and Method

Controlled Atmosphere Packages (CAP) are packages prepared or treated in an oxygen deficient atmosphere to remove or prevent the accumulation of oxygen within the package materials. Packages are overwrapped with apparatus having web stretching capabilities in one aspect of the invention.

Referring to FIGS. 202-204, details of a controlled atmosphere packaging system according to the present invention is shown. FIG. 202 shows a section of PVC web material 6200 is about 0.0008″ in thickness. Preferably, any suitable thickness or gauge can be used. Preferably, web 6200 can be coated, fully or in part and with any desired pattern such that parts of the web remain clear and other coated parts may be opaque. Web 6200 is shown with a suitable heat sealing coating that has been applied in two continuous strips along the edges of the web such that a continuous, central strip remains clear. The width of the clear section 6202 central strip may be about 50% of the total width of the web 6200 and the outer two printed sections 6204 of about equal width being about 25% of the full width each, of web 6200 such that when formed into a tube 6214, a fin seal, 6308, can be provided by heat sealing there together. Preferably, a sealed tube including an upper clear section through which the tray 6210 can be seen and a lower, opaque section 6212 through which tray 6210 cannot be seen.

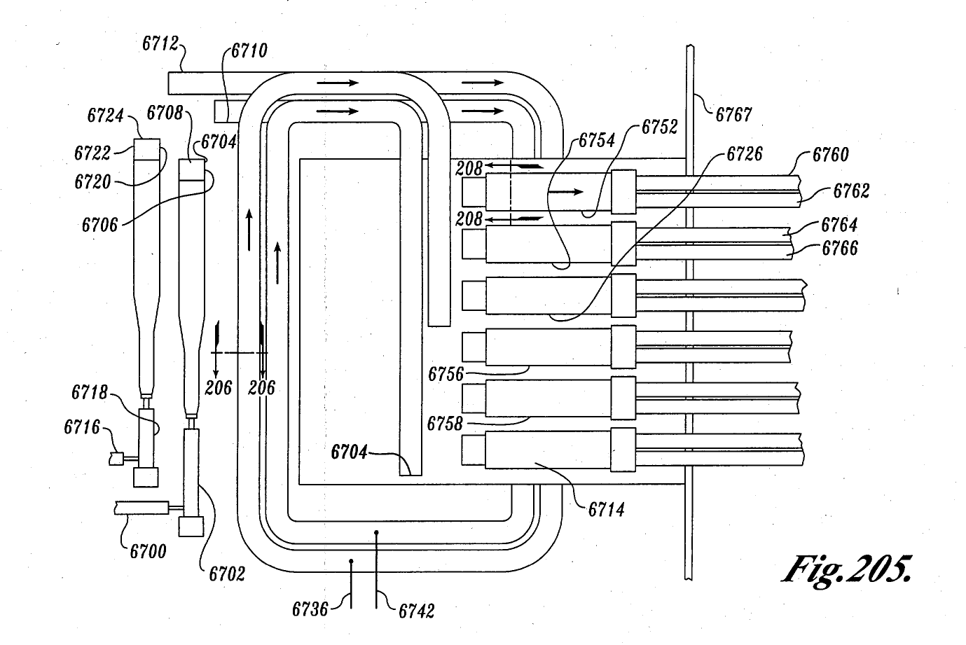

Web 6200 can be processed by a modified Hayssen RT1800, for example, in such a manner so as to form a continuous tube 6214, and shown as PVC web material “fin” sealed tube. Suitable packaging trays such as Mono-Pak™ trays 6210 that have been filled with perishable goods such as ground beef can be inserted into the tube 6214, by automatic devices (not shown) or any other suitable devices, and lateral stretching can be induced into the tube 6214. The lateral stretching can cause the tube 6214 material to firmly contact the tray 6210 and hold the perishable goods contained therein firmly. After the trays 6210 are located inside the fin sealed tube 6214 the tube can also be stretched longitudinally. After the longitudinal stretching of the tube 6214, lateral fin seals, followed by severing of the tube 6214 adjacent to the lateral fin seals, can be provided so as to provide a fully and hermetically sealed package as shown in FIG. 204. The lateral and longitudinal stretching can be provided prior to sealing and severing of the lateral fin seals. Longitudinal stretching can be effected by the modified Hayssen RT1800 after modification and as generally described below.

Referring now to FIG. 201, items 6000, 6002 and 6004 shown thereon include three modified versions of the Hayssen RT 1800 (modified RT1800), flow wrapping packaging machine. The modifications to each item 6000, 6002 and 6004 refers to the inclusion of a sub-assembly to each machine which is detailed in a cross-sectional sketch shown as FIGS. 205-206 so as to enable processing and use of pPVC web material on the RT1800 packaging machines. The following disclosure details the modification that can be incorporated in the RT1800 so as to facilitate the use of pPVC web material as the over wrapping packaging material used thereon to over wrap such packages as the Mono-Pak EPS foam tray.

The Hayssen RT 1800 is manufactured by Hayssen, a division of the Barry-Wehmiller Company, which is located at 225 Spartangreen Boulevard, Duncan, S.C. 29334. Other information describing the RT1800 can be obtained from the following web site: www.hayssen.com. The RT 1800 incorporates a “rotary die wheel” in such a manner so as to provide a continuous movement of the web during machine operation and package sealing. This arrangement provides a method to process and seal packages more rapidly than other types of over wrapping machines but hitherto the RT 1800 has not been used to over wrap packages with pPVC (plasticized polyvinylchloride) web material.

It is desirable to use pPVC web material, in this particular application, because of its most suitable physical characteristics for the packaging of fresh meats such as ground meats and poultry pieces. However, the standard RT1800 is not ideally suited to process pPVC web material and in order to ensure efficient stretching and sealing of the pPVC web the modifications to the RT1800 are necessary.

The HAYSSEN RT1800 rotary die wheel concept operates on the principal of maximizing dwell time. Individual MAGNUM sealing dies are released on demand as packaging material and product move through the machine. The RT1800 packaging equipment is well known to those skilled in the arts and all details of the RT1800 machine construction are readily available from the manufacturer to potential end users of this popular packaging equipment.

Packaging materials may include the Mono-Pak™ EPS tray, over wrapped with plasticized PVC web material, (supplied by AEP/Borden or Huntsman).

It should be noted that the readily available, low cost, pPVC web material as intended for use in this application, has the following properties:

1. Glass clarity

2. Stretch and high extensibility (50-100% before exceeding elastic limit)

3. Memory, providing a “return to its original condition” after stretching (within elastic limit).

4. Standard, enhanced oxygen permeability.

5. Rapid heat sealing to itself.

6. Rapid hot “knife” cutting, providing clean cut edges.

7. Generally, the basic RT1800 machine, as manufactured by Hayssen, would remain similar to existing standard equipment, except for the modification described herein. The existing longitudinal fin or lap sealing (as shown as 6208, in FIG. 203) may require adjustment to facilitate an enhanced lateral web “stretching” capability for a pPVC web. The longitudinal web stretching apparatus, as disclosed herein, should be capable of installation without major structural and basic frame modifications to the existing equipment.

FIGS. 205-206 include an assembly intended for optional and interchangeable use on standard Hayssen RT1800 or similar packaging machines, shows detail of the following items.

Referring now to FIGS. 205-206, the apparatus constructed according to the present invention includes a die wheel 6216 shown in part with the axis of the wheel marked as axis 6218. A number of die carriers 6220 are also shown. The complete die wheel 6216 and drive is not shown, however, since a person skilled in the art will readily recognize the proposed modification when viewing the representation of the die wheel with die carriers as shown. The wheel die assembly fixture may include a standard Hayssen component modified to suit convenient attachment of the “Stretch Web Clamp Assembly”.

The packaged product may include any of the number of trays disclosed herein, for example, the tray shown in FIG. 55, over wrapped with standard (with enhanced O₂ permeability) plasticized PVC web material, (supplied by AEP/Borden or Huntsman). The EPS material can be produced with a surface finish that will not “cling” to the pPVC web material.

Plasticized web of stretch over wrap material is preferably printed or plain material can be used. Preferably, partial coating of the inside web surface, with a low melt heat activated coating (HAC), can provide for improved performance.

A full width, lateral, impulse, heat sealing, element (e.g. cut from Inconnell SS sheet or other “marine” grade, SS sheet material) is installed by attachment to a horizontally disposed rigid and suitably heat tolerant, non metallic base. Preferably, compensation for normal expansion and contraction of the element, during heating and cooling, can be provided. The element is covered with suitable material (PTFE) so as to provide a “non-stick” surface that will not “cling” to pPVC web. The heat sealing assembly is arranged with the heating sealing element in close, adjacent and parallel disposition to a full length strip of a portion of the outer surface of roller 6224, as shown in the sketch. When held together under suitable pressure with two webs of pPVC material located between member 6228 and roller 6224, a full length and hermetic seal between the two webs can be produced.

An alternative heat sealing device includes a heat bank. Use of either impulse or heat bank devices may be determined by manufacturer preference. In the case of a heat bank device, the clamping bars 6230 and 6232 would be separated and insulated from the adjacent heat bank members 6230, 6232 and 6234, 6228 would require independent, return spring mounting. A suitable distance or gap (for insulation and sealing/cutting control devices), between the elevation of the clamping surface of the clamping bar and the elevation of the contact surface of the heat bank, would be required. This would allow clamping of the web(s) by the clamping bar with subsequent web clamping, sealing and cutting by the heat bank.

Web clamping bar 6232 includes a strip like component that is arranged in parallel and close proximity to assembly 6228 so as to provide a clamp to web 6236 at the same time and with similar clamping effect as member 6232 when roller 6224, 6232 and member 6228 are arranged so to do.

Rubber coated roller with cam/clutch bearing 6224 includes a heat resistant rubber coated and suitably ground, solid steel, hardened, rigid roller. Roller 6224 is located between two end plates 6240 and 6242 (not shown) and mounted thereto by bearing (one located at each end of the roller 6224. The bearings are of identical dimensions with “cam/clutch” feature provided in one only bearing. Such arrangement allows the roller 6224 to rotate in a clockwise direction only.

Impulse heat sealing element assembly is arranged to mirror image assembly 6228.

Web clamping bar 6230 is arranged to mirror image web clamping bar 6232.

Rubber coated roller with cam/clutch bearing 6244 includes a heat resistant rubber coated, solid steel, hardened, rigid roller identical to roller 6224 but with a “cam/clutch” feature provided in one only bearing so as to allow roller 6244 to rotate in a counter clockwise direction only, as shown by an arrow in the sketch. The surface finish on both rollers 6244 and 6224 can be arranged so as to cling to web 6236 when contact occurs between suitably tensioned web 6236.

Two end plates 6240 and 6242 are arranged to rigidly retain rollers 6244 and 6224 in relative, respective, parallel and separated proximity, allowing the rollers to rotate as described above. Both end plates may be fitted with suitable coil or flat return springs to hold the rollers 6244 and 6224 in a normal position at a desired distance from bars 6230 and 6232 and heating elements 6234 and 6228.

A cam follower is mounted to each end plate 6240 and 6242 so as to engage with cam tracks (not shown but mounted to main frame of FFS machine) arranged to provide a web sealing pressure to web 6236 by causing depression of end plate return springs.

The web stretching bar 6226 includes a strip of suitable material profiled as shown and provided with an outer surface treatment that can cling to pPVC web material. Web stretching bar 6226 is attached to two pneumatic cylinders [6246 (shown) and 6248 (not shown)] with slotted fixture apertures so as to eliminate locking that may otherwise occur during operation. The web-stretching bar is shown in a normally withdrawn (closed) position and also in a fully extended position, by dotted lines. When in the normally closed position, the upper and highest edge of the bar extends along its full length and is in permanent contact with web(s) 6236. This contact is arranged so as to ensure a suitable tension is induced in the web(s). This can provide a condition allowing the free movement (by stretching) of the web material over roller's 6244 and 6224 only inwardly and toward the web-stretching bar. The cam/clutches installed in the rollers will not allow the web to be pulled away from the web-stretching bar. Preferably, web 6236 can be freely stretched but is essentially clamped by its tensioned and intimate contact with the surface of the rollers and the upper edge of the web-stretching bar.

The Rollers Assembly, includes two off each rollers, 6244 and 6224, endplates 6240 and 6242, cam followers 6250 and 6252, fasteners and return springs as required. When assembled with the complete web stretching assembly and in a normally closed position, a suitable gap is maintained between the rollers and the adjacent contact surfaces of items 6230, 6234, 6232 and 6228, thereby allowing free stretching of the web 6236, by activation of web-stretching bar 6226.

A pneumatic cylinder is shown, attached to the web-stretching bar 6226 to extend bar 6226 to the position shown by dotted lines and thereby stretch the web 6236. Preferably, two cylinders would be provided. Compressed air flow and pressure controls can be arranged to activate cylinders 6246 and 6248 so as to optimize induced tension in web 6236. Any suitable alternative method of web-stretching bar activation and control may be used.

A vacuum tube may be conveniently located so as to provide a method of removing scrap web material (excess material for accumulation in a canister.

In this configuration independent pivoted mounting of each roller and clamping assembly 6256 and 6258 is provided. Each assembly 6256 and 6258 is held in the normal central position (close together), by controlled return springs. Activation of the web-stretching bar 6226 will cause the two assemblies to move away from the central position until contact with the packages 6254. Such an arrangement will provide consistent web stretching with a final web heat sealing at a constant distance from the package. In this configuration end plates 6240 and 6242 would require slotting to accommodate outward rotation of each assembly.

Products, pre-filled with ground beef portions/blocks, are automatically loaded onto the entry end of the Hayssen FFS equipment. Orientation of the products may be in normal or inverted disposition. A normal disposition (with package “open top” side facing upward) would require a side fin or lap web seal, whereas an inverted disposition would require a bottom web seal. Normal operation would include longitudinal sealing after induction of maximum stretch in web 6236. Lateral sealing would occur after longitudinal stretching by web stretching bar 6226. Activation of the web-stretching bar would not commence until closure of the subsequent closing of the closest clamp to its rear, on the wheel. In this way gradual stretching of the pPVC over wrap, during the wheel rotation, can occur until the desired level of stretch and/or tension is achieved when web heat sealing and simultaneous cutting could be provided immediately prior to ejection of the finished package(s). The finished packages could be ejected in a normal and upright disposition, assuming that the packages were loaded in an inverted disposition, alternatively, the packages could be inverted after ejection if the packaging had been loaded onto the RT1800 packaging machine in a normally upright position.

By incorporating the above described modification in the Hayssen RT 1800 packaging machine a web stretching arrangement is provided to stretch the over wrap material 6236 during the normal rotation of the die wheel. It is anticipated that, in view of the rapid heat sealing and cooling characteristics of thin gauge (0.0008″) pPVC, the operational speed of the Hayssen RT 1800 could be increased to more than 1800 feet per minute.

Blending Apparatus

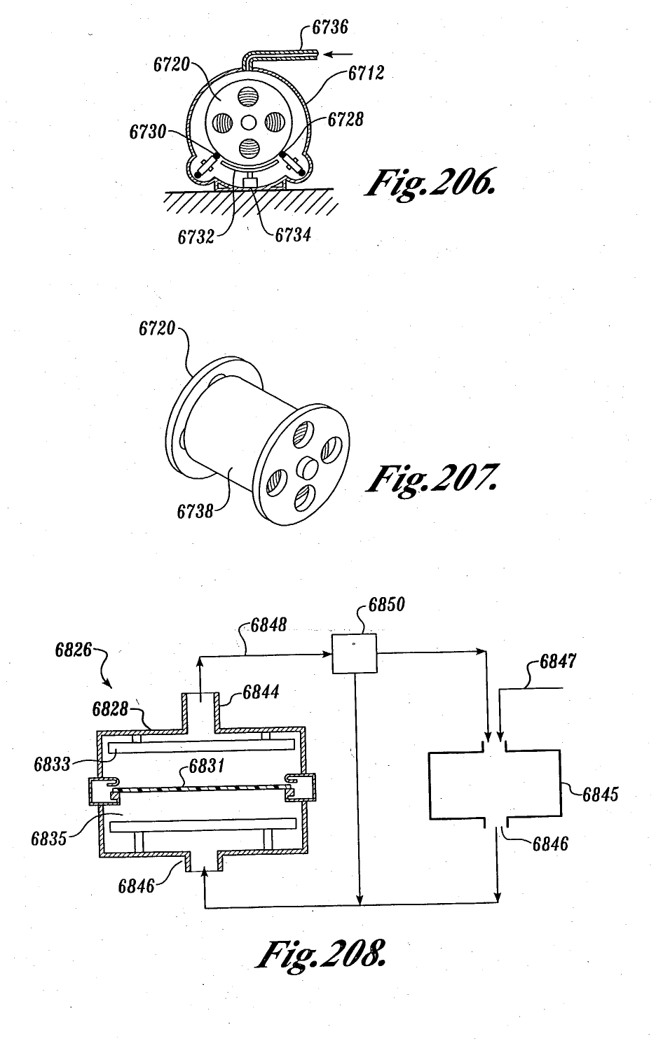

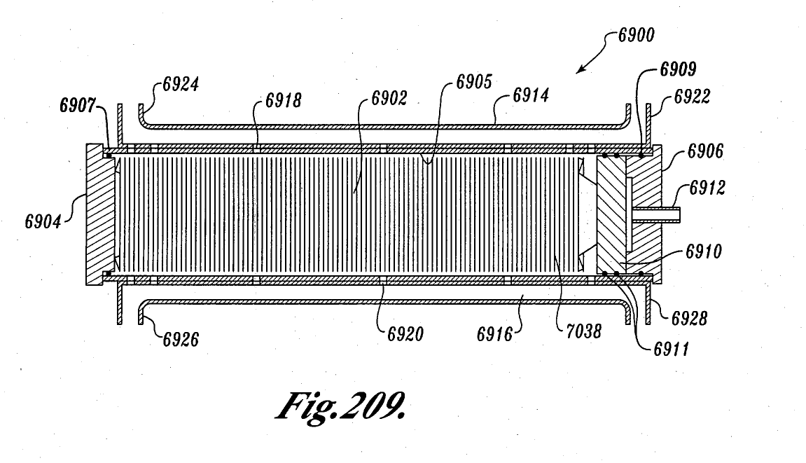

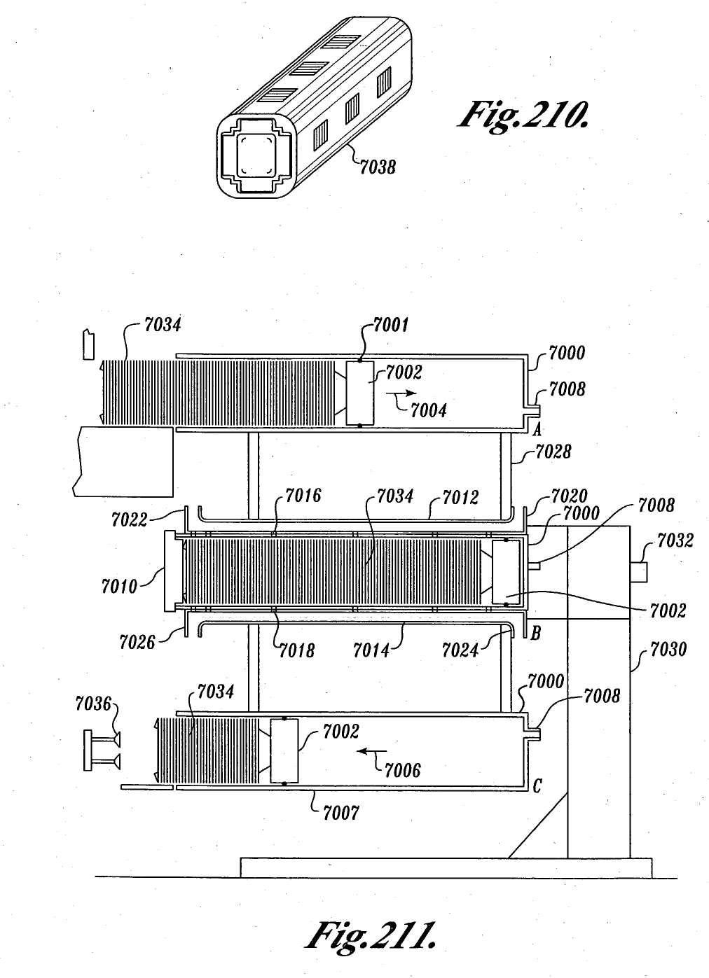

Referring now to FIGS. 207-208, details of an apparatus that can be used to blend one or more individually controlled streams of ground meats that can also be combined with selected conditioning gases or suitable materials and blended together to produced a single stream of blended and conditioned ground meat, is shown. FIG. 208 shows a diagrammatic representation of three streams of ground meats, 6300, 6302 and 6304 that are each pumped through conduits shown as 6306, 6308 and 6310 at independently controlled velocities. Preferably, the apparatus can be arranged to provide one or more streams of ground meat but most preferably three streams will be provided where, for purposes of example, one stream may have an approximate fat content of about 20%, a second stream has an approximate fat content of about 30% and a third stream has a fat content of about 7%. Preferably, the content of each stream can be varied as may be required. Conduits 6306, 6308 and 6310 can be arranged to house independent measuring devices such as the Epsilon GMS-40 in-line measuring equipment. The streams of ground meat can be pumped, by positive displacement pumps that are independently driven by variable speed drivers, at velocities that are continuously adjusted directly corresponding with the respective fat and muscle content of each stream such that when the three streams are subsequently combined together into a single stream of ground meat, the fat and muscle content of the combined stream is substantially consistent and constant at a chosen composition with percentage quantities of fat and muscle held within a range of less than about +/−1% fat content. Furthermore, even though the velocity of each separate stream of ground meat is independently varied according to the fat and muscle content of the respective stream, the resultant single, combined stream can be arranged, by adjusting the velocity of each of the streams 6300, 6302 and 6304, to be at a constant velocity, volume and production rate and as desired within the capacity of the apparatus.

Referring now to FIG. 207, a housing 1318 is arranged with six suitably profiled blades 6312 that are attached together at a central axis 6314 which in turn are attached to a driver 6316. Blades 6312 are attached at axis 6314 and to a driver 6316 in such a manner that blades 6312 can be rotated within the confinement of housing 6318, which is sealed and separate from external atmosphere. Blades 6312 are arranged so as to not contact but be in close proximity to the internal surfaces of the housing 6318. A total of six spaces or segments shown as 6320, are therefore arranged between the blades 6312 that include equal volumes and a recess 6322 is provided at the axis of the blades 6312 so as to allow direct communication between the spaces. The direct communication between the spaces 6320 may be provided or otherwise, if so desired, not provided. A conduit 6324 is attached to the housing 6318 with a spiral auger 6326 contained therein. Auger 6326 may be directly connected to suitable driving devices (not shown) that can provide a variable speed rotating of the auger as required to further blend the single stream of combined ground meats. Preferably, the streams of ground meat can be transferred directly through housing 6318 and into conduit 6324. Blades 6312 can be rotated about the axis by driver 6328 at a suitable speed. Preferably, a series of conduits 6330 can be arranged to have direct communication with the spaces between the blades 6312, as they rotate adjacent thereto, so as to allow injection of any suitable substances such as carbon dioxide into the spaces at any suitable pressure and from a suitable source and in controlled quantities. Preferably, a known quantity of ground meats can be transferred from conduits 6310, 6308 and 6306 into spaces 6320.with a known and controlled quantity of gas or other suitable substance provided therein via conduits 6330, as spaces 6320 rotate about its axis 6322, and pass through conduits. Blades 6312 are arranged with edges that are parallel and in close proximity to the internal surfaces of housing 6318. As ground meat is transferred from the conduits into the spaces 6320 at controlled rates and quantities, controlled quantities of carbon dioxide can also be transferred into the spaces. Preferably, selected quantities of ground meat and carbon dioxide can be transferred, consecutively, into spaces 6320 and transferred as a single volume of materials into conduit 6324 and blended therein, in a continuous process of measured amounts of ground meat and carbon dioxide. Preferably relatively small quantities of measured amounts of ground meat with a selected quantity of carbon dioxide can be blended most efficiently in a continuous process. Such a method of blending can provide a method of thorough and accurate blending with a minimum energy requirement. It can now be seen that the apparatus herein described can be used to efficiently produce a blend of ground meats that has been pre-conditioned with such substances as carbon dioxide and at a chosen rate of production within the capacity of the apparatus. The apparatus shown in FIGS. 207-208 can be enclosed in any suitable jacket or containment so as to allow any suitable heat exchanging medium to contact the housing and thereby, by a heat exchanger means provide precise temperature control of the apparatus and any goods processed therethrough. The temperature control can be precise and set at any suitable temperature within any suitable temperature range. In a preferred embodiment the conduit 6324 may include a suitable portion of static mixing conduit as may be supplied by Statiflo, alternatively auger 6326 may be driven by a suitable driver at any suitable speed. Conduit 6324 may be connected to a suitable positive displacement pump or other suitable pump so that any goods that may have been processed by the apparatus shown in FIGS. 207-208, can be directly transferred thereto and then pumped at a desired rate into suitable holding containers or directly into further processing and/or packaging equipment.

Pre-conditioning Apparatus

Referring now to FIG. 209 a side elevation of a ground meat pre-conditioning apparatus intended for use in pre-conditioning ground meats and any other suitable goods, is shown.

Preferably, the pre-conditioning apparatus is intended for use to pre-condition such perishable goods as ground meats in a continuous process (as opposed to a batch process where the perishable goods may be transferred into a pressure vessel which is then sealed prior to removal of any undesirable gases and provision of desirable and suitable gases therein). The continuous process may be arranged so that the ground meats are continuously transferred through an entry orifice that restricts the transfer into a vessel in such a manner so as to provide a seal. The vessel can be filled with any suitable gas at any suitable pressure and maintained at any suitable temperature. The vessel can be arranged to accommodate any suitable quantity of the ground meats for any suitable period of time or residence time. The ground meats can be arranged to exit the vessel after a suitable period of time by transfer through a restricting exit orifice. The exit orifice and the entry orifice can be arranged to restrict transfer of ground meats therethrough in such a manner so as to prevent suitable gases provided in the vessel from escaping therefrom.

A meat hopper 5400, meat grinder 5402 and drive motor 5404 is arranged to grind meat which passes from the meat grinder 5402 directly into a first conical shaped connection to a tube 5410. Tube 5410 includes a length of high pressure stainless steel tube or other suitable material, and connects with a second conical shaped connection 5412 to grinder 5408. First conical connection 5406 is provided so as to elevate the pressure of the ground meat as it is transferred from said grinder 5402 to tube 5410. Tube 5410 may follow any convenient path and is arranged to have any suitable length and, save two end portions of convenient length, is located in an insulated tank enclosure 5414 that contains a suitable liquid cooling medium 5416, such as brine or glycol. Tube 5410 can be completely immersed in the cooling medium 5416 which can be maintained at a desired and suitable temperature that may be set between about 32 and about 33 degrees F. Another tube 5418 connects the tank enclosure 5414 to a heat exchanger 5420 via a suitably sized pump 5422. Tube 5424 connects the tank enclosure 5414 to the heat exchanger 5420. The pump 5422 is arranged in such a manner that cooling medium 5416 can be pumped at a controlled rate through the heat exchanger 5420 so as to maintain 5416 at a desired temperature. Tube 5426 connects the heat exchanger with a source of suitable gas 5428, such as carbon dioxide, provided at a suitable volume, temperature and pressure. Tube 5430 is arranged to carry any excess quantities of gas 5428 away from heat exchanger 5420 as may be required. Tube 5426 is arranged to connect gas 5428 supply to tube 5410 via the heat exchanger 5420 and connects to the tube 5410 at connection 5432. Connection 5432 is arranged to allow a constant flow of gas 5428 directly into or through suitable valves attached to tube 5410 at a position approximately equal distance from each end of tube 5410.

Meat, which may have been dipped in or sprayed with any suitable bactericide such as natural citric acids, is loaded into the meat hopper 5400 at a convenient rate and is processed by grinding in the meat grinder 5402. Meat grinder 5402 is driven by drive motor 5404 at a suitable speed and ground meat which may be coarse ground, is forced into the first conical connector at a suitable pressure. Ground meat is therefore forced under suitable pressure into and along tube 5410. Due to the immersion in the medium 5416, the temperature of the tube 5410 is approximately equal to the temperature of the medium 5416 and therefore temperature of the coarse ground meat is affected and will be either heated or cooled accordingly. The coarse ground meat can be held in the tube 5410 for such a period of time that will allow the temperature of the coarse ground meat to become substantially equal to the temperature of the medium 5416 by transfer of heat through the walls of the tube 5410. The coarse ground meat can pass through the entire length of the tube 5410 and into the second conical shaped connection 5412 to grinder 5408. Grinder 5408 is driven by motor 5434 and is arranged to grind the coarse ground meats and can be further arranged to produce fine ground meat from coarse ground meat. A speed controller can be arranged to control the speed of motor 5434 and the corresponding production rate or output of the grinder 5408 can thereby be controlled as may be required to correspond with the speed and output of the grinder 5402. Suitable gas 5428 can be injected at a suitable rate, into tube 5410 via tube 5426, at a suitable temperature which may be equal to the temperature of medium 5416, and at a suitable pressure which may be about 200 psi. Gas 5428 may be carbon dioxide and can therefore dissolve into coarse ground meat as it passes through tube 5410. The diameter of tube 5410 can be arranged to be smaller than the internal diameter of grinders 5402 and 5408. The source of gas 5428 can be arranged to provide gas at a suitable pressure and in quantities sufficient to meet the desired rate of absorption by the ground meat passing through the tube 5410 and also the quantity required to maintain medium 5416 at the desired temperature. If the volume of gas 5428, required to maintain the suitable temperature of medium 5416 exceeds the volume of gas required to be provided into tube 5410 then excess gas can be vented to atmosphere through tube 5430. Conversely, if the quantity of gas 5428 required to be provided into tube 5410 is greater than the quantity required to maintain the temperature of medium 5416 at a suitable level, such that the temperature of medium 5416 is otherwise thereby depressed, then a heater can be provided. The heater can be arranged to heat gas 5428 as required to ensure and maintain the temperature of medium 5416 as required.

A suitable device to vary the quantity of medium 5416, that is pumped by pump 5422 through tube 5418 can be provided. Gas 5428 may be injected into the tube at any suitable gas pressure that may be 200 psi, however, under such conditions gas 5428 will be soluble and therefore dissolve in liquids contained in tube 5410, resulting in a pressure drop as the gas and liquids are transferred along tube 5410 toward grinder 5408.

The quantities of gas 5428 and ground meat present in tube 5410 and the length of tube 5410 can be arranged so as to allow partial or complete dissolving of gas 5428 into ground meat while still present within tube 5410.

It may be important that ground meats are not exposed to conditions that will either partially or fully freeze the ground meats during processing in the pre-conditioning apparatus. Accordingly, heat exchanger 5420 can be arranged so as to provide a method of transferring heat between the ground meat within the tube 5410 and gas 5428, and medium 5416 as required and in such a manner that will inhibit and/or prevent freezing of the ground meat during the pre-conditioning process. Heat exchanger 5420 can be arranged so as to provide a method to ensure that, irrespective of the temperature of the meat provided in the hopper 5400, the temperature of the ground meat 5436 will be maintained at a suitable temperature that may vary within a limited range of plus or minus about 0.5 degrees F. Ground meat 5436 can be processed in the pre-conditioning apparatus so as to saturate or partially saturate, to any suitable level, the ground meat with any suitable dissolved gases.

Preferably, any suitable gas such as nitrogen may be provided directly into grinder 5402 through tube 5438 shown, so as to substantially purge and remove any air that may be present with the meat in hopper 5400. The quantity of meat transferred along tube 5410 and the quantity of gas 5428 injected into the tube 5410 at connection 5432 can be measured and controlled with motors 5404 and 5434 and pump 5422, by a programmable logic controller (PLC). Ground meat pre-conditioning apparatus may be controlled by any suitable controller so as to provide an automatic process. The apparatus can be manufactured to suit any required rate of production.

An auger or other pump to assist in transfer of the ground meat through tube 5410 may be located between the meat grinder 5402 and the first conical connection 5406 or any other suitable location.

A suitable tube (not shown) and valves to open and close the tube, may be provided to connect the second conical connection 5406 to the meat grinder 5402 thereby allowing any re-cycling of ground meats that has passed through tube 5410. Such a re-cycling would allow for further pre-conditioning of any goods that had not been correctly processed during a first passage through tube 5410.

Vents to allow excess gas may be provided at suitable locations in tube 5410 or at any other suitable location.

Ground meat 5436 may be further processed by direct transfer from grinder 5408 to any other suitable processor such as a pattie forming machine or directly into a vacuum packaging machine. The transfer of the ground meat 5436 may be via an enclosed mode of transfer so as to eliminate or minimize exposure to ambient atmosphere prior to further processing or packaging.

The pre-treatment of any perishable goods, such as ground beef, as described herein can enhance the keeping qualities of the perishable goods. Preferably, the goods can be placed into a sealed pressure vessel with a known quantity of suitable gases at any suitable pressure for a suitable period of time and maintained at a suitable temperature. Preferably, the suitable gas pressure may be selected at a pressure above ambient air pressure. The quantity of the suitable gas can be increased by providing additional controlled quantities into the pressure vessel as desired. Preferably, the suitable pressure, time and pre-treatment temperature can be precisely controlled and arranged so as to allow the suitable gas to dissolve into any water and oils and/or other substances contained in the goods. The quantity of suitable gas that dissolves into the goods, can therefore be controlled and may be equal to the maximum amount that can dissolve therein at any suitable gas pressure and thereby saturating the goods with the suitable gas in solution. Preferably, a known amount of gas can be dissolved into the goods at a given gas pressure and pre-treatment temperature. The perishable goods can then be removed from the pressure vessel and packaged in any suitable packaging such as a hermetically sealed vacuum package that may include a gas barrier plastic pouch of suitable size. Preferably, after vacuum packaging the perishable goods into the suitable gas barrier pouch at ambient air pressure, the goods can be stored in ambient atmosphere and maintained within a suitable storage temperature range. The suitable storage temperature range can be maintained at a suitable level above the pre-treatment temperature. Preferably a quantity of dissolved gas can emerge from the perishable goods and partially inflate the gas barrier pouch. The size of the gas barrier pouch can be arranged to accommodate the partial inflation without damage to the hermetic sealing of the pouch. The emerged gas then contained within the gas barrier pouch can enhance the keeping qualities of the perishable goods. The emerged gas can subsequently dissolve into the goods again and re-emerge corresponding to any temperature fluctuations that may occur within the suitable storage temperature range. Preferably, a quantity of free suitable gas can be maintained in gaseous condition with the goods within the packaging and the quantity of free gas can be arranged and controlled at a minimum suitable quantity. However, if the temperature of the goods in the gas barrier pouch is increased as a result of failure of refrigeration or any other type of temperature “abuse” to an unacceptable high level (for example 50 degrees F.) for an unacceptably prolonged period so that the quality of the goods is compromised, additional gas will be released from solution therein and cause further expansion of the gas barrier pouch. The gas barrier pouch can be sized such that it will accommodate a known amount of released gas. The known amount of the released gas can be limited to such an amount that will be released by goods at an acceptable temperature and if the acceptable temperature is exceeded any additional release of gas can cause rupturing of the gas barrier pouch (or any other suitable packaging material). Rupturing of the packaging, therefore, can be used as an indication that goods have endured an unacceptable level of abuse.

In yet another preferred embodiment, goods may be treated by exposure to an adequate quantity of suitable gases at a suitable temperature and pressure in such a manner so as to allow a specific quantity of suitable gas to dissolve in the goods. The specific quantity of suitable gas can be arranged so as to equal an amount that will saturate the goods with the suitable gas dissolved therein to a suitable level. The goods can then be packaged in any suitable packaging of suitable size which may include an additional quantity of suitable gas contained and hermetically sealed in the suitable packaging with the goods therein. Preferably the total volume of the goods with specific quantity of suitable gas dissolved therein plus additional quantity of suitable gas can be arranged so as to completely fill the suitable packaging of suitable size to provide a finished package with goods and the gas sealed therein. Therefore, any change in temperature of the finished package and the goods therein will result in a change in the total volume of the goods plus the additional quantity of suitable gas. The packaging, the goods with the suitable gas dissolved therein plus the additional quantity of suitable gas can be arranged so as to accommodate a known variation (increase or decrease) in the total volume, as desired. The known variation can be used as an indicator of the temperature history of the finished package. For example, the packaging may be provided with a valve indicator that will permanently open or break if the temperature of the finished package with the goods, increases to an unacceptable level and extent so that the volume of gas therein and corresponding pressure thereof increases to an unacceptable level.

Primal Meat Portion Shaping Apparatus

Referring now to FIG. 210, an apparatus for shaping primal meat portions includes a container 2800 and plug 2802. Container 2800 and plug 2802 may be manufactured by injection molding a plastics material such as nylon or alternatively a gas permeable and porous material such as a chemically foamed polypropylene or polyester plastic material. Alternatively the container and plug may be manufactured from a stainless steel mesh. The apparatus includes a container 2800, with lugs 2842 and 2844 that are engaged with rails 2814 and 2846. The rails may include, for example, parallel, round, stainless steel bars, suitably mounted to framework, conveniently spaced apart and horizontally disposed, extending for any convenient and desired length that may have bends and curves allowing for the powered or manual movement of the containers 2800 there along while maintaining engagement between the lugs and horizontal rails. The cross-section shown in FIG. 210 provides detail of the container, plug and apparatus through one cross-section only. Other views are not considered necessary since the profile of the container and plugs, across a different section may be similar, differences may only include variations in for example, length. The mechanism, container and plug may be arranged in any suitable and desired shape and size to suit the requirements for each portion of pre-rigor fresh red meat. Generally, the internal volume of an assembled container with a corresponding and matching plug in position, is approximately equal to the volume or displacement of the corresponding fresh red meat primal shown as 2822. The plug 2802 can slide inside the opening of the corresponding container 2800 such that rim 2810 remains in contact with the inside surfaces of the container wall. The displacement of similar fresh red meat primal that have been harvested from different animals will vary. Therefore, in order to accommodate the variation of similar fresh red meat primals, the internal volume, shown as space 2812, of the assembled container and plug can be adjusted to suit the actual displacement of the corresponding fresh red meat primal. The fresh red meat primal 2822 is located in the container and a plug 2802 is located inside the upper portion of the container such that substantially all air has been excluded from the enclosed cavity containing the primal, under the plug. The container 2800 is shown located in close proximity with a press base 2848, with perimeter wall 2850. The press base is mounted onto an elevating shaft 2852 thereby providing a means to elevate the press base so as to contact and retain the lower portion of the container 2800, and also lower the press base parallel with shown center line, such that the 2800 will be suspended on the rails 2814 and 2846 and the press base will not contact or interfere with 2800 and allow the container to slide freely along the length of the rails when the press base is in a lowered position. An assembly, including an outer wall 2816 with a series of driven, concentrically mounted clamps, about a central clamp and located therein, is positioned directly above and aligned with the press base 2848. The wall 2816, and clamps marked 2818, 2828, 2826, 2824 are independently driven in a reciprocating and vertical direction, parallel with the center line shown. A concentric slot 2860 is provided around the perimeter of the clamp 2816, such that a vacuum can be applied to the upper side of the container. A side view of an alternative profiled plug 2856 is shown in FIG. 211.

The container includes a rectangular, round or oval plan profile with a flat bottom and substantially vertical walls extending upwardly from the base. The base and walls are continuously attached via a suitably radiused confluence. Two lugs are conveniently located, one on each opposing side of the container. The consistency of container 2800 is such that it will deform slightly when subjected to pressure but will return to its original shape when the pressure is released. A bevel 2806 is molded as shown to provide an easy penetration by the plug 2802.

Plug 2802 includes a “rigidly” flexible, relatively shallow cup with a flat or profiled face 2808, and flexible walls with tapering thickness and flaring outwardly at an angle of about 5 degrees from vertical. The upwardly extending walls are connected to the plug face with a radius therebetween as shown. The upper rim, 2810, of plug wall is tapered and flexible.

The profile and dimensions of the plug are arranged so as to provide an easy penetration into the matching opening of the corresponding container. However as the plug penetrates the container opening, the tapered disposition of the walls provides for intimate contact and sealing between rim 2810 and inner surface of container vertical walls. The container and plug, when assembled together, provide an enclosed space 2812 that is substantially sealed and isolated from external atmosphere. Space 2812 has a volume that can be varied within the limitations of the container, by moving the plug position, relative to the container, within the container. In all positions, however, the intimate contact between rim 2810 and the inside surface of the container walls is maintained in a substantially “airtight” fashion.

Preferably, containers and matching plugs of different sizes and suitable profiles may be manufactured to suit various sizes of primal portions of fresh red meat, however, in each case the container and corresponding plug are sized to provide a limited but variable internal volume of space shown as 2812. Preferably, primal meat portions, of limited varying size and profile can be accommodated within the same containers provided for similar primal portions.

It should be noted that animals used as a source of primal meat portions vary in profile and size but are typically graded prior to slaughter such that the corresponding primal portions are approximately similar.

This present invention provides for de-boning of carcasses that are still in pre-rigor mortis condition, immediately after animal slaughter and preparation while the temperature of the carcass remains close to normal body temperature. The de-boning of the carcasses at such temperatures is very much easier and provides for much more rapid completion of the de-boning process, thereby substantially reducing costs. Furthermore, pre-rigor mortis disassembly provides the opportunity to control and “mold” the primal meat portion profile such that when the primal portions are chilled, the firm, rigor mortis condition occurs after shaping within the container and plug.

More specifically, according to this present invention, the pre-rigor mortis primal meat portion, having been de-boned, is sprayed with or dipped into a solution of one or more of the following: carbonic acid, acetic acid, ascorbic acid, citric acid and any other suitable substance that can be used to inhibit or eliminate bacterial growth on the primal meat portion. Primal meat portion is then placed into a container of correspondingly suitable dimensions and a plug is inserted into the open end of the container. The assembled container, primal meat portion and plug is located with plugs engaged onto rails 2814 and positioned directly and in alignment above the press base. The press base is elevated so as to closely retain the container. The wall 2816 is lowered so as to engage with the outer surface of the upper portion of the container walls as shown in FIG. 210. Clamp 2818 is then lowered and penetrates opening of the container with radius 2820 end with bevel 2806 and stretching the container opening outwardly thereby clamping it against the inner surface of wall 2816 and providing an airtight seal therebetween. Wall 2816 is attached to an upper plate (not shown) forming a chamber that is isolated from external air. A vacuum source is attached and air is evacuated from between clamping assembly and plug. Progressively, Clamp 2818 is lowered so as to compress the plug against primal, followed by clamp 2826 and finally clamp 2828 is lowered. Clamps 2828, 2826, 2824 are then in contact with the upper surface of the plug and all applying suitable pressure. The vacuum source is then disconnected, allowing atmospheric air to apply pressure to the outer surface of the plug. In this manner, substantially all air can be removed from within the container assembly.

The container assembly can then be immersed into brine or other suitably treated, bacteria free, temperature controlled medium that may be elevated to as much as about 140 degrees F. and held for a suitable period so as to cause death of bacteria that may be present. Following the desired reduction or elevation of the primal temperature, the container assembly can be relocated within a pressure chamber and exposed to an ultra high pressure on the order of about 30,000 psi or more. This procedure can tenderize the primal and also kill bacteria that may be present.

Alternatively, sequentially or simultaneously, the container assembly can be attached to an electrical source so as to provide passing a high voltage current through the primal and thereby treat by way of “Ohmic” heating. In this manner, any bacteria that may be present with the primal can be substantially eliminated or killed.

The assembled container can then be removed from the pressure chamber and again immersed in a cooling medium when the temperature of the primal can be reduced to a desired and optimum temperature prior to removal from the container and followed by automatic slicing. In this manner rigor mortis occurs such that the shape of the primal meat portion after cooling within the container is similar to the inner profile of the container, providing a more efficient shape for slicing with automatic slicing equipment.

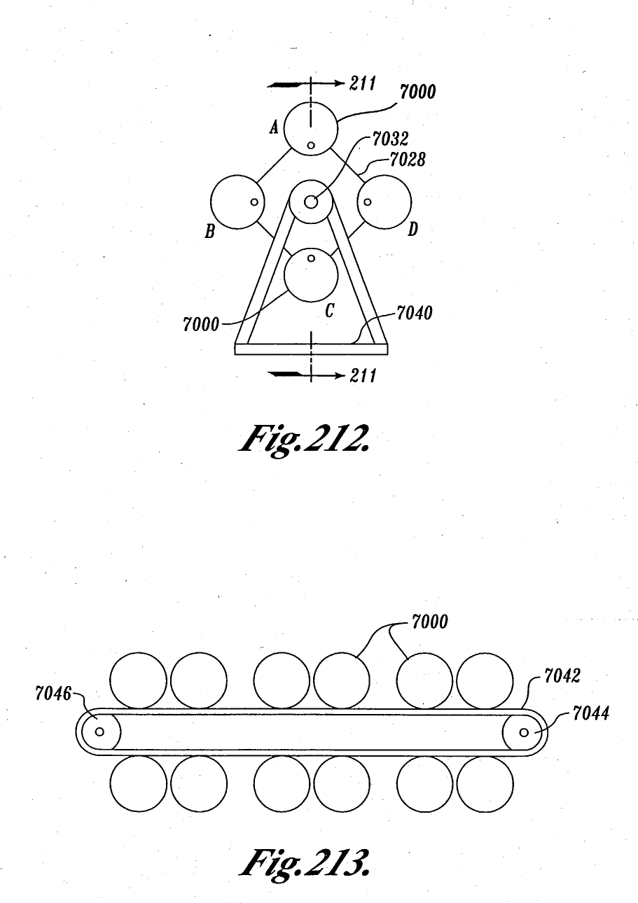

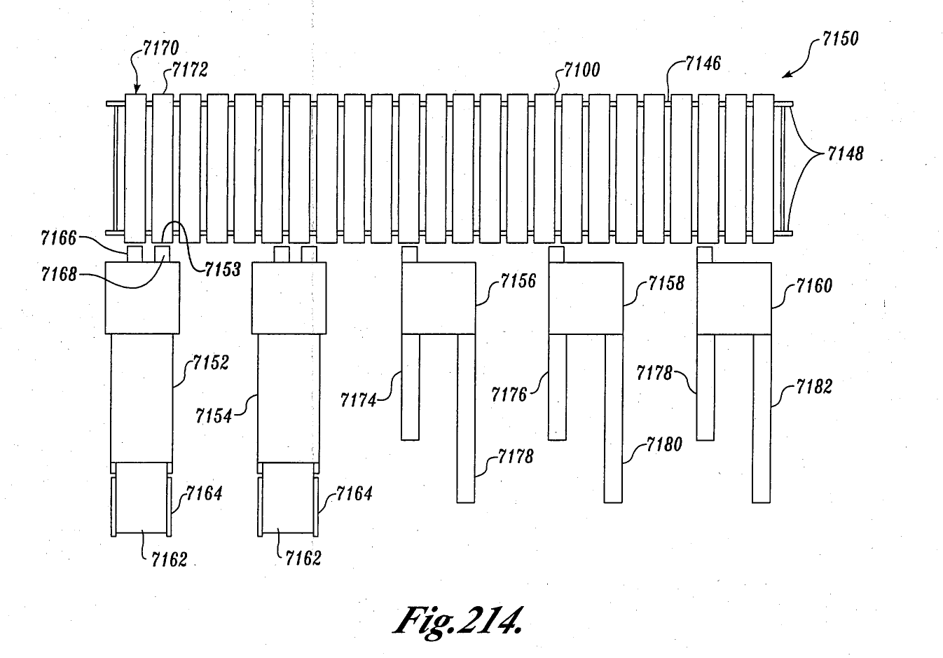

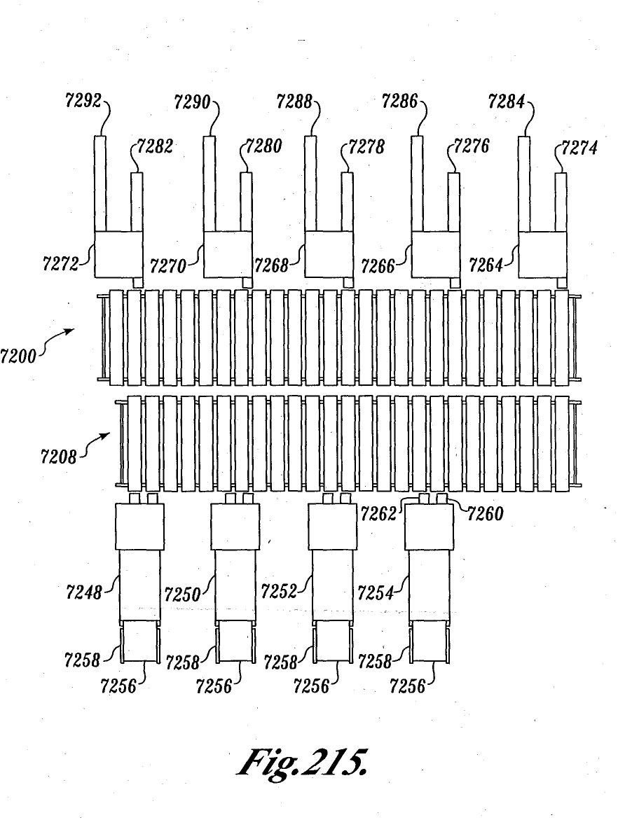

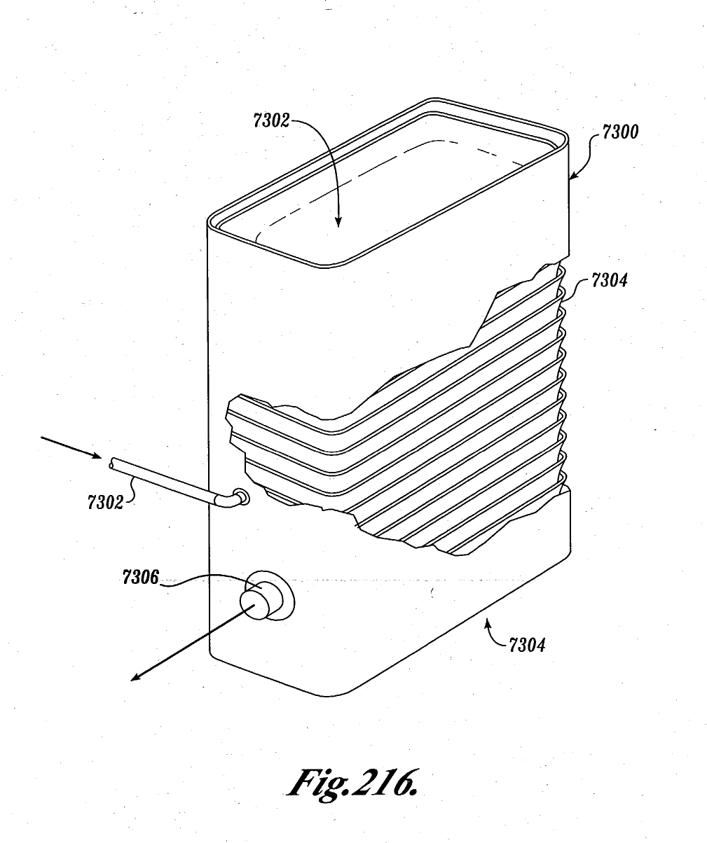

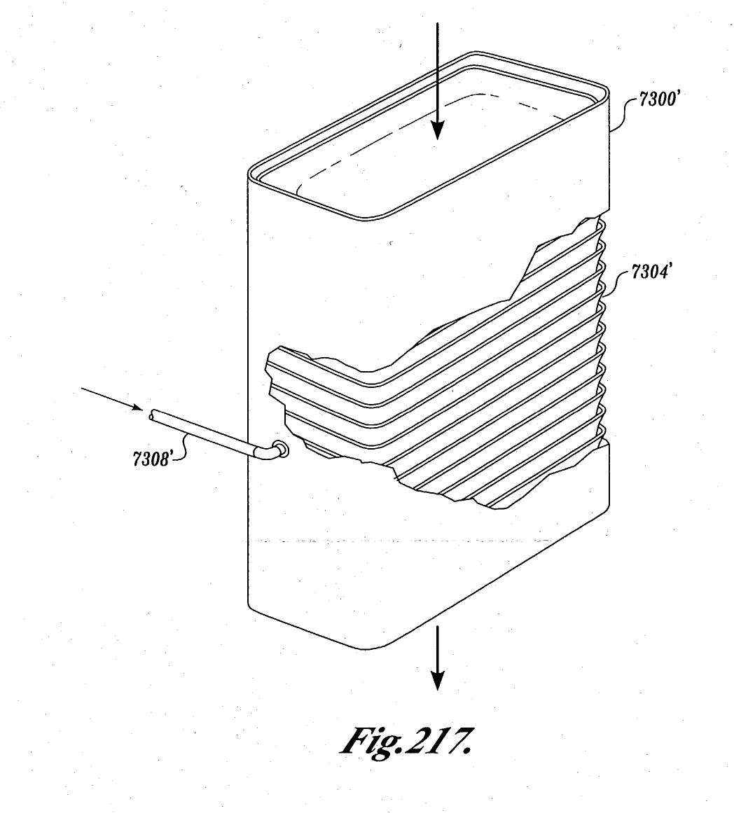

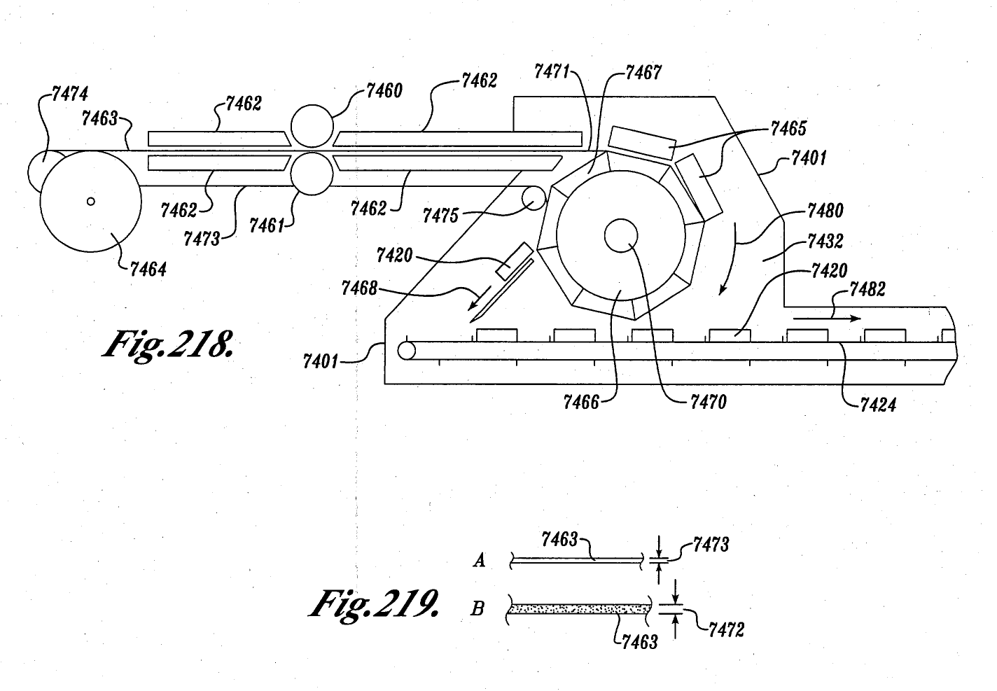

Referring now to FIG. 212, an adjustable container arranged to provide a desired internal profile that can be used to contain, and thereby mold, a suitable cut of meat that has been separated by cutting from an animal carcass immediately after slaughter of the animal and prior to rigor mortis of the animal carcass. FIG. 212 shows details of a molding assembly apparatus constructed according to the present invention including an adjustable container 2830, constructed from any suitable metallic or plastics material, that provides a desired internal space with a suitable profile, is shown. Apparatus can be used to contain in the internal space, and thereby shape by molding to the profile therein, any suitably cut meat primal, that has been separated by cutting devices from an animal carcass immediately after slaughter of the animal and prior to rigor mortis of the animal carcass and primal cuts. The apparatus may be arranged in any suitable manner including the arrangement shown in FIG. 212 which is constructed from four components, including a “trough” shaped member 2832, a mating closure 2834 and two identical plugs 2836. Plugs 2830 are profiled to act as “pistons” in a conduit that is arranged by assembly of the components 2832 and 2834. The conduit includes member 2832 with mating member 2834 which, when in a closed and operating position, has an irregular cross-section profile and the “piston” like plugs, 2836 are arranged to sealingly fit, closely within the conduit. The conduit has parallel horizontally disposed walls that provide the conduit along which the “piston” like plugs can be positioned at any desired location within the conduit and thereby providing a space, between plugs 2836, into which item 2838 can be located. The apparatus is arranged to be stackable and the lower, outer surface of member 2832 is profiled to mate with the upper external surface of member 2834 by “nesting” therewith when stacked in a vertically arranged column.

A suitable (pre-rigor mortis) primal cut of meat, 2838 such as a New York Strip primal, can be placed in trough 2832, with plugs 2836 positioned, one at each end of primal, to provide a defined space with primal located therein. Member 2832 can be mated with member 2832 and closed so as to contact plugs 2836. Members 2832 and 2834 can be fixed in position relative to each other and plugs 2836 can be moved, by mechanical powered devices and under pressure toward each other so as to compress item 2838 to the extent required that will cause item 2838 to adopt a profile identical to the internal profile of the space defined by members 2832 and 2834 and plugs 2836. Assembly including members 2832, 2834 and plugs 2836 with item 2838 contained therein can be fixed by any suitable method to a finished configuration and stacked with other similar assemblies such as on any suitable pallet. Pallet with assemblies stacked thereon, can then be re-located into a temperature controlled chamber. Temperature controlled chamber can be set at any suitable temperature that may be elevated up to not more than about 140 degrees F. for a selected period of time after which the temperature may be gradually reduced to about 29.5 degrees F. Item 2838 will therefore cool and rigor mortis will cause “setting” of the profile of item 2838. Item 2838 can then be removed from molding assembly and sliced. Slicing can be conducted automatically while located inside an oxygen free chamber and with carbon dioxide or any other suitable gas or blend of gases provided at any suitable pressure, present therein.

In another preferred embodiment smaller portions of pre-rigor boneless meat such as beef can be placed into the container assembly and processed therein in such a manner that will result in smaller pieces of pre-rigor boneless meat adhering together to form a single piece that can then be sliced into consumer desirable slices. Pre-rigor boneless beef may include portions of fat and muscle tissue that can be placed into the container, prior to processing, in any desired arrangement such that after processing, the single piece of meat will have a similar appearance to a primal such as a New York strip. In this way, less valuable smaller pieces of boneless beef can be used to produced larger and more valuable primal cuts of beef.

Containers and Plugs for Shaping Meat Primals

FIG. 215 shows a container and plug 3802, which may be manufactured by injection molding and from a plastics material such as nylon or alternatively a gas permeable and porous material such as a chemically foamed polypropylene or polyester plastics materials may be manufactured from a stainless steel mesh. Preferably, a plurality of profiles of the containers and plugs that facilitate an adjustable volume feature will be required in order to provide for all primal shapes and sizes. For example about 80 different containers and plugs would be required to accommodate all of the various shapes of primal meat portions that are typically produced in the disassembly of a single beef cow.

The container may typically include a rectangular, round or oval plan profile with a flat bottom and substantially vertical walls extending upwardly from the base. The base and walls are continuously attached at a suitably radiused confluence. One, two or more lugs 3804 can be conveniently located, one or more on each opposing side of the container to locate the container onto rails 3800 so as to retain and hold the container in a desired position at a desired height from the floor. The rails may be arranged with an electrically or pneumatically powered driver to move or slide the container along the rails, to another position for further processing such as placing the plug 3802 in position by automatic or mechanical apparatus, after loading the primal into space 3808. The consistency of the material from which the container is manufactured can be such that it will deform slightly when subjected to pressure but will return to its original shape when the pressure is released. A bevel 3810 is provided as shown so as to facilitate an easy penetration by the plug 3802 or 3812, into the opening in the container.

The plug may be provided in various profiles. An alternative plug 3812 is shown in FIG. 216 with additional details shown in enlarged cross-sectional view of FIGS. 218-219. The plug includes a “rigidly” flexible, relatively shallow (shallower than the container 3800), “cup” shaped plug, with a flat or suitably profiled face 3814, and upwardly extending, flexible walls 3816 with tapering thickness, flaring outwardly and terminating at a rim 3818. The flexible walls can be provided at an angle of about 5 degrees from vertical relative to horizontal face 3814. The upwardly extending walls are joined to the plug face 3814 with a suitable radius therebetween as shown. The upper rim 3818 of the plug wall is tapered to provide a thin cross-section at the outer edge of the lip and is flexible. An additional rim 3820 located on the opposite side of recess 3822 as shown, that follows a path around the perimeter of face 3814 thereby providing a recess. Slots 3824 are provided through rim to a depth equal to the height of the rim such that the base of each slot is on the same plane and level with face. Slots allow liquids such as liquid purge and blood to escape therethrough and then between the flexible walls of the plug and the inner surface of the container 3800. A controlled and pre-determined pressure P can be applied to the plug 4101 as shown in FIG. 221 so as to cause the liquid purge to be expelled from space 4107 through sides 4105. The pressure P is equal to the weight W of red meat primal contained therein multiplied by a constant x. Constant x is determined by the type of meat being processed and could be equal to W, or several times W and is determined by customer quality requirements.

The profile and dimensions of the plug are arranged so as to provide an easy penetration into the matching opening of the corresponding container, however, as the plug penetrates the container opening, the tapered disposition of the walls provides for intimate contact and sealing between the rim 3818 and the inner surface of the container vertical walls. The container and plug, when assembled together as shown in FIG. 216 provide an enclosed space 3808 that is substantially sealed and isolated from external atmosphere. The space 3808 has a volume that can be varied within the limitations of the container, by moving the plug position, relative to the container. Preferably, however, the intimate contact between the rim 3818 and the inside surface of the container walls is maintained in a substantially “airtight” fashion.

More specifically, according to this present invention, the pre-rigor mortis primal meat portion, having been de-boned, is sprayed, washed or dipped in a solution including one or more of the following: carbonic acid, acetic acid, ascorbic acid, citric acid and any other suitable substance that can be used to inhibit or eliminate bacterial growth on the primal meat portion. The primal meat portion is then placed into the container of correspondingly suitable dimensions and the plug is inserted into the open end of the container. The assembled container, primal meat portion and plug can be located with the lugs engaged onto the rails and positioned directly and in alignment above the press base. The press base is elevated so as to closely retain the container as shown. The wall 3830 is lowered so as to engage with the outer surface of the upper portion of the container walls as shown in FIG. 216. Clamp 3832 is then lowered and penetrates opening of the container with radius 3834 engaging with bevel 3810 and stretching the container opening outwardly thereby clamping it against the inner surface of wall 3830 and providing an airtight seal therebetween. Wall 3830 can be attached to an upper plate (not shown) forming a chamber that is isolated from external air. A vacuum source is attached and air is evacuated from between clamping assembly and plug. Progressively, 3836 is lowered so as to compress the plug against primal 3838, followed by clamp 3840 and finally clamp 3842 is lowered. Clamps 3842, 3840, 3836 are then in contact with the upper surface of the plug and all applying suitable pressure. The vacuum source is then disconnected, allowing atmospheric air to apply pressure to the outer surface of the plug. In this manner, substantially all air can be removed from within the container assembly.

The container assembly is opened as follows: A port 3844 is shown in the container base. The port is provided to allow connection to a source of compressed clean gas or clean air. The compressed gas can then be injected through the port and assist in the removal of the primal when desired or after the primal has been stored in the container for a desired period of time.

The assembled container and plug with the primal contained therein may be immersed into clean water, brine or other suitably treated, bacteria free, temperature controlled medium that is temperature controlled by refrigeration. Following the desired reduction or elevation of the primal temperature the container assembly can be relocated within an ultra high pressure (UHP) chamber and exposed to an ultra high pressure on the order of about 30,000 psi to about 100,000 psi or more. This procedure can tenderize the primal and also kill bacteria that may be present. UHP equipment used may be similar to such equipment manufactured by Flow International, Incorporated of Kent, Wash., USA.

Alternatively, sequentially or simultaneously, the container assembly can be attached to an electrical source so as to pass a high voltage current through the primal and thereby treat by way of “Ohmic” heating. Preferably, any bacteria that may be present with the primal can be substantially eliminated or killed.

The container and plug assembly can then be removed from the pressure chamber and again immersed in a cooling medium when the temperature of the primal can be reduced to a desired and optimum temperature prior to removal from the container and followed by automatic slicing. In this manner rigor mortis occurs so that the shape of the primal meat portion after cooling within the container is similar to the inner profile of the container, providing a more efficient shape for slicing with automatic slicing equipment.

In another preferred embodiment the container may be arranged and used to process several, smaller, (thinner) fresh primals simultaneously. This can be achieved with the use of partitions or separating plates. The separating plates can be interposed between the smaller fresh primal portions in an arrangement that can include placing a first primal into the container followed by a separating plate, followed by a second primal, followed by a second separating plate, followed by a third primal, followed by a plug. Any quantity of fresh primal portions, that can fit within the container, can be processed in this manner.

Containers and Plugs for Shaping Multiple Meat Primals

In another preferred embodiment, the container may be arranged and used to process several primals simultaneously. FIG. 217 shows an assembly constructed according to the present invention that includes container 3900, a first 3902, second 3904 and third 3906 primal with first 3908 and second 3910 separating plates therebetween. The plug is shown in position after insertion and all air has been removed from the space between the container base and the plug 3812. The assembly can then be immersed in cooling medium for further processing and chilling.

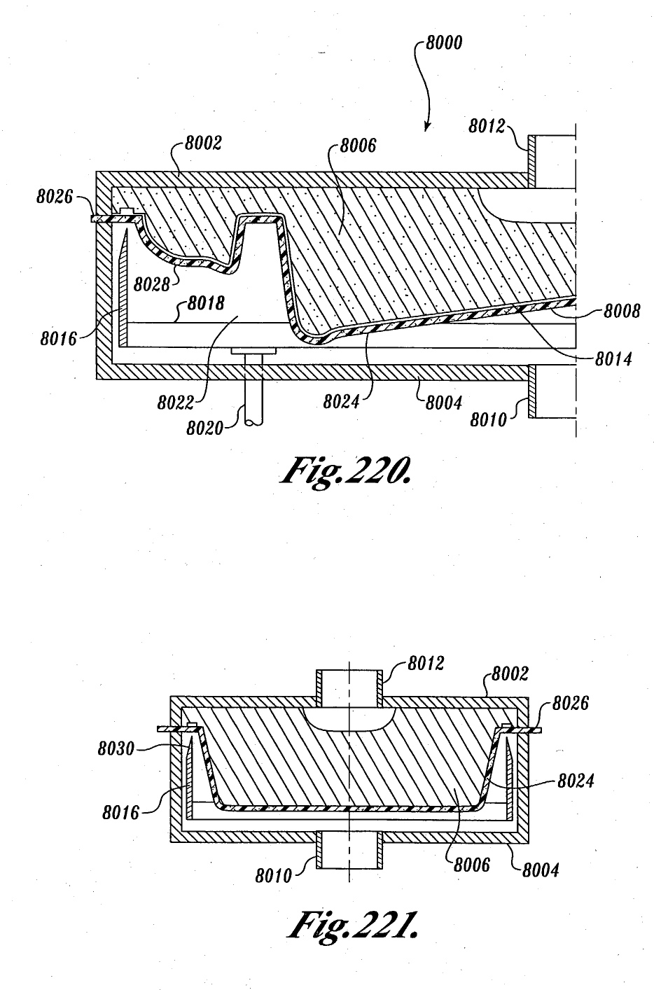

In yet another preferred container embodiment, the container may be arranged and used to process several primals simultaneously without the use of separating plates. FIG. 220 shows detail of a cross-section through an assembly constructed according to the present invention that includes a container 4000 with a first 4002 and second 4004 tenderloin contained therein. The plug 4006 is shown in position after insertion and substantially all air has been removed from the space between the container base and the plug. The assembly can then be immersed in a cooling medium for further processing and chilling. This process can provide an apparatus of attaching two tenderloins together to produce a single tenderloin of uniform profile and cross-sectional shape. The tenderloin can then be removed and sliced into slices of equal profile size and weight.

In yet a further preferred embodiment, the primal meat portions can be removed from the container 4100, after chilling and rigor mortis, and sliced automatically and without separation of slices. Preferably, after slicing and while still generally held together in a single item, the sliced primal meat portion can be placed into a preformed gas barrier bag and sealed therein or alternatively placed into a gas barrier packaging tray that has been automatically thermoformed, in-line on a machine such as a Multivac R530 (Manufactured by Multivac Sepp Haggenmuller GmbH & Co. The gas barrier packaging tray can be profiled and shaped so as to be similar and/or identical in internal profile to the container 4100. The gas barrier packaging tray can then be located into a vacuum chamber and a substantially gas barrier lid, that may be a skin vacuum package (otherwise known by those skilled in the arts, as SVP), and conveniently heat sealed therein at flanges around the cavity of the gas barrier packaging tray. Preferably, a hermetically sealed primal meat portion package can be produced that contains the primal meat portion that has been conveniently sliced according to a customer specification and requirement. The vacuum or SVP packaging process, that can be automatically performed with the use of R530 can rapidly and automatically produce a plurality of the hermetically sealed primal meat portion packages can be stored in temperature controlled storage conditions. Preferably, a hermetically sealed primal meat portion package can be further processed by UHP apparatus prior to sale and delivery to customers.

Plant Layout

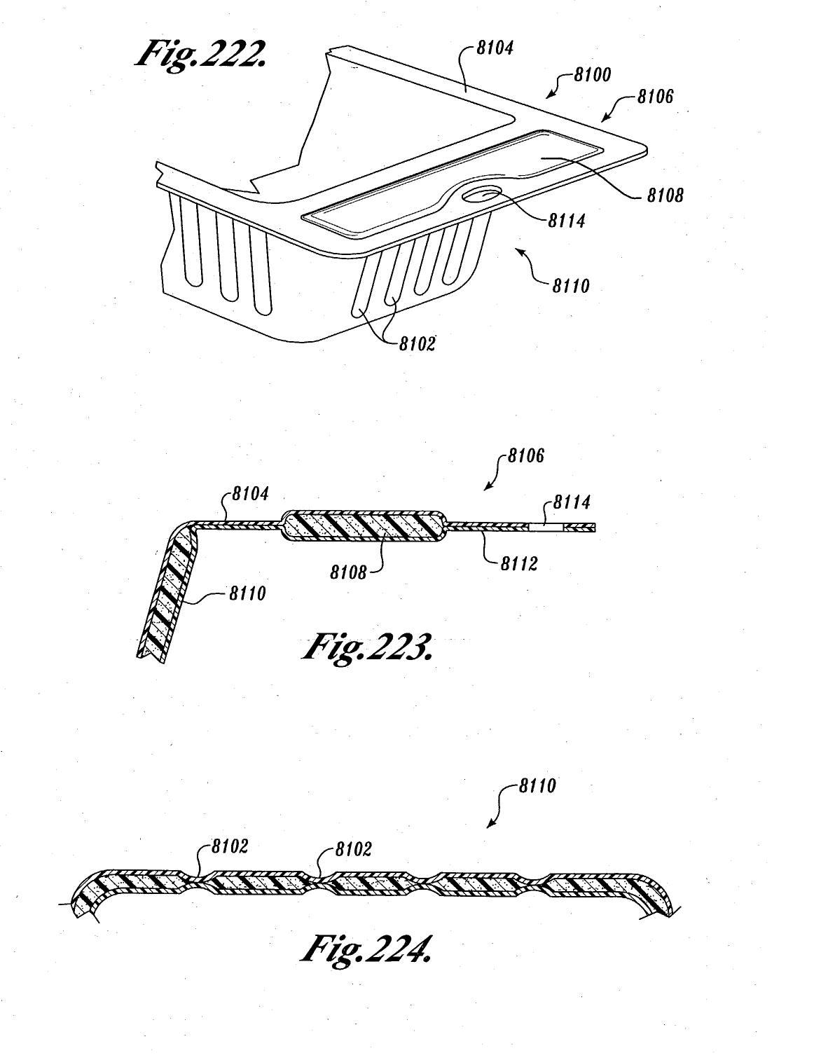

Referring now to FIG. 222, a preferred equipment layout according to the present invention includes three rectangular components being identified by the reference numeral 3350. Preferably, the equipment includes three similar components. Each component is arranged to form a horizontally displaced, rectangular or square tube with doors at each end. The tube is conveniently position so that access to the doors at each end of the tube can be accessed for loading of packaging materials into the tube. When the doors are shut, the tube is sealed to provide a fully enclosed container or enclosure in which the EPS or FP trays can be stored. Conveniently located ports are provided into the walls of the tube such that suitable gasses can be introduced as required within the tube thereby displacing substantially all atmospheric air and most particularly atmospheric oxygen there from.

The tube is loaded with quantities of EPS and/or FP trays and the doors are closed to provide a sealed container. Most preferably nitrogen, other inert and/or any other suitable gasses are provided into the tube so as to displace substantially all air from the interior of the tube and thereby providing a condition where the gas is in contact with the surface of the EPS and/or FP trays. Preferably, an ozone generator may be installed and chlorine gas may be provided within the enclosure. Any gasses and most particularly oxygen, that may be present within the cells of the trays can therefore freely diffuse and exchange with the gas in contact with the tray surfaces. With the passage of time, gas contained within the cell structure of the tray walls will therefore be displaced with gas in contact with the outer surface of the trays. Preferably, oxygen gas will be substantially removed from the cell structure. Oxygen will gradually accumulate and the level of “free” residual oxygen remaining in the tube can be monitored by automatic gas analysis and maintained at a minimum and desired level. This is achieved by extracting gasses from within the tube at a point near an end of the tube while providing an equal quantity of additional oxygen free gas into the tube at a point near to the opposite end of the tube from the extraction point at the other end of the tube.

Equipment 3302 is a tray sealing apparatus which is arranged to produce packages, including tray, web and perishable goods contents shown as ground meat. The perishable goods may be portions of beef, pork or any other suitable perishable goods.

Referring now to equipment 3318, a representation of an apparatus is shown for producing substantially gas barrier “master containers” from a roll of suitable material 3316. Equipment 3318 may be a Multivac R 530 that has been adapted to suit the production system of the present invention. Equipment 3320 shown at can be provided for (optionally) locating an oxygen absorber into each master container with the retail packages before sealing a barrier lid to the master container. The barrier lid material 3322 includes a roll of the barrier plastics lid material.

Apparatus 3334 shown in FIG. 222 represents a typical carousel style vacuum packing machine, such as an “Old Rivers” equipment that has 8 vacuum chambers fitted thereto. The carousel style vacuum packing machine, 3332, is shown fitted with 8 vacuum chamber assemblies similar to that as shown in FIG. 223 and described herein. Referring now to FIG. 223, a closed vacuum chamber 2700 including upper vacuum chamber 2702 and lower vacuum plate 2704 is shown. A rack 2700 with 2708 trays containing perishable goods, red meat, are shown inside closed vacuum chamber 2700. An evacuation port 2710 in direct communication with a source of vacuum is provided. A switch is attached to the vacuum source so as to provide on/off control. Two continuous and concentric ‘O’ rings 2712 are located between the edges of 2702 and 2704 and spaced apart providing a space 2714 therebetween. The distance between ‘O’ rings is arranged such that when multiplied by the length of space 2714 the total projected area between the concentric ‘O’ rings can be calculated. Total projected area shall therefore be equal to PI×‘L1’. When a vacuum is applied to port 2710, the closing force created between 2702 and 2704 can be determined. Assuming that vacuum can be represented in terms of 80% of atmospheric air pressure, at approximately 14 psi, then the chamber total closing force, in pounds, would be equal to DI×LI×0.8×14. A gas or blend of desired gasses can be provided within the closed vacuum chamber at a pressure above atmospheric pressure which will provide a chamber opening force. However, in this arrangement, the closing force can be arranged to exceed the opening force thereby providing a method of maintaining a pressure with the closed chamber at a level above that of the prevailing atmospheric air pressure while the closed vacuum chamber remains closed due to the closing force provided. A further evacuation port 2716 is provided in 2702 and a gassing port 2718 is provided also. The upper vacuum chamber 2702 is arranged so that it can be lifted vertically upward and away from 2704 allowing removal of the rack with trays and another rack with trays can be placed therein such that a continuous production process can be undertaken. The upper vacuum chamber 2702 and the lower vacuum plate 2702 may be arranged with clamping and structural supports so as to allow an increase of gas pressure to gas provided therein to any desired pressure such as 500 psi or more.

Perishable goods are located in an EPS (foamed polystyrene) tray with inherent or enhanced gas permeability. A gas permeable web is positioned above the EPS tray. The web has adhesive applied to the region of the web that will come into contact with flanges of the tray so as to provide a seal between web and tray. The web is then sealed to the flanges of the tray. The flange of the tray may be compressed as shown to provide improved structural integrity and strength.

The EPS tray with inherent or enhanced gas permeability can quickly transfer, remove and exchange substantially all oxygen gas from foam cells during “carousel evacuation and gassing process”.

The web may be printed on one or both sides with panels that can be seen from the upper side after sealing to the tray. A bar code can be applied to label on the underside of the package. The bar code can include code information such as the specific weight of tray contents, date packaged and type of content goods. Information can be read by a scanner at any time after packaging and converted to consumer readable information that can be printed by, for example, ink jet printers onto the panel prior to retail display.

A device to cause oscillation of gas pressure within the chamber at a frequency that will cause improved and more rapid exchange of air and oxygen contained within cells of EPS tray with desired gas provided in chamber, can be provided. Furthermore, the oscillation of gas pressure within the chamber, can cause the permeable web to raise and lower and provide a space between the web and upper surface of the goods thereby allowing the gas provided in the chamber to directly contact the tray contents beneath the web. Oscillation can also provide improved contact with the goods and enhanced absorption of the gasses by the goods. The oscillation may be set at a range of gas pressures that are above or below prevailing atmospheric pressure. The gas may include other substances in vapor, atomized or powder form and the composition may be selected and include the most suitable blend of one or more of the following: nitrogen, oxygen, argon, carbon dioxide, hydrogen, krypton, neon, helium, xenon, O₃, F₂, H₂, O₂, KMnO₄, HClO, ClO₂, Br₂ and I₂.

A desirable blend of gasses such as carbon dioxide and ozone can be provided within the closed chambers 2702 and 2704 with the rack with trays contained therein.

Referring now to FIG. 223, racks with trays can be automatically loaded into open vacuum chambers 3332 which are then closed. A vacuum source is then applied to port 2710 and a desired gas provided into closed vacuum chambers after removal of atmospheric air there from. The carousel is rotated, intermittently, in the counterclockwise direction shown in FIG. 222 and stopped such that after each vacuum chamber assembly 3332 has fully traveled around the perimeter of the carousel the rack with trays can be automatically removed from each vacuum chamber and replaced with another. Therefore a continuous and automatic process of treating trays containing perishable goods with desired gasses can be provided.

Referring now to equipment 3326, a diagrammatic representation of an automatic carton erecting, filling and sealing equipment is shown. A supply of cartons is also shown as 3324.

Referring now to equipment 3328, a representation of an automatic carton palletizer, such as model FL 100 manufactured by Columbia Machine, Inc., Vancouver Wash., is shown. The palletizer is arranged to automatically palletize finished cartons of packaged perishable goods with a supply of empty pallets 3330. Finished cartons can be automatically transferred from equipment 3326 to the palletizer 6.

Equipment 3334 is a representation of equipment configured to locate tray flange covers prior to loading of the perishable goods into the tray. The flange covers are described in Australian patent application PM8415. Equipment 3308 is a representation of a section of the packaging equipment that is exposed as require to facilitate efficient loading of the perishable goods into the trays. Equipment 3310 is a representation of equipment configured to remove tray flange covers and as generally described in Australian patent application PM8415. Equipment 3306 is a representation of the direction of flow of an alternative perishable goods to be optionally loaded into the trays.

Equipment 3336 is a representation of equipment configured to receive, grind, condition and process meat and other similar perishable goods like the one shown in FIG. 186. Equipment 3340 is a meat grinder. Equipment 3342 is a pressure vessel. Equipment 3344 is a secondary meat grinder. Equipment 3346 is a pressure vessel. Equipment 3338 represents the perishable food item, such as portions of meat, that is to be processed and packaged. Equipment 3304 is a diagrammatic representation of equipment configured to locate tray flange covering members prior to loading of the perishable goods into the tray. Equipment 3308 is a diagrammatic representation of a section of the packaging equipment that is exposed as require to facilitate efficient loading of the perishable goods into the trays. Equipment 3312 is a representation of a roll of plastics lid material intended for sealing to flanges of the trays after perishable goods have been placed therein. Equipment 3314 is a representation of an optional feature and equipment for locating labels onto the underside or, after adjustment, upper side of the retail packages after sealing of lid material to flanges of the trays. Equipment 3318 is a representation of an apparatus for producing substantially gas barrier “master containers” from a roll of suitable material 3316, locating an optional oxygen absorbing material into each master container with the retail packages and sealing a lid to the master container that is unwound from a roll of plastics lid material shown as 3322. Equipment 3334 is a representation of a typical carousel type vacuum packaging machine that has been modified according to the description provided herein, and located adjacent to both packaging equipment items 2 and 3, so as to facilitate easy transfer of finished packages therebetween. Equipment 3332 is one of 8 vacuum chambers mounted to the carousel and as shown in FIG. 223. Equipment 3326 is a representation of an automatic carton erecting, filling and sealing equipment with a supply of cartons 3324. Equipment 3328 is a representation of an automatic palletizer.

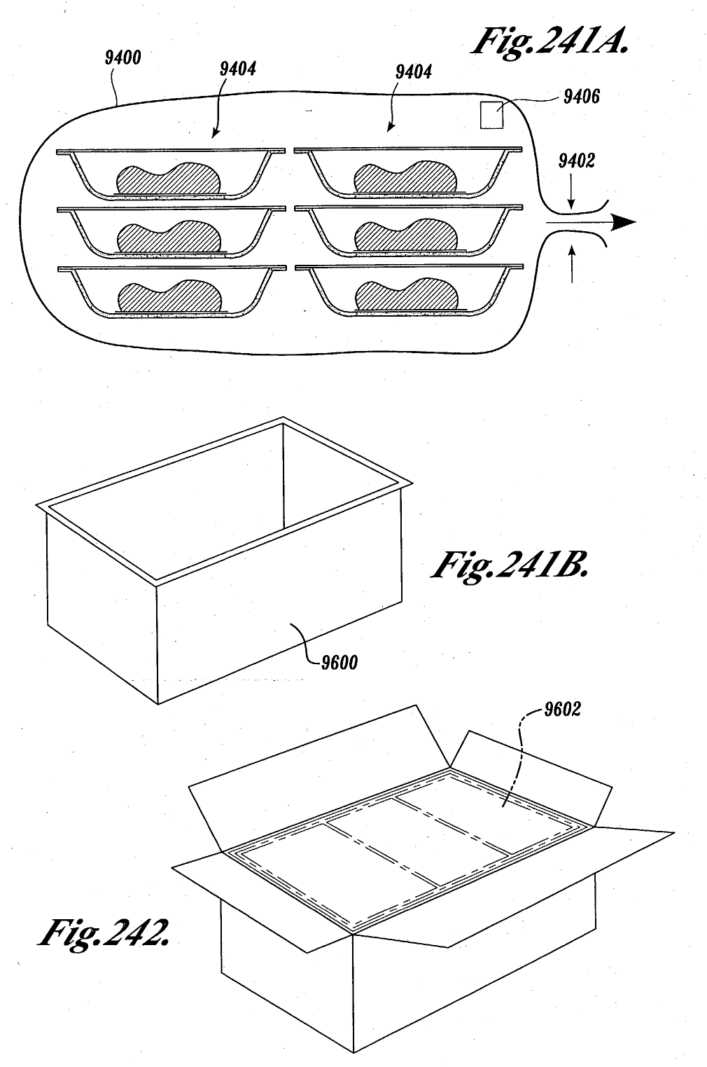

Equipment 3300 is a representation of equipment configured to exchange air and more particularly, atmospheric oxygen, contained within the cell structure of foamed polystyrene trays (EPS trays) and foamed polyester trays (FP trays). FIG. 240 shows a cross-sectional side view of half of the arrangement and FIG. 241 shows a cross-section across the full width of the arrangement, through parts of a preferred apparatus and packaging.

Equipment 3350 is a diagrammatic representation of an alternative equipment configured to exchange air and atmospheric oxygen, contained within the cell structure of foamed polystyrene trays (EPS trays) and foamed polyester trays (FP trays).

Thermoforming Apparatus

Referring now to FIG. 224, a plan view of equipment layout according to the present invention is shown that can be used to produce trays constructed according to this invention.

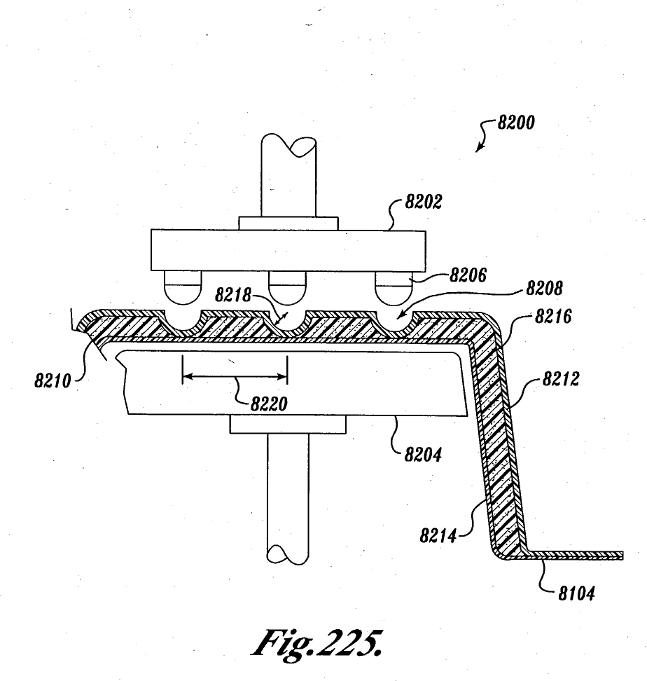

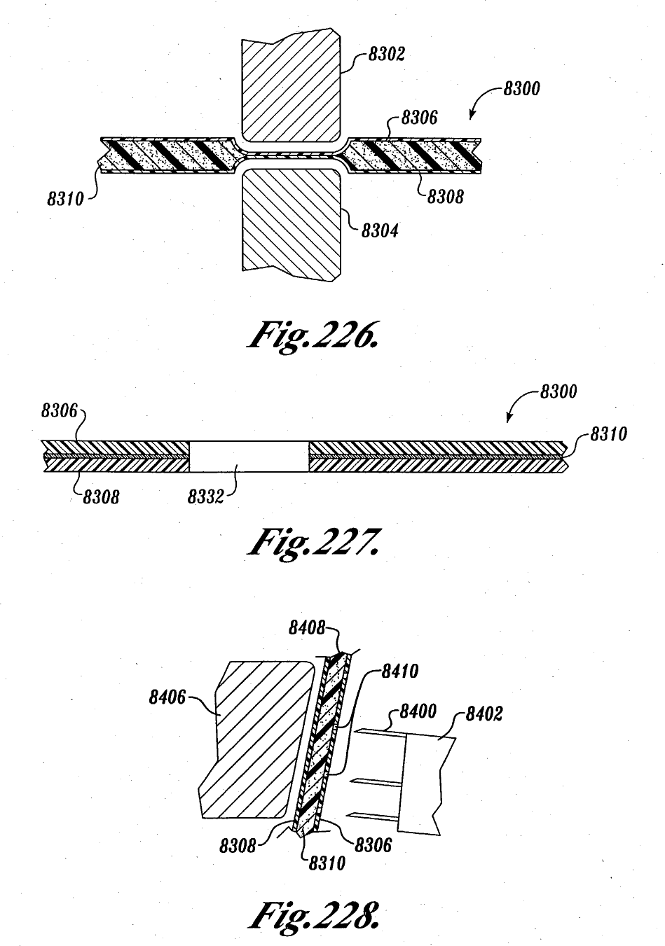

The equipment layout is shown in a convenient arrangement for the efficient production of the trays. Primary extruder 4600 is arranged adjacent to secondary extruder 4602 in a normal condition for production of expanded polystyrene foam sheet. Direction of flow is shown traveling toward wind-up mechanism 4604 with spool 4606 attached thereto. A roll of EPS sheet material 4608, is shown adjacent to tube 4610. Tube 4610 follows a path that is conveniently arranged parallel with tube 4612. A cross-section through tube 4610 is shown in FIG. 225. Tube 4610 extends to a point of termination adjacent to thermoforming machine shown as 4614. A second EPS foam extrusion system with primary extruder 4616 and secondary extruder 4618 is located adjacent to the first EPS foam sheet extrusion system 4600 and 4602. Second extrusion system extrudes sheet in direction of flow as shown and toward winder 4620, spool 4622 and roll 4624 adjacent to the entry end of tube 4612. The construction of tube 4612 can be identical to tube 4610. Tube 4610 and tube 4612 are parallel to each other and follow a concentric path such that 4612 terminates at an end in close proximity to thermoforming machine 4626. Tubes 4610 and 4612 follow parallel and concentric paths that spiral upwardly thereby providing an extended length of tubes 4610 and 4612 and contained within a convenient area.

Referring now to FIG. 225, a section through tube 4612 is detailed. Spool 4606 can be seen inside tube 4612 resting on belt 4628 and belt 4630. Belt 4628 and belt 4630 are held taught and arranged to engage with drive sprockets conveniently located so as to engage the belts. Belts can, thereby, carry spool 4606. Carrying members extend throughout the full length of tubes 4610 and 4612 thereby carrying spools 4606 through tube 4612 and 4610. A dish 4632 is mounted to a pneumatic cylinder 4634 such that when extended the dish can elevate the spool 4606 upwardly so as to lift the spool away from driving belts 4628 and 4630. Tube 4612 is shown mounted directly onto a floor, however the tube can be elevated above the floor by suitable frame members. Gas 4636 is provided in tube 4612, gas may be nitrogen gas. A three dimensional sketch of spool 4606 is shown with roll of material 4612 wound thereon. Spools 4606 can be loaded into the entry end of tubes 4612 and 4610 which are conveniently located adjacent to the winding members attached to foam extrusion equipment. Spools can be carried through tubes 4610 and 4612 on belts 4628 and 4630 that may be operating continuously. Dish 4632 is located conveniently between belt 4628 and belt 4630. Dish 4632 and spool 4606 can thereby be elevated, by activating pneumatic cylinder, upwardly and away from contacting belts 4628 and 4630. Pneumatic cylinder 4634 with dish attached thereto may be provided in sections that extend throughout the full length of tubes 4610 and 4612. By operating belts 4628 and 4630 with forward driving motion and pneumatic cylinder 4634 and dish, spools 4606 can be carried through tubes 4610 and 4612 according to demand.

Preferably, tubes 4610 and 4612 can be flooded with a suitable gas such as nitrogen or a blend of gasses including argon, carbon dioxide, nitrogen and a quantity of oxygen that does not exceed about 5% and is not less than about 1000 PPM of blend of gasses, through ports 4640 and 4612. Spools with rolls of EPS foam material can be stored in tubes 4610 and 4612 for a period of time as may be required in the normal aging of EPS foam material. This period of time may be in the order of twelve hours and accordingly the length of tubes 4610 and 4612 will be arranged so as to accommodate sufficient spools of material required for production of trays and also allowing for the twelve hour residence time as required. After storing the spools 4606 in tubes 4610 and 4612 quantities of spools can be removed from the exit end of the tubes adjacent to the thermoforming machines. Spools can be loaded onto the thermoforming machines and thermoformed trays with flaps can be manufactured, as required.

Referring now to FIG. 227, a cross-section through a thermoforming machine oven is shown. The oven includes a substantially sealed and enclosed rectangular tube with heaters 4633, 4635 arranged above and below EPS sheet 4631 that can be carried therethrough. The EPS sheet can be fed into the oven through a slot that is slightly larger than a cross-section through the EPS sheet. Tube 4646 is attached to the under section of the oven and tube 4644 is attached to the upper section of the oven. Gas can be provided at a pressure above the ambient atmospheric pressure, from a “nitrogen generator” directly into tube 4646. Gas can be extracted from tube 4644 that follows a path along path 4648 and through cooler 4650. Tube 4644 delivers the gas and an additional quantity of air along tube 4644 and into the nitrogen generator. The nitrogen generator generates nitrogen gas by way of separating oxygen from air and allowing only nitrogen to pass into and through tube 4646. Gas may be provided into tube 4646 directly from tube 4644 if required.

Referring again to FIG. 224, a plan view of tubes 4660, 4662, 4664, 4666 are shown passing through a wall. The tubes may be filled with a suitable gas. Fully formed trays with flaps can be loaded into the tubes for direct transfer and use on packing machines.

Preferably, the thermoforming apparatus herein described can be incorporated into the plant layout schematic of FIG. 222. Referring now to FIG. 228, a slight modification to a previous equipment plan is shown for producing trays according to the present invention. Equipment includes four tubes 4700, 4702, 4704, and 4706. Each item is arranged to form a horizontally displaced, rectangular or square tube with doors at each end. Each tube is conveniently positioned so that access to doors at each end of tube can be accessed for loading of packaging materials into tube. When the doors are shut, the tube is sealed to provide a fully enclosed container or enclosure in which the EPS or FP trays can be stored. Conveniently located ports are provided into the walls of the tube such that suitable gasses can be introduced as required within the tube thereby displacing substantially all atmospheric air and most particularly atmospheric oxygen there from.

Each tube is loaded with quantities of EPS and/or FP trays and doors are closed to provide a sealed container. Most preferably nitrogen, other inert and/or any other suitable gasses are provided into the tube so as to displace substantially all air from the interior of the tube and thereby providing a condition where gas is in contact with the surface of EPS and/or FP trays. Additionally, an ozone generator may be installed and chlorine gas may be provided within the enclosure. Any gasses and most particularly oxygen, that may be present within the cells of the trays can therefore freely diffuse and exchange with the gas in contact with the tray surfaces. With the passage of time, gas contained within the cell structure of the tray walls will therefore be displaced with gas in contact with the outer surface of the trays. Most importantly oxygen gas will be substantially removed from the cell structure. Oxygen will gradually accumulate and the level of “free” residual oxygen remaining in the tube can be monitored by automatic gas analysis and maintained at a minimum and desired level. This is achieved by extracting gasses from within the tube at a point near an end of the tube while providing an equal quantity of additional oxygen free gas into the tube at a point near to the opposite end of the tube from the extraction point at the other end of the tube.

Open and Closed Cell Structures

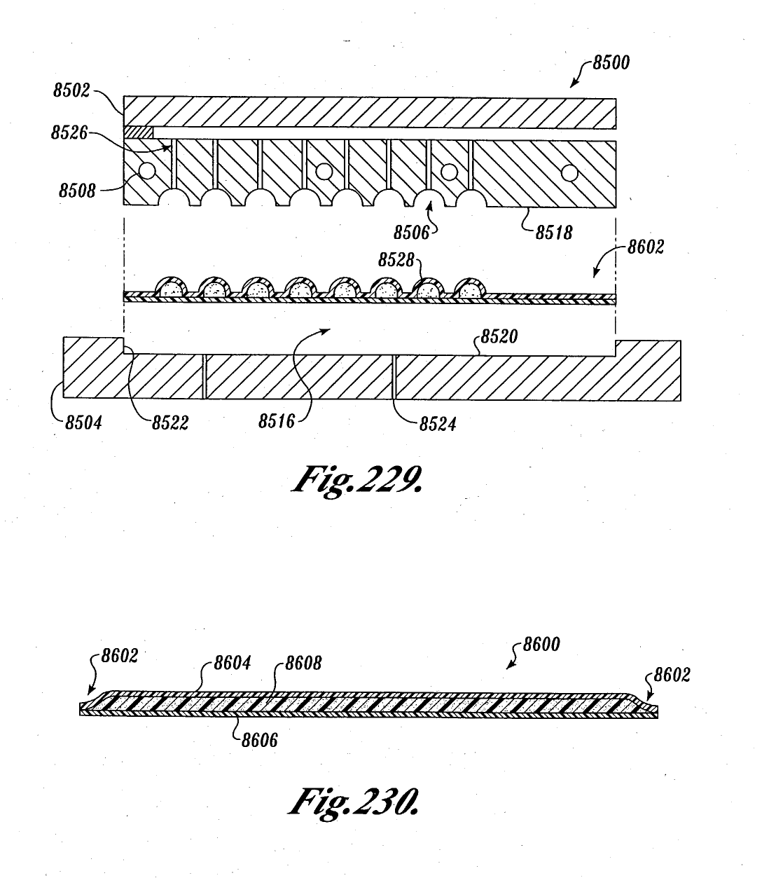

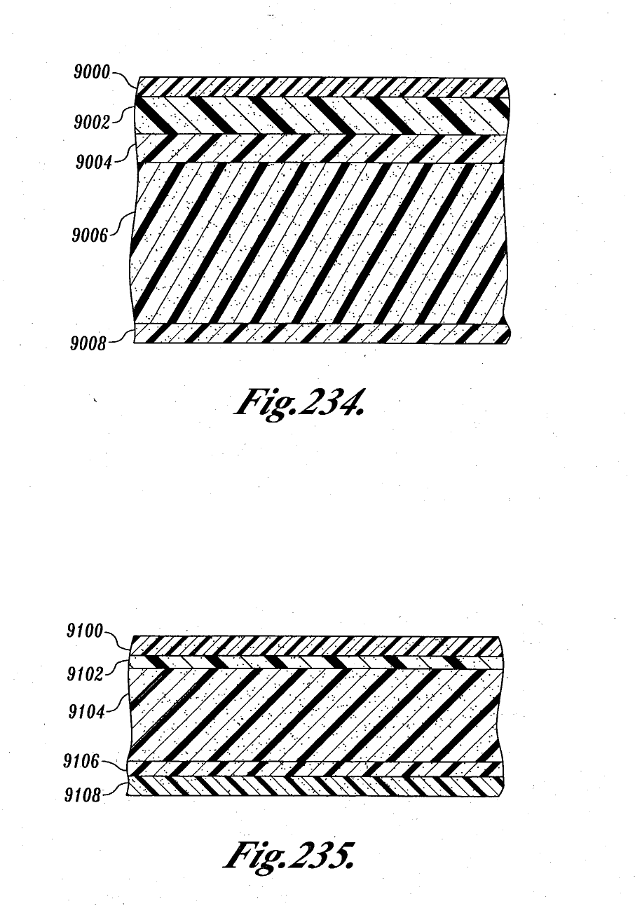

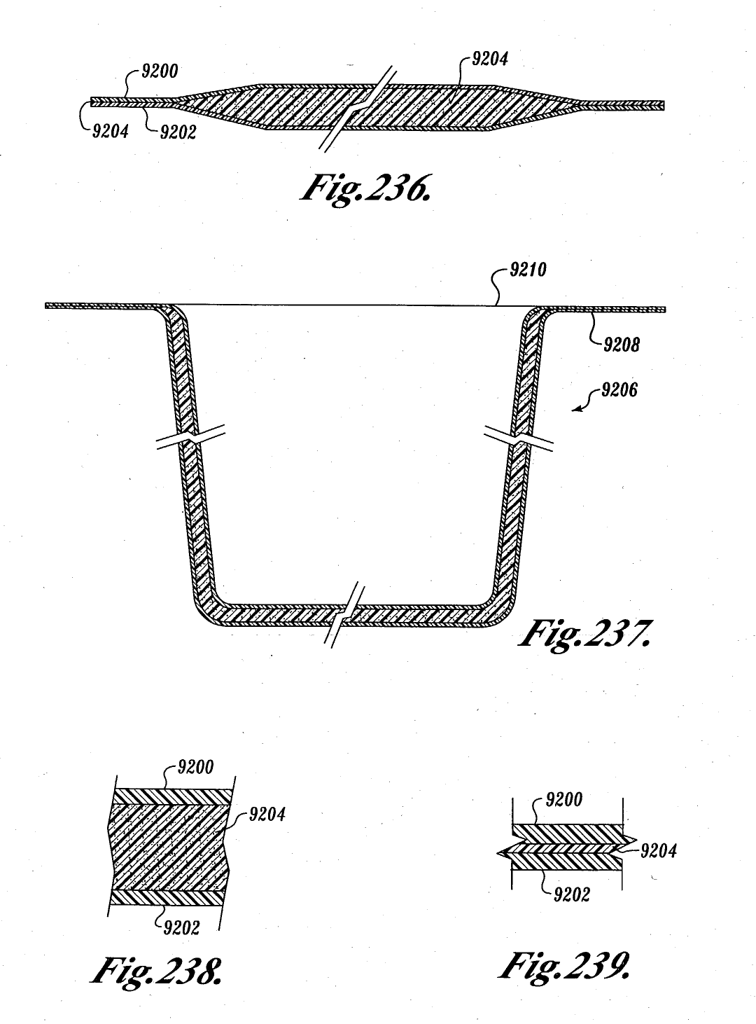

Referring now to FIGS. 229-237, cross-sectional and enlarged views of expanded polystyrene (EPS) foam sheet are shown, wherein FIG. 229 shows a cross-section through a portion of co-extruded EPS foam including three layers 4500, 4502 and 4504. FIG. 230 shows a cross-section through a portion of extruded EPS foam sheet including three layers 4506, 4508 and 4510 and wherein layers 4506 and 4510 include skin similar to the section shown in FIG. 233.

Referring to FIG. 229, outer layers 4500 and 4504 sandwich an inner layer 4502. Outer layers 4500 and 4504 include closed cell EPS foam as shown in FIG. 232. “Closed cell” EPS foam describes a physical condition where the cells or bubbles, that are filled with gas, generally include enclosed spherical spaces where the cell, bubble or sphere is not fractured and therefore any gas contained therein can enter or exit the spheres by diffusion through the spherical wall only and not through fractures or openings in the sphere wall. FIG. 232 shows a grouping of cells or bubbles that contain a gas which may be air. Layer 4502 includes a layer of open celled EPS foam as shown in FIG. 235. “Open cell” EPS foam is a physical condition where most cells or bubbles are fractured and allow gas and other matter to invade the internal space of the open cells readily. Production of open cell EPS foam can be effected by introducing contaminants into the polystyrene melt prior to foaming. The contaminants may include a surfactant to enhance liquid absorbing properties, can cause fractures in the cell walls to appear. Closed cell EPS foam is produced by ensuring that there are no contaminants in the polystyrene melt prior to foaming. Closed cell foam generally provides a more mechanically stable and rigid structure than does open cell foam. Therefore in order to produce a more mechanically stable and rigid packaging tray, closed cell polystyrene is a preferred construction material. However closed cell EPS foam resists absorbing liquids such as blood, water and purge. In order to produce a superior EPS foam packaging material that has both liquid absorbing and structurally sound properties use of a combination of both types of open and closed cell foam is preferable. A preferred material would include three layers of co-extruded multi-layer foam sheet where layers 4500 and 4504 include closed cell EPS foam and layer 4502 includes open cell EPS foam.

Referring now to FIG. 230 a cross-section through a preferred material is shown where a three layer material includes two outer layers 4506 and 4510 and a center layer 4508. Layers 4506 and 4510 are similar and include a skin that can be induced by exposing a mono extruded layer of EPS foam, before the foam has cooled and solidified, to relatively cool air applied thereto under regulated pressure. By applying the regulated compressed air in this way a skin can be formed by deflating the open or closed cell structure at one or both surfaces of the EPS sheet. The layer 4508 includes a layer of open cell EPS foam.

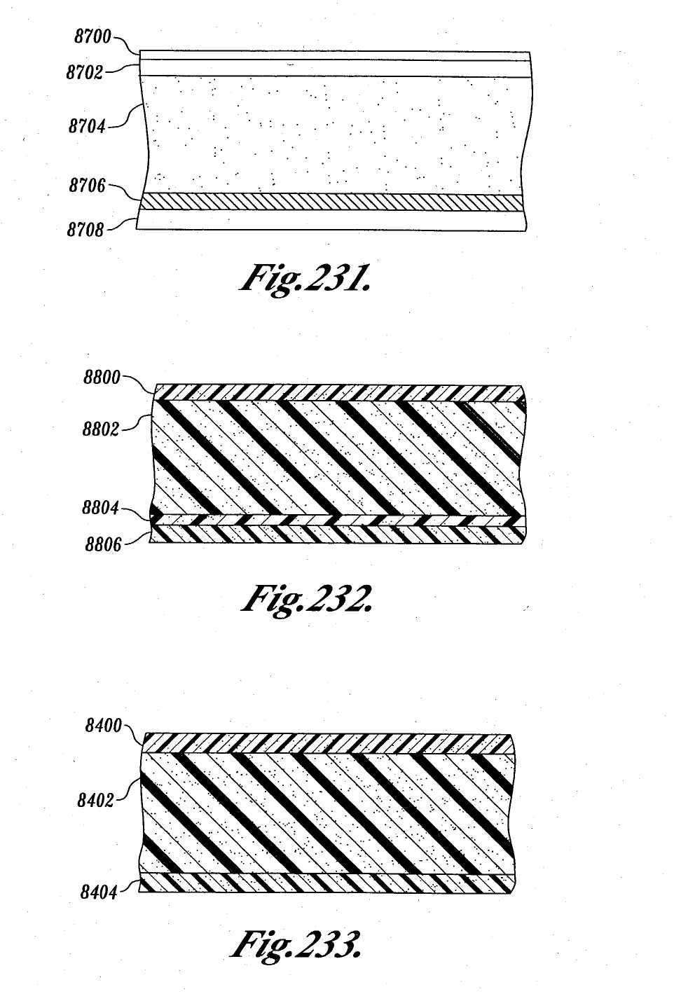

Referring now to FIG. 231, the closed cells are shown schematically, as being exposed to gas pressure that is higher than gas pressure inside the closed cells. Enlarged view of closed cell FIG. 237 shows a ratio of a pressure differential where P equals the external gas pressure and P1 the closed cell internal gas pressure. FIG. 234 shows a grouping of closed cell EPS foam cells where the internal pressure P1 is greater than the external gas pressure P.

The present invention to provides a method to substantially remove oxygen gas that may be retained within the cell structure of the EPS foam packaging materials and to also reduce the amount of oxygen and/or slow the rate at which oxygen may re-enter the cell structure after removal from storage and processing in a suitable gas. The following steps disclose a method that can be used to achieve this condition. Any or all of the following steps may be effected in the sequence shown or any other sequence that enhances the most efficient and rapid removal of undesirable gasses, including oxygen, from the structure of the packaging materials:

Place a quantity of EPS foam packaging materials, such as trays with flaps, in a gas tight and sealed pressure chamber, with evacuation and gassing ports therein and valves attached so as to allow evacuation and gassing, with suitable gas, of the pressure chamber as desired.

Provide a vacuum inside the pressure chamber, by lowering gas pressure therein, and maintain for a period of time so as to enhance the removal of oxygen from the structure of the packaging materials in a desired manner.

Introduce a suitable gas into the pressure chamber at an initial selected and suitable pressure that may be below ambient atmospheric pressure.

Maintain the selected and suitable pressure for a period of time that enhances the removal of oxygen from the structure of the packaging materials in a desired or optimized manner.

Progressively increase the pressure of the suitable gas in the pressure chamber, in a continuous or intermittent manner, over time, until the gas pressure is above atmospheric pressure.

Maintain the gas pressure for a period of time that enhances the removal of oxygen from the structure of the packaging materials in a desired or optimized manner.

By heating and/or cooling apparatus, maintain the temperature of the packaging materials and the suitable gas in the pressure chamber, at a temperature that enhances the removal of oxygen from the structure of the packaging materials in a desired or optimized manner.

During the process, described above, exchange the suitable gas, while maintaining the suitable gas pressure in the pressure chamber as required, which can continuously occur during the process, at a suitable rate of exchange to ensure that any undesirable gas, including oxygen, that may become present in the suitable gas, is substantially removed from within the pressure chamber.

Remove the packaging materials from the pressure chamber and allow the packaging materials to physically expand as can occur due to a higher relative gas pressure that may exist in the closed cell structure of the EPS packaging materials.

Maintain the packaging materials at a suitable temperature for a suitable period of time, after removal from the pressure chamber.

The steps disclosed above may be repeated, sequentially or otherwise and in a manner that provides an efficient process to remove undesirable gasses from the structure of the packaging materials and to enhance the expansion of the packaging materials in a desired manner.

In this way oxygen gas can be removed, from within the open and closed cell structure of EPS foam material, and replaced with the suitable gas at a pressure above atmospheric pressure. The packaging materials can then be used for packaging. The higher pressure within the closed cell structure can gradually equilibrate with that of the prevailing ambient atmospheric air pressure, however during this equilibration period the rate of re-entry of atmospheric oxygen into the structure of the packaging materials can thereby be reduced.

In another preferred embodiment, adhesives such as any suitable bonding medium may be applied to surfaces of the flaps of tray and the tray walls and base by any suitable “ink jet” apparatus. Furthermore, colored graphic printing and any desired information can be printed and/or applied to any desired surfaces of the tray and flaps by any suitable “ink jet” apparatus. The “ink jet” equipment is manufactured by several companies such as Hewlett Packard, Xerox, SciTex, Marconi/Video Jet and others. The equipment can be arranged to apply inks, lacquers and adhesive materials as required by, for example, arranging the ink jet equipment adjacent to a conveyor that can transport the trays with flaps at a suitable speed and in such a manner as to allow application of the inks and other materials to the trays and flaps, as required. The conveyor may be arranged adjacent to and integrated with thermoforming machinery such that immediately after producing trays with flaps, the trays can be automatically transferred onto the conveyor. The conveyor can be arranged to carry trays with flaps at a controlled speed and as required to allow application of inks and any suitable materials thereto by ink jet printer.

Tray Treatment Method and Apparatus for the Removal of Oxygen

Referring now to FIG. 238, details of an apparatus for storing foam (EPS or polyester foam) trays, for exchanging gas in cells with a preferred gas is shown. This apparatus provides a method to substantially remove any residual oxygen that may be retained in the cell structure of EPS packaging materials intended for use in packaging fresh red meats in a “low oxygen” master container, case ready packaging system. The method disclosed herein can provide a process to remove and replace the residual oxygen, with a desired gas, more rapidly than occurs when the EPS packaging materials are stored in a chamber containing desired gas in a static condition at ambient atmospheric pressure. The apparatus includes a rectangular or suitably profiled tube 4200. The tube 4200 is arranged to have two open ends 4202 and 4204, one at each end of the tube 4200. The tube is provided with evacuation port 4206 and gas entry port 4208. The tube can be filled with precut foam (EPS) trays with flaps, or sheets of foam 4210. The tube can be arranged to have a suitable length and be configured in such manner as to allow automatic loading from the trim press of a suitably modified thermoforming and tray trimming apparatus. The tube can further be arranged so as to allow automatic removal of one tray with flaps at a time for subsequent automatic processing of the tray with flaps to form a finished tray with bonded and sealed flaps.

Open ends 4202 and 4204 can be arranged to mate with covering caps (not shown) in such a manner as to completely enclose the tube and provide airtight seals at both open ends. The completely enclosed tube 4200 can thereby provide a vacuum chamber containing the trays with flaps such that when a vacuum source is connected to evacuation port 4206 substantially all air contained therein can be removed. After evacuation of the air from the tube, the vacuum within the tube can be maintained for a period of time, the period of time being sufficient to allow removal of substantially all retained air and oxygen from the cell structure of the trays with flaps. After removal of substantially all air and oxygen from within the cell structure, a suitable gas such as nitrogen or carbon dioxide can be provided into the tube via gas entry port 4208. The gas can be retained within the enclosed and sealed tube 4200 for a period of time sufficient to allow the cell structure to become filled with the suitable gas. Alternatively, evacuation of air from within the tube can be adjusted to provide a remaining gas or air pressure therein at any pressure between zero and ambient atmospheric air pressure and suitable gases can be provided in the tube so as to blend with any remaining air contained therein after evacuation to a desired pressure. Such process of evacuation and gassing can be repeated in accordance with an optimized process that will result in the most rapid exchange of retained oxygen in the cell structure with a desired gas.

In another preferred embodiment, the evacuation port 4206 may be provided in the sealing cover over open end 4204 and the gas entry port 4208 may be provided in the sealing cover over the open end 4204. The preferred embodiment can thereby provide an arrangement where a vacuum source can be attached to the evacuation port and a gas source can be attached to gas entry port and provide a continuous flow of gas through the tube from one end to the other so as to contact the surface of the trays with flaps contained herein. The pressure of the gas flowing through the tube can be arranged at a level most suitable to achieve the most rapid removal of air and oxygen that may be contained within the cell structure of the trays with flaps and thereby exchange the oxygen with the desired gas.

Referring now to diagram FIG. 238, details are shown of an apparatus for storing foam (EPS or polyester foam) trays, for exchanging gas such as oxygen that may be contained in the cell structure of the trays, with a preferred gas. The apparatus removes any residual oxygen that may be retained in the cell structure of the EPS trays that are intended for use in packaging fresh red meats in a “low oxygen” master container, case ready packaging system. The apparatus and method disclosed herein can provide a process to remove and replace the residual oxygen, with a desired gas, more rapidly than occurs when the EPS packaging materials are stored in a chamber containing desired gas in a static condition at ambient atmospheric pressure.

The apparatus includes a rectangular or suitably profiled tube 4200. The tube is arranged to have two open ends 4202 and 4204, one at each end of the tube. The tube is provided with evacuation port 4206 and gas entry port 4208. The tube can be filled with precut foam (EPS) trays with flaps, or sheets of foam 4210. The tube can be arranged to have a suitable length and be configured in such manner as to allow automatic loading from the trim press of a suitably modified thermoforming and tray trimming apparatus. The tube can further be arranged so as to allow automatic removal of one tray with flaps at a time for subsequent automatic processing of the tray with flaps to form a finished tray with bonded and sealed flaps as described above.

The open ends 4202 and 4204 can be arranged to mate with covering caps (not shown) in such a manner as to completely enclose the tube and provide airtight seals at both the open ends. The completely enclosed tube can thereby include a vacuum chamber containing the trays with flaps such that when a vacuum source is connected to evacuation port 4206 substantially all air contained therein can be removed. After evacuation of the air from the tube, the vacuum within the tube can be maintained for a period of time, the period of time being sufficient to allow removal of substantially all retained air and oxygen from the cell structure of the trays with flaps. After removal of substantially all air and oxygen from within the cell structure, a suitable gas such as nitrogen or carbon dioxide can be provided into the tube via gas entry port 4208. The gas can be retained within the enclosed and sealed tube for a period of time, which may be 1 to 2 hours, sufficient to allow the cell structure to become filled with the suitable gas. In a preferred procedure, the air will be substantially evacuated through the evacuation port 4206 and then a gas such as nitrogen will be introduced through port 4208 at a suitable low pressure. The gas will be held at the suitable low pressure for a period of time and then, the low pressure of the gas will be gradually increased, over a period of time, and until the gas pressure is increased to a maximum gas pressure above ambient atmospheric pressure. The maximum gas pressure may be 60 psi or more.

Alternatively, a partial evacuation of air from within the tube 4200, to a level that does not completely evacuate the tube but lowers the air pressure therein to a pressure above zero and below ambient atmospheric air pressure. A suitable, oxygen free, gas such as nitrogen can be provided into the tube, through the port 4208, so as to blend with the remaining air contained therein. This process of partial evacuation followed by gassing can be repeated, sequentially until the oxygen gas contained in the EPS cell structure is removed and in an optimized process that will result in the rapid exchange of the retained oxygen in the cell structure with a desired gas.

In another preferred embodiment the evacuation port 4206 may be provided in the sealing cover over the open end 4204 and the gas entry port 4208 may be provided in the sealing cover over the open end 4202. A vacuum source can be attached to the evacuation port 4206 and a suitable gas source, such as nitrogen or a blend of gasses including argon, carbon dioxide, nitrogen and a quantity of oxygen that does not exceed 5% and is not less than 1000 PPM, can be attached to the gas entry port 4208 and thereby providing a continuous flow of gas through the tube from port 4208 to evacuation port 4206 so that the suitable gas contacts the surface of the trays with flaps contained herein. The pressure of the gas flowing through the tube can be arranged at a level most suitable to achieve the most rapid removal of air and oxygen that may be contained within the cell structure of the trays with flaps.

In yet another preferred embodiment, a plurality of the rectangular tube 4200, may be conveniently stacked together and located inside a suitably sized vacuum chamber. Substantially all air may be evacuated from within the vacuum chamber and held with the vacuum source attached thereto for a period of time sufficient to allow removal of substantially all gas from within the expanded polystyrene foam cell structure. A suitable gas, such as nitrogen can then be provided into the vacuum chamber, at a pressure equal or greater than ambient atmospheric pressure so as to completely fill the vacuum chamber and contact all surfaces of foam trays in the tubes. After a period of time the plurality of tubes can be removed from the vacuum chamber.

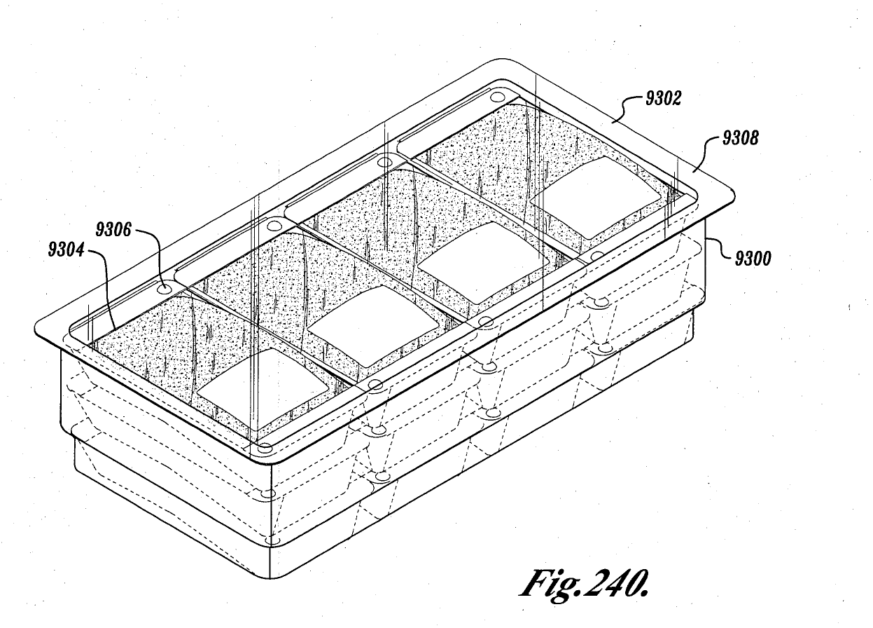

Referring now to FIG. 239, another embodiment of a rectangular tube having top bottom open ends is shown. Preferably, the rectangular tube may be manufactured from any suitable material such as stainless steel or other plastics material and may be arranged to have any convenient length. Preferably, the rectangular tube can be manufactured with longitudinally parallel sides and a cross-section that corresponds with the cut size of the trays that are shown therein. More specifically the rectangular tube will have a cross-sectional opening that is sized so as to be slightly larger that the cut size of the trays contained therein. For example, if the plan, cut size dimensions of the trays is 5 inches long by 4 inches wide the opening in the rectangular tube will be about 5.125 inches long by about 4.125 inches wide.

A gas entry port 3302 is shown located in the wall of the rectangular tube at about equal distance from each end of the rectangular tube. A plurality of additional gas entry ports may be provided at any suitable location in the wall of the rectangular tube. Most preferably, a suitable gas or blend of gasses, such as nitrogen, may be provided inside the rectangular tube through the entry port 3302. The gas may be provided by an injector into the rectangular tube through one or more of gas entry ports at a set pressure and volume. Gas may be provided at a pressure that is varied by normal methods or alternatively by way of a set pitch sound that may also be varied in a manner to enhance gas exchange. Preferably, length of rectangular tube 3300 can be arranged such that when trays are passed through the rectangular tube, the residence time of trays within the rectangular tube will be sufficient to allow gas exchange to occur between suitable gas provided through the entry port and into the rectangular tube and gasses such as oxygen that may be contained within the cell structure of the trays. Trays may be loaded through an opening at the open tope of rectangular tube and unloaded through the open bottom.

Preferably, rectangular tube is vertically disposed such that gravity will provide sufficient force to cause the trays to pass through the opening through the rectangular tube, when trays are removed from the bottom of rectangular tube. Alternatively, the rectangular tube may be horizontally disposed and a driver such as an auger (not shown) may be provided to transfer the trays through the rectangular tube. Preferably, the rectangular tube may be arranged so as to connect with an automatic tray dispenser so that trays can be automatically removed, one or more at a time, and subsequently be positioned onto a packaging machine in readiness for loading of perishable goods such as fresh red meat therein. A plurality of rectangular tubes may be arranged together in a grouping so as to process a plurality of trays simultaneously.

The rectangular tube can be manufactured to suit trays of any size.

Tray Forming Apparatus

Referring now to FIGS. 240-241 where a cross-section of the tray forming apparatus 2200 is illustrated. The apparatus is intended for used in a method for removing oxygen gas from the structure of expanded polystyrene packaging materials that are intended for use in packaging perishable goods that could be deleteriously affected by the presence of oxygen in quantities that exceed 500 PPM. The method includes but is not limited to the use of any suitable gas at any suitable pressure arranged to pass through the packaging materials by providing the suitable gas to one side of the packaging materials at a pressure above what is the gas pressure of any gas that is present on the opposing side of the packaging materials. The suitable gas will thereby be caused to pass through the packaging materials and furthermore cause a reduction in oxygen contained in the structure of the packaging materials.

The apparatus includes two parts. The first part shown in FIG. 240 is a side view cross-section with the apparatus in a closed position and a tray clamped between an upper chamber 2252 and a lower chamber 2254. FIG. 240 shows half of the apparatus with a center line marked through what would be the center of the apparatus. The other half of the apparatus is a mirror image of the part that is shown. FIG. 241 shows a cross-section across the entire width of the upper and lower chambers 2252 and 2254.

The apparatus 2200 includes an upper and lower chamber which are arranged so as to be moveable toward and away relative to each other, thereby allowing trays to be processed in a continuous mode.

A porous mold 2256, that is profiled to follow the contours of the tray and to neatly fit within the confinement of the chambers 2252 and 2254, is provided and can be fixed to the upper chamber. A gassing port 2258 is provided in the lower chamber 2256 and an evacuation port 2260 is provided in the upper chamber 2252. The porous mold 2256 can be manufactured from a suitable porous material and may have grooves and slots machined across the surface of the profiled face 2262 that are all connected to evacuation port 2260, thereby allowing gasses to be evacuated therethrough and through port 2260. The apparatus can be configured to accommodate one or more trays, however, for ease of explanation the apparatus shown in FIGS. 240-241 preferably accommodates one tray. A blade 2264 is provided within chamber 2254 which is attached to a moving member. The blade 2264 can be arranged in a continuous length to provide a knife edge that follows the perimeter of what will become the processed and cut tray. Space is provided between the surface of the profiled mold 2256, as shown, providing a space into which a suitable pressurized gas can be provided.

A tray 2268, having extended flanges, 2270, is located on the porous mold 2256 and the chambers 2252 and 2254 are closed so as to clamp the flange ‘TF’ around the full perimeter of the tray. The tray 2270 may be thermoformed from expanded polystyrene and therefore has a porosity and can therefore allow pressurized gas to pass therethrough. Pressurized nitrogen gas can then be provided into the space through port 2258 at a suitable pressure. A vacuum source can be attached to port 2260. The gas thereby passes through the porous tray walls and can displace oxygen gas that may be present therein. The pressurized gas can be provided into the space and passed through the tray porous walls for sufficient time to displace substantially all oxygen gas that may have formerly been present therein. The blade 2264 with knife edge can be activated and moved by the moving member 2250 so as to cut through the tray flange 2270. Chambers 2252 and 2254 are opened allowing the tray 2268 to be removed in readiness for additional trays to be processed in a similar fashion as described above. Trays 2268 can be removed and replaced on the porous mold 2256 in a continuous, intermittent and automatic procedure. The porous mold 2256 can be interchanged with other molds having different profiles to suit other trays of different size and profile.

Flange 2270 and any other part of the tray 2270 and the flap 2272 may be compressed, as desired, to substantially remove gas from the foam cells thereby forming a substantially solid section in the tray, flap 2272 and flange 2270 as required. In this way the solid section can be arranged to provide a continuous solid section around the perimeter of the tray such that a web of material such as pPVC can be sealed to the solid section along a strip like path around what will become a perimeter of a finished package. The solid section may be located at the connection between the flap 2272 and the tray 2268 such that the flap 2272 and the tray 2268 can be hinged and folded so as to allow contact of tray flange 2270 with the tray 2268.

The apparatus is similar to a standard expanded polystyrene thermoforming machine, where two parallel platens are arranged in close relative proximity and with a powered device for moving the platens toward and away from each other. Matched tools including two parts, are typically mounted onto the platens such that a heated sheet of expanded polystyrene or other suitable sheet, can be located between the platens and separated matched tool parts. The platens can be moved toward each other to a position that clamps the heated sheet between the two parts of the matched tool, thereby imparting a three dimensional profile that corresponds to the profile of the matched tool, into the sheet. After the sheet cools, the platens and the matched tool open and the profiled sheet can be removed automatically to allow the positioning of another sheet of EPS sheet therebetween. The EPS sheet is typically arranged in a continuous web.

As disclosed in the aforementioned description, trays can be processed in an automatic and continuous mode, such that any oxygen gas that may be retained in the EPS cell structure can be substantially removed and replaced with a desired gas such as nitrogen. The method and apparatus described herein, can also be incorporated into standard thermoforming machinery used for production of thermoformed EPS trays.

In a preferred embodiment, the trays with flaps can be produced on an automatic apparatus that heats a web of EPS sheet in an oven that substantially excludes oxygen so as to ensure that during any expansion of the EPS sheet during heating, immediately prior to thermoforming of the EPS sheet, oxygen gas will be substantially prevented from entering into the cell structure of the EPS sheet. This can be achieved by providing a suitable gas such as nitrogen in the oven during the heating of the EPS sheet, the nitrogen gas being in direct contact with the surfaces of the EPS sheet. The EPS sheet can then be transferred directly into a forming station that is arranged to substantially exclude oxygen gas therefrom and furthermore, apply pressurized nitrogen gas to one side of the tray with flaps during the forming process and causing the nitrogen gas to pass into and through the tray and flaps during the forming process. Adhesive or solvent can then be applied to selected areas of the flaps and the tray, either before or after trimming the tray with flaps from the sheet of EPS material. Then automatically fold the flaps and mechanically apply sufficient pressure to the flaps to hold against the walls of tray and cause bonding between the flap and the tray at desired regions therebetween.

A preferred embodiment includes, but is not limited to automatically or manually performing the following steps:

1. Providing a tray that may be thermoformed from expanded polystyrene (EPS) with flaps as shown in diagram. The tray having dimensions that will provide for the efficient use of the internal capacity of typical, refrigerated transport vehicles.

2. Exposing the tray to a gas that excludes oxygen and allowing the gas to exchange with any gasses contained within the cells of the EPS thereby substantially displacing any atmospheric oxygen from the cells.

3. Providing perishable goods onto the base of the tray. The perishable goods having been treated and processed to substantially eliminate any bacteria thereon.

4. Sealing a gas permeable material such as pPVC to the flanges of the tray.

5. Folding and then sealing the flaps to flanges of the tray.

6. Placing the tray or a plurality of similar trays into a gas barrier master container.

7. Displacing substantially all atmospheric gas, and particularly atmospheric oxygen, within the master container, with a desired single or blend of desired gasses.

8. Sealing a lid over the opening in the master container to form a hermetically sealed package containing the trays with perishable goods and desired gas.

9. Placing the master container inside a carton such as can be manufactured from corrugated cardboard and enclosing the master container.

10. Locating a plurality of the closed cartons onto a standard (GMA specified) pallet (Dimensions of 40″×48″) so as to maximize the efficient use of the area provided by the pallet.

Tray Materials of Construction

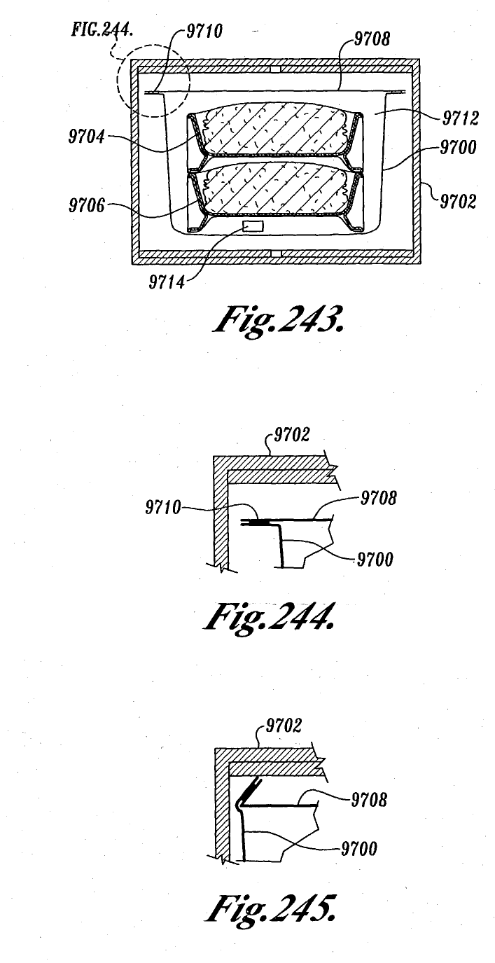

A multi-layer, co-extruded plastics sheet product extruded through an annular die is disclosed, including substantially amorphous polyester polymers, with additives, similar, but not exclusively, to the structures shown in FIGS. 242-240 where at least one of the layers is a foamed polyester and where at least one or more other layers includes at least about 30% regrind material derived from the skeletal scrap remaining after production of thermoformed trays from the sheet, with the balance of the regrind layer including a chosen virgin amorphous polyester polymer.

FIG. 242 shows a multilayer coextruded plastic sheet constructed according to the present invention including five layers. Beginning from the uppermost layer 2900, the co-extruded first layer 2900 includes a mix of blended components about 50% Eastman 6763 and about 50% Eastman 19411. The first layer 2900 is about 0.001 inches thick. The second co-extruded layer 2902 includes Eastman 9921 and is about 0.0025″ thick. The third co-extruded layer 2904 includes a blended mix of foamed Eastman 9663 and Eastmann additive G4ZZZ-3AZZ, and is about 0.012″ thick. The fourth co-extruded layer 2906 includes Eastman 9921 and is about 0.0015″ thick. The fifth layer 2908 includes regrind material recovered from tray thermoforming processes, and is about 0.002″ thick. The overall thickness of the sheet material shown in FIG. 242 is about 0.018″ thick.

FIG. 243 shows a multilayer coextruded plastic sheet constructed according to the present invention. The sheet material includes four layers. Starting from the uppermost layer, the first co-extruded layer 2909 includes a blended mix of about 60% Eastman 9921 and about 40% Eastman 6763. The first layer 2909 is about 0.002″ thick. The second co-extruded layer 2910 includes a blended mix of foamed Eastman 9663 and Eastman additive G4ZZZ-3AZZ, and is about 0.011″ thick. The third co-extruded layer 2912 includes regrind material derived from skeletal scrap recovered from the tray thermoforming process, and is about 0.0015″ thick. The fourth co-extruded layer 2914 includes a blended mix of about 60% Eastman 9921 and about 40% Eastman 6763 and is about 0.002″ thick. The overall thickness of the material shown in FIG. 243 is about 0.0165″ thick.

FIG. 244 shows a multilayer, coextruded plastic sheet including three layers. Beginning with the uppermost layer, the first co-extruded layer 2916 includes a blended mix of about 20% Eastman 6763, 50% Eastman 9921, and about 30% of regrind material. The first layer 2916 is about 0.0025″ thick. The second co-extruded layer 2918 includes a mix of blended and foamed Eastman 9663 and Eastman additive G4ZZZ-3AZZ. The second layer 2918 is about 0.011″ thick. The third co-extruded layer 2920 includes a mix of about 20% Eastman 6763, about 50% Eastman 9921, and about 30% regrind material. The third layer 2920 is about 0.0025″ thick. The overall thickness of the sheet material of FIG. 244 is about 0.016″ thick.

FIG. 245 shows a multilayer, coextruded plastic material constructed according to the present invention. The sheet material includes five layers. Beginning with the uppermost layer, the first co-extruded layer 2922 includes a blended mix of about 50% Eastman 19411 and about 50% Eastman 6763. The first layer 2922 is about 0.0015″ thick. The second co-extruded layer 2924 includes a blended mix of about 90% Eastman 9921 and about 10% of regrind material derived from skeletal scrap recovered from the tray thermoforming process. The second layer 2924 is about 0.006″ thick. The third co-extruded layer 2926 includes a blended mix of about 90% of regrind material derived from skeletal scrap from the tray thermoforming process and about 10% of Eastman 9921. The third layer 2926 is about 0.003 inches thick. The fourth co-extruded layer 2928 includes a mix of blended and foamed Eastman 9663 and Eastman additive G4ZZZ-34ZZ. The fourth layer 2928 is about 0.019 inches thick. The fifth co-extruded layer 2930 includes a mix of about 90% Eastman 9921 and about 10% of regrind material. The fifth layer 2930 is about 0.0005″ thick. The overall thickness of the sheet material of FIG. 245 is about 0.03″ thick.

FIG. 246 shows a multilayer, coextruded plastic sheet material constructed according to the present invention. The sheet material includes five layers. Beginning with the uppermost layer 2932, the layer 2932 includes about 50% blended Eastman 6763 and about 50% Eastman 19411. The first co-extruded layer 2932 is about 0.0015″ thick. The second co-extruded layer 2934 includes about 10% blended Eastman 9921 and about 90% regrind materials derived from skeletal scrap recovered from tray thermoforming process. The second layer 2934 is about 0.0015″ thick. The third co-extruded layer 2936 includes blended and foamed Eastman 9663 and Eastman additive G4ZZZ-3AZZ. The third layer 2936 is about 0.010″ to about 0.019 thick. The fourth co-extruded layer 2938 includes about 10% blended Eastman and about 90% regrind materials derived from skeletal scrap recovered from tray thermoforming process. The fourth layer 2938 is about 0.0015″ thick. The fifth co-extruded layer 2940 includes about 50% blended Eastman 6763 and about 50% Eastman 19411. The fifth layer 2940 is about 0.0015″ thick. The overall thickness of the sheet material of FIG. 246 is about 0.016″ thick.

Tray Materials of Construction

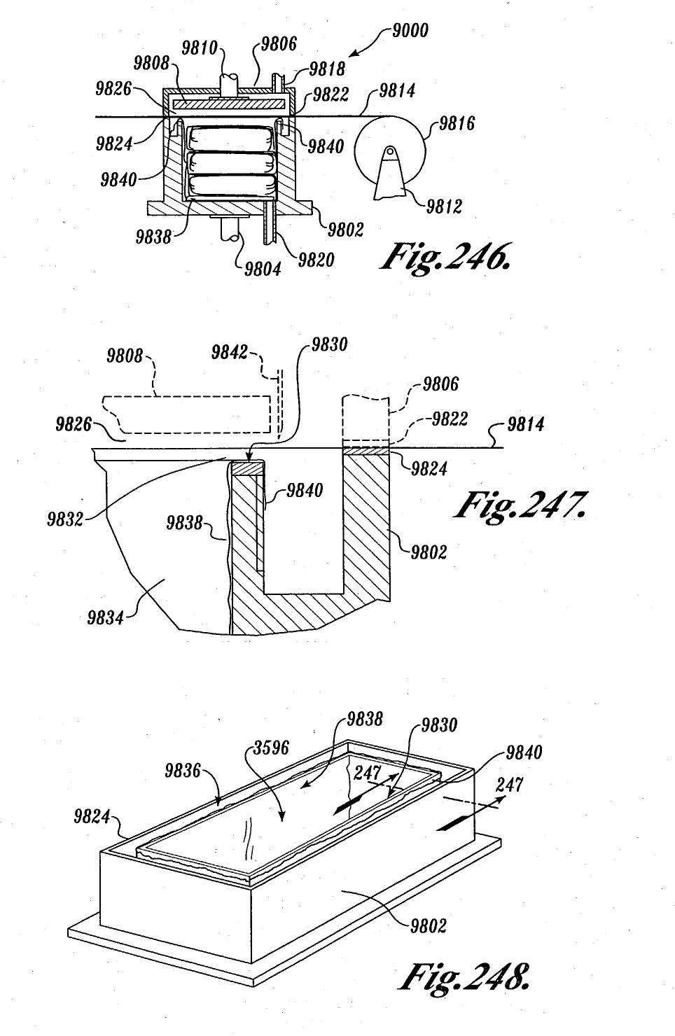

Referring now to FIG. 247, a cross-sectional view through a portion of material constructed according to the present invention is shown. Polyester sheet material is co-extruded in a three layer construction having two outer layers 2000 and 2002 of Eastman APET 9921 (about 0.002″ thick, each) and an inner layer 2004 of foamed Eastman 9663 with an Eastman recommended quantity of Eastman melt strength enhancer G4ZZZ-3AZZ. Inner layer 2004 is about 0.015″ thick. Inner layer 2004 is foamed with a suitable quantity of nitrogen gas, substantially excluding air from foam cells. The total thickness of co-extruded sheet is approximately 0.019″ thick. The gas barrier properties of the outer layers of Eastman 9921 are such that air will be substantially prevented from permeating into the inner layer of foamed polyester. Sections of the material have been compressed so as to solidify the inner layer of foamed Eastman Polyester 9663 with the melt strength enhancer. Both edges of co-extruded sheet are sealed together, by any suitable sealer, preferably immediately after co-extrusion and prior to winding onto a roll. Sealing edges substantially prevents air from permeating into inner layer 2004 of foamed polyester. Material is wound onto a roll and is then stored, most preferably in a temperature controlled storage area and at a temperature below 10° C. Following storage, the roll of co-extruded polyester material is substantially converted into trays of a desired profile and size by a thermoforming apparatus such as shown in FIG. 248 where a cross-section through such a tray is shown. Thermoforming apparatus includes a typical method of pre-heating the sheet, clamping convenient rectangular sections of the heated sheet and vacuum (or pressure) forming the sheet onto a suitable tray forming mould, however, at the moment of thermoforming and prior to cooling of the sheet, a suitably shaped tool, that may also be heated to a desired temperature, can be pressed against the flange regions, or edge of the flange regions, of the trays during the forming process and thereby compress the flanges. Most desirably the compression of the flanges will cause substantially all gas to be expelled from the inner layer of foamed polyester in the flange regions only. Said trays are severed, by a cutting member, from the sheet of material such that the edges of the flange are substantially sealed together. Such a process can provide a tray with gas barrier outer layers of polyester and an inner foamed layer of polyester such that the inner layer is substantially prevented from direct contact with ambient air. In this way ambient air will be substantially prevented from permeating into the inner layer and also providing a gas barrier to substantially prevent nitrogen gas within the foam cells from escaping and exchanging with air.

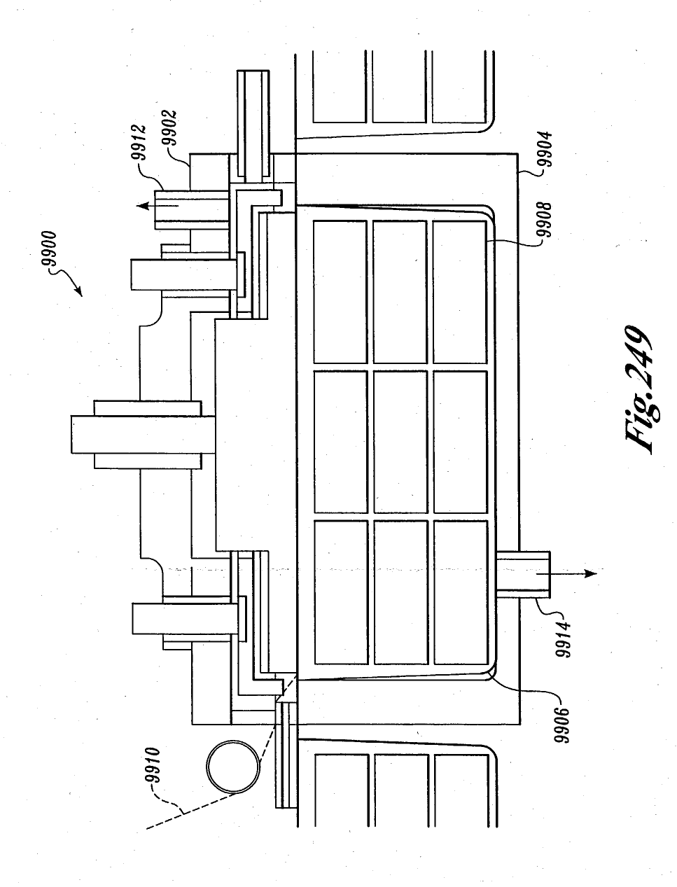

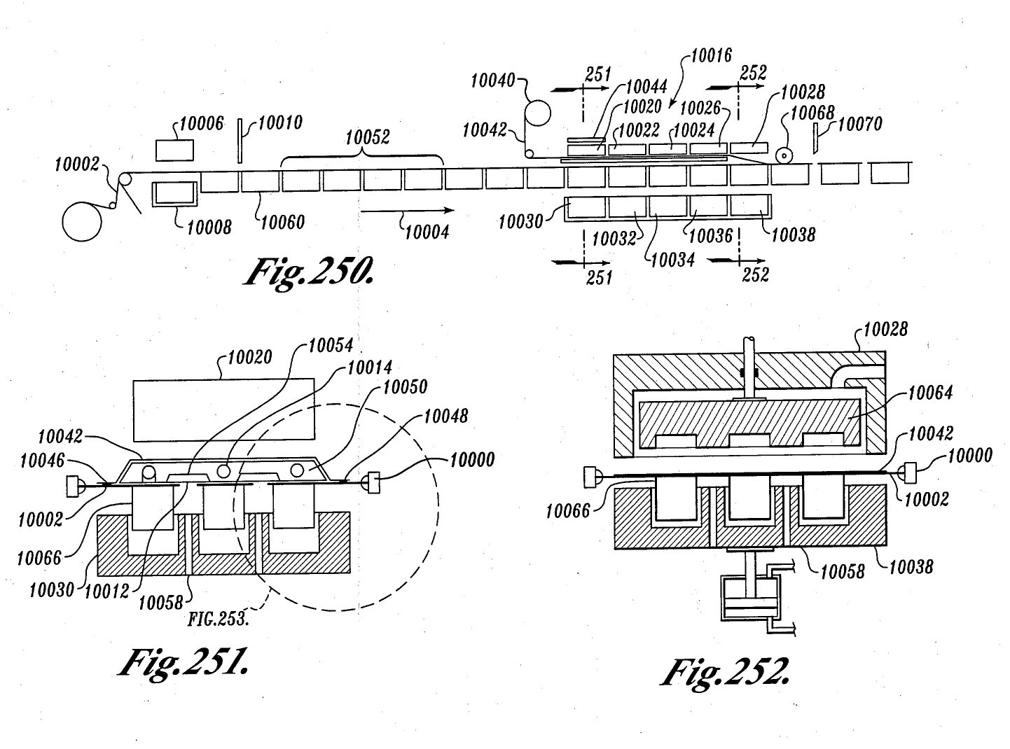

FIG. 249 shows a cross-section of the material showing an upper 2000, an inner 2004, and a lower 2002 layer. The upper layer 2000 is about 0.002″ thick, the inner layer 2004 of foam polyester is about 0.15 thick and the lower layer 2002 is about 0.002″ thick. FIG. 250 shows the material of FIG. 249 when the material is compressed according to the present invention. Outer layers 2000 and 2004 remain substantially about 0.002″ thick, but inner layer 2004 has been compressed to about 0.001″ thick.

Tray Rib Forming Apparatus

Referring now to FIG. 251 a tray with ribs formed in accordance with this invention is shown. The inventor has previously invented a system whereby a low oxygen modified wing system including a “master container” (container) with trays therein, is evacuated. During evacuation, all contents of the container are exposed to a very high level of vacuum, furthermore, the pressure of nitrogen gas, contained within the inner layer foam cells which is approximately equal to the prevailing ambient atmospheric pressure, will exert an “exploding” pressure against the inner surfaces of the outer layers. Pressure can cause distortion resulting in, at least, partial separation of inner layer from outer layers. Furthermore, in extreme cases tray walls could rupture and burst open. Clearly, such an event is undesirable and this present invention provides a method, equipment and production of a tray (product), that can minimize this undesirable event. By including regions of dense material, the inventor has discovered that trays can withstand the low pressure atmosphere used in the above application.

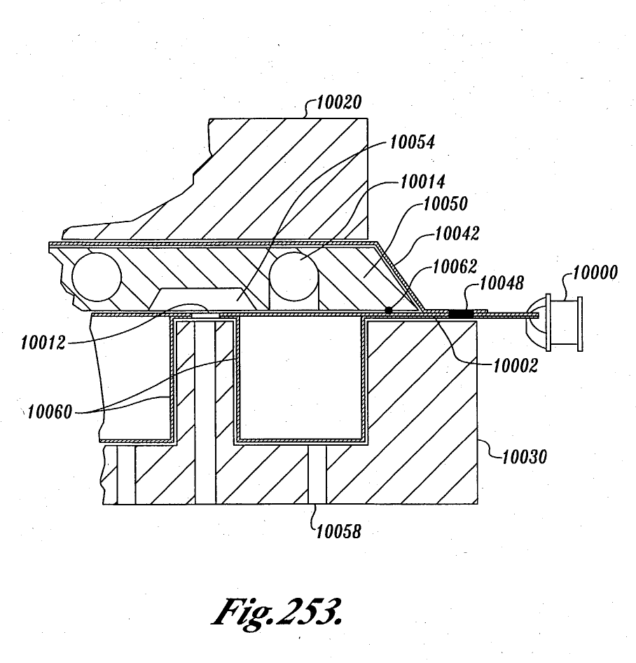

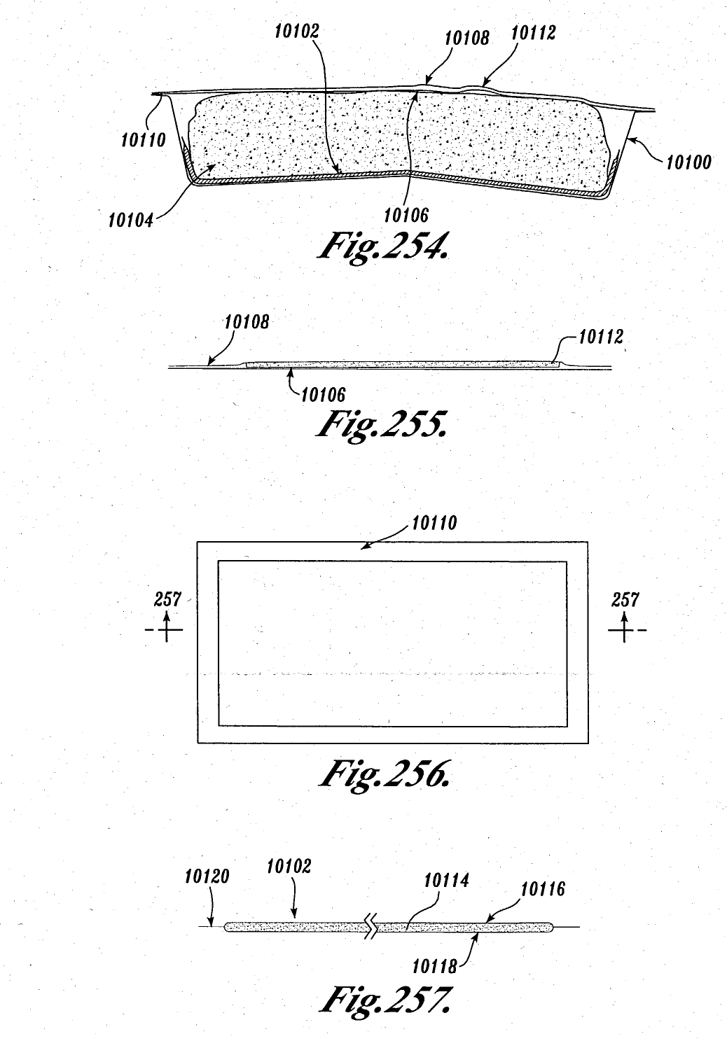

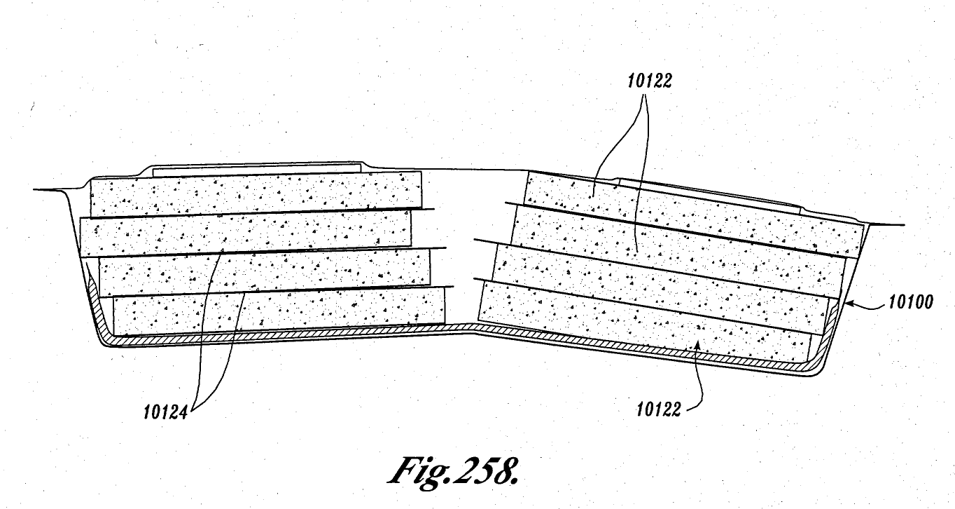

FIG. 251 shows a three dimensional section of a tray that has been thermoformed from sheets of material similar to those described in the structures shown in FIGS. 242-246. FIG. 253 is a view of a section through a wall of the tray with ribs 2100 provided therein. Referring now to FIG. 256, an apparatus that can be used to provide ribs 2100 is shown. Ribs can be provided by closing heat bank 2118 onto wall of tray 2114 when tray 2114 is supported by pad 2116. Heat bank 2118 can thereby weld/heat seal a portion of the inner surface of the outer layers 2108, 2112 to each other after compression of inner layer 2110 foam cells such that the outer layers become welded/heat sealed to each other at the point of contact. Radius 2106 of ribs 2100 as shown in FIG. 253 can be adjusted and also the distance of pitch from radius to radius can also be adjusted by production of equipment providing the desired adjustments. Adjustments can be made in order to provide for optimized configuration of radius 2106 and pitch such that the exploding effect of exposure to high vacuum that could otherwise result in the rupturing of the tray, as described above can be minimized.

In a preferred embodiment, an apparatus for compressing a web of material 2124 to provide ribs therein is detailed in FIG. 255. Heat banks 2120 and 2124 are arranged, as required, in a mechanism so as to enable compressing of material therebetween and thereby bond outer layer 2126 and inner layer 2130 together with compressed foamed polyester layer 2128 therebetween. A cross-sectional view through a portion of compressed material 2124 with an aperture punched therethrough is shown in FIG. 256. Additionally a mechanism for providing perforations in an outer layer of a tray wall thermoformed from the material shown in FIG. 247, is also detailed in FIG. 257. Perforations 2136 can be provided to allow communication and transfer of gasses from the foamed polyester layer 2128 and through perforations 2136.

Rib Forming Apparatus

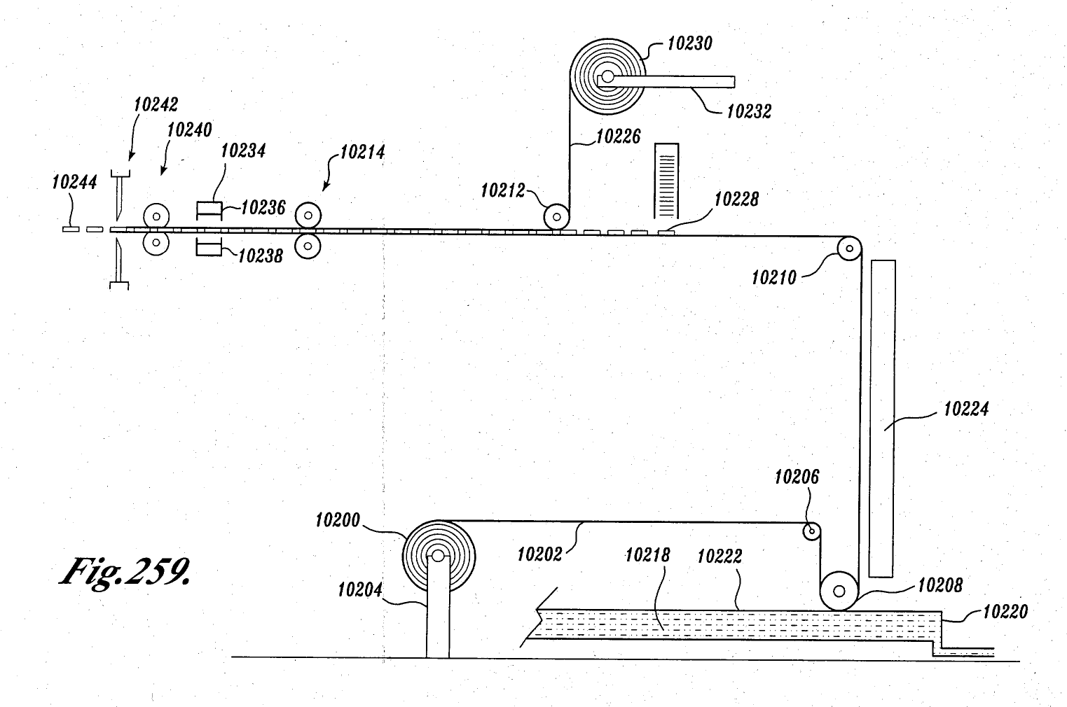

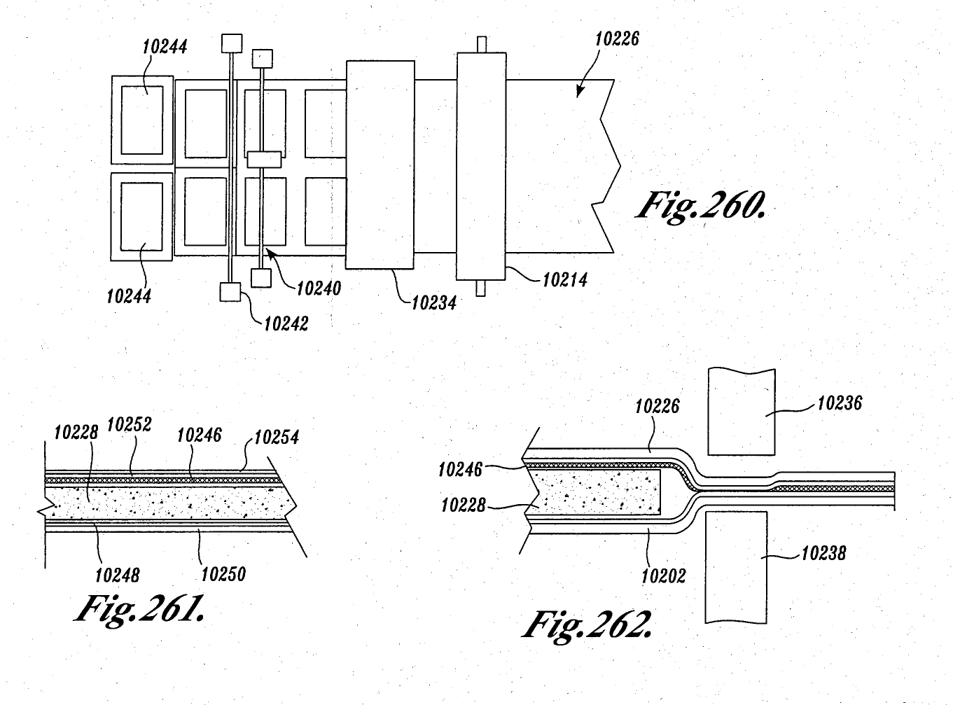

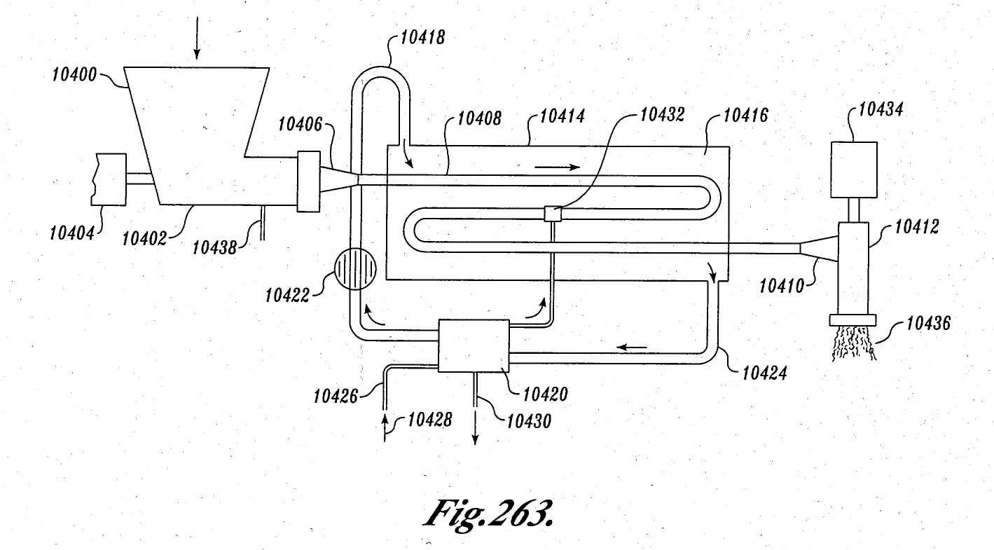

Referring now to FIG. 258, a cross-section through a tooling assembly of tool parts 2200 and 2202, with a section of material 2124 (after processing/forming), is shown. Tooling part 2200 is temperature controlled by passing liquid 2206 through conveniently located passageways shown as ports 2204. Liquid is preconditioned to a specified and desired temperature and is passed through ports 2204 at a rate sufficient to control the temperature of tooling part 2200. Similarly part 2002 can be temperature controlled in a similar manner (not shown). Evacuation holes 2208 are located in part 2200 and evacuation ports 2210 are also located in tooling part 2202. A plan view of cavity 2212 is shown in FIG. 259 with length and width dimensions respectively also shown. FIG. 260 shows a cross-section through a section of material, which has been sealed around its periphery 2124 by compressing and sealing the outer layers together, before processing with matching tool parts 2200 and 2202. Tooling assembly includes two parts 2200 and 2202 and the face 2214 of part 2200 is arranged to have width and length dimensions such that it can enter and partially penetrate cavity 2212 with a clearance around the perimeter of the cavity of 0.010″, such that the parts 2200 and 2202 are in close proximity but substantially do not contact each other. The tooling parts 2200 and 2202 can be mounted onto independently moving members that can simultaneously provide a predetermined closing movement toward each other and with a desired force. Face 2214 is parallel to face 2216 and when parts 2200 and 2202 are closed together in a closed position, parts 2200 and 2202 are arranged so as not to contact and the distance between face 2214 on part 2200 and 2216 on part 2202 is at a set predetermined distance. A vertical wall 2218 is located around cavity 2212 and when part 2200 and 2202 are in a closed position an enclosed space is so defined by face 2214, face 2216 and walls 2218. Therefore, the volume of space can be predetermined and the displacement of section of material 2124 can also be predetermined. Volume and displacement can be arranged to be substantially equal. A section of material 2124, shown in FIG. 260 is heated to a desired temperature and located into the cavity 2212 immediately prior to closing parts 2200 and 2202, such that when parts 2200 and 2202 are closed and a vacuum source is applied to evacuation ports 2210 and passageways 2208 in parts 2200 and 2202, the profile of the section of material 2124 will be altered, so as to substantially conform to the profile of the space wherein ribs 2220 will be formed by rib mold 2222 in face 2214. This method of forming a part with a desired profile from a substantially flat (two dimensional) sheet of material 2124 can be applied to form parts such as trays. The profile of the trays will be determined by the profile of the tooling parts which can be manufactured to specific requirements and particularly to provide a method of producing trays of optimized profile and rigidity for use, for example, in master container modified atmosphere packaging system as described herein.

Removal of Oxygen from Cell Structures

Referring now to FIG. 261, a cross-sectional view of a pressure chamber apparatus, vacuum tube 4900, is shown. The apparatus is intended to be used in the process of removing any oxygen gas that may be retained within the cell structure of expanded polystyrene foam packaging materials such as trays with flaps, that are intended for use in packaging perishable products such as red meats in a low residual oxygen modified atmosphere package. The vacuum tube 4900 includes a tube of suitable length, open at both ends with end caps 4904 and 4906 fitted to each end which together, provide a sealed and air tight pressure chamber. The end caps can be clamped in position and are removable as desired. The vacuum tube 4900 may be manufactured from any suitable material such as aluminum, stainless steel or a plastic material or a combination thereof. The size and profile of the vacuum tube can be arranged to suit and accommodate a magazine, such as is detailed in FIG. 263. The magazine has an outer profile and dimensions such that it can be readily located inside the vacuum tube 4900. The inner profile of the magazine 4908 is arranged to suit a particular size of tray with flaps. A plurality of a particular size of tray with flaps can be located within the magazine and held in this position as required for further processing as a complete unit. A plurality of magazines can be provided to suit any desired sizes of trays with flaps. A piston 4910 fitted with seals between the piston and the internal surface of bore of the vacuum tube 4900 can be located in the bore of the vacuum tube adjacent to end cap 4906. The piston can be manufactured from materials that include a suitable quantity of a magnetic material such as iron. The piston is arranged so as to move easily within the confines of the vacuum tube along the bore. The end cap 4906 can be manufactured with an electro-magnetic devices attached thereto that are capable of activation as required in a manner that, as and when required, will cause the piston to become magnetically attached thereto. A port 4912 is provided in the end cap 4906. Two manifolds marked manifold 4914 and manifold 4916 are fitted on opposite sides of the vacuum tube 4900. The manifold 4914 has direct communication with the vacuum tube through apertures 4918 and manifold 4916 has direct communication with the vacuum tube through apertures 4920. Ports are provided at each end of the manifolds. The manifold ports 4922, 4924, 4926 and 4928 are connected to a vacuum source and nitrogen gas or any other suitable gas source, via a three-way valve such that either gas, set at a selected and adjustable pressure, or alternatively a vacuum source can be attached directly to the manifold ports. The gas supply and the vacuum source can be alternately attached to each manifold port, together or separately, in any desired sequence and/or manner that will efficiently remove residual oxygen from cell structure of packaging materials contained in the vacuum tube 4900.

A plurality of vacuum tubes 4900 may be manufactured in suitable quantities and arranged so as to be attached to an apparatus such as shown in FIG. 267. The vacuum tubes 4900 are arranged to allow the transfer of magazines 4908, therethrough after removal of both end caps with the piston electro-magnetically attached to end cap 4906. Alternatively the trays with flaps may be transferred from the magazine 4908 directly there from. Empty magazines can then be returned by automatic transfer to a known location and as controlled by a programmable CPU or PLC (programmable logic controller) attached to the magazine assembly.

Referring again to FIG. 267, an apparatus is shown as vacuum tube assembly, and includes a quantity of preferably 23, horizontally and parallel disposed vacuum tubes, similar to 4900, and each marked individually can be seen attached to a pair of parallel and continuous chains that are in turn arranged to engage with sprockets that are in turn arranged with suitable drivers. The quantity of vacuum tubes, attached to the chains, may be varied according to requirements.

An apparatus shown as magazine assembly, including a quantity of preferably 23, to correspond to the number of vacuum tubes horizontally and parallel disposed magazines, with each magazine similar to magazine 4908, and each marked individually, secured to a pair of parallel and continuous chains, that are in turn arranged to engage with sprockets that are in turn arranged with suitable drivers. The magazines are arranged so as to be detachable from the magazine assembly.

The vacuum tube assembly and the magazine assembly are arranged such that magazines can be automatically transferred between the assemblies, as required. In this way a magazine that has been loaded with trays with flaps can be selectively transferred from the magazine assembly to a selected vacuum tube location in the vacuum tube assembly

A quantity of preferably 4 thermoforming machines 4948, 4950, 4952 and 4954 are shown positioned adjacent to the magazine assembly so as trays with flaps, produced by the thermoforming machines, can be loaded directly into the magazines. Any suitable quantity of thermoforming machines with interchangeable tooling to suit any number of different sizes of trays with flaps can be provided, as required, and located adjacent to the magazine assembly.

Machines 4948, 4950, 4952 and 4954 include suitable thermoforming machines that are arranged to thermoform trays with flaps from suitable rolls of expanded polystyrene sheet provided on rolls 4956 on spools 4958. Each thermoforming machine includes ovens and forming and trimming (cutting) devices. Trays with flaps are thermoformed, trimmed and ejected in horizontally disposed stacks, such that the stacks extend onto shelves 4960 and 4962 arranged on each machine 4948 through 4954. Magazines 4900 can be positioned adjacent to and in line with stacks on shelves 4960 and 4962 so as to facilitate loading of the trays with flaps directly therein. Preferably, trays with flaps can be produced by thermoforming machines 4948, 4950, 4952 and 4954 and loaded directly into any selected magazine. Each magazine has an address which is known and a computer a CPU (central processing unit) can control the thermoforming machines in concert with the magazine assembly. Any suitable quantity of thermoforming machines can be arranged at positions adjacent to the magazine assembly. Each thermoforming machine can be arranged to produce different sizes of trays with flaps, as required, which can be arranged to be transferred and loaded into suitable magazines with known addresses.

Preferably, magazine assembly and the vacuum tube assembly can be arranged to operate in concert and controlled by the CPU.

Apparatus that is arranged to fold and bond trays with flaps are shown and marked 4964, 4966, 4968, 4970 and 4972 and arranged to fold and bond trays with flaps of different sizes, and specification details, as required. The CPU is programmed with the location of each machine 4964, 4966, 4968, 4970 and 4972 and specification details of trays with flaps. Accordingly, the apparatus can be programmed to operate in concert with the vacuum tube assembly such that magazines can be transferred between the apparatus and the magazine assembly by transfer of magazines to magazine locations shown as magazine 4974, 4976, 4978, 4980, 4982 as required for subsequent folding and bonding. After folding and bonding has been completed by any of the machines 4964, 4966, 4968, 4970 and 4972, finished trays are positioned onto the respective conveyors 4984, 4986, 4988, 4990 or 4992 for transport thereon to packaging machines.

The magazine assembly and/or the vacuum tube assembly can be enclosed in a space that can have a suitable gas, such as nitrogen, provided therein and temperature controlled at a suitable temperature.

Apparatus shown in FIG. 267 is thus arranged to automatically produce trays with flaps on the thermoforming machines. The trays with flaps can then be transferred into magazines that can be secured to the magazine assembly. The magazines can be transferred from the magazine assembly to any of the vacuum tubes attached to the vacuum tube assembly. Trays with flaps can then be processed according to any suitable process and as herein disclosed. The magazines can then be transferred to the folding and bonding apparatus for further processing and subsequent transfer to packaging machines for use in packaging perishable goods.

The tray with flaps, folding and bonding machines 4964, 4966, 4968, 4970 and 4972, are arranged to fold and bond any trays with flaps of different specification details. The CPU is programmed with location of each machine 4964, 4966, 4968, 4970 and 4972, and specification details of trays with flaps stored in the magazines. Accordingly, the vacuum tube assembly can be programmed to unload trays with flaps into magazines 4974, 4976, 4978, 4980 and 4982, as required for subsequent folding and bonding. After folding and bonding has been completed by any of the machines 4964, 4966, 4968, 4970 and. 4972, finished trays are positioned onto the respective conveyors 4984, 4986, 4988, 4990 or 4992 for transport thereon to packaging machines.

The thermoforming machines 4948, 4950, 4952 and 4954 and the tray with flaps, folding and bonding machines 4964, 4966, 4968, 4970 and 4972, the corresponding magazines 4974, 4976, 4978, 4980 and 4982 and conveyors 4984, 4986, 4988, 4990 or 4992 can be enclosed in a space that can have a suitable gas, such as nitrogen, provided therein.

The nitrogen gas can be produced by a suitably sized nitrogen generator such as an on-site nitrogen supply, incorporating a non-cryogenic air separation apparatus known as Pressure Swing Absorption (PSA) Generators. Suitable PSA generators are available from BOC Gases, a division of The BOC Group. Any convenient source of gas supply may be used.

Apparatus for the Removal of Oxygen from Cell Structures

Referring now to FIGS. 262-265, an apparatus that is intended to be used in the process of removal of any oxygen gas that may be retained within the cell structure of expanded polystyrene foam trays and flaps that are intended for use in packaging perishable products such as red meats in a low residual oxygen modified atmosphere package is shown. FIG. 262 shows details of three identical vacuum tubes 4800 in various stages of the process and at positions A, B and C. Each vacuum tube includes a tube, open at one end and closed at the other. The vacuum tubes may be manufactured from any suitable material such as aluminum, stainless steel or a plastic material or a combination thereof. The size and profile of the vacuum tubes can be arranged to suit and accommodate any sizes of the tray with flaps. A piston 4802 fitted with a seal between the piston and the internal surface of bore of the vacuum tube, such as “O” rings appropriately attached to the piston, can be located in the bore of each vacuum tube. The piston is arranged so as to move easily within the confines of the vacuum tube along the bore, with low friction and. resistance between the bore and the piston “O” rings. A port 4808 is provided in the closed end of each vacuum tube and a cap 4810 is provided, when required, to completely close and seal in an airtight manner, the open end of the vacuum tubes. Two manifolds marked 4812 and 4814 are fitted on opposite sides of the vacuum tubes. The manifold 4812 has direct communication into the vacuum tube through apertures 4816 and manifold 4814 has direct communication with the vacuum tube through apertures 4818. Ports are provided at each end of the manifolds. The manifold ports 4820, 4822, 4824 and 4826 are connected to a vacuum source and nitrogen gas or other suitable gas source, via a three-way valve such that either gas, set at a selected and adjustable pressure, or alternatively vacuum source can be attached directly to manifold ports. The gas supply and the vacuum source can be alternately applied to each manifold port in a manner that will most efficiently remove the residual oxygen from the cell structure.

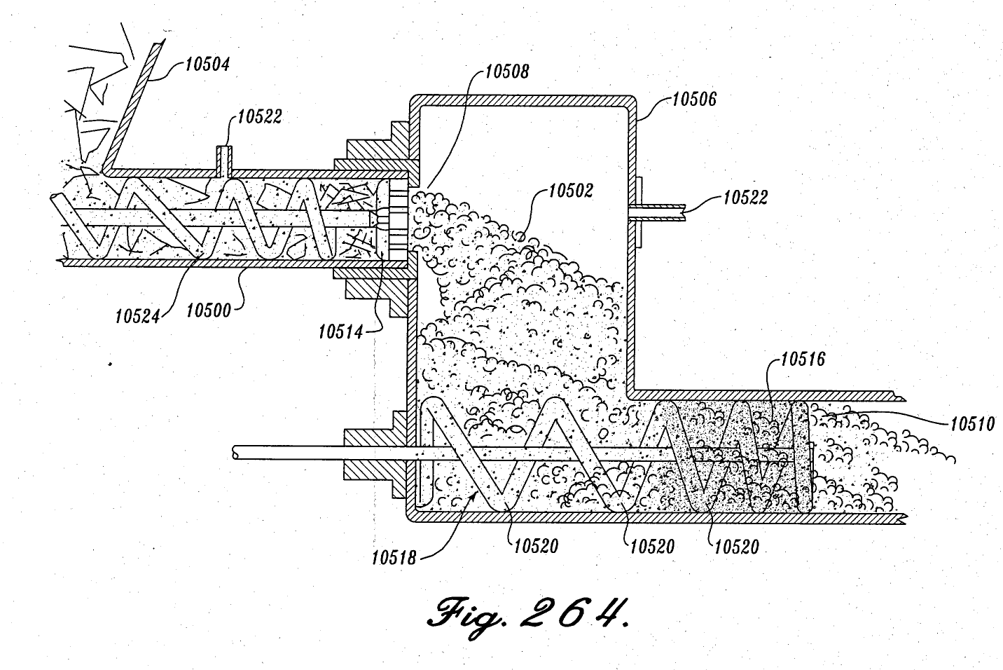

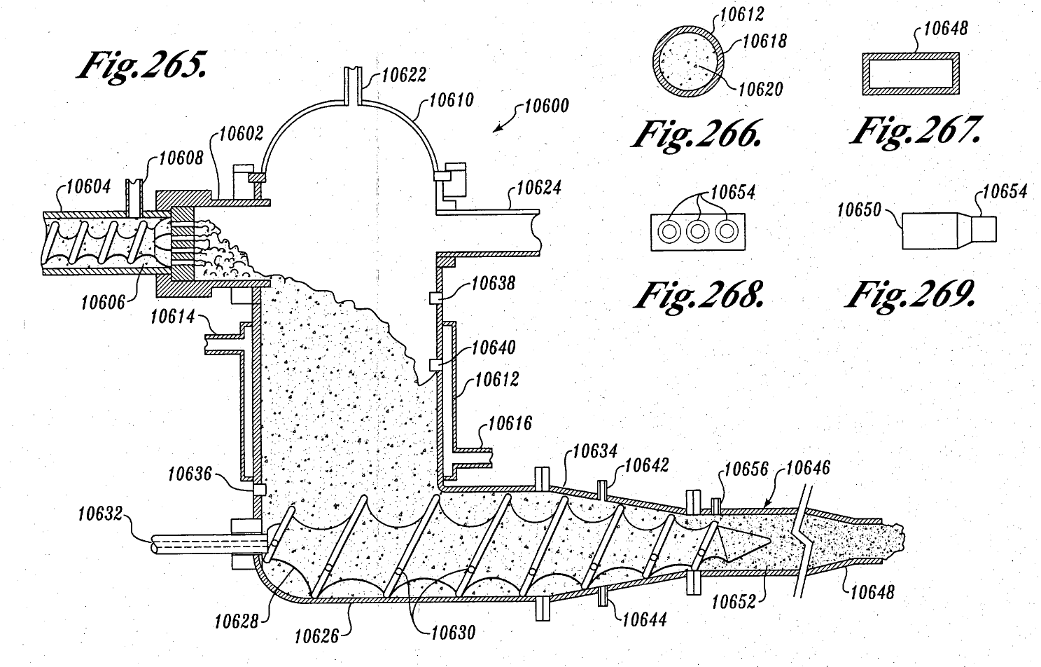

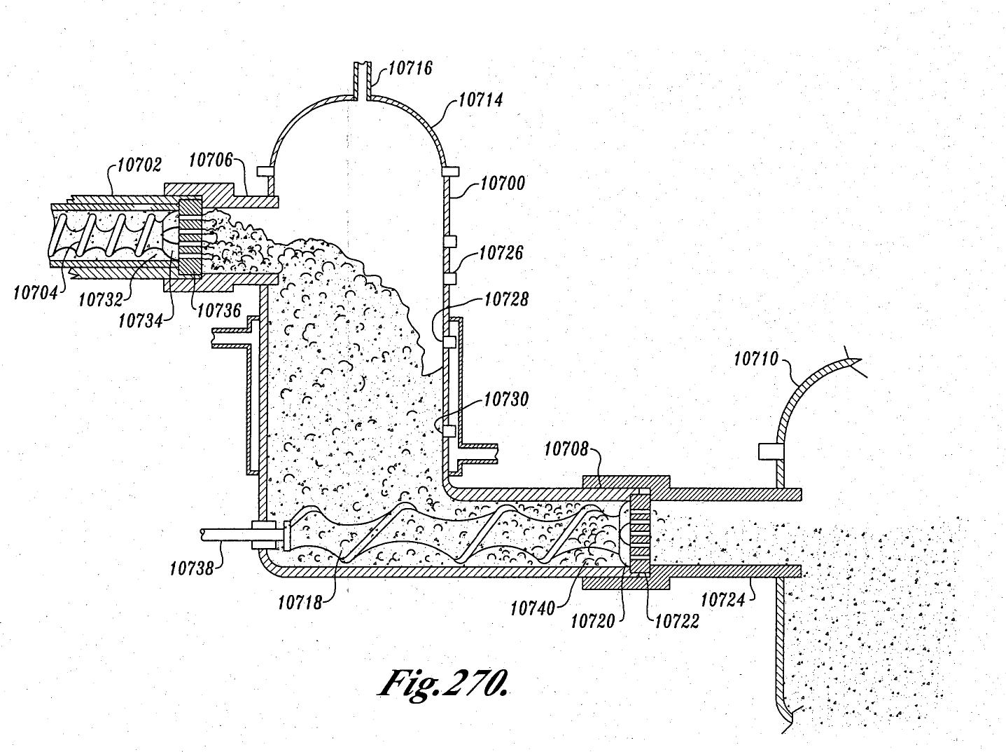

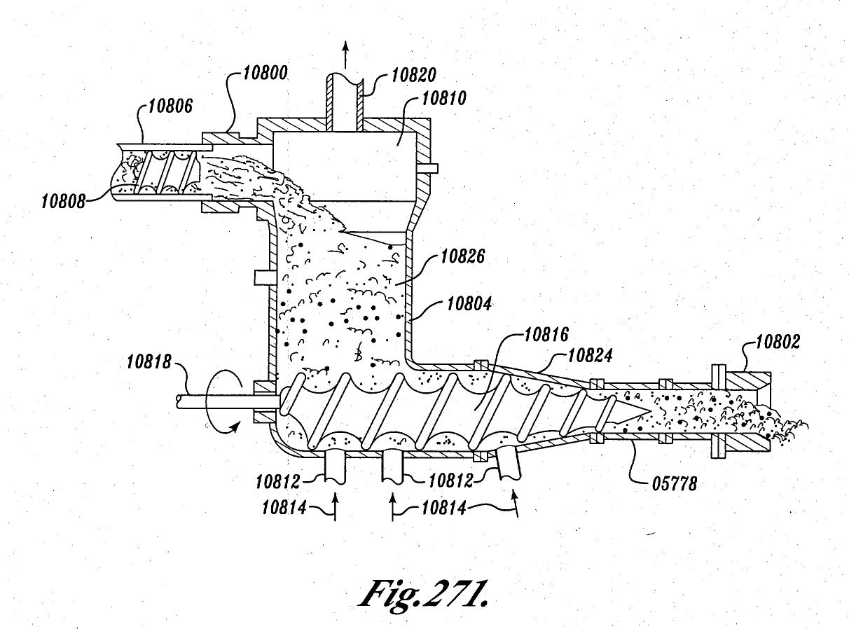

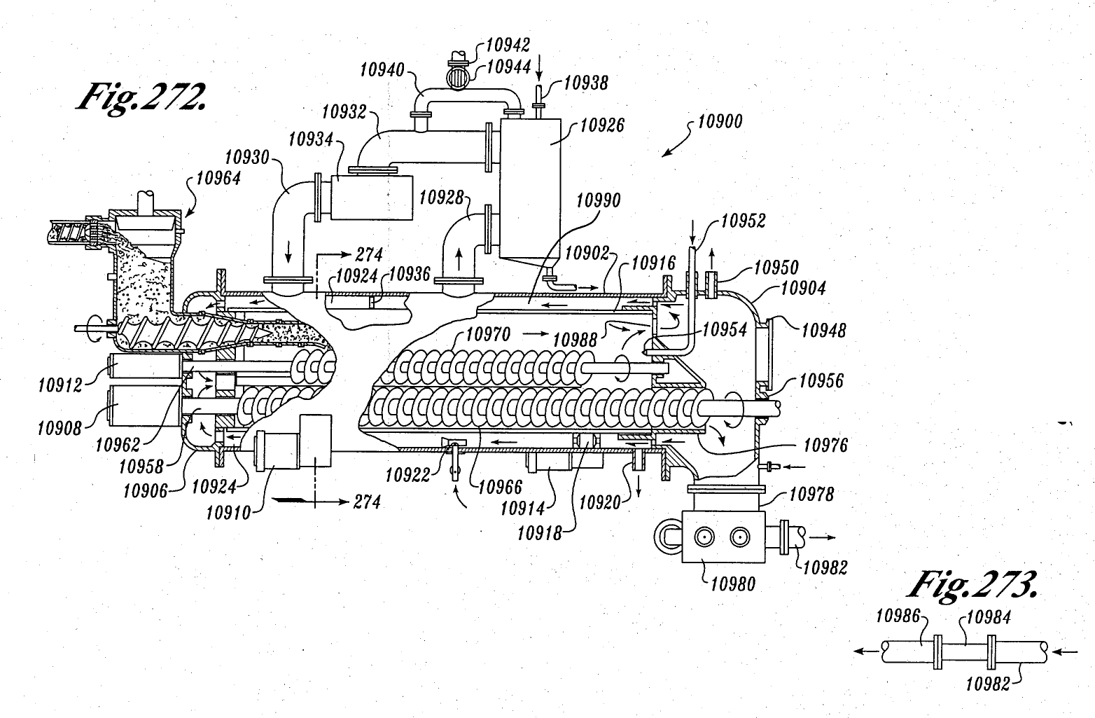

Referring now to FIG. 264, a rear end elevation of the apparatus is shown. As can be seen, four horizontally disposed vacuum tubes 4800, are mounted to a frame 4830 which is in turn attached to a main frame 4830 via pivot 4832. The main frame 4830 is rigidly attached to base of frame that is located firmly on a floor. A driver 4832 is provided and arranged to rotate the vacuum tubes about pivot 4832. The drive can rotate the vacuum tubes, attached to frame 4828, all together as a single unit, with an intermittent motion such that during each intermittent motion the frame 4828 with vacuum tubes 4800, moves through 90 degrees or a quarter a single revolution. In this way vacuum tube 4800 at position A would move to the position B. The vacuum tube at position B would move to D and D to A. The apparatus is arranged so as to allow automatic loading of a quantity of trays 4834 at position A. At position B, the vacuum tube is arranged to be sealed with trays 4834 therein and position 5100 is arranged so as to allow unloading of the trays 4834 from vacuum tube 4800.

Referring again to FIG. 262, with vacuum tube 4800 at position A, trays 4834 are shown being loaded into the vacuum tube with a loading force. During the loading, a suitable gas such as nitrogen can be provided through port 4808 of the vacuum tube at position A, at a desired pressure so as to exert a desired level of force against piston 4802, thereby holding the trays 4834 in a firmly held, nested, disposition while submitting to the loading force. The piston thereby moves toward the closed end of the loading vacuum tube until the vacuum tube is filled with trays. Cap 4818 is then positioned into the open end of the vacuum tube thereby sealing in an airtight manner with trays 4834 enclosed therein. Immediately after closing and sealing the open end with cap 4810, a vacuum source is attached to all ports 4820, 4822, 4824, and 4826. The vacuum source remains attached thereto for a set period of time, sufficient to remove substantially all air from the closed vacuum tube 4800. After evacuation of substantially all air from the vacuum tube 4800 at position A, the vacuum source can be disconnected from manifold 4812 and a nitrogen gas source attached thereto, such that nitrogen gas is provided into manifold 4812 and through apertures 4816 so as to flood the vacuum tube at a desired pressure. The nitrogen gas then flows across the surfaces of trays 4834 and through apertures 4818 and into manifold 4814. The vacuum source can then be disconnected from the manifold 4814 so as to allow pressure of nitrogen gas inside vacuum tube to be increased to a desired pressure. The nitrogen gas can be maintained at the desired pressure for a desired period of time sufficient to allow exchange with and thereby removal of substantially all oxygen that may be present in the cell structure of the trays with flaps. Alternating and or pulsating vacuum and gassing of the vacuum tubes can be arranged so as to provide rapid removal of the oxygen gas. A gas analyzer can be attached to each vacuum tube and arranged to determine the residual oxygen gas content inside the vacuum tube. When the residual oxygen content of gas present inside the vacuum tube has been reduced to a desirable level, the frame 4828 with vacuum tubes 4800 attached, can be then rotated so that the vacuum tube at position B is rotated to position 5100, the cap 4810 is removed and the trays 4834 are extracted by providing nitrogen gas through port 4808 at a suitable pressure so as to cause the piston to move toward the open end of the vacuum tube and eject the trays through the open end of the vacuum tube. Suction cups 4836 may be used to intermittently remove a single tray at a time until the vacuum tube is emptied.

Each vacuum tube 4800 can be provided with individual and separate identification. Preferably, separate identification may be arranged by way of a bar code attached to the vacuum tube, at a convenient location or alternatively it may be by way of a chip, embedded into a section of each vacuum tube.

The vacuum tubes 4800 may be arranged to accommodate any size of tray with flaps. The trays with flaps may be pre-loaded into an open magazine 4838, such as shown in FIG. 263, that is arranged to fit inside any of the vacuum tubes 4800. Any suitable quantity of open magazines may be provided and each one can be arranged so as to have constant outer dimensions that allow close and neat fitting within the vacuum tubes 4800, while the open magazine internal dimensions are arranged to suit different sizes of trays with flaps. Each magazine can be fitted with an individual address or identifying mark such as a machine readable and recognizable bar code or computer chip, embedded into the magazine at any convenient location. The address of the individual open magazine can thereby be identified. The open magazine can be loaded with the trays with flaps and then stored in, for example, a suitable racking system for a period of time, and when required for use, the loaded open magazine can be automatically removed from the racking system and transferred to the vacuum tube 4800 for processing. Any convenient quantity of open magazines can be manufactured and loaded with trays of various sizes, collectively providing an open magazine. The racking system may be located inside an enclosed storage space that may be filled with a desired gas such as nitrogen. In this way the procedure of loading, processing and then unloading the trays with flaps, in the vacuum tubes 4800, that have been stored in the open magazine with identifiable address, may be arranged in an automatic process. Trays can be held within the magazine by a clip or a brush.

The vacuum tubes 4800 may be attached to any suitable mechanism with the capability of positioning the vacuum tubes as required, such as is shown in FIG. 262.

Referring now to FIG. 266, a plan view of various apparatus constructed according to the present invention is shown. A pair of horizontally disposed, parallel, continuous chains 4846 are arranged on suitable sprockets 4848 mounted in a frame. The sprockets are attached to a driver (not shown) that includes a programmable servo motor arranged to drive the parallel chains, in either direction, as required. Vacuum tubes 4800 are fixed to continuous chains 4846 as shown and includes a quantity of preferably 23 vacuum tubes, marked with individual addresses to provide a vacuum tube assembly generally denoted by 4850. The vacuum tubes are positioned with the closed ends toward the rear of equipment layout and the open ends toward the front of the equipment layout.

Thermoforming machines 4852 and 4854 are positioned adjacent to the vacuum tube assembly so as trays produced therewith can be loaded directly into vacuum tubes. Three tray with flap, folding and bonding machines 4856, 4858 and 4860 are located adjacent to the vacuum tube assembly.

Machines 4852 and 4854 include suitable thermoforming machines that are arranged to thermoform trays with flaps from suitable rolls of expanded polystyrene sheet provided on rolls on spools 4864. Each thermoforming machine includes ovens forming and trimming apparatus. Trays with flaps are thermoformed, trimmed and ejected in horizontally disposed, and nested quantities onto shelf 4866 and 4868. Vacuum tubes 4870 and 4872 are positioned adjacent to and in line with shelf 4866 and 4868 so as to facilitate loading of the trays with flaps directly therein. In this way, trays with flaps can be produced by thermoforming machines 4852 and 4854 and loaded directly into the vacuum tubes. Each vacuum tube has an address which is known, and a computer, with CPU (central processing unit) can control the thermoforming machines in concert with the vacuum tube assembly. Any suitable quantity of thermoforming machines can be arranged at positions adjacent to the vacuum tube assembly. Each thermoforming machine can be arranged to produce different sizes of trays with flaps, as required, which can be arranged to be transferred and loaded into vacuum tubes with known addresses. Alternatively, the thermoforming machines may be arranged so as to produce trays with flaps for loading into open magazines for subsequent storage before processing on the vacuum tube assembly.

The tray with flaps, folding and bonding machines 4856, 4858 and 4860 are arranged to fold and bond the trays with flaps of different specification details. The CPU is programmed with location of each machine 4856, 4858 and 4860 and specification details of trays with flaps. Accordingly, the vacuum tube assembly can be programmed to unload trays with flaps into magazines 4874, 4876 and 4878, as required for subsequent folding and bonding. After folding and bonding has been completed by any of the machines 4856, 4858, and 4860, finished trays are positioned onto the respective conveyors 4878, 4880 or 4882 for transport thereon to packaging machines.

The tray with flaps, folding and bonding machines 4856, 4858, and 4860, the corresponding magazines 4878, 4880 or 4882 and conveyors can be enclosed in a space that can have a desirable gas, such as nitrogen, provided therein.

The desirable gas, such as nitrogen can be produced by a suitably sized nitrogen generator such as an on-site nitrogen supply, incorporating a non-cryogenic air separation devices known as Pressure Swing Absorption (PSA) Generators. Suitable PSA generators are available from BOC Gases, a division of The BOC Group. Any convenient source of gas supply may be used.

FIG. 105 shows a cross section through an apparatus that may be used for pumping pre-blended grinds into a profiled conduit thereby providing an extruded stream of grinds for subsequent slicing and production of patties. An enclosed housing 12 is shown with a tapering screw 15 mounted therein. The external surfaces of the tapering screw can be profiled to match the internal surface of housing 12 such that these surfaces are in close but not touching proximity and so that the screw 15 will scrape the internal surface of the housing 12. The arrangement in FIG. 105 shows a single screw but may alternatively be arranged with parallel sides that are not tapered. The screw is most preferably tapered and may be mounted in tandem and adjacent to a counter rotating, correspondingly matching, second tapering screw (not shown) in parallel therewith. Such a pair of matched and meshing screws can provide a means to scrape all surfaces of the screws and all internal surfaces of housing 12. As shown in FIG. 105, screw 15 is driven via a shaft 14 attached to a suitable driving motor (not shown) such as a servo electric motor, which can drive the screw(s) in a direction indicated by arrow 14 and at a variable speed. Pre-blended grinds 20 that have been processed as required in enclosed vessels (not shown) that substantially excluded oxygen from contact thereto, are provided by any suitable transferring mechanism into conduit 9 which is attached via a gas tight flange 11 to housing 12. Grinds 20 provided into housing 12 are substantially free of air or oxygen and any voids contained therein can be substantially filled with carbon dioxide. Grinds 20 can be transferred into housing 12 at a controlled temperature below the freezing point of water such as at 29.5 degrees F. Housing 12 may be fitted with a suitable jacket and insulation with conduits provided therein (not shown) through which any suitable liquid, maintained at any suitable temperature, can be transferred. A piston 16 is shown located within a cylinder 25, which in turn, is mounted directly to housing 12. Piston 16 can be directly coupled to a driving mechanism (not shown) that will activate movement of the piston in a reciprocating manner with directions of movement shown by double headed arrow 27. FIG. 107 shows piston 16, cylinder 25, grinds 20, and screw 15 and it can be seen that the end of piston 16 is provided with a radius 26, that matches the external radius of screw 15 such that when piston 16 is in close but not touching proximity to rotating screw 15, the external surface of piston 16 at 26 will be wiped by the outermost edges of screw 15 as it rotates. In this way substantially no fat or grinds can accumulate by sticking to the exposed surface of piston 16, at 26. A single matching piston and cylinder assembly is shown mounted to housing 12, however, more than one such matching assembly may be mounted in radial disposition to housing 12. In fact, for example, three or four such matching piston and cylinder assemblies may be mounted around the circumference of housing 12 and arranged to operated simultaneously or as may otherwise be required. Mounted to the exit end of housing 12, a conduit 18 is fixed in a sealed and gas tight manner. Conduit 18 is shown with a restriction therein, such that the internal diameter at the point of entry is identical to the internal diameter of housing 12 and the diameter of conduit 18 is tapered so as to reduce the cross sectional area and therefore, when grinds are pumped there through, back pressure is generated against the exposed end surface 26 of piston 16. A flange 19 is shown at the exit end of apparatus shown in FIG. 105 which may correspond with matching flanges of profiled conduits (such as 45 in FIG. 106) that can be interchangeably attached thereto, to provide a different profiles and size of extruded streams of grinds pumped there through. An arrow 29 shows the direction of flow of extruded stream of grinds 20.

In a preferred embodiment, grinds 20 are transferred into housing 12 and carried in a forward direction, indicated by arrow 29, by rotation of tapered screw 15, in a continuous stream. During transfer through housing 12, grinds 20 are compressed so as to ensure any voids that may be contained therein are eliminated by dissolving of CO2, contained in the voids, into said grinds. As stream 20 is transferred in the direction shown by arrow 29, a cone shaped conduit at 18 further restricts stream of grinds 20 and compresses it into a substantially void free stream exerting a back pressure that is proportionate to the velocity of stream 20 and the restriction according to the diameter of conduit 18. Alternatively, other suitable restrictive conduits or valves may be provided in place of conduit 18. In order to provide a stream of grinds that has been conditioned to a suitable temperature, housing 12 can be temperature controlled by any suitable heat exchanging and temperature controlling apparatus.

In a preferred embodiment, a mechanism is provided for slicing beef patties from a continuous stream of grinds, allowing slicing of individual patties to occur while the stream of grinds is stationary relative to the knife. This can be achieved by moving the slicing mechanism parallel with and at the same speed as the stream of grinds and slicing while in motion followed by rapid return of the slicing mechanism to an original position in readiness for subsequent slicing. However, this can be difficult to control and high production output is generally not possible. In a preferred embodiment the stream of grinds 20 is halted at the time of slicing. Most preferably the velocity of stream 20, at the exit point 30 can be adjusted between a maximum rate of flow that is substantially determined by the speed of rotation of screw 15, and zero velocity by controlled activation of piston 16. This may be achieved by activating piston 16, so that it moves, at a controlled rate, away from the housing 12 and therefore increasing the available volume within cylinder 25 that can be filled with grinds transferred by screw 15 and momentarily at a rate equal to the transfer of grinds through housing 12. This arrangement can provide a momentary reduction of flow and halting of stream of grinds 20 at exit point 30. In order to achieve this, and ensure that there is no movement of said stream of grinds at exit point 18, the rate of increase in available volume in cylinder 25 must be equal to the volumetric rate of flow of stream of grinds 20. Therefore, by activating piston 16 in a reciprocating manner, grinds can be intermittently accommodated within space 31, in cylinder 25 and then immediately expelled therefrom in a continuously repeated cycle. In this way, velocity of stream of grinds 20, can be intermittently varied between a maximum rate of flow and substantially no rate of flow, by adjusting the flow rate provided by rotation of screw 15 in concert with the cyclical reciprocating motion of piston 16. Furthermore, additional piston and cylinder assemblies may be installed to provide larger capacities of volumetric variation in space 31 and to vary the quantity of grinds extruded during each flow cycle from the exit end of conduit 18 at 30. Any quantity of grinds extruded during each piston 16 cycle can be arranged to be equal to the desired weight of a single beef pattie. This cycle rate may be arranged to exceed 500 cycles per minute and, for example, if it is desired to produce quarter pound beef patties, at this rate of 500 cpm, a total rate of production would be equal to 125 lbs. of patties per minute.

Referring now to FIG. 106, a cross section through an apparatus intended for use in slicing extruded streams of ground meats, as described above in FIG. 105 to produce patties, is shown. Any suitable cutting blade may be used to slice from a continuously extruded section 40, such as a high-speed, band blade that is driven by a suitable electric motor. Referring now to FIG. 105 and FIG. 106, a temperature controlled conduit, 45, with flange 41, is arranged so that it can be mounted directly to the flanges 19, of apparatus shown in FIG. 105. An arrow 42 shows the direction of flow of a stream of grinds 40 transferred from conduit 18, via orifice 30 into conduit 45. Conduit 45 may be provided at any suitable length 43, and can be arranged with temperature controlling conduits 44 imbedded in the walls of conduit 45. Any suitable liquid that will remain liquid at a selected temperature may be transferred through conduits 44 at a flow rate that will ensure temperature control of stream 40 as may be required. A knife cutting blade 47 with suitably machined bearing attachment 54 is shown mounted to a driving shaft 46. Conduit 45 is mounted at a convenient angle and adjacent to revolving blade 47 such that as blade 47 is rotated, patties can be sliced from stream of grinds 40 and deposited into stacks of sliced patties as shown at 51 and 52. In this way, patties can be produced, stacked and transported to a packaging station via conveyor belting 50 that is driven intermittently by a drive roller 49 in a direction shown by arrow 52.

In order to minimize accumulation of fat and/or ice on the internal surfaces of conduit 18, scrapers (not shown) may be mounted, for example to the end of screw 15 to scrape internal surfaces thereof. Additionally, internal conduit surfaces may be treated with non-stick surfaces that are resistant to any such build up of fat and/or ice. Furthermore, separate temperature zones may be arranged such that, for example, housing 12 may be maintained at 29.5 degrees F. and any suitable insulation provided at the connection between conduits 18 and 45. In this way conduit 45 may be set at a much lower temperature such as 10 degrees F. so as to cause a “crust” freezing of the external surface of stream of grinds 40 and thus provide an improved condition for slicing by knife 47. The intermittently varied velocity of stream of grinds 18 can be directly and correspondingly integrated with each revolution of knife 47 such that during the knife cutting action of stream 40, the velocity of stream 40 is reduced to virtually zero and then as the knife rotates through an arc away from the stream 40 and toward the next slicing of the subsequent pattie, the velocity of stream 40 can be accelerated then decelerated so as to be again in a substantially stationary position for subsequent slicing by said knife 47. Control of stream 40 flow rate is therefore provided by the reciprocating action of piston 16.

Referring now to FIG. 108, a side elevation of an apparatus assembled to continuously produce fine ground boneless beef 77, from coarse ground boneless beef 61 in an enclosed system that substantially excludes oxygen, is shown. Coarse ground beef 61 is transferred through conduit 63 to fine grinder 65. Flanges 62 and 64 are fixed together to provide a gas and liquid tight seal there between allowing continuous transfer of pressurized coarse ground beef 61 to fine grinder 65. Ground beef 61 and 77 can be maintained at a selected temperature such as 29.5 degrees F. Fine ground beef 77 is then transferred into vessel 70 from grinder 65, and allowed to accumulate therein. A connection to vessel 70 from a gas source, via a pipe 78 provides a conduit to deliver suitably pressurized gas such as carbon dioxide into vessel 70 and to allow contact of selected gas with grinds 77. Also, a conduit 79 allows controlled release of excess gas that may accumulate in vessel 77, for example via controlled pressure release valves (not shown) installed in conduit 79. In this way a selected gas such as carbon dioxide can be provided in any free space in vessel 70, at a constant, selected gas pressure. Positive displacement pump 71, is driven via shaft 72, that in turn is driven by a servo electric motor (not shown) or other such suitable variable drive motor and in such a manner as to allow adjustment, as required, to the rate of pumping of fine grinds 77 from vessel 70 into conduit 73. Pump 71, may also provide a controlled pressure inducing feature by its pumping action of fine ground beef 77 into conduit 73 thereby causing substantially all gaseous voids, contained in 77, to be eliminated by dissolving of any free CO₂ gas contained therein. In this way, grinds 77 that may contain voids or spaces filled with CO₂ can be transferred to a solid stream of grinds 20 that is substantially free of any voids. Solid stream of grinds 20 may be transferred in the direction shown by arrow 74 to directly connect to conduit 9 shown in FIG. 105.

The aforementioned method and apparatus for the processing meats refers not exclusively but most preferably to ground meats that are can be pumped via a single or several positive displacement pumps. In many other applications, production of meat food products, that involve slicing of large pieces of beef, is required. It has been determined, by the present inventor, that preventing contact of the freshly cut beef surface with atmospheric air can provide enhancement of storage life. Consumers, in general will only buy red meat and therefore to accommodate the needs of the consumer and the requirements of the meat packer, the present invention is directed at providing an improved process whereby meat is sliced by automatic apparatus, directly into an enclosure that excludes air (and oxygen). Therefore, in another preferred embodiment, apparatus shown in FIG. 109 and the following disclosure, an apparatus that can slice primal beef portions directly into an enclosure with an oxygen free gas therein, is detailed.

Referring now to FIG. 109, a round cross sectional conduit 81 is horizontally disposed and mounted with an exit end 103 directly adjacent and above an end of a conveyor 94, that is mounted at an elevating angle to the horizontal. The conveyor elevating angle is set such that slices of meat will be urged forward by the action of blade 92 as it rotates and descends, slicing through the primal so that the sliced and separated portion will fall gently onto the conveyor 94. Enclosure 98 can be filled with carbon dioxide gas 99 or other suitable gas that is held at a suitable temperature and gas pressure above ambient atmospheric pressure and in such a manner to ensure that substantially no air and most importantly, no atmospheric oxygen can enter enclosure 98. The profile of conduit 81 may be chosen to suit any particular product which may not be round and for example, a square or rectangular profile may be chosen, however, in this instance a round profile has been shown. A blade 92 attached to a shaft 91 is conveniently mounted at the exit end 103 of conduit 81 such that slices 94 can be cut from the end of primal 87 after emerging from conduit 81. Blade 92 can be arranged to cut a single slice during a single revolution of shaft 91. Therefore the intermittent sequencing of firstly driving blade 92 for a single revolution to cut a single slice, followed by the measured and controlled movement of a primal such as 87 from the exit end 103 of conduit 81 can be arranged to automatically and continuously operate. Slices 94 can then be carried forward in a continuous or intermittent and controlled action for further processing or packaging, along conveyor 94 driven in the direction shown by arrow 96, by roller 93.

Plugs 82, 85 and 89 are shown in cross section and located on the inside of conduit 81 between primal beef portions 87. Primal beef portions 87 may have been previously processed and allowed to set in a mold, after pre-rigor mortis harvesting from a slaughtered animal, such that the cross sectional dimensions of the molded primal corresponds substantially with the cross section of conduit 81. This method of molding primal cuts of meat has previously been described in the inventor's earlier patent disclosures and while the primal cuts can vary in size, molds can be arranged such that only those dimensions shown by numbers 101 and 102 will significantly vary. In this way, primal cuts of meat may be located into the entry end of conduit 81 and in the direction shown by arrow 100. After locating a primal 87, into the entry end of conduit 81 a plug such as 82 is then loaded directly behind the primal 97 followed by another primal and then another plug such that a continuous sequence of primal cuts, each with a plug interposed between. Each plug such as 82 comprises a profiled “piston” with an iron core 88 enclosed in a plastics frame 85. Each iron core 88 may be magnetized to such an extent that, when a suitably mounted electromagnet is adjacent thereto a magnetic bond is developed between the iron core 88 and the electromagnet that is substantially unbreakable by any force that is likely to be applied to either part in this apparatus application. Frame 85 is arranged with one or more flexible lips 86 that can sealingly contact the inner surface of conduit 81 and but allow plugs 82 to slide along the internal surfaces of conduit 81, flexible lips 86 can thereby provide a seal around the full perimeter of plug 82 with conduit 81 and can therefore act as a piston held captive within the conduit 81. A series of electromagnetic rings 83, are mounted to a drive mechanism (not shown) and each electromagnet is “mated” with a single plug such as 82, located on the inside of conduit 81. The distance between each plug such as 82, and as shown in examples 101 and 102 can be electronically measured by proximity devices conveniently mounted external to the conduit 81 and adjacent thereto and in such a manner so as to allow measurement of any distance between any two plugs. In this way, any particular primal cut of beef can be measured and with suitable computer apparatus arranged and connected to any suitable measuring arrangement such as said proximity switches, a selected quantity of slices can be automatically calculated and subsequently sliced as the primal emerges from the exit end of conduit 81 by knife blade 92. It may be preferable to remove a thin section of sliced meat from each end of each primal and divide the balance into a quantity of slices having a desirable thickness. Alternatively the length of each primal, as shown in examples 101 and 102, can be divided into a selected number of slices with a thickness automatically calculated, accordingly. Alternatively, slices of a chosen weight may be calculated by computer apparatus. In all cases, the primal cuts can be automatically and intermittently transferred along conduit 81 with each forward movement of electromagnets 83 which carry plugs such as 82 forward simultaneously. In this way, the thickness of any slice cut by knife 92 can be determined by the distance of each forward movement of electromagnets 83. As plugs, such as 82, are carried forward and emerge from exit end 103, the operation of blade 92 can be arranged to allow the automatic removal of each plug and subsequent transfer to the entry or loading end of conduit 81 in readiness for its next use. Plugs can be sanitized prior to next use as may be required.

Conduit 81 can be temperature controlled by any suitable method which may be provided by circulating liquid, such as glycol, through conduits provided within or in contact with the walls of conduit 8, and the internal surface of conduit 81 may be treated so as to resist “sticking” to anything passed there through. In this way, primal portions of beef may be “crust frozen” during transfer through conduit 81. One or more conduits, such as 97, may be provided to connect a vacuum, gas or selected agent source directly to conduit 81.

Perishable food products produced, in part or otherwise, in the manner described herein may be placed in any suitable tray with or without any suitable substance and over wrapped with any suitable web of material such as pPVC and then placed in a master container that may be manufactured from a substantially gas barrier material or partial gas barrier material to provide finished packages. Following this, finished packages may be stored in any suitable storage room maintained at any suitable temperature until required for sale, at which time finished may be removed, labeled and displayed for sale in a retail outlet such as a supermarket.

Electronic Method of Transacting Business

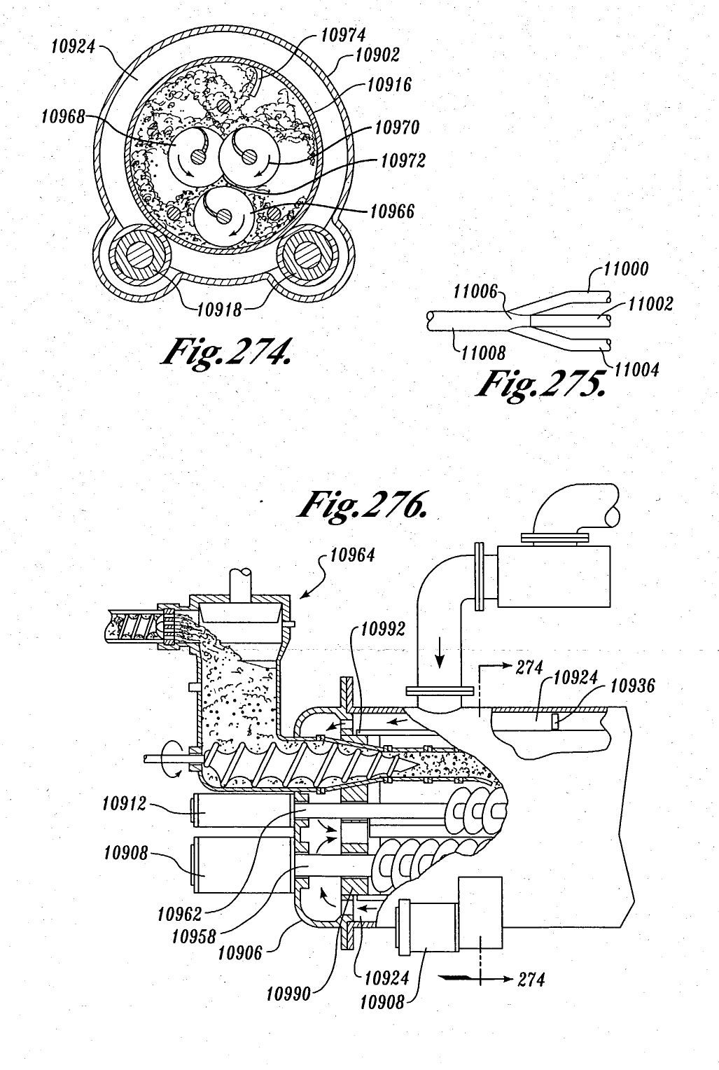

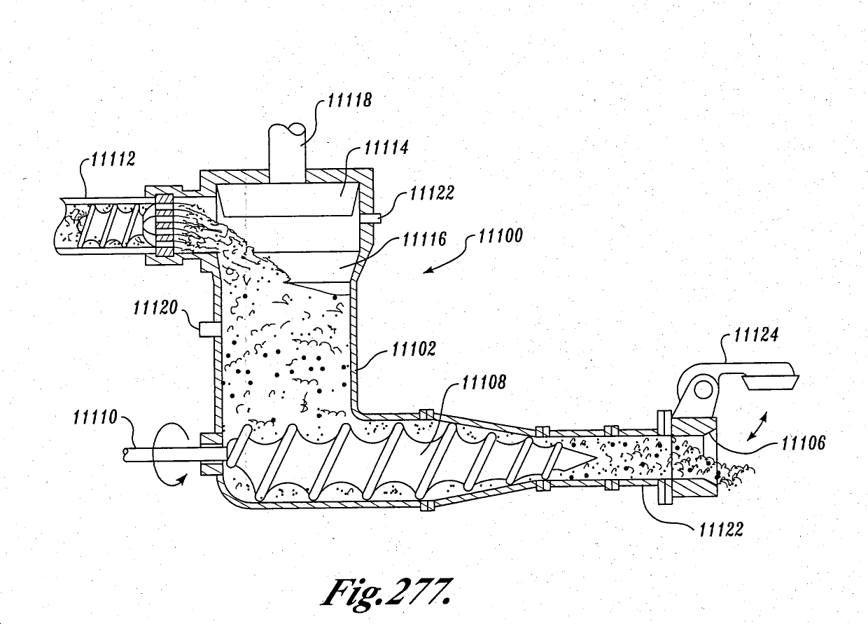

Referring now to FIG. 275, a schematic representation of an apparatus for storing and processing goods in a meat processing train resident in a meat processing plant, is illustrated.

A pressure vessel 8058 is connected directly to a supply conduit 8002 in a gas and liquid tight manner, such that goods 8012 can be transferred through conduit 8002 and into vessel 8058 for storage and processing therein. Vessel 8058 may be arranged in an inclined disposition so as to reduce the depth of goods, measured along a vertical, straight line inside the vessel, contained therein. Vessel 8058 may also be arranged with a suitable blending arrangement mounted therein in such a manner so as to allow blending of any goods stored in or transferred through vessel 8058. A fat, protein and water content measuring device 8004 is inserted between conduit 8002 and valve 8006. The measuring device 8004 may be mounted at the connecting point and directly between conduit 8002 and vessel 8058 to provide a means of isolating conduit 8002 from vessel 8058 in a gas tight manner. A tube 8060 connects vessel 8058 to a source of suitable gas or agent via a suitable valve (not shown) to allow transfer of any suitable gas or agent, such as any storage life enhancing gas, into vessel 8058. A port 8008 with connection hose to a suitable vacuum generator is provided in the wall of vessel 8058 at an upper location so as to allow evacuation of gases from vessel if required. A connection to conduit 8016 is provided at a lower location in the vessel 8058 such that any goods transferred into vessel 8058 will tend to gravitate there toward, irrespective of any mechanical transferring arrangement that may be mounted inside vessel 8058. Conduit 8016 is connected directly to a positive displacement pump 8022 via a liquid collection point arranged to collect any purge 8018 or liquids that may accumulate in vessel 8058 after normal release from goods therein, such as purge associated with meats. A connection tube 8052 is coupled to pump 8054 in such a manner so as to allow pumping of any accumulated purge or liquids 8018 via tube 8056. Tube 8056 is connected to a spray nozzle arrangement 8064 mounted on the internal wall of vessel 8058 at an upper location of vessel 8058. In this way purge 8018 can be sprayed in a spray 8010 onto the upper surface of goods 8012 and thereby be returned to its source within vessel 8058. Purge 8018 may reticulate downward and again accumulate in 8016 and so be recycled by pumping again through tube 8052. Purge 8018 may also be treated with any suitable agent such as suitable bactericide, prior to spraying at 8064 and thereby reducing bacteria content and improving safety of the ground meat product for human consumption. With the apparatus herein disclosed, it can be seen that goods 8012 can be transferred via conduit 8002 through measuring device 8004 and valve 8006 and into vessel 8058 in a manner that substantially excludes ambient air. Measuring device 8004 can provide a means to measure the quantity of fat and/or water and/or protein in goods transferred there through. In this way, the value of goods in vessel 8058, based on current market pricing, can be immediately and automatically calculated as it is transferred therein. A valve 8020 is mounted directly beneath conduit 8016, which in turn connects to positive displacement pump 8022. Valve 8020 is arranged to provide a means to substantially isolate vessel 8058 in a gas and liquid tight manner. Positive displacement pump 8022 is arranged to pump goods, as may be required, through fine grinder 8024 and subsequently extrude fine ground goods, such as ground beef, directly into packaging trays, such as 8028, that is positioned adjacent thereto. Alternatively, any other processing arrangements such as pattie manufacturing equipment, can be connected directly to the downstream and exit end of pump 8022, and in such a manner so as to allow any selected processing methods of goods. The exit end of pump 8022 may be enclosed in an enclosure that is filled with an oxygen free and suitable gas, selected for it's food product quality and storage life enhancing properties.

Referring now to FIG. 276, a cross section of a portion of the meat packaging system is illustrated. A pair of horizontal conveyors 8072 carry a tray 8068 loaded with meat 8066. A space is defined between the horizontal conveyers 8072, such that a ink jet printer 8074 can reside between the conveyors 8072. The ink jet printer 8074 can print a barcode with information such as weight and date of packaging the meat product 8066.

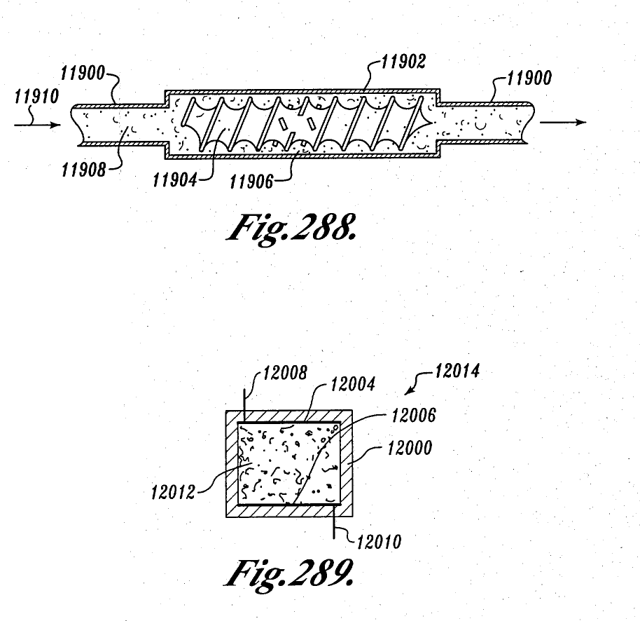

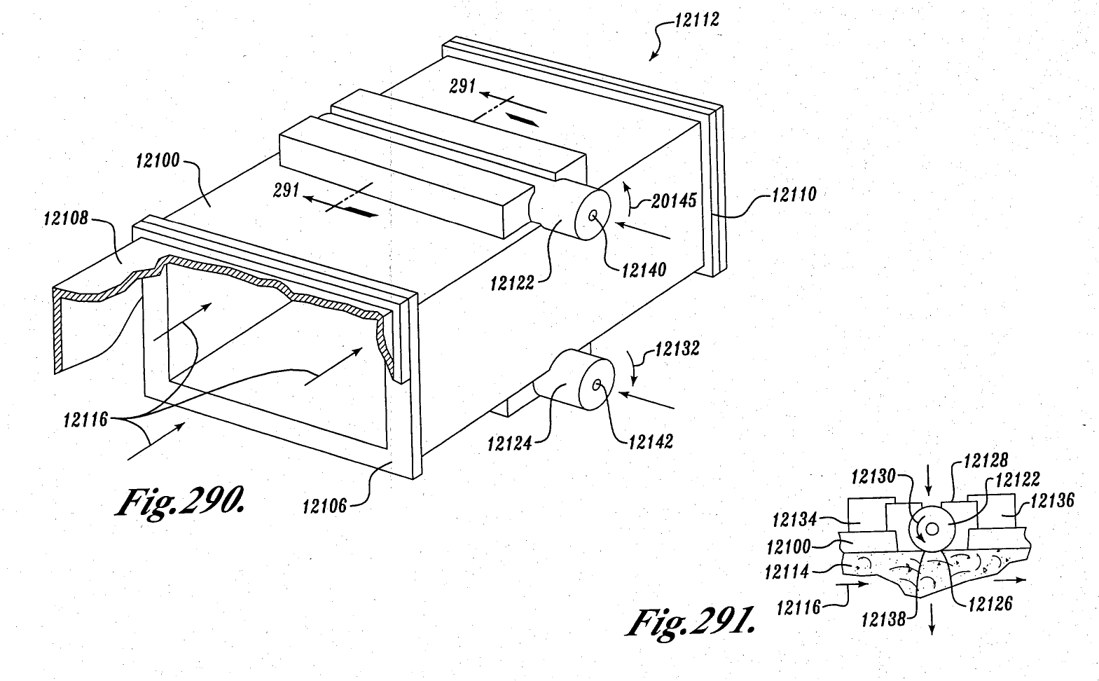

Referring now to FIG. 287, a schematic illustration of a system for transacting commerce over a communication network according to the present invention is illustrated. The meat processing equipment is resident within a meat processing plant 9000. The meat processing equipment can be the processing and storage equipment illustrated in FIG. 275 or any of the equipment, which can reside within a meat processing plant 9000, as described in this disclosure. The meat processing plant is connected to a communication system, such as the internet 9006, via a seller computer 9004. A person of ordinary skill in the art will appreciate that seller computer 9004 can include a plurality of computers connected within a LAN environment. Furthermore, the seller computer 9004 can be connected to one or a plurality of operator terminals having a monitor, user interface and input devices. Referring now to FIG. 288, the seller computer includes a central processing unit 9012 (hereinafter “CPU”), network interface 9100, display 9104 and mass memory 9106. Residing within the mass memory of the seller computer 9004 are instructions for providing a graphical user interface (hereinafter “GUI”), a database 9110, and an operating system 9112. The database may contain historical sales data, traffic, weather, or road information to enable the determination of an estimated delivery time to a buyer's designated destination. Such historical information, when used in this manner can provide a means of more accurate prediction of actual sales of fresh meat products, for example ground beef and beef patties are purchased and consumed by consumers at barbecues, more frequently and in larger quantities during the hot summer week end and holiday periods, when compared to colder periods when barbecues are a less appropriate and popular recreational event. Referring again to FIG. 287, the seller computer is connected to the internet 9006, which in turn is connected to one or a plurality of buyer computers, 9008, 9010, 9012. The buyer computers are used to place an order specifying one or more specifications, such as quantity of meat, type of meat, fat content, lean meat content, weight, size, or any other of a plurality of specifications which is useful for quantifying meat products. The seller computer 9004 receives purchase orders via the internet 9006, with a central processing unit receiving the order and processing the order to determine which variables or parameters to manipulate in the meat processing plant 9000 to fulfill the buyer specifications. The seller computer 9004 may vary the rate of production of a processing train or adjust the content of fat in proportion to lean tissue by controlling valves, pumps or direct a slicing or cutting machining to cut a predetermined amount of product in differing sizes or shapes. The seller computer 9004 can also contain instructions to extract weather or highway and road information from other servers 9014 and 9016 connected to the internet 9006 to compute an estimated delivery time at the buyer's designated destination. The seller computer 9004 includes programmable instructions to direct certain events to occur when the estimated delivery time to the buyer's specified destination are in excess of the allowable amount of time that meat can remain in a finished package without undergoing significant oxidation such that it would become unsalable. Meat packaged in a controlled atmosphere environment of carbon dioxide according to the present invention can endure for about 6-9 days after exposure to ambient atmospheric gas at 36 degrees F., without undergoing significant discoloration or rancidity/oxidation. If however, the estimated time of delivery will exceed this recommended amount, the seller computer 9004 can direct that the buyer's order be packaged in a gas barrier master container containing a substantially oxygen free gas. Packaging in a master container extends the shelf-life of finished packages for about an additional 6 weeks. However, if the estimated amount of time necessary to deliver the buyer's order to the designated delivery destination is less than the amount of time before sufficient discoloration or rancidity/oxidation sets in, then the buyer's order does not need to be packaged in a low oxygen gas barrier master container, thus reducing the average cost per pound of meat product because average packaging costs can be reduced. Once packaged the meat is delivered to the buyer through conventional channels, such as by refrigerated truck 9002, rail, or ship to the buyer's designated destination. The memory of the seller computer 9004 contains programmable instructions for carrying out the present invention. One method carried out by seller the computer 9006 is illustrated in FIG. 290. The method includes an event for receiving buyer specifications 9300. The seller computer will then execute a set of programmable instructions designed to carry out the buyer's order in event 9302. The seller computer may for instance issue instructions that result in accelerating a pump and conveyor to increase the rate of production, or open a valve to mix any number differing meat streams of differing fat content to arrive at the buyer's specification for fat content. Other instructions can direct a cutting machine or slicing equipment, sealing station, weigh station, counter, collating or order consolidation/assembly direct from the packaging line or from packages held in storage, followed by palletizing to meet the buyer's order. Further, the seller computer will determine whether it will be necessary to package the finished trays in a barrier master container, which can involve calculating an estimated time of arrival to the buyer's designated destination 9304, or estimated time of arrival at the point of sale to a consumer, after delivery to a distribution center. The seller computer can receive any desirable parameter and necessary information to carry out the instructions either from a resident database of previous buyer data or the seller computer may gather the information from the internet from other computers 9014 and 9016. The seller computer may use weather information 9312 or transportation information such as road or highway conditions 9310. The seller computer contains instructions to package a buyer's meat order in a master container 9306, when it is determined that an unacceptable level of deterioration will occur to the packaged meat if it is not packaged in a master container. The seller computer will then instruct the packaging train to package, palletize and ship the product to the buyer 9308. The seller computer can also have access to the buyer historical data to use in computing the quantity or type of meat which is purchased by buyers.

In another alternate embodiment of the invention, the buyer can be invoiced from the measuring devices located upstream of the vessels. For example, the measuring devices located after the grinding heads can be used to invoice the buyer, while the meat is still held in storage in the vessels. In this manner the product can be specifically tailored to an individual buyer's specifications.

Furthermore, the present invention can also provide for a method of compensating for surge in the blending process. For example, surge can be eliminated by excluding any gas in the meat streams, but ground meat is elastic and can continue flowing at a rate exceeding the pumping velocity after the pump has been slowed or stopped. Alternatively, when the pumping velocity is accelerated, the actual velocity may lag momentarily. The above has an effect on blending accuracy, particularly, when the on-line fat, water & protein measuring device is located upstream from the continuous blender. As the meat streams (two or more) emerge from their respective conduits directly into the blending conduit the fat, water and protein (fat and lean) content of each stream determines the velocity of the respective streams. The fat and lean content is measured upstream therefore there is a set distance (measured) between the point of measuring and the point of transfer from the conduit to the blender. The pumping speed therefore must be adjusted to compensate for this surge.

Referring now to FIG. 289, a buyer computer includes a network interface 9200 for connecting to a communication system, such as the internet, a processing unit 9202, a display 9204, a mass memory 9206 including instructions for providing a GUI 9208 and an operating system 9210. Buyer computers may be located at supermarkets, supermarket head quarters, or regional centers where all sales data and information is collected directly from the checkout bar-code reading apparatus located at each supermarket. A person of ordinary skill in the art will readily appreciate that one or more computers can be used by a buyer at a remote location to enter purchase orders via the internet. Buyer computers can also include hand held remote controlling devices. The information gathered at the point of retail by buyer computers can be gathered and sent to a remote or local regional buying center having another buyer computer. The regional buying center can communicate with the seller server to place an order via the internet. Furthermore, the seller server computer can have access to the historical data gathered by buyer computers as well.

Referring now to FIG. 277, an actual embodiment of a pre-form web with flaps is illustrated. The pre-form web 8100 can be shaped into a finished tray. The web can be constructed of any suitable material such as PVC, PP or other suitable materials herein disclosed in this specification. The method used to form the web can be thermoforming or any other suitable methods. The web 8100 is constructed of a rectangular base 8102. The base is surrounded by four upwardly extending walls 8104, 8106, 8108 and 8110. The walls may be outwardly reclined to facilitate the removal of the web from a mold or the nesting together in a stack of similar tray pre-forms (not shown). The walls are connected to the base 8102 at a lower portion thereof and adjoining walls are connected to each other thusly forming corner sections. In this embodiment, the corner sections are made from the ends of the walls being creased inwardly 8114 where the ends attach to an adjacent wall. Thus, two ends of two walls form an inwardly extending corrugation 8112 to give the web additional strength when finished into a tray. Two walls 8102 and 8108 of the four walls on opposing sides are formed with an upwardly extending region 8116 in the center, and an angled shaped bottom edge 8118 to give the finished trays the ability to be stacked atop one another without allowing the sealing web of a lower tray to touch the base of the adjacent stacked upper tray. While an angled bottom has been shown, the shape may take an arcuate form. Furthermore, the base is configured to have similar angled surfaces or arcuate shape that corresponds to the shape of the lower portion of the side walls 8102 and 8108. The upper edges of the walls 8104, 8106, 8108, and 8110 are attached to flaps 8120, 8122, 8124 and 8126, respectively. Referring now to FIG. 278, the flaps are joined to the upper edge of the walls at a hinge 8128 to allow the flaps to rotate inwardly. The finished tray 8130 will thusly include an outer 8132 and an inner 8134 reinforcing wall made from the flaps. The flaps include a tab 8136 connected to one edge of the flap which can be folded inwardly as shown in FIG. 278 to press fit into a groove 8138 formed at the lower perimeter of the base 8102. The member formed by the folded tab 8136 thus forms a securing device which is press fitted into the corresponding base groove 8138 without the need for bonding the flaps to the finished tray with adhesives thereto.

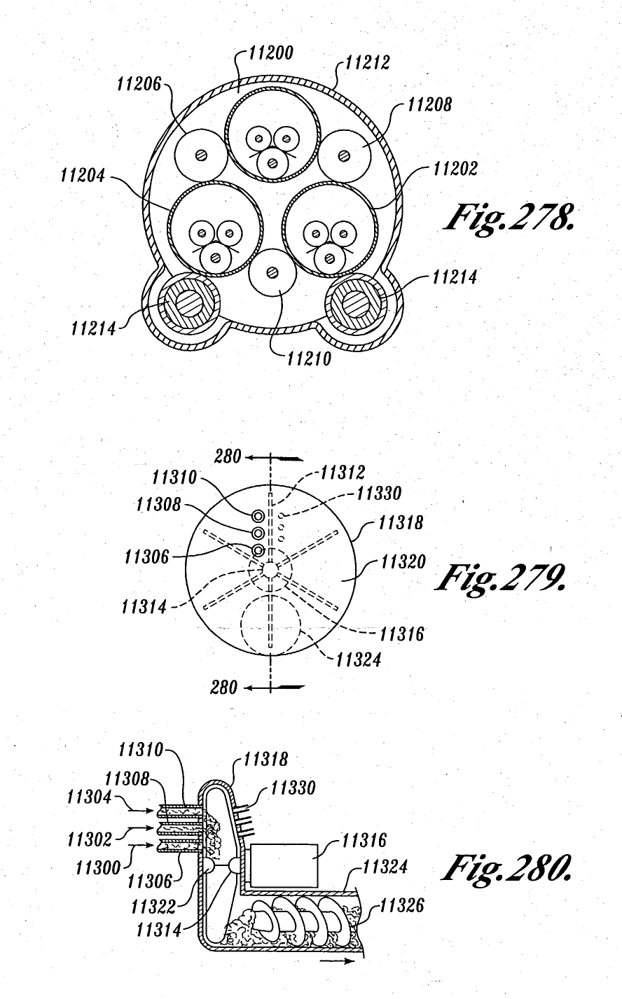

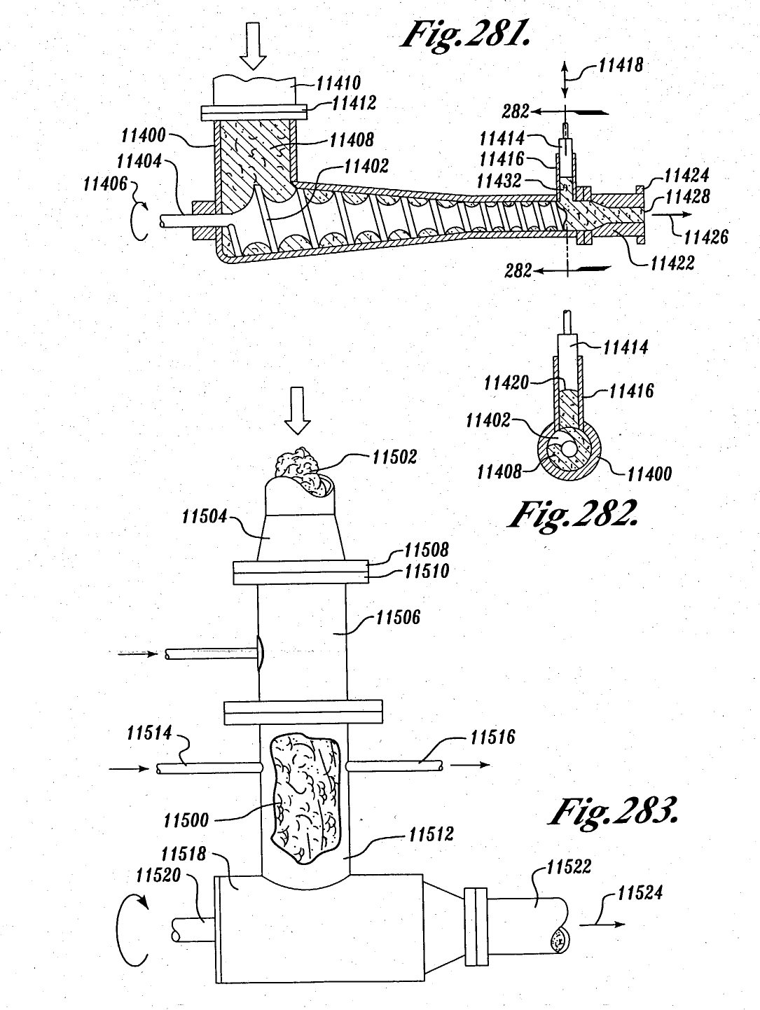

Referring now to FIG. 279, a mold 8200 for forming pre-rigor mortis meat is illustrated. Pre-rigor mortis meat is moldable to form any of a variety of desired shapes by placing quantities of harvested pre-rigor meat into any one of a plurality of mold forms. In one actual embodiment shown in FIG. 279, a mold 8200 is shaped in an elongated form. The mold 8200 can be constructed of suitable materials, some of which can be advantageously permeable to ozone or any other suitable gas or substance. The mold 8200 has four walls 8202, 8204, 8206, and 8208. The bottom wall 8206 of the mold 8200 can be configured to be angled or arcuate such as the base shown in FIG. 277. However, any mold can be provided with a bottom wall suitably configured to the shape of any of the trays herein disclosed. This is provided in a mold so as to enable slicing of the meat into portions of similar size and weight, which can conform to the finished tray to utilize the space within the tray in the most efficient manner. In this way substantially identical slices of meat can be produced with virtually no trimming requirement. Whenever trimming is required, a loss is incurred since the portions trimmed off can only be used in a product, such as grinds, of lower value than the sliced meat. Identical slices can be sold in packages of “same weigh and same price”, which is a preferred supermarket strategy as opposed to randomly priced packages that have individual package price determined by random weight due to inconsistent size and weight of each slice of fresh meat contained in a single package. Referring again to FIG. 279, two walls 8204 and 8208 of the four walls form the vertical walls of the mold 8200. The vertical walls 8204 and 8208 can be inclined or reclined to match the configuration of any packaging tray walls. The mold 8200 includes a top wall 8202 connecting the two vertical walls 8204 and 8208 at a upper portion thereof. The mold 8200 also includes a bottom wall 8206 connecting the vertical walls 8204 and 8208 at a lower portion thereof. Thusly formed, the mold 8200 resembles a hollow tube with a cross-section shape shown in FIG. 280. Although an irregular shaped polygon is shown as a profile shape, the shape of the mold can be any suitable shape to resemble a tray's dimensions. The bottom wall 8206 can be shaped to substantially conform to the tray base as described above. The mold 8200 includes openings formed on opposite ends of the mold thereof. A lip 8210 is formed within a short distance inward from a first opening of the mold 8200. A plug 8212 fits within the opening and is constrained to move toward the opening by the lip 8210. A second plug 8214 is inserted in the mold 8200 from the opposite opening. The second plug 8214 can be pressed to form the meat to a shape substantially resembling the mold 8200. A chip 8216 or proximity switch can be embedded within the plugs to determine the distance from the first plug to the second plug. In this manner, the correct size of the meat portions can be determined. Once the pressing operation is completed, the shaped meat 8218 can be sliced automatically or manually to suit the size of the finished trays. In this manner, two dimensions are kept constant which will consistently provide meat portions of constant size and weight that can fit within the trays, while advantageously only varying one dimension, which will most preferably be the length of the molded portion. The shaped meat can contain an area of fat 2819.

In another alternate, the mold is provided with a port for injecting desirable concentrations of gases or for evacuating undesirable constituents, which can include gases or liquids.

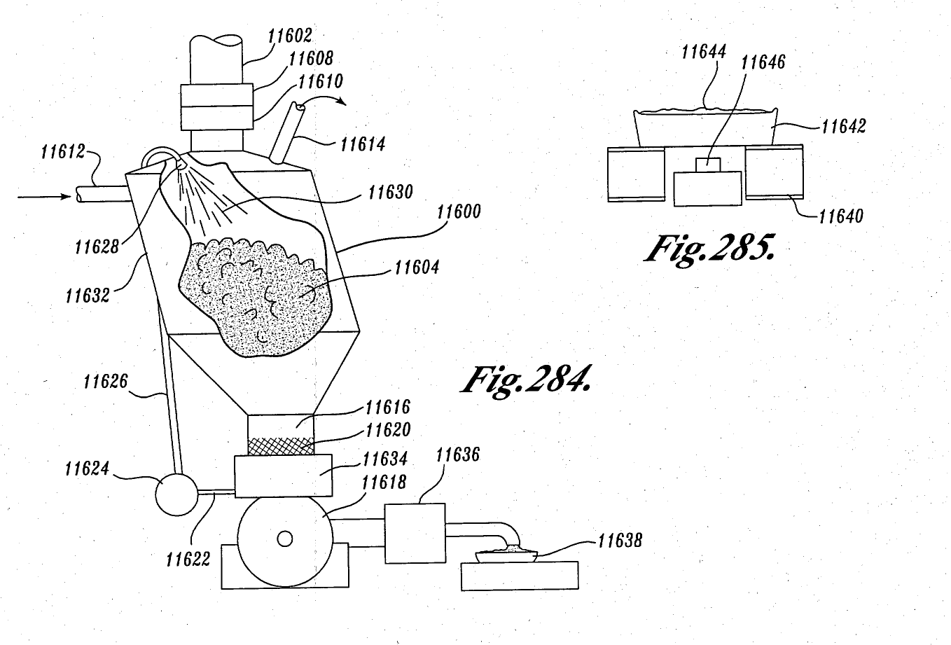

Referring now to FIG. 282, an alternate embodiment of a pre-form web with flaps is illustrated. The web 8300 includes a base 8302 with four vertical walls 8304, 8306, 8308, and 8310 connected to the base 8302 at lower edges of the walls thereof. The pre-form web 8300 is preferably constructed by injection molding or other suitable methods, such as thermoforming. The walls may be inclined to facilitate the removal of the web pre-form from a mold. The base is connected to the walls at lower portions thereof, and the walls are connected to each other at adjacent ends, thusly forming corners 8312, 8314, 8316 and 8318 where the ends of walls connected to each other and to the base 8302 meet. Opposing two walls 8310 and 8314 of the four walls are formed with angled edges at a lower central portion thereof to form an recess so that upon stacking of finished trays, the goods are preferably not in contact with a lower stacked tray. The base 8302 is likewise configured with angled surfaces to correlate to the shape of the walls 8310 and 8314 so that the base 8302 is aptly suited to minimize contact with the goods of a lower stacked tray. The upper edges of the walls include flaps 8320, 8322, 8324 and 8326 suitably constructed so as to inwardly rotate about a hinge around the perimeter of the opening. Referring to FIG. 283, the flaps are constructed with a number of surfaces 8328 and 8330 at desirable oblique or perpendicular angles to impart strength to the flaps and the finished tray in the form of a structural member. As with other trays disclosed herein, the tray of this embodiment is intended to be stackable atop one another. Referring now to FIG. 284, a portion of a finished tray with goods 8332 placed therein and folded flap 8334 is illustrated.

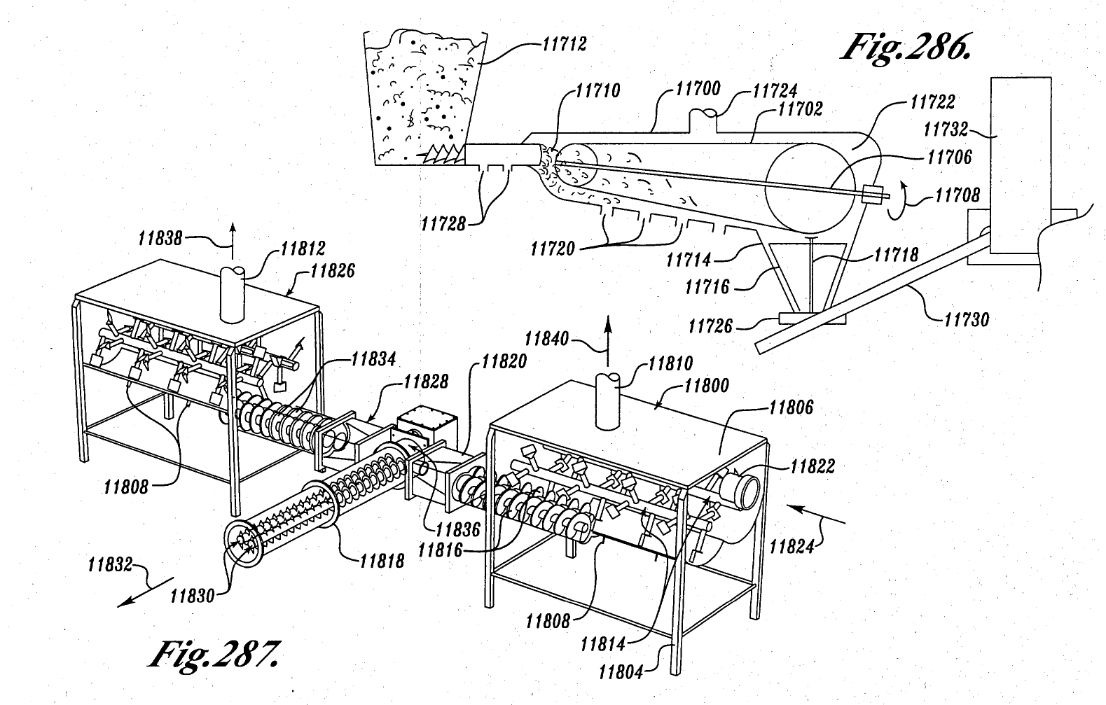

Referring now to FIG. 285, another alternate embodiment of a pre-form web for finishing into a tray is illustrated. The web in this embodiment can be thermoformed of suitable materials disclosed herein or by other suitable methods known in the arts. The web 8400 includes a rectangular base 8402 with four walls 8404, 8406, 8408 and 8410 attached at the respective four sides around the perimeter of the base 8402. The walls contain ribs 8422 to add structural rigidity and strength to a finished web. When the flaps are folded, the flaps can be bonded to the ribs, which project outward, thusly allowing bonding of the ribs to the flaps. In this manner, the flap faces 8424 can be pre-printed with a barcode containing relevant information or other product description. The walls are connected to each other at adjacent ends thereof, respectively. The four adjacent walls are joined to each other by corrugated sections 8412, 8414, 8416 and 8418 joining a first end of a first wall to a second end of a second wall and so on. When the web 8400 is finished into a tray, the corrugated sections will appear as shown in FIG. 286. The corrugated sections are intended to impart rigidity and strength to the finished tray 8420. For example, under certain thermoforming or injection molding conditions, the lower corners where the base and walls are connected, the web material may be stretched or “thinned” out, thus creating a weak spot and a potential source for leaks. By forming a web with corrugated corners the weak sections of the finished tray are strengthened accordingly.

In another alternate embodiment illustrated in FIG. 294, a tray is constructed with flaps and having contoured ends to substantially lie adjacent to a corner where the base and walls are joined together, when the flaps are thusly folded. The flap ends reinforce the corners of the finished tray by overlapping and/or wrapping around the corner sections on the bottom and sides thereof. One or two flap ends may be bonded to a corner to reinforce the corners. In one actual embodiment, a tray 9700 includes four flap, flaps 9702 and 9704 include contoured end portions 9706 and 9708, respectively, rounded to conform to a rounded corner 9710 of the web base and walls. A first flap 9702 is folded and bonded to the tray 9700 such that the rounded end portion 9706 of the flap 9702 overlaps the corner area 9710. A second flap 9704 has an end portion 9708 can be folded on top of the first rounded flap end portion 9706 to doubly strengthen the corner section 9710 of tray 9700, as illustrated in FIG. 295.

A method according to the present invention includes grinding boneless beef directly into an enclosed chamber that has been filled with a suitable gas such as CO2 and which substantially excludes oxygen from contacting with said ground beef. Adjusting temperature of said ground beef to a suitable temperature. Processing and mixing ground beef (meat), in a vessel or series of vessels substantially excluding oxygen, so as to blend and adjust the relative quantities of fat and muscle in the finished product to a desired ratio can take place, while maintaining the ground beef at a suitable temperature. The ground beef can then be extruded in a stream of grinds by pumping through an enclosed conduit with an exit end and a selected cross sectional area and profile that is substantially similar to typical beef pattie, at a velocity that is adjustable while maintaining pumping at a substantially constant rate. The stream of ground beef can be pressurized in a conduit at a selected pressure and compressing any voids such that CO₂ gas contained therein dissolves into the stream of ground beef, while continuing to maintain ground beef at a suitable temperature. The velocity of the stream of grinds can be adjusted so as to intermittently slow or stop it's flow as it emerges from the exit end of the enclosing conduit and allow slicing with knife means to provide single beef patties in stacks of a chosen quantity. Intermittent slowing or stopping of flow may exceed 500 cycles per minute. The processed meat is interfaced with a packaging system which packages the fresh meat patties without exposure to air while continuing to maintain at a suitable temperature.

Referring now to FIG. 291, a schematic illustration of a plant layout is shown. The plant layout includes a processing stream or train, for processing meat. In one section of the plant, sources of meat 9454, 9456, and 9458 are transferred to meat grinders 9402, 9404, and 9406. A suitable supplier for meat grinders is the Weiler Company, Inc. of Whitewater, Wis. The meat grinders are connected to downstream pre-blending and transfer equipment 9408, 9410 and 9412, which may include screw and/or belt conveyers and pumps as the transfer equipment. The pre-blending and transfer equipment may be supplied by the Weiler Co. and the continuous blending equipment supplied by Case Ready Solutions, LLC of Mercer Island, Wash. The pre-blending equipment is connected to on-line measuring devices 9414, 9416, and 9418, respectively, for measuring the amount of fat to lean meat ratio. The measuring devices can be supplied by Epsilon Industrial of Austin Tex. or Holmes/Newman of Fallbrook, Calif. The transfer equipment includes positive displacement pumps supplied by the Weiler Company. Downstream from the measuring devices, the meat is transferred to continuous blending equipment, 9420 where the meat is blended in a controlled or modified atmosphere, which substantially excludes oxygen. At this point one or a plurality of meat streams can be fed into the blending equipment to provide for meat grinds of a desired constituency of fat and lean meat, therefore the continuous blending equipment includes a product entry port for one or a plurality of meat streams. The continuous blending equipment is supplied by Case Ready Solutions, LLC and Wenger of Sabetha, Kans. While a continuous blending process is preferred for consistency and efficiency, the ground meat can be fed in batches with holding vessels interspersed throughout the process, the meat can then transferred to one or more vessels 9432, 9434, 9436 and 9440 for temporary storage. One vessel 9438 may serve for rejects or off spec product. Temperature control by injection of carbon dioxide can be adjusted to between about 29 to about 38° F., the pressure is held to less than about 40 psi, in the continuous blending equipment and vessels but the pressure is kept to less than about 10 psi elsewhere throughout the equipment. Continuous blending equipment 9420 can be horizontally disposed and elevated to provide for a gravity feeding arrangement alternately and to either of vessels 9432, 9434, 9436 and 9440. A quantity of any specified blend of fat and lean grinds, sufficient to fill a vessel is produced followed by a quantity of another specified blend of fat and lean grinds, sufficient to fill a second vessel. Vessels can be supplied by the Weiler and Company. Blended grinds are transferred from each vessel by suitable conveying and transfer equipment such as positive displacement pumps to meat portioners 9422, 9424, 9426, and 9428, where the meat is extruded and sliced into desired portions by size or weight. Feeding may be continuous or in batches as required. The packaging section of the plant includes a conveyor system 9446, 9448, 9450, and 9452 for moving unfinished webs through stations, where webs are finished into trays and loaded with goods, such as portioned meats. After the goods have been loaded into trays, the trays are sealed by a second web, such as may be provided with the Hayssen model RT1800, 9442 and 9444, with the modifications described herein above. Further packaging may include loading into master containers, depending on the circumstances and palletizing, according to a buyer's specifications. The processing of the ground meat is conducted in a controlled or modified atmosphere having little to no exposure to oxygen. Suitable gases are described in the specification. The equipment is preferably automated and controlled by a computer 9460, such as equipment supplied by the Wenger Co. The computer can be connected to one or more buyer computers via a communication system, such as the internet, for automatically receiving and filling orders from buyers, such as supermarkets.

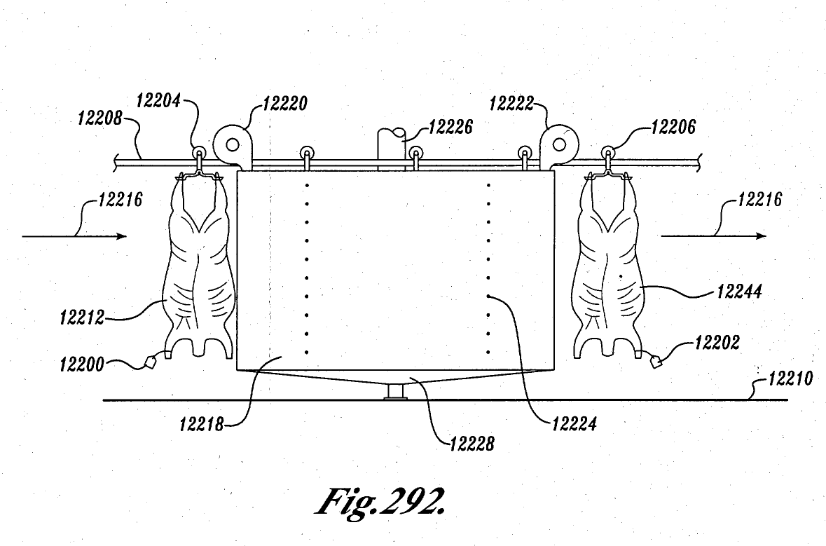

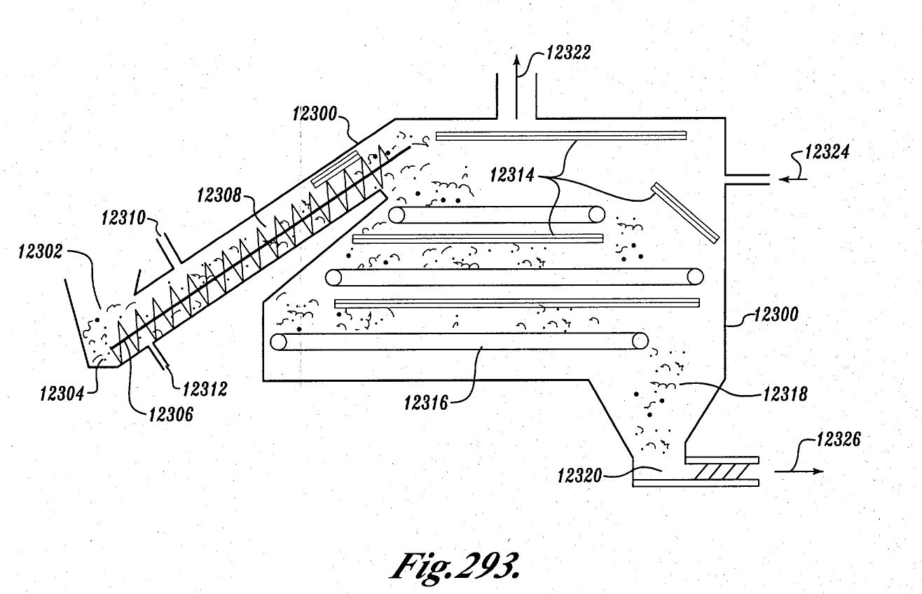

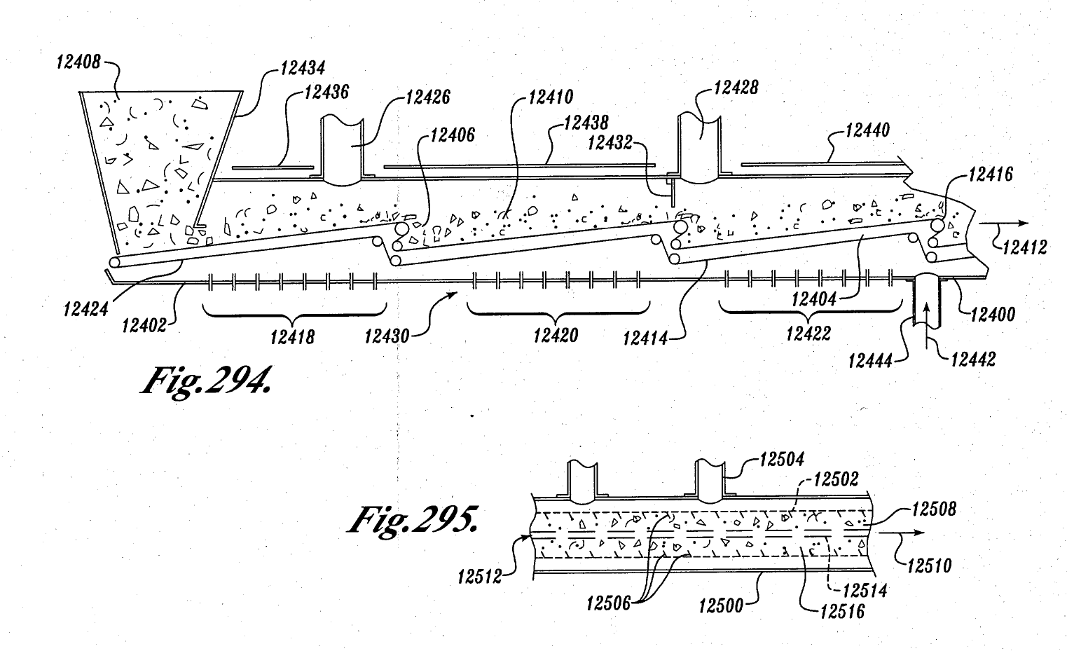

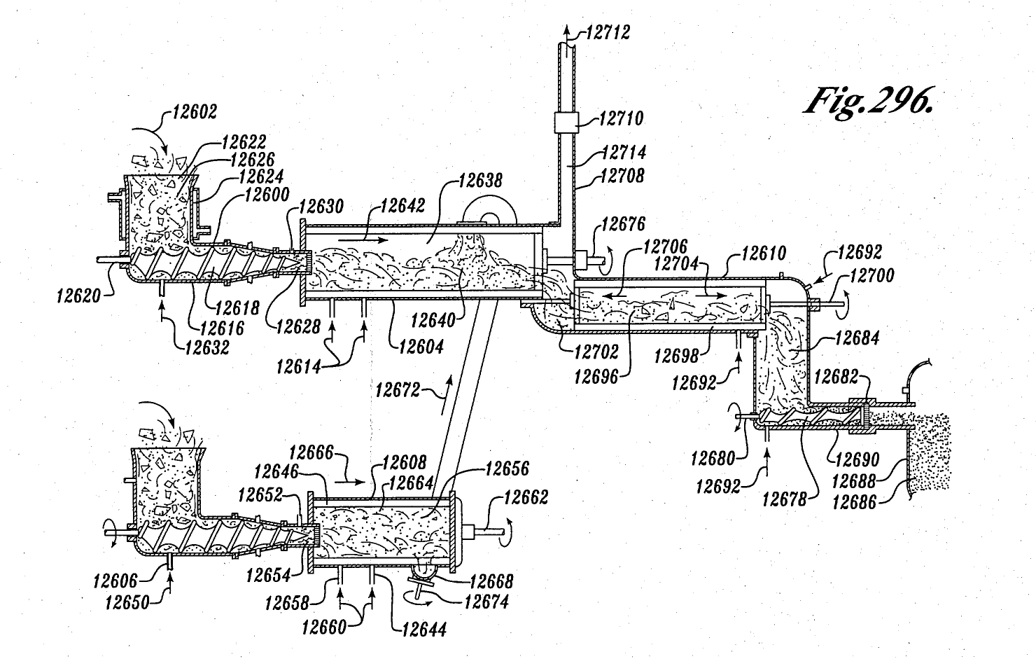

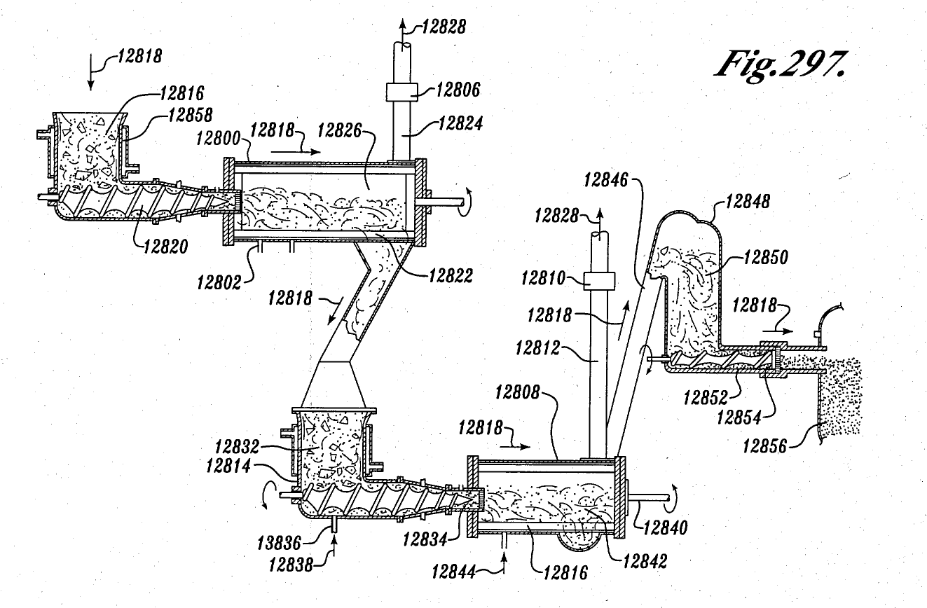

Referring now to FIG. 292, a schematic representation of a packaging area of a meat processing plant is illustrated. The packaging area can include one or a plurality of processing trains. In one embodiment, the packaging area 292 includes three sources of webs 9502, 9504, and 9506 for processing the unfinished webs. A web treatment train includes magazines 9508, 9510, and 9512 containing the webs, gas treatment and sterilizing equipment, and bonding equipment to produce the finished trays from the unfinished pre-form webs. Under some circumstances, bonding equipment may not be necessary for non-bonded trays which can be produced by using pre-form webs not requiring bonding. There can be one or a plurality of unfinished web streams, which can produce finished webs of differing sizes as required. The equipment in this area can be supplied by PMI Cartoning Inc. of Elk Grove Village, Ill., with adhesives supplied by National Starch and Chemical (a division of the ICI Group) of Bridgewater, N.J. The tray treatment section is linked to conveyor and transfer equipment which moves individual finished trays along a conveyor, while meat grinding, portioning and loading apparatus, 9514, 9516 and 9518 processes the meat stored in vessels 9520, 9522, and 9524 which is then loaded as goods into the finished trays. The trays can then be weighed and labeled with a bar code containing relevant information. The weighing and labeling equipment can be supplied by the Herbert Industrial of Haverhill, Suffolk, UK. The trays with goods are then sealed with a second web. The finished packages continue to travel on conveyors where the packages can be directed to a stacking apparatus 9528, such as drop loaders, supplied by PMI Cartoning, Inc. At the stacking apparatus, further equipment can produce thermoformed cartons. Thermoforming equipment 9530 can be supplied by Cott Technologies Inc. of La Puente, Calif. The finished packages can then be loaded and stacked into the newly thermoformed cartons. The auto carton equipment can be supplied by PMI Cartoning, Inc. The cartons are then palletized in palletizing equipment 9534 and made ready for shipment to a buyer's designated delivery destination. For the majority of the meat processing, the meat is excluded from substantial contact with oxygen to minimize oxidation. Therefore desirable concentrations of gases are continually being used to pad processing equipment. This equipment can be supplied by the BOC Gases company. Other equipment is developed to remove undesirable gases by using vacuum equipment. Vacuum equipment can be supplied by the Kinney Co of New York or the Reitschle vacuum pump manufacturing company of Germany. Conveyor and or transfer equipment can be supplied by PMI Cartoning, Inc. While three differing webs for trays may be provided at the loading station, each master container is provided with a manner of identifying an allocated destination. The master containers are palletized to ship where they are needed by the buyer or alternatively may be placed in storage. The computer controller is provided with a set of instructions to manage, in cooperation with the input provided for by an operator interface, the processing and packaging of the meat goods.

Referring now to FIG. 293, a schematic illustration of web treatment and welding equipment is shown. In one embodiment, the equipment includes tray loading magazines 9602 and gas exchange magazines and chambers 9604. A nitrogen gas generator 9612 is provided to pad the equipment, providing an inert environment to substantially exclude oxygen. The nitrogen generating equipment can be supplied by the BOC company. The trays travel on a delivery conveyor to an adhesive applicator and bonding equipment 9606, where the trays are formed from webs and then bonded to produce the finished trays. The adhesive applicator and bonding equipment can be supplied by National Search and Chemical. Under some circumstances, the trays can be formed without bonding, such as from the pre-form web with tabs on the foldable flaps. The finished webs are then delivered where needed on the meat processing train where need by a delivery conveyor 9608. The section of the plant for finishing trays is controlled by controller computer 9610. The computer 9610 can be integrated with other sections of the plant to provide for just in time delivery of finished webs.

The present invention provides an efficient method of processing fresh red meat products at the point of animal slaughter for subsequent case ready packaging and delivery to the consumer via a typical supermarket or retail sale outlet. The consumer may be located thousands of miles away from the point of slaughter which often results in distribution and delivery that can require a period of time exceeding 20 days.

Perishable food products produced, in part or otherwise, in the manner described herein may be placed in any suitable tray with or without any suitable substance and over wrapped with any suitable web of material such as pPVC (or PE) and then placed in a master container that may be manufactured from a substantially gas barrier material or partial gas barrier material to provide finished packages. Following this, finished packages may be stored in any suitable storage room maintained at any suitable temperature until required for sale, at which time finished may be removed, labeled and displayed for sale in a retail outlet such as a supermarket.

Referring now to FIG. 296, a schematic illustration of an embodiment of a plant layout according to the present invention comprising an automated system of pre-treating packaging components and perishable goods such as ground meats is shown. The arrangement as shown includes four production lines for the portioning, loading, over-wrapping and assembly of barrier master container packages. Four empty tray conveyors are shown as 9800. Trays are transferred along conveyors 9800 to transverse conveyors 9802, 9804, 9806, and 9808. A continuous mixer 9810 is arranged to deposit selected ground beef into any one of four silos 9812, 9814, 9816, and 9818. Each of silos 9812, 9814, 9816, and 9818 is arranged with a positive displacement pump attached thereto such that ground meat can be pumped via conduits (not shown) from silo 9812 to fine grinder 9820, from silo 9814 to fine grinder 9822, from silo 9816 to fine grinder 9824, and from silo 9818 to fine grinder 9816. A dump silo 9828 is provided such that any quantities of material that are determined to be unsuitable for packaging can be transferred therein. Fine grinders 9820, 9822, 9824, and 9826 are attached respectively to portioning equipment 9830, 9832, 9834, and 9836. Empty trays transferred along conveyors 9800 are loaded with ground meat portions from portioner 9830 at conveyor 9802, from portioner 9832 at conveyor 9804, from portioner 9834 at conveyor 9806, and from portioner 9826 at conveyor 9808. Conveyors 9838 transfer loaded trays from each loading conveyor 9802, 9804, 9806, and 9808 to weighing scales 9840, 9842, 9844 and 9846, respectively. Labels with weight and product information as required, are applied to the bottom of loaded trays, by bottom label applicators 9848, 9850, 9852, and 9854, respectively. Loaded trays are then over wrapped by flow packers 9856, 9858, 9858, and 9860, respectively. Automatic stackers 9862, 9864, 9866, and 9868 stack selected groups of loaded over wrapped trays which are then transferred and automatically loaded by automatic loaders 9876, 9878, 9880, and 9882, into gas barrier containers formed in line on horizontal thermoforming machine 9870. Conveyors transfer trays from the flow packers to the automatic stackers. An automatic carton erection apparatus 9872 is arranged to enclose each barrier master container in a carton, which is then transferred to an exit conveyor 9874. A central control panel 9884 is located conveniently to allow control of the complete system. Continuous mixer 9810 and silos 9812, 9814, 9816, and 9818 may be located in an adjacent room separated by an insulated wall such that the contents of the silos can be maintained at a selected temperature which maybe 34 degrees F.

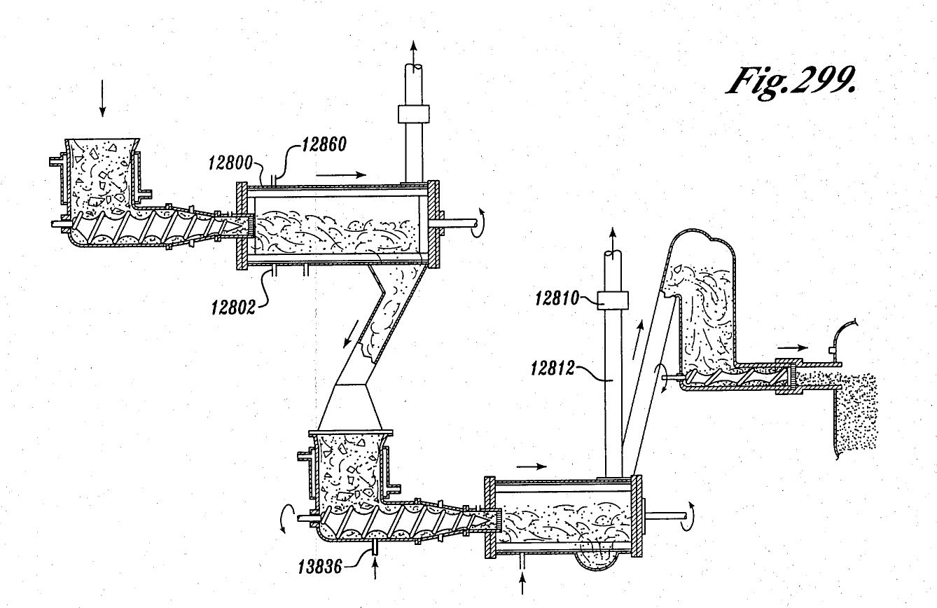

Referring now to FIG. 297, a schematic, cross sectional illustration of a section of the plant layout according to the present invention is shown in FIG. 299. The plant is located on a factory floor, 5000, and at a convenient elevation from the floor, in an enclosed, suitably ventilated room that is temperature controlled at about 38 degrees F. A generally horizontally disposed conduit is defined by an outer, substantially gas tight, enclosure 3001. Packaging components such as tray performs 3021 and web materials 3011, and ground meat 3027 are transferred into the conduit 3001 in such a manner so as to substantially exclude the entry of atmospheric oxygen and a gas 3032 is provided in any space inside conduit 3001 that is not occupied by equipment or goods. Gas 3032 is selected and may comprise any suitable gas such as carbon dioxide or nitrogen and is maintained at a pressure above ambient atmospheric pressure. A conveyor 3024 is conveniently mounted within conduit 3001 and arranged to carry trays 3020 there through. Tray pre-forms 3021 are stacked into profiled and vertically disposed magazines 3023 and 3099. Magazines 3023 and 3099 are arranged to have an outer wall that closely, but not touchingly, follows the outer profile of the stacks of pre-form trays 3021, contained therein. De-nesting mechanisms (not shown) are arranged to remove a single perform from the bottom of a stack such as contained in magazine 3023 and position it onto conveyor 3024. In this way, gas contained within conduit 3001 can then fill the cavity in tray perform and thereby substantially preventing any atmospheric oxygen or other undesirable gases from entering into the tray cavity. Tray pre-forms 3021 are then carried in the direction shown by arrow 3031 to a position below the folding and bonding arrangement not shown but housed within enclosure 3017. During the folding and bonding of pre-form 3021 to form tray 3020 gas 3032 fills all cavities or interstitial voids contained in the tray and in this way it is ensured that only a selected and suitable gas is contained therein. Finished empty trays 3020 are then placed by 3017 onto conveyor 3024 and carried forward to be loaded with portions of ground meat 3027. A stream of selected ground meat is transferred through conduit 3100 at a convenient velocity and into fine grinder 3028 and in such a manner so as to extrude a continuous and suitably cross sectional profiled stream of ground meat 3101 onto conveyor 3024. Extruded stream 3101 is extruded into conduit 3001 and onto conveyor 3024, mounted therein, at a suitable velocity so that guillotine 3026 can cut portions of substantially similarly sized ground meat sections there from. Portions of ground meat 3027 are then transferred into trays 3020 which are there together transferred through conduit 3001 on conveyor 3024. Conveyor 3024 can be arranged with upwardly disposed “cleats” 3080 or a series of suitable enclosures to ensure that when ground meat portions 3027 are loaded into trays 3020 the tray is positioned precisely beneath the respective ground meat portion, allowing accurate loading into tray 3020 to produce a loaded tray with goods 3030. Loaded trays with goods 3030 are then transferred through conduit 3001 toward over wrapping equipment arranged to over wrap trays 3030. A roll of suitable over wrapping web material 3010 is conveniently mounted above conduit 3001 and is unwound by transferring a single web of material 3011 through a slot like conduit 3012. Gas contained in conduit 3001 at an elevate pressure can pass over the surfaces of web 3011 while it passes through slot like conduit 3012 and in this way ensure that substantially no atmospheric oxygen is allowed to enter conduit 3012 or conduit 3001. Over wrapped and hermetically sealed trays 3102 are transferred along conduit 3001 toward robot stacking arrangement 3014. Robot 3014 is enclosed in a housing that forms a part of conduit 3001 and is programmed to stack trays 3102 into groups 3015 that are then loaded into gas barrier containers 3013. Gas barrier containers 3013 can be formed in line and flushed with a suitable gas prior to loading of stacks 3015 therein. Horizontal thermoforming machine 3016 is conveniently located below robot 3014 and is arranged so that the thermoformed barrier containers 3013 are enclosed within an extension of conduit 3001 and thereby ensuring that gas 3032 is in contact therewith and filling cavities in barrier containers 3013.

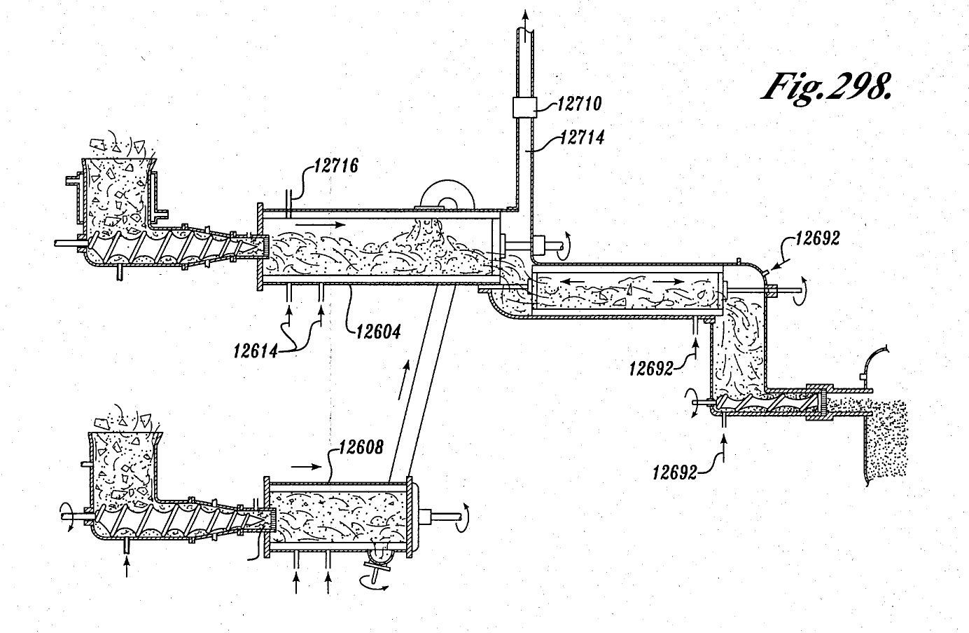

Referring now to FIG. 298 the tray de-nesting apparatus portion of FIG. 297, before the pre-form flaps have been bonded to the tray walls, is shown in a cross sectional view. Vertically disposed walls 3023 are arranged to closely conform to the outer edge perimeter of the stacked pre-forms 3021. A narrow gap is thereby maintained between the stack 3021 and magazine walls 3023 allowing the tray pre-forms to slide through the magazine without restriction, as the lowest tray performs are progressively removed and placed onto conveyor 3024. Gas 3032, from conduit 3001, is exhausted through the narrow gap at 3040 and additional selected gas such as 3032 can be injected through conduits 3022 at a suitable pressure so as to substantially fill spaces between the stacked pre-forms as they are gradually transferred through magazine 3023.

Referring now to FIG. 299, a schematic illustration of an embodiment of an specially arranged thermoforming apparatus is shown according to the present invention. The apparatus shown in FIG. 299 is intended to provide an alternative, preferred and economical method of delivering trays to conveyor 3024 as shown in FIG. 297. A wheel 3066 is mounted onto a shaft 3070. Wheel 3066 is arranged to have 8 flat sides, onto which tooling 3067 can be mounted. Wheel 3066 is attached directly to a sprocket (not shown), which engages with a pair of continuous gripper chains 3073. Other sprockets including idler sprockets 3075 and drive sprockets 3074 are mounted to maintain gripper chains 3073 follow a fixed and generally horizontally disposed track. A roll of interchangeable and thermoformable material 3064 is located between chains 3073 and is unwound in a continuous web of material 3063. As web 3063 is unwound from roll 3064 it is held by gripper chains 3073 at each side edge and withdrawn, at a suitable rate, from roll 3064 by the forward motion of chains 3073. Sprockets 3074 are attached to a suitable drive motor with controller that progressively carries web 3063 between heat banks 3062. Heat banks 3062 are mounted in close proximity above and below web 3063 and as gripper chain 3073 carries web 3063 there between is heated. The temperature of heat banks 3062 is controlled and maintained within a selected range so as to ensure that the temperature of web 3063 is at a thermoformable temperature as it passes from between heat banks 3062 and onto a face of wheel 3066. Rollers 3060 and 3061 are arranged to contact the upper and lower surfaces of web 3063 and apply a calendering pressure thereto. Rollers 3062 and 3061 are maintained at a temperature as required. Eight sets of tools 3067 are mounted to wheel 3066. Each tool 3067 comprises a four-sided tray cavity forming depression with a flat forming depression adjacent to each side, such that a pre-form with four flaps can be formed therein. Clamping fixtures with plugs or matching molds 3065 are arranged to conveniently be incorporated as required while the pre-form being formed in matching tools 3067. Forming tool 3067 can be arranged such that the flap forming sections of the tool can be hinged so as to fold the flaps after cutting from web 3063, and become bonded to walls of the tray cavity prior to ejection. In this way, a pre-form tray can be thermoformed, cut from the web 3063, folded and bonded, and ejected by tools on wheel 3066. A finished tray 3020 is then ejected and allowed to fall in the direction as shown by arrow 3068, onto conveyor 3024. Enclosure 3001 is arranged to completely enclose the wheel assembly 3066, clamping arrangements 3065 and conveyor 3024, and in such a manner to ensure that all cavities between walls and flaps of tray 3020 are filled with selected gas 3032. Web 3063 may comprise a solid extruded sheet of plastics material, extruded from any suitable polymer, with an additive contained therein that will generate a suitable gas such as carbon dioxide when heated to a thermoformable temperature. Web material 3063 may comprise a polypropylene polymer with any suitable additive such as a filler additive containing calcium bicarbonate that will release carbon dioxide gas when heated, within the extruded polymer sheet, to a thermoformable temperature. In this way, an expanded polypropylene sheet (EPP) of material can be formed immediately prior to use, and ensuring that carbon dioxide gas fills the interstitial spaces within the web material from which trays 3020 are formed.

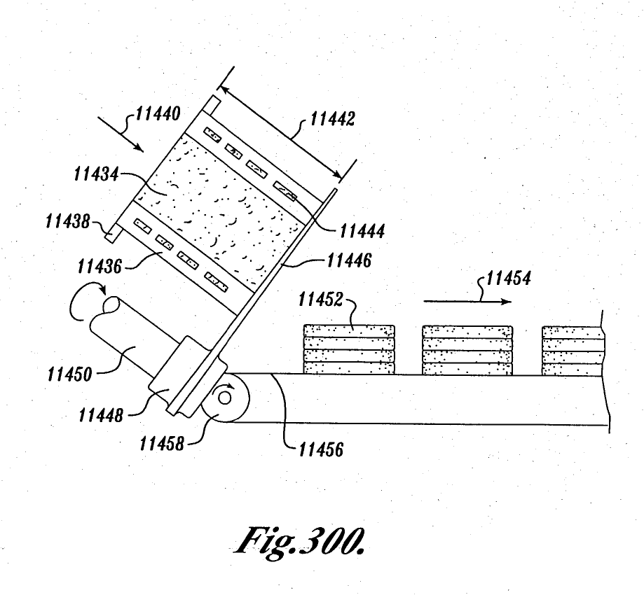

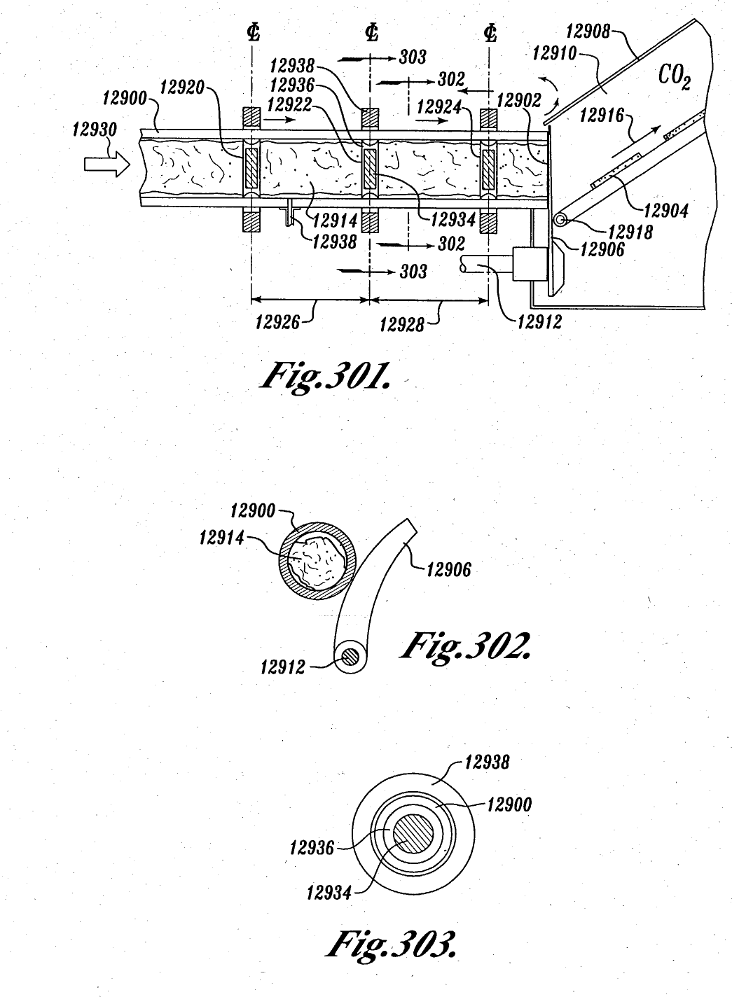

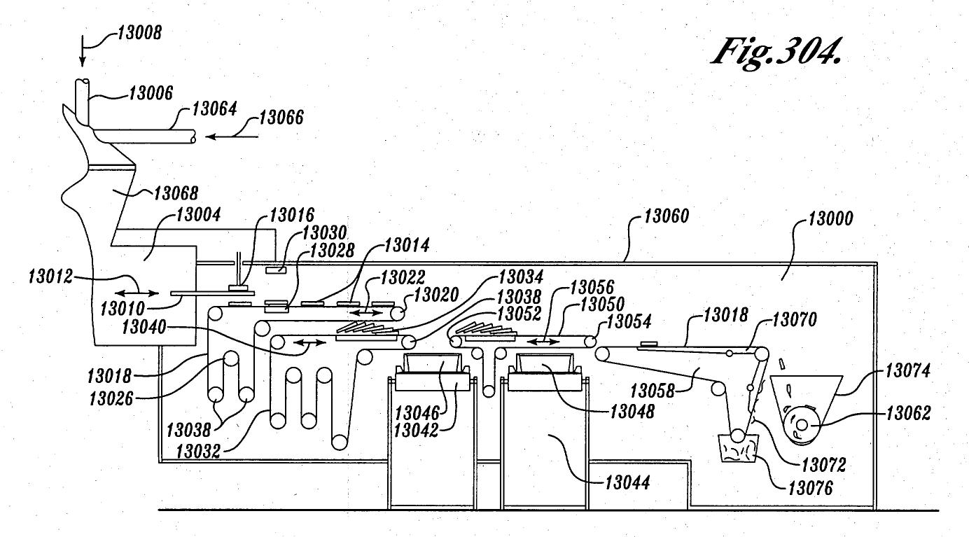

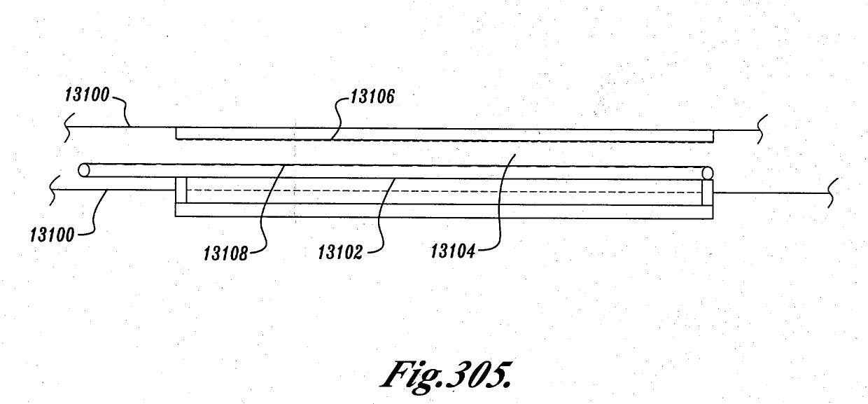

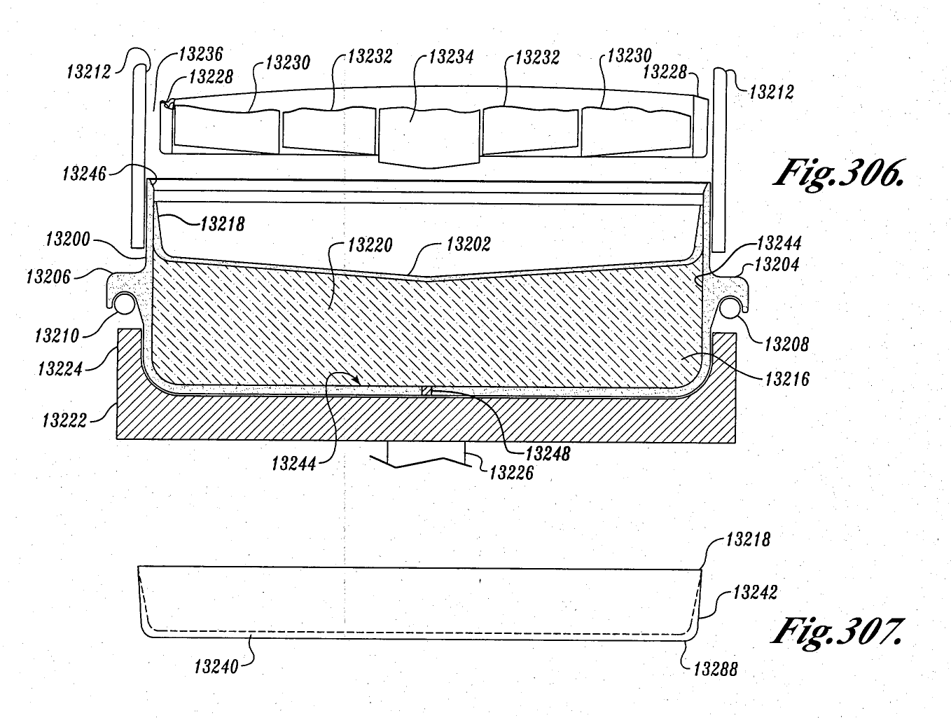

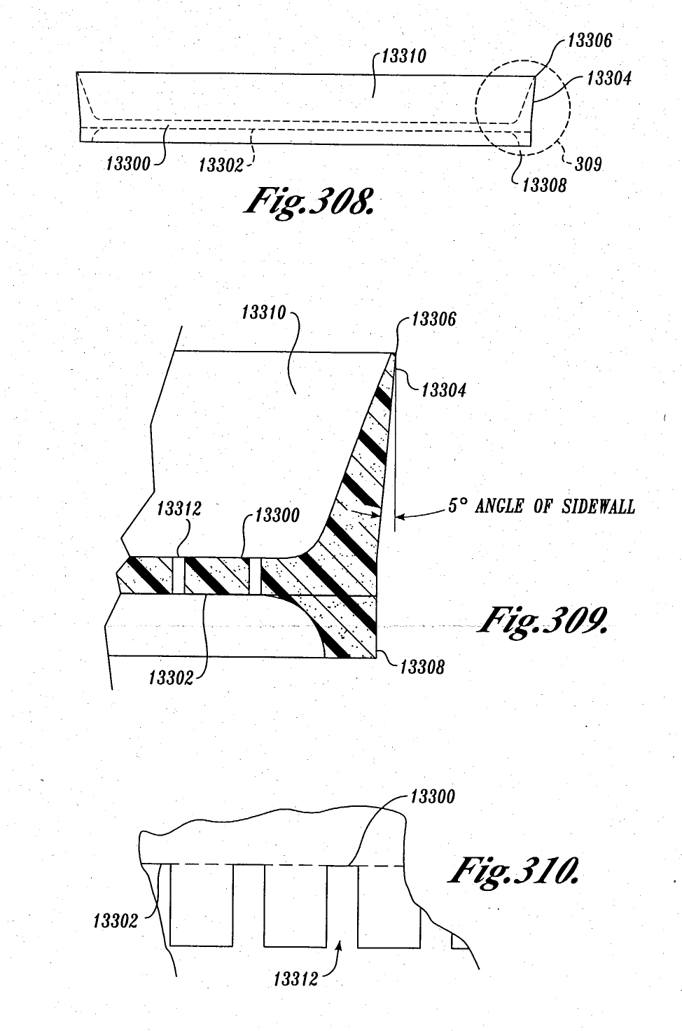

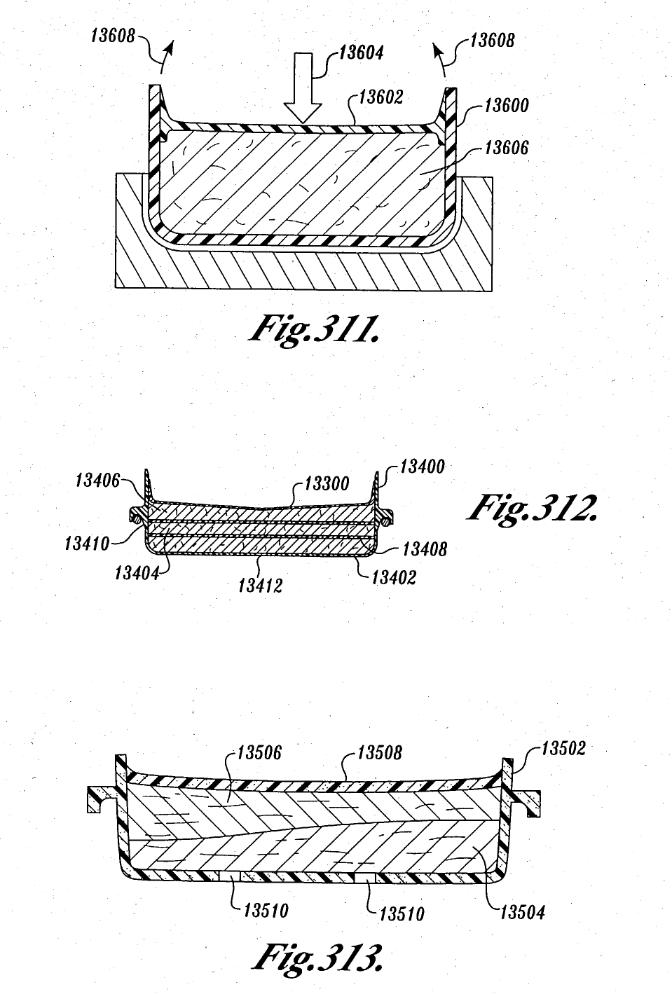

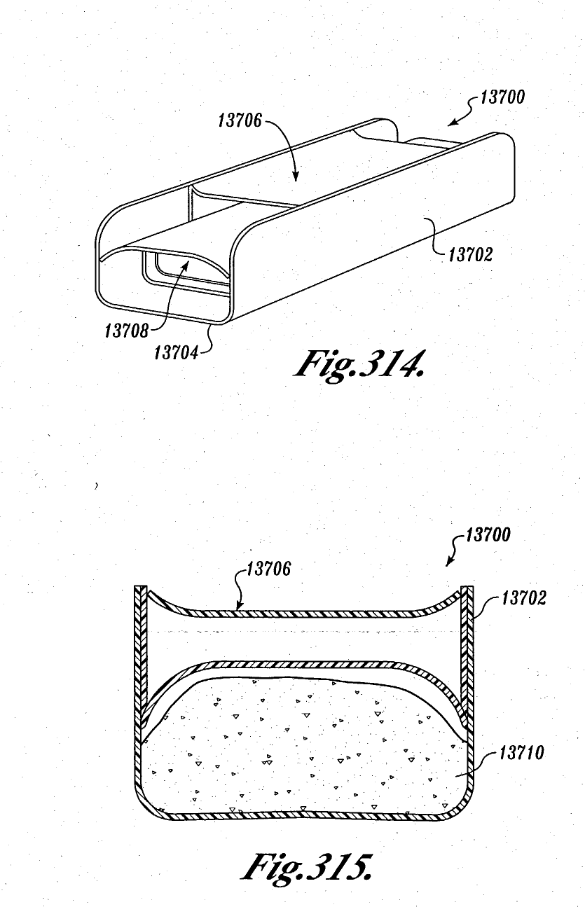

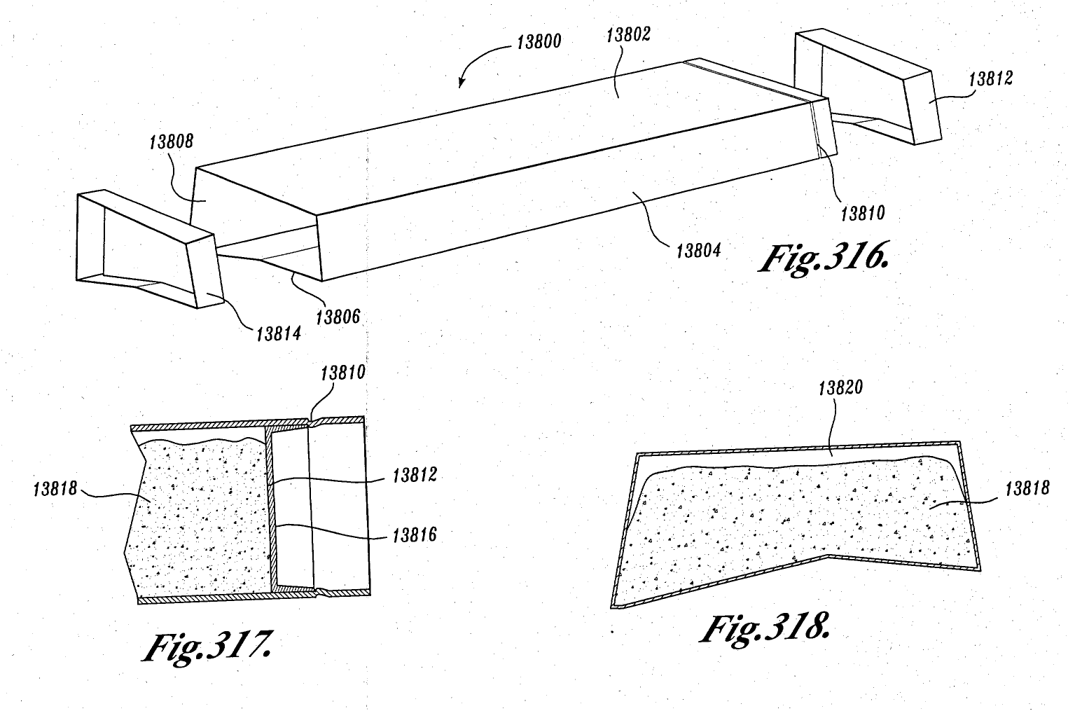

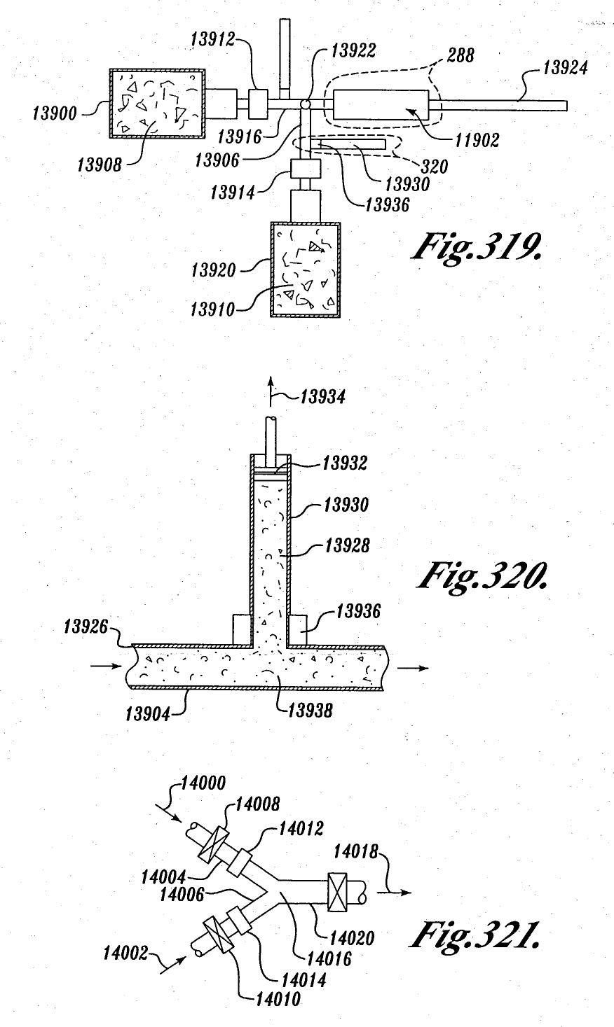

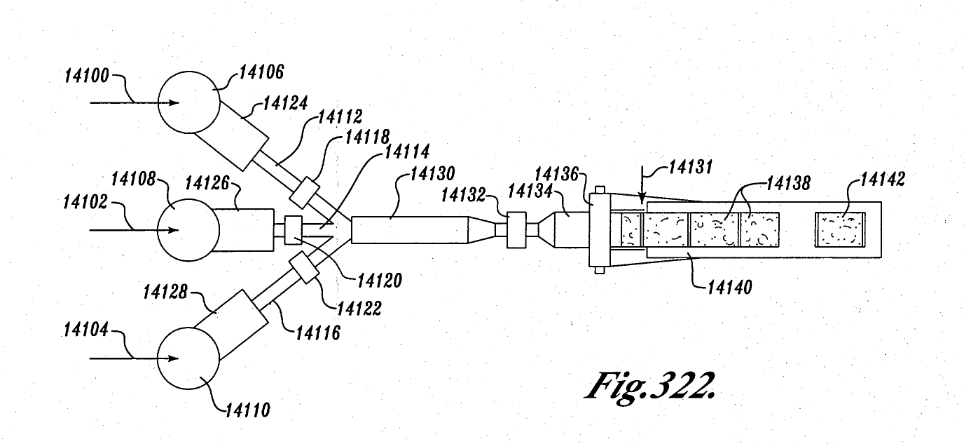

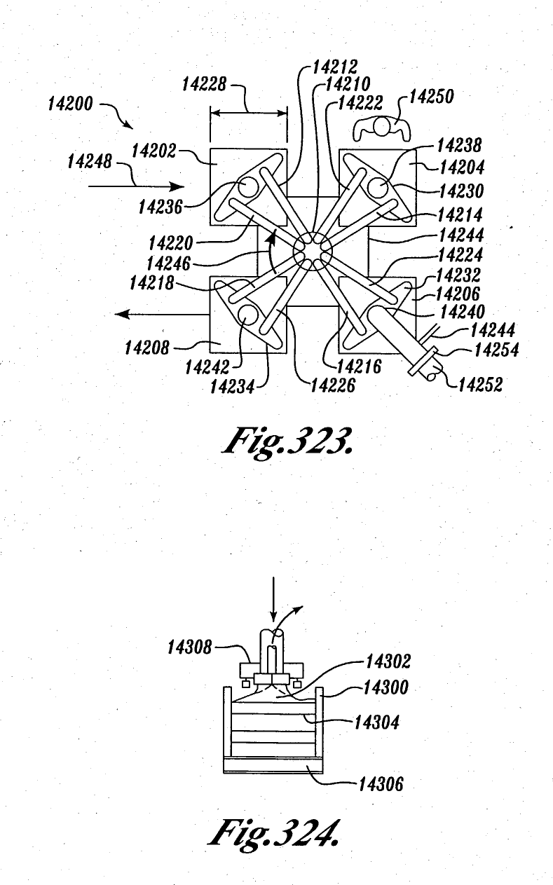

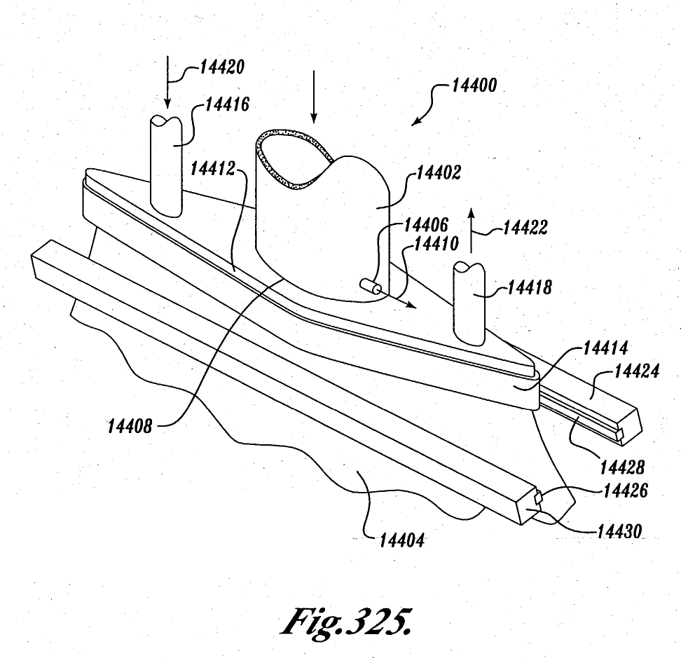

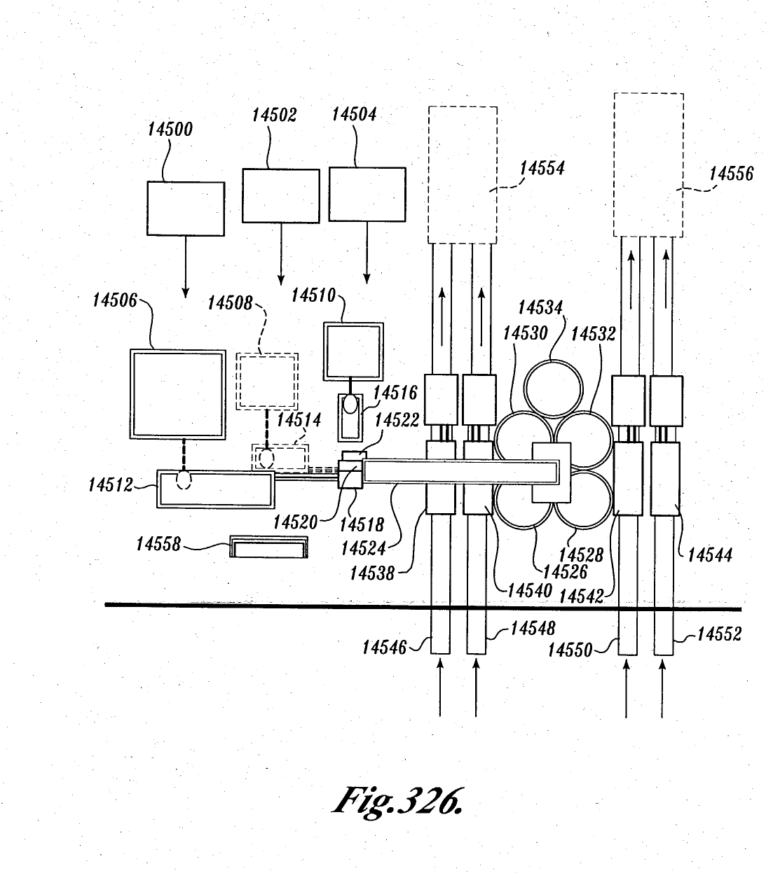

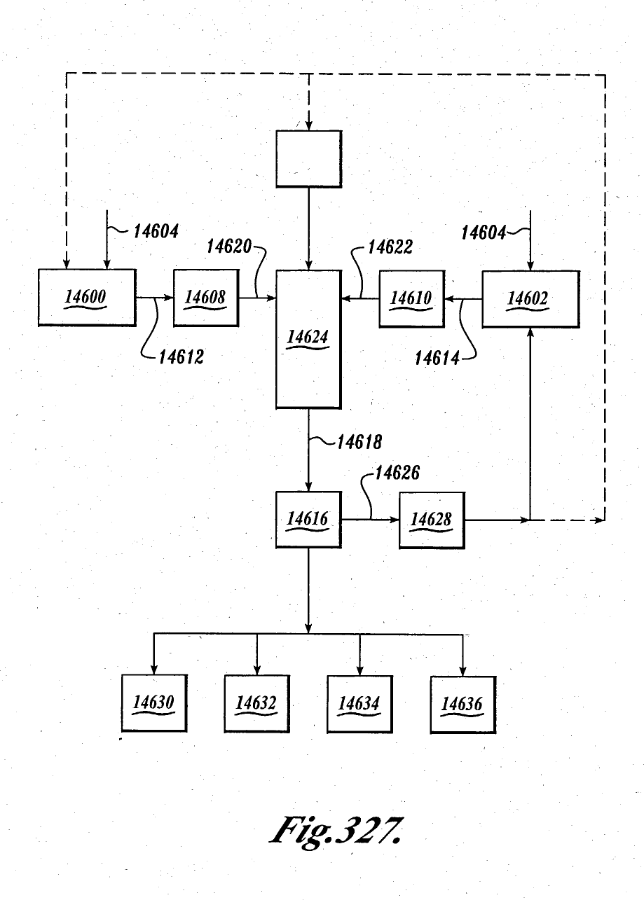

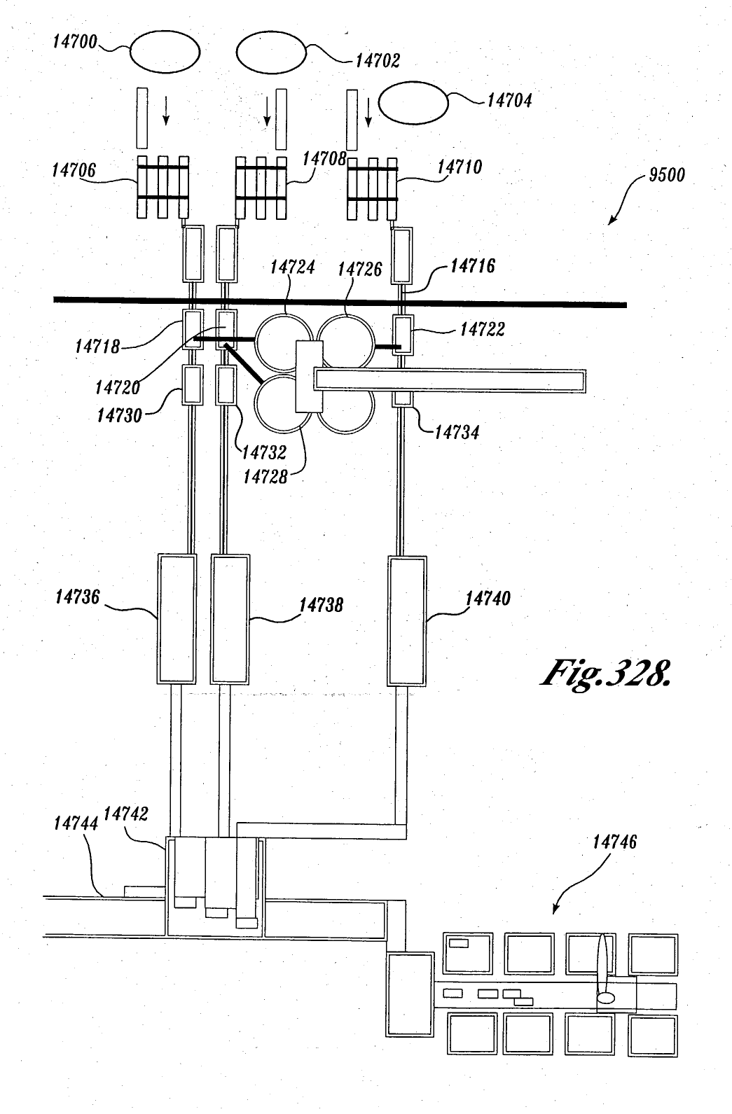

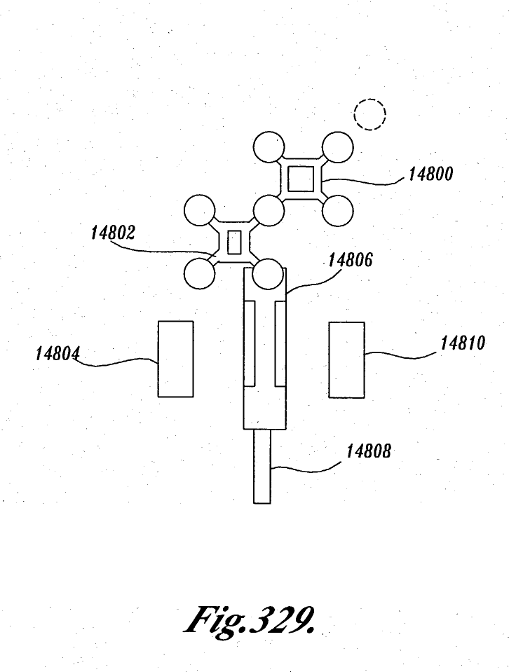

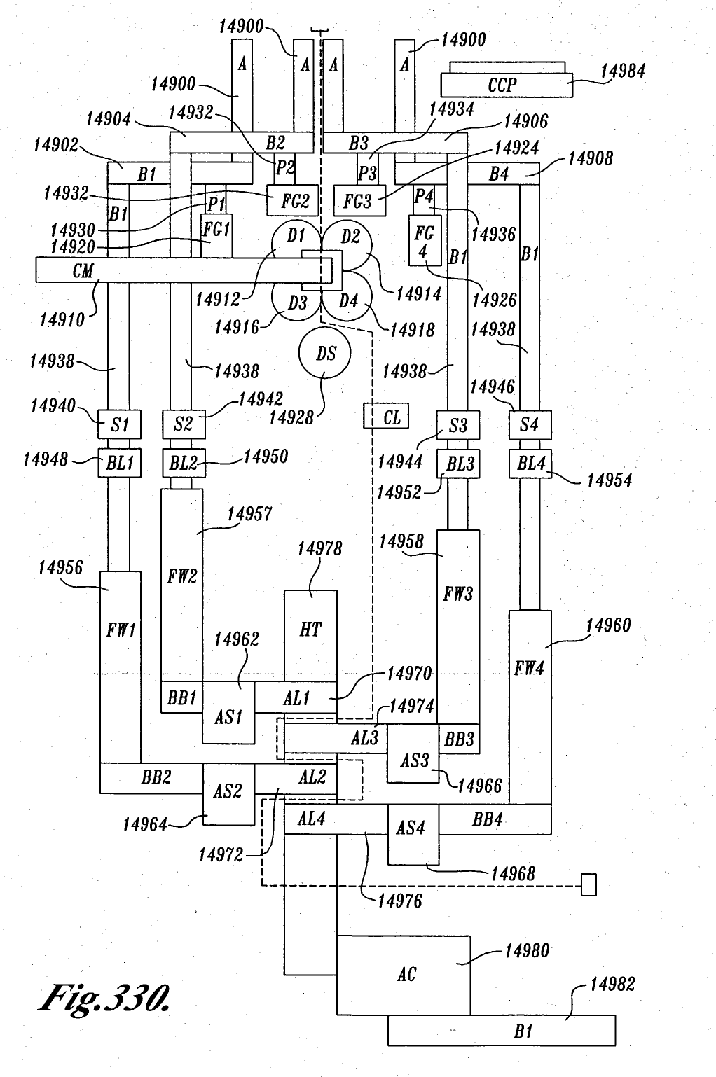

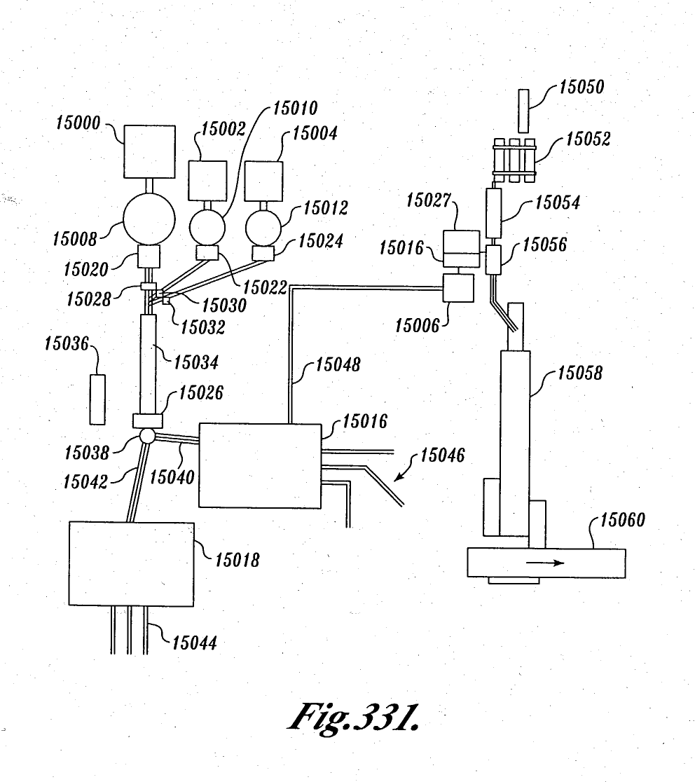

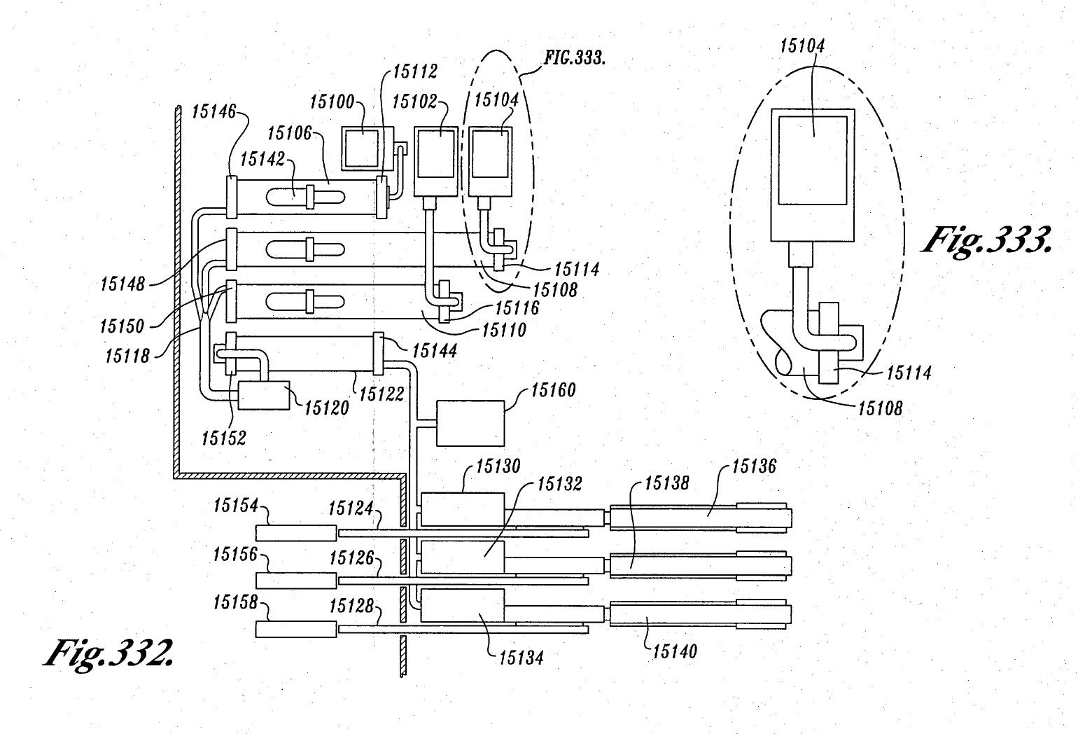

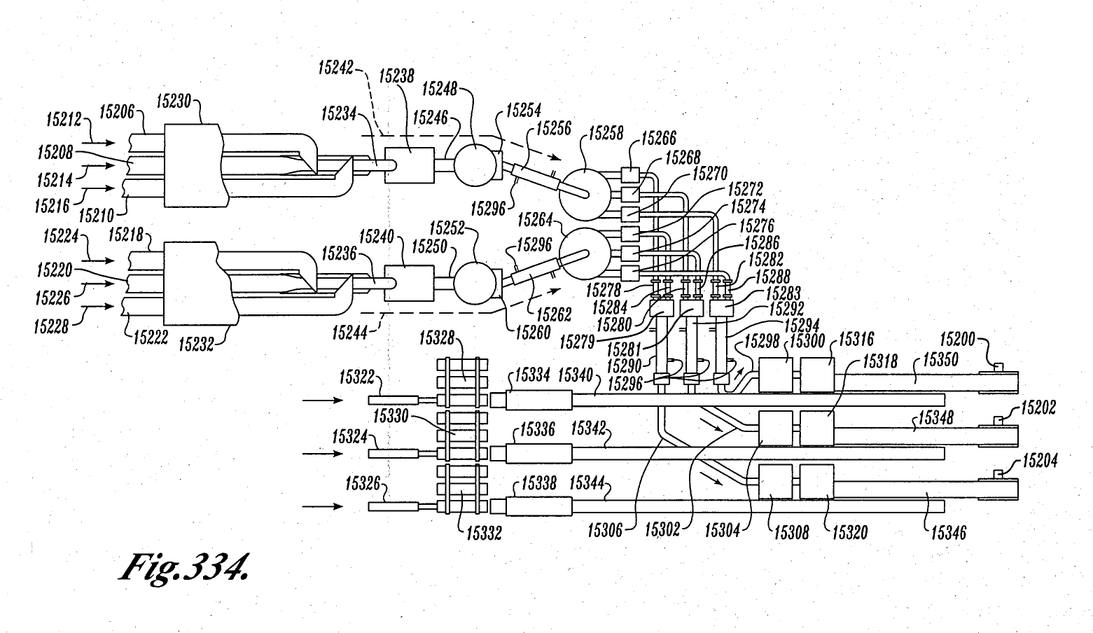

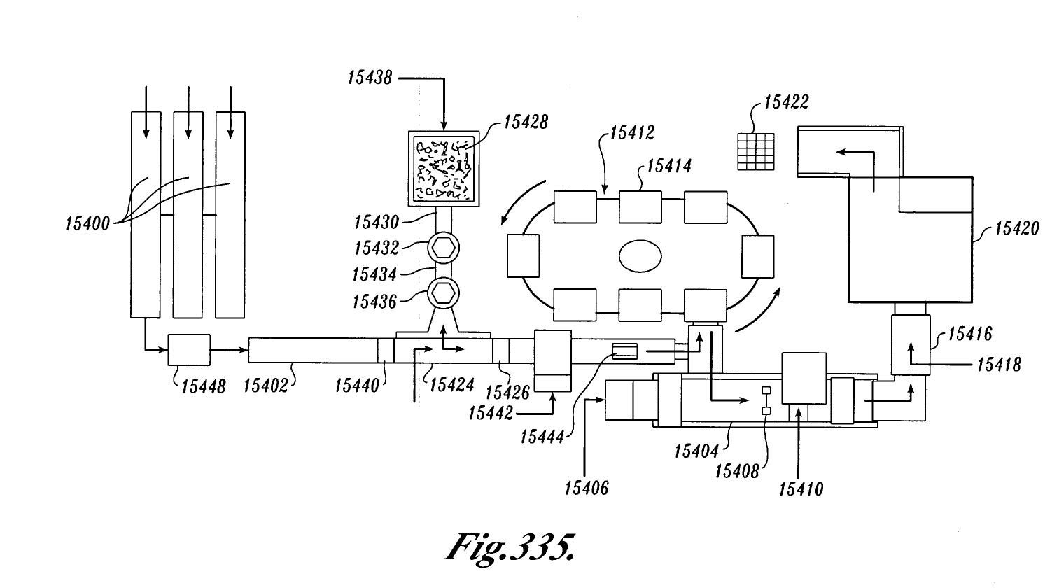

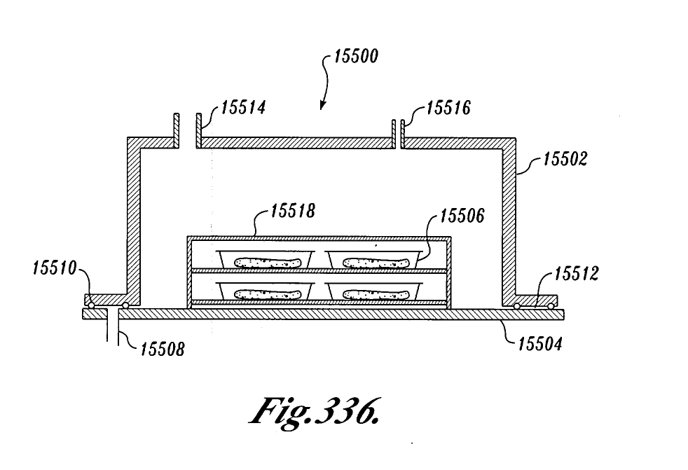

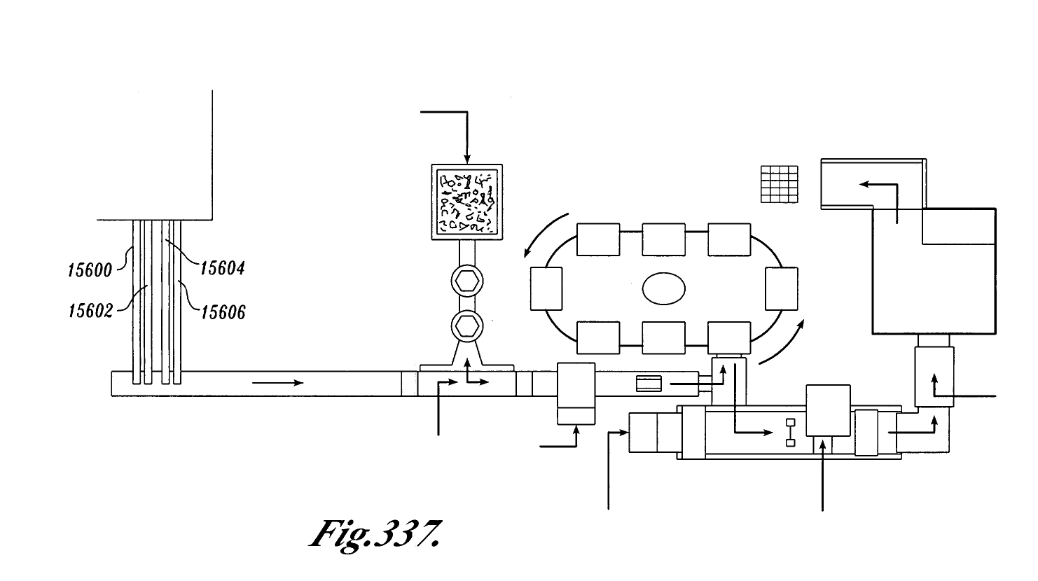

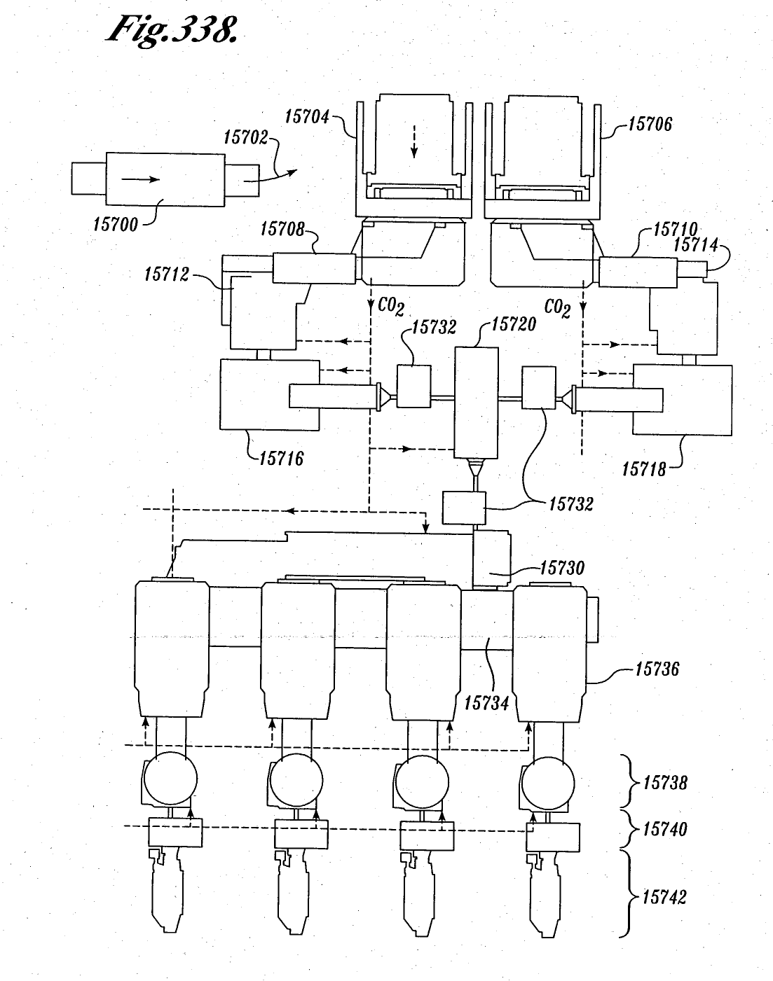

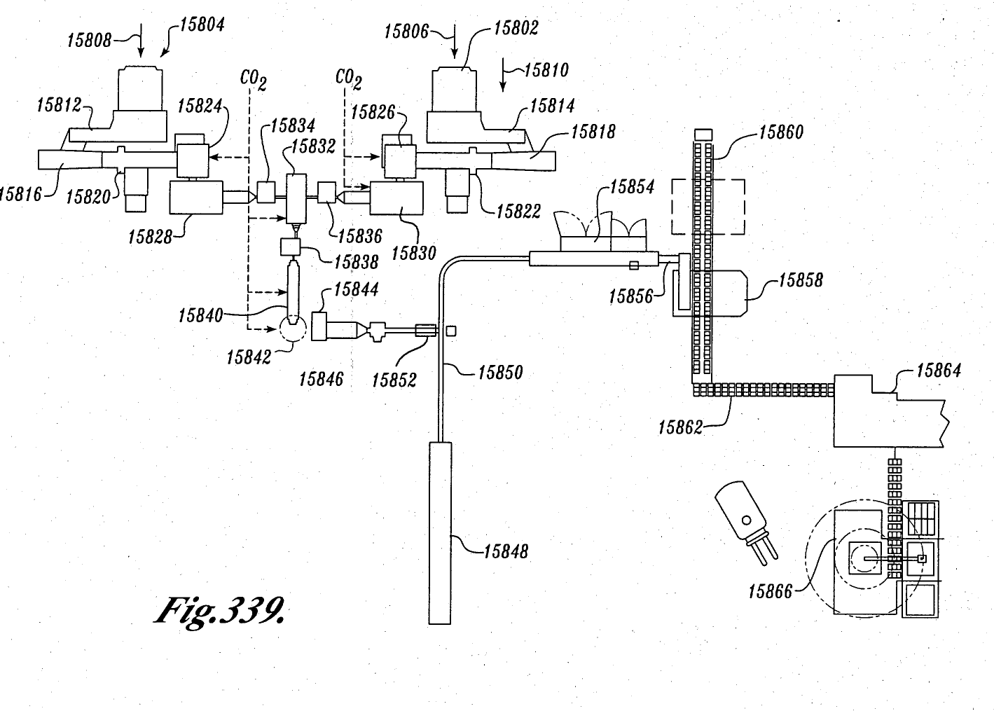

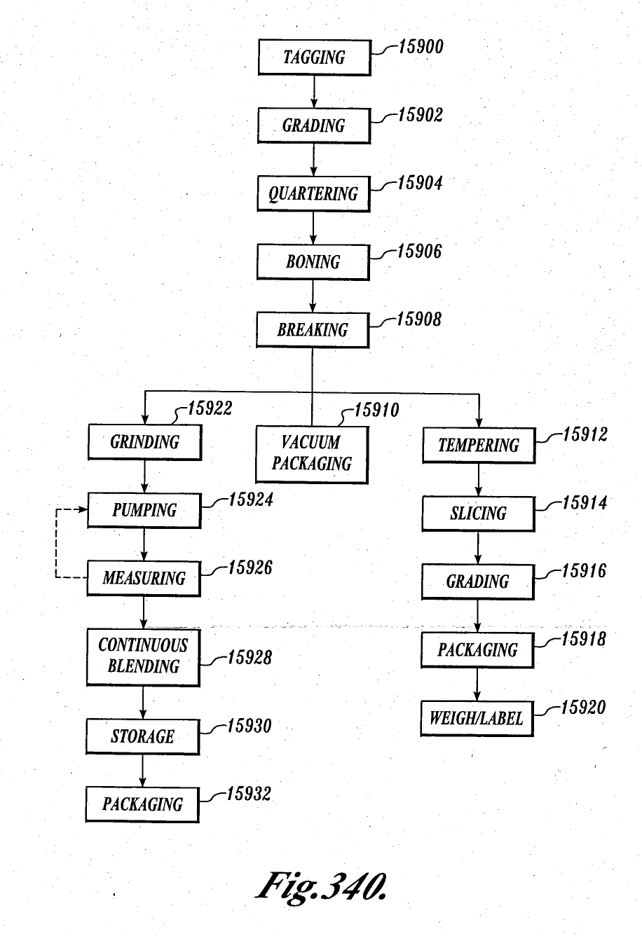

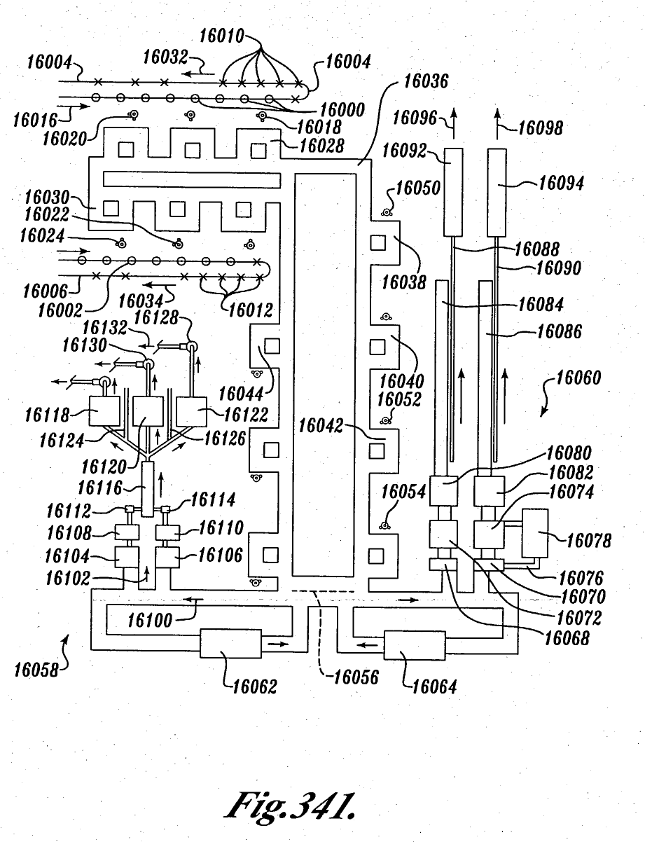

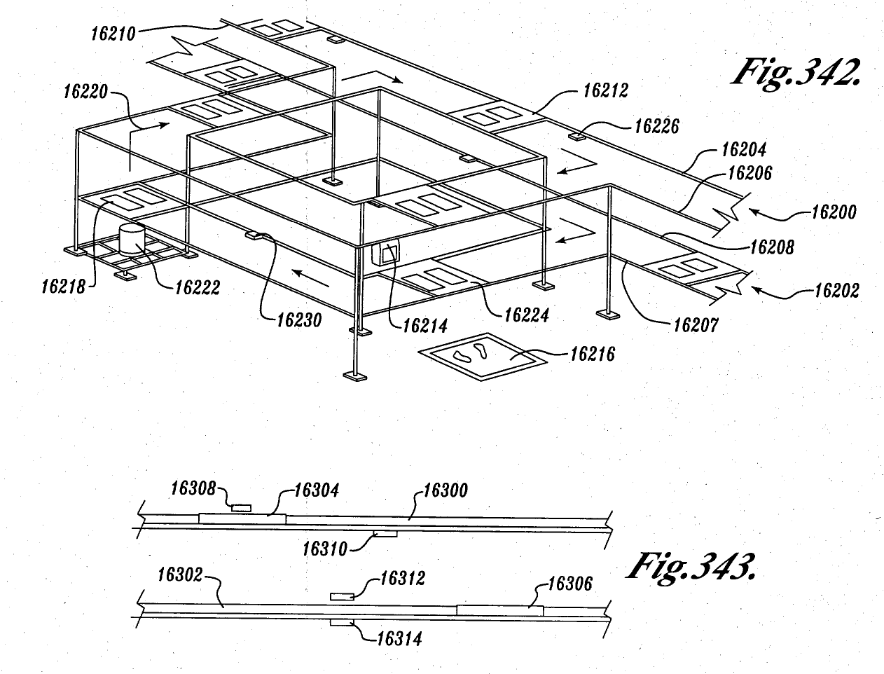

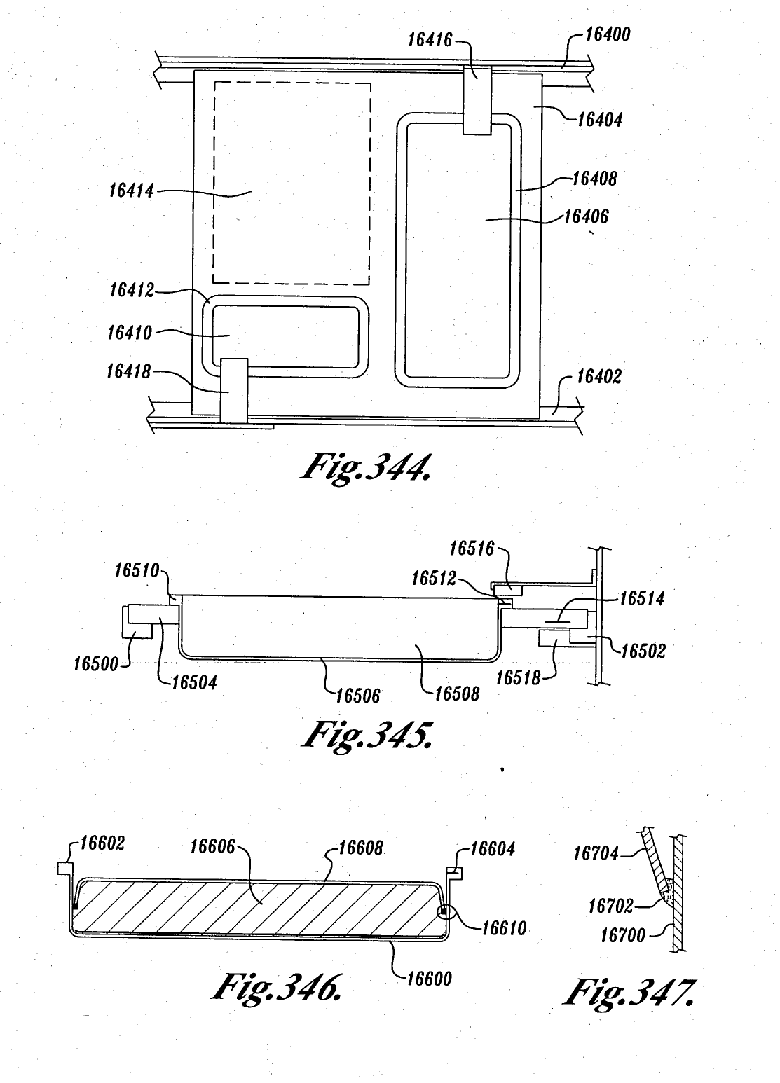

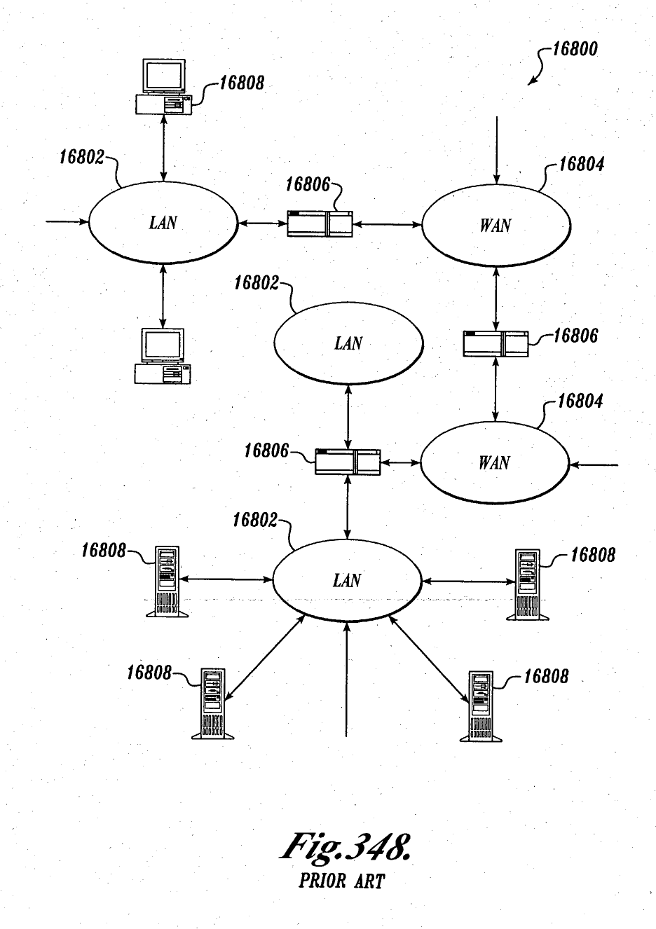

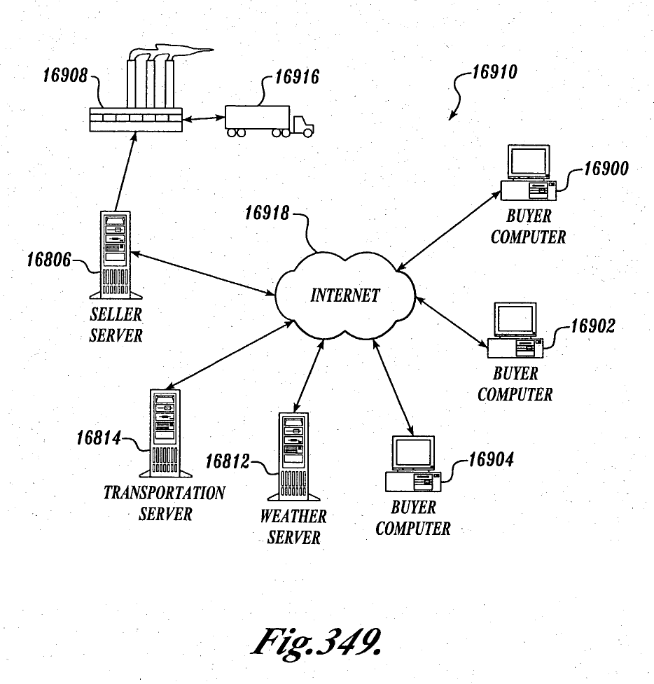

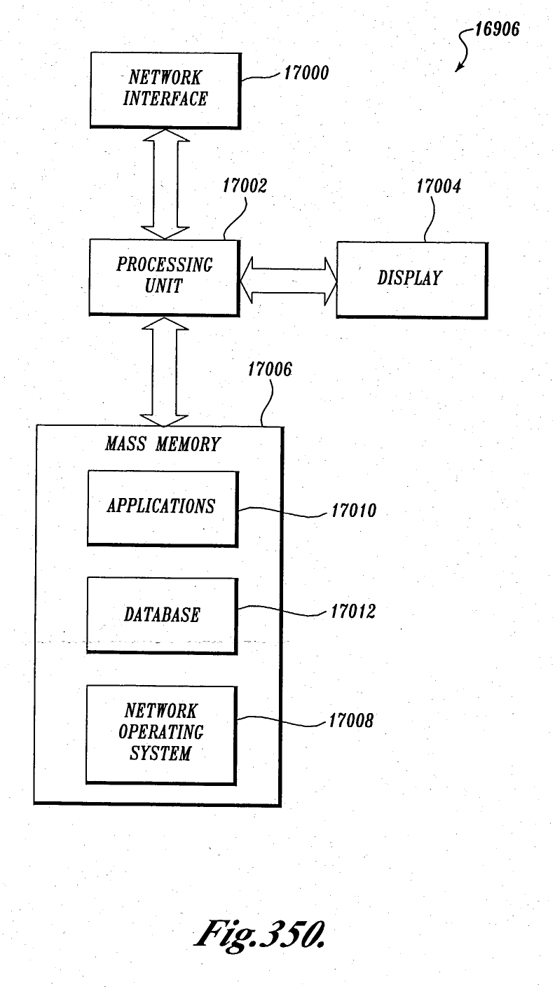

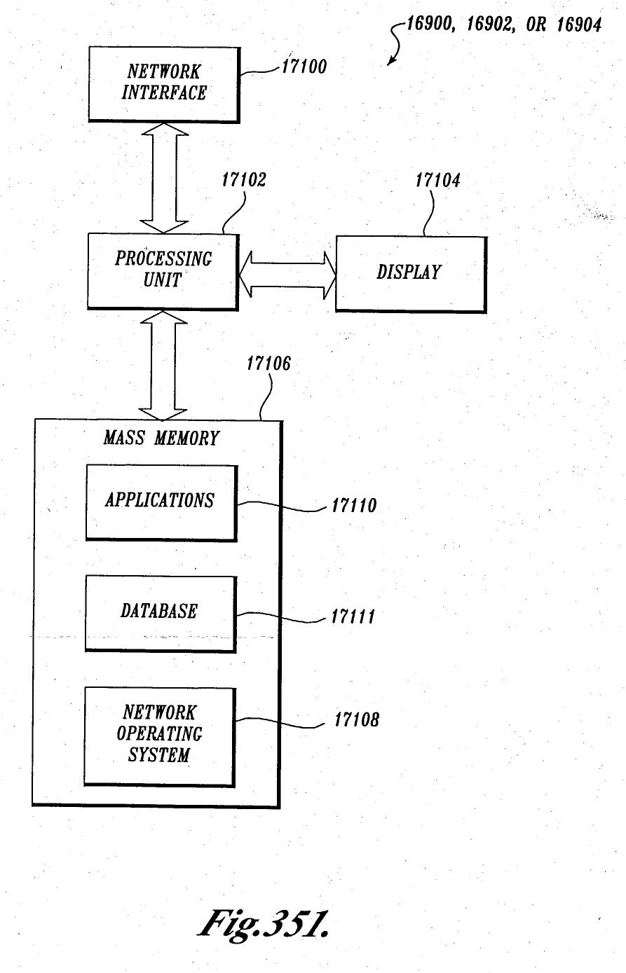

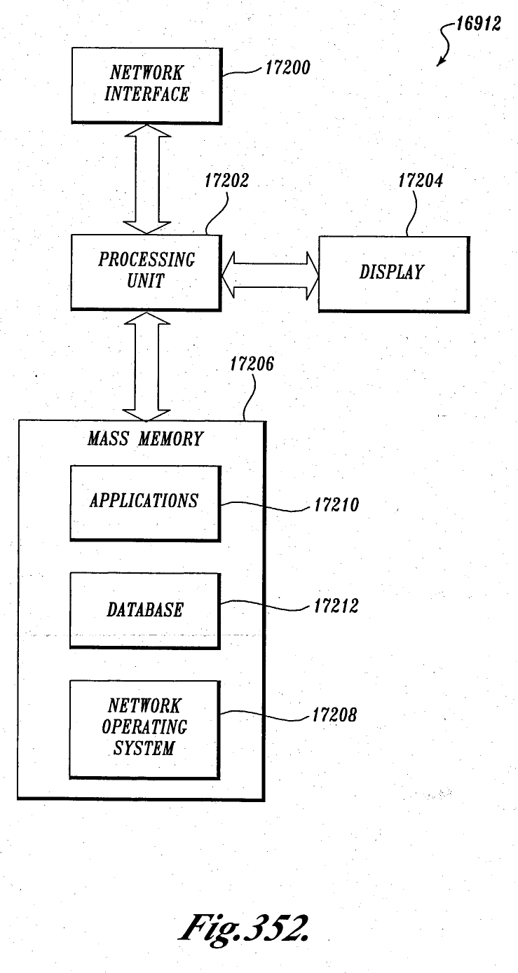

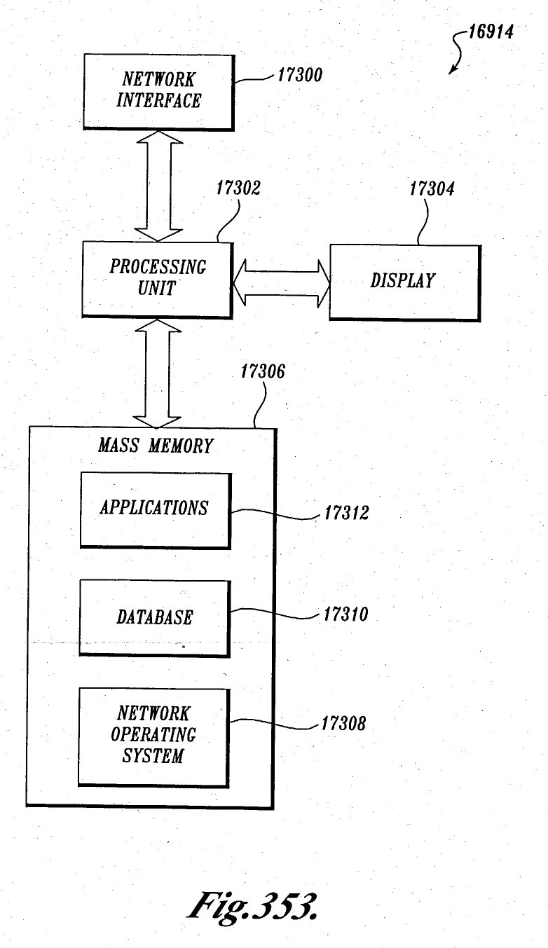

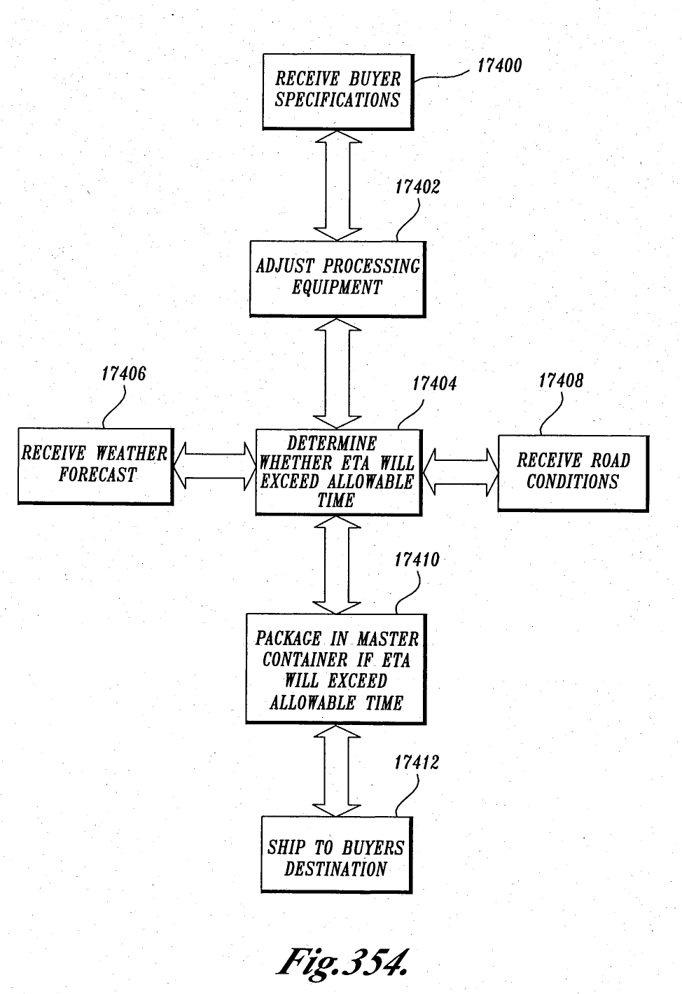

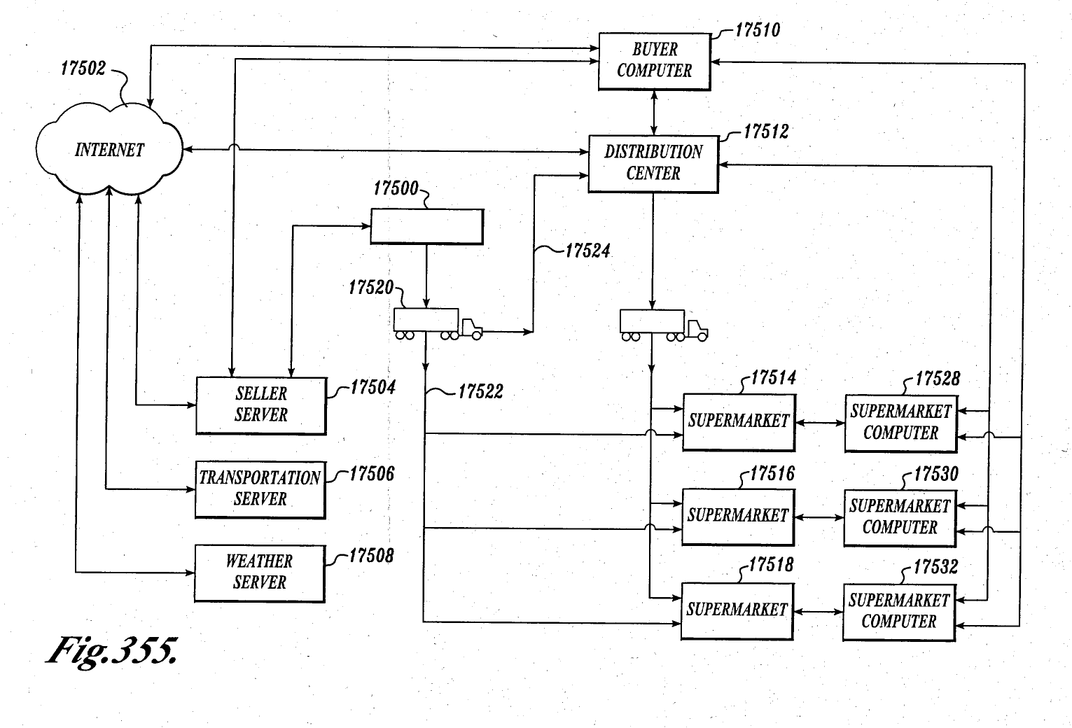

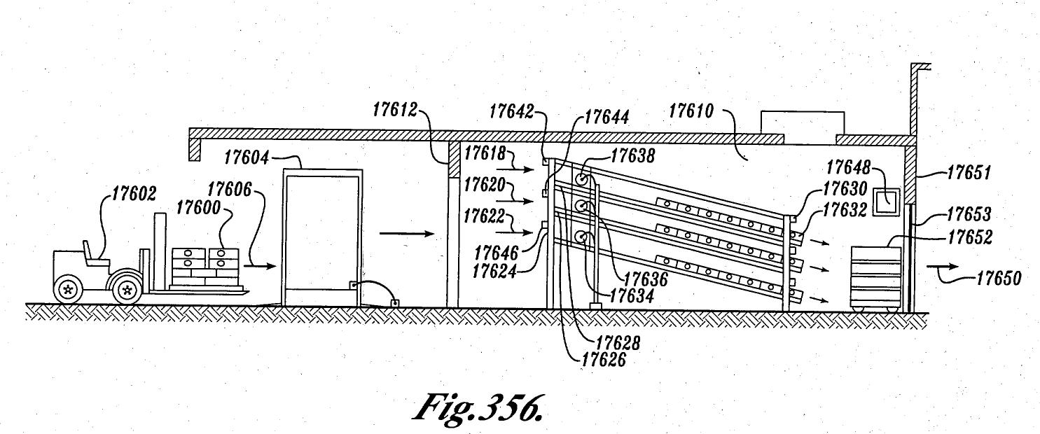

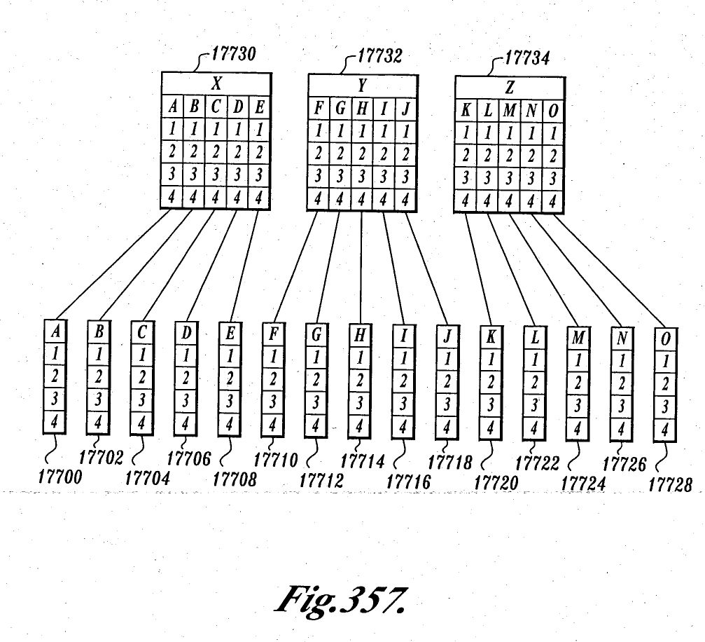

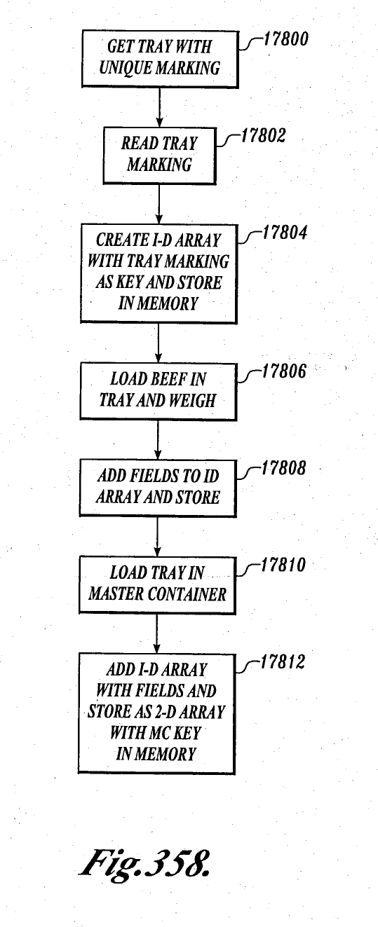

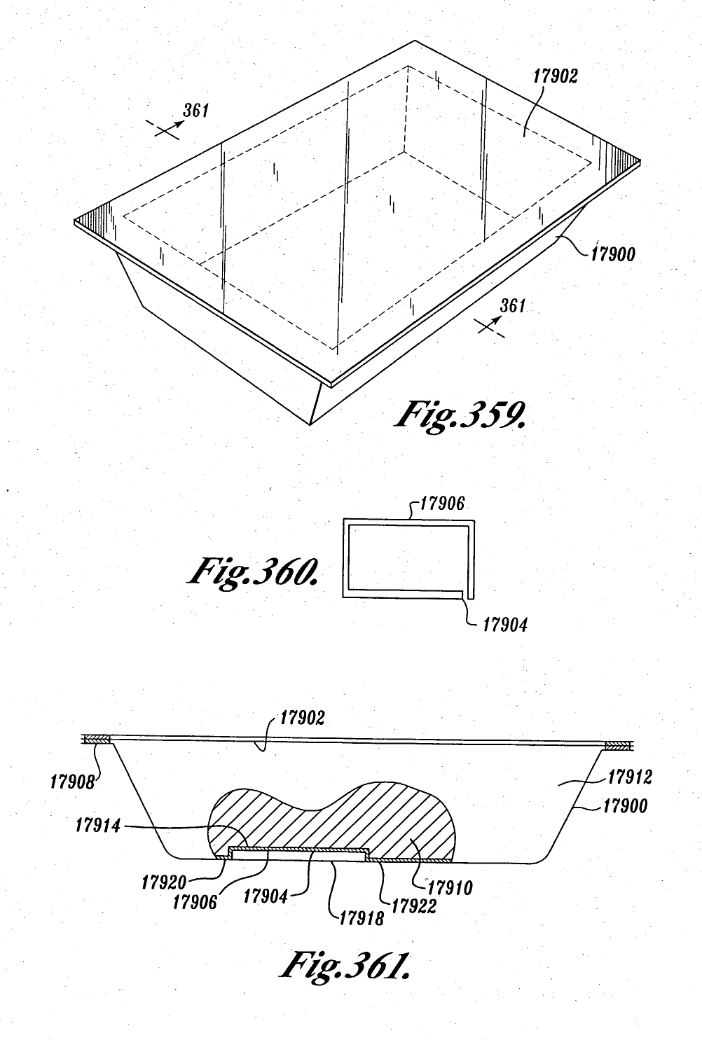

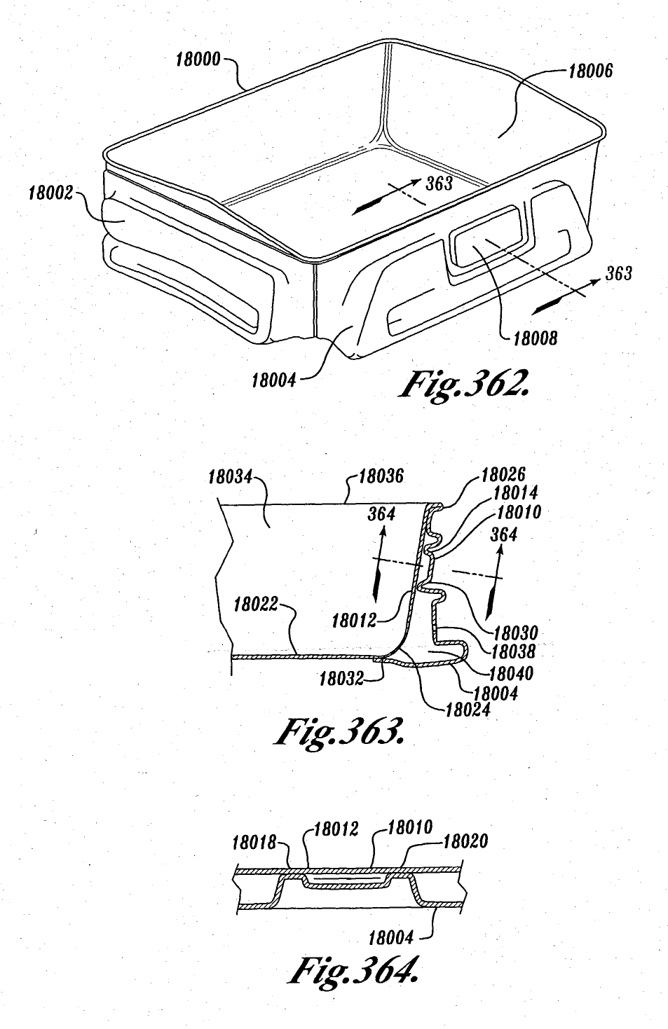

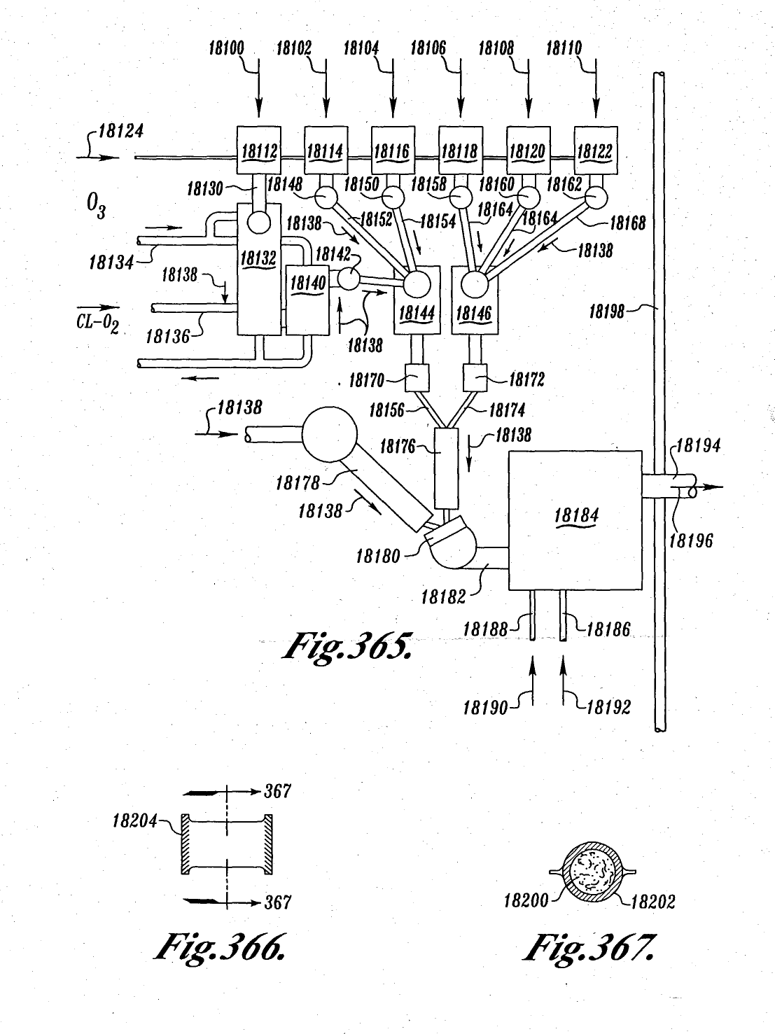

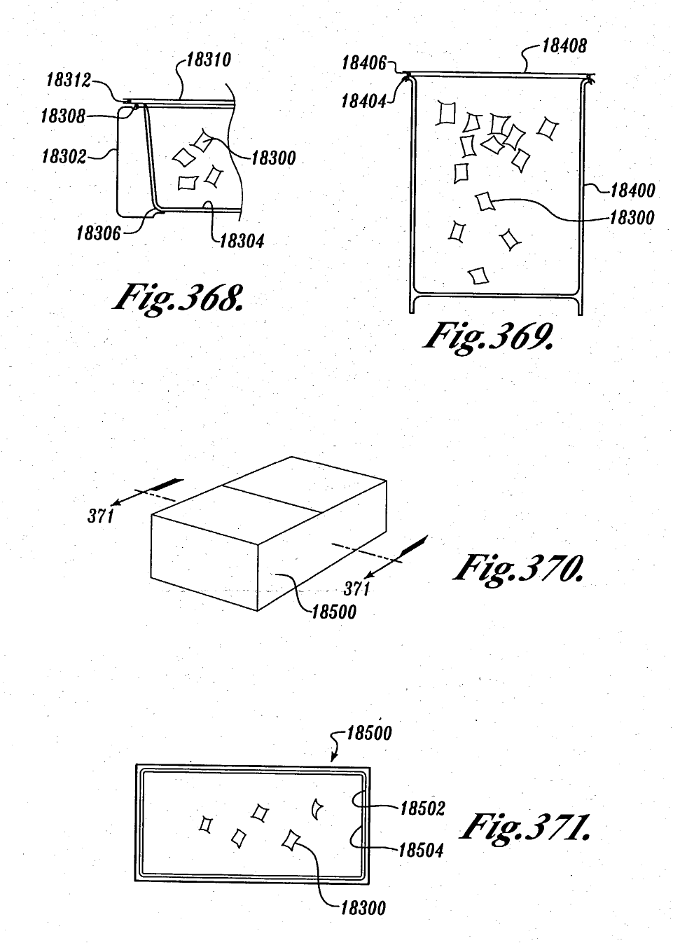

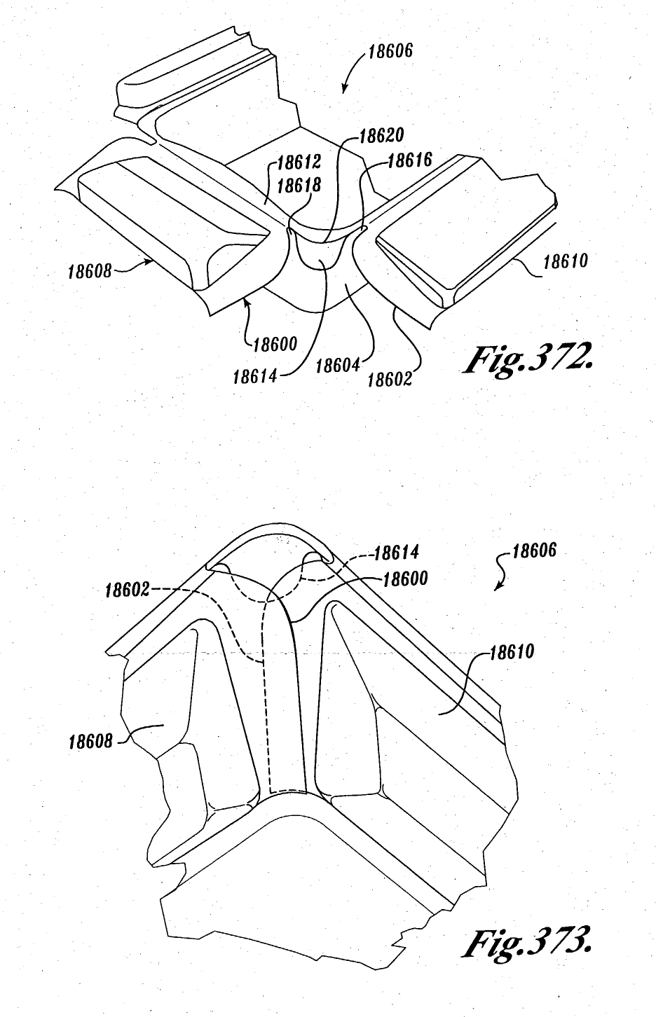

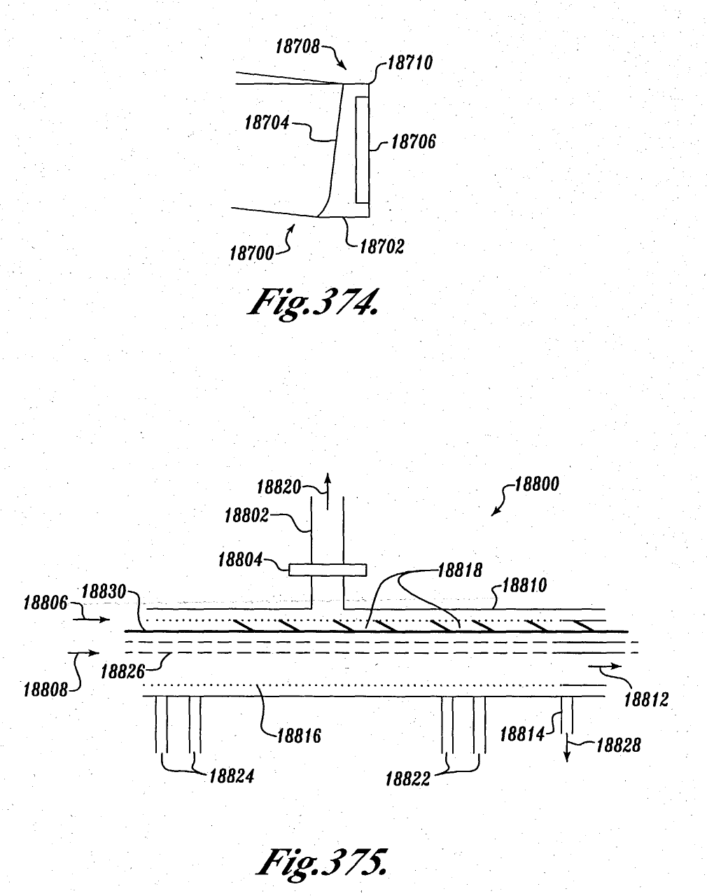

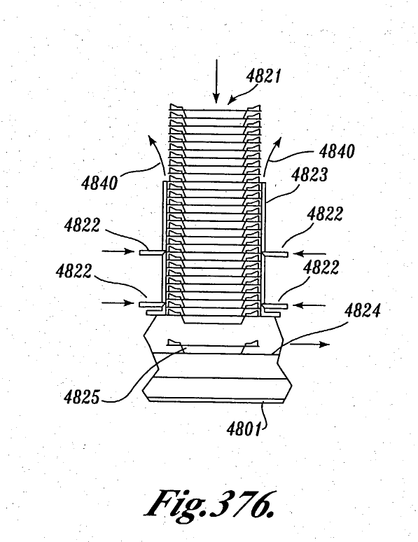

Referring now to FIG. 300, a section of web 3063 is shown with a thickness 3073, which may be for example 0.010 inches, prior to heating. A section of web material 3071 is shown with thickness 3072 which may be for example 0.030 inches thick. As shown, web 3063 can be increased in thickness from 0.010 inches to 0.030 inches, by heating to a thermoformable temperature.

Modifications may be made to the inventions as would be apparent to persons skilled in the packaging arts. These and other modifications may be made without departing from the ambit of the invention, the nature of which is to be determined from the foregoing description.

Any suitable substance, gas, blend of gases, solution or agent may be substituted, included as an alternative or included with any suitable gas or blend of gases that has been specified for any use or application in this disclosure.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for producing a goods stream, comprising:
transferring a first stream of goods having at least one variable to a first device capable of measuring at least one variable;
transferring a second stream of goods having at least one variable to a second device capable of measuring at least one variable; and
combining the first and second streams into a goods stream, wherein combining takes place in the presence of a gas that has an oxygen content different from the oxygen content of air.

2. The method of claim 1, wherein the streams are maintained in a substantially enclosed environment.

3. The method of claim 1, wherein transferring the first and second streams occurs simultaneously.

4. The method of claim 1, further comprising diverting the combined single stream to one of a plurality of vessels.

5. The method of claim 1, wherein a variable in the combined stream is determined by varying the flow rate of at least one of the first and the second streams.

6. The method of claim 1, wherein the variable of the combined stream is controlled by decreasing the flow rate of at least one of the first and the second streams.

7. The method of claim 1, wherein the variable is selected from the group consisting of fat, lean tissue, and water content of the goods.

8. The method of claim 1, further comprising grinding the goods of the first and the second streams before combining.

9. The method of claim 8, further comprising applying a bacteria-reducing agent to the goods prior to grinding.

10. The method of claim 9, wherein the agent comprises an acid.

11. The method of claim 10, wherein the acid is selected from the group consisting of citric acid, acetic acid, lactic acid, and carbonic acid.

12. The method of claim 9, wherein the agent comprises ozone in water.

13. The method of claim 1, further comprising treating the first and second streams with radiation.

14. The method of claim 13, wherein the radiation is selected from the group consisting of E beam, x-ray, gamma, and ultraviolet C.

15. The method of claim 8, further comprising exposing the first and the second streams to a gas, that has an oxygen content different from the oxygen content of air, during grinding.

16. The method of claim 15, wherein the gas comprises carbon dioxide, carbon monoxide, nitrogen, oxygen, or any combination thereof.

17. The method of claim 1, further comprising exposing the first and second streams to a gas that has an oxygen content different from the oxygen content of air.

18. The method of claim 8, further comprising exposing the first and second streams to a gas, that has an oxygen content different from the oxygen content of air, prior to grinding.

19. The method of claim 8, further comprising mixing the goods of the first and second streams after grinding and before measuring.

20. The method of claim 19, further comprising exposing the first and second streams to a gas that has an oxygen content different from the oxygen content of air during mixing.

21. The method of claim 20, wherein the gas is carbon dioxide, carbon monoxide, nitrogen, oxygen, or any combination thereof.

22. The method of claim 1, further comprising enclosing the first and the second streams in a vessel upstream of the measuring device.

23. The method of claim 22, further comprising controlling a gas that has an oxygen content different from the oxygen content of air in the vessel.

24. The method of claim 23, wherein the gas comprises carbon dioxide, carbon monoxide, nitrogen, oxygen, or any combination thereof.

25. The method of claim 1, further comprising exposing the goods to a gas that has an oxygen content different from the oxygen content of air, during blending.

26. The method of claim 25, further comprising adding water to the goods, in an amount not exceeding an amount of water that has evaporated from the goods, during treatment of the goods.

27. The method of claim 25, wherein the gas comprises carbon dioxide, carbon monoxide, nitrogen, oxygen, or any combination thereof.

28. The method of claim 1, further comprising grinding the combined goods stream.

29. The method of claim 28, further comprising exposing the combined goods stream to a gas, that has an oxygen content different from the oxygen content of air, during grinding.

30. The method of claim 29, wherein the gas comprises carbon dioxide, carbon monoxide, nitrogen, oxygen, or any combination thereof.

31. The method of claim 1, wherein the first stream comprises a plurality of two or more goods streams.

32. The method of claim 31, further comprising treating the plurality of streams to reduce bacteria that may be present.

33. The method of claim 1, wherein the second stream comprises a plurality of two or more goods streams.

34. The method of claim 33, further comprising treating the plurality of streams to reduce bacteria that may be present.

35. The method of claim 1, wherein the first stream has a lower proportion of at least one variable in comparison with a higher proportion of the same variable in the second stream.

36. The method of claim 35, further comprising combining the first and second streams to produce a combined stream, having a combined variable proportion that is between the low proportion of the first stream and the high proportion of the second stream.

37. The method of claim 1, further comprising producing a plurality of combined streams from the first and the second goods streams.

38. The method of claim 37, further comprising determining a variable of each of the plurality of combined streams, by controlling the flow rates of the first and second streams.

39. The method of claim 1, wherein the combined stream is transferred to a controlled-atmosphere packaging system.

40. The method of claim 1, wherein the transferring of the first and the second streams is carried out by pumps that compensate for surge.

41. The method of claim 1, further comprising applying a bacteria-reducing agent to the goods before combining.

42. The method of claim 41, wherein the agent comprises an acid.

43. The method of claim 42, wherein the acid is selected from the group consisting of citric acid, acetic acid, lactic acid, and carbonic acid.

44. The method of claim 41, wherein the agent comprises ozone in water.

45. The method of claim 1, further comprising packaging the combined goods stream in a chub package.

46. The method of claim 1, further comprising portioning the combined stream.

47. The method of claim 46, further comprising portioning the combined stream into patties.

48. The method of claim 1, wherein combining the streams is at a pressure greater than ambient pressure.

49. A method for producing a goods stream, comprising:
transferring a first stream of goods having at least one variable to a first device capable of measuring at least one variable;
transferring a second stream of goods having at least one variable to a second device capable of measuring at least one variable; and
combining the first and second streams into a goods stream, wherein the first and second streams have been in contact with a gas that has an oxygen content different from the oxygen content of air.
